(19) United States
(12) Patent Application Publication
(10) Pub. No.: US 2010/0184624 A1
(43) Pub. Date: Jul. 22, 2010

(54) ARRAYS AND METHODS COMPRISING M. SMITHII GENE PRODUCTS

(75) Inventors: Buck Sparrow Samuel, St. Louis, MO (US); Elizabeth E. Hansen, St. Louis, MO (US); Jeffrey I. Gordon, St. Louis, MO (US)

Correspondence Address: POLSINELLI SHUGHART PC, 100 SOUTH FOURTH STREET, SUITE 100, SAINT LOUIS, MO, 63102-1825, US

(73) Assignee: THE WASHINGTON UNIVERSITY, St. Louis, MO (US)

(21) Appl. No.: 12/627,961

(22) Filed: Nov. 30, 2009

Related U.S. Application Data
(63) Continuation-in-part of application No. PCT/US2008/065344, filed on May 30, 2008.
(60) Provisional application No. 60/932,457, filed on May 31, 2007.

(51) Int. Cl. C40B 40/08

(52) U.S. Cl. 506/17

(57) ABSTRACT

The present invention encompasses arrays and methods related to the genome of Methanobrevibacter-smithii.

### CROSS REFERENCE TO RELATED APPLICATIONS

This application claims the priority of PCT application PCT/US2008/065344, filed May 30, 2008, which claims the priority of U.S. provisional application No. 60/932,457, filed May 31, 2007, each of which is hereby incorporated by reference in its entirety.

### GOVERNMENTAL RIGHTS

This invention was made with government support under Grant numbers DK30292 and DK70077 awarded by the National Institutes of Health. The government has certain rights in the invention.

### FIELD OF THE INVENTION

The present invention encompasses arrays and methods related to the genome of Methanobrevibacter smithii.

### BACKGROUND OF THE INVENTION

### I. Weight Problems and Current Approaches

According to the Center for Disease Control (CDC), over sixty percent of the United States population is overweight, and almost twenty percent are obese. This translates into 38.8 million adults in the United States with a Body Mass Index (BMI) of 30 or above. Obesity is also a world-wide health problem with an estimated 500 million overweight adult humans [body mass index (BMI) of 25.0-29.9 kg/m²] and 250 million obese adults. This epidemic of obesity is leading to worldwide increases in the prevalence of obesity-related disorders, such as diabetes, hypertension, as well as cardiac pathology, and non-alcoholic fatty liver disease (NAFLD).

According to the National Institute of Diabetes, Digestive and Kidney Diseases (NIDDK) approximately 280,000 deaths annually are directly related to obesity. The NIDDK further estimated that the direct cost of healthcare in the U.S. associated with obesity is $51 billion. In addition, Americans spend $33 billion per year on weight loss products. In spite of this economic cost and consumer commitment, the prevalence of obesity continues to rise at alarming rates. From 1991 to 2000, obesity in the U.S. grew by 61%.

Additionally, malnourishment or disease may lead to individuals being under weight. The World Health Organization estimates that one-third of the world is under-fed and one-third is starving. Over 4 million will die this year from malnourishment. One in twelve people worldwide is malnourished, including 160 million children under the age of 5.

### II. Gastrointestinal Microbiota

Humans are host to a diverse and dynamic population of microbial symbionts, with the majority residing within the distal intestine. The gut microbiota contains representatives from ten known divisions of the domain Bacteria, with an estimated 500-1000 species-level phylogenetic types present in a given healthy adult human; the microbiota is dominated by members of two divisions of Bacteria, the Bacteroidetes and the Firmicutes. Members of the domain Archaea are also represented, most prominently by a methanogenic Euryarchaeote, Methanobrevibacter smithii and occasionally Methanosphaera stadtmanae. The density of colonization increases by eight orders of magnitude from the proximal small intestine (10³) to the colon (10¹¹). The distal intestine is an anoxic bioreactor whose microbial constituents help the subject by providing a number of key functions: e.g., breakdown of otherwise indigestible plant polysaccharides and regulating subject storage of the extracted energy; biotransformation of conjugated bile acids and xenobiotics; degradation of dietary oxalates; synthesis of essential vitamins; and education of the immune system.

Dietary fiber is a key source of nutrients for the microbiota. Monosaccharides are absorbed in the proximal intestine, leaving dietary fiber that has escaped digestion (e.g. resistant starches, fructans, cellulose, hemicelluloses, pectins) as the primary carbon sources for microbial members of the distal gut. Fermentation of these polysaccharides yields short-chain fatty acids (SCFAs; mainly acetate, butyrate and propionate) and gases (H₂ and CO₂). These end products benefit humans. For example, SCFAs are an important source of energy, as they are readily absorbed from the gut lumen and are subsequently metabolized in the colonic mucosa, liver, and a variety of peripheral tissues (e.g., muscle). SCFAs also stimulate colonic blood flow and the uptake of electrolytes and water.

### III. Methanogens

Methanogens are members of the domain Archaea. Methanogens thrive in many anaerobic environments together with fermentative bacteria. These habitats include natural wetlands as well as man-made environments, such as sewage digesters, landfills, and bioreactors. Hydrogen-consuming, mesophilic methanogens are also present in the intestinal tracts of many invertebrate and vertebrate species, including termites, birds, cows, and humans. Using methane breath tests, clinical studies estimate that between 30 and 80 percent of humans harbor methanogens.

Culture- and non-culture-based enumeration studies have demonstrated that members of the Methanobrevibacter genus are prominent gut mesophilic methanogens. The most comprehensive enumeration of the adult human colonic microbiota reported to date found a single predominant archaeal species, Methanobrevibacter smithii. This gram-positive-staining Euryarchaeote can comprise up to 10¹⁰ cells/g feces in healthy humans, or ˜10% of all anaerobes in the colons of healthy adults.

A focused set of nutrients are consumed for energy by methanogens: primarily H₂/CO₂, formate, acetate, but also methanol, ethanol, methylated sulfur compounds, methylated amines and pyruvate. These compounds are typically converted to CO₂ and methane (e.g. acetate) or reduced with H₂ to methane alone (e.g. methanol or CO₂). Some methanogens are restricted to utilizing only H₂/CO₂ (e.g. Methanobrevibacter arbophilicus), or methanol (e.g. Methanospaera stadtmanae). Other more ubiquitous methanogens exhibit greater metabolic diversity, like Methanosarcina species. In vitro studies suggest that M. smithii is intermediate in this metabolic spectrum, consuming H₂/CO₂ and formate as energy sources.

### IV. Anaerobic Microbial Fermentation in the Mammalian Intestine

Fermentation of dietary fiber is accomplished by syntrophic interactions between microbes linked in a metabolic food web, and is a major energy-producing pathway for members of the Bacteroidetes and the Firmicutes. Bacteroides thetaiotaomicron has previously been used as a model bacterial symbiont for a variety of reasons: (i) it effectively ferments a range of otherwise indigestible plant polysaccharides in the human colon; (ii) it is genetically manipulatable; and, (iii) it is a predominant member of the human distal intestinal microbiota. Its 6.26 Mb genome has been sequenced: the results reveal that B. thetaiotaomicron has a large collection of known or predicted glycoside hydrolases (261 in total; by comparison, our human genome only encodes 99 known or predicted glycoside hydrolases). B. thetaiotaomicron also has a significant expansion of outer membrane polysaccharide binding and importing proteins (over 208 paralogs of two starch binding proteins known as SusC and SusD), as well as a large repertoire of environmental sensing proteins [e.g. 50 extra-cytoplasmic function (ECF)-type sigma factors; 25 anti-sigma factors, and 32 novel hybrid two-component systems]. Functional genomics studies of B. thetaiotaomicron in vitro and in the ceca of gnotobiotic mice, indicates that it is capable of very flexible foraging for dietary (and host-derived) polysaccharides, allowing this organism to have a broad niche and contributing to the functional stability of the microbiota in the face of changes in the diet.

In vitro biochemical studies of B. thetaiotaomicron and closely related Bacteroides species (B. fragilis and B. succinogenes) indicate that their major end products of fermentation are acetate, succinate, H₂ and CO₂. Small amounts of pyruvate, formate, lactate and propionate are also formed.

V. Removal of Hydrogen from the Intestinal Ecosystem is Important for Efficient Microbial Fermentation

Anaerobic fermentation of sugars causes flux through glycolytic pathways, leading to accumulation of NADH (via glyceraldehyde-3P dehydrogenase) and the reduced form of ferredoxin (via pyruvate:ferredoxin oxidoreductase). B. thetaiotaomicron is able to couple NAD⁺ recovery to reduction of pyruvate to succinate (via malate dehydrogenase and fumarase reductase), or lactate (via lactate dehydrogenase). Oxidation of reduced ferredoxin is easily coupled to production of H₂. However, H₂ formation is, in principle, not energetically feasible at high partial pressures of the gas. In other words, lower partial pressures of H₂ (1-10 Pa) allow for more complete oxidation of carbohydrate substrates. The subject removes some hydrogen from the colon by excretion of the gas in the breath and as flatus. However, the primary mechanism for eliminating hydrogen is by interspecies transfer from bacteria by hydrogenotrophic methanogens. Formate and acetate can also be transferred between some species, but their transfer is complicated by their limited diffusion across the lipophilic membranes of the producer and consumer. In areas of high microbial density or aggregation like in the gut, interspecies transfer of hydrogen, formate and acetate is likely to increase with decreasing physical distance between microbes.

Methanogen-mediated removal of hydrogen can have a profound impact on bacterial metabolism. Not only does re-oxidation of NADH occur, but end products of fermentation undergo a shift from a mixture of acetate, formate, H₂, CO₂, succinate and other organic acids to predominantly acetate and methane with small amounts of succinate. This facilitates disposal of reducing equivalents, and produces a potential gain in ATP production due to increased acetate levels. For example, a reduction in hydrogen allows Clostridium butyricum to acquire 0.7 more ATP equivalents from fermentation of hexose sugars. Co-culture of M. smithii with a prominent cellulolytic ruminal bacterial species, Fibrobacter succinogenes S85, results in augmented fermentation, as manifested by increases in the rate of ATP production and organic acid concentrations. Co-culture of M. smithii association with Ruminococcus albus eliminates NADH-dependent ethanol production from acetyl-CoA, thereby skewing bacterial metabolism towards production of acetate, which is more energy yielding. H₂-producing fibrolytic bacterial strains from the human colon exhibit distinct cellulose degradation phenotypes when co-cultured with M. smithii, indicating that some bacteria are more responsive to syntrophy with methanogens.

While there is suggestive evidence that methanogens cooperate metabolically with members of Bacteroides, studies have not elucidated the impact of this relationship on a subject's energy storage or on the specificity and efficiency of carbohydrate metabolism. Colonization of adult germ-free mice with M. smithii and/or B. thetaiotaomicron, revealed that the methanogen increased the efficiency and changed the specificity of bacterial digestion of dietary glycans. Moreover, co-colonized mice exhibited a significantly greater increase in adiposity compared with mice colonized with either organism alone.

### SUMMARY OF THE INVENTION

One aspect of the present invention encompasses an array. The array comprises a substrate having disposed thereon at least one nucleic add, wherein the nucleic acid comprises a nucleic acid sequence selected from the nucleic acid sequences listed in Table A.

Another aspect of the present invention encompasses an array. The array comprises a substrate having disposed thereon at least one polypeptide, wherein the polypeptide is encoded by a nucleic acid sequence selected from the nucleic acid sequences listed in Table A.

Yet another aspect of the present invention encompasses a method of selecting a compound that has efficacy for modulating a gene product of M. smithii present in the gastrointestinal tract of a subject. The method comprises comparing an M. smithii gene profile to a gene profile of the subject, identifying a gene product of the M. smithii gene profile that is divergent from a corresponding gene product of the subject gene profile, or absent in the gene profile of the subject, and selecting a compound that modulates the M. smithii gene product but does not substantially modulate the corresponding divergent gene product of the subject.

Still another aspect of the invention encompasses a method for modulating a gene product of M. smithii present in the gastrointestinal tract of a subject. The method comprises administering to the subject an HMG-CoA reductase inhibitor. The inhibitor may be formulated for release in the distal portion of the subject's gastrointestinal tract and thereby substantial inhibit more of the HMG-CoA reductase of M. smithii compared to the subject's HMG-CoA reductase.

Other aspects and iterations of the invention are described more thoroughly below.

### REFERENCE TO COLOR FIGURES

The application file contains at least one photograph executed in color. Copies of this patent application publication with color photographs will be provided by the Office upon request and payment of the necessary fee.

### BRIEF DESCRIPTION OF THE FIGURES

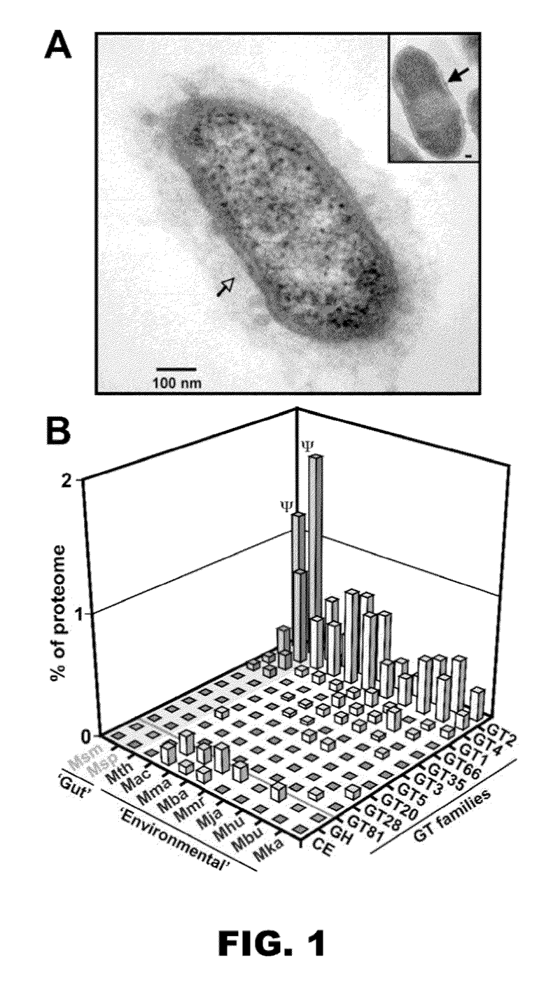

FIG. 1. depicts a micrograph and a graph illustrating that M. smithii produces glycans that mimic those produced by humans—(A) TEM of M. smithii harvested from the ceca of adult GF mice after a 14 day colonization. The inset shows a comparable study of stationary phase M. smithii recovered from a batch fermentor containing Methanobrevibacter complex medium (MBC). Note that the size of the capsule is greater in cells recovered from the cecum (open vs. closed arrow). (B) Comparison of glycosyltransferase (GT), glycosylhydrolase (GH) and carbohydrate esterase (CE) families (defined in CAZy; Table 10) represented in the genomes of the following sequenced methanogens (see Table 5): Msm, Methanobrevibacter smithii; Msp, Methanosphaera stadtmanae; Mth, Methanothermobacter thermoautotrophicus; Mac, Methanosarcina acetivorans; Mba, M. barkeri; Mma, M. mazei; Mmp, Methanococcus maripaludis; Mja, M. jannaschii; Mhu, Methanospirillum hungatei; Mbu, Methanococcoides burtonii; and Mka, Methanopyrus kandleri. Gut methanogens (highlighted in orange) have no GH or CE family members, but have a larger proportion of family 2 GTs (^{ψ}, p<0.00005 based on binomial test for enrichment vs. non-gut associated methanogens). Scale bar, 100 μm in panel A.

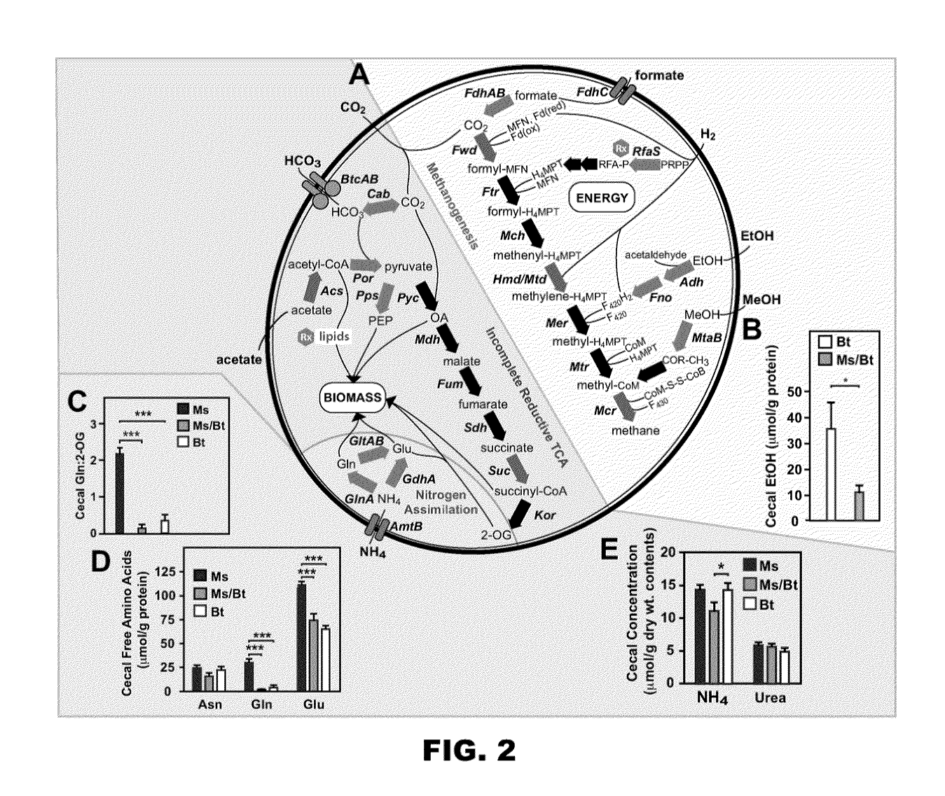

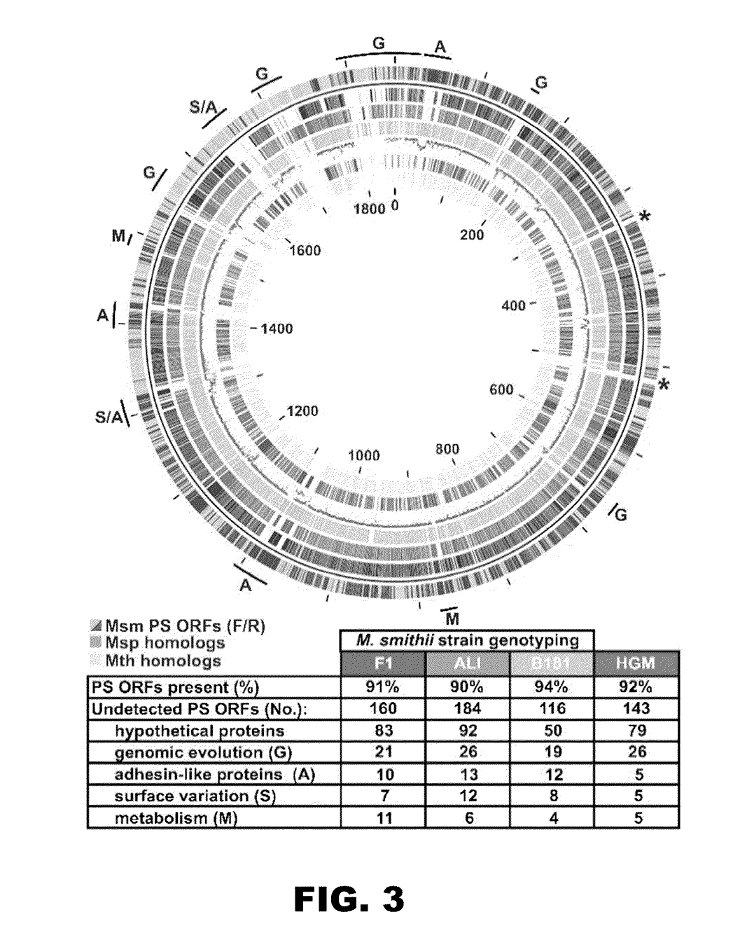

FIG. 2. depicts graphs and diagrams illustrating biochemical assays of M. smithii metabolism in the ceca of gnotobiotic mice. (A) In silico metabolic reconstructions of M. smithii pathways involved in (i) methanogenesis from formate, H₂/CO₂, and alcohols, (ii) carbon assimilation from acetate and bicarbonate, and (iii) nitrogen assimilation from ammonium. Abbreviations: Acs, acetyl-CoA synthase; Adh, alcohol dehydrogenase; Ags, 18α-ketoglutarate synthase; AmtB, ammonium transporter; BtcA/B, bicarbonate (HCO₃) ABC transporter; Cab, carbonic anhydrase; CH₃, methyl; CoA, coenzyme A; CoB, coenzyme B; CoM, coenzyme M; COR, corrinoid; F₄₂₀, cofactor F₄₂₀; F₄₃₀, cofactor F₄₃₀; Fd, ferredoxin (ox-oxidized, red-reduced); FdhAB, formate dehydrogenase subunits; FdhC, formate transporter; Fno, F₄₂₀-dependent NADP reductase; Ftr, formylmethanofuran:tetrahydromethanopterin (H₄MPT) formyltransferase; Fum, fumarate hydratase; Fwd, tungsten formylmethanofuran dehydrogenase; GdhA, glutamate dehydrogenase; GlnA, glutamine synthetase; GltA/B, glutamate synthase subunits A and B; Hmd, H₂-forming methylene-H₄MPT dehydrogenase; Kor, 2-oxoglutarate synthase; Mch, methenyl-H₄MPT cyclohydrolase; Mcr, methyl-CoM reductase; Mdh, malate dehydrogenase; MeOH, methanol; Mer, methylene-H₄MPT reductase; MFN, methanofuran; MtaB, methanol:cobalamin methyltransferase; Mtd, F₄₂₀-dependent methylene-H₄MPT dehydrogenase; Mtr, methyl-H₄ MPT:CoM methyltransferase; NH4, ammonium; OA, oxaloacetate; PEP, phosphoenol pyruvate; Por, pyruvate:ferredoxin oxidoreductase; Pps, phosphoenolpyruvate synthase; PRPP, 5-phospho-a-D-ribosyl-1-pyrophosphate; Pyc, pyruvate carboxylase; RfaS, ribofuranosylaminobenzene 5′-phosphate (RFA-P) synthase; Sdh, succinate dehydrogenase; Suc, succinyl-CoA synthetase. (B) Ethanol (EtOH) levels in the ceca of mice colonized with B. thetaiotaomicron±M. smithii (n=10-15 animals/group representing 3 independent experiments; each sample assayed in duplicate; mean values±SEM plotted). (C) Ratio of cecal concentrations of glutamine (Gln) and 2-oxoglutarate (2-OG) (n=5 animals/group; samples assayed in duplicate; mean values±SEM). (D) Cecal levels of free Gln (glutamine), Glu (glutamate) and Asn (asparagine) (n=5 animals/group; samples assayed in duplicate; mean values±SEM). (E) Cecal ammonium and urea levels measured in samples used for the assays shown in panels C and D. *, p<0.05; **, p<0.01; ***, p<0.005, according to Student's t-test.

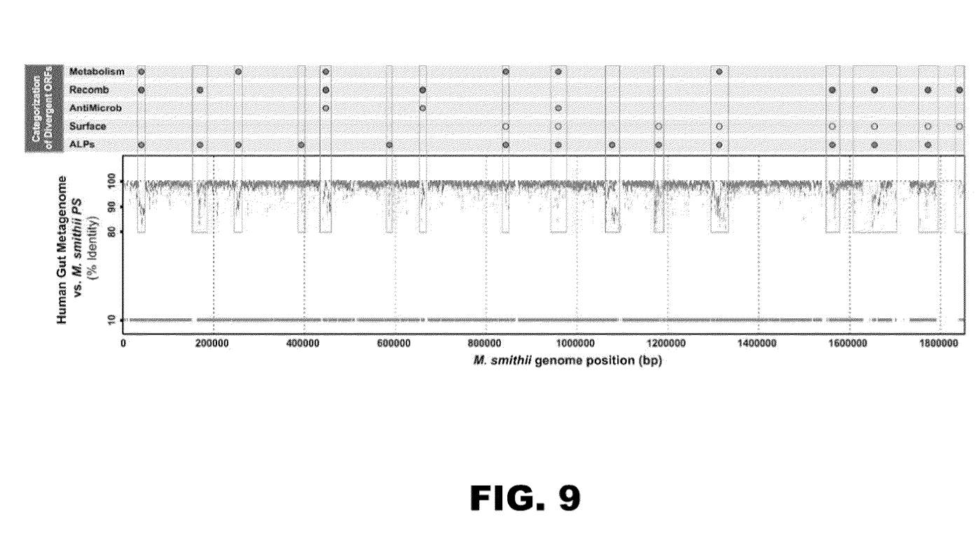

FIG. 3. depicts a diagram of the analysis of the M. smithii pan-genome. Schematic depiction of the conservation of M. smithii PS genes [depicted in the outermost circle where the color code is orange for forward strand ORFs (F) and blue for reverse strand ORFs (R)] in (i) other M. smithii strains (GeneChip-based genotyping of strains F1, ALI, and B181; circles in increasingly lighter shades of green, respectively), (ii) the fecal microbiomes of two healthy individuals [human gut microbiome (HGM), shown as the red plot in the fifth innermost circle with nucleotide identity plotted from 80% (closest to the purple circle) to 100% (closest to lightest green ring); see also FIG. 9 for details], and (iii) two other members of the Methanobacteriales division, M. stadtmanae (Msp; purple circle), another human gut methanogen, and M. thermoautotrophicus (Mth; yellow circle), an environmental thermophile [mutual best blastp hits (e-value <10⁻²⁰)]. Tick marks in the center of the Figure indicate nucleotide number in kbps. Asterisks denote the positions of ribosomal rRNA operons. Letters highlight distinguishing features among M. smithii genomes: the table below the figure summarizes differences in M. smithii gene content between strains F1, ALI, and B181 as well as the two human fecal metagenomic datasets.

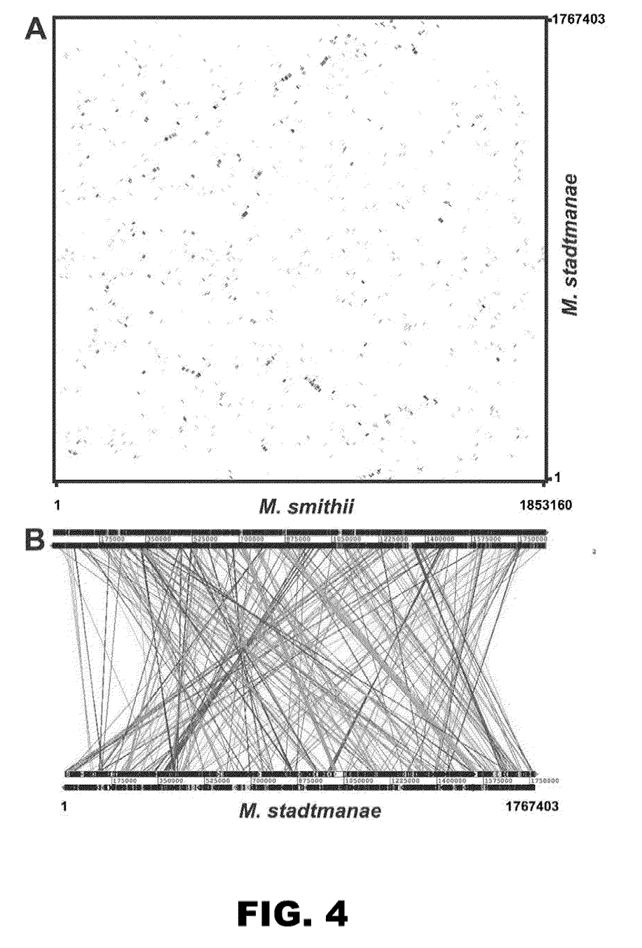

FIG. 4. depicts two illustrations of the analysis of synteny between M. smithii and M. stadtmanae genomes. (A) Dot plot comparison. (B) Results obtained with the Artemis Comparison Tool (Carver et al., (2005) Bioinformatics 21:3422-3) set to tBLASTX and the most stringent confidence level (blue, forward strand; orange, reverse strand). The gut methanogens exhibit limited synteny.

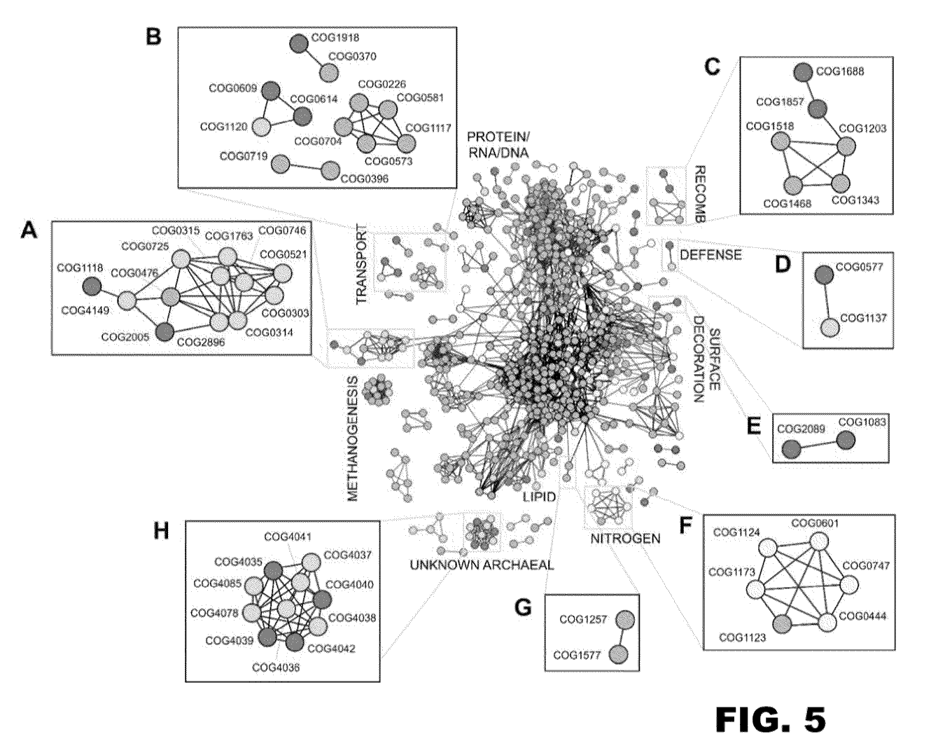

FIG. 5. depicts an illustration of the predicted interaction network of M. smithii clusters of orthologous groups (COGs) based on STRING. Individual M. smithii COGs are represented by nodes (circles; 622 of the 1352 COGs in M. smithii's genome). Predicted interactions are represented by black lines (0.95 confidence interval; summary of 9,765 total predicted interactions are shown). COG conservation among the Methanobacteriales is denoted by node color: red, M. smithii alone; yellow, gut methanogens; green, M. smithii and M. thermoautotrophicus; and gray, all three genomes. Several clusters are highlighted: (A) molybdopterin biosynthesis (methanogenesis from CO₂); (B) ion transport; (C) DNA repair/recombination; (D) antimicrobial transport; (E) sialic acid synthesis; (F) amino acid transport system; (G) HMG-CoA reductase cluster; and (H) conserved archaeal membrane protein cluster. See Table 9 for lists of genes assigned to COGs.

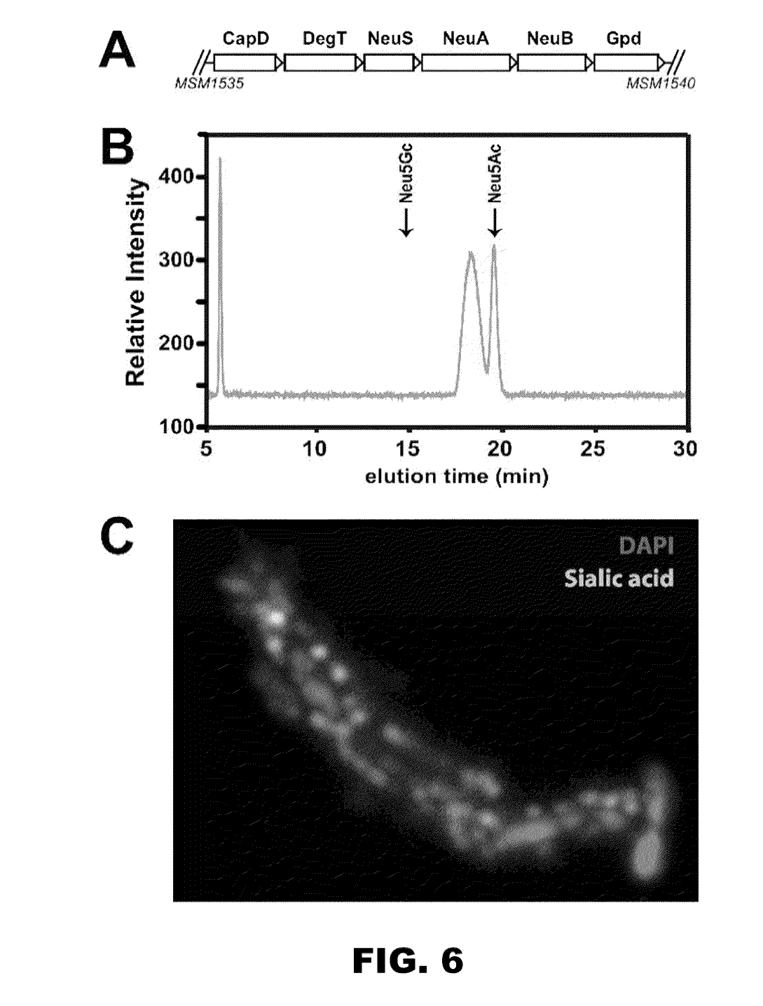

FIG. 6. depicts an illustration, a graph, and a micrograph showing sialic acid production by M. smithii in vitro. (A) M. smithii gene cluster (MSM1535-40) encoding enzymes predicted to be needed to synthesize sialic acid-like sugars (N-acetylneuraminic acid; Neu5Ac): CapD, polysaccharide biosynthesis protein/sugar epimerase; DegT, pleiotropic regulatory protein/amidotransferase; NeuS, Neu5Ac cytidylyltransferase; NeuA, CMP-Neu5Ac synthetase; NeuB, Neu5Ac synthase; Gpd, glycerol-3-phosphate dehydrogenase. (B) Reverse phase-HPLC of derivatized M. smithii cell wall extracts. The position of elution of N-acetylneuraminic acid (Neu5Ac) and N-glycolylneuraminic acid (Neu5Gc) standards are shown. The concentration of Neu5Ac species of sialic acid, as defined by co-elution with standards, in M. smithii cell walls, when the organism has been cultured in a batch fermentor for 6 d in supplemented MBC medium (does not contain any sialic acid sources), is 410 pmol/g wet weight of cells (average of three assays). (C) Lectin staining with fluorescein-labeled SNA (Sambucus nigra agglutinin) shows that M. smithii F1 is decorated with Neu5Ac epitopes (counter stained with DAPI; ×100 magnification). The specificity of lectin staining was assessed using E. coli K92 (positive control; sialic acid-producing), B. longum NCC2705 (negative control) and M. smithii cells with no lectin added (background autofluorescence control).

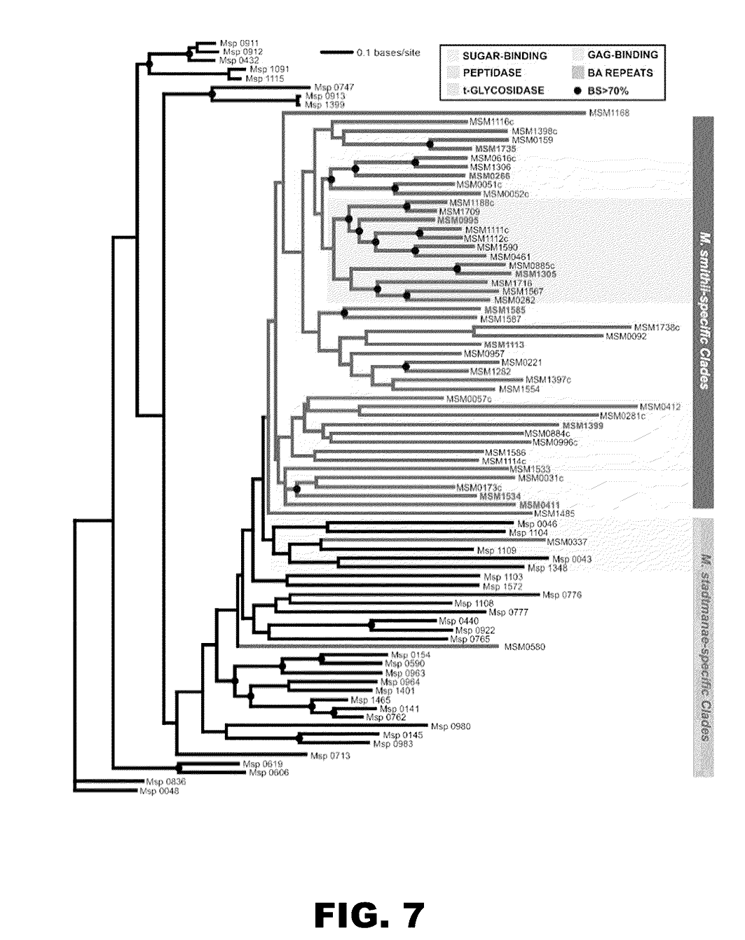

FIG. 7. depicts distinct complements of adhesin-like proteins in gut methanogens. A maximum likelihood tree of a CLUSTALW alignment of all adhesin-like proteins (ALPs) in M. smithii (47; red branches) and in M. stadtmanae (38; black branches). Each methanogen possesses specific clades of ALPs. Branches that are supported by bootstrap values >70% are noted. InterPro-based analysis reveals that many of these proteins contain common adhesin domains [i.e., invasin/intimin domains (IPR008964) and pectate lyase folds (IPR011050)]. They also have domains associated with additional functionality (basis for branch highlighting): (i) sugar binding [e.g., galactose-binding-like (IPR008979) and Concanavalin A-like lectin (IPR013320)]; (ii) glycosaminoglycan (GAG)-binding (IPR012333); or (iii) peptidase activity [e.g., carboxypeptidase regulatory region (IPR008969) and beta-lactamase/transpeptidase-like fold (IPR012338)]; (iv) transglycosidase activity [e.g., glycosidase superfamily domains (SSF51445)]; and/or (v) general adhesin/porin activity [e.g., Bacillus anthracis OMP repeats/DUF11 (IPR001434)]. See Table 11 for a complete list of ALPs and domains identified by InterProScan.

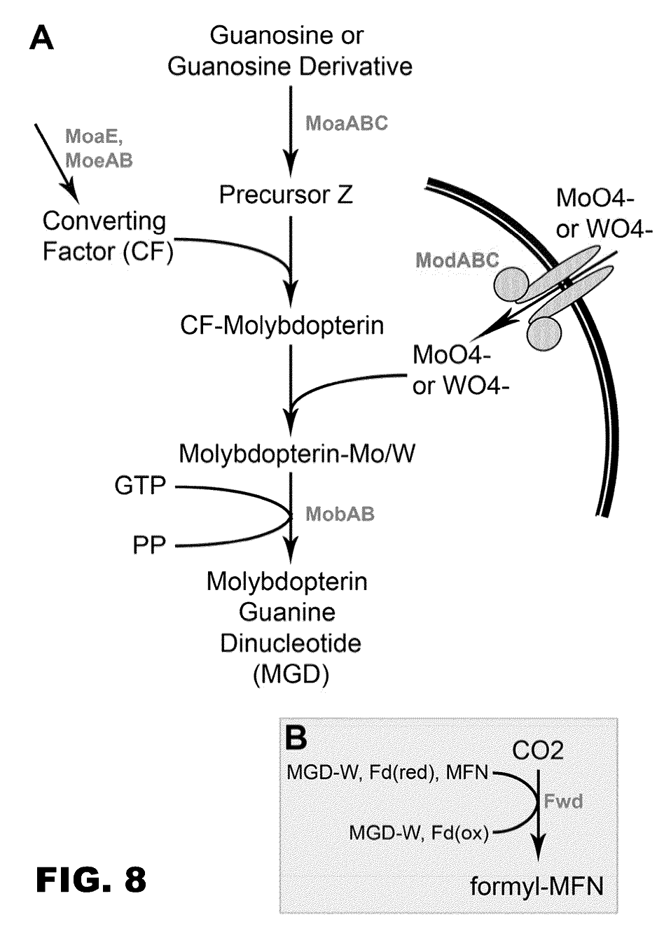

FIG. 8. depicts an illustration showing the importance of the molybdopterin biosynthesis pathway for methanogenesis from carbon dioxide in M. smithii. (A) In silico metabolic reconstruction of the predicted molybdopterin biosynthesis pathway encoded by the M. smithii genome. Molybdopterin can chelate molybdate (MoO₄⁻) or tungstate (WO₄²⁻) ions. Abbreviations: MoaABCE, molybdenum cofactor biosynthesis proteins A (MSM0849, MSM1406), B (MSM0840), C (MSM1362), and E (MSM0130); MoeAB, molybdopterin biosynthesis proteins A (MSM1343) and B (MSM0729); ModABC, molybdate ABC transport system (MSM1609-11); MobAB, molybdopterin-guanine dinucleotide (MGD) biosynthesis proteins A (MSM0240) and B (MSM1407); PP, pyrophosphate. Note that the molybdate transporter may also be used for WO₄²⁻, as no dedicated complex has been identified for its transport. (B) Schematic of the first step in the methanogenesis pathway from carbon dioxide (CO₂) catalyzed by tungsten-containing formylmethanofuran dehydrogenase (Fwd; MSM1408-14, MSM0783, MSM1396). Essential cofactors for this reaction include tungsten delivered by MGD, methanofuran (MFN), and ferridoxin [Fd; converted from a reduced (red) to oxidized (ox) form during the reaction].

FIG. 9. illustrates the divergence in genes involved in surface variation, genome evolution, and metabolism among M. smithii strains and in the human gut microbiomes of two healthy adults. Each of the 139,521 unidirectional reads in the metagenomic dataset (Gill et al., (2006) Science 312, 1355-9) were compared to the M. smithii PS genome using NUCmer. Reads with nucleotide sequence identity ≧80% (present) are plotted. A summary of representation of M. smithii PS genes present in the metagenomic dataset is displayed at the bottom of the graph (92% of the total ORFs). [Note that the gaps are indications of genome plasticity in the dataset, and include transposases, restriction-modification systems and prophage genes.] Selected regions of heterogeneity (divergence) are highlighted; genes in these regions are involved in the metabolism of bacterial products, recombination/repair machinery (Recomb), anti-microbial resistance (AntiMicrob), surface variation (Surface), and adhesion (ALPs). See Table 2 for details.

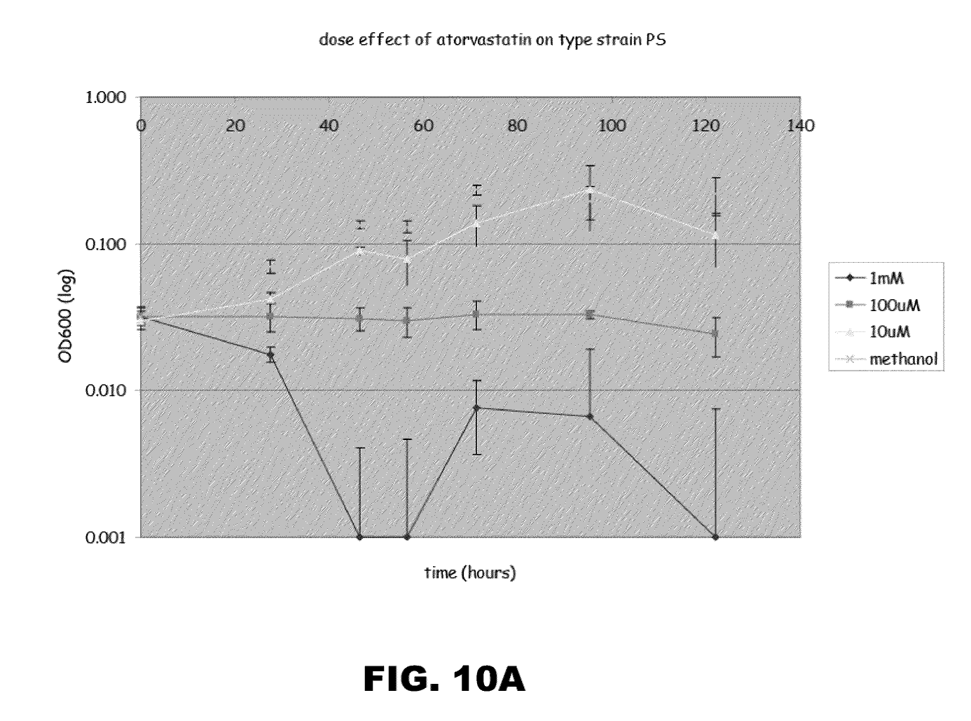

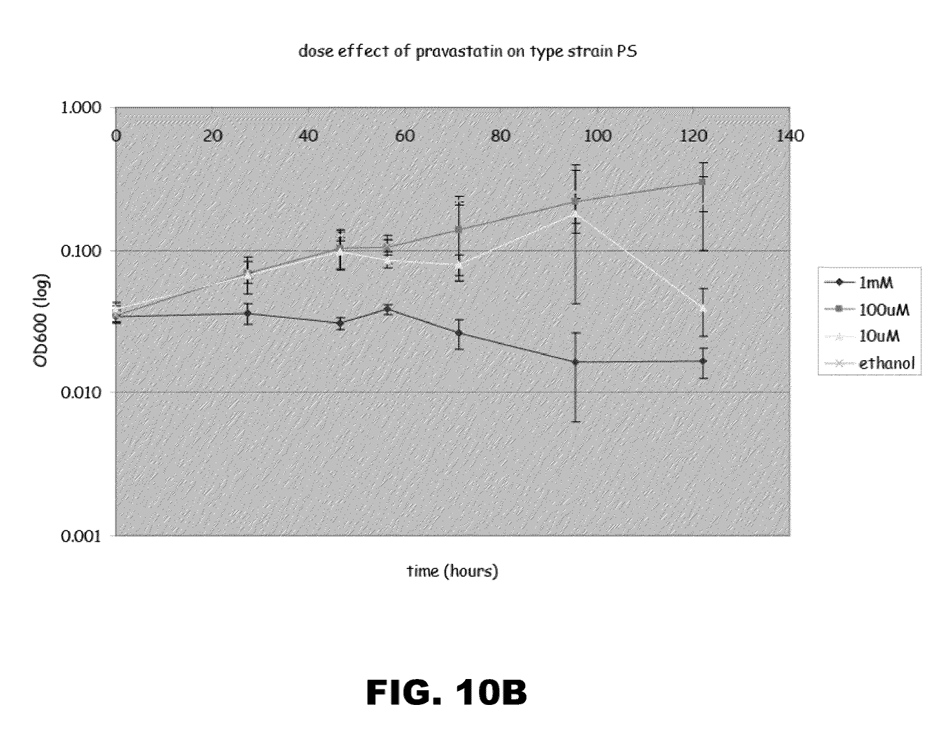

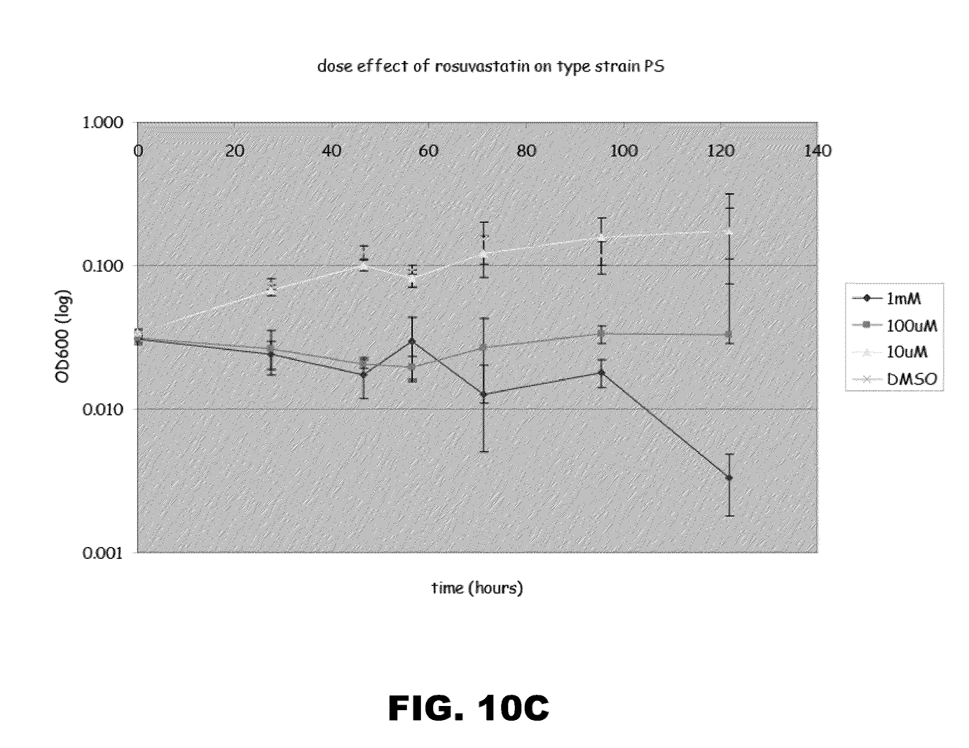

FIG. 10 depicts three graphs showing the dose effect of atorvastatin (A), pravastatin (B), and rosuvastatin (C) on M. smithii strain PS.

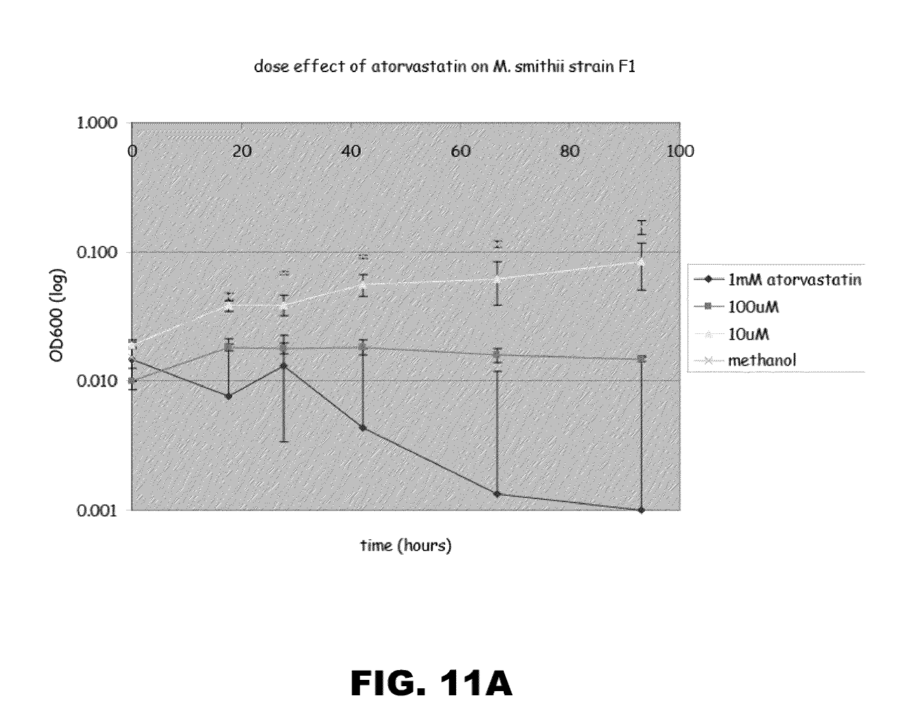

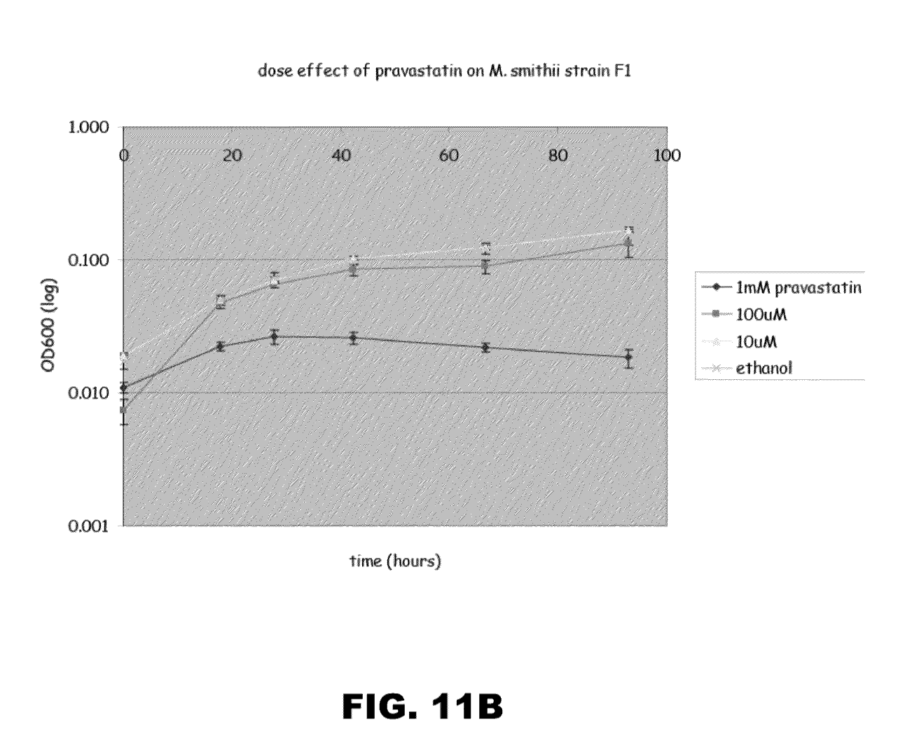

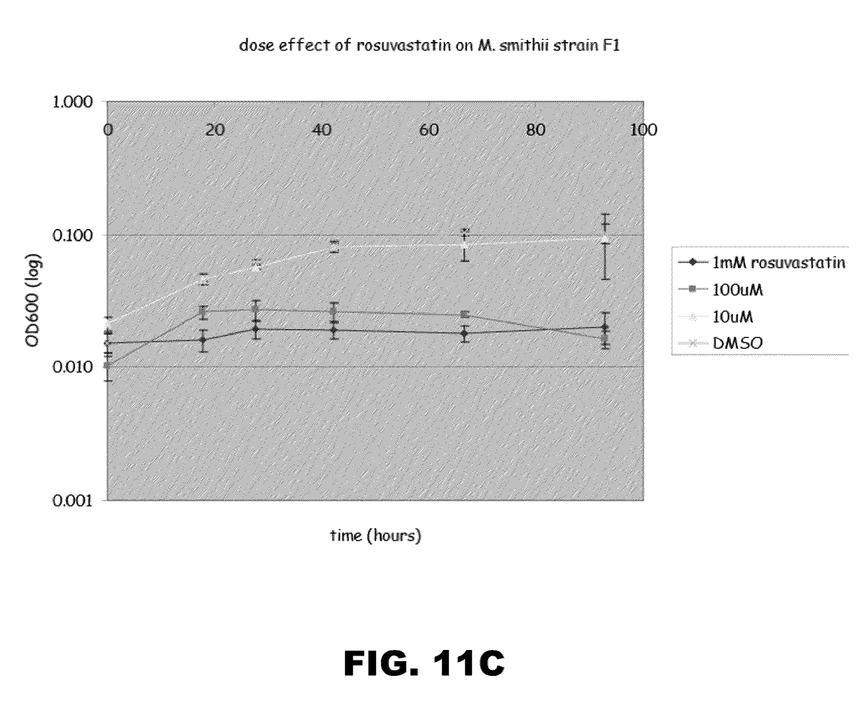

FIG. 11 depicts three graphs showing the dose effect of atorvastatin (A), pravastatin (B), and rosuvastatin (C) on M. smithii strain F1.

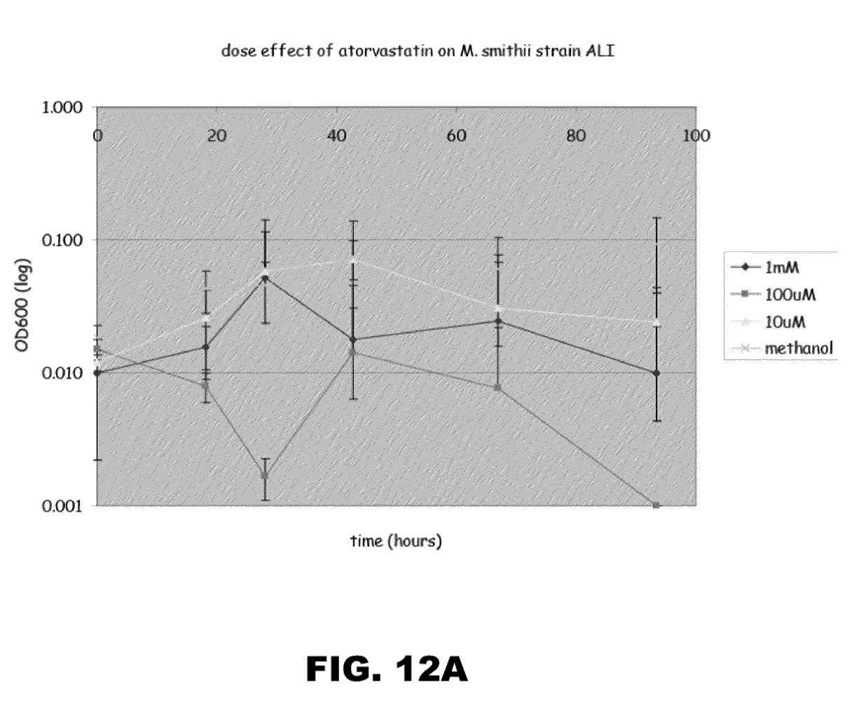

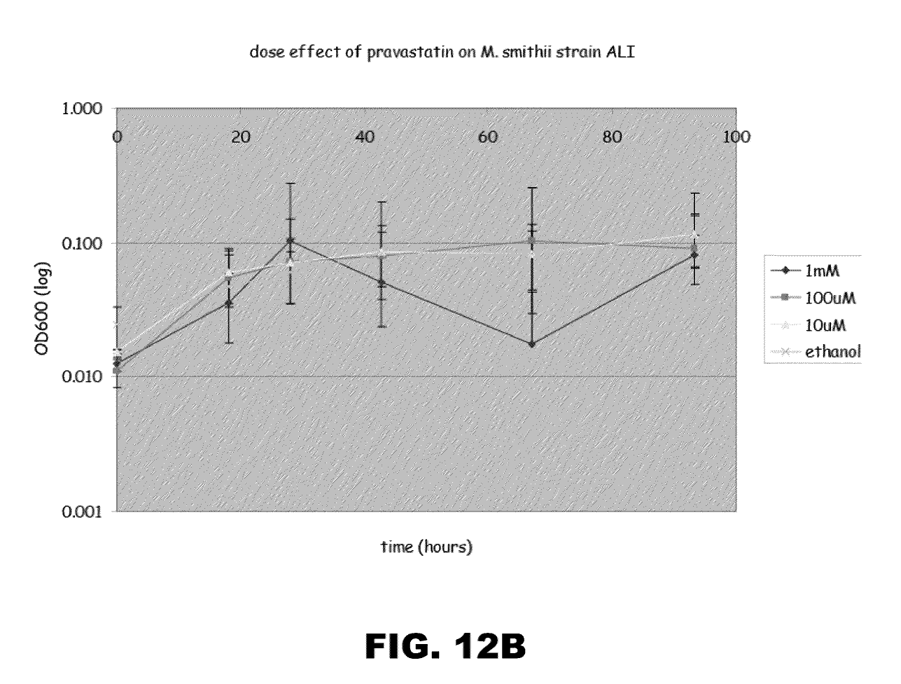

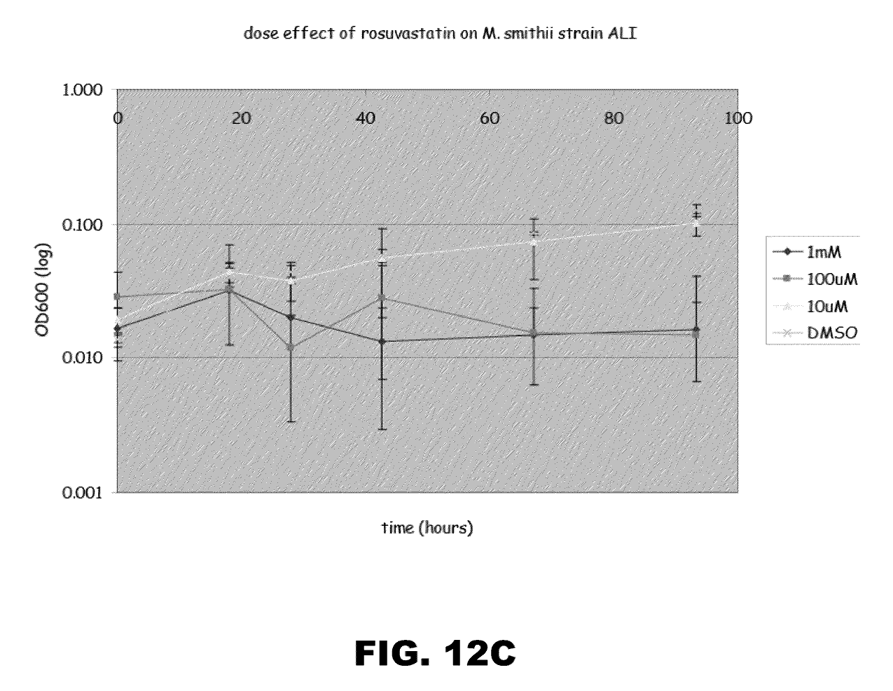

FIG. 12 depicts three graphs showing the dose effect of atorvastatin (A), pravastatin (B), and rosuvastatin (C) on M. smithii strain ALI.

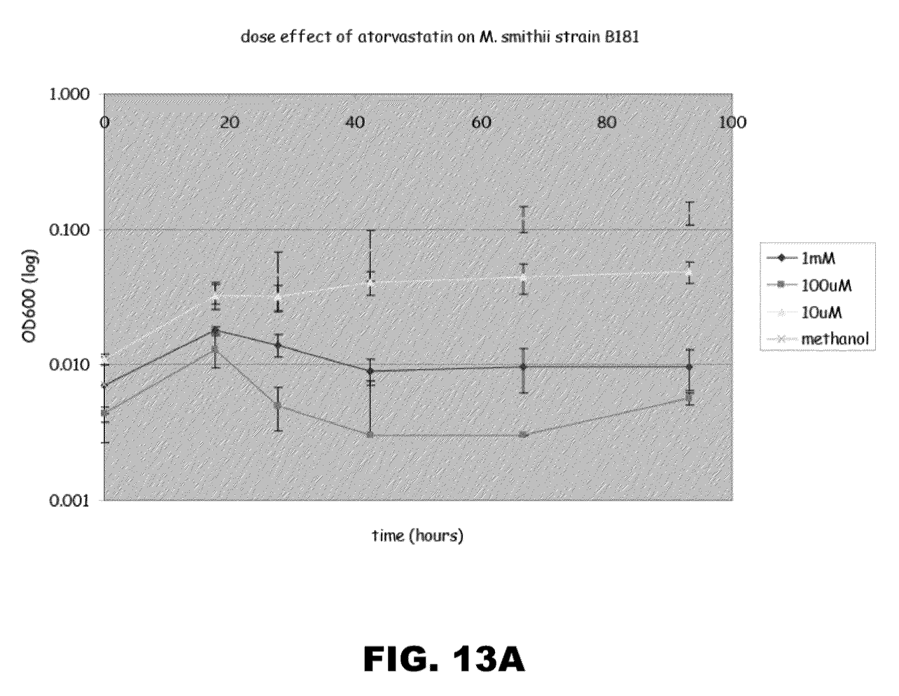

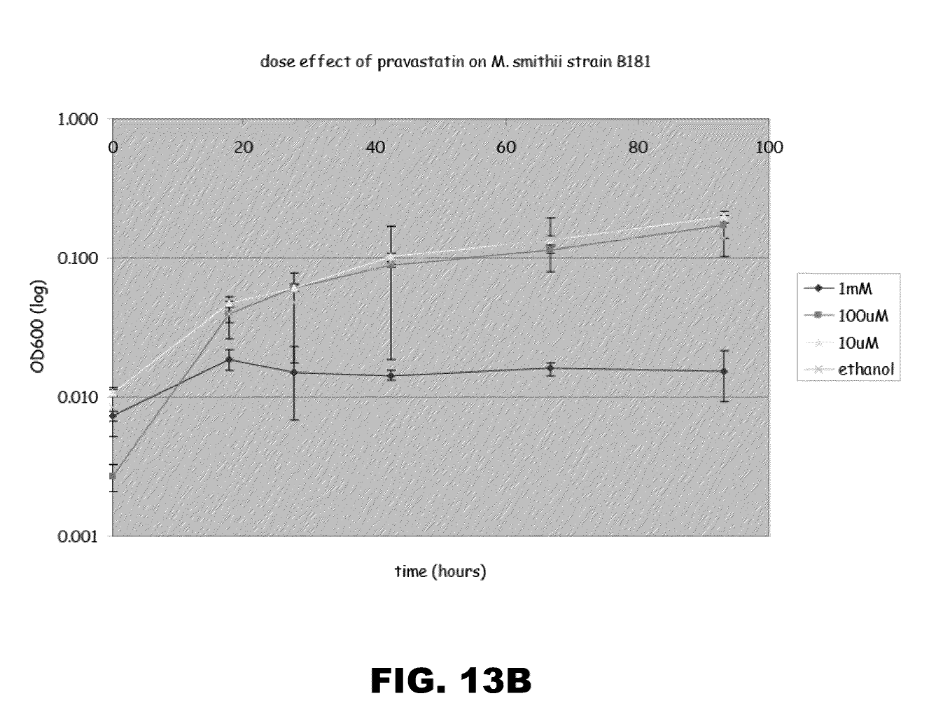

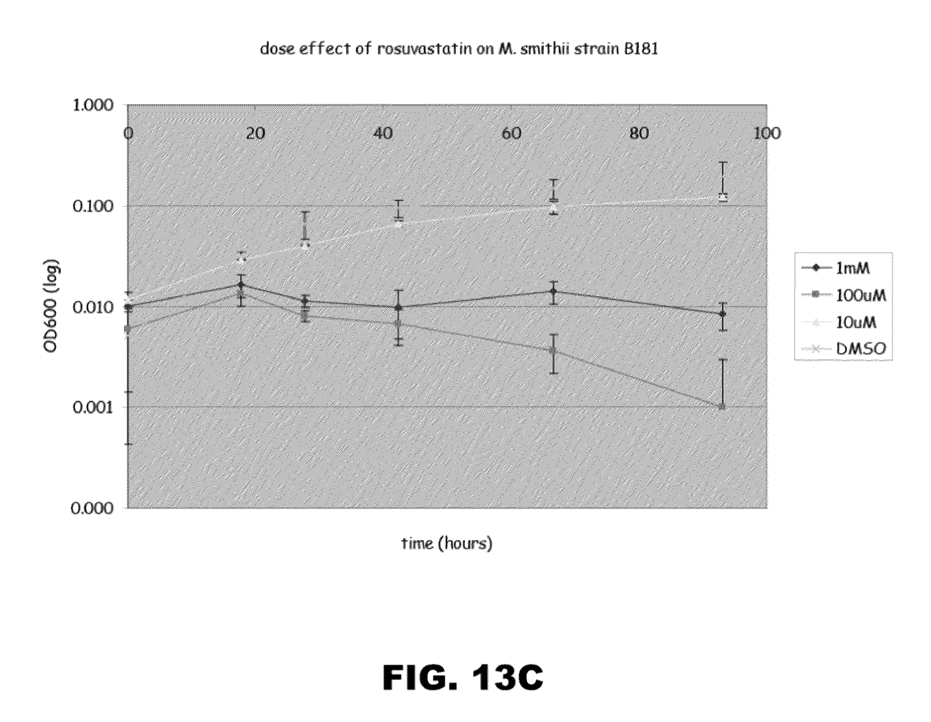

FIG. 13 depicts three graphs showing the dose effect of atorvastatin (A), pravastatin (B), and rosuvastatin (C) on M. smithii strain B181.

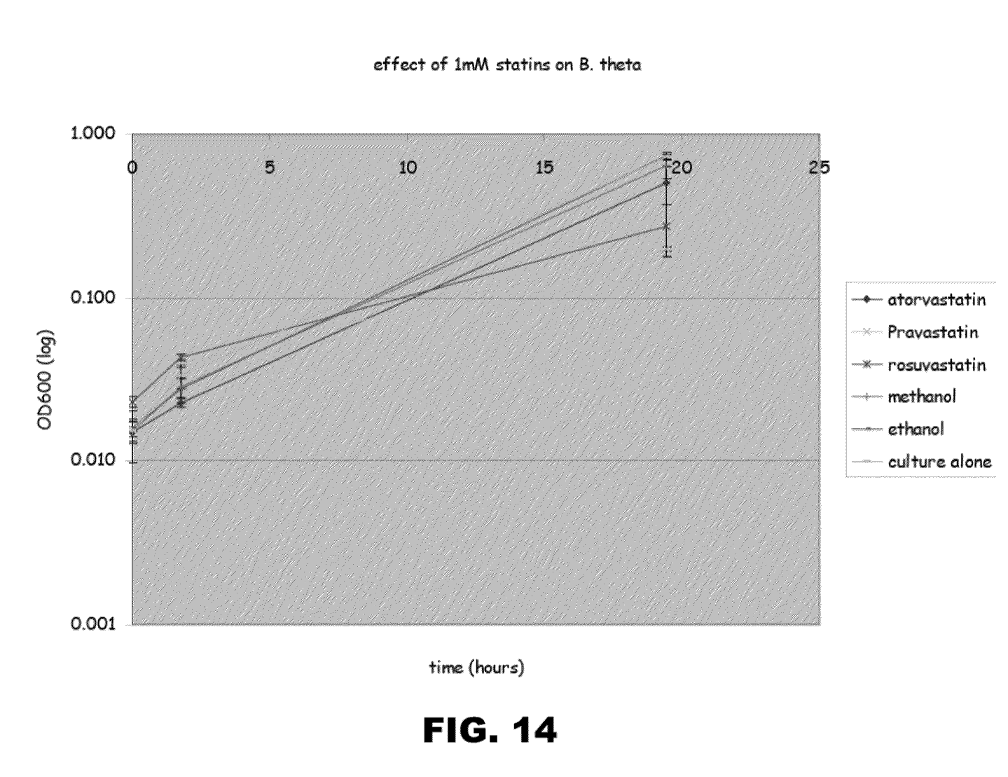

FIG. 14 depicts three graphs showing the effect of statins (concentration of 1 mM) on B. thetaiotaomicron.

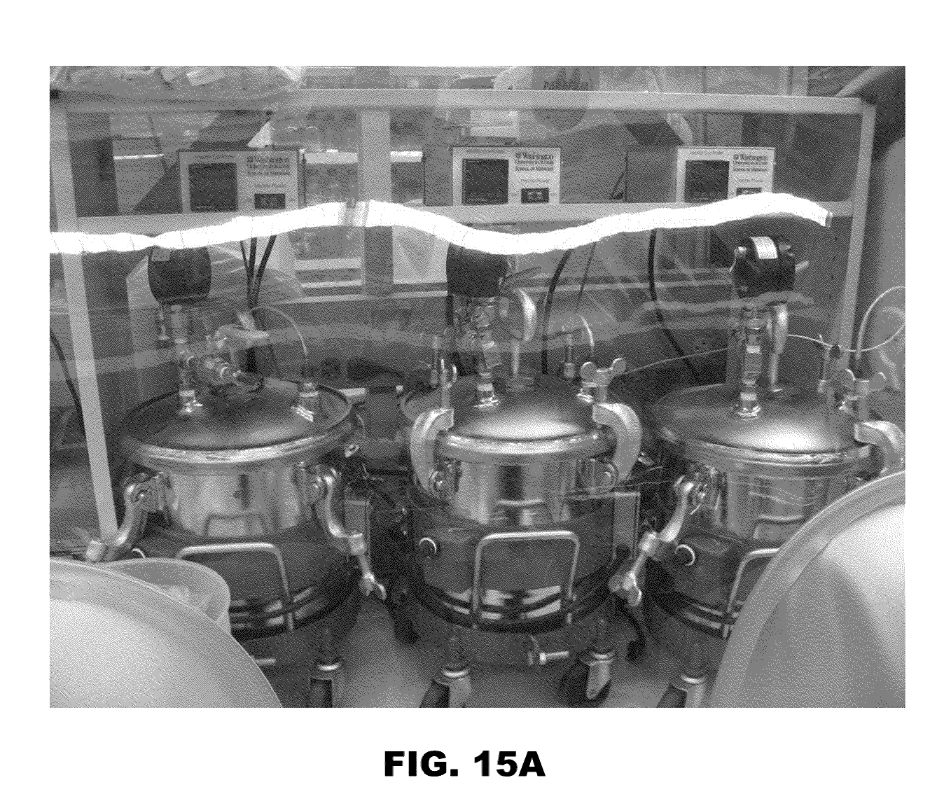

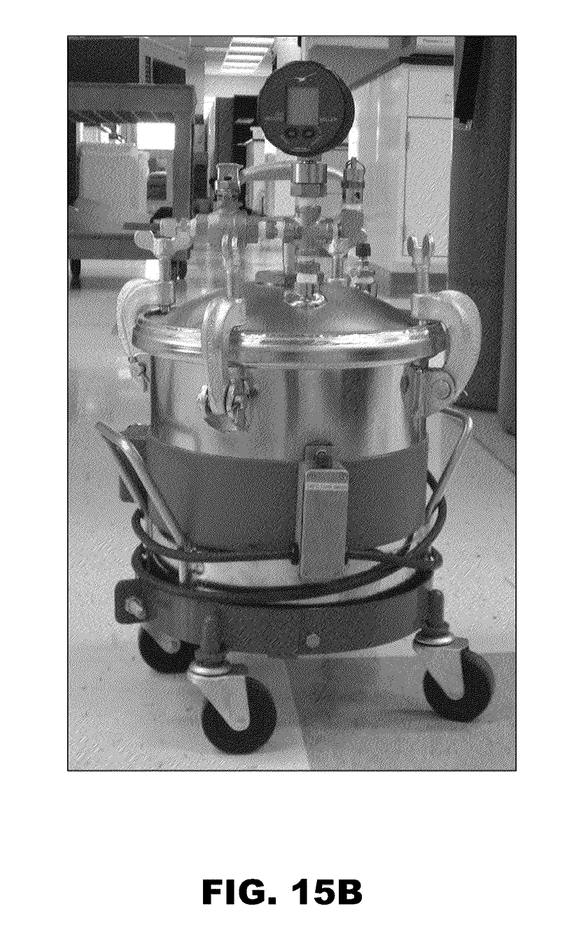

FIG. 15 depicts two photographs of the PHAT system described in the Examples. Panel A shows the pressurized incubation vessels within the anaerobic chamber, while Panel B shows an individual PHAT system outside of the chamber.

### DETAILED DESCRIPTION

The present invention provides arrays and methods utilizing the genome and proteome of the methanogen M. smithii, which is the predominant methanogen present in the human gastrointestinal tract. Modulating the Archaeal population of the gastrointestinal tract of a subject, of which M. smithii is a major component, modulates the efficiency and selectivity of carbohydrate metabolism. The genome and proteome of M. smithii may be used, according to the methods presented herein, to promote weight loss or weight gain in a subject. In particular, the methods of the present invention may be used to identify compounds that promote weight loss or weight gain in a subject. The method relies on applicants' discovery that certain M. smithii gene products are conserved between M. smithii strains, yet divergent (or absent) from the correlating gene products expressed by the subject's microbiome or genome. This allows the selection of compounds that specifically modulate the M. smithii gene product, while substantially not modulating the subject's gene product.

### I. Arrays

One aspect of the invention encompasses use of biomolecules in an array. As used herein, biomolecule refers to either nucleic acids derived from the M. smithii genome, or polypeptides derived from the M. smithii proteome. The M. smithii genome or proteome may be utilized to construct arrays that may be used for several applications, including discovery of compounds that modulate one or more M. smithii gene products, judging efficacy of existing weight gain or loss regimes, and for the identification of biomarkers involved in weight gain or loss, or a weight gain or loss related disorder.

The array may be comprised of a substrate having disposed thereon at least one biomolecule. Several substrates suitable for the construction of arrays are known in the art. The substrate may be a material that may be modified to contain discrete individual sites appropriate for the attachment or association of the biomolecule and is amenable to at least one detection method. Alternatively, the substrate may be a material that may be modified for the bulk attachment or association of the biomolecule and is amenable to at least one detection method. Non-limiting examples of substrate materials include glass, modified or functionalized glass, plastics (including acrylics, polystyrene and copolymers of styrene and other materials, polypropylene, polyethylene, polybutylene, polyurethanes, TeflonJ, etc.), nylon or nitrocellulose, polysaccharides, nylon, resins, silica or silica-based materials including silicon and modified silicon, carbon, metals, inorganic glasses and plastics. In an exemplary embodiment, the substrates may allow optical detection without appreciably fluorescing.

A substrate may be planar, a substrate may be a well, i.e. a 1534-, 384-, or 96-well plate, or alternatively, a substrate may be a bead. Additionally, the substrate may be the inner surface of a tube for flow-through sample analysis to minimize sample volume. Similarly, the substrate may be flexible, such as a flexible foam, including closed cell foams made of particular plastics. Other suitable substrates are known in the art.

The biomolecule or biomolecules may be attached to the substrate in a wide variety of ways, as will be appreciated by those in the art. The biomolecule may either be synthesized first, with subsequent attachment to the substrate, or may be directly synthesized on the substrate. The substrate and the biomolecule may both be derivatized with chemical functional groups for subsequent attachment of the two. For example, the substrate may be derivatized with a chemical functional group including, but not limited to, amino groups, carboxyl groups, oxo groups or thiol groups. Using these functional groups, the biomolecule may be attached using functional groups on the biomolecule either directly or indirectly using linkers.

The biomolecule may also be attached to the substrate non-covalently. For example, a biotinylated biomolecule can be prepared, which may bind to surfaces covalently coated with streptavidin, resulting in attachment. Alternatively, a biomolecule or biomolecules may be synthesized on the surface using techniques such as photopolymerization and photolithography. Additional methods of attaching biomolecules to arrays and methods of synthesizing biomolecules on substrates are well known in the art, i.e. VLSIPS technology from Affymetrix (e.g., see U.S. Pat. No. 6,566,495, and Rockett and Dix, Xenobiotica 30(2):155-177, each of which is hereby incorporated by reference in its entirety).

In one embodiment, the biomolecule or biomolecules attached to the substrate are located at a spatially defined address of the array. Arrays may comprise from about 1 to about several hundred thousand addresses. In one embodiment, the array may be comprised of less than 10,000 addresses. In another alternative embodiment, the array may be comprised of at least 10,000 addresses. In yet another alternative embodiment, the array may be comprised of less than 5,000 addresses. In still another alternative embodiment, the array may be comprised of at least 5,000 addresses. In a further embodiment, the array may be comprised of less than 500 addresses. In yet a further embodiment, the array may be comprised of at least 500 addresses.

A biomolecule may be represented more than once on a given array. In other words, more than one address of an array may be comprised of the same biomolecule. In some embodiments, two, three, or more than three addresses of the array may be comprised of the same biomolecule. In certain embodiments, the array may comprise control biomolecules and/or control addresses. The controls may be internal controls, positive controls, negative controls, or background controls.

The biomolecule may be a nucleic acid derived from the M. smithii genome (GenBank Accession number CP000678), comprising, in part, nucleic acid sequences labeled MSM001 through MSM1795, inclusive. Such nucleic acids may include RNA (including mRNA, tRNA, and rRNA), DNA, and naturally occurring or synthetically created derivatives. A nucleic acid derived from the M. smithii genome is a nucleic acid that comprises at least a portion of a nucleic acid sequence selected from the nucleic acid sequences listed in Table A. The nucleic acid may comprise fewer than 10, at least 10, at least 20, at least 30, at least 40, at least 50, at least 60, at least 70, at least 80, at least 90, at least 100, at least 150, at least 200, or more than 200 bases of a nucleic acid sequence selected from the nucleic acid sequences listed in Table A. One embodiment of the invention is an array comprising a substrate, the substrate having disposed thereon at least one nucleic acid, wherein the nucleic acid comprises a nucleic acid sequence selected from the nucleic acid sequences listed in Table A. In another embodiment, the nucleic acid consists of a nucleic acid sequence selected from the nucleic acid sequences listed in Table A. In certain embodiments, the nucleic acid comprises a nucleic acid sequence derived from a sequence in Table A marked by an asterick. The asterick marks sequences associated with a core gut-associated M. smithii genome.

In one embodiment, the nucleic acid or nucleic acids may be selected from the group of nucleic acids listed in Table A that are conserved among M. smithii strains, but divergent from a corresponding nucleic acid of the subject. In this context, a “corresponding nucleic acid” refers to a nucleic acid sequence of the subject, or the subject's micobiome, that has greater than 75% identity to a nucleic acid sequence of Table A. The term, “divergent,” as used herein, refers to a sequence of Table A that has less than 99% identity, but greater than 75% identity, with a nucleic acid sequence of the subject, or the subject's microbiome. For instance, in some embodiments, divergent refers to less than or equal to about 98%, 97%, 96%, 95%, 94%, 93%, 92%, 91%, 90%, 89%, 88%, 87%, 86%, 85%, 84%, 83%, 82%, 81%, 80%, 79%, 78%, 77%, or 76%, identity between the nucleic acid sequence of Table A and the nucleic acid sequence of the subject. Conversely, the term “conserved,” as used herein, refers to a nucleic acid sequence of one M. smithii strain that has greater than about 90% identity to a nucleic acid sequence from another M. smithii strain.

If a subject, or the subject's microbiome, does not comprise a nucleic acid sequence that has greater than 75% identity to a nucleic acid sequence of Table A, that nucleic acid sequence of Table A is “absent” from the subject. In certain embodiments, the nucleic acid or nucleic acids of the array of the invention are selected from the group comprising nucleic acid sequences that are absent from the subject gut microbiome or genome. For instance, in one embodiment, the nucleic acid may be selected from the group of nucleic acids designated absent or divergent in Table 2. Percent identity may be determined as discussed below.

Alternatively, the nucleic acid or nucleic acids derived from the M. smithii genome (Table A) may be selected from the group of nucleic acids comprising nucleic acid sequences that are expressed in vivo by M. smithii while residing in the gastrointestinal tract of a subject. In another embodiment, the nucleic acid or nucleic acids may be selected from the group of nucleic acids comprising nucleic acid sequences that are expressed by M. smithii while residing in the gastrointestinal tract of a subject, and whose expression levels are not affected by the presence of actively fermenting bacteria. In another embodiment, the nucleic acid or nucleic acids may be selected from the group of nucleic acids comprising nucleic acid sequences that are expressed by M. smithii while residing in the gastrointestinal tract of a subject, and whose expression levels are affected by the presence of actively fermenting bacteria. The in vivo expression levels of a nucleic acid may be determined by methods known in the art, including RT-PCR. In yet another embodiment, the nucleic acid or nucleic acids may be selected from the group of nucleic acids that encode the M. smithii transcriptome or metabolome.

The biomolecule may also be a polypeptide derived from the M. smithii proteome. A polypeptide derived from the M. smithii proteome is a polypeptide that is encoded by at least a portion of a nucleic acid sequence selected from the nucleic acid sequences listed in Table A. The polypeptide may comprise fewer than 10, at least 10, at least 20, at least 30, at least 40, at least 50, at least 60, at least 70, at least 80, at least 90, at least 100, at least 150, at least 200, or more than 200 amino acids encoded by a nucleic acid sequence selected from the nucleic acid sequences listed in Table A. One embodiment of the invention is an array comprising a substrate, the substrate having disposed thereon at least one polypeptide, wherein the polypeptide is encoded by a nucleic acid sequence selected from the nucleic acid sequences listed in Table A. In certain embodiments, a biomolecule may be an amino acid sequence derived from a sequence in Table A marked by an asterick. The asterick marks sequences associated with a core gut-associated M. smithii genome.

In one embodiment, the polypeptide or polypeptides may be selected from the group of polypeptides comprising polypeptide sequences that are conserved among M. smithii strains, but divergent from a corresponding polypeptide of the subject. The terms conserved and divergent are used as defined above. In certain embodiments, the polypeptide or polypeptides are selected from the group comprising polypeptides absent from the subject gut microbiome or genome. In another embodiment, the polypeptide or polypeptides may be selected from the group of polypeptides comprising polypeptide sequences with greater than about 75% but less than about 99% identity to a correlating polypeptide from the subject gut microbiome or genome. In yet another embodiment, the polypeptide or polypeptides may be selected from the group of polypeptides comprising polypeptide sequence with greater than about 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, or 98% identity to a correlating polypeptide from the subject gut microbiome or genome. In one embodiment, for instance, the polypeptide may be encoded by a nucleic acid designated absent or divergent in Table 2. Percent identity may be determined as discussed below.

Alternatively, the polypeptide or polypeptides derived from the M. smithii proteome (see Table A) may be encoded by a nucleic acid selected from the group of nucleic acids comprising nucleic acid sequences that are expressed in vivo by M. smithii while residing in the gastrointestinal tract of a subject. In another embodiment, the polypeptide or polypeptides may be encoded by a nucleic acid selected from the group of nucleic acids comprising nucleic acid sequences that are expressed by M. smithii while residing in the gastrointestinal tract of a subject, and whose expression levels are not affected by the presence of actively fermenting bacteria. In still another embodiment, the polypeptide or polypeptides may be encoded by a nucleic acid selected from the group of nucleic acids comprising nucleic acid sequences that are expressed by M. smithii while residing in the gastrointestinal tract of a subject, and whose expression levels are affected by the presence of actively fermenting bacteria. In yet another embodiment, the polypeptide or polypeptides may be encoded by a nucleic acid selected from the group of nucleic acids that encode the M. smithii transcriptome or metabolome.

The array may alternatively be comprised of biomolecules from the genome or proteome of M. smithii that are indicative of an obese subject microbiome. Alternatively, the array may be comprised of biomolecules from the genome or proteome of M. smithii that are indicative of a lean subject microbiome. A biomolecule is “indicative” of an obese or lean microbiome if it tends to appear more often in one type of microbiome compared to the other. Such differences may be quantified using commonly known statistical measures, such as binomial tests. An “indicative” biomolecule may be referred to as a “biomarker.”

Additionally, the array may be comprised of biomolecules from the genome or proteome of M. smithii that are modulated in the obese subject microbiome compared to the lean subject microbiome. As used herein, “modulated” may refer to a biomolecule whose representation or activity is different in an obese subject microbiome compared to a lean subject microbiome. For instance, modulated may refer to a biomolecule that is enriched, depleted, up-regulated, down-regulated, degraded, or stabilized in the obese subject microbiome compared to a lean subject microbiome. In one embodiment, the array may be comprised of a biomolecule enriched in the obese subject microbiome compared to the lean subject microbiome. In another embodiment, the array may be comprised of a biomolecule depleted in the obese subject microbiome compared to the lean subject microbiome. In yet another embodiment, the array may be comprised of a biomolecule up-regulated in the obese subject microbiome compared to the lean subject microbiome. In still another embodiment, the array may be comprised of a biomolecule down-regulated in the obese subject microbiome compared to the lean subject microbiome. In still yet another embodiment, the array may be comprised of a biomolecule degraded in the obese subject microbiome compared to the lean subject microbiome. In an alternative embodiment, the array may be comprised of a biomolecule stabilized in the obese subject microbiome compared to the lean subject microbiome.

Additionally, the biomolecule may be at least 80, 85, 90, or 95% homologous to a biomolecule derived from Table A. In one embodiment, the biomolecule may be at least 80, 81, 82, 83, 84, 85, 86, 87, 88, or 89% homologous to a biomolecule derived from Table A. In another embodiment, the biomolecule may be at least 90, 91, 92, 93, 94, 95, 96, 97, 98, 99, or 100% homologous to a biomolecule derived from Table A.

In certain embodiments, an array of the invention may comprise at least one, ten, a hundred, or a thousand different sequences listed in Table A, or amino acid sequences derived from the sequences listed in Table A. For instance, an array may comprise about 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, 1000, 1010, 1020, 1030, 1040, 1050, 1060, 1070, 1080, 1090, 1100, 1110, 1120, 1130, 1140, 1150, 1160, 1170, 1180, 1190, 1200, 1210, 1220, 1230, 1240, 1250, 1260, 1270, 1280, 1290, 1300, 1310, 1320, 1330, 1340, 1350, 1360, 1370, 1380, 1390, 1400, 1410, 1420, 1430, 1440, 1450, 1460, 1470, 1480, 1490, 1500, 1510, 1520, 1530, 1540, 1550, 1560, 1570, 1580, 1590, 1600, 1610, 1620, 1630, 1640, 1650, 1660, 1670, 1680, 1690, 1700, 1710, 1720, 1730, 1740, 1750, 1760, 1770, 1780, 1790, or about 1800 different nucleic acid sequences listed in Table A or amino acids derived from the sequences listed in Table A.

In determining whether a biomolecule is substantially homologous or shares a certain percentage of sequence identity with a sequence of the invention, sequence similarity may be determined by conventional algorithms, which typically allow introduction of a small number of gaps in order to achieve the best fit. In particular, “percent identity” of two polypeptides or two nucleic acid sequences is determined using the algorithm of Karlin and Altschul (Proc. Natl. Acad. Sci. USA 87:2264-2268, 1993). Such an algorithm is incorporated into the BLASTN and BLASTX programs of Altschul et al. (J. Mol. Biol. 215:403-410, 1990). BLAST nucleotide searches may be performed with the BLASTN program to obtain nucleotide sequences homologous to a nucleic acid molecule of the invention. Equally, BLAST protein searches may be performed with the BLASTX program to obtain amino acid sequences that are homologous to a polypeptide of the invention. To obtain gapped alignments for comparison purposes, Gapped BLAST is utilized as described in Altschul et al. (Nucleic Acids Res. 25:3389-3402, 1997). When utilizing BLAST and Gapped BLAST programs, the default parameters of the respective programs (e.g., BLASTX and BLASTN) are employed. See http://www.ncbi.nlm.nih.gov for more details.

Furthermore, the biomolecules used for the array may be labeled. One skilled in the art understands that the type of label selected depends in part on how the array is being used. Suitable labels may include fluorescent labels, chromagraphic labels, chemi-luminescent labels, FRET labels, etc. Such labels are well known in the art.

### II. Use of the Arrays

The arrays may be utilized in several suitable applications. For example, the arrays may be used in methods for detecting association between a biomolecule of the array and a compound in a sample. In this context, compound refers to a nucleic acid, a protein, a lipid, or chemical compound. In some embodiments, a compound may be an antibody. This method typically comprises incubating a sample with the array under conditions such that the compounds comprising the sample may associate with the biomolecules attached to the array. The association is then detected, using means commonly known in the art, such as fluorescence. “Association,” as used in this context, may refer to hybridization, covalent binding, ionic binding, hydrogen binding, van der Waals binding, and dated binding. A skilled artisan will appreciate that conditions under which association may occur will vary depending on the biomolecules, the compounds, the substrate, and the detection method utilized. As such, suitable conditions may have to be optimized for each individual array created.

In one embodiment, the array may be used as a tool in methods to determine whether a compound has efficacy for modulating a gene product of M. smithii. In certain embodiments, the array may be used as a tool in methods to determine whether a compound has efficacy for modulating a gene product of M. smithii while M. smithii is residing in the gastrointestinal tract of a subject. Typically, such a method comprises comparing a plurality of biomolecules from either the M. smithii genome or proteome before and after administration of a compound for modulating a gene product of M. smithii, such that if the abundance of a biomolecule that correlates with the gene product is modulated, the compound is efficacious in modulating a gene product of M. smithii. The array may also be used to quantitate the plurality of biomolecule's of M. smithii's genome or proteome before and after administration of a compound. The abundance of each biomolecule in the plurality may then be compared to determine if there is a decrease in the abundance of biomolecules associated with the compound. In other embodiments, the array may be used to quantify the levels of M. smithii in an obese subject prior to, during, or after treatment for obesity. Alternatively, the array may be used to quantify the levels of M. smithii in an underfed individual prior to, during, or after implementation of dietary recommendations designed to increase nutrient and energy harvest.

In a further embodiment, the array may be used as a tool in methods to determine whether a compound has efficacy for treatment of weight gain or a weight gain related disorder in a subject. Typically, such a method comprises comparing a plurality of biomolecules of M. smithii's genome or proteome before and after administration of a compound for the treatment of weight gain or a weight gain related disorder, such that if the abundance of biomolecules associated with weight gain decreased after treatment, the compound is efficacious in treating weight gain in a subject.

In still a further embodiment, the array may be used as a tool in methods to determine whether a compound has efficacy for treatment of weight loss or a weight loss related disorder in a subject. Typically, such a method comprises comparing a plurality of biomolecules of M. smithii's genome or proteome before and after administration of a compound for the treatment of weight loss or a weight loss related disorder, such that if the abundance of biomolecules associated with weight loss decreased after treatment, the compound is efficacious in treating weight loss in a subject.

In an alternative embodiment, a proteome array of the invention may be used to screen antibodies that bind to one or more sequences of the M. smithii proteome.

The present invention also encompasses M. smithii gene profiles. Generally speaking, a gene profile is comprised of a plurality of values with each value representing the abundance of a biomolecule derived from either the M. smithii genome or proteome. The abundance of a biomolecule may be determined, for instance, by sequencing the nucleic acids of the M. smithii genome as detailed in the examples. This sequencing data may then be analyzed by known software to determine the abundance of a biomolecule in the analyzed sample. An M. smithii gene profile may comprise biomolecules from more than one M. smithii strain. The abundance of a biomolecule may also be determined using an array described above. For instance, by detecting the association between compounds comprising an M. smithii derived sample and the biomolecules comprising the array, the abundance of M. smithii biomolecules in the sample may be determined.

A profile may be digitally-encoded on a computer-readable medium. The term “computer-readable medium” as used herein refers to any medium that participates in providing instructions to a processor for execution. Such a medium may take many forms, including but not limited to non-volatile media, volatile media, and transmission media. Non-volatile media may include, for example, optical or magnetic disks. Volatile media may include dynamic memory. Transmission media may include coaxial cables, copper wire and fiber optics. Transmission media may also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, or other magnetic medium, a CD-ROM, CDRW, DVD, or other optical medium, punch cards, paper tape, optical mark sheets, or other physical medium with patterns of holes or other optically recognizable indicia, a RAM, a PROM, and EPROM, a FLASH-EPROM, or other memory chip or cartridge, a carrier wave, or other medium from which a computer can read.

A particular profile may be coupled with additional data about that profile on a computer readable medium. For instance, a profile may be coupled with data about what therapeutics, compounds, or drugs may be efficacious for that profile. Conversely, a profile may be coupled with data about what therapeutics, compounds, or drugs may not be efficacious for that profile. Alternatively, a profile may be coupled with known risks associated with that profile. Non-limiting examples of the type of risks that might be coupled with a profile include disease or disorder risks associated with a profile. The computer readable medium may also comprise a database of at least two distinct profiles.

Profiles may be stored on a computer-readable medium such that software known in the art and detailed in the examples may be used to compare more than one profile.

Another aspect of the invention is a method for selecting a compound that has efficacy for modulating a gene product of M. smithii present in the gastrointestinal tract of a subject. The method generally comprises comparing an M. smithii gene profile to a gene profile of the subject and identifying a gene product of the M. smithii gene profile that is divergent from a corresponding gene product of the subject gene profile, or absent in the gene profile of the subject. Next the method comprises selecting a compound that modulates the M. smithii gene product, but does not substantially modulate the corresponding gene product of the subject. In a further embodiment, the compound also does not substantially modulate the corresponding gene product of an archaeon other than M. smithii, or a non-archaeal microbe, in the gastrointestinal tract of the subject. The compound may for instance, inhibit or promote the growth of M. smithii. The compound may also decrease or increase the efficiency of carbohydrate metabolism in the subject. Accordingly, the compound may also promote weight loss or weight gain in the subject.

Another further aspect of the invention is a method for selecting a compound that has efficacy for modulating a gene product of M. smithii present in the gastrointestinal tract of a subject. The method comprises comparing an M. smithii gene profile to a gene profile of the subject and identifying a gene product of the M. smithii gene profile that is divergent from a corresponding gene product of the subject gene profile, or absent in the gene profile of the subject. Next the method comprises selecting a compound that can be administered so as to modulate the M. smithii gene product, but not substantially modulate the corresponding gene product of the subject. In a further embodiment, the administered compound also does not substantially modulate the corresponding gene product of an archaeon other than M. smithii, or a non-archaeal microbe, in the gastrointestinal tract of the subject. The compound may be administered, for instance, so as to inhibit or promote the growth of M. smithii. The compound may also be administered so as to decrease or increase the efficiency of carbohydrate metabolism in the subject. Accordingly, the compound may also be administered so as to promote weight loss or weight gain in the subject.

The present invention also encompasses a kit for evaluating a compound, therapeutic, or drug. Typically, the kit comprises an array and a computer-readable medium. The array may comprise a substrate having disposed thereon at least one biomolecule that is derived from the M. smithii genome or proteome. In some embodiments, the array may comprise at least one biomolecule that is derived from the M. smithii metabolome or transcriptome. The computer-readable medium may have a plurality of digitally-encoded profiles wherein each profile of the plurality has a plurality of values, each value representing the abundance of a biomolecule derived from M. smithii detected by the array. The array may be used to determine a profile for a particular subject under particular conditions, and then the computer-readable medium may be used to determine if the profile is similar to known profile stored on the computer-readable medium. Non-limiting examples of possible known profiles include obese and lean profiles for several different subjects.

### III. Method of Promoting Weight Loss or Gain

A further aspect of the invention encompasses a method of promoting weight loss or gain. The method incorporates the discovery that modulating the Archaeon population of the gastrointestinal tract of a subject, of which M. smithii is a major component, modulates the efficiency and selectivity of carbohydrate metabolism. Furthermore, the method relies on applicants' discovery that certain M. smithii gene products are conserved among M. smithii strains, yet divergent (or absent) from the correlating gene products expressed by the subject's microbiome or genome. This divergence allows the selection of compounds to specifically modulate the M. smithii gene product, while substantially not modulating the subject's gene product, as described above.

By way of non-limiting example, weight loss may be promoted by administering an HMG-CoA reductase inhibitor to a subject. In an exemplary embodiment, the inhibitor will selectively inhibit the HMG-CoA reductase expressed by M. smithii and not the HMG-CoA reductase expressed by the subject. In another embodiment, a second HMG CoA-reductase inhibitor may be administered that selectively inhibits the HMG CoA-reductase expressed by the subject in lieu of the HMG-CoA reductase expressed by M. smithii. In yet another embodiment, an HMG-CoA reductase inhibitor that selectively inhibits the HMG-CoA reductase expressed by the subject may be administered in combination with an HMG-CoA reductase inhibitor that selectively inhibits the HMG-CoA reductase expressed by M. smithii. One means that may be utilized to achieve such selectivity is via the use of time-release formulations as discussed below. Compounds that inhibit HMG-CoA reductase are well known in the art. For instance, non-limiting examples include atorvastatin, pravastatin, rosuvastatin, and other statins.

### (a) Pharmaceutical Compositions

These compounds, for example HMG-CoA reductase inhibitors, may be formulated into pharmaceutical compositions and administered to subjects to promote weight loss. According to the present invention, a pharmaceutical composition includes, but is not limited to, pharmaceutically acceptable salts, esters, salts of such esters, or any other adduct or derivative which upon administration to a subject in need is capable of providing, directly or indirectly, a composition as otherwise described herein, or a metabolite or residue thereof, e.g., a prodrug.

The pharmaceutical compositions maybe administered by several different means that will deliver a therapeutically effective dose. Such compositions can be administered orally, parenterally, by inhalation spray, rectally, intradermally, intracisternally, intraperitoneally, transdermally, bucally, as an oral or nasal spray, or topically (i.e. powders, ointments or drops) in dosage unit formulations containing conventional nontoxic pharmaceutically acceptable carriers, adjuvants, and vehicles as desired. Topical administration may also involve the use of transdermal administration such as transdermal patches or iontophoresis devices. The term parenteral as used herein includes subcutaneous, intravenous, intramuscular, or intrasternal injection, or infusion techniques. In an exemplary embodiment, the pharmaceutical composition will be administered in an oral dosage form. Formulation of drugs is discussed in, for example, Hoover, John E., Remington's Pharmaceutical Sciences, Mack Publishing Co., Easton, Pa. (1975), and Liberman, H. A. and Lachman, L., Eds., Pharmaceutical Dosage Forms, Marcel Decker, New York, N.Y. (1980).

The amount of an HMG-CoA reductase inhibitor that constitutes an “effective amount” can and will vary. The amount will depend upon a variety of factors, including whether the administration is in single or multiple doses, and individual subject parameters including age, physical condition, size, and weight. Those skilled in the art will appreciate that dosages may also be determined with guidance from Goodman & Goldman's The Pharmacological Basis of Therapeutics, Ninth Edition (1996), Appendix II, pp. 1707-1711 and from Goodman & Goldman's The Pharmacological Basis of Therapeutics, Tenth Edition (2001), Appendix II, pp. 475-493.

### (b) Controlled Release Formulations

As described above, an HMG-CoA reductase inhibitor may be specific for the M. smithii enzyme, or for the subject's enzyme, depending, in part, on the selectivity of the particular inhibitor and the area the inhibitor is targeted for release in the subject. For example, an inhibitor may be targeted for release in the upper portion of the gastrointestinal tract of a subject to substantially inhibit the subject's enzyme. In contrast, the inhibitor may be targeted for release in the lower portion of the gastrointestinal tract of a subject, i.e., where M. smithii resides, then the inhibitor may substantially inhibit M. smithii's enzyme.

In order to selectively control the release of an inhibitor to a particular region of the gastrointestinal tract for release, the pharmaceutical compositions of the invention may be manufactured into one or several dosage forms for the controlled, sustained or timed release of one or more of the ingredients. In this context, typically one or more of the ingredients forming the pharmaceutical composition is microencapsulated or dry coated prior to being formulated into one of the above forms. By varying the amount and type of coating and its thickness, the timing and location of release of a given ingredient or several ingredients (in either the same dosage form, such as a multi-layered capsule, or different dosage forms) may be varied.

The coating can and will vary depending upon a variety of factors, including, the particular ingredient, and the purpose to be achieved by its encapsulation (e.g., time release). The coating material may be a biopolymer, a semi-synthetic polymer, or a mixture thereof. The microcapsule may comprise one coating layer or many coating layers, of which the layers may be of the same material or different materials. In one embodiment, the coating material may comprise a polysaccharide or a mixture of saccharides and glycoproteins extracted from a plant, fungus, or microbe. Non-limiting examples include corn starch, wheat starch, potato starch, tapioca starch, cellulose, hemicellulose, dextrans, maltodextrin, cyclodextrins, inulins, pectin, mannans, gum arabic, locust bean gum, mesquite gum, guar gum, gum karaya, gum ghatti, tragacanth gum, funori, carrageenans, agar, alginates, chitosans, or gellan gum. In another embodiment, the coating material may comprise a protein. Suitable proteins include, but are not limited to, gelatin, casein, collagen, whey proteins, soy proteins, rice protein, and corn proteins. In an alternate embodiment, the coating material may comprise a fat or oil, and in particular, a high temperature melting fat or oil. The fat or oil may be hydrogenated or partially hydrogenated, and preferably is derived from a plant. The fat or oil may comprise glycerides, free fatty acids, fatty acid esters, or a mixture thereof. In still another embodiment, the coating material may comprise an edible wax. Edible waxes may be derived from animals, insects, or plants. Non-limiting examples include beeswax, lanolin, bayberry wax, carnauba wax, and rice bran wax. The coating material may also comprise a mixture of biopolymers. As an example, the coating material may comprise a mixture of a polysaccharide and a fat.

In an exemplary embodiment, the coating may be an enteric coating. The enteric coating generally will provide for controlled release of the ingredient, such that drug release can be accomplished at some generally predictable location in the lower intestinal tract below the point at which drug release would occur without the enteric coating. In certain embodiments, multiple enteric coatings may be utilized. Multiple enteric coatings, in certain embodiments, may be selected to release the ingredient or combination of ingredients at various regions in the lower gastrointestinal tract and at various times.

The enteric coating is typically, although not necessarily, a polymeric material that is pH sensitive. A variety of anionic polymers exhibiting a pH-dependent solubility profile may be suitably used as an enteric coating in the practice of the present invention to achieve delivery of the active to the lower gastrointestinal tract. Suitable enteric coating materials include, but are not limited to: cellulosic polymers such as hydroxypropyl cellulose, hydroxyethyl cellulose, hydroxypropyl methyl cellulose, methyl cellulose, ethyl cellulose, cellulose acetate, cellulose acetate phthalate, cellulose acetate trimellitate, hydroxypropylmethyl cellulose phthalate, hydroxypropylmethyl cellulose succinate and carboxymethylcellulose sodium; acrylic acid polymers and copolymers, preferably formed from acrylic acid, methacrylic acid, methyl acrylate, ammonio methylacrylate, ethyl acrylate, methyl methacrylate and/or ethyl methacrylate (e.g., those copolymers sold under the trade name “Eudragit”); vinyl polymers and copolymers such as polyvinyl pyrrolidone, polyvinyl acetate, polyvinylacetate phthalate, vinylacetate crotonic acid copolymer, and ethylene-vinyl acetate copolymers; and shellac (purified lac). In one embodiment, the coating may comprise plant polysaccharides that can only be digested in the distal gut by the microbiota. For instance, a coating may comprise pectic galactans, polygalacturonates, arabinogalactans, arabinans, or rhamnogalacturonans. Combinations of different coating materials may also be used to coat a single capsule.

The thickness of a microcapsule coating may be an important factor in some instances. For example, the “coating weight,” or relative amount of coating material per dosage form, generally dictates the time interval between oral ingestion and drug release. As such, a coating utilized for time release of the ingredient or combination of ingredients into the gastrointestinal tract is typically applied to a sufficient thickness such that the entire coating does not dissolve in the gastrointestinal fluids at pH below about 5, but does dissolve at pH about 5 and above. The thickness of the coating is generally optimized to achieve release of the ingredient at approximately the desired time and location.

As will be appreciated by a skilled artisan, the encapsulation or coating method can and will vary depending upon the ingredients used to form the pharmaceutical composition and coating, and the desired physical characteristics of the microcapsules themselves. Additionally, more than one encapsulation method may be employed so as to create a multi-layered microcapsule, or the same encapsulation method may be employed sequentially so as to create a multi-layered microcapsule. Suitable methods of microencapsulation may include spray drying, spinning disk encapsulation (also known as rotational suspension separation encapsulation), supercritical fluid encapsulation, air suspension microencapsulation, fluidized bed encapsulation, spray cooling/chilling (including matrix encapsulation), extrusion encapsulation, centrifugal extrusion, coacervation, alginate beads, liposome encapsulation, inclusion encapsulation, colloidosome encapsulation, sol-gel microencapsulation, and other methods of microencapsulation known in the art. Detailed information concerning materials, equipment and processes for preparing coated dosage forms may be found in Pharmaceutical Dosage Forms: Tablets, eds. Lieberman et al. (New York: Marcel Dekker, Inc., 1989), and in Ansel et al., Pharmaceutical Dosage Forms and Drug Delivery Systems, 6^{th} Ed. (Media, Pa.: Williams & Wilkins, 1995).

### DEFINITIONS

The term “activity of the microbiota population” refers to the microbiome's ability to harvest energy.

An “effective amount” is a therapeutically-effective amount that is intended to qualify the amount of agent that will achieve the goal of modulating an M. smithii gene product, promoting weight loss, or promoting weight gain.

As used herein, “gene product” refers to a nucleic acid derived from a particular gene, or a polypeptide derived from a particular gene. For instance, a gene product may be a mRNA, tRNA, rRNA, cDNA, peptide, polypeptide, protein, or metabolite.

“Metabolome” as used herein is defined as the network of enzymes and their substrates and biochemical products, which operate within subject or microbial cells under various physiological conditions.

As used herein, the term “pharmaceutically acceptable salt” refers to those salts which are, within the scope of sound medical judgment, suitable for use in contact with the tissues of humans and other subjects without undue toxicity, irritation, allergic response and the like, and are commensurate with a reasonable benefit/risk ratio. Pharmaceutically acceptable salts are well known in the art. For example, S. M. Berge, et al. describe pharmaceutically acceptable salts in detail in J. Pharmaceutical Sciences, 66: 1 19 (1977), incorporated herein by reference. The salts can be prepared in situ during the final isolation and purification of the composition of the invention, or separately by reacting the free base function with a suitable organic acid. Non-limiting examples of pharmaceutically acceptable, nontoxic acid addition salts are salts of an amino group formed with inorganic acids such as hydrochloric acid, hydrobromic acid, hydroionic acid, nitric acid, carbonic acid, phosphoric acid, sulfuric acid and perchloric acid.

As used herein, the “subject” may be, generally speaking, an organism capable of supporting M. smithii in its gastrointestinal tract. For instance, the subject may be a rodent or a human. In one embodiment, the subject may be a rodent, i.e. a mouse, a rat, a guinea pig, etc. In an exemplary embodiment, the subject is human.

“Transcriptome” as used herein is defined as the network of genes that are being actively transcribed into mRNA in subject or microbial cells under various physiological conditions.

The phrase “weight gain related disorder” includes disorders resulting from, at least in part, obesity. Representative disorders include metabolic syndrome, type II diabetes, hypertension, cardiovascular disease, and nonalcoholic fatty liver disease. The phrase “weight loss related disorder” includes disorders resulting from, at least in part, weight loss. Representative disorders include malnutrition and cachexia.

As various changes could be made in the above compounds, products and methods without departing from the scope of the invention, it is intended that all matter contained in the above description and in the examples given below, shall be interpreted as illustrative and not in a limiting sense.

### EXAMPLES

The following examples illustrate various iterations of the invention.

### Materials and Methods for the Examples

### Genome Sequencing and Annotation

Methanobrevibacter smithii strain PS (ATCC 35061) was grown as described below for 6 d at 37° C. DNA was recovered from harvested cell pellets using the QIAGEN Genomic DNA Isolation kit with mutanolysin (1 unit/mg wet weight cell pellet; Sigma) added to facilitate lysis of the microbe. An ABI 3730xl instrument was used for paired end-sequencing of inserts in a plasmid library (average insert size 5 Kb; 42,823 reads; 11.6×-fold coverage), and a fosmid library (average insert size of 40 Kb; 7,913 reads; 0.6×-fold coverage). Phrap and PCAP (Huang et al. (2003) Genome Res 13:2164-70) were used to assemble the reads. A primer-walking approach was used to fill-in sequence gaps. Physical gaps and regions of poor quality (as defined by Consed; Gordon et al., (1998) Genome Res. 8, 195-202) were resolved by PCR-based re-sequencing. The assembly's integrity and accuracy was verified by clone constraints. Regions containing insufficient coverage or ambiguous assemblies were resolved by sequencing spanning fosmids. Sequence inversions were identified based on inconsistency of constraints for a fraction of read pairs in those regions. The final assembly consisted of 12.6× sequence coverage with a Phred base quality value 40. Open-reading frames (ORFs) were identified and annotated as described below.

### Biochemical Assays

Perchloric acid-, hydrochloric acid-, and alkali extracts of freeze dried cecal contents were prepared, and established pyridine nucleotide-linked microanalytic assays (Passonneau et al., (1993) Enzymatic Analysis:A practical guide) used to measure metabolites.

### Microbes and Culturing

All M. smithii strains [PS (ATCC 35061), ALI (DSMZ 2375), B181 (DSMZ 11975), and F1 (DSMZ 2374)] were cultivated in 125 ml serum bottles containing 15 ml MBC medium supplemented with 3 g/L formate, 3 g/L acetate, and 0.3 mL of a freshly prepared anaerobic solution of filter-sterilized 2.5% Na₂S (Samuel et al., (2006) PNAS 103:10011-6). The remaining volume in the bottle (headspace) contained a 4:1 mixture of H₂ and CO₂: the headspace was replenished every 1-2 d for a 6 d growth at 37° C.

M. smithii PS was also cultured in a BioFlor-110 batch fermentor with dual 1.5 L fermentation vessels (New Brunswick Scientific). Each vessel contained 750 ml of supplemented MBC medium. One hour prior to inoculation, 7.5 ml of sterile 2.5% Na₂S solution was added to the vessel, followed by one half of the contents of a serum bottle culture that had been harvested on day 5 of growth. Microbes were then incubated at 37° C. under a constant flow of H₂/CO₂ (4:1) (agitation setting, 250 rpm). One milliliter of a sterile solution of 2.5% Na₂S was added daily.

Colonization of Germ-Free Mice with M. smithii PS with and without B. thetaiotaomicron VPI-5482

Mice belonging to the NMRI/KI inbred strain (Bry et al., (1996) Science 273:1380-3) were housed in gnotobiotic isolators (Hooper et al., (2002) Mol Cell Micro 31:559-589) where they were maintained under a strict 12 h light cycle (lights on at 0600 h) and fed a standard, autoclaved, polysaccharide-rich chow diet (B&K Universal, East Yorkshire, UK) ad libitum. Each mouse was inoculated at age 8 weeks with a single gavage of 10⁸ microbes/strain [B. thetaiotaomicron was harvested from an overnight culture in TYG medium (Sonnenburg et al., Science 307:1955-9); M. smithii from serum bottles containing MBC medium after a 5 d incubation at 37° C. (Samuel et al., (2006) PNAS 103:10011-6)]. For a given experiment, the same preparation of cultured microbes was used for mono-association (single species added) and co-colonization (both species added).

Immediately after animals were sacrificed, cecal contents were recovered for preparation of DNA, RNA and biochemical studies (n=5 mice/treatment group/experiment; n=3 independent experiments). Colonization density was assessed using a qPCR-based assay employing species-specific primers, as described in Samuel et al., (2006) PNAS 103:10011-6.

### Genome Annotation

M. smithii genes were identified by comparing outputs from GLIMMER v.3.01 (Delcher et al., (1999) Nucleic Acids Res 27:4636-41), CRITICA v.1.05b (Badger et al., (1999) Mol Biol Evol 16:512-24), and GeneMarkS v.2.1 (Besemer et al. (2001) Nucleic Acids Res 29:2607-18). WUBLAST (http://blast.wustl.edu/) was then used to identify all ORFs with significant hits to the NR database (as of Dec. 1, 2006). ORFs containing <30 codons and without significant homology (e-value threshold of 10⁻⁵) to other proteins, were eliminated. rRNA and tRNA genes were identified using BLASTN and tRNA-Scan (Lowe et al., (1997) Nucleic Acids Res 25:955-64). Annotation of the predicted proteome of M. smithii was completed by using BLAST homology searches against public databases, and domain analysis with Pfam (http://pfam.janelia.org/) and InterProScan [release 12.1; (Apweiler et al., Nucleic Acids Res 29:37-40)]. Functional classifications were made based on GO terms assigned by InterProScan and homology searches against COGs (Tatusov et al., (2001) Nucleic Acids Res 29:22-8), followed by manual curation. Metabolic pathways were constructed based on KEGG (Kanehisa et al., (2004) Nucleic Acids Res 32:D277-80) and MetaCyc [(Caspi et al., (2006) Nucleic Acids Res 34:D511-6); http://metacyc.org/)]. Glycosyltransferases (GT) were categorized according to CAZy [http://www.cazy.org; (Coutinho et al., (1999) Recent Advances in Carbohydrate Bioengineering p. 3-12)]. Putative prophage genes were identified using two independent approaches: (i) BLASTN of predicted M. smithii ORFs against a database of all known phage sequences (http://phage.sdsu.edu/phage); and (ii) Hidden Markov Model (HMM)-based analysis using Phage_Finder (Fouts (2006) Nucleic Acids Res 34:5839-51).

### Comparative Genomic Analyses

GO term assignments—The number of genes in each archaeal genome that were assigned to each GO term, or to its parents in the GO hierarchy [version available on Jun. 6, 2006; (Ashburner et al., (2000) Nat Genet 25:25-9)] were totaled. All terms assigned to at least five genes in a given genome were then subjected to statistical tests for overrepresentation, and all terms with a total of five genes across all tested genomes for under-representation, using a binomial comparison reference set (see Table 6). Genes that could not be assigned to a GO category were excluded from the reference sets. A false discovery rate of <0.05 was set for each comparison (Benjamini et al., (1995) J of the Royal Statistical Society B 57:289-300). All tests were implemented using the Math::CDF Perl module (E. Callahan, Environmental Statistics, Fountain City, Wis.; available at http://www.cpan.org/), and scripts written in Perl.

Percent identity comparisons—The M. smithii PS genome sequence was compared to the M. stadtmanae genome (Fricke et al., (2006) J Bacteriol 188:642-58) and a 78 Mb metagenomic dataset of the human fecal microbiome (Gill et al., (2006) Science 312:1355-9) using NUCmer (part of MUMmer v.3.19 package; (Kurtz et al., Genome Biol 5:R12), and a percent identity plot was generated using Mummerplot.

Genomic synteny—Comparisons of synteny between M. smithii and M. stadtmanae were completed using the Artemis Comparison Tool (Carver et al., (2005) Bioinformatics 21:3422-3) set to tBLASTX and the most stringent confidence level.

M. smithii interaction network analyses—All M. smithii COGs were submitted to the STRING database (http://string.embl.de/; (von Mering et al., (2003) Nucleic Acids Res 31:258-61) to create predicted interaction networks (0.95 confidence interval). The program Medusa (Hooper et al., (2005) Bioinformatics 21:4432-3) was then used to organize the networks and color the nodes based on their conservation in M. smithii's proteome (mutual best BLASTP hits with e-values <10⁻²⁰ to the other Methanobacteriales genomes).

Clustering of adhesin-like proteins—M. smithii and M. stadtmanae ALPs were first aligned using CLUSTALW (v.1.83; (Chenna et al., (2003) Nucleic Acids Res 31:3497-500)). To retain the highest level of discrimination between the proteins, the alignment was subsequently converted into a nucleotide alignment using PAL2NAL (Suyama et al., (2006) Nucleic Acids Res 34:W609-12). The resulting alignment was used to create a maximum likelihood tree with RAxML [Randomized accelerated maximum likelihood for high performance computing [RAxML-VI-HPC, v2.2.1; (Stamatakis (2006) Bioinformatics 22:2688-90)] first using the GTR+CAT approximation method for rapid generation of tree topology, followed by the GTR+gamma evolutionary model for determination of likelihood values. ModelTest (v3.7; http://darwin.uvigo.es/software/modeltest.html) also identified GTR+gamma as the most appropriate evolutionary model for the dataset. Bootstrap values were determined from 100 neighbor-joining trees in Paup (v. 4.0b10, http://paup.csit.fsu.edu/). Tree visualization was completed with TreeView (Page (1996) Comput Appl Biosci 12:357-8).

Functional Genomic Analysis of M. smithii Gene Expression in Gnotobiotic Mice

RNA isolation—100-300 mg aliquots of frozen cecal contents from each gnotobiotic mouse was added to 2 ml tubes containing 250 μl of 212-300 μm-diameter acid-washed glass beads (Sigma), 500 μl of buffer A (200 mM NaCl, 20 mM EDTA), 210 μl of 20% SDS, and 500 μl of a mixture of phenol:chloroform:isoamyl alcohol (125:24:1; pH 4.5; Ambion). Samples were lysed using a bead beater (BioSpec; ‘high’ setting for 5 min at room temperature) and cellular debris was pelleted by centrifugation (10,000×g at 4° C. for 3 min). The extraction was repeated by adding another 500 μL of phenol:chloroform:isoamyl alcohol to the aqueous supernatant. RNA was precipitated from the pooled aqueous phases, resuspended in 100 μl nuclease-free water (Ambion), 350 μl Buffer RLT (QIAGEN) was added, and RNA further purified using the RNeasy mini kit (QIAGEN).

Analysis of the Production of Sialic Acid-Like Molecules by M. smithii

Reverse-phase HPLC analysis of cellular extracts—M. smithii was cultured in MBC medium, in a batch fermenter, to stationary phase (6 d incubation). Cells were collected by centrifugation, washed three times in PBS, snap frozen in liquid nitrogen, and stored at −80° C. Sialic acid content was assayed using established protocols (Manzi et al., (1995) Current Protocols in Molecular Biology)). Briefly, sialic acids were liberated by homogenization of the cell pellet (−30-50 mg wet weight) in 0.5 ml of 2M acetic acid with subsequent incubation of the homogenate for 3 h at 80° C. Samples were filtered through Microcon 10 filters (Millipore) and the filtrate, containing free sialic acid, was dried (speed-vacuum). The released sialic acid was derivatized with DMB (1,2-diamino-4,5-methylene-dioxybenzene) to yield a fluorescent adduct, which was analyzed by C18 reverse phase high-pressure liquid chromatography (RP-HPLC; Dionex DX-600 workstation). Sialic acid-like molecules were quantified by comparison to known amounts of derivatized standards [N-acetylneuraminic acid (Neu5Ac) and Nglycolylneuraminic acid (Neu5Gc)], and blanks (buffer alone).

Histochemical studies—M. smithii strains PS and F1 were grown in MBC as above. Bacteroides thetaiotaomicron VPI-5482, and Bifidobacterium longum NCC2705 were grown under anaerobic conditions in TYG medium to stationary phase and used as negative controls. Escherichia coli strain K92 (ATCC 35860), which is known to produce sialic acid (Egan et al., (1977) Biochemistry 16:3687-92), was incubated in 1419 medium (ATCC) to stationary phase and used as a positive control. All strains were fixed in 1.5 ml conical plastic tubes in either 4% paraformaldehyde or 100% ethanol for at least 8 h at 4° C. Samples were then washed with PBS and stored at −20° C. in 50% ethanol, 20 mM Tris and 0.1% IGEPAL CA-630 (Sigma; prepared in deionized water) until assayed. Samples were diluted in deionized water, placed on coated glass slides (Cel-Line/Erie Scientific Co.), air-dried, dehydrated in graded ethanols (50%, 80%, 100%), treated with blocking buffer (0.3% Triton X-100, 1% BSA in PBS; 30 min at room temperature), and then incubated with 10 μg/ml fluorescein-labeled Sambucus nigra lectin (SNA; Vector Laboratories; specificity, Neu5Acα2,6Gal/GalNAc epitopes) for 1 h at room temperature. Slides were subsequently washed with PBS, stained with 4′,6-diamidino-2-phenylindole (DAPI, 2 μg/ml; 5 min at room temperature), washed with de-ionized water, and mounted in PBS/glycerol. Slides were visualized with an Olympus BX41 microscope and photographed using a Q Imaging QICAM camera and OpenLab software (Improvision, Inc., v.3.1.5).

Transmission Electron Microscopy (TEM) of M. smithii.

Cells were harvested at day 6 of growth in the batch fermentor, and cellular morphology was defined by TEM using methods identical to those described previously for B. thetaiotaomicron (Sonnenburg et al., (2005) Science 307:1955-9). TEM studies of M. smithii present in the ceca of gnotobiotic mice that had been colonized for 14 d with the archaeon were conducted using the same protocol.

Microanalytic Biochemical Analyses of Cecal Samples Recovered from Gnotobiotic Mice

Extraction of metabolites from cecal contents—For measurement of ammonia and urea levels, perchloric acid extracts were prepared from 2 mg of freeze-dried cecal contents. [Contents were collected with a 10 μl inoculation loop, quick frozen in liquid nitrogen, and lyophilized at −35° C.] The lyophilized sample was homogenized in 0.2 ml of 0.3M perchloric acid at 1° C.

For the remaining metabolites, alkali and acid extracts were prepared from 4 mg of dried cecal samples that were homogenized in 0.4 ml 0.2M NaOH at 1° C. For the alkali extract, an 80 μl aliquot was removed, heated for 20 min at 80° C. and then neutralized with 80 μl of 0.25M HCl and 100 mM Tris base. For the acid extract, a 60 μl aliquot was removed and added to 20 μl 0.7M HCl, heated for 20 min at 80° C., and then neutralized with 40 μl 100 mM Tris base. Protein content was determined in the alkali extracts using the Bradford method (Bio Rad).

Metabolite assays—The sample concentrations for ammonium and urea were high enough so that direct fluorometric measurements could be used for detection. However, to measure the low sample concentrations for asparagine, glutamate, glutamine, α-ketoglutarate and ethanol, protocols were adapted from previously established pyridine nucleotide-linked assays, an “oil well” technique, and enzymatic cycling amplification (Passonneau et al., (1993) Enzymatic Analysis:A Practical Guide). All chemicals and enzymes were from Sigma unless otherwise noted.

Ammonium and Urea: For measurement of ammonium, a 20 μl aliquot of a perchloric acid extract of a given sample of cecal contents was added to 1 ml of a solution containing 50 mM imidazole HCl (pH 7.0), 0.2 mM α-ketoglutarate, 0.5 mM EDTA, 0.02% BSA, 10 μM NADH, and 10 μg/ml beef liver glutamate dehydrogenase (in glycerol; specific activity, 40 units/mg protein). Following a 40 min incubation at 24° C., fluorescence was measured using a Ratio-3 system filter fluorometer (Farrand Optical Components and Instruments, Valhalla, N.Y.; excitation at 360 nm; emission at 460 nm). Sample blanks were run that lacked added glutamate dehydrogenase. Ammonium acetate standards were carried throughout all steps.

To measure urea concentrations, 2 μl of a 50 mg/ml solution of Jack bean urease (50 units/mg) was added to the same sample used to determine ammonium levels. Following a 40 min incubation at 24° C., urea levels were defined based on a further reduction in fluorescence. Control sample blanks lacked added urease. Reference urea standards were carried throughout all steps.

Asparagine: A 0.5 μl aliquot of the alkali extract of a given sample of cecal contents was added to 0.5 μl of a solution containing 50 mM Trizma HCl (pH 8.7), 0.04% BSA, and 4 μg/ml E. coli asparaginase (160 units/mg protein). Sample blanks lacked added asparaginase. After a 30 min incubation at 24° C., 2 μl of a solution containing 50 mM Trizma HCl (pH 8.1), 10 μM α-ketoglutarate, 10 μM NADH, 4 mM freshly prepared ascorbic acid, 10 μg/ml of pig heart glutamic-oxalacetic transaminase (220 units/mg protein), plus 5 μg/ml beef heart malic dehydrogenase (2800 units/mg protein) was added, and the resulting mixture was incubated for 30 min at 24° C. One microliter of 0.25M HCl was then introduced. After a 10 min incubation at 24° C., a 2 μl aliquot of the reaction mixture was transferred to 0.1 ml of NAD cycling reagent for 20,000 cycles of amplification and the amplified product measured according to methods described by Passonneau and Lowry ((1993) Enzymatic Analysis:A Practical Guide). Sample blanks lacked added asparaginase. Reference asparagine standards were carried throughout all steps.

Glutamate and Glutamine: A 0.1 μl aliquot from an acid extract of a given sample of cecal contents was added to 0.1 μl of reagent containing 100 mM Na acetate (pH 4.9), 20 mM HCl, 0.4 mM EDTA and 50 μg/ml E. coli glutaminase (780 units/mg protein). Another 0.1 μl aliquot of the cecal contents was added to the same reagent in a parallel reaction that lacked added glutaminase (to measure glutamate alone). Following a 60 min incubation at 24° C., 2 μl of a solution containing 50 mM Tris acetate (pH 8.5), 0.1 mM NAD+, 0.1 mM ADP and 50 μg/ml beef liver glutamate dehydrogenase (120 units/mg protein; Roche) was added to both reaction mixtures, which were subsequently incubated for 30 min at 24° C. The reactions were terminated by addition of 1 μl of 0.2M NaOH and then heated for 20 min at 80° C. A 2 μl aliquot was subsequently transferred to 0.1 ml NAD cycling reagent and subjected to 20,000 cycles of amplification. Reference glutamine and glutamate standards were carried throughout all steps.

α-Ketoglutarate—A 0.5 μl aliquot from an given alkali extract was added to 0.5 μl of reagent containing 100 mM imidazole acetate (pH 6.5), 0.04% BSA, 50 mM ammonium acetate, 0.2 mM ADP, 4 mM ascorbic acid (freshly prepared), 40 μM NADH and 20 μg/ml beef liver glutamate dehydrogenase (120 units/mg protein; Roche). Following a 30 min incubation at 24° C., the reaction was terminated by adding 0.5 μl of 0.2M HCl. A 1 μl aliquot was transferred to 0.1 ml NAD cycling reagent and subjected to 30,000 cycles of amplification. α-Ketoglutarate standards were carried throughout all steps.

Ethanol: A 0.5 μl aliquot of an acid extract from cecal contents was added to 0.5 μl of a solution consisting of 5 mM Tris HCl (pH 8.1), 0.04% BSA, 0.1 mM NAD+, and 20 μg/ml yeast alcohol dehydrogenase (350 units/mg protein). Following a 60 min incubation at 24° C., 1 μl of 0.15M NaOH was added and the mixture heated for 20 min at 80° C. A 0.5 μl aliquot of this reaction mixture was transferred to 0.1 ml of NAD cycling reagent and amplified 5000-fold. Ethanol standards were carried throughout all steps.

Whole Genome Genotyping with Custom M. smithii GeneChips

GeneChips were manufactured by Affymetrix (http://www.affymetrix.com), based on the sequence of the PS strain genome (see Table 12 for details of the GeneChip design). Duplicate cultures of M. smithii strains PS (ATCC 35061), F1 (DSMZ 2374), ALI (DSMZ 2375) and B181 (DSMZ 11975), were grown in 125 ml serum bottles as described above. Genomic DNA was prepared from each strain using the QIAGEN Genomic DNA Isolation kit: mutanolysin (Sigma; 2.5 U/mg wet wt. cell pellet) was added to facilitate lysis of the microbes. DNA (5-7 μg) was further purified by phenolchloroform extraction and then sheared by sonication to <200 bp, labeled with biotin (Enzo BioArray Terminal Labeling Kit), denatured at 95° C. for 5 min, and hybridized to replicate GeneChips using standard Affymetrix protocols (http://www.affymetrix.com). M. smithii genes represented on the GeneChip were called “Present” or “Absent” by DNA-Chip Analyzer v1.3 (dChip; www.biostat.harvard.edu/complab/dchip/) using modeled (PM/MM ratio) data.

### Statistical Analysis

Pairwise comparisons were made using unpaired Student's t-test. One-way ANOVA, followed by Tukey's post hoc multiple comparison test, was used to determine the statistical significance of differences observed between three groups.

### Development of PHAT (Pressurized Heated Anaerobic Tank) System

A system for culturing M. smithii in 96-well plate format was designed and constructed in the following manner (See FIG. 15). Three stainless steel paint canisters (Binks, 83S-210, 2 gallon size) were modified for incubation of plates at 37° C. in an oxygen-free gas mix of 20% CO₂/80% H₂ at a pressure of 30 psi, where all of these growth parameters can be monitored and recorded.

The canisters are heated using Electro-Flex Heat brand Pail Heaters controlled by a custom designed controller consisting of a 16A2120 temperature/process control (Love Controls), an RTD (resistance temperature detector) probe to measure internal tank temperature, and several safety features to prevent overheating or burns.

The system is pressurized with oxygen-free gas that has flowed through a custom-built oxygen scrub. Commercially available gas mixes used for culturing M. smithii contain trace levels of oxygen that would kill the organism: thus, the gas mixture must be passed through an oxygen scrub. This scrub consists of a glass tube filled with copper mesh that is heated to 350° C. with heating tape (HTS/Amptek Duo-Tape), controlled by a benchtop power controller (HTS/Amptek BT-Z). The oxygen scrub is covered with insulating tape and secured behind a heat resistant polyetherimide case. Pressure in each tank is measured and recorded with a digital manometer (LEO record, Omni Instruments).

The system is housed inside an anaerobic chamber (COY laboratories) to allow inspection and manipulation of cultures and plates without exposing M. smithii to oxygen. Each tank can house 30 standard volume 96-well plates, which can be analyzed inside the COY anaerobic chamber with a microplate reader (BioRad) that monitors growth by measuring optical density.

### Statin Susceptibility

Stock solutions (100×) of atorvastatin were prepared in methanol, pravastatin in ethanol, and rosuvastatin in DMSO (dimethyl sulfoxide) to concentrations of 100 mM, 10 mM and 1 mM. 1.5 μl of the stock solutions were added to wells in 96-well plates and transferred to the COY anaerobic chamber where they were kept for at least 24 hours to become anaerobic. 150 microliters of actively growing Methanobrevibacter smithii cultures were then added to each well (excluding medium+drug blanks) to bring the drug concentrations to 1 mM, 100 μM and 10 μM, respectively. The plates were incubated in the newly developed pressurized heated anaerobic tank system in a 4:1 mixture of oxygen-scrubbed H₂ and CO₂ at a pressure of 30 psi. Cultures grown in 1% ethanol, methanol and DMSO were used as controls. Growth was measured by determining optical density at 600 nm using the BioRad microplate reader (model 680).

Starting cultures of M. smithii strains [DSMZ 861 (PS), 2374 (F1), 2375 (ALI) and 11975 (B181)] were grown in 96 well plates in 150 μl volume/well of Methanobrevibacter complex medium (MBC) supplemented with 3 g/liter formate, 3 g/liter acetate, and 33 ml/liter of 2.5% Na₂S (added just before use). Each condition was tested in triplicate with the average measurement plotted.

### Example 1

### M. smithii Genome Description

The 1,853,160 base pair (bp) genome of the M. smithii type strain PS contains 1,795 predicted protein coding genes (Tables 1-4), 34 tRNAs, and two rRNA clusters. Some observations on the genome itself are as follows:

Elements that Affect Genome Evolution

The M. smithii PS genome contains multiple elements that can influence genome evolution, including 30 transposases, an integrated prophage (−38 kb; MSM1640-92), eight insertion sequence (IS) elements, 16 genes involved in DNA repair, 9 restriction-modification (R-M) system subunits, and four predicted integrases (Table 4).

Several lytic phages have been reported to infect M. smithii, including a 69 kb linear phage known as PG that belongs to the ψM1-like viruses (Prangishvili et al. (2006) Virus Res 117:52-67), and another 35 kb phage (PMS11; Calendar (2005) The Bacteriophages). The PG phage is AT-rich, heavily nicked, and lytic (burst size, 30-90), with a latent period of 3-4 h (Bertani et al. (1985) EMBO Workshop on Molecular Genetics of Archaebacteria and the International Workshop on Biology and Biochemistry of Archaebacteria, pg. 398). BLAST comparisons of the 52 predicted genes in the integrated prophage of M. smithii PS against known phage genes revealed only a few homologs (Table 13). One of the prophage genes (MSM1691) encodes a pseudomurein endoisopeptidase (PeiW): this enzyme may function to cleave M. smithii's cell wall and contribute to autolysis, as related enzymes in a defective Methanothermobacter wolfeii prophage have been shown to do (Luo et al., FEMS Microbiology Letters 208:47-51). The specific ends of the prophage genome could not be identified, and further studies are needed to determine whether the prophage is active and lytic.

The eight insertion sequence (IS) elements in M. smithii's genome (Table 4) range in length from 137 by (MSM1519) to 1013 by (MSM0527) and all are ISM1 (family ISNCY) according to ISfinder (Siguier et al., (2006) Nucleic Acids Res 34:D32-6; http://www-is.biotoul.fr/). ISM1 is a mobile IS element (Hamilton and Reeve (1985) Molecular Genetics and Genomics 200:47-59). IS elements promote genome evolution and plasticity through recombination, gene loss and, potentially, lateral gene transfer (Brugger et al., (2002) FEMS Microbiol Lett 206:131-41).

### Transcriptional Regulation

M. smithii PS contains 60 predicted transcriptional regulators, including homologs of known nutrient sensors [e.g., a HypF family member (maturation of hydrogenases), a PhoU family member (phosphate metabolism), and a NikR family member (nickel)], plus five regulators of amino acid metabolism (Table 3). However, several GO categories related to environmental sensing and regulation (e.g., two-component systems; GO:0000160) are significantly depleted in its proteome compared to the proteomes of methanogens that live in terrestrial or aquatic environments (Table 6). In contrast, B. thetaiotaomicron, which uses complex, structurally diversified glycans as its principal nutrient source, possesses a large and diverse arsenal of nutrient sensors including 32 hybrid two-component systems plus 50 ECF-type sigma factors and 25 anti-sigma factors (Sonnenburg et al, (2006) PNAS 103:8834-9; Xu et al., (2003) Science 299:2074-6). This relative paucity of nutrient sensors may reflect the fact that M. smithii's niche is restricted, and its nutrient substrates are relatively small, readily diffusible molecules that may not require extensive machinery for their recognition.

### Bile Acid Detoxification

In humans, cholic and chenodeoxycholic acids are synthesized in the liver and during their enterohepatic circulation undergo transformation by the intestinal microbiota to an array of metabolites (Hylemon and Harder (1998) FEMS Microbiol Rev 22:475-88). Bile acids and their metabolites have microbicidal activity and a genetically engineered deficiency of the bile acid-activated nuclear receptor FXR leads to reduced bile acid pools and bacterial overgrowth (Inagaki et al., (2006) PNAS 103:3920-5). Both M. smithii and M. stadtmanae encode a sodium:bile acid symporter (MSM1078), a conjugated bile acid hydrolase (CBAH; MSM0986), a short chain dehydrogenase with homology to a 7α-hydroxysteroid dehydrogenase (MSM0021). This is consistent with in vitro studies of M. smithii that demonstrate it is not inhibited by 0.1% deoxycholic acid (Miller et al, (1982) Appl Environ Microbiol 43:227-32).

We compared the proteome of M. smithii with the proteomes of (i) Methanosphaera stadtmanae, a methanogenic Euryarchaeote that is a minor and inconsistent member of the human gut microbiota (Eckburg et al., (2005) Science 308:1635-38), (ii) nine ‘non-gut methanogens’ recovered from microbial communities in the environment, and (iii) these non-gut methanogens plus an additional 17 sequenced Archaea (‘all archaea’) (Table 5).

Compared to non-gut methanogens and/or all archaea, M. smithii and M. stadtmanae are significantly enriched (binomial test, p<0.01) for genes assigned to GO (gene ontology) categories involved in surface variation (e.g., cell wall organization and biogenesis, see below), defense (e.g., multi-drug efflux/transport), and processing of bacteria-derived metabolites (Tables 6 and 7).

The M. smithii and M. stadtmanae genomes exhibit limited global synteny (FIG. 4) but share 968 proteins with mutual best BLAST hit e-values ≦10-20 (46% of all M. smithii proteins; Table 8). A predicted interaction network of M. smithii clusters of orthologous groups (COGs) based on STRING, a database of predicted functional associations between proteins (von Mering et al., (2003) Nucleic Acids Res 31:258-61), shows that it contains more COGs for persistence, improved metabolic versatility, and machinery for genomic evolution compared to M. stadtmanae (FIG. 5 and Table 9).

### Cell Surface Variation

The ability to vary capsular polysaccharide surface structures in vivo by altering expression of glycosyltransferases (GTs) is a feature shared among sequenced bacterial species that are prominent in the distal human gut microbiota (Sonnenburg et al., (2005) Science 307:1955-59; Sonnenburg et al., (2006) PNAS 103:8834-39; Mazmanian et al., (2005) Cell 122:107-118; Coyne et al., (2005) Science 307:1778-81). Transmission EM studies of M. smithii harvested from gnotobiotic mice after a 14 day colonization revealed that it too has a prominent capsule (FIG. 1A). The proteomes of both human gut methanogens also contain an arsenal of GTs [26 in M. smithii and 31 in M. stadtmanae; see Table 10 for a complete list organized based on the Carbohydrate Active enZyme (CAZy) classification scheme (http://www.cazy.org; (Coutinho et al., (1999) Recent Advances in Carbohydrate Bioengineering)]. Unlike the sequenced Bacteroidetes, which possess large repertoires of glycoside hydrolases (GH) and carbohydrate esterases (CE) not represented in the human ‘glycobiome’, neither gut methanogen has any detectable GH or CE family members (FIG. 1B). Both M. smithii and M. stadtmanae dedicate a significantly larger proportion of their ‘glycobiome’ to GT2 family glycosyltransferases than any of the sequenced nongut associated methanogens (binomial test; p<0.00005; FIG. 1B). These GT2 family enzymes have diverse predicted activities, including synthesis of hyaluronan, a component of human glycosaminoglycans in the mucosal layer.

Sialic acids are a family of nine-carbon sugars that are abundantly represented in human mucus- and epithelial cell surface-associated glycans (Vimr et al., (2004) Microbiol Mol Biol Rev 68:132-53). N-acetylneuraminic acid (Neu5Ac) is the predominant type of sialic acid found in our species. Unique among sequenced archaea, M. smithii has a cluster of genes (MSM1535-1540) that encode all enzymes necessary for de novo synthesis of sialic acid from UDP-N-acetylglucosamine (i.e. UDP-GlcNAc epimerase, Neu5Ac synthase, CMP-Neu5Ac synthetase, and a putative polysialtransferase) (FIG. 1C). Biochemical analysis of extracts prepared from cultured M. smithii, plus histochemical staining of the microbe with the sialic-acid specific lectin, Sambucus nigra 1 agglutinin (SNA), confirmed the presence of a molecular species that co-elutes with a sialic acid standard in this analytic HPLC system (FIG. 6A-C). Taken together, our findings indicate that M. smithii has developed mechanisms to decorate its surface with carbohydrate moieties that mimic those encountered in the glycan landscape of its intestinal habitat.

The genomes of both human gut methanogens also encode a novel class of predicted surface proteins that have features similar to bacterial adhesins (48 members in M. smithii and 37 in M. stadtmanae). A phylogenetic analysis indicated that each methanogen has a specific clade of these Adhesin-Like Proteins (ALPs; FIG. 7). A subset of the M. smithii ALPs has homology to pectin esterases (GO:0030599): this GO family, which is significantly enriched in this compared to other Archaea based on the binomial test (p<0.0005; Table 6), is associated with binding of chondroitin, a major component of mucosal glycosaminoglycans. Several other M. smithii ALPs have domains predicted to bind other sugar moieties (e.g. galactose-containing-glycans; FIG. 7A). Both methanogens also have ALPs with peptidase-like domains (see Table 11 for a complete list of InterPro domains).

### Example 2

### Methanogenic and Non-Methanogenic Removal of Bacterial End-Products of Fermentation

Compared to other sequenced non-gut associated methanogens, M. smithii has significant enrichment of genes involved in utilization of CO₂, H₂ and formate for methanogenesis (GO:0015948; Table 6). They include genes that encode proteins involved in synthesis of vitamin cofactors used by enzymes in the methanogenesis pathway [methyl group carriers (F₄₃₀ and corrinoids); riboflavin (precursor for F₄₃₀ biosynthesis); and coenzyme M synthase (involved in the terminal step of methanogenesis)] (see Table 7 for a list of these genes, and FIG. 2A for the metabolic pathways). M. smithii also has an intact pathway for molybdopterin biosynthesis to allow for CO₂ utilization (FIG. 8). M. smithii also upregulates a formate utilization gene cluster (FdhCAB; MSM1403-5) for methanogenic consumption of this B. thetaiotaomicron-produced metabolite (Samuel and Gordon (2006) PNAS 103:10011-10016).

Our previous qRT-PCR and mass spectrometry studies revealed that co-colonization increased B. thetaiotaomicron acetate production [acetate kinase (BT3963) 9-fold upregulated vs. B. thetaiotaomicron-mono-associated controls; P<0.0005; n=4-5 animals/group (Samuel and Gordon (2006) PNAS 103:10011-10016)]. Although acetate is not converted to methane by M. smithii (Miller et al., (1982) Appl. Environ. Microbiol. 43:227-32), we found that its proteome contains an ‘incomplete reductive TCA cycle’ that would allow it to assimilate acetate [Acs (acetyl-CoA synthase, MSM0330), Por (pyruvate:ferredoxin oxidoreductase, MSM0560), Pyc (pyruvate carboxylase, MSM0765), Mdh (malate dehydrogenase, MSM1040), Fum (fumarate hydratase, MSM0477, MSM0563, MSM0769, MSM0929), Sdh (succinate dehydrogenase, MSM1258), Suc (succinyl-CoA synthetase, MSM0228, MSM0924), and Kor (2-oxoglutarate synthase, MSM0925-8) in FIG. 2A]. Two important M. smithii genes associated with this pathway participate in acetate assimilation: Por (pyruvate:ferredoxin oxidoreductase) as well as Cab (carbonic anhydrase, MSM0654), which converts CO₂ to bicarbonate, the substrate for Por.

M. smithii also possesses enzymes that in other methanogens facilitate utilization of two other products of bacterial fermentation, methanol and ethanol (Fricke et al, J Bacteriol 188:642-58; Berk et al., (1997) Arch Microbiol 168:396-402). M. smithii's genome contains a methanol:cobalamin methyltransferase (MtaB, MSM0515), an NADP-dependent alcohol dehydrogenase (Adh, MSM1381), and an F₄₂₀-dependent NADP reductase (Fno, MSM0049) [see FIG. 2A for pathway information]. Biochemical studies confirmed a significant decrease in ethanol levels in the ceca of co-colonized mice [11±2.5 μmol/g total protein in cecal contents versus 35±10 μmol/g and 15 μmol/g in B. thetaiotaomicron and M. smithii mono-associated animals respectively; p<0.05; FIG. 2B]. Expression of B. thetaiotaomicron's alcohol dehydrogenases (BT4512 and BT0535) is not altered by co-colonization (Samuel and Gordon (2006) PNAS 103:10011-10016), indicating that the reduction in cecal ethanol levels observed in co-colonized mice is not due to diminished bacterial production but rather to increased archaeal consumption.

Collectively, these findings indicate that M. smithii supports methanogenic and non-methanogenic removal of diverse bacterial end-products of fermentation: this capacity may endow it with a great flexibility to form syntrophic relationships with a broad range of bacterial members of the distal human gut microbiota.

### Example 3

### M. smithii Utilization of Ammonia as a Primary Nitrogen Source

Subject metabolism of amino acids by glutaminases associated with the intestinal mucosa (Wallace (1996) J Nutr 126:1326 S), or deamination of amino acids during bacterial degradation of dietary proteins yields ammonia (Cabello et al., (2004) Microbiology 150:3527-46). The M. smithii proteome contains a transporter for ammonium (AmtB; MSM0234) plus two routes for its assimilation: (i) the ATP—utilizing glutamine synthetase—glutamate synthase pathway which has a high affinity for ammonium and thus is advantageous under nitrogen-limited conditions; and (ii) the ATP-independent glutamate dehydrogenase pathway which has a lower affinity for ammonium (Dumitru et al., (2003) Appl. Environ. Microbiol. 69:7236-41).

Microanalytic biochemical assays revealed a ratio of glutamine to 2-oxoglutarate concentration that was 15-fold lower in the ceca of co-colonized gnotobiotic mice compared to animals colonized with M. smithii alone, and 2-fold lower compared to B. thetaiotaomicron mono-associated subjects (p<0.0001; FIG. 2C). In addition, levels of several polar amino acids were also significantly reduced in mice with the saccharolytic bacterium and methanogen (FIG. 2D), providing additional evidence for a nitrogen-limited gut environment. The key M. smithii genes involved in ammonia assimilation, particularly those in the high affinity glutamine synthetase-glutamate synthase pathway are GlnA (glutamine synthetase, MSM1418) and GltA/GltB (two subunits of glutamate synthase, MSM0027, MSM0368); FIG. 2A. GeneChip analysis of the transcriptional responses of B. thetaiotaomicron to co-colonization with M. smithii indicated that it also upregulates a high affinity glutamine synthase [BT4339; 2.4-fold vs. B. thetaiotaomicron monoassociated mice; n=4-5 mice/group; p<0.001; (Samuel et al., (2006) PNAS 103:10011-10016)]. This prioritization of ammonium assimilation by B. thetaiotaomicron and M. smithii is accompanied by a modest but not statistically significant decrease in cecal ammonium levels in co-colonized subjects (13.4±1.8 μmol/g dry weight of cecal contents vs. 142.45±1.0 in M. smithii- and 14.4±0.9 in B. thetaiotaomicron-monoassociated animals; n=5-15/group; FIG. 2E). Together, these studies indicate that ammonium represents a source of nitrogen for M. smithii when it exists in isolation in the gut of gnotobiotic mice, and that it may compete with B. thetaiotaomicron for this nutrient resource.

### Example 4

### Considering Targets for Development of Anti-M. smithii Agents

Manipulation of the representation of M. smithii in our gut microbiota could provide a novel means for treating obesity. Functional genomics studies in gnotobiotic mice illustrate one way to approach the issue. For example, inhibitors exist for several M. smithii enzymes. A class of N-substituted derivatives of para-aminobenzoic acid (pABA) interfere with methanogenesis by competitively inhibiting ribofuranosylaminobenzene 5′-phosphate synthase [RfaS; MSM0848; (Dumitru et al., (2003) Appl. Environ. Microbiol. 69:7236-41)].

Archaeal membrane lipids, unlike bacterial lipids, contain ether-linkages. A key enzyme in the biosynthesis of archaeal lipids is hydroxymethylglutaryl (HMG)-CoA reductase (MSM0227), which catalyzes the formation of mevalonate, a precursor for membrane (isoprenoid) biosynthesis (23). HMG-CoA reductase inhibitors (statins) inhibit growth of Methanobrevibacter species in vitro (23).

We designed a custom GeneChip containing probesets directed against 99.1% of M. smithii's 1795 known and predicted protein-coding genes (see Table 12 for details). This GeneChip was used to perform whole genome genotyping of M. smithii PS (control) plus three other strains recovered from the feces of healthy humans: F1 (DSMZ 2374), ALI (DSMZ 2375) and B181 (DSMZ 11975). Replicate hybridizations indicated that 100% of the open reading frames (ORFs) represented on the GeneChip were detected in M. smithii PS, while 90-94% were detected in the other strains, including the potential drug targets mentioned above (Table 2 and FIG. 3). Approximately 50% of the undetectable ORFs in each strain encode hypothetical proteins. The other undetectable genes are involved in genome evolution [e.g., recombinases, transposases, IS elements, and type II restriction modification (R-M) systems], or are components of a putative archaeal prophage in strain PS, or are related to surface variation, including several ALPs (e.g., MSM0057 and MSM1585-90; FIG. 7). Strains F1 and ALI also appear to lack redundant gene clusters encoding subunits of formate dehydrogenase (MSM1462-3) and methyl-CoM reductase (MSM0902-3) that are found in the PS strain (the latter cluster is also undetectable in strain B181). In addition, the only methanol utilization cluster present in the PS strain (MSM1515-8) was not detectable in strain F1 (Table 2).

To further assess the degree of nucleotide sequence divergence among M. smithii strains, we compared the sequenced PS type strain to a 78 Mb metagenomic dataset generated from the aggregate fecal microbial community genome (microbiome) of two healthy humans (Gill et al., (2006) Science 312:1355-59). Their sequenced microbiomes contained 92% of the ORFs in the type strain (Table 2), including the potential drug targets described above. Several R-M system gene clusters (MSM0157-8, MSM1743, MSM1746-7), a number of transposases, a DNA repair gene cluster (MSM0689-95), and all ORFs in the prophage were not evident in the two microbiomes. Sequence divergence was also observed in 33 of the 48 ALP genes plus two ‘surface variation’ gene clusters (MSM1289-1398 and MSM1590-1616) that encode 11 glycosyltransferases and 9 proteins involved in pseudomurein cell wall biosynthesis (FIG. 9). A redundant methyl-CoM reductase cluster (MSM0902-3), an F₄₂₀-dependent NADP oxidoreductase (MSM0049) involved in consumption of bacteria-derived ethanol, and two subunits of the bicarbonate ABC transporter (MSM0990-1; carbon utilization) exhibited heterogeneity in the M. smithii populations present in the gut microbiota of these two adults (Table 2 and FIG. 9).

In yet another type of analysis, we compared the sequenced genome of M. smithii strain PS to the sequenced genomes of 11 other strains, isolated from the fecal microbiota of a pair of adult female monozygotic twins and two other unrelated individuals. The results, summarized in Table A, reveal a set of 1436 genes that are represented in all of these human isolates as well as the PS type strain. These genes, which include the gene encoding HMG-CoA reductase, comprise a human gut-associated M. smithii “core” genome.

### Example 5

### Effect of HMG-CoA Reductase Inhibitors Administration

The PHAT system was used to culture 4 strains of M. smithii (DSMZ 861 (PS), 2374 (F1), 2375 (ALI) and 11975 (B181)) in 96-well plate format, and to test their sensitivities to various HMG-CoA reductase inhibitors. Preliminary results indicate that atorvastatin (Lipitor®), pravastatin (Pravachol®) and rosuvastatin (Crestor®) inhibit all strains tested at concentrations of 1 millimolar. Atorvastatin and rosuvastatin also inhibit all strains at 100 micromolar concentrations (FIG. 10-13; Tables 14-17). None of these three statins had any affect on the growth of a dominant human gut-associated saccharolytic bacterium, Bacteroides thetaiotaomicron (FIG. 14).

TABLE A

| | | | | |
|---|---|---|---|---|
| MSM0001* | MSM0002* | MSM0003* | MSM0004* | MSM0005* |
| MSM0006* | MSM0007 | MSM0008* | MSM0009 | MSM0010* |
| MSM0011 | MSM0012 | MSM0013 | MSM0014 | MSM0015* |
| MSM0016 | MSM0017 | MSM0018 | MSM0019 | MSM0020* |
| MSM0021 | MSM0022 | MSM0023* | MSM0024* | MSM0025* |
| MSM0026* | MSM0027 | MSM0028 | MSM0029 | MSM0030 |
| MSM0031 | MSM0032* | MSM0033* | MSM0034* | MSM0035* |
| MSM0036* | MSM0037* | MSM0038* | MSM0039 | MSM0040 |
| MSM0041 | MSM0042 | MSM0043* | MSM0044* | MSM0045* |
| MSM0046 | MSM0047 | MSM0048* | MSM0049* | MSM0050 |
| MSM0051* | MSM0052* | MSM0053* | MSM0054* | MSM0055* |
| MSM0056* | MSM0057* | MSM0058* | MSM0059* | MSM0060* |
| MSM0061 | MSM0062 | MSM0063 | MSM0064* | MSM0065 |
| MSM0066* | MSM0067* | MSM0068* | MSM0069* | MSM0070* |
| MSM0071* | MSM0072* | MSM0073* | MSM0074* | MSM0075 |
| MSM0076* | MSM0077 | MSM0078* | MSM0079* | MSM0080* |
| MSM0081* | MSM0082* | MSM0083* | MSM0084 | MSM0085* |
| MSM0086* | MSM0087* | MSM0088* | MSM0089* | MSM0090* |
| MSM0091* | MSM0092* | MSM0093 | MSM0094* | MSM0095* |
| MSM0096* | MSM0097 | MSM0098* | MSM0099 | MSM0100* |
| MSM0101* | MSM0102* | MSM0103* | MSM0104* | MSM0105* |
| MSM0106* | MSM0107* | MSM0108 | MSM0109* | MSM0110* |
| MSM0111* | MSM0112 | MSM0113 | MSM0114* | MSM0115* |
| MSM0116* | MSM0117* | MSM0118* | MSM0119* | MSM0120* |
| MSM0121* | MSM0122* | MSM0123 | MSM0124 | MSM0125 |
| MSM0126 | MSM0127* | MSM0128* | MSM0129* | MSM0130* |
| MSM0131* | MSM0132* | MSM0133* | MSM0134* | MSM0135* |
| MSM0136* | MSM0137* | MSM0138* | MSM0139* | MSM0140* |
| MSM0141* | MSM0142* | MSM0143* | MSM0144* | MSM0145* |
| MSM0146* | MSM0147* | MSM0148* | MSM0149* | MSM0150* |
| MSM0151* | MSM0152* | MSM0153* | MSM0154* | MSM0155* |
| MSM0156* | MSM0157* | MSM0158* | MSM0159* | MSM0160 |
| MSM0161* | MSM0162* | MSM0163* | MSM0164* | MSM0165 |
| MSM0166* | MSM0167* | MSM0168* | MSM0169 | MSM0170* |
| MSM0171* | MSM0172* | MSM0173* | MSM0174* | MSM0175* |
| MSM0176* | MSM0177* | MSM0178* | MSM0179* | MSM0180* |
| MSM0181* | MSM0182* | MSM0183* | MSM0184* | MSM0185* |
| MSM0186* | MSM0187* | MSM0188 | MSM0189 | MSM0190* |
| MSM0191* | MSM0192* | MSM0193* | MSM0194* | MSM0195* |
| MSM0196* | MSM0197* | MSM0198* | MSM0199* | MSM0200* |
| MSM0201* | MSM0202* | MSM0203 | MSM0204* | MSM0205* |
| MSM0206* | MSM0207* | MSM0208* | MSM0209 | MSM0210* |
| MSM0211* | MSM0212* | MSM0213* | MSM0214 | MSM0215* |
| MSM0216* | MSM0217* | MSM0218* | MSM0219* | MSM0220* |
| MSM0221* | MSM0222 | MSM0223* | MSM0224* | MSM0225* |
| MSM0226 | MSM0227* | MSM0228 | MSM0229* | MSM0230* |
| MSM0231* | MSM0232* | MSM0233* | MSM0234 | MSM0235 |
| MSM0236* | MSM0237* | MSM0238* | MSM0239* | MSM0240 |
| MSM0241* | MSM0242* | MSM0243* | MSM0244* | MSM0245* |
| MSM0246* | MSM0247* | MSM0248* | MSM0249* | MSM0250* |
| MSM0251* | MSM0252* | MSM0253* | MSM0254* | MSM0255* |
| MSM0256* | MSM0257* | MSM0258 | MSM0259* | MSM0260* |
| MSM0261* | MSM0262* | MSM0263* | MSM0264* | MSM0265* |
| MSM0266* | MSM0267* | MSM0268* | MSM0269* | MSM0270* |
| MSM0271* | MSM0272* | MSM0273* | MSM0274* | MSM0275* |
| MSM0276* | MSM0277* | MSM0278* | MSM0279* | MSM0280* |
| MSM0281* | MSM0282* | MSM0283* | MSM0284* | MSM0285 |
| MSM0286 | MSM0287* | MSM0288* | MSM0289* | MSM0290* |
| MSM0291* | MSM0292* | MSM0293* | MSM0294* | MSM0295* |
| MSM0296* | MSM0297* | MSM0298* | MSM0299* | MSM0300* |
| MSM0301* | MSM0302 | MSM0303* | MSM0304* | MSM0305* |
| MSM0306* | MSM0307* | MSM0308* | MSM0309* | MSM0310* |
| MSM0311* | MSM0312* | MSM0313* | MSM0314* | MSM0315* |
| MSM0316* | MSM0317* | MSM0318* | MSM0319* | MSM0320* |
| MSM0321 | MSM0322* | MSM0323* | MSM0324* | MSM0325* |
| MSM0326* | MSM0327* | MSM0328* | MSM0329* | MSM0330* |
| MSM0331* | MSM0332* | MSM0333* | MSM0334* | MSM0335* |
| MSM0336* | MSM0337* | MSM0338* | MSM0339* | MSM0340* |
| MSM0341 | MSM0342* | MSM0343* | MSM0344* | MSM0345* |
| MSM0346* | MSM0347* | MSM0348* | MSM0349* | MSM0350* |
| MSM0351 | MSM0352* | MSM0353 | MSM0354* | MSM0355* |
| MSM0356 | MSM0357* | MSM0358* | MSM0359* | MSM0360 |
| MSM0361* | MSM0362* | MSM0363* | MSM0364* | MSM0365* |
| MSM0366* | MSM0367* | MSM0368* | MSM0369* | MSM0370* |
| MSM0371* | MSM0372* | MSM0373* | MSM0374* | MSM0375* |
| MSM0376* | MSM0377 | MSM0378* | MSM0379* | MSM0380 |
| MSM0381 | MSM0382* | MSM0383* | MSM0384* | MSM0385* |
| MSM0386* | MSM0387 | MSM0388* | MSM0389* | MSM0390* |
| MSM0391* | MSM0392 | MSM0393* | MSM0394* | MSM0395* |
| MSM0396* | MSM0397* | MSM0398* | MSM0399 | MSM0400* |
| MSM0401* | MSM0402* | MSM0403* | MSM0404* | MSM0405* |
| MSM0406* | MSM0407* | MSM0408* | MSM0409* | MSM0410* |
| MSM0411* | MSM0412* | MSM0413* | MSM0414* | MSM0415* |
| MSM0416* | MSM0417* | MSM0418* | MSM0419 | MSM0420* |
| MSM0421* | MSM0422* | MSM0423 | MSM0424* | MSM0425 |
| MSM0426* | MSM0427* | MSM0428* | MSM0429* | MSM0430* |
| MSM0431* | MSM0432 | MSM0433* | MSM0434* | MSM0435* |
| MSM0436* | MSM0437 | MSM0438* | MSM0439* | MSM0440* |
| MSM0441* | MSM0442* | MSM0443* | MSM0444* | MSM0445* |
| MSM0446* | MSM0447 | MSM0448* | MSM0449* | MSM0450* |
| MSM0451* | MSM0452* | MSM0453* | MSM0454* | MSM0455* |
| MSM0456* | MSM0457* | MSM0458* | MSM0459* | MSM0460* |
| MSM0461 | MSM0462* | MSM0463* | MSM0464* | MSM0465* |
| MSM0466* | MSM0467* | MSM0468* | MSM0469* | MSM0470* |
| MSM0471* | MSM0472* | MSM0473* | MSM0474* | MSM0475* |
| MSM0476* | MSM0477* | MSM0478* | MSM0479* | MSM0480* |
| MSM0481* | MSM0482* | MSM0483* | MSM0484* | MSM0485* |
| MSM0486* | MSM0487* | MSM0488* | MSM0489* | MSM0490 |
| MSM0491* | MSM0492* | MSM0493* | MSM0494 | MSM0495* |
| MSM0496* | MSM0497* | MSM0498 | MSM0499 | MSM0500* |
| MSM0501* | MSM0502* | MSM0503* | MSM0504* | MSM0505* |
| MSM0506* | MSM0507* | MSM0508* | MSM0509* | MSM0510* |
| MSM0511* | MSM0512* | MSM0513* | MSM0514* | MSM0515* |
| MSM0516* | MSM0517* | MSM0518 | MSM0519* | MSM0520* |
| MSM0521* | MSM0522* | MSM0523* | MSM0524* | MSM0525* |
| MSM0526* | MSM0527* | MSM0528* | MSM0529* | MSM0530* |
| MSM0531* | MSM0532* | MSM0533* | MSM0534 | MSM0535* |
| MSM0536* | MSM0537 | MSM0538* | MSM0539* | MSM0540* |
| MSM0541 | MSM0542* | MSM0543* | MSM0544* | MSM0545* |
| MSM0546* | MSM0547* | MSM0548* | MSM0549* | MSM0550* |
| MSM0551* | MSM0552* | MSM0553* | MSM0554* | MSM0555* |
| MSM0556* | MSM0557 | MSM0558* | MSM0559 | MSM0560* |
| MSM0561 | MSM0562* | MSM0563* | MSM0564* | MSM0565* |
| MSM0566 | MSM0567* | MSM0568* | MSM0569* | MSM0570* |
| MSM0571* | MSM0572* | MSM0573* | MSM0574* | MSM0575* |
| MSM0576* | MSM0577* | MSM0578* | MSM0579 | MSM0580* |
| MSM0581* | MSM0582* | MSM0583* | MSM0584* | MSM0585* |
| MSM0586* | MSM0587* | MSM0588* | MSM0589 | MSM0590 |
| MSM0591* | MSM0592 | MSM0593* | MSM0594* | MSM0595* |
| MSM0596* | MSM0597* | MSM0598 | MSM0599* | MSM0600* |
| MSM0601 | MSM0602* | MSM0603* | MSM0604* | MSM0605* |
| MSM0606* | MSM0607* | MSM0608* | MSM0609* | MSM0610* |
| MSM0611* | MSM0612* | MSM0613* | MSM0614* | MSM0615* |
| MSM0616* | MSM0617* | MSM0618* | MSM0619* | MSM0620* |
| MSM0621* | MSM0622* | MSM0623 | MSM0624* | MSM0625* |
| MSM0626 | MSM0627* | MSM0628* | MSM0629* | MSM0630* |
| MSM0631* | MSM0632* | MSM0633* | MSM0634* | MSM0635 |
| MSM0636* | MSM0637* | MSM0638* | MSM0639* | MSM0640* |
| MSM0641* | MSM0642* | MSM0643 | MSM0644* | MSM0645* |
| MSM0646* | MSM0647* | MSM0648* | MSM0649* | MSM0650 |
| MSM0651* | MSM0652* | MSM0653* | MSM0654* | MSM0655* |
| MSM0656* | MSM0657* | MSM0658* | MSM0659 | MSM0660* |
| MSM0661* | MSM0662* | MSM0663* | MSM0664 | MSM0665* |
| MSM0666* | MSM0667* | MSM0668* | MSM0669* | MSM0670* |
| MSM0671* | MSM0672* | MSM0673 | MSM0674* | MSM0675* |
| MSM0676* | MSM0677* | MSM0678* | MSM0679* | MSM0680* |
| MSM0681* | MSM0682* | MSM0683* | MSM0684* | MSM0685* |
| MSM0686* | MSM0687* | MSM0688* | MSM0689 | MSM0690 |
| MSM0691* | MSM0692* | MSM0693* | MSM0694* | MSM0695* |
| MSM0696* | MSM0697* | MSM0698* | MSM0699* | MSM0700* |
| MSM0701* | MSM0702* | MSM0703* | MSM0704* | MSM0705* |
| MSM0706* | MSM0707* | MSM0708* | MSM0709* | MSM0710* |
| MSM0711* | MSM0712* | MSM0713* | MSM0714* | MSM0715* |
| MSM0716* | MSM0717* | MSM0718* | MSM0719* | MSM0720* |
| MSM0721* | MSM0722* | MSM0723* | MSM0724 | MSM0725 |
| MSM0726* | MSM0727* | MSM0728* | MSM0729* | MSM0730* |
| MSM0731 | MSM0732* | MSM0733* | MSM0734* | MSM0735* |
| MSM0736* | MSM0737* | MSM0738* | MSM0739* | MSM0740* |
| MSM0741* | MSM0742* | MSM0743* | MSM0744* | MSM0745* |
| MSM0746* | MSM0747* | MSM0748* | MSM0749* | MSM0750* |
| MSM0751* | MSM0752* | MSM0753* | MSM0754* | MSM0755* |
| MSM0756* | MSM0757* | MSM0758* | MSM0759* | MSM0760* |
| MSM0761* | MSM0762* | MSM0763* | MSM0764* | MSM0765* |
| MSM0766* | MSM0767* | MSM0768* | MSM0769* | MSM0770* |
| MSM0771* | MSM0772* | MSM0773* | MSM0774* | MSM0775* |
| MSM0776 | MSM0777* | MSM0778* | MSM0779 | MSM0780* |
| MSM0781* | MSM0782* | MSM0783 | MSM0784* | MSM0785* |
| MSM0786* | MSM0787 | MSM0788 | MSM0789* | MSM0790* |
| MSM0791* | MSM0792 | MSM0793* | MSM0794* | MSM0795* |
| MSM0796* | MSM0797* | MSM0798* | MSM0799* | MSM0800 |
| MSM0801* | MSM0802* | MSM0803* | MSM0804* | MSM0805* |
| MSM0806 | MSM0807* | MSM0808* | MSM0809* | MSM0810* |
| MSM0811* | MSM0812* | MSM0813* | MSM0814* | MSM0815* |
| MSM0816* | MSM0817* | MSM0818* | MSM0819 | MSM0820* |
| MSM0821* | MSM0822* | MSM0823* | MSM0824* | MSM0825* |
| MSM0826 | MSM0827 | MSM0828* | MSM0829* | MSM0830* |
| MSM0831* | MSM0832* | MSM0833* | MSM0834* | MSM0835* |
| MSM0836* | MSM0837* | MSM0838* | MSM0839* | MSM0840* |
| MSM0841* | MSM0842* | MSM0843* | MSM0844* | MSM0845* |
| MSM0846* | MSM0847* | MSM0848* | MSM0849* | MSM0850 |
| MSM0851* | MSM0852* | MSM0853 | MSM0854* | MSM0855* |
| MSM0856* | MSM0857* | MSM0858* | MSM0859* | MSM0860* |
| MSM0861* | MSM0862* | MSM0863* | MSM0864* | MSM0865* |
| MSM0866* | MSM0867* | MSM0868* | MSM0869* | MSM0870* |
| MSM0871* | MSM0872 | MSM0873 | MSM0874 | MSM0875* |
| MSM0876* | MSM0877 | MSM0878* | MSM0879* | MSM0880* |
| MSM0881 | MSM0882 | MSM0883* | MSM0884* | MSM0885* |
| MSM0886 | MSM0887* | MSM0888 | MSM0889* | MSM0890* |
| MSM0891* | MSM0892* | MSM0893* | MSM0894 | MSM0895 |
| MSM0896* | MSM0897* | MSM0898* | MSM0899* | MSM0900* |
| MSM0901* | MSM0902* | MSM0903* | MSM0904 | MSM0905* |
| MSM0906* | MSM0907* | MSM0908* | MSM0909 | MSM0910 |
| MSM0911* | MSM0912* | MSM0913* | MSM0914* | MSM0915* |
| MSM0916* | MSM0917* | MSM0918* | MSM0919* | MSM0920* |
| MSM0921 | MSM0922* | MSM0923* | MSM0924* | MSM0925* |
| MSM0926* | MSM0927* | MSM0928* | MSM0929* | MSM0930* |
| MSM0931* | MSM0932* | MSM0933* | MSM0934* | MSM0935* |
| MSM0936 | MSM0937* | MSM0938 | MSM0939* | MSM0940* |
| MSM0941* | MSM0942* | MSM0943* | MSM0944* | MSM0945* |
| MSM0946* | MSM0947* | MSM0948* | MSM0949* | MSM0950* |
| MSM0951* | MSM0952* | MSM0953* | MSM0954* | MSM0955* |
| MSM0956* | MSM0957* | MSM0958 | MSM0959* | MSM0960* |
| MSM0961 | MSM0962* | MSM0963* | MSM0964* | MSM0965* |
| MSM0966* | MSM0967* | MSM0968* | MSM0969* | MSM0970* |
| MSM0971* | MSM0972* | MSM0973* | MSM0974* | MSM0975* |
| MSM0976 | MSM0977* | MSM0978* | MSM0979* | MSM0980* |
| MSM0981 | MSM0982* | MSM0983* | MSM0984* | MSM0985* |
| MSM0986 | MSM0987* | MSM0988* | MSM0989* | MSM0990* |
| MSM0991* | MSM0992* | MSM0993* | MSM0994* | MSM0995* |
| MSM0996* | MSM0997* | MSM0998 | MSM0999 | MSM1000* |
| MSM1001* | MSM1002* | MSM1003* | MSM1004 | MSM1005* |
| MSM1006* | MSM1007* | MSM1008* | MSM1009 | MSM1010* |
| MSM1011* | MSM1012* | MSM1013* | MSM1014* | MSM1015* |
| MSM1016* | MSM1017* | MSM1018* | MSM1019* | MSM1020* |
| MSM1021* | MSM1022 | MSM1023* | MSM1024* | MSM1025* |
| MSM1026* | MSM1027* | MSM1028* | MSM1029 | MSM1030* |
| MSM1031* | MSM1032* | MSM1033* | MSM1034 | MSM1035* |
| MSM1036* | MSM1037* | MSM1038* | MSM1039* | MSM1040* |
| MSM1041* | MSM1042 | MSM1043 | MSM1044* | MSM1045* |
| MSM1046* | MSM1047* | MSM1048* | MSM1049* | MSM1050* |
| MSM1051* | MSM1052* | MSM1053* | MSM1054* | MSM1055* |
| MSM1056 | MSM1057 | MSM1058* | MSM1059 | MSM1060* |
| MSM1061 | MSM1062 | MSM1063* | MSM1064* | MSM1065 |
| MSM1066* | MSM1067* | MSM1068* | MSM1069 | MSM1070* |
| MSM1071* | MSM1072* | MSM1073* | MSM1074 | MSM1075* |
| MSM1076* | MSM1077 | MSM1078* | MSM1079* | MSM1080* |
| MSM1081* | MSM1082* | MSM1083* | MSM1084 | MSM1085 |
| MSM1086* | MSM1087* | MSM1088* | MSM1089* | MSM1090* |
| MSM1091* | MSM1092* | MSM1093* | MSM1094* | MSM1095* |
| MSM1096* | MSM1097* | MSM1098* | MSM1099* | MSM1100* |
| MSM1101* | MSM1102* | MSM1103* | MSM1104 | MSM1105* |
| MSM1106* | MSM1107* | MSM1108* | MSM1109* | MSM1110* |
| MSM1111* | MSM1112* | MSM1113* | MSM1114* | MSM1115* |
| MSM1116* | MSM1117* | MSM1118* | MSM1119* | MSM1120* |
| MSM1121* | MSM1122* | MSM1123* | MSM1124* | MSM1125* |
| MSM1126* | MSM1127* | MSM1128* | MSM1129* | MSM1130* |
| MSM1131* | MSM1132* | MSM1133* | MSM1134* | MSM1135* |
| MSM1136* | MSM1137 | MSM1138* | MSM1139 | MSM1140* |
| MSM1141* | MSM1142 | MSM1143* | MSM1144* | MSM1145* |
| MSM1146* | MSM1147* | MSM1148* | MSM1149* | MSM1150 |
| MSM1151* | MSM1152 | MSM1153* | MSM1154* | MSM1155* |
| MSM1156* | MSM1157* | MSM1158* | MSM1159 | MSM1160* |
| MSM1161* | MSM1162* | MSM1163* | MSM1164 | MSM1165 |
| MSM1166* | MSM1167* | MSM1168* | MSM1169* | MSM1170* |
| MSM1171* | MSM1172* | MSM1173* | MSM1174* | MSM1175 |
| MSM1176* | MSM1177* | MSM1178* | MSM1179 | MSM1180* |
| MSM1181* | MSM1182* | MSM1183* | MSM1184* | MSM1185* |
| MSM1186* | MSM1187* | MSM1188 | MSM1189* | MSM1190* |
| MSM1191* | MSM1192* | MSM1193* | MSM1194* | MSM1195* |
| MSM1196* | MSM1197 | MSM1198* | MSM1199* | MSM1200 |
| MSM1201* | MSM1202 | MSM1203* | MSM1204* | MSM1205* |
| MSM1206 | MSM1207* | MSM1208* | MSM1209* | MSM1210 |
| MSM1211* | MSM1212* | MSM1213* | MSM1214* | MSM1215* |
| MSM1216* | MSM1217* | MSM1218* | MSM1219* | MSM1220* |
| MSM1221* | MSM1222 | MSM1223 | MSM1224* | MSM1225* |
| MSM1226* | MSM1227* | MSM1228* | MSM1229* | MSM1230* |
| MSM1231* | MSM1232* | MSM1233* | MSM1234* | MSM1235 |
| MSM1236* | MSM1237* | MSM1238* | MSM1239* | MSM1240* |
| MSM1241* | MSM1242* | MSM1243* | MSM1244* | MSM1245* |
| MSM1246* | MSM1247* | MSM1248* | MSM1249 | MSM1250* |
| MSM1251 | MSM1252 | MSM1253* | MSM1254* | MSM1255* |
| MSM1256* | MSM1257* | MSM1258 | MSM1259* | MSM1260* |
| MSM1261* | MSM1262* | MSM1263* | MSM1264* | MSM1265* |
| MSM1266* | MSM1267 | MSM1268 | MSM1269* | MSM1270* |
| MSM1271 | MSM1272* | MSM1273* | MSM1274* | MSM1275* |
| MSM1276* | MSM1277* | MSM1278 | MSM1279* | MSM1280* |
| MSM1281* | MSM1282 | MSM1283* | MSM1284* | MSM1285* |
| MSM1286* | MSM1287* | MSM1288 | MSM1289* | MSM1290* |
| MSM1291* | MSM1292* | MSM1293* | MSM1294* | MSM1295 |
| MSM1296* | MSM1297* | MSM1298* | MSM1299 | MSM1300* |
| MSM1301* | MSM1302* | MSM1303* | MSM1304* | MSM1305 |
| MSM1306* | MSM1307* | MSM1308 | MSM1309* | MSM1310* |
| MSM1311 | MSM1312 | MSM1313* | MSM1314* | MSM1315 |
| MSM1316 | MSM1317* | MSM1318* | MSM1319* | MSM1320* |
| MSM1321* | MSM1322* | MSM1323 | MSM1324* | MSM1325 |
| MSM1326* | MSM1327 | MSM1328* | MSM1329* | MSM1330* |
| MSM1331* | MSM1332* | MSM1333* | MSM1334* | MSM1335* |
| MSM1336* | MSM1337 | MSM1338* | MSM1339* | MSM1340* |
| MSM1341 | MSM1342* | MSM1343* | MSM1344* | MSM1345* |
| MSM1346* | MSM1347* | MSM1348 | MSM1349* | MSM1350* |
| MSM1351 | MSM1352 | MSM1353* | MSM1354* | MSM1355* |
| MSM1356* | MSM1357* | MSM1358* | MSM1359* | MSM1360* |
| MSM1361* | MSM1362* | MSM1363* | MSM1364* | MSM1365* |
| MSM1366* | MSM1367 | MSM1368* | MSM1369* | MSM1370 |
| MSM1371* | MSM1372* | MSM1373* | MSM1374* | MSM1375* |
| MSM1376* | MSM1377* | MSM1378* | MSM1379* | MSM1380 |
| MSM1381* | MSM1382 | MSM1383* | MSM1384* | MSM1385* |
| MSM1386* | MSM1387* | MSM1388* | MSM1389* | MSM1390* |
| MSM1391* | MSM1392* | MSM1393* | MSM1394* | MSM1395* |
| MSM1396* | MSM1397* | MSM1398 | MSM1399* | MSM1400* |
| MSM1401* | MSM1402 | MSM1403 | MSM1404* | MSM1405* |
| MSM1406* | MSM1407* | MSM1408 | MSM1409* | MSM1410* |
| MSM1411 | MSM1412* | MSM1413 | MSM1414* | MSM1415 |
| MSM1416* | MSM1417* | MSM1418* | MSM1419 | MSM1420* |
| MSM1421* | MSM1422 | MSM1423* | MSM1424 | MSM1425* |
| MSM1426 | MSM1427* | MSM1428* | MSM1429 | MSM1430* |
| MSM1431* | MSM1432 | MSM1433* | MSM1434* | MSM1435* |
| MSM1436* | MSM1437* | MSM1438* | MSM1439* | MSM1440* |
| MSM1441* | MSM1442 | MSM1443* | MSM1444 | MSM1445* |
| MSM1446 | MSM1447* | MSM1448* | MSM1449* | MSM1450 |
| MSM1451* | MSM1452* | MSM1453 | MSM1454 | MSM1455* |
| MSM1456 | MSM1457* | MSM1458* | MSM1459 | MSM1460 |
| MSM1461* | MSM1462* | MSM1463* | MSM1464 | MSM1465 |
| MSM1466 | MSM1467 | MSM1468* | MSM1469 | MSM1470* |
| MSM1471 | MSM1472* | MSM1473* | MSM1474 | MSM1475* |
| MSM1476* | MSM1477* | MSM1478* | MSM1479 | MSM1480* |
| MSM1481* | MSM1482 | MSM1483* | MSM1484* | MSM1485 |
| MSM1486* | MSM1487* | MSM1488 | MSM1489* | MSM1490 |
| MSM1491* | MSM1492* | MSM1493 | MSM1494* | MSM1495* |
| MSM1496* | MSM1497* | MSM1498 | MSM1499* | MSM1500 |
| MSM1501* | MSM1502 | MSM1503* | MSM1504* | MSM1505 |
| MSM1506 | MSM1507 | MSM1508* | MSM1509* | MSM1510* |
| MSM1511* | MSM1512 | MSM1513 | MSM1514* | MSM1515* |
| MSM1516* | MSM1517* | MSM1518* | MSM1519* | MSM1520* |
| MSM1521* | MSM1522* | MSM1523 | MSM1524* | MSM1525* |
| MSM1526* | MSM1527 | MSM1528 | MSM1529 | MSM1530* |
| MSM1531* | MSM1532* | MSM1533 | MSM1534* | MSM1535* |
| MSM1536* | MSM1537* | MSM1538* | MSM1539* | MSM1540* |
| MSM1541* | MSM1542* | MSM1543 | MSM1544* | MSM1545* |
| MSM1546* | MSM1547* | MSM1548* | MSM1549 | MSM1550 |
| MSM1551* | MSM1552* | MSM1553* | MSM1554* | MSM1555* |
| MSM1556* | MSM1557* | MSM1558 | MSM1559* | MSM1560* |
| MSM1561* | MSM1562* | MSM1563* | MSM1564* | MSM1565 |
| MSM1566 | MSM1567 | MSM1568* | MSM1569 | MSM1570* |
| MSM1571* | MSM1572* | MSM1573* | MSM1574* | MSM1575 |
| MSM1576* | MSM1577* | MSM1578 | MSM1579* | MSM1580 |
| MSM1581 | MSM1582* | MSM1583 | MSM1584 | MSM1585 |
| MSM1586* | MSM1587* | MSM1588* | MSM1589 | MSM1590* |
| MSM1591* | MSM1592* | MSM1593 | MSM1594 | MSM1595* |
| MSM1596* | MSM1597* | MSM1598 | MSM1599 | MSM1600* |
| MSM1601* | MSM1602* | MSM1603* | MSM1604* | MSM1605 |
| MSM1606* | MSM1607* | MSM1608* | MSM1609 | MSM1610* |
| MSM1611* | MSM1612* | MSM1613 | MSM1614* | MSM1615* |
| MSM1616 | MSM1617* | MSM1618 | MSM1619 | MSM1620* |
| MSM1621* | MSM1622 | MSM1623* | MSM1624* | MSM1625* |
| MSM1626* | MSM1627* | MSM1628* | MSM1629* | MSM1630* |
| MSM1631 | MSM1632* | MSM1633* | MSM1634* | MSM1635 |
| MSM1636* | MSM1637* | MSM1638 | MSM1639* | MSM1640* |
| MSM1641* | MSM1642* | MSM1643* | MSM1644* | MSM1645 |
| MSM1646* | MSM1647* | MSM1648* | MSM1649 | MSM1650* |
| MSM1651* | MSM1652 | MSM1653* | MSM1654 | MSM1655* |
| MSM1656* | MSM1657 | MSM1658* | MSM1659* | MSM1660 |
| MSM1661* | MSM1662* | MSM1663* | MSM1664* | MSM1665* |
| MSM1666 | MSM1667 | MSM1668* | MSM1669* | MSM1670* |
| MSM1671* | MSM1672* | MSM1673* | MSM1674* | MSM1675 |
| MSM1676* | MSM1677* | MSM1678* | MSM1679 | MSM1680 |
| MSM1681 | MSM1682 | MSM1683 | MSM1684 | MSM1685* |
| MSM1686* | MSM1687* | MSM1688 | MSM1689* | MSM1690* |
| MSM1691 | MSM1692* | MSM1693* | MSM1694* | MSM1695* |
| MSM1696 | MSM1697* | MSM1698* | MSM1699* | MSM1700* |
| MSM1701* | MSM1702 | MSM1703 | MSM1704* | MSM1705 |
| MSM1706 | MSM1707 | MSM1708* | MSM1709 | MSM1710 |
| MSM1711* | MSM1712* | MSM1713 | MSM1714 | MSM1715 |
| MSM1716 | MSM1717 | MSM1718* | MSM1719 | MSM1720* |
| MSM1721* | MSM1722 | MSM1723 | MSM1724 | MSM1725 |
| MSM1726* | MSM1727* | MSM1728 | MSM1729* | MSM1730 |
| MSM1731 | MSM1732* | MSM1733 | MSM1734* | MSM1735 |
| MSM1736 | MSM1737* | MSM1738* | MSM1739* | MSM1740* |
| MSM1741* | MSM1742* | MSM1743* | MSM1744* | MSM1745* |
| MSM1746* | MSM1747* | MSM1748* | MSM1749* | MSM1750* |
| MSM1751* | MSM1752* | MSM1753* | MSM1754* | MSM1755* |
| MSM1756* | MSM1757* | MSM1758* | MSM1759* | MSM1760* |
| MSM1761* | MSM1762* | MSM1763* | MSM1764* | MSM1765* |
| MSM1766* | MSM1767* | MSM1768* | MSM1769 | MSM1770 |
| MSM1771 | MSM1772 | MSM1773 | MSM1774 | MSM1775 |
| MSM1776 | MSM1777 | MSM1778 | MSM1779 | MSM1780 |
| MSM1781 | MSM1782 | MSM1783 | MSM1784 | MSM1785 |
| MSM1786 | MSM1787 | MSM1788 | MSM1789 | MSM1790 |
| MSM1791 | MSM1792 | MSM1793 | MSM1794 | MSM1795 |

| Families | Individuals | Strains | Genes |
|---|---|---|---|
| 4 | 5 | 11 | 1436 |

*Genes found in all strains examined. 11 strains, all isolated from human feces, were sequenced and their gene content compared to Methanobrevibacter smithii PS, the type strain. A total of 1436 genes were found in all strains examined to date.

TABLE 1
General features of the M. smithii PS genome compared to other
sequenced Methanobacteriales

| | | | Methano- |
|---|---|---|---|
| | Methano- | Methano- | thermobacter |
| | brevibacter | sphaera | thermoauto- |
| | smithii | stadtmanae | trophicus |
| Genome Size (bp) | 1,853,160 | 1,767,403 | 1,751,377 |
| G + C content (%) | 31 | 28 | 50 |
| Coding Regions (%) | 90 | 84 | 90 |
| Number of ORFs | 1795 | 1534 | 1869 |
| rRNA operons | 2 | 4 | 2 |
| tRNA genes | 34 | 40 | 39 |
| tRNA genes with intron | 1 | 1 | 3 |
| Transposases (remnants) | 2 (20) | 1 (2) | 0 |
| Insertion Sequences | 8 | 4 | 0 |
| Restriction Modification | 2/6/1 | 3/2/1 | 3/0/0 |
| System Subunits | | | |
| (Type I/II/III) | | | |
| Putative Prophage | Yes | No | No |

TABLE 2
Predicted proteome of M. smithii strain PS and conservation among other
strains and in the fecal microbiome of two healthy adults.

| | | M. smithil | | | | |
|---|---|---|---|---|---|---|
| | | strain genotyping | | | | Human Gut |
| Gene | Annotation | PS | F1 | ALI | B181 | Microbiome |
| MSM0001 | exoribonuclease VII, large subunit, XseA | 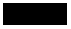 | 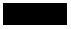 | 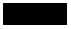 | 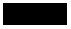 | 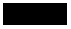 |
| MSM0002 | integrase-recombinase protein | 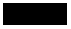 | 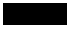 | 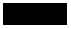 | 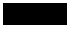 | 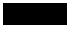 |
| MSM0003 | conserved hypothetical membrane protein (putative heme utilization/adhesion related) | 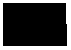 | 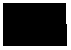 | 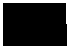 | 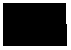 | 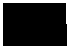 |
| MSM0004 | predicted lysine decarboxylase | 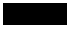 | 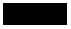 | 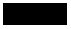 | 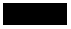 | 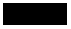 |
| MSM0005 | conserved hypothetical protein | 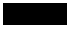 | 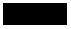 | 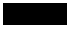 | 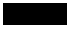 | 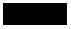 |
| MSM0006 | conserved hypothetical protein | 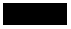 | 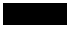 | 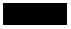 | 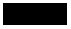 | 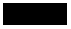 |
| MSM0007 | SAM-dependent methyltransferase | ND | | | | 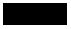 |
| MSM0008 | putative transposase | 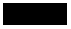 | 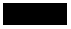 | 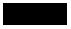 | 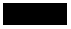 | 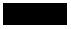 |
| MSM0009 | conserved hypothetical protein | 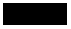 | 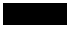 | 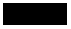 | 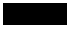 | 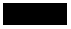 |
| MSM0010 | N-acetyltransferase, GNAT family | 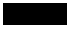 | 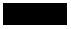 | 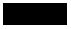 | 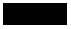 | 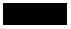 |
| MSM0011 | hypothetical protein | 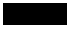 | 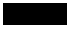 | 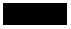 | 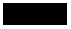 | 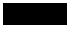 |
| MSM0012 | conserved hypothetical protein | 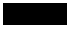 | 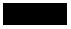 | 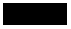 | 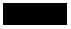 | 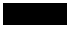 |
| MSM0013 | hypothetical protein | 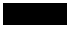 | 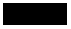 | 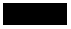 | 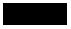 | |
| MSM0014 | putative heat shock related protein | 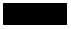 | 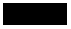 | 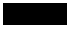 | | |
| MSM0015 | hypothetical protein | 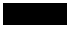 | 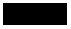 | 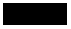 | | |
| MSM0016 | hypothetical protein | 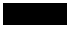 | | | 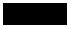 | |
| MSM0017 | hypothetical protein | 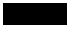 | | | | |
| MSM0018 | hypothetical protein | 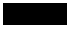 | | | | |
| MSM0019 | hypothetical protein | 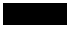 | | | 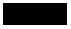 | |
| MSM0020 | predicted O-linked GlnNAc transferase | 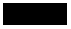 | | | | |
| MSM0021 | short chain dehydrogenase (7-alpha-hydroxysteroid dehydrogenase) | 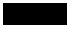 | 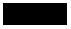 | | 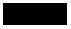 | |
| MSM0022 | hypothetical protein | 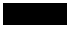 | | | | |
| MSM0023 | uncharacterized protein predicted to be involved in DNA repair | 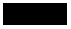 | 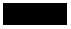 | 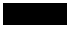 | 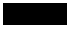 | |
| MSM0024 | hypothetical protein | 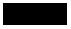 | | | 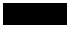 | 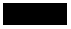 |
| MSM0025 | long-chain-fatty-acid-CoA ligase | 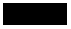 | 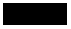 | 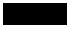 | 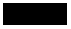 | 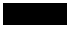 |
| MSM0026 | predicted transcriptional regulator | 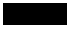 | 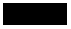 | 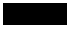 | 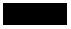 | 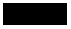 |
| MSM0027 | glutamate synthase, domain 2 with rubredoxin | 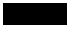 | 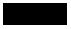 | 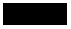 | 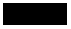 | 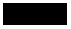 |
| MSM0028 | SAM-dependent methyltransferase | 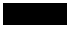 | 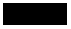 | 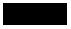 | 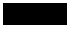 | 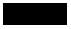 |
| MSM0029 | putative calcium-binding protein | 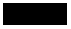 | 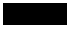 | 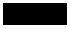 | 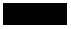 | 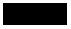 |
| MSM0030 | conserved hypothetical membrane protein | 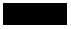 | 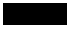 | 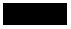 | 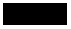 | 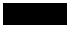 |
| MSM0031 | adhesin-like protein | 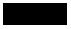 | 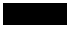 | 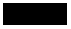 | 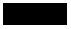 | 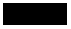 |
| MSM0032 | hypothetical protein | 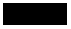 | 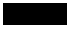 | | 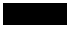 | 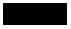 |
| MSM0033 | ketopantoate reductase, ApbA | 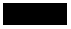 | 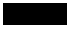 | 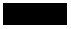 | 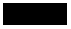 | 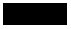 |
| MSM0034 | conserved hypothetical protein | 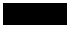 | 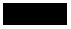 | 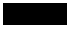 | 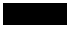 | 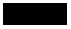 |
| MSM0035 | hypothetical protein | 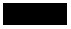 | 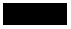 | 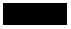 | 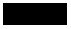 | 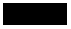 |
| MSM0036 | hypothetical protein | 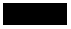 | 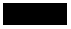 | 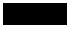 | 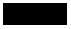 | 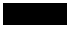 |
| MSM0037 | hypothetical protein | 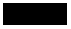 | 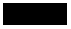 | 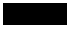 | 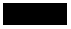 | 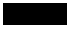 |
| MSM0038 | hypothetical protein | 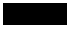 | | 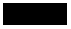 | | 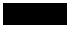 |
| MSM0039 | hypothetical protein | 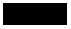 | 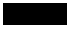 | 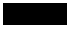 | 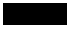 | 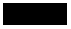 |
| MSM0040 | conserved hypothetical protein | 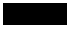 | 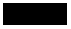 | 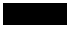 | 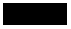 | 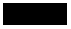 |
| MSM0041 | hypothetical protein | 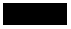 | 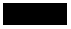 | 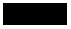 | 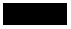 | 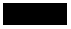 |
| MSM0042 | hypothetical protein | 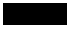 | 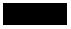 | 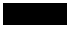 | 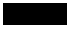 | 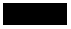 |
| MSM0043 | peptide methionine sulfoxide reductase, PMSR | 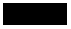 | 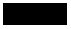 | 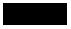 | 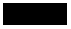 | 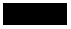 |
| MSM0044 | PLP dependent aminotransferase (aspartate) | 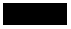 | 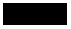 | 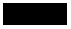 | 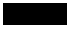 | 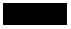 |
| MSM0045 | nucleotide-binding protein (putative ATPase involved in chromosome partitioning) | 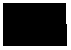 | 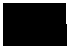 | 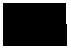 | 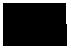 | 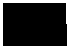 |
| MSM0046 | NADH oxidase | 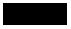 | 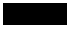 | 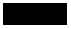 | 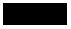 | 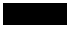 |
| MSM0047 | Chloramphenicol O-acetyltransferase | 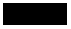 | 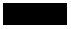 | | 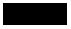 | 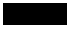 |
| MSM0048 | conserved hypothetical protein | 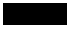 | 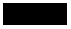 | | | 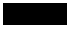 |
| MSM0049 | F420-dependent NADP oxidoreductase, fno | 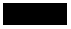 | 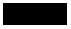 | 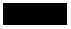 | 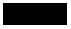 | 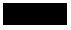 |
| MSM0050 | predicted metal-binding protein | 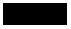 | 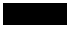 | | | 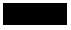 |
| MSM0051 | adhesin-like protein | 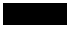 | 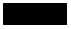 | | | 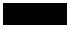 |
| MSM0052 | adhesin-like protein | 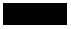 | 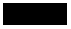 | | | 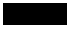 |
| MSM0053 | tRNA nucleotidyltransferase (CCA-adding enzyme) | 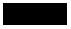 | 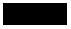 | 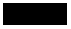 | 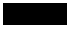 | 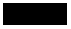 |
| MSM0054 | 2′-5′RNA ligase, LigT | 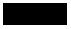 | 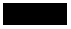 | 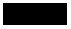 | 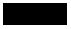 | 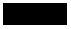 |
| MSM0055 | predicted alternative 3-dehydroquinate synthase | 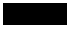 | 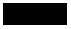 | 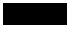 | 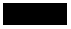 | 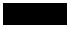 |
| MSM0056 | archaeal fructose-1,6-biphosphate aldolase | 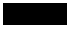 | 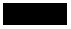 | 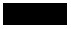 | 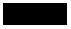 | 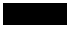 |
| MSM0057 | adhesin-like protein | 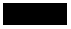 | | | | |
| MSM0058 | DNA helicase II | 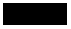 | 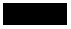 | | | 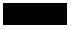 |
| MSM0059 | SAM-dependent methyltransferase | 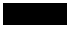 | 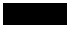 | 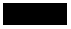 | | 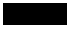 |
| MSM0060 | predicted archaeal kinase (GHMP kinase family) | 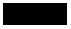 | 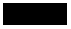 | 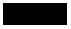 | 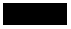 | 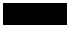 |
| MSM0061 | predicted ATPase (AAA+ superfamily) | 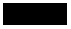 | 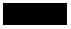 | 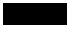 | 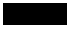 | 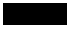 |
| MSM0062 | flavodoxin | 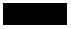 | 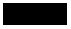 | 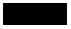 | 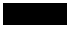 | 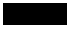 |
| MSM0063 | amidohydrolase (PHP family) | 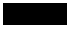 | 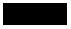 | 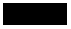 | 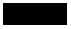 | 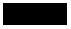 |
| MSM0064 | conserved hypothetical protein | 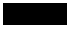 | 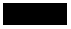 | 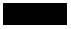 | 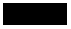 | 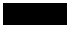 |
| MSM0065 | riboflavin-specific deaminase | 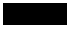 | 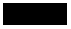 | 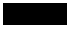 | 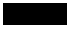 | 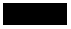 |
| MSM0066 | N-acetylglucosamine-1-phosphate transferase, GT4 family | 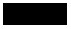 | 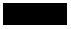 | 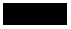 | 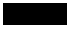 | 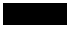 |
| MSM0067 | conserved hypothetical protein | 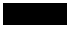 | 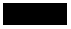 | 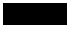 | 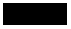 | 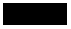 |
| MSM0068 | hypothetical protein | 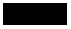 | 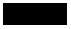 | 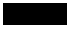 | 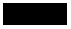 | 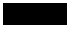 |
| MSM0069 | conserved hypothetical protein | 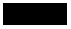 | 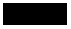 | 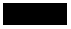 | 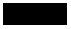 | 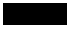 |
| MSM0070 | conserved hypothetical protein | 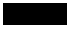 | 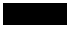 | 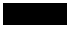 | 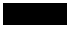 | 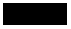 |
| MSM0071 | methionyl-tRNA synthetase, MetG | 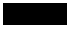 | 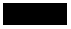 | 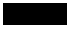 | 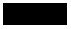 | 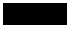 |
| MSM0072 | putative exonuclease SBCC | 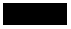 | 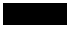 | 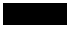 | 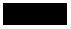 | 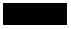 |
| MSM0073 | DNA primase, large subunit (eukaryotic-type) | 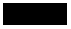 | 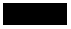 | 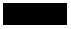 | 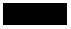 | 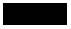 |
| MSM0074 | hypothetical protein | 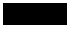 | 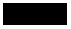 | 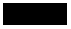 | 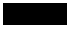 | 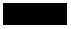 |
| MSM0075 | DNA primase, small subunit | 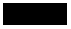 | 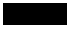 | 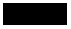 | 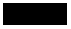 | 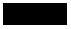 |
| MSM0076 | conserved hypothetical protein | 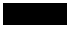 | 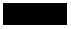 | 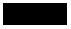 | 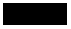 | 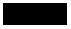 |
| MSM0077 | thymidylate kinase | 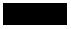 | 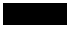 | 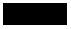 | 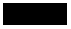 | 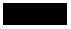 |
| MSM0078 | dolichol kinase (cytidylyltransferase family) | 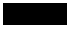 | 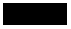 | 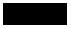 | 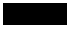 | 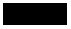 |
| MSM0079 | CofH protein (7,8-didemethyl-8-hydroxy-5-deazariboflavin (FO)/F420 biosynthesis | 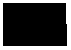 | 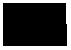 | 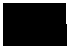 | 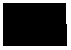 | 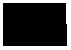 |
| MSM0080 | sulfopyruvate decarboxylase, comD | 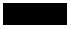 | 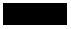 | 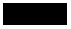 | 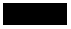 | 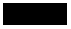 |
| MSM0081 | sulfopyruvate decarboxylase, comE | 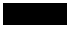 | 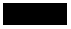 | 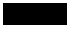 | 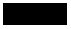 | 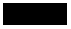 |
| MSM0082 | heterodisulfide reductase, subunit A, HdrA | 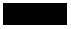 | 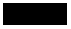 | 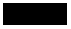 | 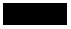 | 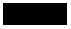 |
| MSM0083 | heterodisulfide reductase, subunit B, HdrB | 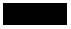 | 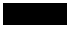 | 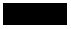 | 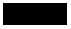 | 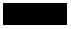 |
| MSM0084 | heterodisulfide reductase, subunit C, HdrC | 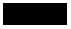 | 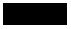 | 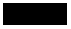 | 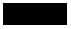 | 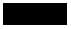 |
| MSM0085 | putative ferredoxin | 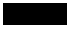 | 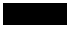 | 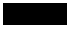 | 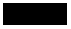 | 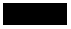 |
| MSM0086 | (2R)-phospho-3-sulfolactate synthase, ComA | 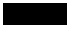 | 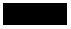 | 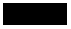 | 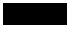 | 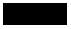 |
| MSM0087 | putative transposase | ND | | | | 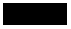 |
| MSM0088 | conserved hypothetical protein | 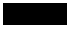 | 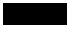 | 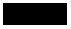 | 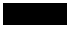 | 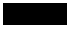 |
| MSM0089 | pyrroline-5-carboxylate reductase (NADP oxidoreductase, coenzyme F420-dependent), ProC | 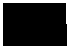 | 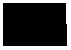 | 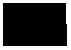 | 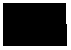 | 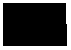 |
| MSM0090 | conserved hypothetical protein (UPF0058) | 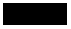 | 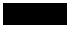 | 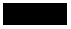 | 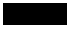 | 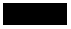 |
| MSM0091 | 2,3-diphosphoglycerate synthase (putative GTPase) | 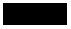 | 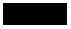 | 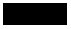 | 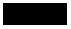 | 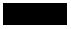 |
| MSM0092 | putative adhesin-like protein | 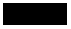 | | 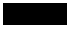 | 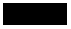 | 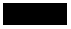 |
| MSM0093 | conserved hypothetical membrane-spanning protein (phage infection) | 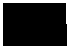 | 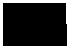 | 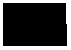 | 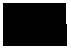 | 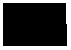 |
| MSM0094 | predicted transcription regulator (TetR family) | 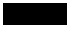 | 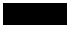 | 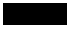 | 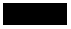 | 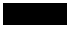 |
| MSM0095 | predicted phosphotransacetylase | 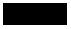 | 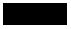 | 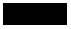 | 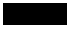 | 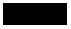 |
| MSM0096 | undecaprenyl pyrophosphate synthase, UppS | 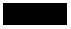 | 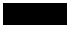 | 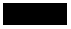 | 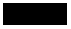 | 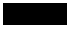 |
| MSM0097 | Mg-dependent DNase, TatD | 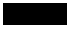 | 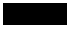 | 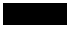 | 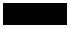 | 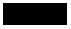 |
| MSM0098 | hypothetical protein | 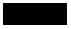 | 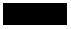 | 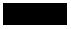 | 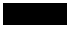 | 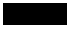 |
| MSM0099 | conserved hypothetical membrane protein | 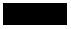 | 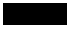 | 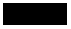 | 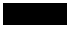 | 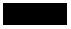 |
| MSM0100 | conserved hypothetical protein | 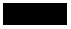 | 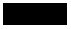 | 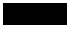 | 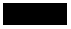 | 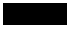 |
| MSM0101 | precorrin-3 methylase, CbiF | 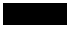 | 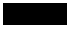 | 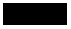 | 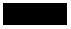 | 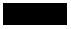 |
| MSM0102 | cobalamin-independent methionine synthase, MetE | 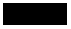 | 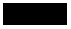 | 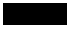 | 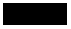 | 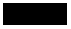 |
| MSM0103 | conserved hypothetical protein | 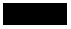 | 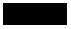 | 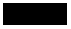 | 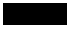 | 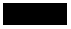 |
| MSM0104 | conserved hypothetical protein | 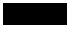 | 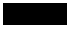 | 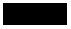 | 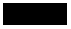 | 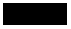 |
| MSM0105 | conserved hypothetical protein | 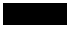 | 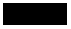 | 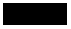 | 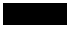 | 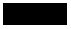 |
| MSM0106 | conserved hypothetical protein | 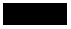 | 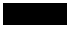 | 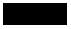 | 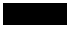 | 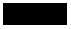 |
| MSM0107 | hydrogenase expression/formation protein, HypB | 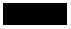 | 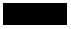 | 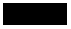 | 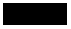 | 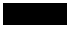 |
| MSM0108 | hydrogenase nickel incorporation protein, HypA | 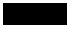 | 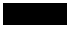 | 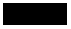 | 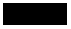 | 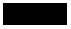 |
| MSM0109 | conserved hypothetical membrane-spanning protein | 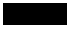 | | 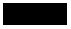 | 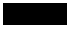 | 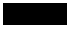 |
| MSM0110 | predicted transposase | 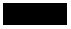 | | | | 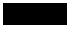 |
| MSM0111 | hypothetical protein | 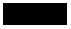 | 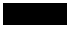 | 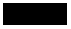 | | 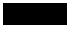 |
| MSM0112 | ATP-dependent RNA helicase, elF-4A family | 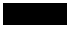 | 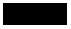 | 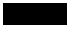 | 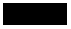 | 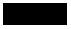 |
| MSM0113 | DNA helicase | 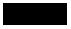 | 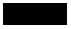 | 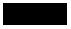 | 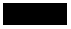 | 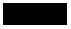 |
| MSM0114 | hypothetical protein | 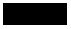 | 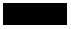 | 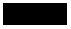 | 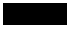 | 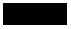 |
| MSM0115 | conserved hypothetical protein | 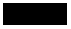 | 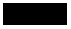 | 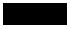 | 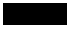 | 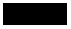 |
| MSM0116 | MobA-related protein | 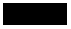 | 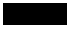 | 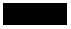 | 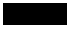 | 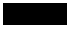 |
| MSM0117 | conserved hypothetical membrane protein | 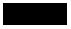 | 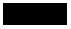 | 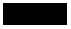 | 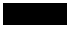 | 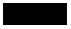 |
| MSM0118 | cell wall biosynthesis protein, MurD-like peptide ligase family | 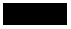 | 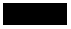 | 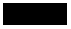 | 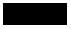 | 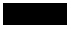 |
| MSM0119 | predicted nuclease | 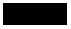 | 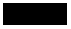 | 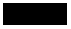 | 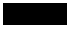 | 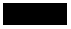 |
| MSM0120 | purine NTPase involved in DNA repair, Rad50 | 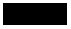 | 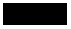 | 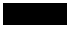 | 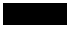 | 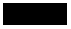 |
| MSM0121 | DNA repair exonuclease (SbcD/Mre11-family), Rad32 | 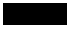 | 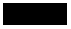 | 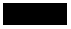 | 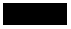 | 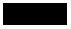 |
| MSM0122 | predicted ATPase | 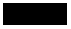 | 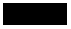 | 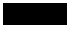 | 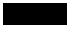 | 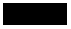 |
| MSM0123 | uncharacterized protein conserved in archaea | 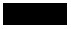 | 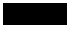 | 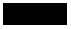 | 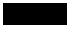 | 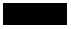 |
| MSM0124 | predicted phosphate-binding protein (PcrB family) | 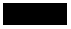 | 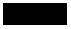 | 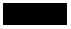 | 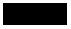 | 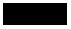 |
| MSM0125 | ribosomal protein L40e | 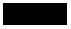 | 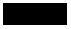 | 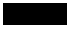 | 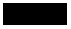 | 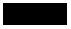 |
| MSM0126 | conserved hypothetical protein | 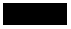 | 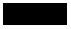 | 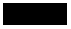 | 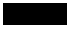 | 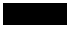 |
| MSM0127 | hypothetical protein | 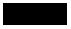 | 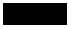 | 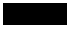 | 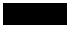 | 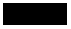 |
| MSM0128 | conserved hypothetical protein | 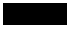 | 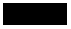 | 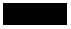 | 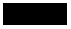 | 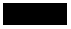 |
| MSM0129 | nicotinamide mononucleotide adenylyltransferase, NadR | 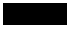 | 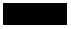 | 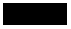 | 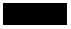 | 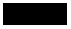 |
| MSM0130 | molybdenum cofactor biosynthesis protein, MoaE | 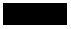 | 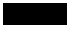 | 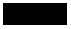 | 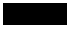 | 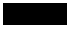 |
| MSM0131 | molybdenum-binding protein, Mopl | 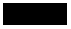 | 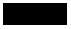 | 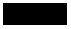 | 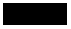 | 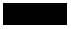 |
| MSM0132 | conserved hypothetical protein | 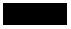 | 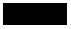 | 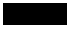 | 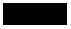 | 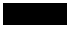 |
| MSM0133 | predicted thioesterase, FcbC | 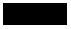 | 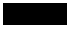 | 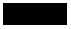 | 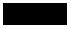 | 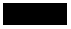 |
| MSM0134 | M42 glutamyl aminopeptidase/endo-glucanase | 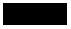 | 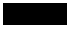 | 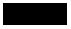 | 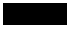 | 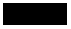 |
| MSM0135 | coenzyme F420-reducing hydrogenase, beta subunit | 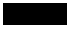 | 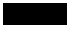 | 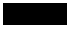 | 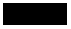 | 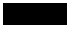 |
| MSM0136 | putative ferredoxin | 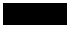 | 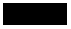 | 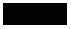 | 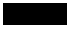 | 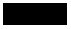 |
| MSM0137 | putative archaeal flagellar protein D/E | 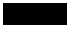 | 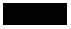 | 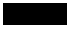 | 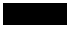 | 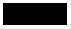 |
| MSM0138 | predicted exonuclease | 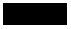 | 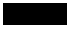 | 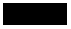 | 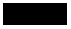 | 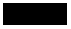 |
| MSM0139 | hypothetical protein | 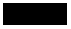 | 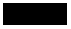 | 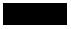 | 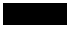 | 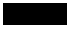 |
| MSM0140 | conserved hypothetical protein | 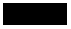 | 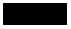 | 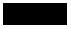 | 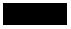 | 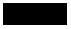 |
| MSM0141 | dephospho-CoA kinase, CoaE | 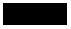 | 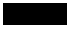 | 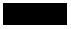 | 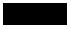 | 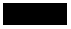 |
| MSM0142 | predicted ATPase (PP-loop superfamily) | 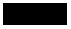 | 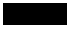 | 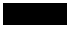 | 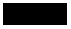 | 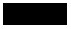 |
| MSM0143 | conserved hypothetical membrane protein | 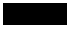 | 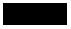 | 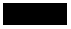 | 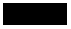 | 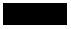 |
| MSM0144 | hypothetical protein (putative ADP-ribosylation domain) | 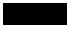 | 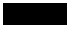 | 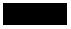 | 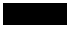 | 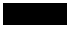 |
| MSM0145 | conserved hypothetical protein | 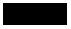 | 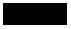 | 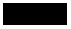 | 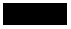 | 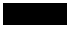 |
| MSM0146 | type IV leader peptidase | 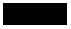 | 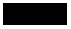 | 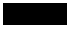 | 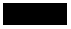 | 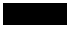 |
| MSM0147 | CTP synthase (UTP-ammonia lyase), PyrG | 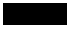 | 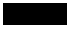 | 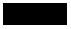 | 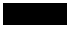 | 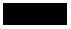 |
| MSM0148 | predicted oxidoreductase, aldo/keto reductase family | 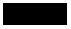 | 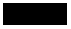 | 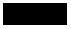 | 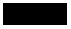 | 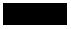 |
| MSM0149 | predicted acetylesterase | 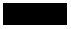 | 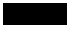 | 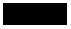 | 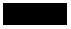 | 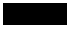 |
| MSM0150 | hypothetical protein | 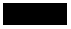 | | 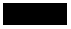 | 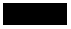 | 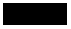 |
| MSM0151 | hypothetical protein | 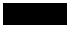 | 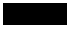 | 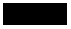 | 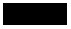 | 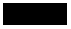 |
| MSM0152 | Na+-driven multidrug efflux pump (MATE family), NorM | 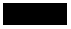 | 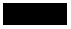 | 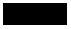 | 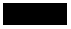 | 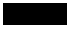 |
| MSM0153 | predicted phosphoglycerate mutase | 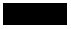 | 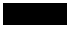 | 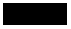 | 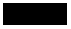 | 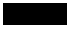 |
| MSM0154 | homoserine dehydrogenase, ThrA | 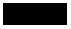 | 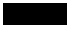 | 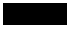 | 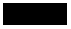 | 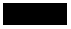 |
| MSM0155 | predicted allosteric regulator of homoserine dehydrogenase | 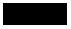 | 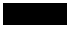 | 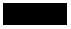 | 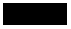 | 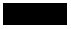 |
| MSM0156 | Asp-tRNA(Asn)/Glu-tRNA(Gln) amidotransferase, C subunit | 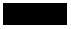 | 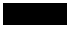 | 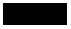 | 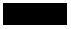 | 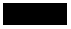 |
| MSM0157 | predicted type I restriction-modification enzyme, subunit S | 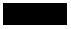 | 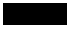 | 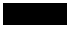 | 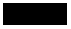 | |
| MSM0158 | type I restriction-modification system methylase, subunit S | 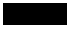 | | | | |
| MSM0159 | adhesin-like protein | 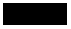 | 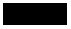 | 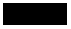 | 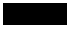 | 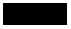 |
| MSM0160 | asparagine synthetase, AsnB | 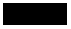 | 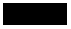 | 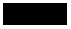 | 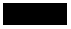 | 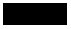 |
| MSM0161 | hypothetical protein | 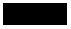 | | 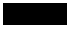 | | 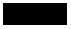 |
| MSM0162 | hypothetical protein | 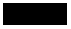 | | | | 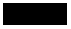 |
| MSM0163 | conserved hypothetical protein predicted to be involved in DNA repair | 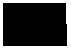 | | | | 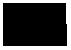 |
| MSM0164 | conserved hypothetical protein predicted to be involved in DNA repair | 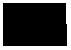 | | | 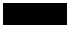 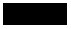 | 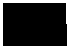 |
| MSM0165 | predicted exonuclease | 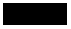 | | | | 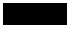 |
| MSM0166 | predicted helicase | 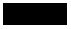 | 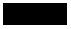 | | | 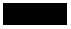 |
| MSM0167 | conserved hypothetical protein predicted to be involved in DNA repair (RAMP superfamily) | 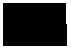 | 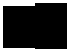 | | | 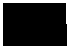 |
| MSM0168 | conserved hypothetical protein predicted to be involved in DNA repair | 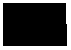 | | | | 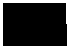 |
| MSM0169 | predicted CRISPR-associated protein | 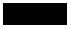 | | | | 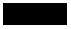 |
| MSM0170 | conserved hypothetical protein predicted to be involved in DNA repair (RAMP superfamily) | 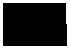 | | | | 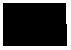 |
| MSM0171 | conserved hypothetical membrane protein (invasin/intimin cell- adhesion domain) | 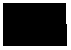 | 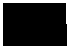 | 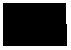 | 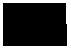 | 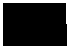 |
| MSM0172 | hypothetical protein | 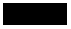 | 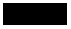 | 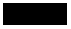 | 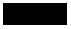 | 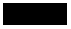 |
| MSM0173 | adhesin-like protein | 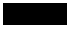 | 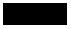 | 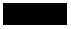 | 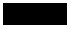 | 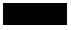 |
| MSM0174 | O-acetylhomoserine sulfhydrylase (PLP-dependent), MET17 | 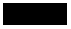 | 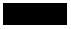 | 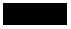 | 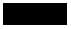 | 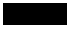 |
| MSM0175 | homoserine O-acetyltransferase, MetX | 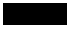 | 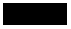 | 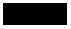 | 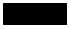 | 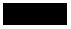 |
| MSM0176 | ribonuclease III (dsRNA-specific), Rnc | 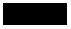 | 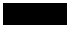 | 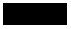 | 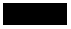 | 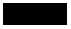 |
| MSM0177 | hypothetical protein | 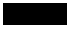 | 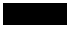 | 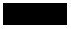 | 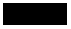 | 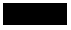 |
| MSM0178 | conserved hypothetical protein | 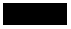 | 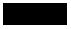 | 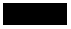 | 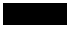 | 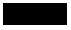 |
| MSM0179 | hypothetical protein | 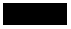 | 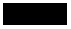 | 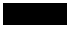 | 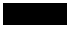 | 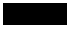 |
| MSM0180 | hypothetical protein | 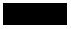 | 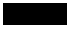 | 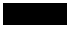 | | 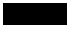 |
| MSM0181 | ribosomal protein L37e | 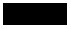 | 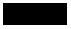 | 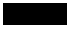 | 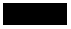 | 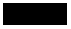 |
| MSM0182 | snRNP Sm-like protein | 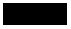 | 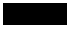 | 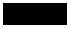 | 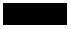 | 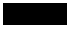 |
| MSM0183 | RNA-binding protein, PUA domain family | 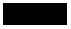 | 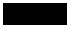 | 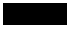 | 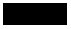 | 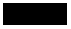 |
| MSM0184 | creatinine amidohydrolase | 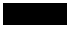 | 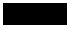 | 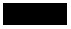 | 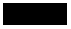 | 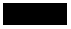 |
| MSM0185 | conserved hypothetical membrane protein | 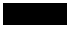 | 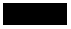 | 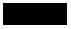 | 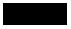 | 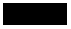 |
| MSM0186 | conserved hypothetical protein | 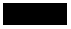 | 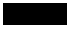 | 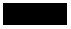 | 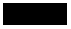 | 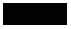 |
| MSM0187 | rubredoxin | 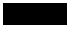 | 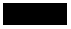 | 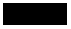 | 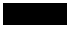 | 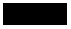 |
| MSM0188 | rubredoxin | 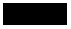 | 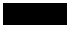 | 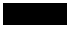 | 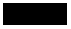 | 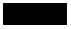 |
| MSM0189 | acetyl/acyl transferase related protein | 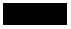 | 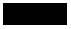 | 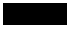 | 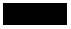 | 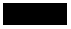 |
| MSM0190 | predicted ATPase | 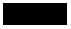 | 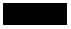 | 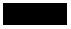 | 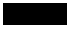 | 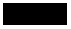 |
| MSM0191 | conserved hypothetical protein | 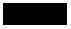 | 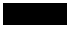 | 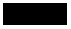 | 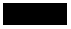 | 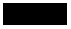 |
| MSM0192 | argininosuccinate lyase, ArgH | 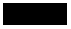 | 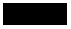 | 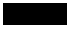 | 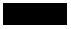 | 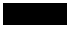 |
| MSM0193 | ribosomal protein S27ae | 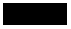 | 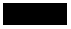 | 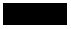 | 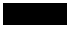 | 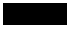 |
| MSM0194 | ribosomal protein S24ae | 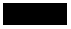 | 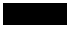 | 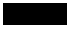 | 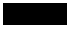 | 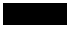 |
| MSM0195 | uncharacterized protein conserved in archaea | 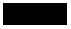 | 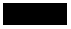 | 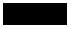 | 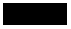 | 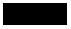 |
| MSM0196 | archaeal DNA-dependent RNA polymerase, subunit E, RpoE | 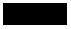 | 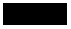 | 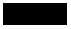 | 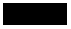 | 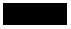 |
| MSM0197 | archaeal DNA-dependent RNA polymerase, subunit E, RpoE | 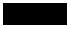 | 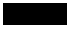 | 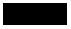 | 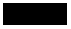 | 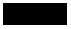 |
| MSM0198 | inorganic pyrophosphatase | 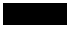 | 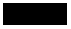 | 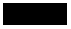 | 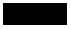 | 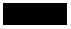 |
| MSM0199 | conserved hypothetical protein (PilT N-term./Vapc superfamily) | 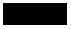 | 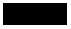 | 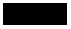 | 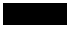 | 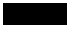 |
| MSM0200 | translation initiation factor alF-2, gamma subunit | 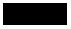 | 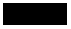 | 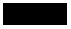 | 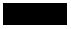 | 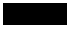 |
| MSM0201 | ribosomal protein S6e | 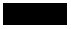 | 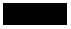 | 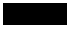 | 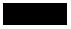 | 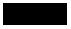 |
| MSM0202 | translation initiation factor alF-2, InfB | 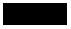 | 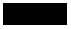 | 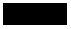 | 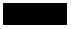 | 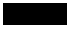 |
| MSM0203 | nucleoside diphosphate kinase, Ndk | 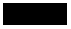 | 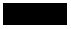 | 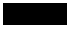 | 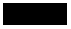 | 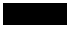 |
| MSM0204 | ribosomal protein L24e | 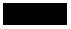 | 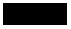 | 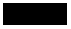 | 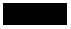 | 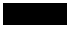 |
| MSM0205 | ribosomal protein S28e | 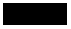 | 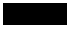 | 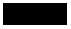 | 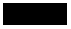 | 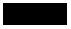 |
| MSM0206 | ribosomal protein L7ae | 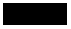 | 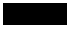 | 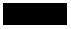 | 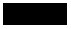 | 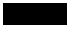 |
| MSM0207 | predicted DNA-binding protein | 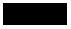 | 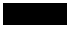 | 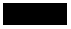 | 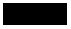 | 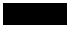 |
| MSM0208 | predicted DNA-binding protein | 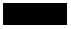 | 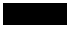 | 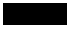 | 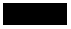 | 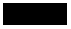 |
| MSM0209 | ferredoxin | 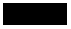 | 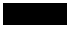 | 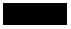 | 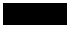 | 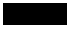 |
| MSM0210 | hypothetical protein | 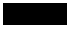 | 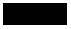 | 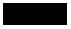 | 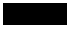 | 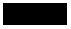 |
| MSM0211 | hypothetical protein | 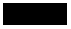 | 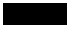 | 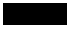 | 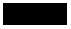 | 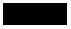 |
| MSM0212 | conserved hypothetical protein | 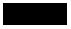 | 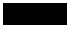 | 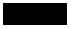 | 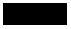 | 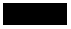 |
| MSM0213 | archaeal histone, HMtA | 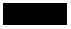 | 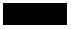 | 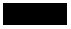 | 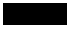 | 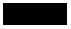 |
| MSM0214 | threonine synthase (pyridoxal-phosphate dependent), ThrC | 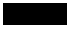 | 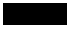 | 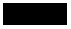 | 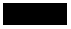 | 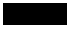 |
| MSM0215 | conserved hypothetical integral membrane protein | 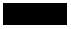 | 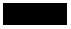 | 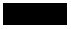 | 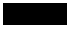 | 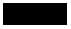 |
| MSM0216 | tryptophanyl-tRNA synthetase, TrpS | 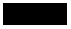 | 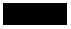 | 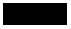 | 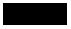 | 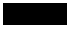 |
| MSM0217 | tRNA intron endonuclease, EndA | 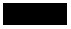 | 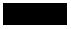 | 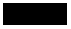 | 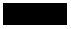 | 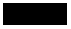 |
| MSM0218 | iron dependent transcriptional regulator (Fe2+-binding) | 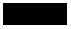 | 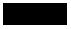 | 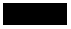 | 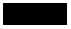 | 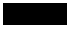 |
| MSM0219 | putative cysteine protease (transglutaminase-like superfamily) | 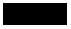 | 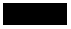 | 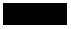 | 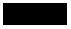 | 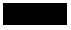 |
| MSM0220 | chaperonin (TCP-1/cpn60 family), alpha subunit | 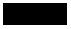 | 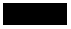 | 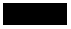 | 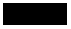 | 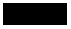 |
| MSM0221 | adhesin-like protein | 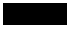 | 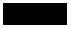 | 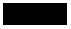 | 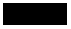 | 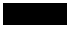 |
| MSM0222 | flavoprotein (Metallo-beta-lactamase superfamily), FpaA | 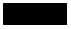 | 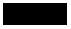 | 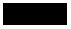 | 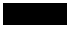 | 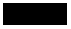 |
| MSM0223 | conserved hypothetical protein | 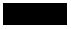 | 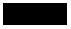 | 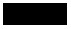 | 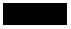 | 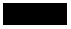 |
| MSM0224 | conserved hypothetical protein | 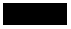 | 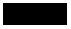 | 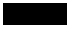 | 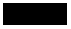 | 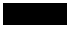 |
| MSM0225 | conserved hypothetical protein | 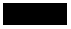 | 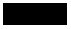 | 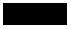 | 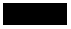 | 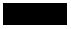 |
| MSM0226 | hypothetical protein | 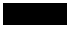 | 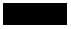 | 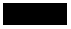 | 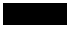 | 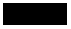 |
| MSM0227 | hydroxymethylglutaryl-CoA (HMG-CoA) reductase, HmgA | 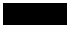 | 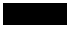 | 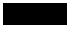 | 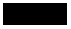 | 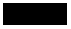 |
| MSM0228 | succinyl-CoA synthetase, alpha subunit, SucD | 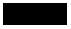 | 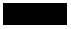 | 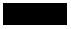 | 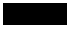 | 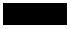 |
| MSM0229 | conserved hypothetical protein | 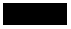 | 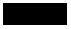 | 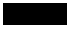 | 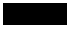 | 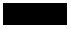 |
| MSM0230 | putative transposase | ND | | | | 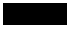 |
| MSM0231 | 3-dehydroquinate dehydratase | 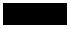 | 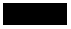 | 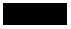 | 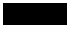 | 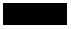 |
| MSM0232 | signal peptidase I | 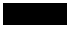 | 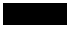 | 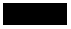 | 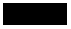 | 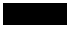 |
| MSM0233 | nitrogen regulatory protein P-II, GlnK | 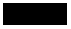 | 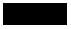 | 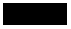 | 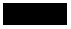 | 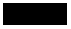 |
| MSM0234 | ammonium transporter | 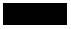 | 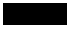 | 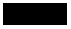 | 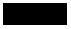 | 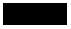 |
| MSM0235 | hypothetical protein | 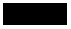 | 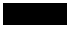 | 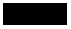 | 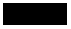 | 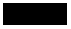 |
| MSM0236 | phosphohydrolase (HD superfamily) | 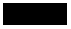 | 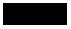 | 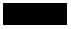 | 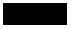 | 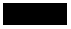 |
| MSM0237 | 3-polyprenyl-4-hydroxybenzoate decarboxylase, UbiX | 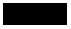 | 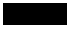 | 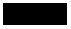 | 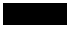 | 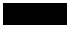 |
| MSM0238 | precorrin-6B methylase, CbiT | 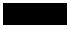 | 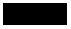 | 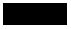 | 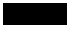 | 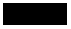 |
| MSM0239 | conserved hypothetical protein | 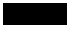 | 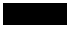 | 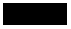 | 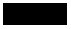 | 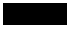 |
| MSM0240 | molybdopterin-guanine dinucleotide biosynthesis protein A, MobA | 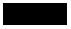 | 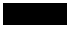 | 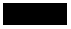 | 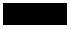 | 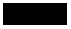 |
| MSM0241 | ribonuclease PH-related protein | 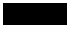 | 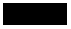 | 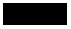 | 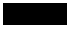 | 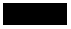 |
| MSM0242 | ribonuclease PH, Rph | 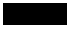 | 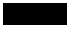 | 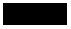 | 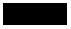 | 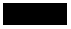 |
| MSM0243 | RNA-binding protein Rrp4 | 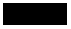 | 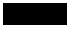 | 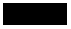 | 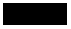 | 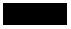 |
| MSM0244 | predicted exosome subunit | 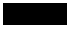 | 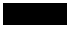 | 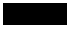 | 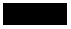 | 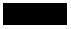 |
| MSM0245 | proteasome, alpha subunit, PsmA | 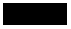 | 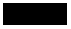 | 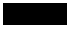 | 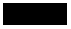 | 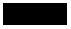 |
| MSM0246 | ribonuclease P, subunit Rpp14 | 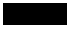 | 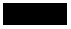 | 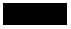 | 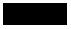 | 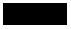 |
| MSM0247 | ribonuclease P, subunit p30 | 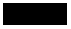 | 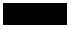 | 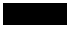 | 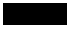 | 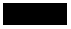 |
| MSM0248 | hypothetical protein | 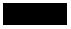 | 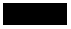 | 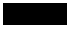 | 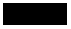 | 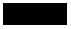 |
| MSM0249 | conserved hypothetical protein | 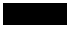 | 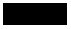 | 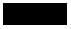 | 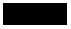 | 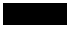 |
| MSM0250 | conserved hypothetical membrane protein (putative zinc-finger domain, Znf265) | 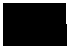 | 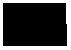 | 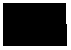 | 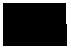 | 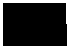 |
| MSM0251 | hypothetical protein | 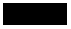 | 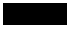 | 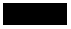 | 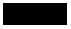 | 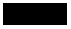 |
| MSM0252 | Na+-driven multidrug efflux pump, NorM | 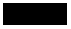 | 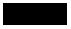 | 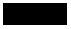 | 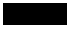 | 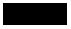 |
| MSM0253 | conserved hypothetical protein | 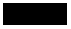 | 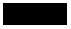 | 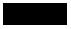 | 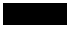 | 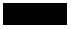 |
| MSM0254 | hypothetical protein | 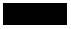 | 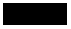 | 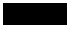 | 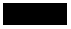 | 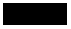 |
| MSM0255 | putative transcription regulator (winged helix DNA-binding domain) | 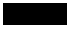 | 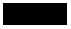 | 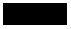 | 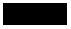 | 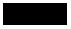 |
| MSM0256 | putative transposase | 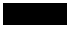 | | 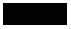 | 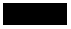 | |
| MSM0257 | conserved hypothetical membrane protein | 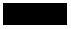 | 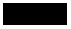 | 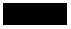 | 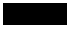 | 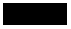 |
| MSM0258 | hypothetical protein (putative zinc-finger domain, Znf265) | 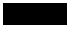 | 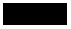 | 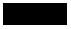 | 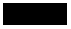 | 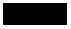 |
| MSM0259 | hypothetical protein (putative zinc beta-ribbon superfamily) | 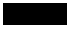 | 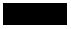 | 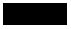 | 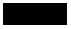 | 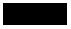 |
| MSM0260 | archaea-specific RecJ-like exonuclease | 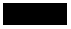 | 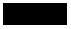 | 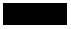 | 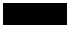 | 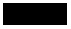 |
| MSM0261 | conserved hypothetical protein | 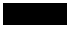 | 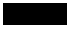 | 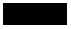 | 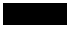 | 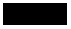 |
| MSM0262 | desulfoferrodoxin (dfx) | 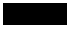 | 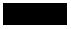 | 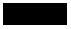 | 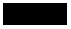 | 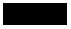 |
| MSM0263 | nitrogen fixation protein, NifU | 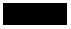 | 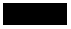 | 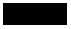 | 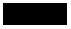 | 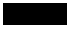 |
| MSM0264 | cysteine desulfurase, NifS | 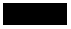 | 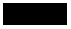 | 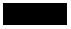 | 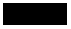 | 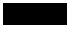 |
| MSM0265 | O-acetylhomoserine sulfhydrylase | 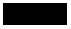 | 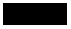 | 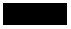 | 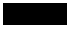 | 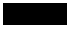 |
| MSM0266 | adhesin-like protein | 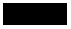 | 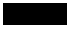 | 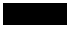 | 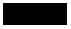 | 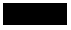 |
| MSM0267 | NAD(P)H-dependent FMN reductase (multimeric flavodoxin) | 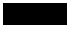 | 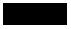 | 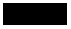 | 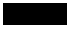 | 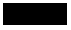 |
| MSM0268 | cysteinyl-tRNA synthetase, CysS | 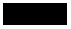 | 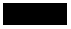 | 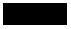 | 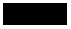 | 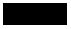 |
| MSM0269 | predicted transcriptional regulator (lambda repressor-like) | 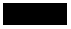 | 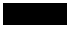 | 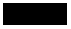 | 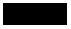 | 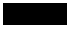 |
| MSM0270 | serine acetyltransferase, CysE | 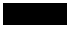 | 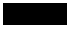 | 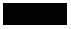 | 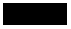 | 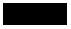 |
| MSM0271 | cysteine synthase, CysK | 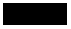 | 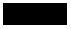 | 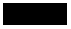 | 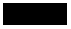 | 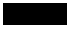 |
| MSM0272 | endonuclease III | 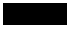 | 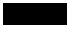 | 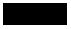 | 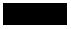 | 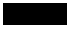 |
| MSM0273 | EPSP synthase (3-phosphoshikimate 1-carboxyvinyltransferase) | 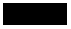 | 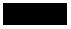 | 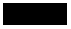 | 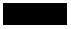 | 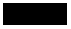 |
| MSM0274 | SAM-dependent methyltransferase (cyclopropane fatty acid synthase-related) | 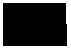 | | | 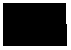 | 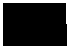 |
| MSM0275 | valyl-tRNA synthetase, ValS | 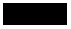 | 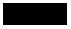 | 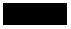 | 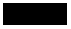 | 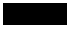 |
| MSM0276 | conserved hypothetical protein | 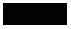 | 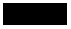 | 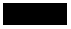 | 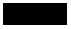 | 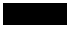 |
| MSM0277 | phenylalanyl-tRNA synthetase, beta subunit, PheT | 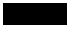 | 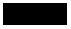 | 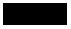 | 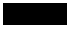 | 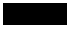 |
| MSM0278 | hypothetical protein | 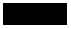 | 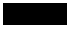 | 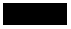 | 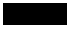 | 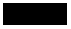 |
| MSM0279 | conserved hypothetical protein (UPF0047 family) | 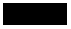 | 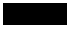 | | 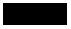 | 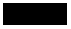 |
| MSM0280 | predicted archaeal ATPase (AAA+ superfamily) | 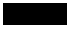 | 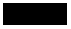 | | 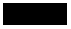 | 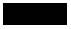 |
| MSM0281 | putative adhesin-like protein | 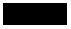 | 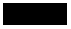 | 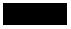 | 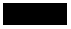 | 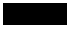 |
| MSM0282 | adhesin-like protein | 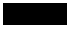 | 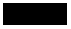 | 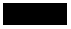 | 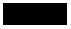 | 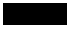 |
| MSM0283 | hypothetical protein | 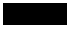 | 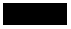 | 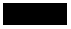 | 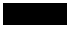 | 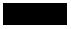 |
| MSM0284 | ribose 5-phosphate isomerase, RpiA | 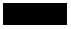 | 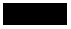 | 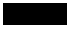 | 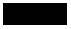 | 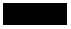 |
| MSM0285 | conserved hypothetical protein (UPF0179 family) | 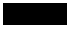 | 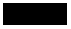 | 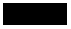 | 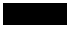 | 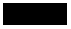 |
| MSM0286 | glycerol 1-phosphate dehydrogenase (Dehydroquinate synthase-like family) | 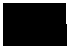 | 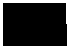 | 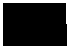 | 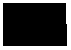 | 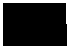 |
| MSM0287 | prolyl-tRNA synthetase, ProS | 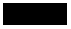 | 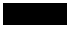 | 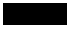 | 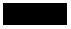 | 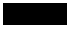 |
| MSM0288 | conserved hypothetical protein (DUF121 daomain) | 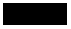 | 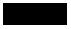 | 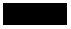 | 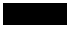 | 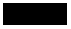 |
| MSM0289 | phosphomethylpyrimidine kinase (HMPP-kinase), ThiD | 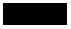 | 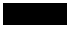 | 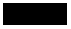 | 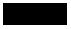 | 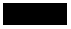 |
| MSM0290 | nitrate/sulfonate/bicarbonate ABC transporter, ATPase component, TauB | 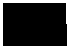 | 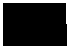 | 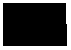 | 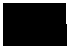 | 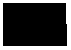 |
| MSM0291 | nitrate/sulfonate/bicarbonate ABC transporter, permease component, TauC | 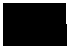 | 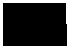 | 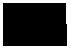 | 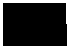 | 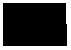 |
| MSM0292 | predicted metal-dependent membrane protease | 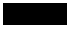 | 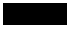 | 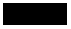 | 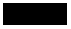 | 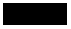 |
| MSM0293 | cation transport ATPase, HAD family | 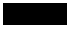 | 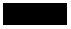 | 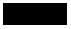 | 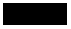 | 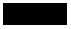 |
| MSM0294 | conserved hypothetical protein | 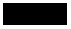 | 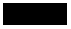 | 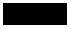 | 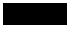 | 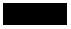 |
| MSM0295 | formate dehydrogenase accessory protein, FdhD | 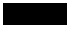 | 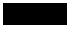 | 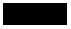 | 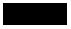 | 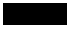 |
| MSM0296 | putative carboxymuconolactone decarboxylase | 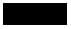 | 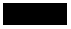 | 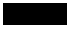 | 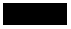 | 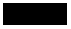 |
| MSM0297 | predicted exosome subunit | 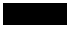 | 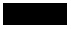 | 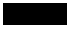 | 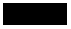 | 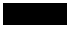 |
| MSM0298 | ribosomal protein L15e | 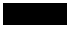 | 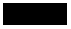 | 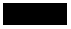 | 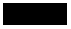 | 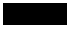 |
| MSM0299 | conserved hypothetical protein | 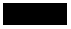 | 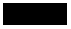 | 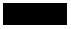 | 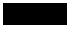 | 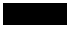 |
| MSM0300 | peptide/nickel ABC transporter, solute-binding component | 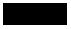 | 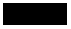 | 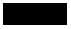 | 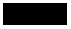 | 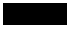 |
| MSM0301 | peptide/nickel ABC transporter, permease component, DppB | 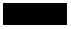 | 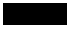 | 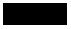 | 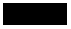 | 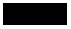 |
| MSM0302 | peptide/nickel ABC transporter, permease component, DppC | 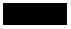 | 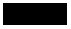 | 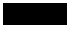 | 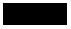 | 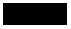 |
| MSM0303 | peptide/nickel ABC transporter, ATP-binding component, DppD | 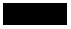 | 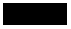 | 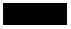 | 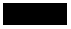 | 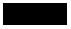 |
| MSM0304 | peptide/nickel ABC transporter, ATP-binding component, DppF | 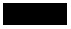 | 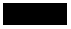 | 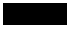 | 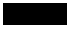 | 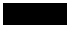 |
| MSM0305 | conserved hypothetical membrane protein (IMP dehydrogenase related) | 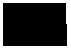 | 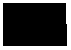 | 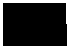 | 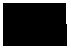 | 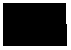 |
| MSM0306 | polyferredoxin, iron-sulfur binding | 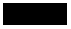 | 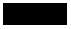 | 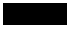 | 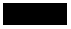 | 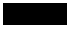 |
| MSM0307 | sugar kinase (ribokinase/pfkB superfamily) | 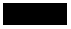 | 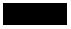 | 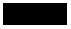 | 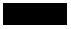 | 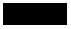 |
| MSM0308 | formylmethanofuran:tetrahydromethanopterin formyltransferase, FtrC | 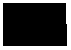 | 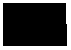 | 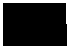 | 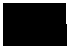 | 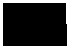 |
| MSM0309 | conserved hypothetical membrane protein | 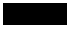 | 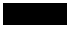 | 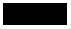 | 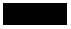 | 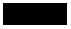 |
| MSM0310 | polyferredoxin, iron-sulfur binding | 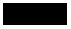 | 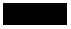 | 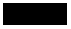 | 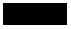 | 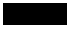 |
| MSM0311 | polyferredoxin, iron-sulfur binding | 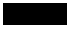 | 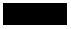 | 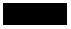 | 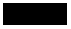 | 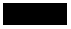 |
| MSM0312 | [NiFe]-hydrogenase-3-type complex, large subunit/NADH:quinine oxidoreductase (complex I), subunit 49 K/NdhH/NuoD | 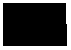 | 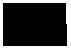 | 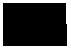 | 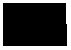 | 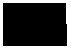 |
| MSM0313 | [NiFe]-hydrogenase-3-type complex, small subunit/NADH:quinine oxidoreductase (complex I), subunit PSST/NdhK/NuoB | 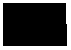 | 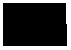 | 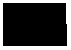 | 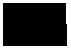 | 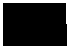 |
| MSM0314 | conserved hypothetical protein | 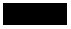 | 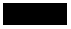 | 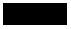 | 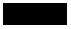 | 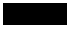 |
| MSM0315 | predicted [NiFe]-hydrogenase-3-type complex Eha, membrane protein EhaL | 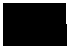 | 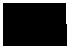 | 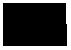 | 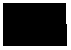 | 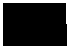 |
| MSM0316 | hypothetical protein | 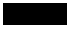 | 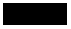 | 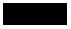 | 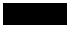 | 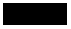 |
| MSM0317 | NADH dehydrogenase (ubiquinone), subunit 1 | 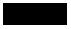 | 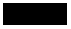 | 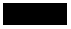 | 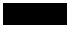 | 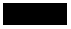 |
| MSM0318 | conserved hypothetical membrane protein | 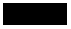 | 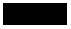 | 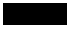 | 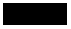 | 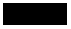 |
| MSM0319 | NADH dehydrogenase I, subunit N related | 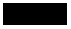 | 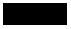 | 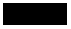 | 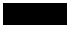 | 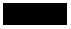 |
| MSM0320 | predicted [NiFe]-hydrogenase-3-type complex Eha, membrane protein EhaG | 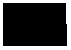 | 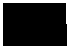 | 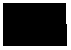 | 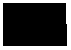 | 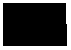 |
| MSM0321 | conserved hypothetical membrane protein | 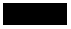 | 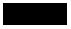 | 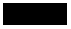 | 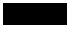 | 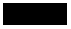 |
| MSM0322 | predicted [NiFe]-hydrogenase-3-type complex Eha, membrane protein EhaE | 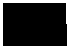 | 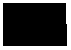 | 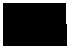 | 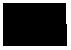 | 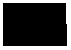 |
| MSM0323 | conserved hypothetical membrane protein | 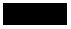 | 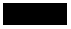 | 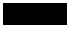 | 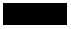 | 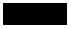 |
| MSM0324 | conserved hypothetical membrane protein | 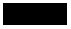 | 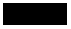 | 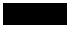 | 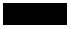 | 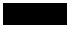 |
| MSM0325 | conserved hypothetical membrane protein | 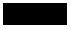 | 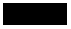 | 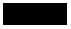 | 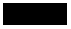 | 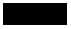 |
| MSM0326 | conserved hypothetical membrane protein | 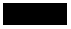 | 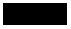 | 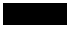 | 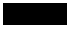 | 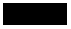 |
| MSM0327 | UDP-glucose 4-epimerase (NAD dependent) | 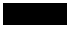 | 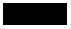 | 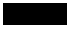 | 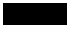 | 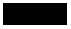 |
| MSM0328 | conserved hypothetical protein | 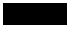 | 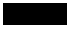 | 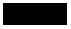 | 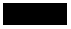 | 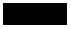 |
| MSM0329 | DNA binding protein (regulator), xenobiotic response element family | 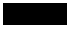 | 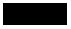 | 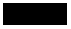 | 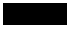 | 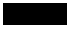 |
| MSM0330 | acetyl-CoA synthetase, AMP-forming-related, Acs | 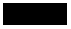 | 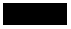 | 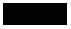 | 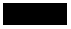 | 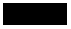 |
| MSM0331 | 2-oxoisovalerate ferredoxin oxidoreductase, delta subunit | 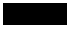 | 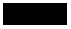 | 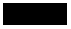 | 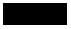 | 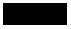 |
| MSM0332 | 2-oxoisovalerate ferredoxin oxidoreductase, alpha subunit | 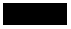 | 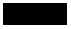 | 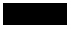 | 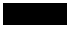 | 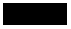 |
| MSM0333 | 2-oxoisovalerate ferredoxin oxidoreductase, beta subunit | 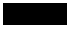 | 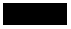 | 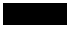 | 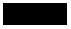 | 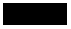 |
| MSM0334 | L-asparaginase, GatD, | 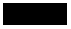 | 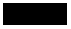 | 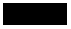 | 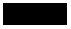 | 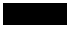 |
| MSM0335 | archaeal glutamyl-tRNA(Gln) amidotransferase, subunit E, GatE | 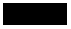 | 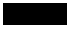 | 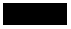 | 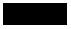 | 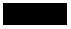 |
| MSM0336 | hypothetical protein | 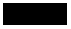 | 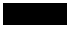 | 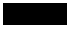 | 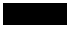 | 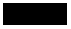 |
| MSM0337 | putative adhesin-like protein | 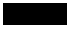 | 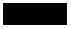 | | 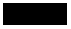 | 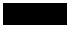 |
| MSM0338 | hypothetical protein | 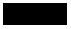 | 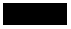 | 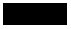 | 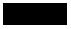 | 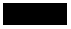 |
| MSM0339 | hypothetical protein | 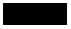 | 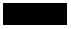 | 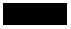 | 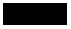 | 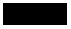 |
| MSM0340 | thioredoxin reductase (NADPH), TrxB | 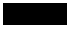 | 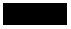 | 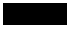 | 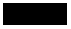 | 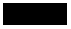 |
| MSM0341 | hypothetical protein | 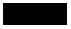 | 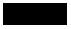 | 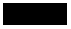 | 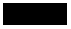 | 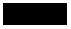 |
| MSM0342 | putative transposase | ND | | | | |
| MSM0343 | GMP synthase (glutamine-hydrolysing), subunit A, GuaA | 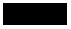 | 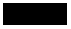 | 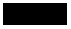 | 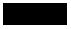 | 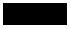 |
| MSM0344 | hypothetical protein | 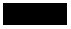 | 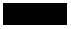 | 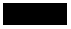 | 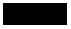 | 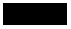 |
| MSM0345 | GMP synthase (glutamine-hydrolysing), PP-ATPase domain/subunit, GuaA | 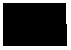 | 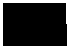 | 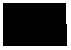 | 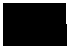 | 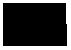 |
| MSM0346 | conserved hypothetical protein | 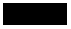 | 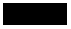 | 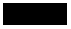 | 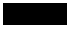 | 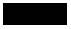 |
| MSM0347 | putative pyridoxal phosphate-dependent enzyme | 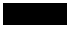 | 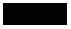 | 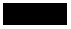 | 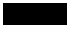 | 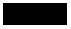 |
| MSM0348 | conserved hypothetical protein | 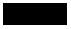 | 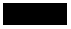 | 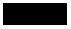 | 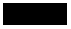 | 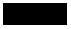 |
| MSM0349 | hypothetical protein | 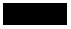 | 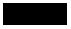 | 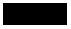 | 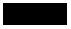 | 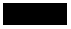 |
| MSM0350 | 2-isopropylmalate synthase, LeuA | 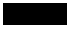 | 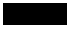 | 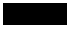 | 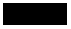 | 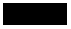 |
| MSM0351 | conserved hypothetical protein | 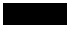 | 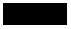 | 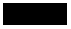 | 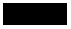 | 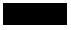 |
| MSM0352 | predicted DNA modification methylase | 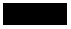 | 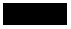 | 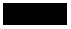 | 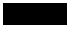 | 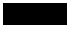 |
| MSM0353 | conserved hypothetical protein | 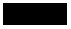 | 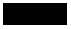 | 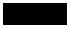 | 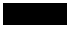 | 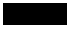 |
| MSM0354 | ATP-dependent 26S proteasome regulatory subunit, RPT1 | 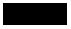 | 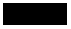 | 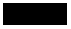 | 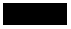 | 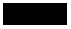 |
| MSM0355 | predicted transcription factor (eukaryotic MBF1 related) | 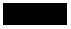 | 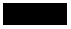 | 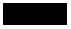 | 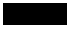 | 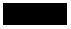 |
| MSM0356 | conserved hypothetical protein | 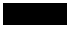 | 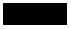 | 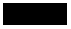 | 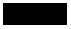 | 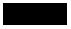 |
| MSM0357 | conserved hypothetical membrane protein (possible Zinc-binding) | 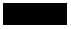 | 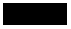 | 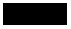 | 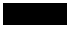 | 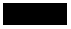 |
| MSM0358 | conserved hypothetical membrane protein | 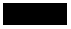 | 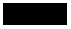 | 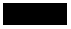 | 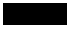 | 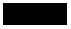 |
| MSM0359 | cell wall biosynthesis protein, MurD-like peptide ligase family | 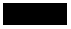 | 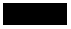 | 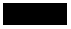 | 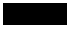 | 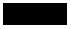 |
| MSM0360 | cell wall biosynthesis protein, phospho-N-acetylmuramoyl- pentapeptidetransferase family | 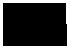 | 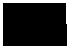 | 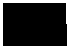 | 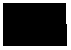 | 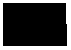 |
| MSM0361 | carbamoyl-phosphate synthase, large subunit, CarB | 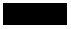 | 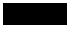 | 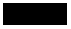 | 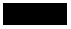 | 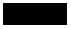 |
| MSM0362 | coenzyme F420-reducing hydrogenase (Ni, Fe-hydrogenase maturation protease), delta subunit | 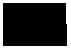 | 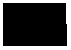 | 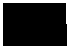 | 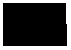 | 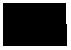 |
| MSM0363 | predicted RNA methylase | 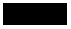 | 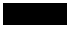 | 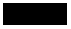 | 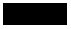 | 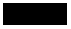 |
| MSM0364 | transcriptional regulator (nickel-responsive), NikR | 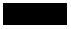 | 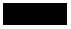 | 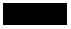 | 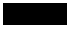 | 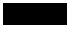 |
| MSM0365 | conserved hypothetical protein | 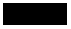 | 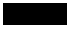 | 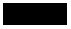 | 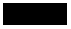 | 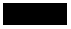 |
| MSM0366 | hypothetical protein | 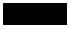 | 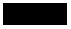 | 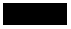 | 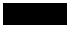 | 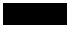 |
| MSM0367 | conserved hypothetical protein | 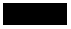 | 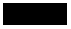 | 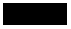 | 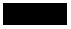 | 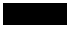 |
| MSM0368 | glutamate synthase (NADPH), subunit 2 | 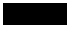 | 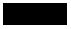 | 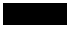 | 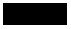 | 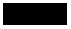 |
| MSM0369 | glutamate synthase, subunit 3 | 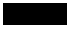 | 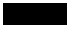 | 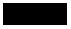 | 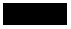 | 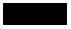 |
| MSM0370 | glutamate synthase, subunit 1 | 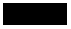 | 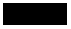 | 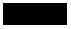 | 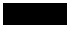 | 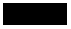 |
| MSM0371 | predicted glutamine amidotransferase involved in pyridoxine biosynthesis, Pdx2 | 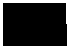 | 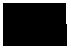 | 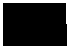 | 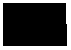 | 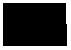 |
| MSM0372 | phycobiliprotein (PBS) lyase (HEAT repeat) | 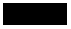 | 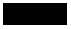 | 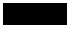 | 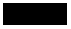 | 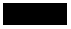 |
| MSM0373 | isocitrate/isopropylmalate dehydrogenase, LeuB | 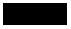 | 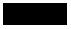 | 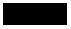 | 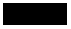 | 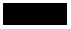 |
| MSM0374 | long-chain fatty-acid-CoA ligase (AMP-forming), CaiC | 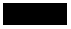 | 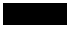 | 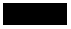 | 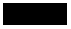 | 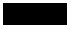 |
| MSM0375 | acetylglutamate kinase, ArgB | 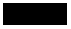 | 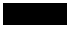 | 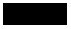 | 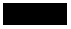 | 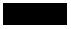 |
| MSM0376 | alcohol dehydrogenase (zinc-binding), GroES-like | 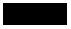 | 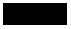 | 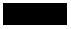 | 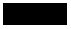 | 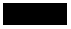 |
| MSM0377 | 4-diphosphocytidyl-2-methyl-D-erithritol synthase, IspD | 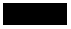 | 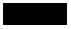 | 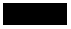 | 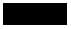 | 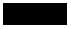 |
| MSM0378 | SAM-dependent methyltransferase | 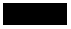 | 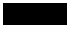 | 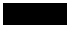 | 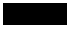 | 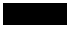 |
| MSM0379 | glutamate N-acetyltransferase, ArgJ | 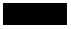 | 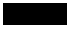 | 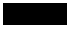 | 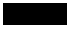 | 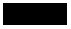 |
| MSM0380 | hypothetical protein | 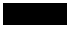 | 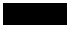 | 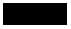 | 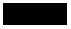 | 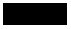 |
| MSM0381 | conserved hypothetical protein | 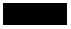 | 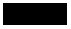 | 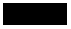 | 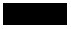 | 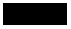 |
| MSM0382 | conserved hypothetical protein (PIN domain-like) | 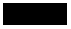 | 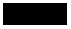 | 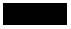 | 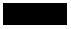 | 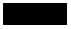 |
| MSM0383 | predicted phosphohydrolase, calcineurin-like superfamily | 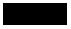 | 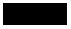 | 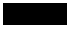 | 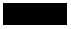 | 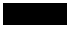 |
| MSM0384 | transcription factor, NACalpha-BTF3 related | 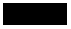 | 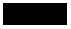 | 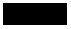 | 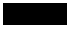 | 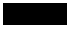 |
| MSM0385 | anaerobic magnesium-protoporphyrin IX monomethyl ester cyclase, Elongator protein 3/MiaB/NifB family | 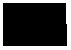 | 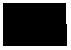 | 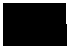 | 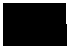 | 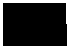 |
| MSM0386 | sodium/proline symporter (proline permease), PutP | 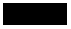 | 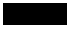 | 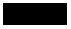 | 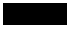 | 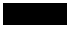 |
| MSM0387 | coenzyme F390 synthetase, PaaK | 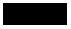 | 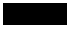 | 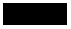 | 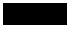 | 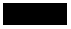 |
| MSM0388 | amino acid regulator | 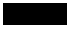 | 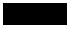 | 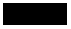 | 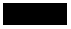 | 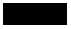 |
| MSM0389 | hypothetical protein | 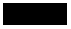 | 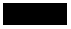 | 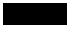 | 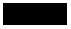 | 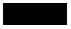 |
| MSM0390 | hypothetical protein | 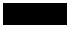 | 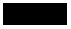 | 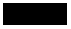 | 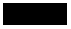 | 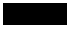 |
| MSM0391 | indolepyruvate ferredoxin oxidoreductase, beta subunit | 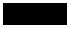 | 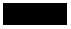 | 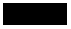 | 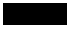 | 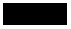 |
| MSM0392 | indolepyruvate ferredoxin oxidoreductase, alpha subunit | 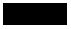 | 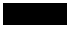 | 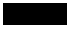 | 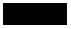 | 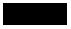 |
| MSM0393 | fumarate reductase, iron-sulfur protein | 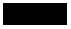 | 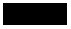 | 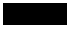 | 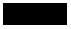 | 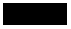 |
| MSM0394 | rRNA methylase, SpoU family | 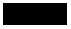 | 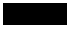 | 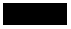 | 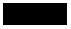 | 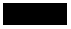 |
| MSM0395 | ferredoxin, iron-sulfur binding | 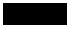 | 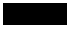 | 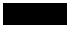 | 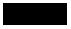 | 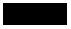 |
| MSM0396 | putative transposase | 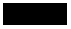 | 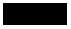 | | | 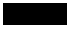 |
| MSM0397 | xanthine/uracil permease, UraA | 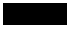 | 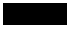 | 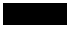 | 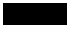 | 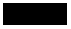 |
| MSM0398 | uracil phosphoribosyltransferase, Upp | 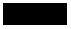 | 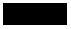 | 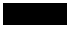 | 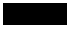 | 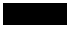 |
| MSM0399 | hypothetical protein | 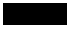 | | | | 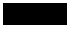 |
| MSM0400 | hypothetical protein | 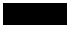 | | | | 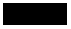 |
| MSM0401 | predicted surface protease | 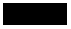 | 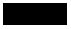 | 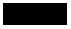 | 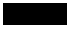 | 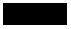 |
| MSM0402 | dCTP deaminase, dUTPase family | 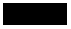 | 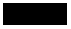 | 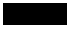 | 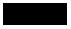 | 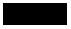 |
| MSM0403 | glycyl-tRNA synthetase | 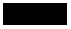 | 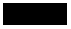 | 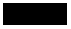 | 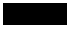 | 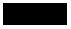 |
| MSM0404 | predicted transcriptional regulator | 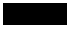 | 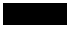 | 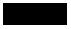 | 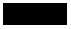 | 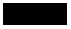 |
| MSM0405 | predicted metal-dependent DNase, TatD-related family | 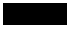 | 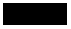 | 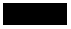 | 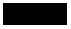 | 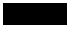 |
| MSM0406 | conserved hypothetical protein | 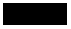 | 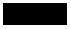 | 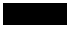 | 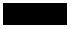 | 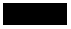 |
| MSM0407 | P-loop containing nucleoside triphosphate hydrolase (NAD(P)- binding) | 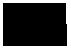 | 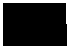 | 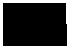 | 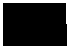 | 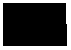 |
| MSM0408 | 2-phosphoglycerate kinase/small-molecule binding protein | 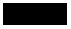 | 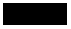 | 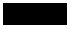 | 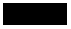 | 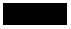 |
| MSM0409 | C4-type Zinc-finger protein | 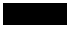 | 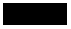 | 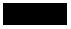 | 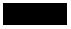 | 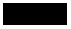 |
| MSM0410 | conserved hypothetical protein, histone-fold superfamily | 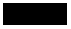 | 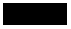 | 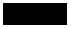 | 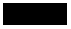 | 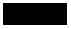 |
| MSM0411 | adhesin-like protein | 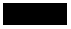 | 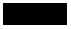 | 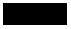 | 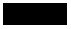 | 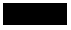 |
| MSM0412 | putative adhesin-like protein | 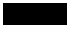 | 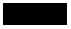 | 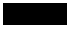 | 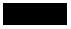 | 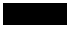 |
| MSM0413 | transcriptional regulator, MarR family | 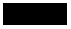 | 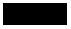 | 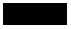 | 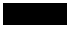 | 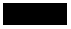 |
| MSM0414 | Na+-driven multidrug efflux pump, NorM | 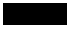 | 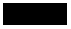 | 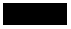 | 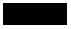 | 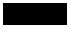 |
| MSM0415 | uridylate kinase, PyrH | 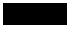 | 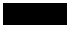 | 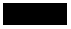 | 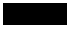 | 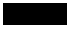 |
| MSM0416 | Mg-dependent DNase, TatD-related | 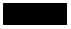 | 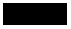 | 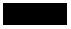 | 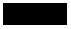 | 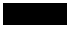 |
| MSM0417 | predicted transmembrane protein with a zinc ribbon | 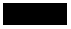 | 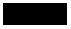 | 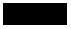 | 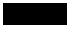 | 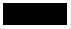 |
| MSM0418 | conserved hypothetical protein | 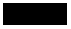 | 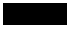 | 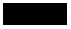 | 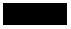 | 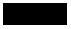 |
| MSM0419 | conserved hypothetical protein | 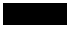 | 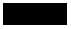 | 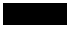 | 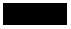 | 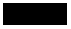 |
| MSM0420 | predicted permease | 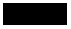 | 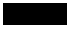 | 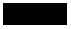 | 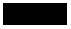 | 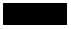 |
| MSM0421 | hypothetical protein | 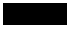 | 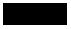 | 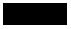 | 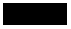 | 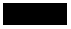 |
| MSM0422 | conserved hypothetical membrane protein | 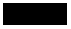 | 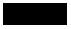 | 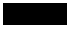 | 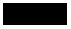 | 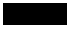 |
| MSM0423 | glycosyltransferase (modular protein with two domains distantly related to glycosyltransferases), GT2/GT1 families [CAZy] | 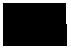 | 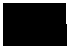 | 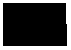 | 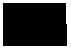 | 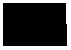 |
| MSM0424 | transcription initiator factor TFIIB (zinc-binding) | 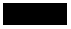 | 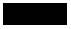 | 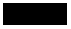 | 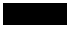 | 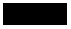 |
| MSM0425 | predicted RNA-binding protein involved in rRNA processing | 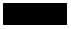 | 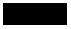 | 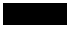 | 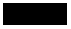 | 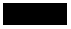 |
| MSM0426 | demethylmenaquinone methyltransferase | 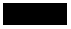 | 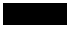 | 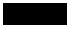 | 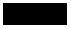 | 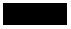 |
| MSM0427 | DNA primase (bacterial type), DnaG | 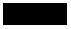 | 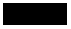 | 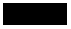 | 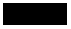 | 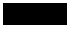 |
| MSM0428 | integrase-recombinase protein, phage integrase family | 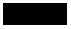 | 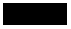 | 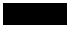 | 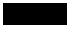 | 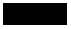 |
| MSM0429 | biotin biosynthesis protein, BioY | 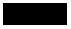 | 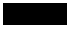 | 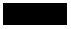 | 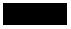 | 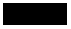 |
| MSM0430 | conserved hypothetical protein, predicted metal-binding | 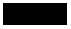 | 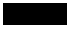 | 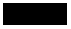 | 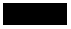 | 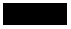 |
| MSM0431 | predicted ATP-dependent carboligase, biotin carboxylase-related | 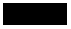 | 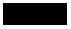 | 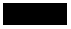 | 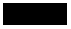 | 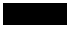 |
| MSM0432 | conserved hypothetical protein | 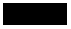 | 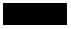 | 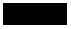 | 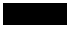 | 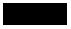 |
| MSM0433 | archaeal/vacuolar-type H+-transporting ATP synthase, subunit D | 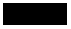 | 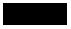 | 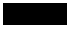 | 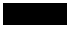 | 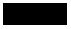 |
| MSM0434 | archaeal/vacuolar-type H+-transporting ATP synthase, subunit B | 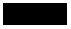 | 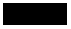 | 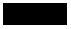 | 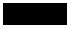 | 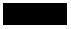 |
| MSM0435 | archaeal/vacuolar-type H+-transporting ATP synthase, subunit A | 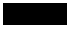 | 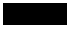 | 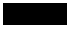 | 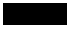 | 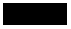 |
| MSM0436 | archaeal/vacuolar-type H+-transporting ATP synthase, subunit F | 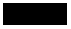 | 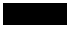 | 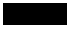 | 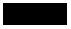 | 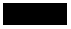 |
| MSM0437 | archaeal/vacuolar-type H+-transporting ATP synthase, subunit C | 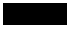 | 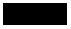 | 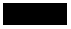 | 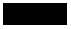 | 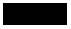 |
| MSM0438 | archaeal/vacuolar-type H+-transporting ATP synthase, subunit E | 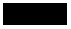 | 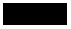 | 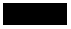 | 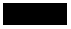 | 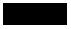 |
| MSM0439 | archaeal/vacuolar-type H+-transporting ATP synthase, subunit K | 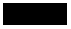 | 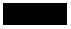 | 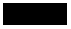 | 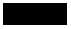 | 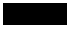 |
| MSM0440 | archaeal/vacuolar-type H+-transporting ATP synthase, subunit I | 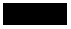 | 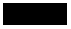 | 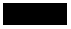 | 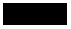 | 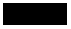 |
| MSM0441 | archaeal/vacuolar-type H+-transporting ATP synthase, subunit H | 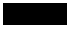 | 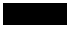 | 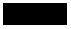 | 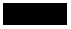 | 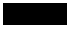 |
| MSM0442 | hypothetical protein | 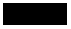 | 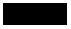 | 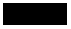 | 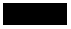 | 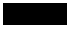 |
| MSM0443 | hypothetical protein | 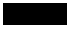 | 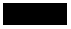 | 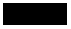 | 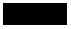 | 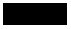 |
| MSM0444 | hypothetical protein | 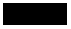 | 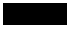 | 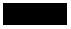 | 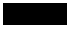 | 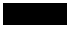 |
| MSM0445 | NADH dehydrogenase/NAD(P)H nitroreductase | 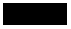 | 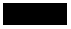 | 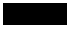 | 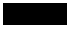 | 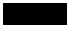 |
| MSM0446 | citrate synthase, GltA | 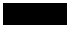 | 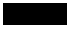 | 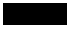 | 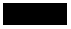 | 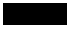 |
| MSM0447 | fumarate hydratase, alpha subunit | 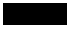 | 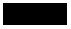 | 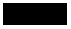 | 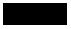 | 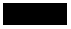 |
| MSM0448 | conserved hypothetical protein | 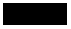 | 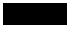 | 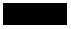 | 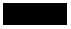 | 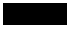 |
| MSM0449 | 2-methylcitrate dehydratase, MmgE/PrpD family | 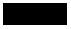 | 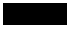 | 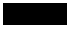 | 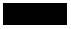 | 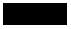 |
| MSM0450 | conserved hypothetical membrane protein | 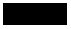 | 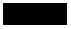 | 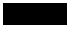 | 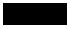 | 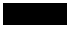 |
| MSM0451 | conserved hypothetical membrane protein | 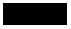 | 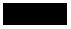 | 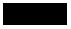 | 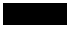 | 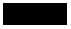 |
| MSM0452 | predicted DNA-binding protein | 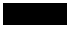 | 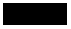 | 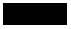 | 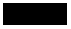 | 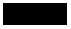 |
| MSM0453 | predicted transcriptional regulator | 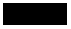 | 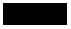 | 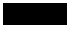 | 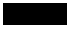 | 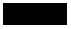 |
| MSM0454 | hypothetical protein | 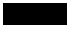 | 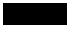 | 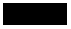 | 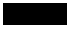 | 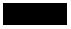 |
| MSM0455 | conserved hypothetical protein | 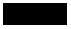 | 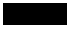 | 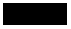 | 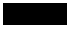 | 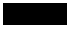 |
| MSM0456 | conserved hypothetical protein | 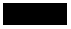 | 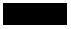 | 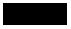 | 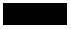 | 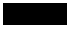 |
| MSM0457 | D-3-phosphoglycerate dehydrogenase, SerA | 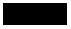 | 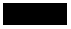 | 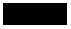 | 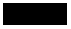 | 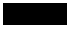 |
| MSM0458 | transposase, homeodomain-like superfamily | ND | | | | 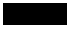 |
| MSM0459 | hypothetical protein | 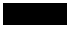 | | 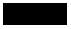 | 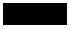 | 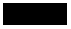 |
| MSM0460 | predicted transposase | 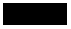 | | | 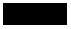 | |
| MSM0461 | adhesion-like protein | 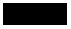 | | 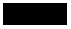 | 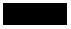 | |
| MSM0462 | predicted metal-dependent protease, PAD1/JAB1 superfamily | 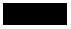 | 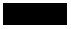 | 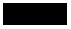 | 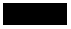 | 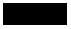 |
| MSM0463 | predicted tRNA (His) guanylyltransferase | 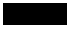 | 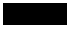 | 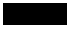 | 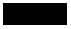 | 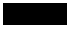 |
| MSM0464 | homoserine/aspartate dehydrogenase (NAD binding), glyceraldehyde-3-phosphate dehydrogenase-like superfamily | 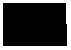 | 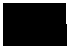 | 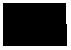 | 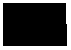 | 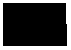 |
| MSM0465 | conserved hypothetical protein | 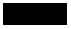 | 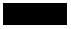 | 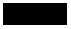 | 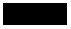 | 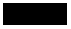 |
| MSM0466 | predicted tRNA-binding protein | 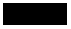 | 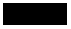 | 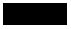 | 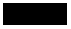 | 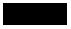 |
| MSM0467 | NADP-dependent glyceraldehyde-3-phosphate dehydrogenase | 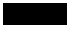 | 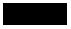 | 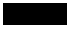 | 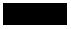 | 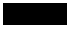 |
| MSM0468 | conserved hypothetical membrane protein | 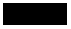 | 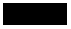 | 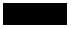 | 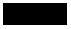 | 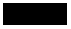 |
| MSM0469 | conserved hypothetical membrane protein | 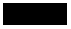 | 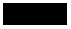 | 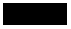 | 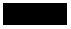 | 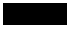 |
| MSM0470 | conserved hypothetical membrane protein | 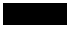 | 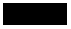 | 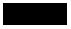 | 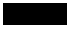 | 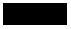 |
| MSM0471 | type II secretion system protein F, GspF | 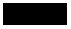 | 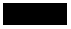 | 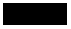 | 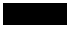 | 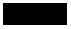 |
| MSM0472 | Xaa-Pro aminopeptidase | 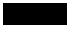 | 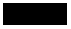 | 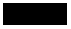 | 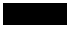 | 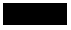 |
| MSM0473 | hypothetical protein | 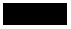 | 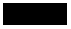 | 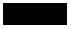 | 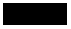 | 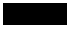 |
| MSM0474 | hypothetical protein | 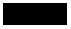 | | | | |
| MSM0475 | hypothetical protein | 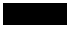 | | | 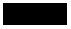 | |
| MSM0476 | hypothetical protein | 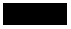 | | | 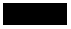 | |
| MSM0477 | hypothetical protein | 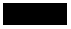 | 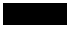 | 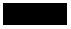 | 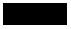 | 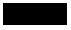 |
| MSM0478 | hypothetical protein | 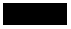 | 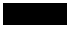 | 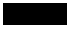 | 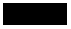 | 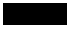 |
| MSM0479 | Zn-dependent protease, peptidase M50 family | 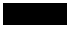 | 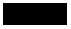 | 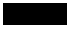 | 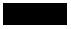 | 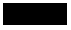 |
| MSM0480 | YcaO-like protein | 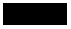 | 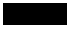 | 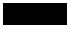 | 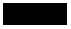 | 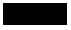 |
| MSM0481 | TfuA-like protein | 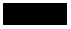 | 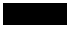 | 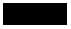 | 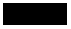 | 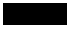 |
| MSM0482 | ATP-utilizing enzymes, PP-loop superfamily | 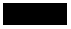 | 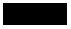 | 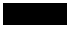 | 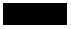 | 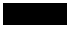 |
| MSM0483 | conserved hypothetical protein | 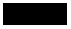 | 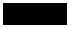 | 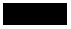 | 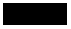 | 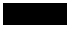 |
| MSM0484 | inosine-5′-monophosphate dehydrogenase related protein | 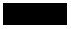 | 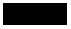 | 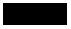 | 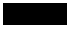 | 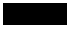 |
| MSM0485 | universal stress protein, UspA | 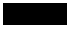 | 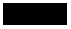 | 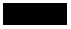 | 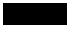 | 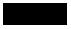 |
| MSM0486 | N-ethylammeline chlorohydrolase, metallo-dependent amidohydrolase family | 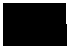 | 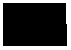 | 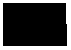 | 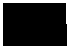 | 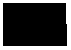 |
| MSM0487 | hypothetical protein | 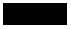 | 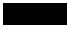 | 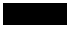 | 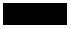 | 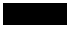 |
| MSM0488 | carbamoylphosphate synthase, large subunit, CarB | 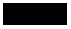 | 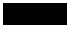 | 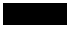 | 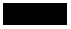 | 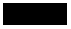 |
| MSM0489 | carbamoylphosphate synthase, small subunit, CarA | 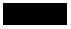 | 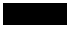 | 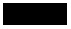 | 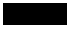 | 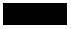 |
| MSM0490 | SAM-dependent methyltransferase, UbiE/CobQ family | 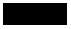 | 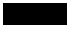 | 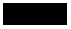 | 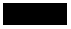 | 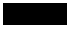 |
| MSM0491 | nicotinate-nucleotide pyrophosphorylase (carboxylating), NadC | 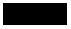 | 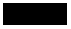 | 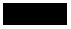 | 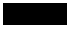 | 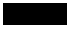 |
| MSM0492 | ribonuclease Z (zinc-dependent), beta-lactamase superfamily, ElaC | 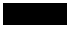 | 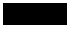 | 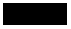 | 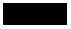 | 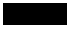 |
| MSM0493 | mechanosensitive ion channel protein, Sm-like ribonucleoprotein superfamily, MscS | 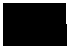 | 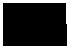 | 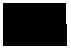 | 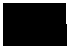 | 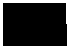 |
| MSM0494 | quiinolinate synthetase, subunit A, NadA | 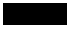 | 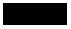 | 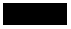 | 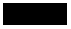 | 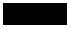 |
| MSM0495 | conserved hypothetical protein | 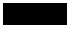 | 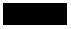 | 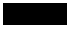 | 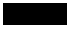 | 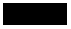 |
| MSM0496 | homoserine O-acetyltransferase | 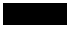 | 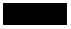 | 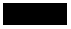 | 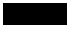 | 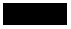 |
| MSM0497 | predicted nuclease, RecB family | 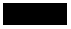 | 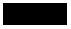 | 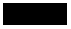 | 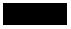 | 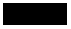 |
| MSM0498 | hypothetical protein | 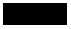 | 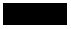 | 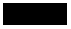 | 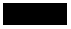 | 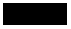 |
| MSM0499 | conserved hypothetical protein | 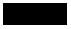 | 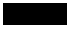 | 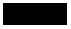 | 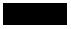 | |
| MSM0500 | N-carbamoyl-D-amino acid amidohydrolase | 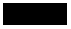 | 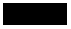 | 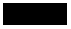 | 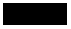 | 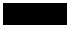 |
| MSM0501 | phycocyanin alpha phycocyanobilin lyase, CpcE | 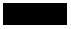 | 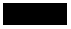 | 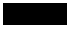 | 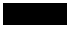 | 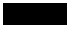 |
| MSM0502 | ATP-depepndent helicase, Lhr-like | 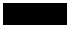 | 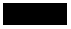 | 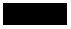 | 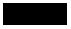 | 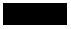 |
| MSM0503 | flavodoxin, FldA | 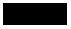 | 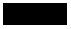 | 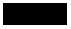 | 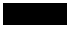 | 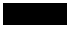 |
| MSM0504 | conserved hypothetical protein | 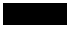 | 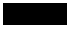 | 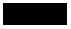 | 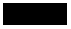 | 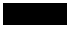 |
| MSM0505 | hypothetical protein | 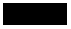 | 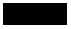 | 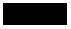 | 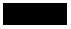 | 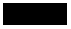 |
| MSM0506 | ATP-utilizing enzyme, ATP-grasp superfamily | 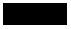 | 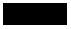 | 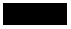 | 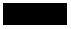 | 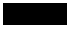 |
| MSM0507 | predicted phosphoesterase, YfcE | 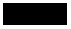 | 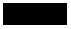 | 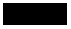 | 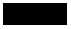 | 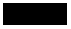 |
| MSM0508 | cell division protein J (23S rRNA methlase), FtsJ | 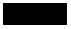 | 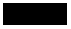 | 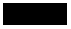 | 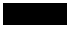 | 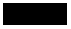 |
| MSM0509 | conserved hypothetical protein | 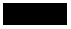 | 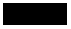 | 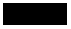 | 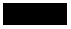 | 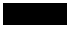 |
| MSM0510 | predicted ATPase involved in DNA replication control, MCM2/3/5 family | 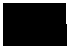 | 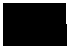 | 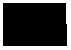 | 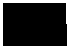 | 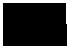 |
| MSM0511 | translation initiator factor 2, beta subunit (alF-2beta) | 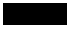 | 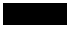 | 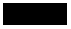 | 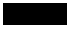 | 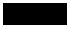 |
| MSM0512 | NMD3-related protein (nonsense mediated mRNA decay) | 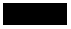 | 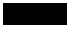 | 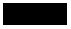 | 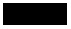 | 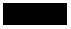 |
| MSM0513 | tyrosyl-tRNA synthetase, TyrS | 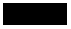 | 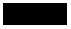 | 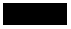 | 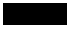 | 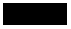 |
| MSM0514 | conserved hypothetical protein | 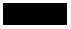 | 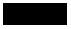 | 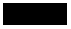 | 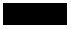 | 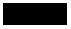 |
| MSM0515 | methanol:cobalamin methyltransferase, MtaB | 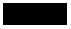 | | 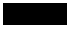 | 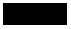 | 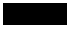 |
| MSM0516 | corrinoid protein (methionine synthase-related), MtaC | 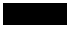 | | 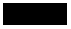 | 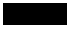 | 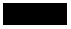 |
| MSM0517 | methyltransferase activation protein, MapA | 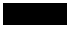 | | 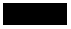 | 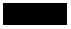 | 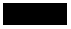 |
| MSM0518 | methylcobalamin:coenzyme M methyltransferase, MtaA | 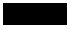 | | 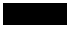 | 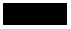 | 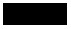 |
| MSM0519 | conserved hypothetical protein | 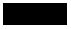 | | 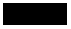 | 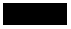 | 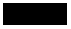 |
| MSM0520 | thymidylate kinase, Tmk | 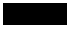 | 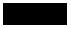 | 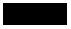 | 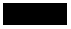 | 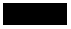 |
| MSM0521 | conserved hypothetical membrane protein | 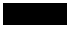 | 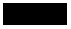 | 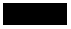 | 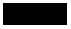 | 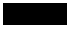 |
| MSM0522 | collagenase, peptidase family U32 | 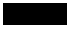 | 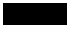 | 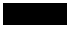 | 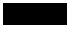 | 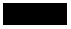 |
| MSM0523 | collagenase, peptidase family U32 | 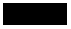 | 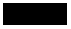 | 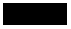 | 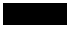 | 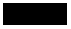 |
| MSM0524 | DNA mismatch repair ATPase, MutS | 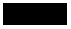 | 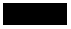 | 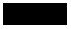 | 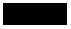 | 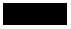 |
| MSM0525 | predicted unusual protein kinase, ubiquinone biosynthesis protein- related, AarF | 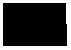 | 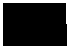 | 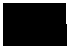 | 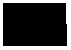 | 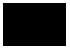 |
| MSM0526 | conserved hypothetical protein | 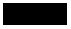 | | | | |
| MSM0527 | IS element ISM1 (ICSNY family) | 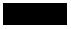 | | 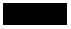 | 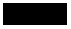 | 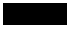 |
| MSM0528 | IS element ISM1 (ICSNY family) | 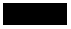 | | 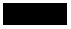 | 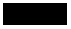 | 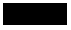 |
| MSM0529 | hypothetical protein | 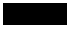 | 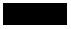 | 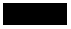 | 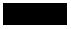 | 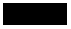 |
| MSM0530 | predicted O-linked GlcNAc transferase | 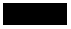 | 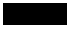 | 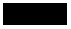 | 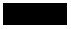 | 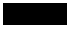 |
| MSM0531 | adenine/cytosine DNA methyltransferase | 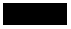 | 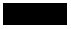 | 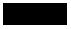 | 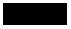 | 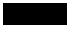 |
| MSM0532 | IS element ISM1 (ICSNY family) | 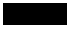 | | | 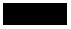 | 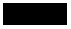 |
| MSM0533 | IS element ISM1 (ICSNY family) | 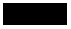 | | 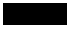 | 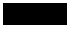 | 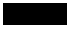 |
| MSM0534 | IS element ISM1 (ICSNY family) | 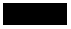 | 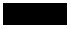 | 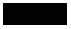 | 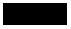 | 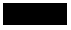 |
| MSM0535 | hypothetical protein | 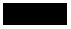 | | 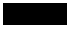 | 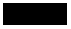 | 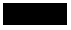 |
| MSM0536 | hypothetical protein | 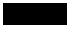 | | 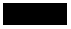 | 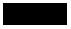 | 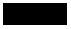 |
| MSM0537 | TPR-repeat protein | 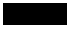 | | 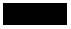 | 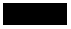 | 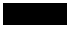 |
| MSM0538 | pyruvate formate-lyase activating enzyme, PflA | 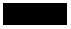 | 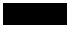 | 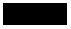 | 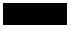 | 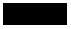 |
| MSM0539 | putative DNA-directed DNA polymerase | 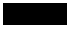 | 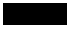 | 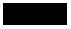 | 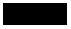 | 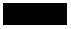 |
| MSM0540 | predicted transcriptional regulator | 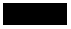 | 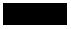 | 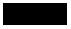 | | 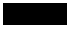 |
| MSM0541 | hypothetical protein | ND | | | | 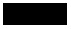 |
| MSM0542 | coenzyme F420-dependent N5, N10-methylene tetrahydromethanopterin | 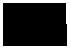 | 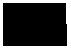 | 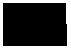 | 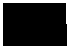 | 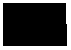 |
| MSM0543 | DNA repair photolyase, SplB | 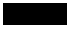 | 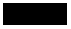 | 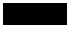 | 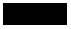 | 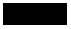 |
| MSM0544 | predicted Fe-S oxidoreductase | 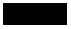 | 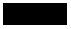 | 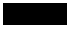 | 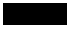 | 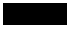 |
| MSM0545 | conserved hypothetical protein | 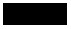 | 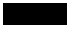 | 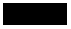 | 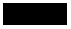 | 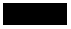 |
| MSM0546 | conserved hypothetical protein | 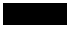 | 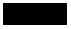 | 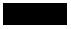 | 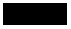 | 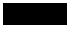 |
| MSM0547 | predicted nucleotidyltransferase, cytidyltransferase-related | 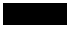 | 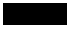 | 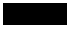 | 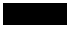 | 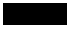 |
| MSM0548 | 6-phosphogluconate dehydrogenase, beta-hydroxyacid dehydrogenase related, MmsB | 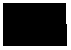 | 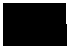 | 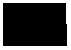 | 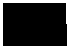 | 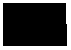 |
| MSM0549 | cytochrome C-type biogenesis protein, DsbD | 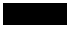 | 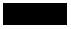 | 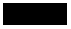 | 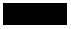 | 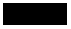 |
| MSM0550 | protein disulfide-isomerase, thioredoxin-related | 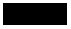 | 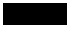 | 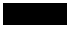 | 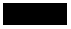 | 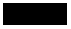 |
| MSM0551 | conserved hypothetical protein | 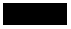 | 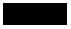 | 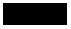 | 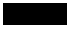 | 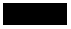 |
| MSM0552 | sulfur transfer protein involved in thiamine biosynthesis | 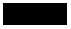 | 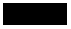 | 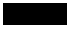 | 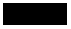 | 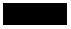 |
| MSM0553 | ATPase, PP-loop superfamily | 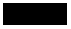 | 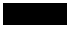 | 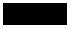 | 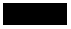 | 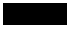 |
| MSM0554 | protein containing von Willebrand factor type A (vWA) domain, CoxE | 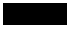 | 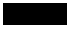 | 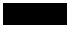 | 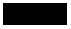 | 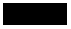 |
| MSM0555 | MoxR-like ATPase | 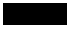 | 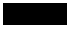 | 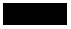 | 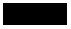 | 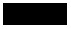 |
| MSM0556 | dihydropteroate synthase | 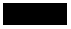 | 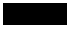 | 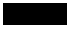 | 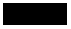 | 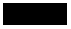 |
| MSM0557 | pyruvate:ferredoxin oxidoreductase, gamma subunit, PorG | 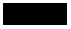 | 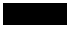 | 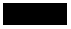 | 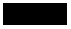 | 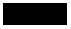 |
| MSM0558 | pyruvate:ferredoxin oxidoreductase, delta subunit, PorD | 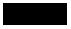 | 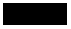 | 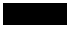 | 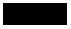 | 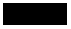 |
| MSM0559 | pyruvate:ferredoxin oxidoreductase, alpha subunit, PorA | 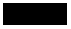 | 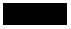 | 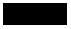 | 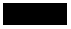 | 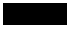 |
| MSM0560 | pyruvate:ferredoxin oxidoreductase, beta subunit, PorB | 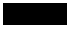 | 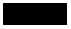 | 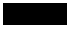 | 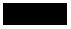 | 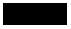 |
| MSM0561 | formate dehydrogenase, iron-sulfur subunit | 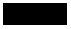 | 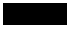 | 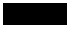 | 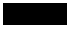 | 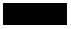 |
| MSM0562 | formate dehydrogenase, iron-sulfur subunit | 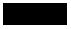 | 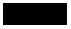 | 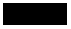 | 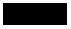 | 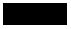 |
| MSM0563 | fumarate hydratease, alpha subunit | 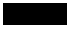 | 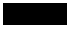 | 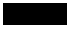 | 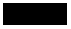 | 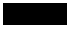 |
| MSM0564 | phosphate uptake regulator, PhoU | 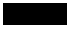 | 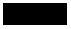 | 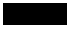 | 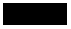 | 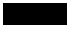 |
| MSM0565 | phosphate ABC transporter, ATPase component, PstB | 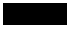 | 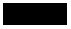 | 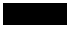 | 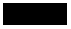 | 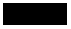 |
| MSM0566 | phosphate ABC transporter, permease component, PstA | 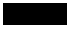 | 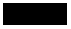 | 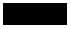 | 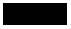 | 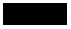 |
| MSM0567 | phosphate ABC transporter, permease component, PstC | 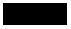 | 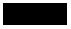 | 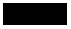 | 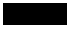 | 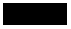 |
| MSM0568 | phosphate ABC transporter, phosphate-binding component, PstS | 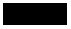 | 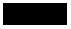 | 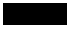 | 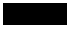 | 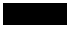 |
| MSM0569 | phosphate transport system regulator related protein, PhoU | 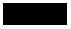 | 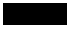 | 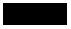 | 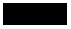 | 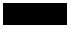 |
| MSM0570 | conserved hypothetical protein | 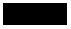 | 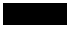 | 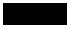 | 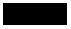 | 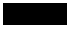 |
| MSM0571 | conserved hypothetical protein | 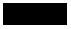 | 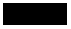 | 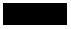 | 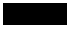 | 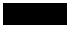 |
| MSM0572 | H2-forming N5, N10-methylenetetrahydromethanopterin dehydrogenase (coenzyme F420-dependent), Mth | 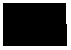 | 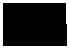 | 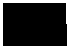 | 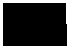 | 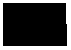 |
| MSM0573 | biotin synthetase, BioB | 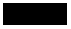 | 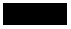 | 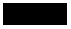 | 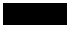 | 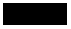 |
| MSM0574 | conserved hypothetical protein | 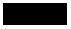 | 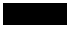 | 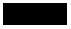 | 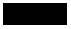 | 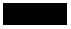 |
| MSM0575 | conserved hypothetical protein | 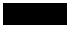 | 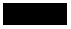 | 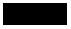 | 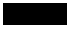 | 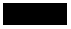 |
| MSM0576 | NIF3-related protein (NGG1p interacting factor 3) | 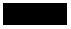 | 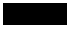 | 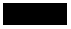 | 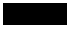 | 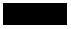 |
| MSM0577 | predicted dinucleotide-utilizing enzyme, ThiF/HesA family | 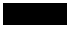 | 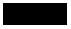 | 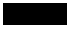 | 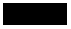 | 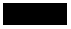 |
| MSM0578 | conserved hypothetical protein | 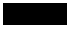 | 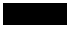 | 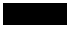 | 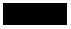 | 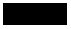 |
| MSM0579 | polyferredoxin, iron-sulfur binding | 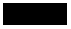 | 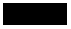 | 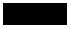 | 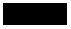 | 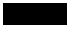 |
| MSM0580 | putative adhesin-like protein | 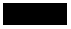 | 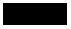 | 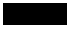 | 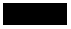 | 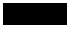 |
| MSM0581 | conserved hypothetical membrane protein | 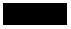 | 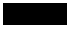 | 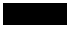 | 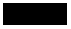 | 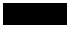 |
| MSM0582 | peptide methionine sulfoxide reductase, PMSR | 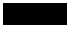 | 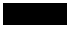 | 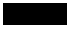 | 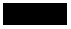 | 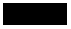 |
| MSM0583 | cobalt ABC transporter, permease component, CbiM | 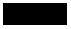 | 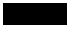 | 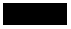 | 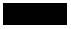 | 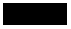 |
| MSM0584 | cobalt ABC transporter, permease component | 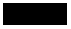 | 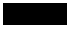 | 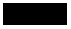 | 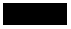 | 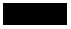 |
| MSM0585 | cobalt ABC transporter, permease component, CbiQ | 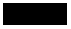 | 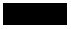 | 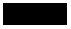 | 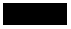 | 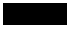 |
| MSM0586 | cobalt ABC transporter, ATPase component, CbiO | 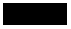 | 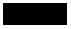 | 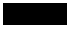 | 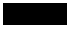 | 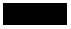 |
| MSM0587 | conserved hypothetical protein | 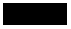 | 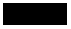 | 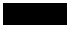 | 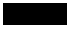 | 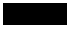 |
| MSM0588 | ferrous iron transport protein A, FeoA | 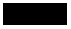 | 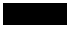 | 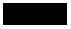 | 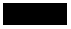 | 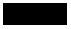 |
| MSM0589 | ferrous iron transport protein B, FeoB | 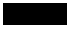 | 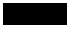 | 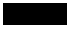 | 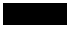 | 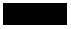 |
| MSM0590 | hypothetical protein | 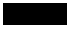 | 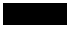 | 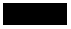 | 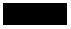 | 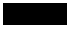 |
| MSM0591 | hypothetical protein | 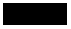 | 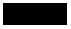 | 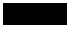 | 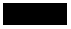 | 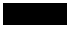 |
| MSM0592 | conserved hypothetical protein | 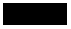 | 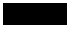 | 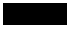 | 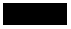 | 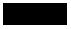 |
| MSM0593 | multidrug ABC transporter, ATPase component, CcmA | 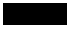 | 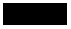 | 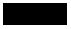 | 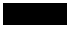 | 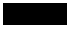 |
| MSM0594 | multidrug ABC transporter, permease component | 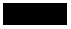 | 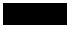 | 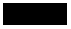 | 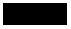 | 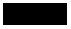 |
| MSM0595 | multidrug ABC transporter, permease component | 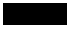 | 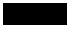 | 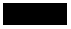 | 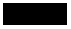 | 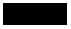 |
| MSM0596 | bacterial type II secretion system protein, GspF | 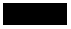 | 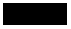 | 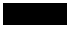 | 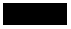 | 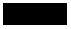 |
| MSM0597 | bacterial type II/IV secretion system protein kinase, GspE | 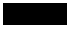 | 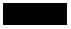 | 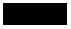 | 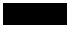 | 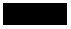 |
| MSM0598 | SAM-dependent methyltransferase | 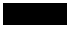 | 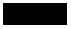 | 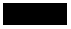 | 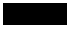 | 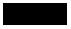 |
| MSM0599 | conserved hypothetical membrane protein | 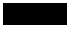 | 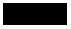 | 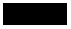 | 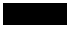 | 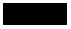 |
| MSM0600 | transcriptional regulator, MarR family | 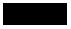 | 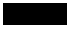 | 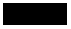 | 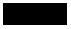 | 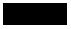 |
| MSM0601 | putative transposase | ND | | | | |
| MSM0602 | translation elongation factor EF-1, beta subunit | 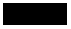 | 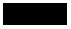 | 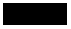 | 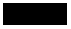 | 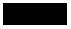 |
| MSM0603 | predicted Zn-ribbon RNA-binding protein involved in translation | 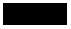 | 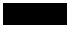 | 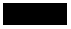 | 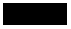 | 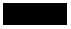 |
| MSM0604 | predicted archaeal aspartate/glutamate/uridylate kinase | 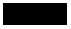 | 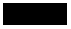 | 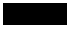 | 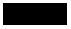 | 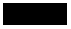 |
| MSM0605 | peptidyl-tRNA hydrolase, PTH2 family | 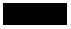 | 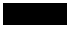 | 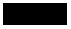 | 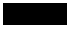 | 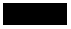 |
| MSM0606 | hypothetical protein | 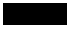 | 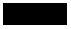 | 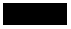 | 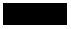 | 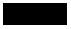 |
| MSM0607 | predicted ATPase, RNase L inhibitor family | 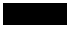 | 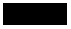 | 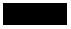 | 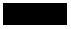 | 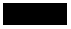 |
| MSM0608 | putative metal-binding protein | 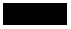 | 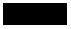 | 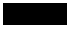 | 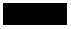 | 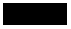 |
| MSM0609 | ferredoxin, iron-sulfur binding | 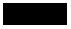 | 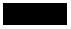 | 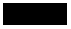 | 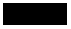 | 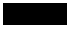 |
| MSM0610 | aspartate aminotransferase | 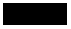 | 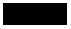 | 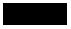 | 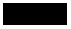 | 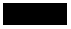 |
| MSM0611 | DNA repair protein, RadB | 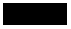 | 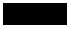 | 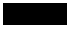 | 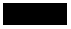 | 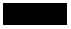 |
| MSM0612 | putative translation factor, Sua5/YciO/YrdC/YwlC family | 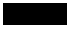 | 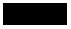 | 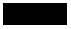 | 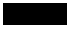 | 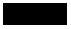 |
| MSM0613 | phosphatidylglycerophosphate synthase, PgsA | 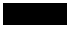 | 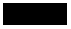 | 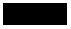 | 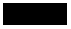 | 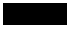 |
| MSM0614 | conserved hypothetical protein | 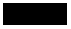 | 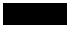 | 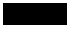 | 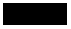 | 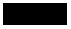 |
| MSM0615 | archaeal fructose 1,6-bisphosphatase | 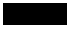 | 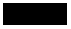 | 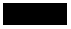 | 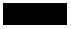 | 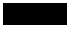 |
| MSM0616 | adhesin-like protein | 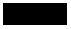 | 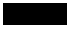 | 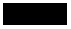 | 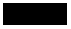 | 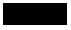 |
| MSM0617 | thiamine biosynthesis ATP pyrophosphatase, Thil | 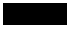 | 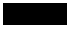 | 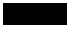 | 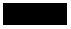 | 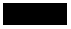 |
| MSM0618 | pH regulator (monovalent cation:H+antiporter | 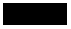 | 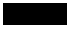 | 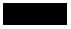 | 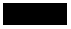 | 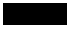 |
| MSM0619 | alanyl-tRNA synthetase, AlaS | 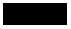 | 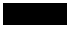 | 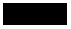 | 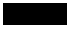 | 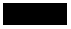 |
| MSM0620 | ribosomal protein L12p | 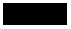 | 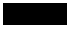 | 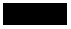 | 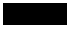 | |
| MSM0621 | ribosomal protein L10p | 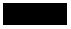 | 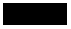 | 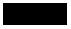 | 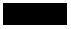 | 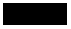 |
| MSM0622 | ribosomal protein L1p | 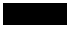 | 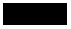 | 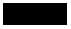 | 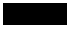 | 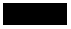 |
| MSM0623 | ribosomal protein L11 | 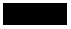 | 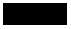 | 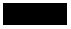 | 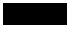 | 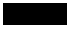 |
| MSM0624 | transcription antiterminator, NusG | 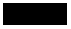 | 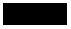 | 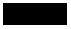 | 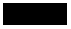 | 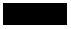 |
| MSM0625 | protein translocation complex sec61, gamma subunit | 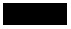 | 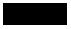 | 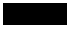 | 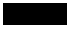 | 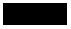 |
| MSM0626 | cell division protein, FtsZ | 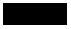 | 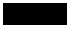 | 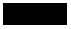 | 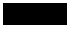 | 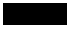 |
| MSM0627 | tetrahydromethanopterin S-methyltransferase, subunit H, MtrH | 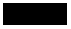 | 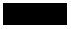 | 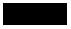 | 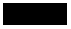 | 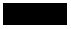 |
| MSM0628 | conserved hypothetical protein | 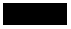 | 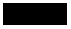 | 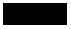 | 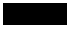 | 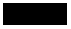 |
| MSM0629 | putative transposase | ND | | | | 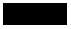 |
| MSM0630 | conserved hypothetical protein | 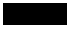 | 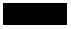 | 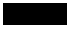 | 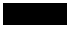 | 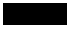 |
| MSM0631 | transcription initiator factor IIE, alpha unit | 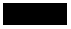 | 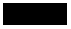 | 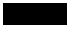 | 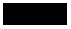 | 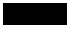 |
| MSM0632 | predicted hydrolase, HD superfamily | 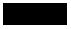 | 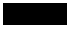 | 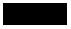 | 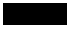 | 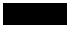 |
| MSM0633 | archaeosine tRNA-ribosyltransferase | 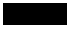 | 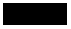 | 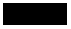 | 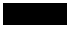 | 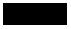 |
| MSM0634 | predicted metal-sulfur cluster biosynthetic enzyme | 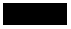 | 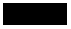 | 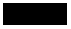 | 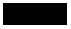 | 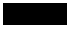 |
| MSM0635 | predicted regulator of amino acid metabolism | 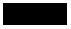 | 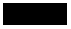 | 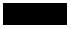 | 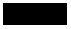 | 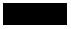 |
| MSM0636 | hydrogenase expression/formation protein, HypC | 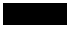 | 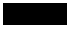 | 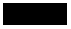 | 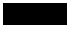 | 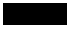 |
| MSM0637 | dihydrolipoamide dehydrogenase | 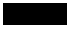 | 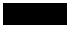 | 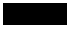 | 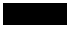 | 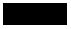 |
| MSM0638 | pfam match to MurG; not predicted to be a carbohydrate active enzyme by CAZy | 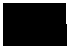 | 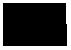 | 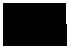 | 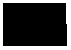 | 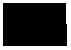 |
| MSM0639 | putative cell wall biosynthesis protein | 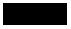 | 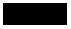 | 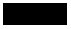 | 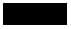 | 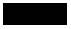 |
| MSM0640 | cell division protein (RNA-binding), PeIA | 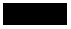 | 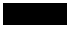 | 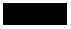 | 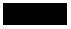 | 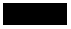 |
| MSM0641 | prephenate dehydrogenase (NADP+) | 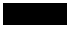 | 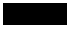 | 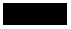 | 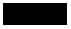 | 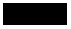 |
| MSM0642 | cell divison control protein Cdc48, AAA+ATPase family | 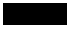 | 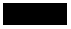 | 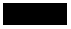 | 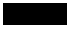 | 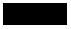 |
| MSM0643 | conserved hypothetical protein | 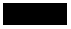 | 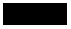 | 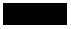 | 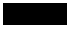 | 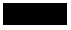 |
| MSM0644 | thiamine biosynthesis protein, ThiC | 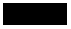 | 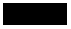 | 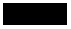 | 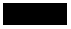 | 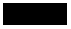 |
| MSM0645 | ATP-dependent DNA ligase, Cdc9 | 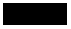 | 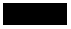 | 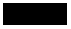 | 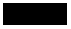 | 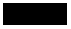 |
| MSM0646 | conserved hypothetical protein | 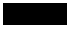 | 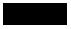 | 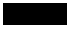 | 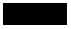 | 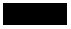 |
| MSM0647 | predicted RNA-binding protein, contains TRAM domain | 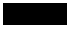 | 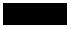 | 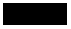 | 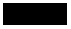 | 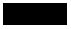 |
| MSM0648 | phosphomannomutase, ManB | 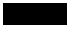 | 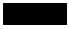 | 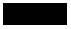 | 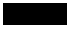 | 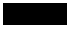 |
| MSM0649 | conserved hypothetical protein | 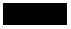 | 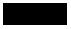 | 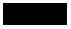 | 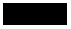 | 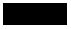 |
| MSM0650 | transcriptional regulator, TetR/AcrR family | 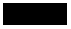 | 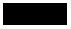 | 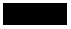 | 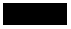 | 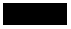 |
| MSM0651 | best blast hit to MTH1585; not predicted to be a carbohydrate active enzyme by CAZy | 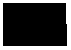 | 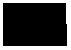 | 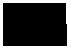 | 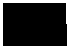 | 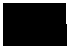 |
| MSM0652 | pyruvate formate-lyase activating enzyme, PflA | 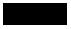 | 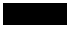 | 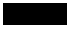 | 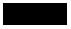 | 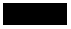 |
| MSM0653 | histidinol-phosphate aminotransferase, HisC | 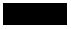 | 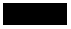 | 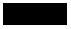 | 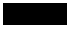 | 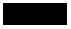 |
| MSM0654 | carbonic anhydrase, Cab | 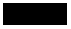 | 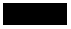 | 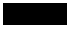 | 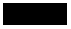 | 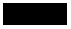 |
| MSM0655 | glucose-1-phosphate thymidylyltransferase | 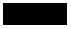 | 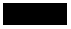 | 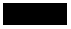 | 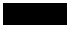 | 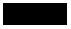 |
| MSM0656 | phosphomannomutase, ManB | 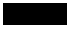 | 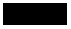 | 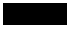 | 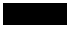 | 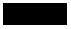 |
| MSM0657 | phosphoglycerate mutase, AP superfamily | 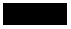 | 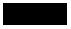 | 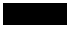 | 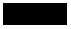 | 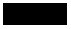 |
| MSM0658 | hypothetical protein | 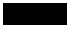 | 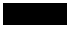 | 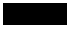 | 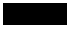 | 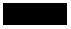 |
| MSM0659 | conserved hypothetical membrane protein | 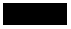 | 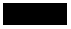 | 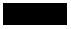 | 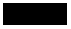 | 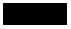 |
| MSM0660 | LemA protein | 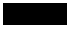 | 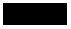 | 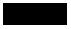 | 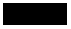 | 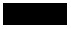 |
| MSM0661 | small subunit ribosomal protein S3Ae | 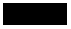 | 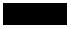 | 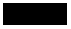 | 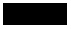 | 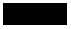 |
| MSM0662 | putative flagellar protein, FliL | 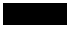 | 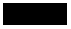 | 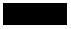 | 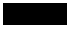 | 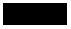 |
| MSM0663 | dinitrogenase iron-molybdenum cofactor biosynthesis protein, NifX_NifB family | 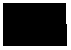 | 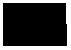 | 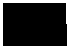 | 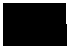 | 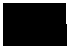 |
| MSM0664 | multimeric flavodoxin, NADPH-dependent FMN reductase family | 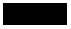 | 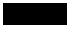 | 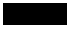 | 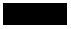 | 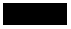 |
| MSM0665 | 5′-methylthioadenosine phosphorylase | 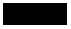 | 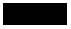 | 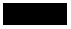 | 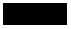 | 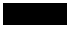 |
| MSM0666 | conserved hypothetical protein | 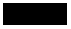 | 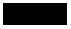 | 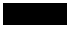 | 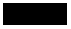 | 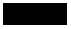 |
| MSM0667 | conserved hypothetical protein | 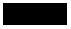 | 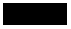 | 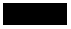 | 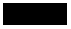 | 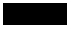 |
| MSM0668 | conserved hypothetical protein | 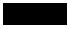 | 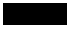 | 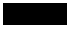 | 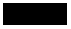 | 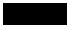 |
| MSM0669 | hypothetical protein | 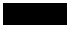 | 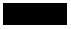 | 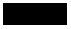 | 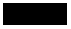 | 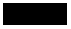 |
| MSM0670 | conserved hypothetical protein | 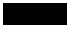 | 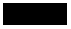 | 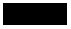 | 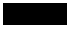 | 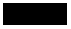 |
| MSM0671 | cell division control protein Cdc6-related, AAA+ATPase superfamily | 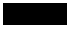 | 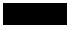 | 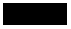 | 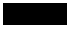 | 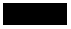 |
| MSM0672 | thiamine pyrophosphokinase | 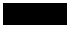 | 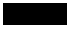 | 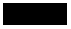 | 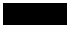 | 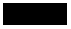 |
| MSM0673 | conserved hypothetical membrane protein | 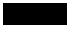 | 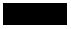 | 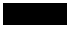 | 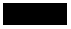 | 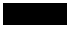 |
| MSM0674 | hypothetical protein | 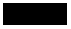 | 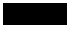 | 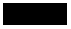 | 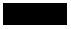 | 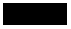 |
| MSM0675 | hypothetical protein | 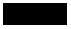 | 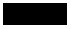 | 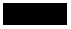 | 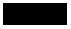 | 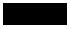 |
| MSM0676 | conserved hypothetical membrane protein | 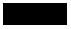 | 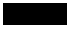 | 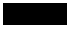 | 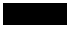 | 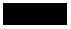 |
| MSM0677 | archaeal aspartate aminotransferase | 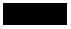 | 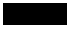 | 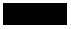 | 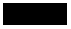 | 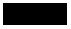 |
| MSM0678 | conserved hypothetical membrane protein | 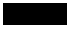 | 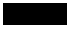 | | | |
| MSM0679 | conserved hypothetical membrane protein | 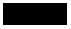 | | | | |
| MSM0680 | predicted ATPase, AAA+ superfamily | 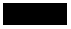 | | | 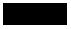 | |
| MSM0681 | conserved hypothetical protein | 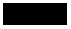 | 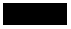 | 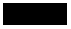 | 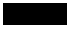 | 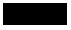 |
| MSM0682 | hypothetical protein | 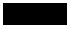 | 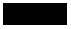 | 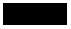 | 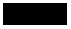 | 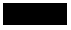 |
| MSM0683 | conserved hypothetical protein | 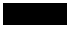 | 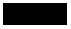 | 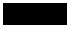 | 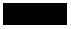 | 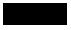 |
| MSM0684 | conserved hypothetical protein | 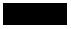 | 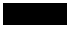 | 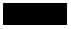 | 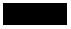 | 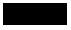 |
| MSM0685 | hypothetical protein | 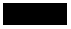 | 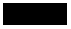 | 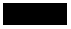 | 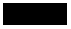 | 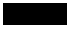 |
| MSM0686 | acetolactate synthase (TPP-requiring), large subunit, IIvB | 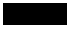 | 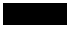 | 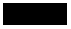 | 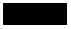 | 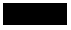 |
| MSM0687 | deoxycytidine-triphosphate deaminase, Dcd | 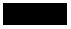 | 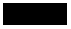 | 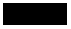 | 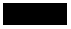 | 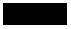 |
| MSM0688 | 4-oxalocrotonate tautomerase | 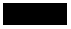 | 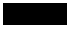 | 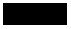 | 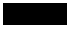 | 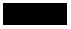 |
| MSM0689 | hypothetical protein | 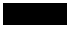 | 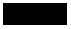 | 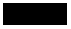 | 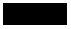 | 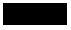 |
| MSM0690 | helicase | 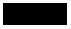 | 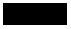 | 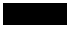 | 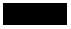 | 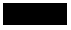 |
| MSM0691 | mutator mutT protein (NUDIX domain) | 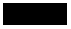 | 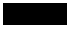 | 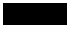 | 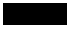 | 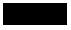 |
| MSM0692 | conserved hypothetical protein | 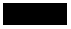 | 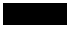 | 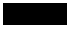 | 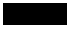 | |
| MSM0693 | ATPase involved in DNA repair, SbcC | 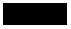 | | | | |
| MSM0694 | hypothetical protein | 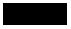 | | | | |
| MSM0695 | DNA repair helicase | 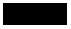 | | | | 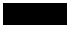 |
| MSM0696 | Fe-S oxidoreductase | 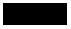 | | | 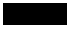 | 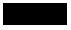 |
| MSM0697 | hypothetical protein | 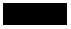 | 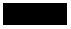 | 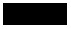 | 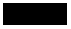 | 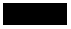 |
| MSM0698 | hypothetical protein | 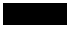 | 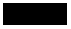 | 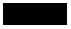 | 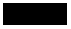 | 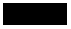 |
| MSM0699 | Na+-dependent transporter, SNF family | 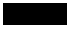 | 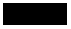 | 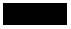 | 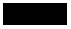 | 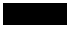 |
| MSM0700 | putative poly-gamma-glutamate synthesis protein, PgsA | 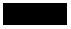 | 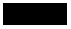 | 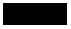 | 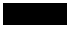 | 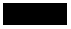 |
| MSM0701 | signal recognition particle GTPase SRP54 | 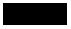 | 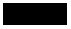 | 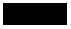 | 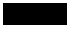 | 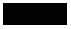 |
| MSM0702 | predicted prefoldin, alpha subunit | 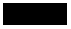 | 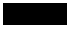 | 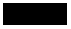 | 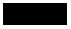 | 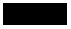 |
| MSM0703 | ribosomal protein LX | 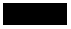 | 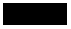 | 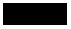 | 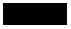 | 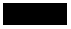 |
| MSM0704 | translation initiation factor 6 (alF-6) | 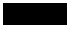 | 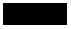 | 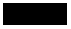 | 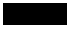 | 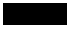 |
| MSM0705 | ribosomal protein L31a | 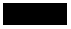 | 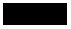 | 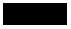 | 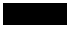 | 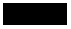 |
| MSM0706 | ribosomal protein L39a | 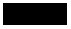 | 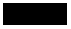 | 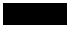 | 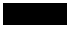 | 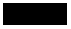 |
| MSM0707 | predicted subunit of tRNA methyltransferase | 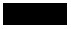 | 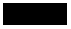 | 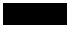 | 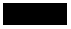 | 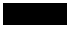 |
| MSM0708 | dsDNA-binding protein | 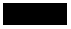 | 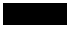 | 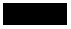 | 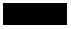 | 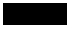 |
| MSM0709 | ribosomal protein S16a | 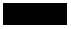 | 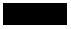 | 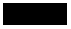 | 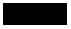 | 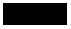 |
| MSM0710 | RNA-binding protein, CRS1/YhbY family | 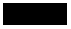 | 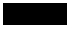 | 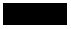 | 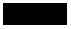 | 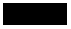 |
| MSM0711 | ribonuclease P, subunit RPR2 | 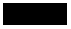 | 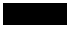 | 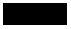 | 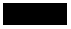 | 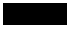 |
| MSM0712 | conserved hypothetical protein (DUF1696 domain) | 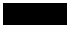 | 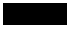 | 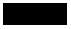 | 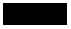 | 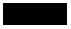 |
| MSM0713 | predicted nucleotide kinase | 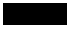 | 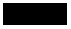 | 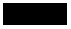 | 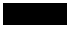 | 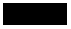 |
| MSM0714 | predicted GTPase | 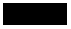 | 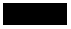 | 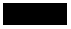 | 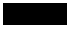 | 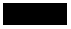 |
| MSM0715 | predicted GTPase | 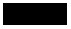 | 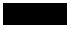 | 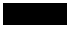 | 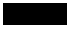 | 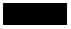 |
| MSM0716 | oligosaccharyl transferase, STT3 subunit | 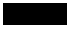 | 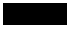 | 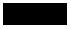 | 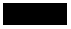 | 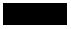 |
| MSM0717 | DNA topoisomerase I, TopA | 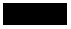 | 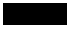 | 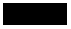 | 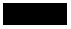 | 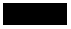 |
| MSM0718 | conserved hypothetical protein | 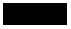 | 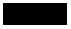 | 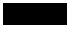 | 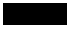 | 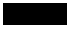 |
| MSM0719 | phosphoserine phosphatase, HAD family, SerB | 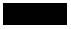 | 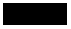 | 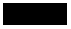 | 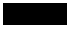 | 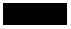 |
| MSM0720 | transcription initiator factor TFIID TATA binding protein | 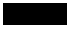 | 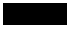 | 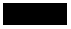 | 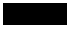 | 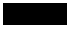 |
| MSM0721 | adenylate cyclase, class 2 | 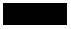 | 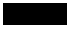 | 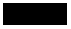 | 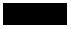 | 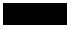 |
| MSM0722 | 2-isopropylmalate synthase, LeuA | 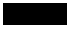 | 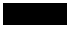 | 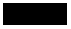 | 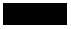 | 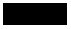 |
| MSM0723 | 3-isopropylmalate dehydratase, LeuC | 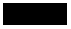 | 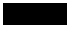 | 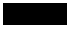 | 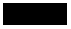 | 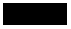 |
| MSM0724 | 4-hydroxybenzoate synthetase (chorismate lyase) | 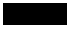 | 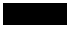 | 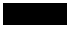 | 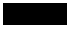 | 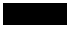 |
| MSM0725 | DNA repair flap structure-specific 5′-3′ endonuclease | 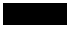 | 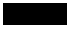 | 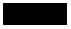 | 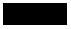 | 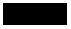 |
| MSM0726 | conserved hypothetical protein | 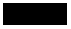 | 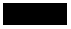 | 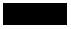 | 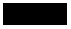 | 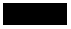 |
| MSM0727 | S-adenosylhomocysteine hydrolase (adenosylhomocysteinase), AhcY | 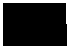 | 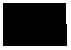 | 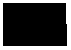 | 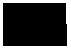 | 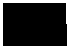 |
| MSM0728 | predicted oxidoreductase, aldo/keto reductase family | 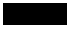 | 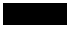 | 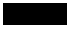 | 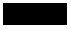 | 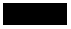 |
| MSM0729 | molybdopterin biosynthesis protein, MoeB | 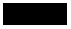 | 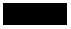 | 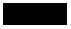 | 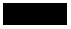 | 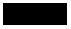 |
| MSM0730 | putative transposase | ND | | | | |
| MSM0731 | putative DNA helicase II, UvrD | 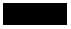 | 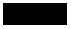 | 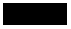 | 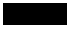 | 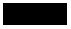 |
| MSM0732 | tRNA pseudouridine synthase B, TruB | 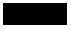 | 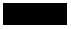 | 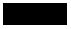 | 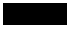 | 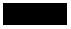 |
| MSM0733 | ribosomal protein L14e | 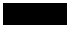 | 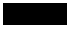 | 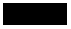 | 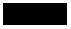 | 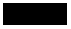 |
| MSM0734 | cytidylate kinase, Cmk | 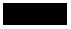 | 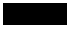 | 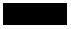 | 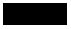 | 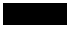 |
| MSM0735 | ribosomal protein L34e | 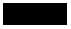 | 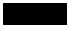 | 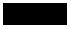 | 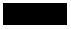 | 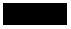 |
| MSM0736 | conserved hypothetical membrane protein | 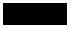 | 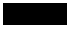 | 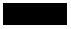 | 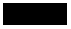 | 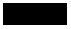 |
| MSM0737 | archaeal adenylate kinase, AdkA | 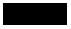 | 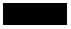 | 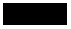 | 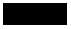 | 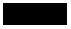 |
| MSM0738 | preproetin translocase, SecY subunit, SecY | 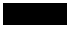 | 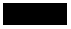 | 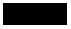 | 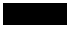 | 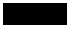 |
| MSM0739 | ribosomal protein L15p | 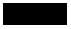 | 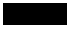 | 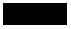 | 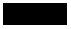 | 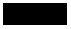 |
| MSM0740 | ribosomal protein L30p | 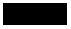 | 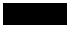 | 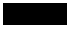 | 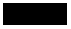 | 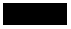 |
| MSM0741 | ribosomal protein S5p, RpsE | 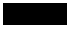 | 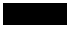 | 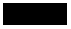 | 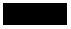 | 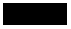 |
| MSM0742 | ribosomal protein L18p, RpIR | 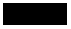 | 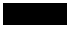 | 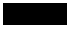 | 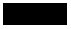 | 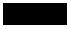 |
| MSM0743 | ribosomal protein L19e | 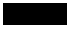 | 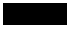 | 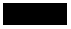 | 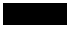 | 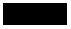 |
| MSM0744 | ribosomal protein L32e | 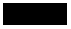 | 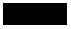 | 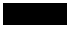 | 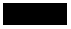 | 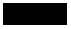 |
| MSM0745 | ribosomal protein L6p, RpIF | 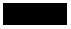 | 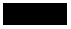 | 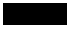 | 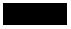 | 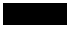 |
| MSM0746 | ribosomal protein S8p | 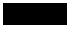 | 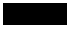 | 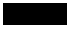 | 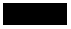 | 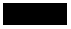 |
| MSM0747 | ribosomal protein S14p | 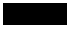 | 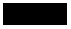 | 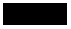 | 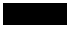 | 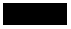 |
| MSM0748 | ribosomal protein L5p | 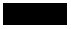 | 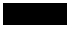 | 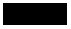 | 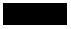 | 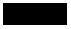 |
| MSM0749 | ribosomal protein S4e | 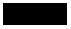 | 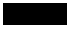 | 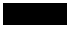 | 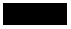 | 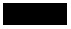 |
| MSM0750 | ribosomal protein L24p | 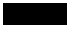 | 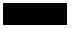 | 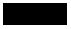 | 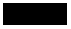 | 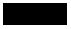 |
| MSM0751 | ribosomal protein L14p | 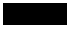 | 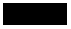 | 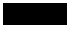 | 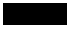 | 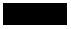 |
| MSM0752 | ribosomal protein S17p | 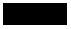 | 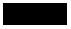 | 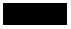 | 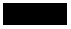 | 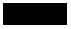 |
| MSM0753 | ribonuclease P, subunit P29 | 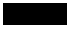 | 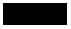 | 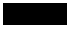 | 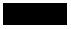 | 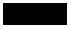 |
| MSM0754 | translation initiation factor SUI1 | 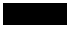 | 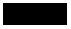 | 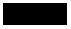 | 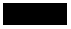 | 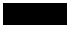 |
| MSM0755 | ribosomal protein L29p | 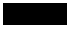 | 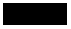 | 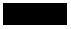 | 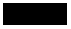 | 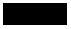 |
| MSM0756 | ribosomal protein S3p | 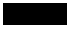 | 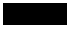 | 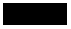 | 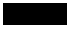 | 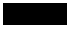 |
| MSM0757 | ribosomal protein L22p | 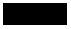 | 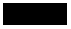 | 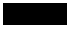 | 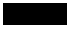 | 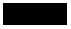 |
| MSM0758 | ribosomal protein S19p | 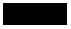 | 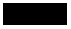 | 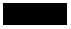 | 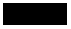 | 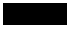 |
| MSM0759 | ribosomal protein L2p | 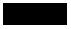 | 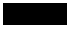 | 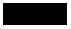 | 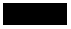 | 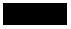 |
| MSM0760 | ribosomal protein L23p | 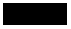 | 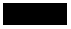 | 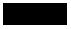 | 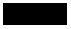 | 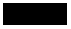 |
| MSM0761 | ribosomal protein L1e | 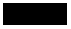 | 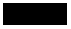 | 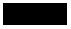 | 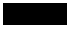 | 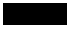 |
| MSM0762 | ribosomal protein L3p | 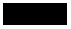 | 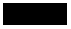 | 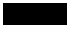 | 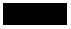 | 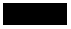 |
| MSM0763 | conserved hypothetical protein | 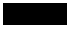 | 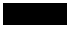 | 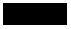 | 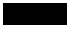 | 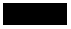 |
| MSM0764 | ribosomal L11 RNA methyltransferase (SAM-dependent) | 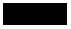 | 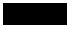 | 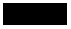 | 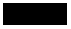 | 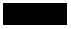 |
| MSM0765 | pyruvate carboxylase (acetyl-CoA/biotin carboxylase), subunit A, PycA | 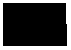 | 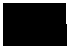 | 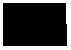 | 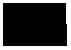 | 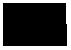 |
| MSM0766 | biotin-[acetyl-CoA-carboxylase]ligase/biotin operon regulator bifunctional protein, BirA | 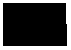 | 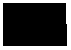 | 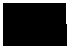 | 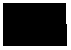 | 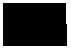 |
| MSM0767 | selenocysteine synthase, SelA | 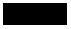 | 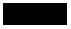 | 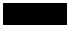 | 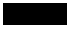 | 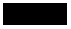 |
| MSM0768 | conserved hypothetical protein | 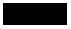 | 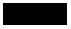 | 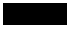 | 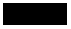 | 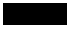 |
| MSM0769 | fumarate hydratase, class I | 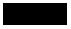 | 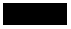 | 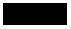 | 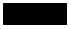 | 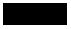 |
| MSM0770 | cobalt ABC transporter, ATPase component, CbiO | 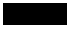 | 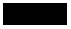 | 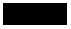 | 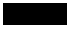 | 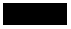 |
| MSM0771 | cobalt ABC transporter, permease component, CbiQ | 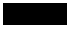 | 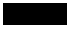 | 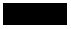 | 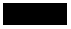 | 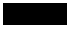 |
| MSM0772 | predicted permease, major facilitator superfamily | 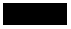 | 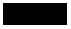 | 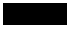 | 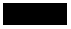 | 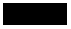 |
| MSM0773 | multidrug ABC transporter, ATPase component | 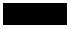 | 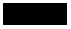 | 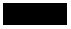 | 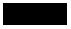 | 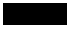 |
| MSM0774 | multidrug ABC transporter, ATPase component | 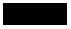 | 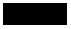 | 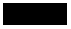 | 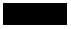 | 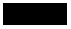 |
| MSM0775 | transcriptional regulator, AraC family | 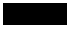 | 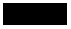 | 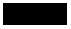 | 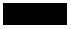 | 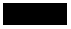 |
| MSM0776 | conserved hypothetical membrane protein | 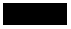 | 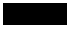 | 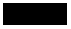 | 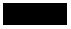 | 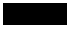 |
| MSM0777 | conserved hypothetical protein | 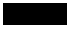 | 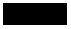 | 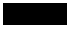 | 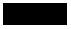 | 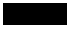 |
| MSM0778 | predicted RNA-binding protein, eukaryotic snRNP-like | 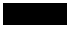 | 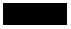 | 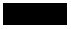 | 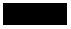 | 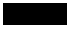 |
| MSM0779 | predicted Zn-dependent hydrolase, metallo-beta-lactamase superfamily | 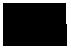 | 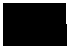 | 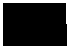 | 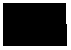 | 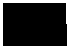 |
| MSM0780 | conserved hypothetical protein | 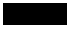 | 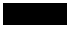 | 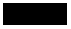 | 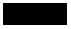 | 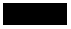 |
| MSM0781 | conserved hypothetical protein | 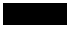 | 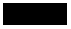 | 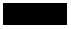 | 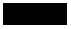 | 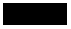 |
| MSM0782 | hypothetical protein | 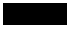 | 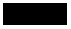 | 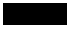 | 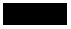 | 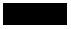 |
| MSM0783 | tungsten formylmethanofuran dehydrogenase, subunit F, FwdF | 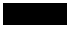 | 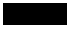 | 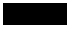 | 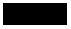 | 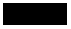 |
| MSM0784 | ferredoxin | 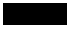 | 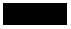 | 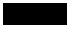 | 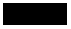 | 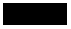 |
| MSM0785 | predicted phosphopantetheine adenylyltransferase (PPAT) | 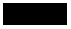 | 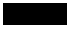 | 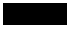 | 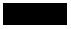 | 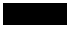 |
| MSM0786 | transglutaminase-like protein, putative cysteine protease | 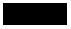 | 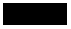 | 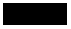 | 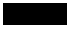 | 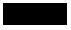 |
| MSM0787 | Fe-S oxidoreductase | 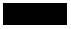 | 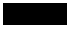 | 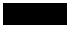 | 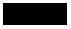 | 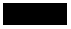 |
| MSM0788 | aspastate aminotransferase | 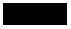 | 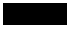 | 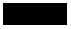 | 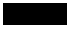 | 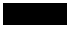 |
| MSM0789 | cation efflux system protein (zinc/cadmium/cobalt) | 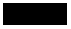 | 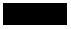 | 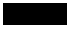 | 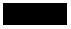 | 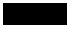 |
| MSM0790 | CBS-domain-containing protein | 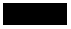 | 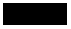 | 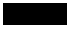 | 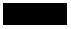 | 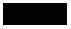 |
| MSM0791 | 2-phosphoglycerate kinase | 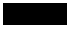 | 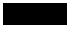 | 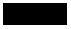 | 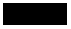 | 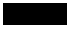 |
| MSM0792 | predicted calcineurin-like phosphoesterase | 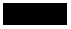 | 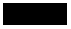 | 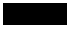 | 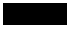 | 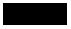 |
| MSM0793 | conserved hypothetical protein | 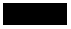 | 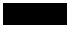 | 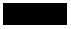 | 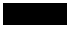 | 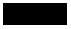 |
| MSM0794 | conserved hypothetical protein | 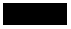 | 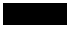 | 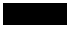 | 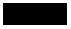 | 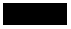 |
| MSM0795 | heterodisulfide reductase, subunit B, HdrB | 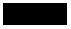 | 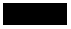 | 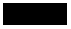 | 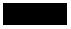 | 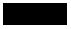 |
| MSM0796 | heterodisulfide reductase, subunit C, HdrC | 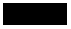 | 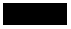 | 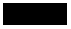 | 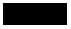 | 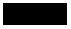 |
| MSM0797 | archaeosine tRNA-ribosyltransferase | 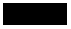 | 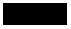 | 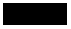 | 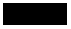 | 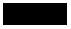 |
| MSM0798 | hypothetical protein | 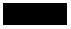 | 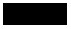 | 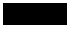 | 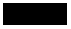 | 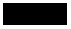 |
| MSM0799 | conserved hypothetical protein | 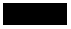 | 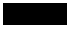 | 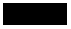 | 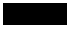 | 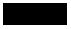 |
| MSM0800 | hypothetical protein | 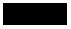 | 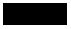 | 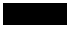 | 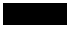 | 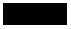 |
| MSM0801 | diphthine synthase, DphB | 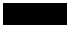 | 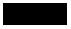 | 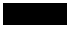 | 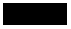 | 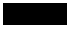 |
| MSM0802 | methyltransferase | 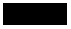 | 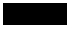 | 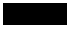 | 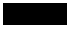 | 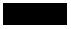 |
| MSM0803 | predicted metal-dependent membrane protease, CAAX amino terminal protease family | 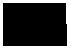 | 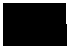 | 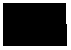 | 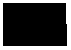 | 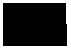 |
| MSM0804 | translation initiation factor alF-2B, alpha subunit | 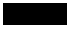 | 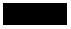 | 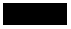 | 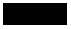 | 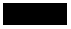 |
| MSM0805 | polar amino acid ABC transporter, ATPase component | 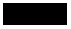 | 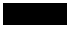 | 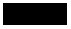 | 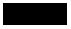 | 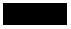 |
| MSM0806 | polar amino acid ABC transporter, permease component | 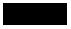 | 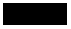 | 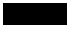 | 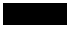 | 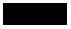 |
| MSM0807 | polar amino acid ABC transporter, substrate-binding component | 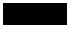 | 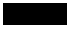 | 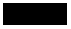 | 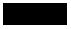 | 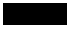 |
| MSM0808 | nitrogenase iron-molybdenum cofactor biosynthesis protein, NifB | 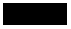 | 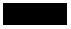 | 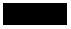 | 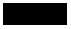 | 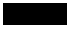 |
| MSM0809 | conserved hypothetical protein | 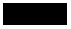 | 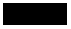 | 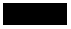 | 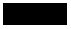 | 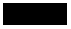 |
| MSM0810 | activator of (R)-2-hydroxyglutaryl-CoA dehydratase | 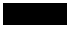 | 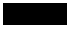 | 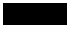 | 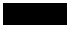 | 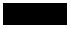 |
| MSM0811 | conserved hypothetical protein | 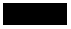 | 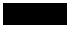 | 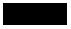 | 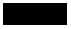 | 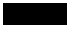 |
| MSM0812 | conserved hypothetical protein | 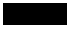 | 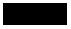 | 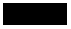 | 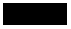 | 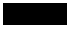 |
| MSM0813 | predicted peptidyl-prolyl cis-trans isomerase | 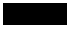 | 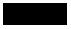 | 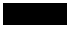 | 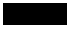 | 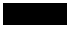 |
| MSM0814 | phosphoribosylformylglycinamidine synthase-related protein (selenophosphate synthetase) | 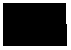 | 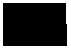 | 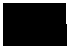 | 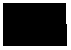 | 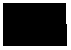 |
| MSM0815 | conserved hypothetical protein | 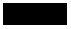 | 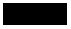 | 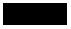 | 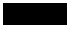 | 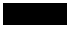 |
| MSM0816 | predicted nucleic acid-binding protein, PIN domain-like family | 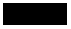 | 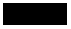 | 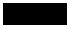 | 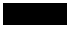 | 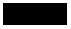 |
| MSM0817 | predicted transcriptional regulator | 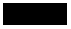 | 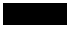 | 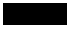 | 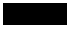 | 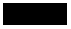 |
| MSM0818 | predicted transcriptional regulator | 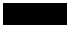 | 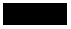 | 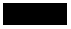 | 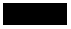 | 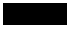 |
| MSM0819 | putative transcription regulator, ArsR family | 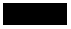 | 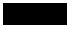 | 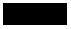 | 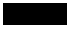 | 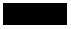 |
| MSM0820 | molybdenum cofactor biosynthesis protein, MoaB | 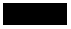 | 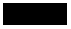 | 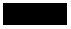 | 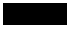 | 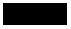 |
| MSM0821 | orotate phosphoribosyltransferase, PyrE | 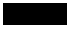 | 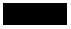 | 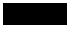 | 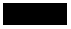 | 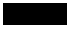 |
| MSM0822 | photosynthetic reaction centre cytoplasmic domain-containing protein | 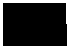 | 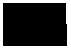 | 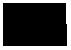 | 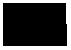 | 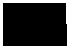 |
| MSM0823 | phosphoenolpyruvate synthase/pyruvate phosphate dikinase, PpsA | 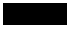 | 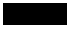 | 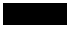 | 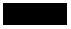 | 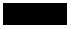 |
| MSM0824 | putative N-acetyltransferase, GNAT family | 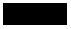 | 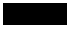 | 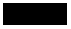 | 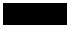 | 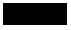 |
| MSM0825 | adenosylcobinamide amidohydrolase, CbiZ | 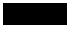 | 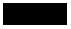 | 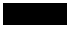 | 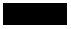 | 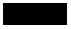 |
| MSM0826 | chaperonin, Cpn60/TCP-1/thermosome family, GroL | 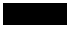 | 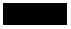 | 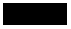 | 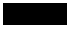 | 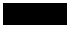 |
| MSM0827 | predicted metal-dependent hydrolase, cyclase family | 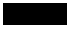 | 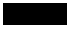 | 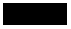 | 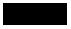 | 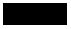 |
| MSM0828 | best blast hit to Msp_0220; not predicted to be a carbohydrate active enzyme by CAZy | 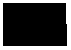 | 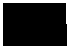 | 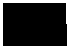 | 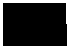 | 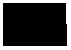 |
| MSM0829 | aspartate-semialdehyde dehydrogenase, Asd | 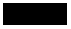 | 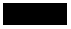 | 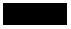 | 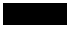 | 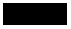 |
| MSM0830 | dihydrodipicolinate reductas, DapB | 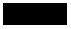 | 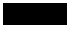 | 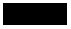 | 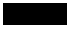 | 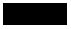 |
| MSM0831 | dihydrodipicolinate synthase, DapA | 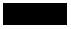 | 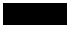 | 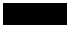 | 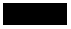 | 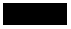 |
| MSM0832 | aspartokinase, alpha subunit | 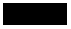 | 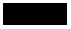 | 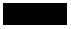 | 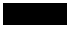 | 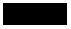 |
| MSM0833 | ribosomal protein S17a | 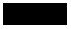 | 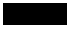 | 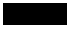 | 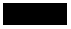 | 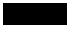 |
| MSM0834 | chorismate mutase | 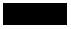 | 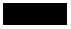 | 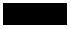 | 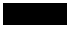 | 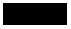 |
| MSM0835 | archaeal shikimate kinase | 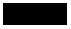 | 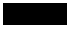 | 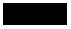 | 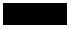 | 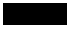 |
| MSM0836 | related to alpha-glycosyltransferases, GT4 family | 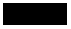 | 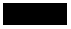 | 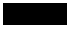 | 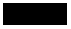 | 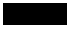 |
| MSM0837 | cobalamin biosynthesis protein D, CbiD | 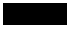 | 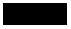 | 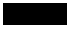 | 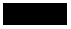 | 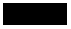 |
| MSM0838 | putative thioredoxin/glutaredoxin | 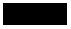 | 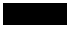 | 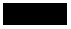 | 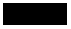 | 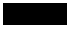 |
| MSM0839 | ATP-dependent helicase | 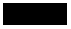 | 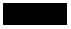 | 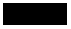 | 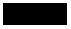 | 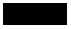 |
| MSM0840 | conserved hypothetical protein | 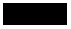 | 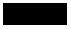 | 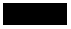 | 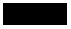 | 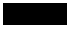 |
| MSM0841 | photosynthetic reaction centre cytoplasmic domain containing protein | 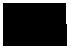 | 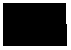 | 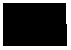 | 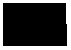 | 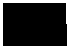 |
| MSM0842 | histone acetyltransferase, radical SAM superfamily | 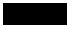 | 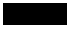 | 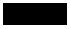 | 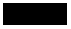 | 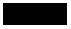 |
| MSM0843 | 2-deoxyribose-5-phosphate aldolase (DERA), DeoC | 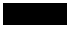 | 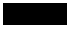 | 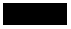 | 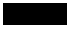 | 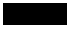 |
| MSM0844 | archaeal histone, HmtA | 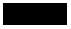 | 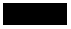 | 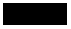 | 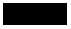 | 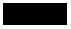 |
| MSM0845 | 2-methylthioadenine synthetase, MiaB | 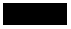 | 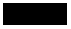 | 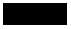 | 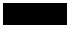 | 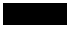 |
| MSM0846 | uncharacterized archaeal Zn-finger protein | 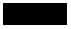 | 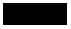 | 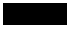 | 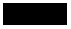 | 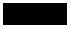 |
| MSM0847 | archaeal 3-isopropylmalate dehydratase, small subunit, LeuD | 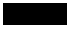 | 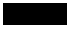 | 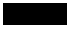 | 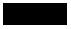 | 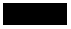 |
| MSM0848 | ribofuranosylaminobenzene 5′-phosphate synthase, RfaS | 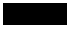 | 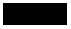 | 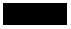 | 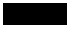 | 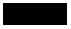 |
| MSM0849 | molybdenum cofactor biosynthesis-related protein, MoaA | 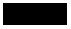 | 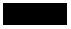 | 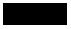 | 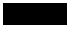 | 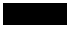 |
| MSM0850 | predicted CDP-diglyceride synthetase | 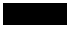 | 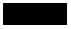 | 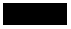 | 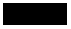 | 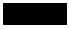 |
| MSM0851 | predicted transcriptional regulator | 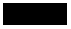 | 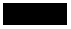 | 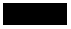 | 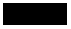 | 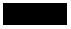 |
| MSM0852 | predicted ATP-utilizing enzyme | 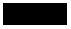 | 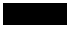 | 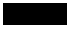 | 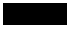 | 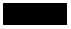 |
| MSM0853 | UDP-N-acetylglucosamine 2-epimerase, WecB | 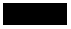 | 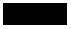 | 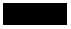 | 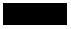 | 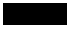 |
| MSM0854 | hypothetical protein | 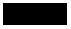 | 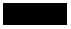 | 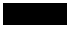 | 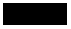 | 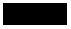 |
| MSM0855 | archaeal tRNA pseudouridine synthase A, TruA | 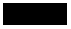 | 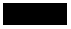 | 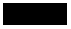 | 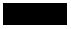 | 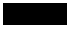 |
| MSM0856 | antimicrobial peptide ABC transporter, permease component | 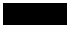 | 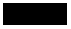 | 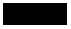 | 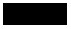 | 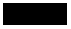 |
| MSM0857 | antimicrobial peptide ABC transporter, ATPase component | 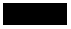 | 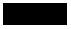 | 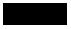 | 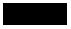 | 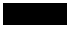 |
| MSM0858 | phosphoribosylformimino-5-aminoimidazole carboxamide ribotide (ProFAR)isomerase, HisA | 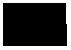 | 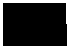 | 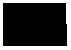 | 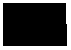 | 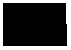 |
| MSM0859 | glycerol-3-phosphate cytidylyltransferase | 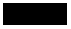 | 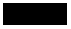 | 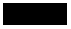 | 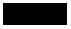 | 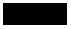 |
| MSM0860 | aspartate-semialdehyde dehydrogenase, ArgC | 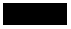 | 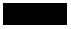 | 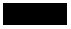 | 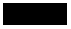 | 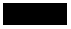 |
| MSM0861 | flavodoxin | 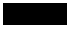 | 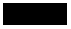 | 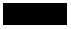 | 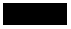 | 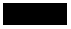 |
| MSM0862 | aspartate carbamoyltransferase regulatory chain, PyrI | 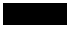 | 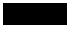 | 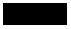 | 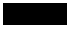 | 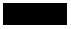 |
| MSM0863 | pyridoxamine-phosphate oxidase (FMN-binding) | 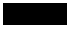 | | | 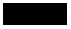 | 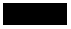 |
| MSM0864 | predicted transcriptional regulator | 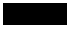 | | 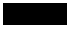 | | 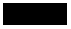 |
| MSM0865 | putative glucose-methanol-choline oxidoreductase (FAD-dependent) | 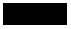 | 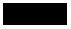 | 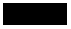 | 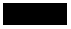 | 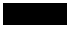 |
| MSM0866 | Zn metalloprotease, TIdD | 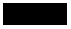 | 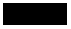 | 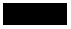 | 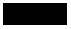 | 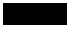 |
| MSM0867 | AMMECR1-related protein | 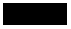 | 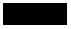 | 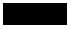 | 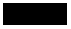 | |
| MSM0868 | hypothetical protein | 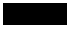 | 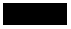 | | 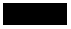 | |
| MSM0869 | GTPase, GTP1/OBG family | 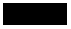 | 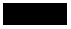 | 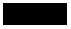 | 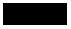 | 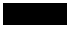 |
| MSM0870 | molecular chaperone (small heat shock protein), HSP20/alpha crystallin family | 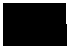 | 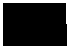 | 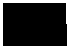 | 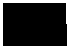 | 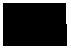 |
| MSM0871 | putative transposase | ND | | | | 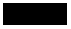 |
| MSM0872 | glucosamine:fructose-6-phosphate aminotransferase (isomerizing), AgaS | 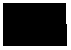 | 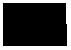 | 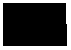 | 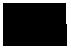 | 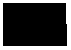 |
| MSM0873 | conserved hypothetical protein | 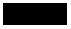 | 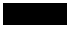 | 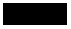 | 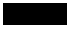 | 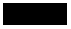 |
| MSM0874 | adenine deaminase, AdeC | 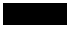 | 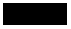 | 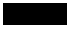 | 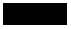 | 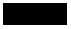 |
| MSM0875 | lysine-oxoglutarate reductase/Saccharopine dehydrogenase (LOR/SDH) bifunctional enzyme | 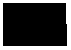 | 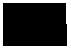 | 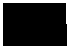 | 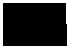 | 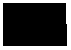 |
| MSM0876 | arginase/agmatinase/formimionoglutamate hydrolase, SpeB | 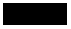 | 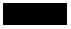 | 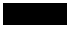 | 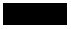 | 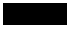 |
| MSM0877 | translation initiation factor 5A (alF-5A) | 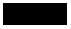 | 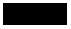 | 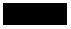 | 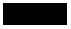 | 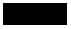 |
| MSM0878 | pyruvoyl-dependent arginine decarboxylase, PdaD | 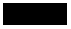 | 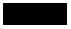 | 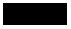 | 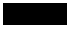 | 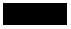 |
| MSM0879 | Poly(P)/ATP NAD kinase, inositol monophosphatase family, PpnL | 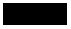 | 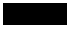 | 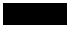 | 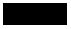 | 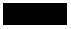 |
| MSM0880 | UDP-N-acetylmuramyl tripeptide synthetase (Mur ligase) | 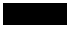 | 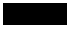 | 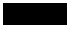 | 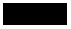 | 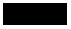 |
| MSM0881 | porphobilinogen deaminase | 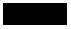 | 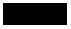 | 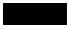 | 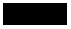 | 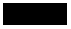 |
| MSM0882 | 3-chlorobenzoate-3,4-dioxygenase dyhydrogenase | 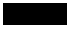 | 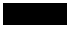 | 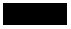 | 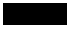 | 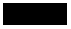 |
| MSM0883 | orotate phosphoribosyltransferase | 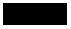 | 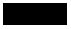 | 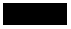 | 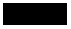 | 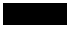 |
| MSM0884 | adhesin-like protein | 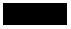 | 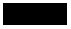 | 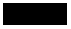 | 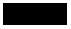 | 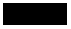 |
| MSM0885 | adhesin-like protein | 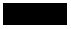 | 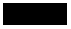 | 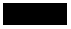 | 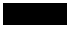 | 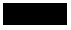 |
| MSM0886 | hypothetical protein | 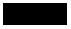 | 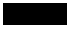 | 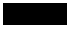 | 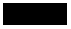 | 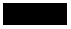 |
| MSM0887 | universal stress protein, adenine nucleotide alpha hydrolase-like family | 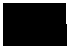 | 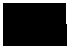 | 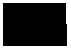 | 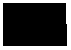 | 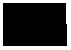 |
| MSM0888 | glutamate dehydrogenase (NADP+), GdhA | 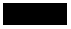 | 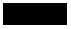 | 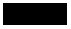 | 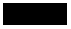 | 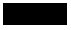 |
| MSM0889 | hypothetical protein | 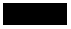 | 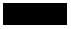 | 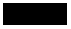 | 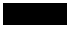 | 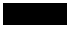 |
| MSM0890 | hypothetical protein | 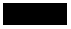 | | | 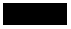 | 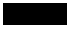 |
| MSM0891 | peptide chain release factor eRF, subunit 1 | 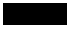 | 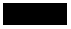 | 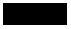 | 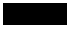 | 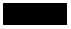 |
| MSM0892 | putative zinc-binding protein | 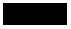 | 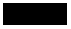 | 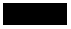 | 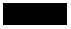 | 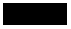 |
| MSM0893 | acetyltransferase | 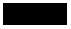 | 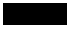 | 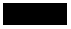 | 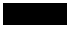 | 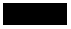 |
| MSM0894 | conserved hypothetical protein | 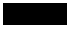 | 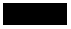 | 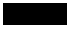 | 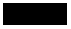 | 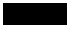 |
| MSM0895 | cation transport ATPase, HAD family | 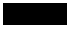 | 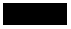 | 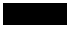 | 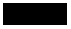 | 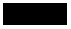 |
| MSM0896 | precorrin-6X reductase, CbiJ | 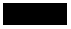 | 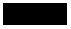 | 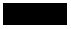 | 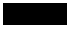 | 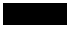 |
| MSM0897 | ribosomal protein S10p | 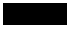 | 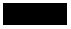 | 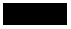 | 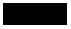 | 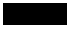 |
| MSM0898 | translation elongation factor 1-alpha (EF-Tu) | 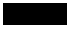 | 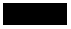 | 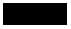 | 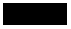 | 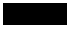 |
| MSM0899 | translation elongation factor EF-2, FusA | 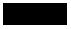 | 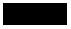 | 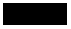 | 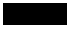 | 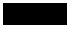 |
| MSM0900 | ribosomal protein S7p | 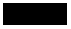 | 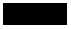 | 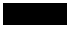 | 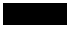 | 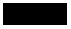 |
| MSM0901 | ribosomal protein S12p | 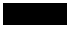 | 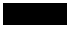 | 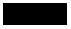 | 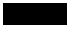 | 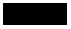 |
| MSM0902 | methyl-coenzyme M reductase, alpha subunit, McrA | 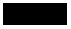 | | 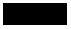 | | |
| MSM0903 | methyl-coenzyme M reductase, gamma subunit, McrG | 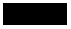 | | | | |
| MSM0904 | methyl-coenzyme M reductase, D subunit, McrD | 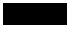 | 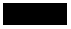 | 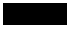 | | |
| MSM0905 | methyl-coenzyme M reductase, beta subunit, McrB | 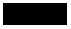 | 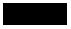 | 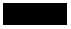 | | |
| MSM0906 | transcription termination factor, NusA | 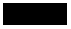 | 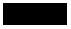 | 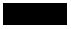 | 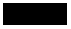 | 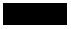 |
| MSM0907 | ribosomal protein L17Ae | 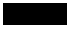 | 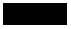 | 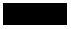 | 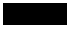 | 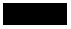 |
| MSM0908 | DNA-dependent RNA polymerase, subunit A, RpoA | 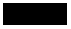 | 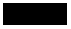 | 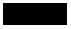 | 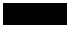 | 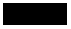 |
| MSM0909 | DNA-dependent RNA polymerase, subunit A′, RpoA | 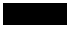 | 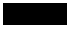 | 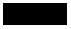 | 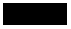 | 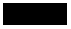 |
| MSM0910 | DNA-dependent RNA polymerase, subunit B′, RpoB | 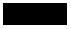 | 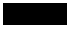 | 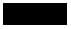 | 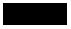 | 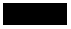 |
| MSM0911 | DNA-dependent RNA polymerase, subunit B, RpoB | 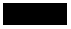 | 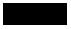 | 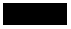 | 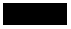 | 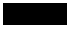 |
| MSM0912 | DNA-dependent RNA polymerase, subunit H, RpoH | 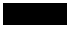 | 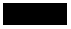 | 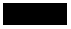 | 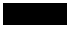 | 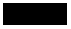 |
| MSM0913 | hypothetical protein | 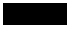 | | 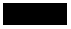 | 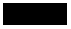 | 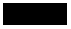 |
| MSM0914 | predicted O-linked GlcNAc transferase | 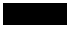 | | 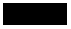 | 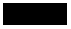 | 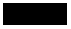 |
| MSM0915 | hypothetical protein | 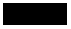 | 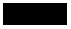 | 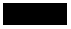 | 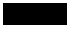 | 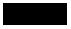 |
| MSM0916 | hydroxyethylthiazole kinase, ThiM | 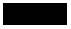 | 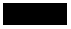 | 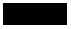 | 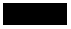 | 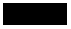 |
| MSM0917 | thiamine monophosphate synthase, ThiE | 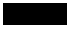 | 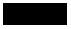 | 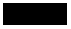 | 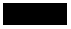 | 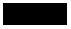 |
| MSM0918 | 3-phosphoglycerate kinase, Pgk | 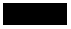 | 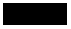 | 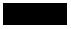 | 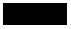 | 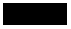 |
| MSM0919 | triosephosphate isomerase, TpiA | 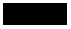 | 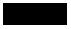 | 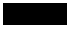 | 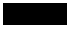 | 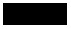 |
| MSM0920 | conserved hypothetical protein | 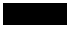 | 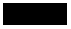 | 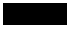 | 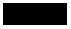 | 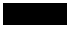 |
| MSM0921 | predicted surface protein | 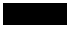 | | | 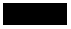 | |
| MSM0922 | Fe-S oxidoreductase | 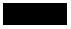 | 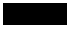 | 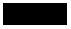 | 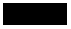 | 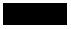 |
| MSM0923 | multimeric flavodoxin | 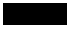 | 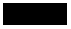 | 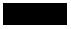 | 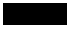 | 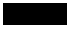 |
| MSM0924 | succinyl-CoA synthetase, beta subunit, SucC | 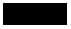 | 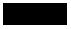 | 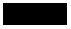 | 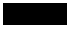 | 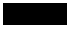 |
| MSM0925 | 2-oxoglutarate ferredoxin oxidoreductase, gamma subunit, KorC | 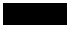 | 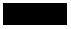 | 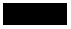 | 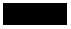 | 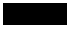 |
| MSM0926 | 2-oxoglutarate ferredoxin oxidoreductase, beta subunit, KorB | 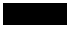 | 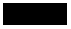 | 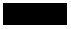 | 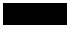 | 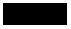 |
| MSM0927 | 2-oxoglutarate ferredoxin oxidoreductase, alpha subunit, KorA | 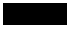 | 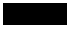 | 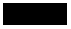 | 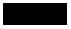 | 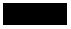 |
| MSM0928 | 2-oxoglutarate ferredoxin oxidoreductase, delta subunit, KorD | 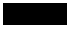 | 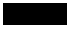 | 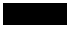 | 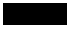 | 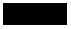 |
| MSM0929 | fumarate hydratase, FumA | 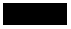 | 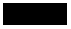 | 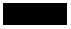 | 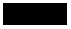 | 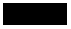 |
| MSM0930 | peptidyl-prolyl cis-trans isomerase, FKBP-type | 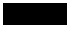 | 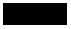 | 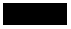 | 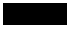 | 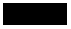 |
| MSM0931 | conserved hypothetical protein | 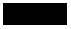 | 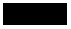 | 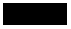 | 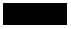 | 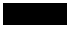 |
| MSM0932 | conserved hypothetical protein | 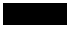 | 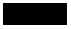 | 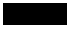 | 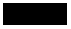 | 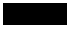 |
| MSM0933 | cobalamin-5-phosphate synthase, CobS | 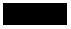 | 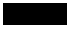 | 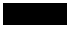 | 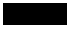 | 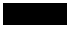 |
| MSM0934 | predicted phosphatidylglycerophosphatase A-related protein | 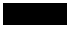 | 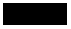 | 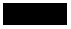 | 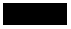 | 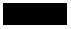 |
| MSM0935 | conserved hypothetical protein | 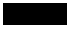 | 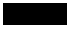 | 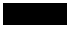 | 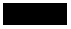 | 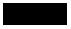 |
| MSM0936 | transcription regulator-related ATPase, ExsB | 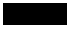 | 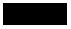 | 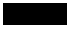 | 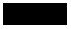 | 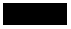 |
| MSM0937 | HD superfamily hydrolase | 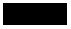 | 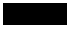 | 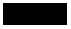 | 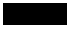 | 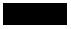 |
| MSM0938 | hypothetical protein | 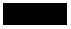 | 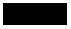 | 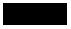 | 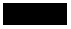 | 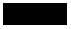 |
| MSM0939 | pyruvate carboxylase, subunit B, PycB | 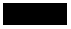 | 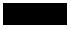 | 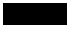 | 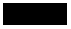 | 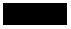 |
| MSM0940 | myo-inositol-1-phosphate synthase | 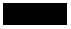 | 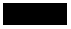 | 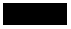 | 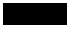 | 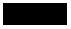 |
| MSM0941 | prenylteansferase, UbiA | 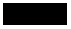 | 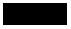 | 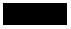 | 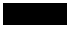 | 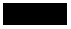 |
| MSM0942 | conserved hypothetical membrane protein | 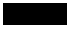 | 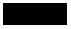 | 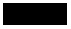 | 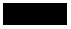 | 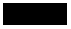 |
| MSM0943 | conserved hypothetical protein | 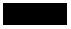 | 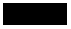 | 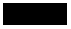 | 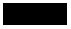 | 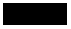 |
| MSM0944 | CMP-N-acetylneuraminic acid synthetase, NeuA | 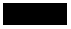 | 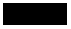 | 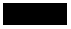 | 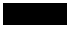 | 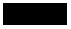 |
| MSM0945 | hydrogenase expression/formation protein, HypD | 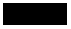 | 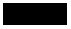 | 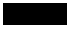 | 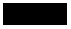 | 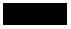 |
| MSM0946 | archaeal sucrose-phosphate phosphatase (SPP-like), HAD family | 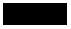 | 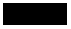 | 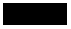 | 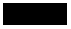 | 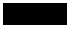 |
| MSM0947 | predicted zinc metalloprotease, modulator of DNA gyrase | 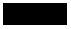 | 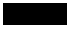 | 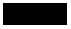 | 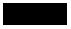 | 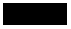 |
| MSM0948 | hypothetical protein | 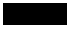 | 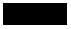 | 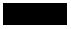 | 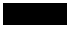 | 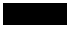 |
| MSM0949 | transcriptional activator | 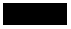 | 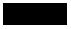 | 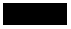 | 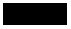 | 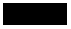 |
| MSM0950 | molybdopterin biosynthesis protein, MoeA | 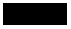 | 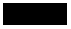 | 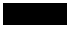 | 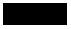 | 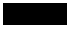 |
| MSM0951 | translation initiation factor alF-1A | 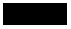 | 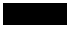 | 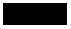 | 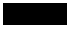 | 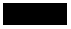 |
| MSM0952 | serine/threonine protein kinase, RIO1 family | 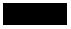 | 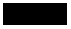 | 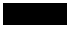 | 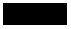 | 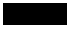 |
| MSM0953 | conserved hypothetical membrane protein | 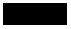 | 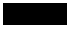 | 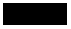 | 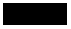 | 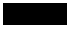 |
| MSM0954 | predicted RNA-binding protein | 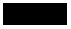 | 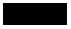 | 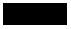 | 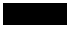 | 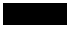 |
| MSM0955 | type II DNA topoisomerase VI, subunit B | 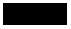 | 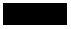 | 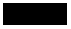 | 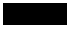 | 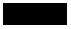 |
| MSM0956 | type II DNA topoisomerase VI, subunit A | 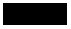 | 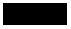 | 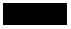 | 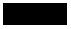 | 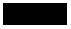 |
| MSM0957 | adhesin-like protein | 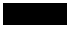 | 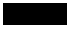 | 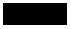 | 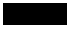 | 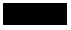 |
| MSM0958 | predicted 1,4-beta-cellobiosidase | 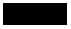 | 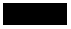 | 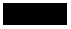 | 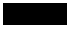 | 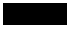 |
| MSM0959 | conserved hypothetical protein | 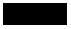 | 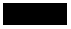 | 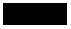 | 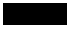 | 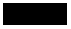 |
| MSM0960 | cation transport ATPase, HAD family | 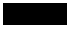 | 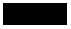 | 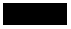 | 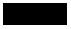 | 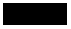 |
| MSM0961 | heavy-metal cation transporting ATPase | 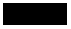 | 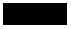 | 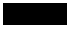 | 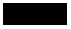 | 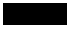 |
| MSM0962 | glyceraldehyde 3-phosphate dehydrogenase, GapA | 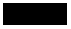 | 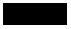 | 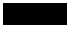 | 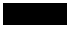 | 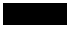 |
| MSM0963 | endonuclease IV, xylose isomerase-like TIM barrel family, Nfo | 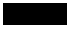 | 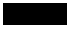 | 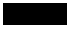 | 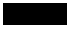 | 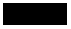 |
| MSM0964 | calcineurin-like phosphoesterase | 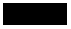 | 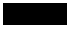 | 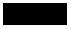 | 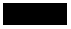 | 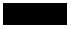 |
| MSM0965 | 3-hydroxyacyl-CoA dehydrogenase, FadB | 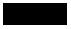 | 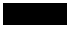 | 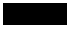 | 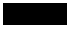 | 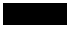 |
| MSM0966 | predicted 26S protease regulatory subunit (ATP-dependent), AAA+ family ATPase | 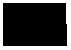 | 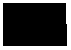 | 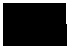 | 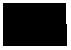 | 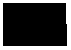 |
| MSM0967 | glutamyl-tRNA reductase, HemA | 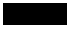 | 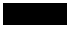 | 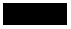 | 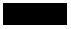 | 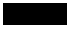 |
| MSM0968 | bifunctional precorrin-2 oxidase/chelatase (siroheme synthase), CysG | 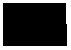 | 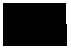 | 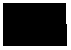 | 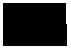 | 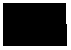 |
| MSM0969 | predicted metal-binding transcription factor | 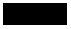 | 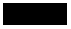 | 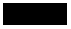 | 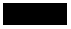 | 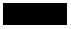 |
| MSM0970 | conserved hypothetical protein | 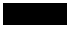 | 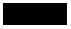 | 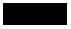 | 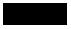 | 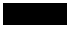 |
| MSM0971 | methyl-coenzyme M reductase, component A2 | 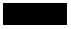 | 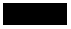 | 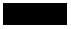 | 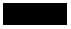 | 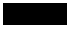 |
| MSM0972 | tRNA-dihydrouridine synthase | 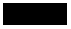 | 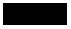 | 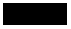 | 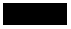 | 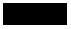 |
| MSM0973 | GTP cyclohydrolase III, GGDN family | 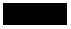 | 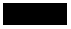 | 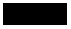 | 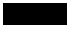 | 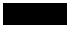 |
| MSM0974 | LPPG:FO 2-phospho-L-lactate transferase, CofD | 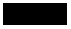 | 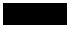 | 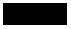 | 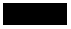 | 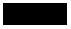 |
| MSM0975 | F420-0:gamma-glutamyl ligase, CofE | 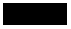 | 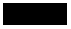 | 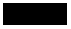 | 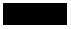 | 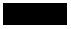 |
| MSM0976 | archaeal IMP cyclohydrolase, PurO | 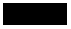 | 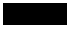 | 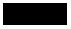 | 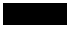 | 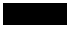 |
| MSM0977 | putative biopolymer transport protein, ExbD/TolR family | 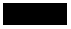 | 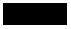 | 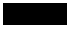 | 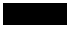 | 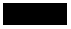 |
| MSM0978 | biopolymer transport protein, MotA/TolQ/ExbB proton channel family | 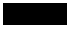 | 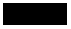 | 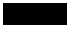 | 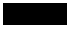 | 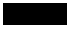 |
| MSM0979 | ribonuclease HII, RnhB | 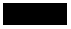 | 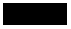 | 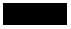 | 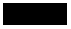 | 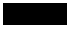 |
| MSM0980 | rod shape-determining protein, MreB/MrI family | 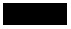 | 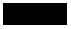 | 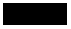 | 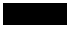 | 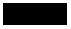 |
| MSM0981 | conserved hypothetical protein | 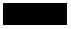 | 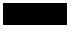 | 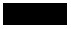 | 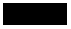 | 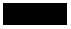 |
| MSM0982 | phosphatidylserine synthase, PssA | 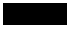 | 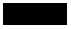 | 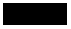 | 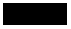 | 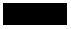 |
| MSM0983 | conserved hypothetical protein | 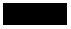 | 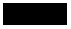 | 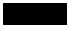 | 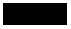 | 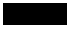 |
| MSM0984 | sortase (surface protein transpeptidase), SrtA | 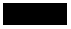 | 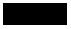 | 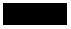 | 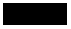 | 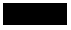 |
| MSM0985 | conserved hypothetical protein | 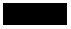 | 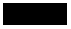 | 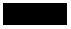 | 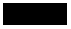 | 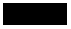 |
| MSM0986 | conjugated bile acid hydrolase (CBAH) | 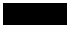 | 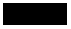 | 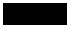 | 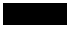 | 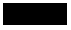 |
| MSM0987 | tyrosine decarboxylase, MfnA | 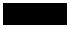 | 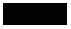 | 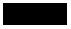 | 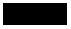 | 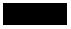 |
| MSM0988 | phosphoenolpyruvate synthase, PpsA | 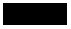 | 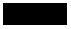 | 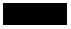 | 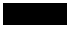 | 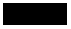 |
| MSM0989 | ribosomal protein L10e | 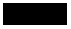 | 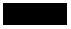 | 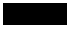 | 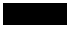 | 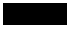 |
| MSM0990 | nitrate/sulfonate/bicarbonate ABC transporter, ATPase component | 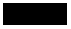 | 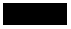 | 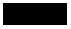 | 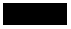 | 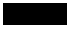 |
| MSM0991 | nitrate/sulfonate/bicarbonate ABC transporter, substrate-binding component | 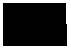 | 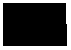 | 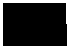 | 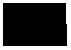 | 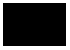 |
| MSM0992 | conserved hypothetical protein | 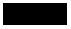 | 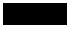 | 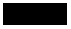 | 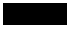 | 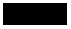 |
| MSM0993 | putative ATPase, glucocorticoid receptor-like (DNA-binding domain) family | 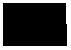 | 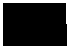 | 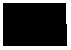 | 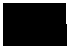 | 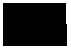 |
| MSM0994 | predicted nucleotidyltransferase | 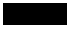 | 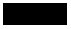 | 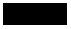 | 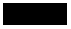 | 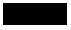 |
| MSM0995 | adhesin-like protein | 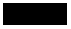 | | 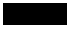 | 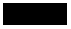 | 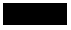 |
| MSM0996 | adhesin-like protein | 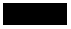 | | 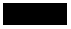 | 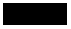 | 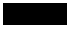 |
| MSM0997 | dihydroorotase, PyrC | 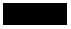 | | 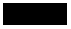 | 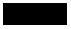 | 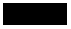 |
| MSM0998 | polyferredoxin, MvhB | 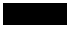 | 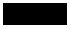 | 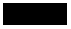 | 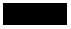 | 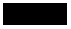 |
| MSM0999 | methyl viologen-reducing hydrogenase, alpha subunit, MvhA | 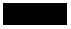 | 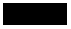 | 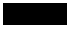 | 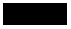 | 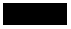 |
| MSM1000 | methyl viologen-reducing hydrogenase, gamma subunit, MvhG | 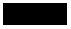 | 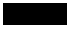 | 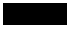 | 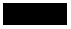 | 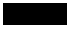 |
| MSM1001 | methyl viologen-reducing hydrogenase, delta subunit, MvhD P | 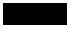 | 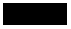 | 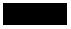 | 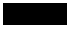 | 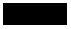 |
| MSM1002 | ABC transporter involved in Fe-S cluster assembly, permease component | 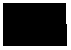 | 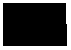 | 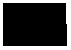 | 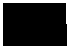 | 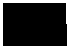 |
| MSM1003 | ABC transporter involved in Fe-S cluster assembly, permease component | 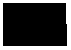 | 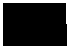 | 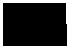 | 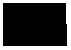 | 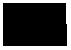 |
| MSM1004 | photosynthetic reaction centre cytoplasmic domain containing protein | 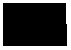 | 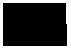 | 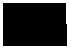 | 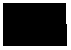 | 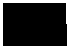 |
| MSM1005 | GTP:adenosylcobinamide-phosphate guanylyltransferase | 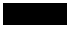 | 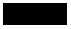 | 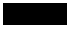 | 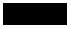 | 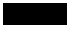 |
| MSM1006 | conserved hypothetical protein | 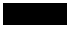 | 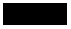 | 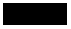 | 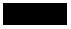 | 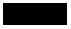 |
| MSM1007 | N5-methyl-tetrahydromethanopterin:coenzyme M methyltransferase, subunit H, MtrH | 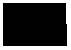 | 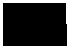 | 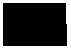 | 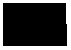 | 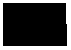 |
| MSM1008 | N5-methyl-tetrahydromethanopterin:coenzyme M methyltransferase, subunit G, MtrG | 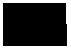 | 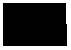 | 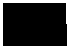 | 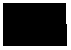 | 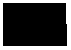 |
| MSM1009 | N5-methyl-tetrahydromethanopterin:coenzyme M methyltransferase, subunit F, MtrF | 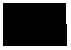 | 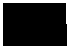 | 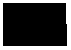 | 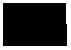 | 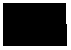 |
| MSM1010 | N5-methyl-tetrahydromethanopterin:coenzyme M methyltransferase, subunit A, MtrA | 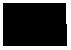 | 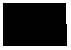 | 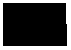 | 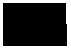 | 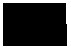 |
| MSM1011 | N5-methyl-tetrahydromethanopterin:coenzyme M methyltransferase, subunit B, MtrB | 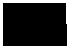 | 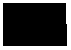 | 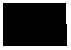 | 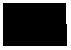 | 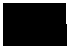 |
| MSM1012 | N5-methyl-tetrahydromethanopterin:coenzyme M methyltransferase, subunit C, MtrC | 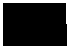 | 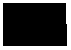 | 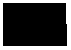 | 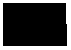 | 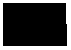 |
| MSM1013 | N5-methyl-tetrahydromethanopterin:coenzyme M methyltransferase, subunit D, MtrD | 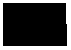 | 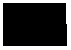 | 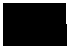 | 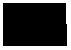 | 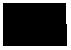 |
| MSM1014 | N5-methyl-tetrahydromethanopterin:coenzyme M methyltransferase, subunit E, MtrE | 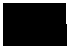 | 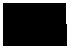 | 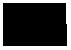 | 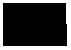 | 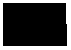 |
| MSM1015 | methyl-coenzyme M reductase, alpha subunit, McrA | 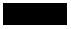 | 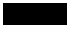 | 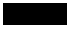 | 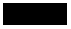 | 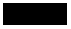 |
| MSM1016 | methyl-coenzyme M reductase, gamma subunit, McrG | 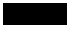 | 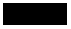 | 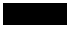 | 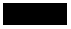 | 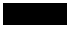 |
| MSM1017 | methyl-coenzyme M reductase, C subunit, McrC | 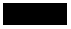 | 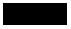 | 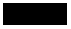 | 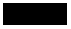 | 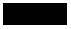 |
| MSM1018 | methyl-coenzyme M reductase, D subunit, McrD | 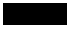 | 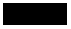 | 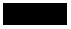 | 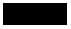 | 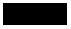 |
| MSM1019 | methyl-coenzyme M reductase, beta subunit, McrB | 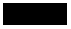 | 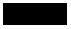 | 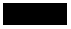 | 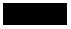 | 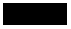 |
| MSM1020 | Fe-S oxidoreductase, Radical SAM family | 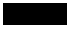 | 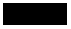 | 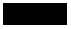 | 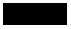 | 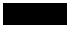 |
| MSM1021 | uncharacterized protein related to methyl coenzyme M reductase subunit C (McrC) | 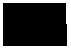 | 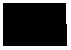 | 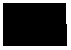 | 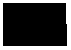 | 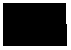 |
| MSM1022 | conserved hypothetical protein | 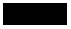 | 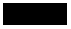 | 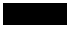 | 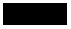 | 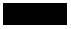 |
| MSM1023 | 2-phosphosulpholactate phosphatase, ComB, (coenzyme M biosynthesis) | 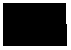 | 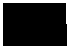 | 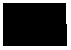 | 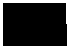 | 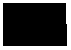 |
| MSM1024 | pheromone shutdown protein, traB family | 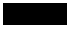 | 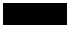 | 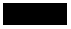 | 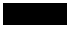 | 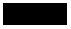 |
| MSM1025 | conserved hypothetical protein | 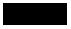 | 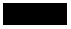 | 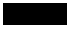 | 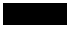 | 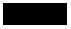 |
| MSM1026 | hemolysin-related protein, transporter-associated family, TlyC | 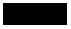 | 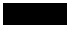 | 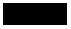 | 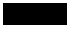 | 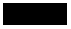 |
| MSM1027 | Ca2+/Na+antiporter (K+-dependent) | 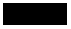 | 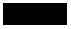 | 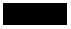 | 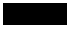 | 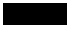 |
| MSM1028 | predicted ATPase, PP-loop family | 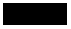 | 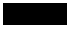 | 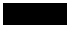 | 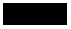 | 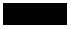 |
| MSM1029 | conserved hypothetical protein | 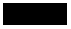 | 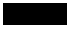 | 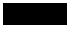 | 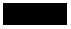 | 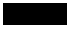 |
| MSM1030 | predicted pyridoxal phosphate-dependent enzyme | 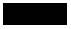 | 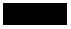 | 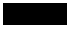 | 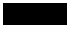 | 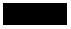 |
| MSM1031 | N2,N2-dimethylguanosine tRNA methyltransferase, Trm1 | 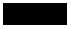 | 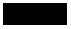 | 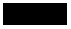 | 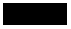 | 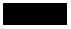 |
| MSM1032 | transcriptional regulator, Lrp family | 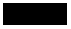 | 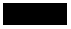 | 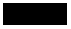 | 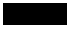 | 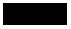 |
| MSM1033 | conserved hypothetical protein | 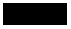 | 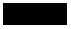 | 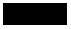 | 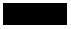 | 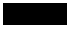 |
| MSM1034 | conserved hypothetical protein | 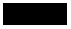 | 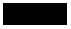 | 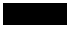 | 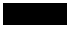 | 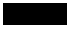 |
| MSM1035 | FO synthase subunit 1 (SAM-dependent), CofG (F420 biosynthesis) | 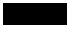 | 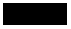 | 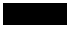 | 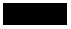 | 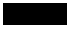 |
| MSM1036 | predicted methyltransferase | 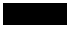 | 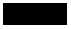 | 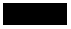 | 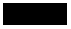 | 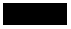 |
| MSM1037 | proteasome, beta subunit | 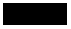 | 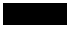 | 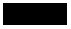 | 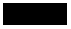 | 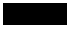 |
| MSM1038 | predicted metal-dependent RNase | 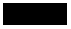 | 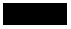 | 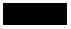 | 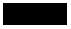 | 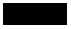 |
| MSM1039 | phosphoribosylformylglycinamidine cyclo-ligase (AIRS), PurM | 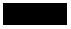 | 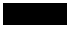 | 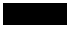 | 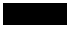 | 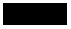 |
| MSM1040 | malate/L-lactate dehydrogenase | 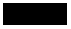 | 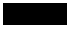 | 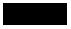 | 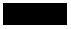 | 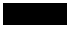 |
| MSM1041 | DNA-dependent DNA polymerase I, PolB1 | 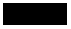 | 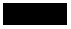 | 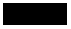 | 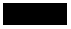 | 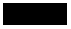 |
| MSM1042 | predicted permease | 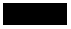 | 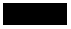 | 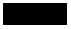 | 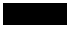 | 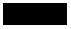 |
| MSM1043 | dihydroorotate dehydrogenase electron transfer subunit, PyrK | 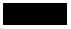 | 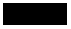 | 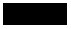 | 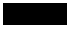 | 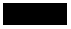 |
| MSM1044 | dihydroorotate dehydrogenase, PyrD | 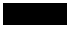 | 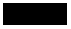 | 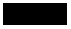 | 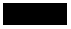 | 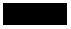 |
| MSM1045 | possible glycosyltransferase | 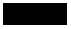 | 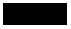 | 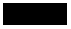 | 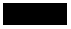 | 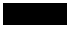 |
| MSM1046 | pre-mRNA splicing ribonucleoprotein PRP31 | 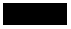 | 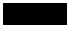 | 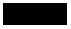 | 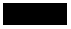 | 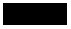 |
| MSM1047 | fibrillarin-like pre-rRNA processing protein, FlpA | 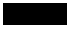 | 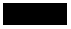 | 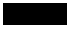 | 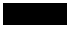 | 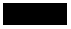 |
| MSM1048 | phosphopantothenoylcysteine synthetase/decarboxylase | 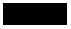 | 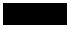 | 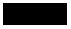 | 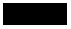 | 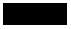 |
| MSM1049 | phosphopantothenoylcysteine synthetase/decarboxylase | 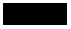 | 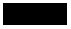 | 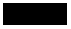 | 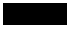 | 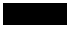 |
| MSM1050 | conserved hypothetical protein | 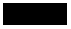 | 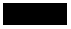 | 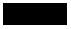 | 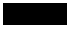 | 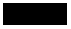 |
| MSM1051 | putative endoglucanase | 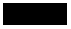 | 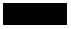 | 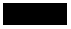 | 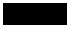 | 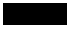 |
| MSM1052 | prephenate dehydratase, PheA | 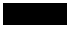 | 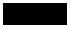 | 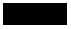 | 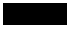 | 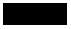 |
| MSM1053 | IMP dehydrogenase related protein | 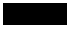 | 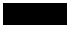 | 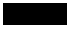 | 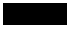 | 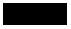 |
| MSM1054 | IMP dehydrogenase related protein | 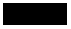 | 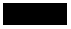 | 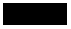 | 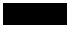 | 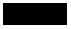 |
| MSM1055 | coenzyme PQQ synthesis protein, SAM family | 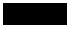 | 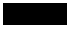 | 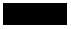 | 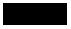 | 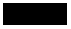 |
| MSM1056 | 6-pyruvoyl-tetrahydropterin synthase | 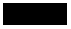 | 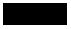 | 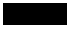 | 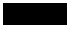 | 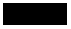 |
| MSM1057 | conserved hypothetical protein | 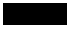 | 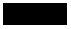 | 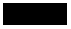 | 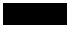 | 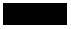 |
| MSM1058 | conserved hypothetical protein | 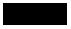 | 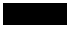 | 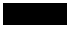 | 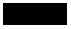 | 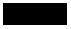 |
| MSM1059 | predicted RecB family exonuclease | 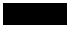 | 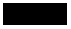 | 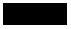 | 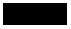 | 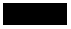 |
| MSM1060 | energy-converting hydrogenase B, subunit Q, EhbQ | 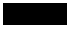 | 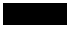 | 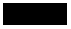 | 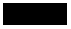 | 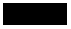 |
| MSM1061 | energy-converting hydrogenase B, subunit P, EhbP | 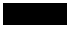 | 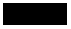 | 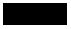 | 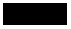 | 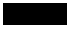 |
| MSM1062 | energy-converting hydrogenase B, subunit O, EhbO | 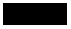 | 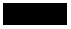 | 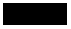 | 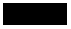 | 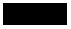 |
| MSM1063 | energy-converting hydrogenase B, subunit N, EhbN | 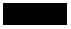 | 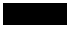 | 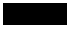 | 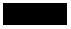 | 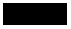 |
| MSM1064 | energy-converting hydrogenase B, subunit M, EhbM | 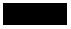 | 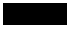 | 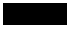 | 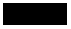 | 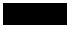 |
| MSM1065 | energy-converting hydrogenase B, subunit L, EhbL | 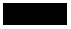 | 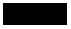 | 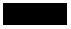 | 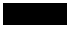 | 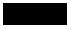 |
| MSM1066 | energy-converting hydrogenase B, subunit K, EhbK | 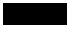 | 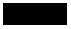 | 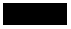 | 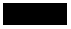 | 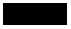 |
| MSM1067 | energy-converting hydrogenase B, subunit J, EhbJ | 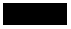 | 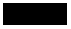 | 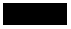 | 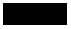 | 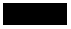 |
| MSM1068 | energy-converting hydrogenase B, subunit I, EhbI | 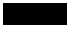 | 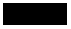 | 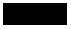 | 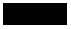 | 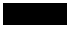 |
| MSM1069 | energy-converting hydrogenase B, subunit H, EhbH | 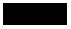 | 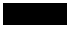 | 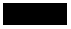 | 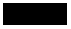 | 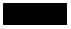 |
| MSM1070 | energy-converting hydrogenase B, subunit G, EhbG | 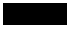 | 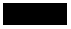 | 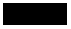 | 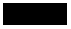 | 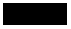 |
| MSM1071 | energy-converting hydrogenase B, subunit F, EhbF | 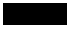 | 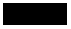 | 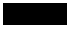 | 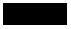 | 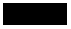 |
| MSM1072 | energy-converting hydrogenase B, subunit E, EhbE | 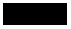 | 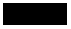 | 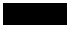 | 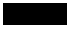 | 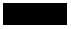 |
| MSM1073 | energy-converting hydrogenase B, subunit D, EhbD | 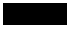 | 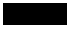 | 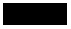 | 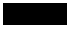 | 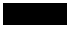 |
| MSM1074 | energy-converting hydrogenase B, subunit C, EhbC | 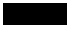 | 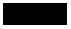 | 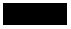 | 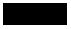 | 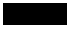 |
| MSM1075 | energy-converting hydrogenase B, subunit B, EhbB | 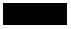 | 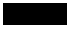 | 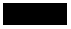 | 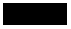 | 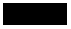 |
| MSM1076 | energy-converting hydrogenase B, subunit A, EhbA | 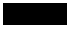 | 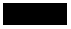 | 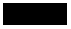 | 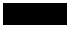 | 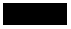 |
| MSM1077 | putative permease (transport) | 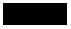 | 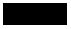 | 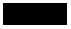 | 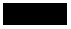 | 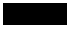 |
| MSM1078 | predicted bile acid/sodium symporter | 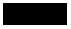 | 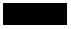 | 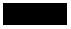 | 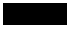 | 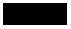 |
| MSM1079 | predicted membrane-bound metal-dependent hydrolase, NCS2 family | 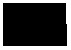 | 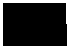 | 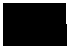 | 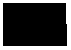 | 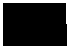 |
| MSM1080 | predicted deacylase | 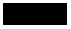 | 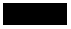 | 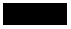 | 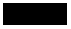 | 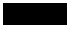 |
| MSM1081 | transcriptional regulator (enhancer-binding protein), DNA2/NAM7 helicase family | 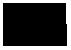 | 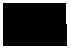 | 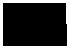 | 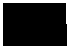 | 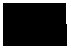 |
| MSM1082 | hypothetical protein | 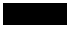 | 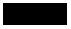 | 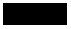 | 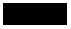 | 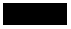 |
| MSM1083 | conserved hypothetical membrane protein | 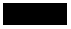 | 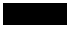 | 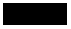 | 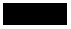 | 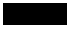 |
| MSM1084 | argininosuccinate synthase, ArgG | 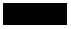 | 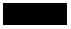 | 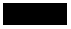 | 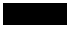 | 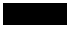 |
| MSM1085 | aquaporin, MIP superfamily, AqpM | 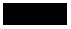 | 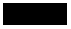 | 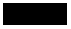 | 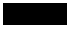 | 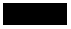 |
| MSM1086 | conserved hypothetical protein | 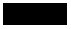 | 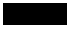 | 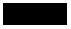 | 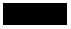 | 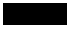 |
| MSM1087 | NAD-dependent protein deacetylase, SIR2 family | 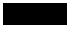 | 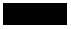 | 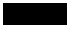 | 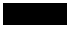 | |
| MSM1088 | hypothetical protein | 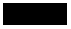 | | 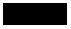 | 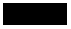 | |
| MSM1089 | hypothetical protein | 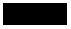 | | 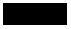 | | |
| MSM1090 | sugar fermentation stimulation protein, SfsA | 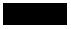 | 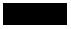 | 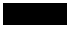 | 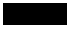 | 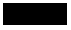 |
| MSM1091 | sugar kinase, YjeF-related protein family | 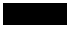 | 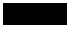 | 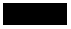 | 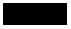 | 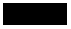 |
| MSM1092 | formylmethanofuran:tertrahydromethanopterin formyltransferase, Ftr | 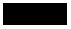 | 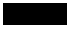 | 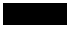 | 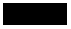 | 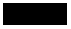 |
| MSM1093 | putative transposase | ND | | | | 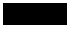 |
| MSM1094 | conserved hypothetical integral membrane protein | 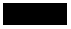 | 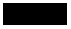 | 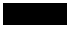 | 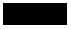 | 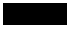 |
| MSM1095 | Trk-type potassium transport system, membrane component, TrkH | 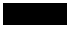 | 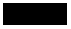 | 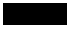 | 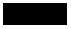 | 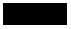 |
| MSM1096 | Trk-type potassium transport system, NAD-binding component, TrkA | 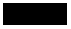 | 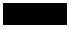 | 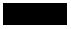 | 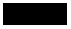 | 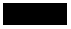 |
| MSM1097 | Zn-dependent hydrolase | 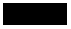 | 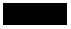 | 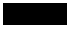 | 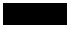 | 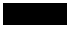 |
| MSM1098 | archaeal holliday junction resolvase | 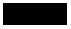 | 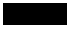 | 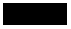 | 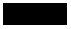 | 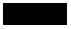 |
| MSM1099 | biotin synthase related protein | 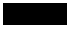 | 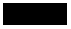 | 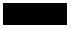 | 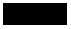 | 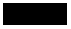 |
| MSM1100 | conserved hypothetical protein | 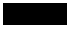 | 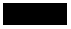 | 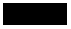 | 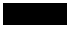 | 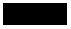 |
| MSM1101 | Asp-tRNA(Asn)/Glu-tRNA(Gln)amidotransferase, B subunit, GatB | 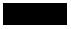 | 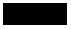 | 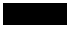 | 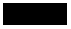 | 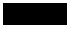 |
| MSM1102 | IMP dehydrogenase related protein | 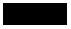 | 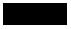 | 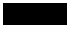 | 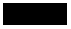 | 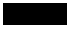 |
| MSM1103 | phosphoribosyl-ATP pyrophosphohydrolase, HisE | 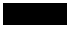 | 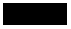 | 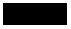 | 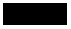 | 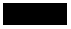 |
| MSM1104 | acetyltransferase, GNAT family | 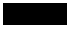 | 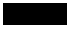 | 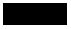 | 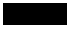 | 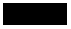 |
| MSM1105 | NCAIR mutase related protein, PurE | 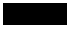 | 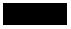 | 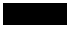 | 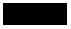 | 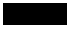 |
| MSM1106 | hydrogenase maturation factor, HypF | 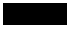 | 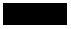 | 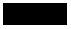 | 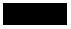 | 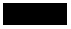 |
| MSM1107 | predicted transcriptional regulator | 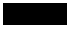 | 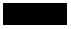 | 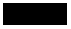 | 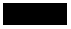 | 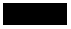 |
| MSM1108 | molecular chaperone GrpE | 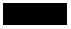 | 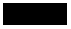 | 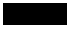 | 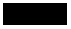 | 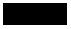 |
| MSM1109 | molecular chaperone DnaJ | 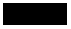 | 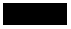 | 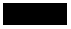 | 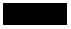 | 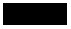 |
| MSM1110 | adhesin-like protein | 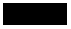 | 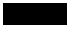 | 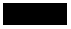 | 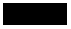 | 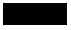 |
| MSM1111 | adhesin-like protein | 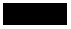 | 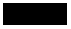 | 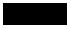 | | 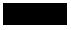 |
| MSM1112 | adhesin-like protein | 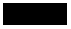 | 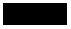 | | 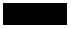 | 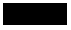 |
| MSM1113 | adhesin-like protein | 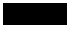 | 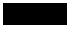 | 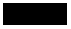 | 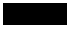 | 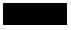 |
| MSM1114 | adhesin-like protein | 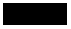 | 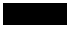 | 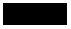 | | 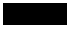 |
| MSM1115 | putative transposase | ND | | | | |
| MSM1116 | adhesin-like protein | 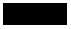 | 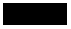 | | 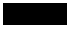 | 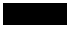 |
| MSM1117 | cobalamin biosynthesis protein N, CobN | 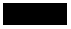 | 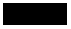 | | | |
| MSM1118 | conserved hypothetical protein | 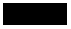 | 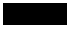 | 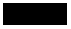 | 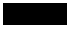 | 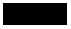 |
| MSM1119 | conserved hypothetical protein | 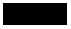 | 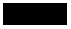 | 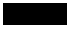 | 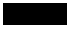 | 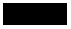 |
| MSM1120 | methionine aminopeptidase, Map | 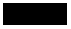 | 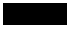 | 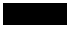 | 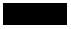 | 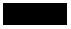 |
| MSM1121 | coenzyme F420-reducing hydrogenase, beta subunit, FrhB | 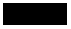 | 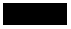 | 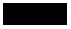 | 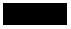 | 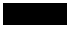 |
| MSM1122 | coenzyme F420-reducing hydrogenase, gamma subunit, FrhG | 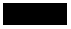 | 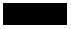 | 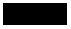 | 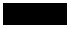 | 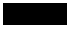 |
| MSM1123 | coenzyme F420-reducing hydrogenase, delta subunit, FrhD | 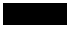 | 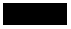 | 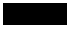 | 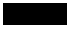 | 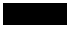 |
| MSM1124 | coenzyme F420-reducing hydrogenase, alpha subunit, FrhA | 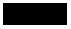 | 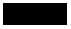 | 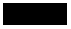 | 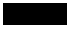 | 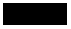 |
| MSM1125 | predicted endoglucanase (CobN-related) | 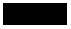 | 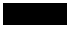 | 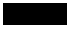 | 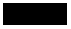 | 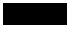 |
| MSM1126 | predicted transcriptional regulator, ArsR family | 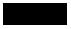 | 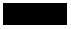 | 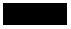 | 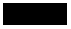 | 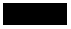 |
| MSM1127 | cation transport ATPase, HAD family | 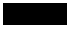 | 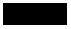 | 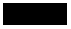 | 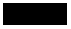 | 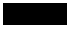 |
| MSM1128 | hypothetical protein | 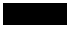 | 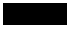 | 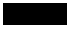 | 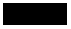 | 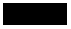 |
| MSM1129 | conserved hypothetical protein | 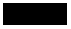 | 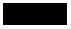 | 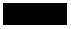 | 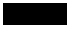 | 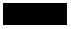 |
| MSM1130 | conserved hypothetical protein | 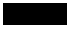 | 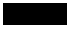 | 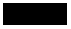 | 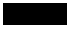 | 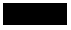 |
| MSM1131 | conserved hypothetical protein | 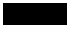 | 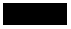 | 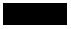 | 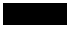 | 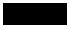 |
| MSM1132 | ribosome biogenesis protein Nop10 | 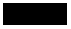 | 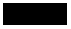 | 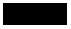 | 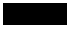 | 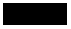 |
| MSM1133 | translation initiation factor alF-2, alpha subunit | 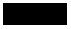 | 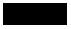 | 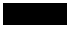 | 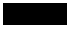 | 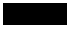 |
| MSM1134 | ribosomal protein S27e | 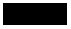 | 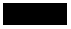 | 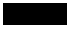 | 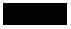 | 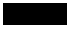 |
| MSM1135 | ribosomal protein L44e | 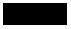 | 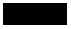 | 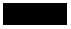 | 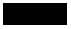 | 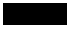 |
| MSM1136 | conserved hypothetical protein | 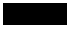 | 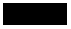 | 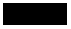 | 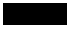 | 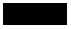 |
| MSM1137 | DNA polymerase sliding clamp subunit, PCNA family, Pcn | 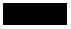 | 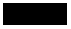 | 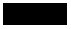 | 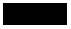 | 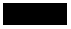 |
| MSM1138 | predicted glutamine amidotransferase, CobB/CobQ-like family | 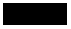 | 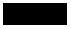 | 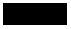 | 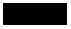 | 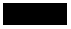 |
| MSM1139 | cell wall biosynthesis protein, MurD-like peptide ligase family | 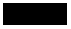 | 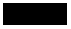 | 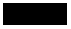 | 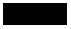 | 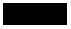 |
| MSM1140 | hypothetical protein | 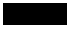 | 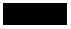 | 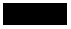 | 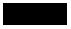 | 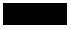 |
| MSM1141 | tryptophan synthase, alpha subunit, TrpA | 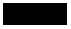 | 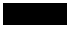 | 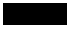 | 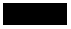 | 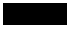 |
| MSM1142 | tryptophan synthase, beta subunit, TrpB | 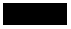 | 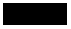 | 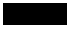 | 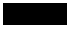 | 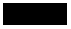 |
| MSM1143 | indole-3-glycerol phosphate synthase, TrpC | 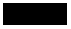 | 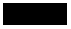 | 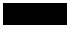 | 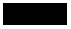 | 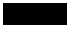 |
| MSM1144 | anthranilate phosphoribosyltransferase, TrpD | 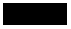 | 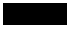 | 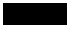 | 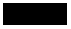 | 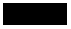 |
| MSM1145 | anthranilate/para-aminobenzoate synthase component II, TrpG | 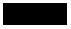 | 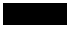 | 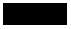 | 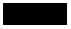 | 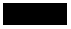 |
| MSM1146 | anthranilate/para-aminobenzoate synthase component I, TrpE | 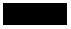 | 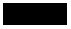 | 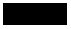 | 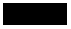 | 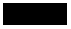 |
| MSM1147 | hypothetical protein | 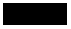 | 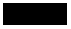 | 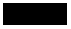 | 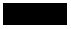 | 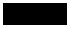 |
| MSM1148 | predicted metal-dependent membrane protease | 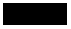 | 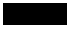 | 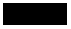 | 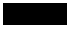 | 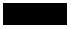 |
| MSM1149 | conserved hypothetical membrane protein | 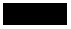 | 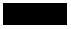 | 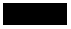 | 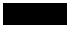 | 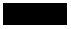 |
| MSM1150 | predicted transcriptional regulator | 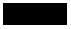 | 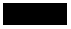 | 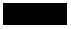 | 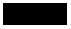 | 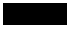 |
| MSM1151 | adenylosuccinate lyase, PurB | 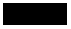 | 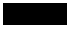 | 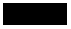 | 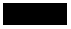 | 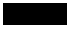 |
| MSM1152 | conserved hypothetical membrane protein | 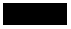 | 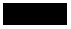 | 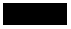 | 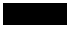 | 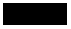 |
| MSM1153 | cation transport ATPase, HAD family | 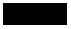 | 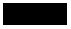 | 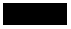 | 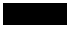 | 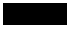 |
| MSM1154 | metal-dependent amidohydrolase | 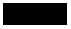 | 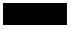 | 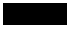 | 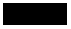 | 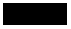 |
| MSM1155 | conserved hypothetical protein | 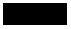 | 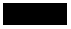 | 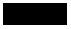 | 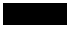 | 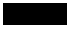 |
| MSM1156 | tRNA pseudouridine synthase D, TruD | 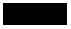 | 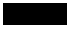 | 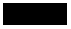 | 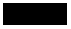 | 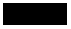 |
| MSM1157 | hypothetical protein | 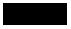 | 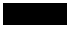 | 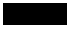 | 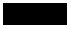 | 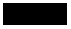 |
| MSM1158 | hydrogenase expression/formation protein, HypE | 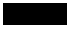 | 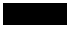 | 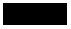 | 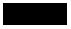 | 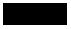 |
| MSM1159 | glutamine amidotransferase, HisH | 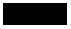 | 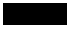 | 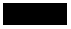 | 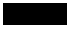 | 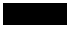 |
| MSM1160 | nitrogenase molybdenum-iron protein, NifD | 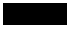 | 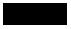 | 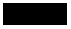 | 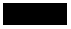 | 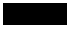 |
| MSM1161 | hypothetical protein | 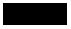 | 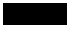 | 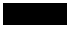 | 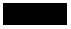 | 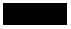 |
| MSM1162 | conserved hypothetical protein | 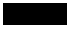 | 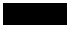 | 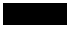 | 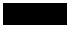 | 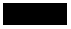 |
| MSM1163 | hypothetical protein | 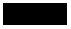 | 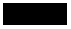 | 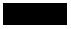 | 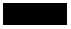 | 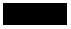 |
| MSM1164 | predicted GTPase, HSR1-related family | 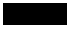 | 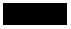 | 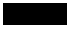 | 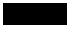 | 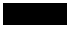 |
| MSM1165 | predicted phosphohydrolase (metal-dependent) | 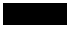 | 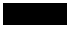 | 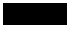 | 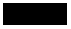 | 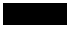 |
| MSM1166 | conserved hypothetical membrane protein | 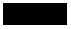 | 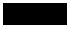 | 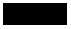 | 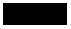 | 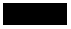 |
| MSM1167 | cobalt precorrin-6Y C5, 15-methyltransferase, CbiE | 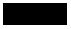 | 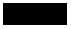 | 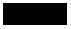 | 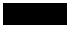 | 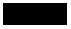 |
| MSM1168 | putative adhesin-like protein | 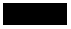 | 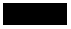 | 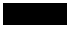 | 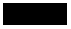 | 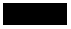 |
| MSM1169 | hypothetical protein | 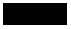 | 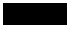 | 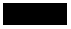 | 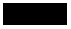 | 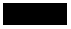 |
| MSM1170 | arsenite-transporting ATPase | 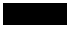 | 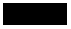 | 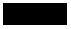 | 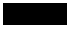 | 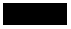 |
| MSM1171 | ammonia-dependent NAD+synthetase, NadE | 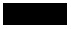 | 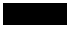 | 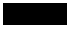 | 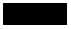 | 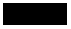 |
| MSM1172 | leucyl-tRNA synthetase, LeuS | 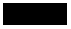 | 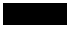 | 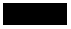 | 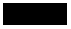 | 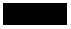 |
| MSM1173 | tRNA(1-methyladenosine)methyltransferase | 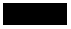 | 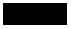 | 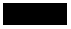 | 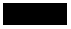 | 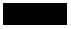 |
| MSM1174 | heat shock protein HtpX (Zn-dependent) | 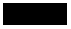 | 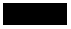 | 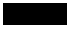 | 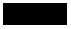 | 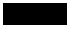 |
| MSM1175 | conserved hypothetical membrane protein | 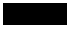 | 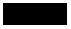 | 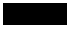 | 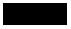 | 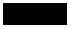 |
| MSM1176 | replication factor C, small subunit, RfcS | 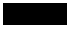 | 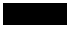 | 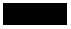 | 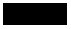 | 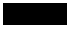 |
| MSM1177 | replication factor C, large subunit, RfcL | 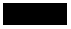 | 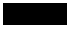 | 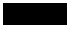 | 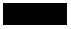 | 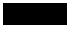 |
| MSM1178 | putative ATPase implicated in cell cycle control | 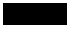 | 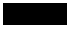 | 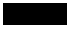 | 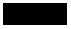 | 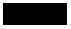 |
| MSM1179 | shikimate 5-dehydrogenase, AroE | 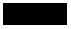 | 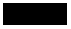 | 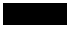 | 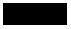 | 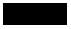 |
| MSM1180 | predicted metal-dependent membrane protease | 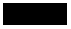 | 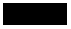 | 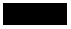 | 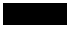 | 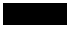 |
| MSM1181 | histidyl-tRNA synthetase, HisS | 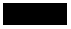 | 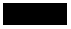 | 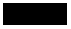 | 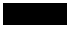 | 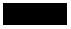 |
| MSM1182 | phosphoribosyl-AMP cyclohydrolase, HisI | 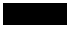 | 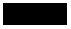 | 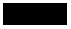 | 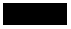 | 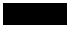 |
| MSM1183 | ATPase, PilT family | 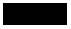 | 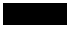 | 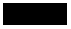 | 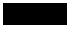 | 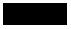 |
| MSM1184 | sugar phosphate isomerase/epimerase, AP endonuclease family 2 | 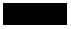 | 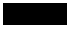 | 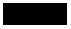 | 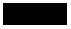 | 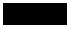 |
| MSM1185 | methylated-DNA-[protein]-cysteine S-methyltransferase | 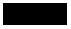 | 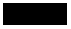 | 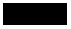 | 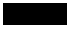 | 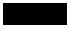 |
| MSM1186 | potassium transport system, membrane component, KefB | 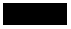 | 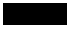 | 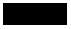 | 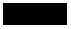 | 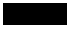 |
| MSM1187 | ERCC4-like helicase | 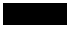 | 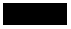 | 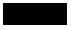 | 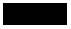 | 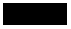 |
| MSM1188 | adhesin-like protein | 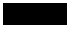 | 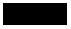 | 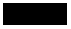 | 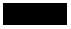 | 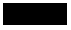 |
| MSM1189 | putative transposase | ND | | | | |
| MSM1190 | cell wall biosynthesis protein, UDP-N-acetylmuramate-alanine ligase family | 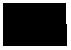 | 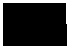 | 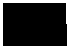 | 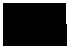 | 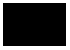 |
| MSM1191 | cell wall biosynthesis protein, MurD-like peptide ligase family | 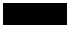 | 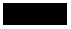 | 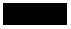 | 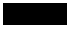 | 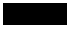 |
| MSM1192 | conserved hypothetical protein | 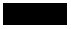 | 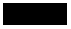 | 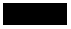 | 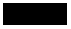 | 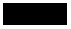 |
| MSM1193 | single-stranded DNA-specific exonuclease, DHH family | 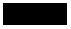 | 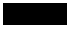 | 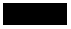 | 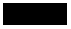 | 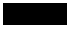 |
| MSM1194 | ribosomal protein S15p | 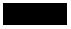 | 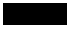 | 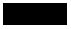 | 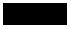 | 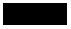 |
| MSM1195 | xanthosine triphosphate pyrophosphatase, Ham1 family | 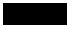 | 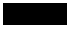 | 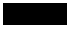 | 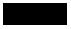 | 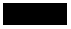 |
| MSM1196 | predicted archaeal ATPase, AAA+ superfamily | 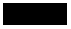 | | | | |
| MSM1197 | predicted ATPase, AAA+ superfamily | 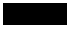 | 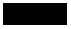 | 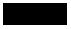 | 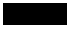 | 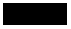 |
| MSM1198 | O-sialoglycoprotein endopeptidase | 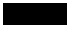 | 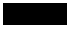 | 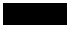 | 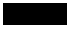 | 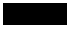 |
| MSM1199 | conserved hypothetical protein | 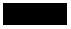 | 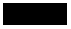 | 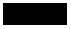 | 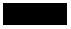 | 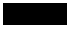 |
| MSM1200 | phosphoribosyltransferase, CobT | 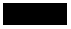 | 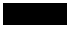 | 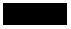 | 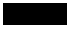 | 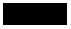 |
| MSM1201 | undecaprenyl-diphosphatase, UppP | 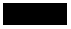 | 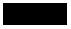 | 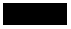 | 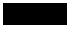 | 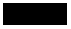 |
| MSM1202 | branched-chain-amino-acid aminotransferase, IIvE | 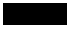 | 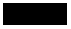 | 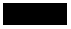 | 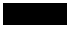 | 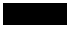 |
| MSM1203 | Zn-dependent protease, peptidase M48 family | 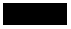 | 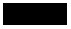 | 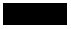 | 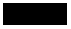 | 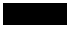 |
| MSM1204 | coenzyme F420-dependent methylenetetrahydromethanopterin dehydrogenase, Mtd | 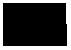 | 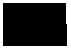 | 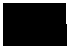 | 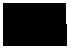 | 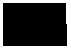 |
| MSM1205 | conserved hypothetical membrane protein | 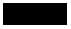 | 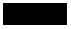 | 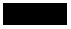 | 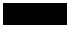 | 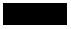 |
| MSM1206 | imidazoleglycerol-phosphate dehydrogenase, HisB | 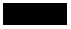 | 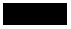 | 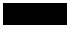 | 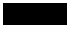 | 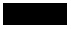 |
| MSM1207 | molybdate transport system regulatory protein | 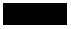 | 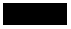 | 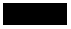 | 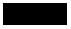 | 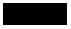 |
| MSM1208 | teichoic acid transporter | 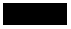 | 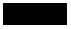 | 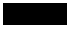 | 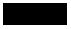 | 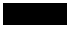 |
| MSM1209 | multimeric flavodoxin | 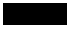 | 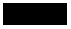 | 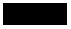 | 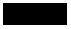 | 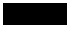 |
| MSM1210 | efflux pump antibiotic resistance protein, MFS permease family | 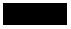 | 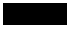 | 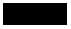 | 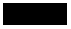 | 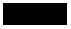 |
| MSM1211 | putative phosphoserine phosphatase | 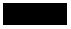 | 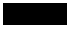 | 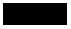 | 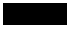 | 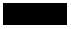 |
| MSM1212 | conserved hypothetical protein | 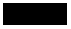 | 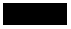 | 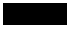 | 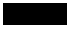 | 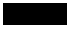 |
| MSM1213 | 3-hexulose 6-phosphate synthase/formaldehyde activating enzyme | 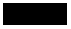 | 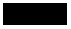 | 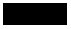 | 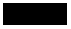 | 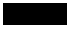 |
| MSM1214 | threonyl-tRNA synthetase, ThrS | 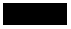 | 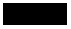 | 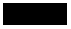 | 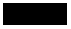 | 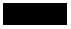 |
| MSM1215 | cobyrinic acid a,c-diamide synthase, CbiA | 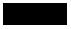 | 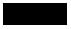 | 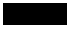 | 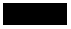 | 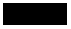 |
| MSM1216 | conserved hypothetical membrane protein | 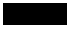 | 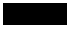 | 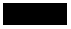 | 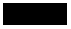 | 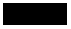 |
| MSM1217 | type II restriction endonuclease | 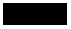 | 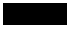 | 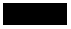 | 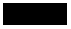 | 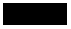 |
| MSM1218 | predicted acid phosphatase (survival protein), SurE | 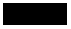 | 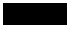 | 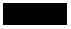 | 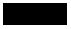 | 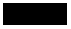 |
| MSM1219 | hypothetical protein | 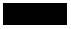 | 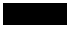 | 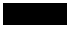 | 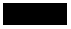 | 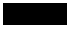 |
| MSM1220 | small nucleolar ribonucleoprotein, Sm-like family | 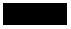 | 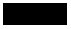 | 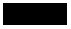 | 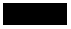 | 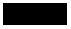 |
| MSM1221 | actin-like ATPase | 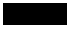 | 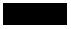 | 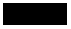 | 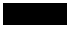 | 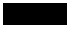 |
| MSM1222 | ketol-acid reductoisomerase, IIvC | 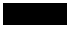 | 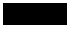 | 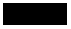 | 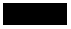 | 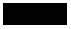 |
| MSM1223 | carbonic anhydrase | 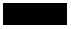 | 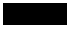 | 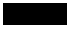 | 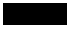 | 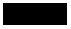 |
| MSM1224 | acetolactate synthase, small subunit (regulatory), IIvH | 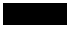 | 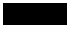 | 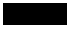 | 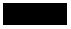 | 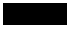 |
| MSM1225 | acetolactate synthase, large subunit (TPP-requiring), IIvB | 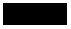 | 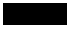 | 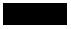 | 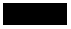 | 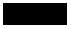 |
| MSM1226 | ornithine carbamoyltransferase, ArgF | 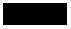 | 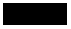 | 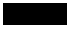 | 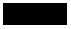 | 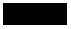 |
| MSM1227 | phosphoribosylamine-glycine ligase, PurD | 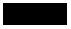 | 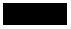 | 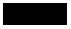 | 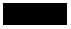 | 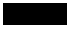 |
| MSM1228 | Na+-driven multidrug efflux pump | 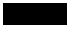 | 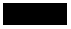 | 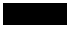 | 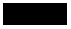 | 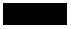 |
| MSM1229 | Na+-driven multidrug efflux pump | 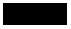 | 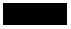 | 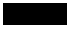 | 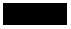 | 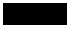 |
| MSM1230 | transcriptional regulator, MarR family | 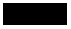 | 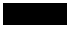 | 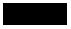 | 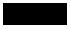 | 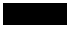 |
| MSM1231 | arginyl-TRNA synthetase, ArgS | 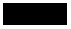 | 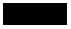 | 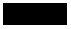 | 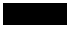 | 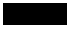 |
| MSM1232 | signal peptidase I | 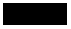 | 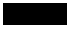 | 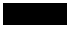 | 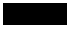 | 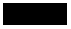 |
| MSM1233 | glutamate-1-semialdehyde 2,1-aminomutase, HemL | 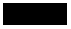 | 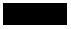 | 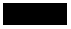 | 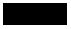 | 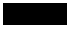 |
| MSM1234 | cobalt-precorrin-8X methylmutase, CbiC | 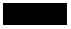 | 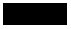 | 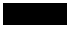 | 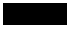 | 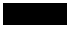 |
| MSM1235 | predicted flavoprotein | 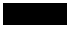 | 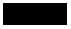 | 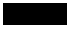 | 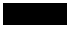 | 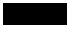 |
| MSM1236 | aspartyl-tRNA synthetase, AspS | 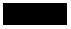 | 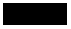 | 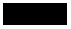 | 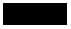 | 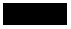 |
| MSM1237 | dihydroxy-acid dehydratase, IIvD | 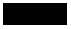 | 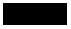 | 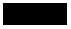 | 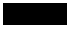 | 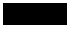 |
| MSM1238 | histidinol dehydrogenase, HisD | 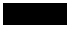 | 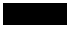 | 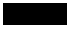 | 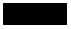 | 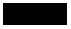 |
| MSM1239 | predicted DNA-binding protein | 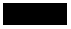 | 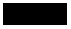 | 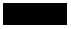 | 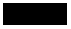 | 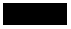 |
| MSM1240 | predicted AAA ATPase | 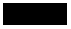 | 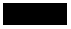 | 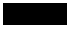 | 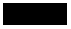 | 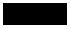 |
| MSM1241 | chromosome partitioning ATPase | 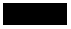 | 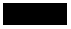 | 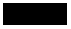 | 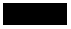 | 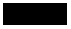 |
| MSM1242 | tryptophan synthase, beta subunit, TrpB | 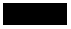 | 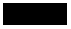 | 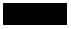 | 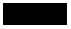 | 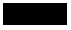 |
| MSM1243 | putative actin-like ATPase | 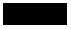 | 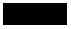 | 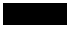 | 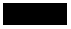 | 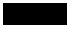 |
| MSM1244 | predicted metal-dependent phosphoesterases, PHP family | 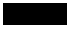 | 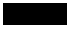 | 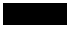 | 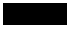 | 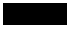 |
| MSM1245 | archaeal DNA-binding protein, AlbA | 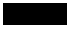 | 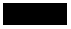 | 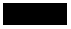 | 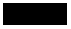 | 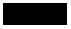 |
| MSM1246 | isopropylmalate synthase, LeuA | 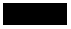 | 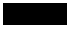 | 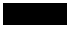 | 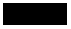 | 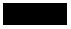 |
| MSM1247 | serine/threonine protein kinase related protein (PQQ-binding) | 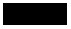 | 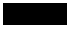 | 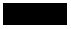 | 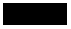 | 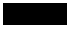 |
| MSM1248 | multidrug ABC transporter, permease component | 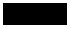 | 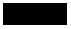 | 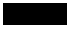 | 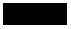 | 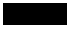 |
| MSM1249 | multidrug ABC transporter, ATPase component | 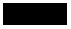 | 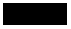 | 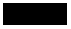 | 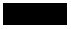 | 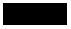 |
| MSM1250 | predicted transcriptional regulator, PadR-like family | 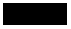 | 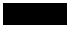 | 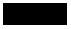 | 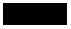 | 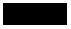 |
| MSM1251 | predicted sugar phosphate isomerase/epimerase, AP endonuclease family 2 | 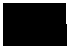 | 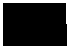 | 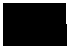 | 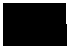 | 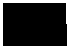 |
| MSM1252 | cation transporting P-type ATPase, HAD family | 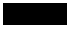 | 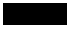 | 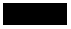 | 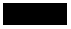 | 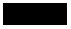 |
| MSM1253 | glutamyl-tRNA (Gln) amidotransferase subunit A, GatA | 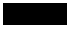 | 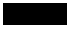 | 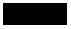 | 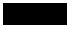 | 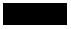 |
| MSM1254 | cobyric acid synthase | 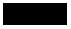 | 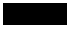 | 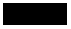 | 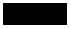 | 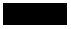 |
| MSM1255 | hypothetical protein | 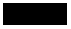 | 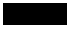 | 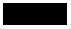 | 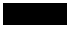 | 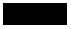 |
| MSM1256 | 3,4-dihydroxy-2-butanone 4-phosphate synthase, RibB | 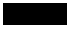 | 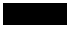 | 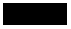 | 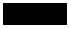 | 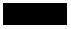 |
| MSM1257 | predicted transcriptional regulator of riboflavin/FAD biosynthetic operon | 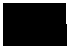 | 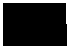 | 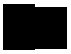 | 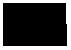 | 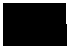 |
| MSM1258 | fumarate reductase/succinate dehydrogenase flavoprotein, Sdh | 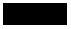 | 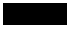 | 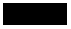 | 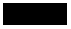 | 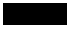 |
| MSM1259 | predicted metal-dependent hydrolase, TRZ/ATZ family | 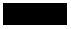 | 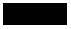 | 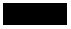 | 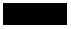 | 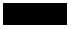 |
| MSM1260 | archaeal histone | 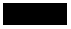 | 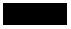 | 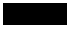 | 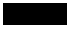 | 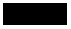 |
| MSM1261 | ATP phosphoribosyltransferase, HisG | 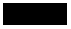 | 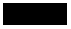 | 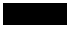 | 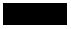 | 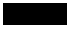 |
| MSM1262 | flavodoxin (protoporphyrinogen oxidase) | 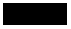 | 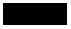 | 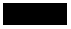 | 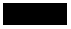 | 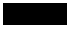 |
| MSM1263 | aspartate carbamoyltransferase, PyrB | 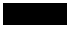 | 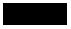 | 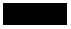 | 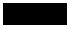 | 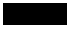 |
| MSM1264 | cell division control protein 6, Cdc6 | 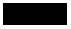 | 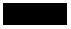 | 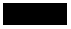 | 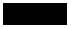 | 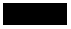 |
| MSM1265 | conserved hypothetical protein | 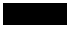 | 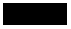 | 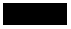 | 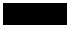 | 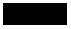 |
| MSM1266 | cobalamin biosynthesis protein D, CobD | 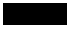 | 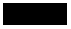 | 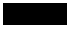 | 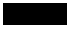 | 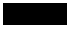 |
| MSM1267 | cobalamin biosynthesis protein G, CbiG | 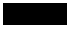 | 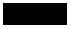 | 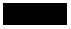 | 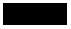 | 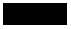 |
| MSM1268 | conserved hypothetical protein | 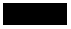 | 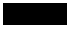 | 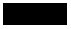 | 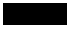 | 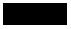 |
| MSM1269 | putative Met repressor-like protein | 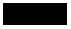 | 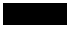 | 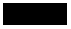 | 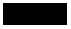 | 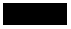 |
| MSM1270 | fuculose-1-phosphate aldolase, class II aldolase/adducin family | 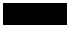 | 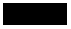 | 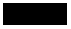 | 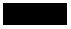 | 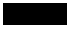 |
| MSM1271 | archaeal DNA polymerase II, small subunit | 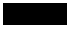 | 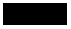 | 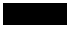 | 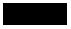 | 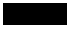 |
| MSM1272 | conserved hypothetical protein | 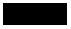 | 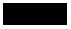 | 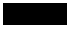 | 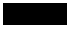 | 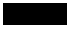 |
| MSM1273 | cobalt precorrin-3B C17-methyltransferase, CbiH | 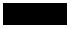 | 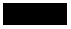 | 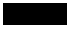 | 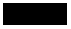 | 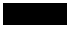 |
| MSM1274 | predicted potassium ion transport protein | 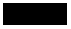 | 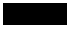 | 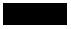 | 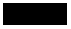 | 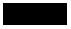 |
| MSM1275 | mgtE-like divalent cation transporter | 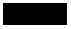 | 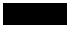 | 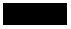 | 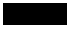 | 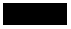 |
| MSM1276 | conserved hypothetical protein | 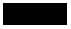 | 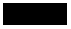 | 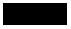 | 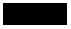 | 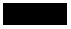 |
| MSM1277 | conserved hypothetical membrane protein | 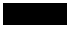 | 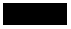 | 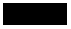 | 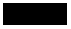 | 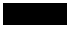 |
| MSM1278 | predicted archaeal ATPase, AAA+ superfamily | 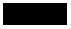 | 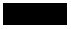 | 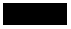 | 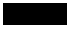 | 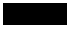 |
| MSM1279 | predicted nucleic-acid-binding protein containing a Zn-ribbon | 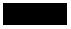 | 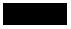 | 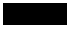 | 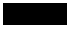 | 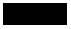 |
| MSM1280 | sirohydrochlorin cobaltochelatase, CbiX | 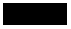 | 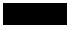 | 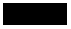 | 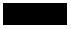 | 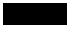 |
| MSM1281 | sirohydrochlorin cobaltochelatase-related protein | 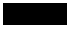 | 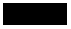 | 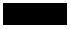 | 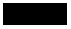 | 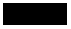 |
| MSM1282 | putative adhesin-like protein | 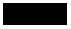 | 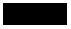 | 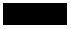 | 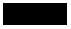 | 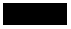 |
| MSM1283 | thiamine monphosphate kinase, ThiL | 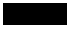 | 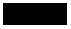 | 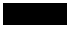 | 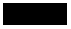 | 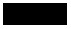 |
| MSM1284 | pyruvate formate-lyase activating enzyme, PflA | 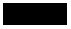 | 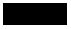 | 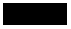 | 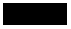 | 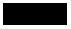 |
| MSM1285 | conserved hypothetical protein | 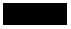 | 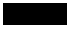 | 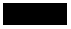 | 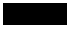 | 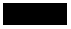 |
| MSM1286 | 3-octaaprenyl-4-hydroxybenzoate carboxy-lyase, UbiD | 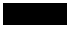 | 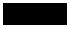 | 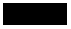 | 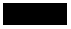 | 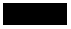 |
| MSM1287 | phosphoribosylaminoimidazole carboxylase (NCAIR muatse), PurE | 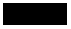 | 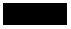 | 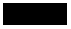 | 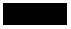 | 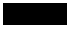 |
| MSM1288 | conserved hypothetical membrane protein | 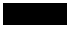 | 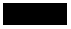 | | 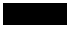 | |
| MSM1289 | GtrA-like surface polysaccharide biosynthesis protein, GtrA | 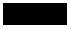 | 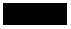 | | | 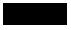 |
| MSM1290 | glycosyltransferase (related to beta-glycosidases), GT2 family [CAZy] | 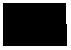 | 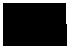 | | 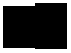 | 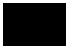 |
| MSM1291 | conserved hypothetical membrane protein | 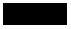 | 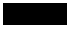 | 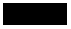 | 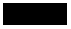 | 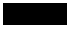 |
| MSM1292 | transcriptional accessory protein, S1 RNA binding family, Tex | 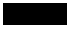 | 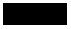 | 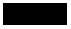 | 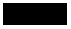 | 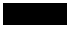 |
| MSM1293 | nitroreductase, NADH oxidase/flavin reductase family | 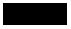 | 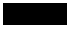 | 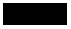 | 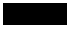 | 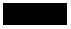 |
| MSM1294 | glycosyltransferase, GT2 family | 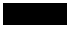 | 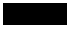 | 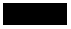 | 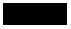 | 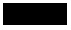 |
| MSM1295 | predicted DNA-binding protein | 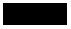 | 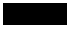 | 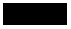 | 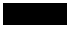 | 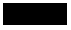 |
| MSM1296 | riboflavin synthase, beta subunit, RibH | 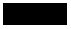 | 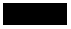 | 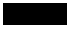 | | 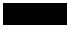 |
| MSM1297 | glycosyltransferase, GT2 family | 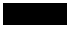 | 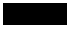 | | 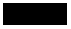 | |
| MSM1298 | 3-isopropylmalate dehydrogenase, LeuB | 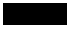 | 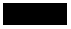 | 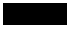 | 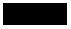 | 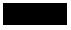 |
| MSM1299 | 3-isopropylmalate dehydratase, small subunit, LeuD | 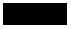 | 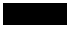 | 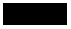 | 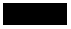 | 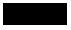 |
| MSM1300 | 3-isopropylmalate dehydratase, large subunit, LeuC | 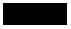 | 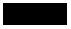 | | 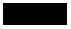 | 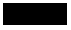 |
| MSM1301 | predicted Fe-S oxidoreductase | 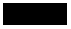 | 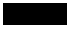 | 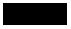 | | 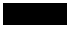 |
| MSM1302 | conserved hypothetical protein | 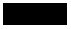 | 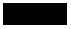 | 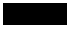 | 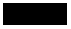 | 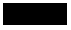 |
| MSM1303 | UDP-N-acetyl-D-mannosaminuronate dehydrogenase | 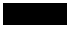 | 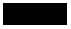 | | 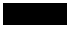 | 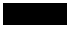 |
| MSM1304 | dTDP-4-dehydrorhamnose reductase, RfbD | 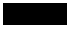 | 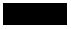 | 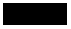 | 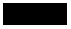 | 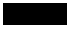 |
| MSM1305 | adhesin-like protein | 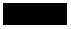 | 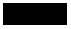 | 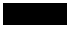 | | 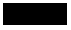 |
| MSM1306 | adhesin-like protein | 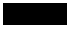 | 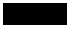 | | | 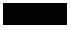 |
| MSM1307 | dTDP-glucose pyrophosphorylase, RfbA | 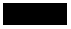 | 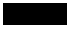 | 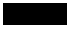 | 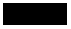 | 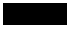 |
| MSM1308 | dTDP-4-dehydrorhamnose 3,5-epimerase | 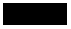 | 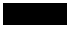 | 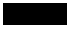 | 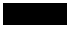 | 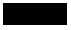 |
| MSM1309 | dTDP-D-glucose 4,6-dehydratase, RfbB | 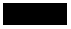 | | 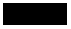 | 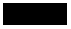 | 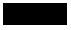 |
| MSM1310 | glycosyltransferase, GT2 family | 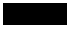 | 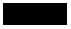 | | | 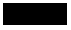 |
| MSM1311 | glycosyltransferase, GT2 family | 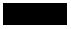 | 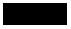 | 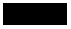 | | 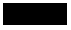 |
| MSM1312 | glycosyltransferase, GT2 family | 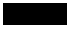 | | 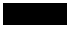 | 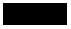 | 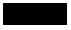 |
| MSM1313 | distantly related to glycosyltransferases, GT4 family | 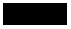 | 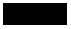 | 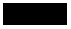 | 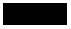 | 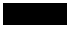 |
| MSM1314 | hypothetical protein | 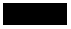 | 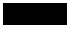 | 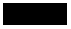 | 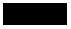 | 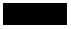 |
| MSM1315 | predicted transcriptional regulator | 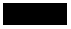 | | 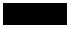 | 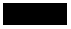 | 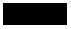 |
| MSM1316 | glycosyltransferase, GT2 family | 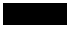 | 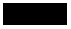 | 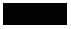 | 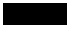 | 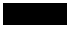 |
| MSM1317 | distantly related to glycosyltransferases, GT4 family | 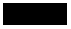 | 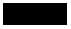 | 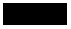 | 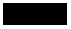 | 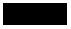 |
| MSM1318 | conserved hypothetical protein | 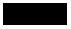 | 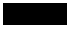 | 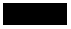 | 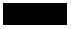 | 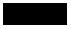 |
| MSM1319 | conserved hypothetical protein | 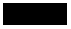 | 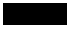 | 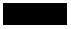 | 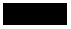 | 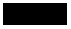 |
| MSM1320 | possible glycosyltransferase | 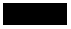 | 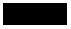 | 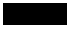 | 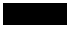 | 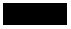 |
| MSM1321 | predicted glycosyltransferase, GT2 family | 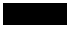 | 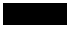 | 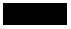 | 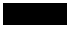 | 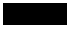 |
| MSM1322 | distantly related to alpha-glycosyltransferases, GT4 family | 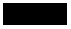 | 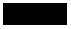 | 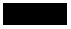 | 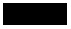 | 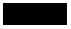 |
| MSM1323 | glycosyltransferase, GT2 family | 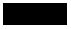 | 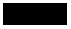 | 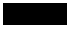 | 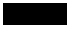 | 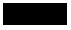 |
| MSM1324 | glycosyltransferase, GT2 family | 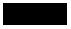 | 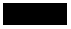 | 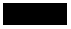 | 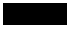 | 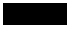 |
| MSM1325 | predicted polysaccharide/polyol phosphate ABC transporter, permease component | 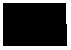 | 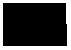 | 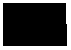 | 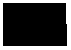 | 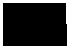 |
| MSM1326 | polysaccharide/polyol phosphate ABC transporter, ATPase component | 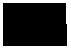 | 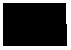 | 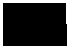 | 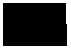 | 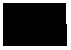 |
| MSM1327 | predicted CDP-glycerol:poly(glycerophosphate) glycerophosphotransferase | 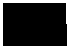 | 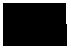 | 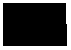 | 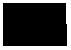 | 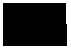 |
| MSM1328 | glycosyltransferase, GT2 family | 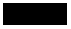 | 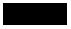 | 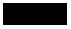 | 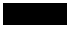 | 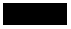 |
| MSM1329 | predicted glycosyltransferase, GT2 family | 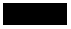 | 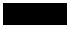 | 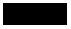 | 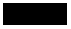 | 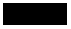 |
| MSM1330 | predicted glycosyltransferase, GT2 family | 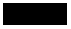 | 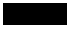 | 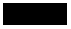 | 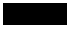 | 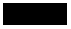 |
| MSM1331 | bacterial sugar transferase, WcaJ | 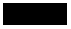 | 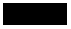 | 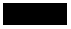 | 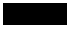 | 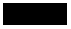 |
| MSM1332 | ssDNA-binding protein | 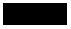 | 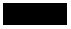 | 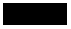 | 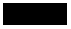 | 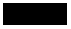 |
| MSM1333 | DNA repair protein RadA, RadA | 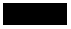 | 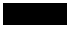 | 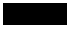 | 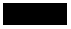 | 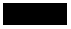 |
| MSM1334 | predicted permease | 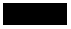 | 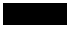 | 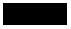 | 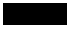 | 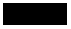 |
| MSM1335 | hypothetical protein | 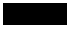 | 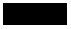 | 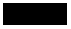 | 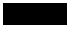 | 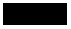 |
| MSM1336 | heterodisulfide reductase, subunit A, HdrA | 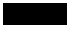 | 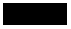 | 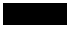 | 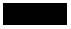 | 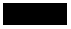 |
| MSM1337 | glycine hydroxymethyltransferase, GlyA | 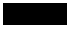 | 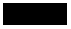 | 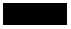 | 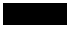 | 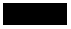 |
| MSM1338 | archaeal flavoprotein | 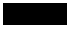 | 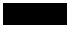 | 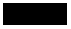 | 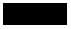 | 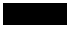 |
| MSM1339 | conserved hypothetical protein | 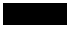 | 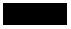 | 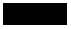 | 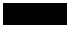 | 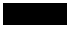 |
| MSM1340 | archaeal S-adenosylmethionine synthetase, MetK | 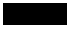 | 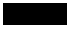 | 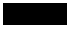 | 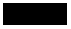 | 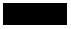 |
| MSM1341 | isoleucyl-tRNA synthetase, IIeS | 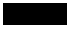 | 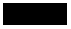 | 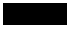 | 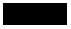 | 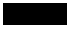 |
| MSM1342 | phosphoribosylformylglycinamidine (FGAM) synthase, PurL | 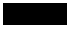 | 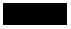 | 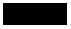 | 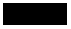 | 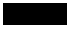 |
| MSM1343 | molybdenum cofactor biosynthesis protein, MoeA | 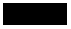 | 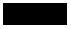 | 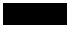 | 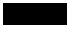 | 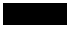 |
| MSM1344 | predicted membrane-associated Zn-dependent protease | 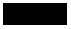 | 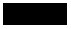 | 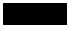 | 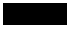 | 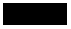 |
| MSM1345 | hypothetical protein | 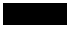 | 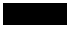 | 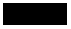 | 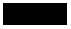 | 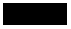 |
| MSM1346 | conserved hypothetical protein | 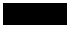 | | 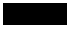 | | 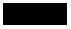 |
| MSM1347 | hypothetical protein | 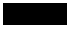 | 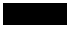 | 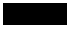 | 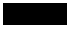 | 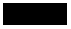 |
| MSM1348 | rubrerythrin | 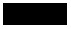 | 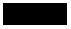 | 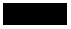 | 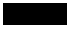 | 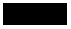 |
| MSM1349 | F420H2-oxidase/flavoprotein, FprA | 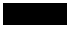 | 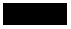 | 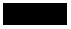 | 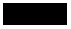 | 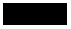 |
| MSM1350 | predicted transcriptional regulator, ArsR family | 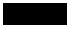 | 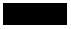 | 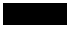 | 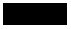 | 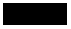 |
| MSM1351 | precorrin-2 C20-methyltransferase, CbiL | 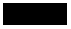 | 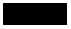 | 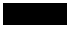 | 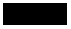 | 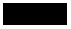 |
| MSM1352 | predicted ATP-dependent DNA helicase | 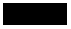 | 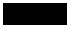 | 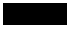 | 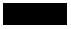 | 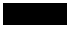 |
| MSM1353 | putative topoisomerase IV, subunit A | 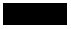 | 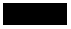 | 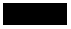 | 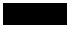 | 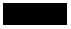 |
| MSM1354 | DNA_directed RNA polymerase subunit M, RpoM | 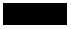 | 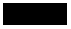 | 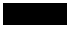 | 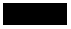 | 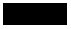 |
| MSM1355 | ADP-ribose pyrophosphatase, NUDIX hydrolase family | 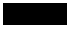 | 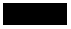 | 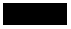 | 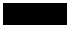 | 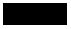 |
| MSM1356 | DNA-directed RNA polymerase, subunit L, RpoL | 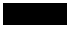 | 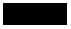 | 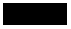 | 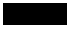 | 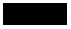 |
| MSM1357 | predicted RNA-binding protein | 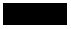 | 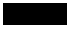 | 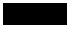 | 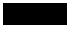 | 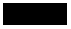 |
| MSM1358 | diphthamide synthase, subunit DPH2 | 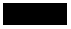 | 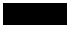 | 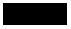 | 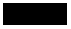 | 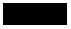 |
| MSM1359 | adenine phosphoribosyltransferase, Apt | 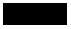 | 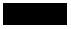 | 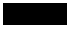 | 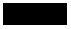 | 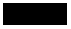 |
| MSM1360 | signal recognition particle GTPase SRP54 | 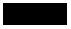 | 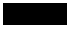 | 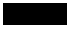 | 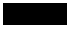 | 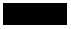 |
| MSM1361 | predicted pseudouridylate synthase | 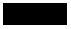 | 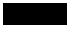 | 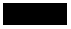 | 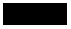 | 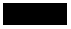 |
| MSM1362 | molybdenum cofactor biosynthesis protein C, MoaC | 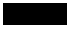 | 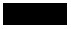 | 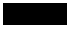 | 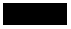 | 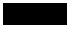 |
| MSM1363 | preprotein translocase, SecG subunit, SecG | 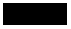 | 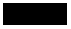 | 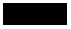 | 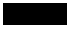 | 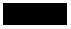 |
| MSM1364 | imidazoleglycerol-phosphate synthase, HisF | 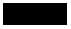 | 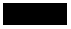 | 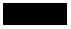 | 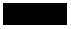 | 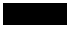 |
| MSM1365 | 3-methyladenine DNA glycosylase/8-oxoguanine DNA glycosylase | 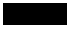 | 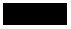 | 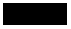 | 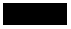 | 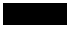 |
| MSM1366 | lactoylglutathione lyase, LgIU | 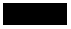 | 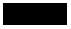 | 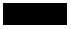 | 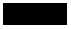 | 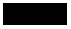 |
| MSM1367 | peptidyl-prolyl cis-trans isomerase, PpiB | 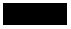 | 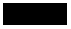 | 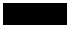 | 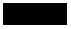 | 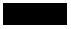 |
| MSM1368 | N-acetylornithine aminotransferase, ArgD | 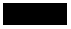 | 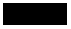 | 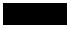 | 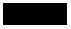 | 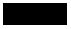 |
| MSM1369 | MutT-related protein, NUDIX family | 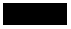 | 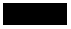 | 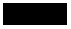 | 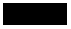 | 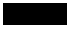 |
| MSM1370 | conserved hypothetical membrane protein | 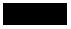 | 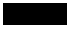 | 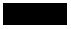 | 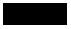 | 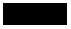 |
| MSM1371 | diaminopimelate decarboxylase, LysA | 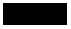 | 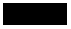 | 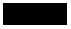 | 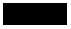 | 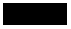 |
| MSM1372 | diaminopimelate epimerase, DapF | 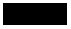 | 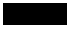 | 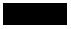 | 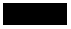 | 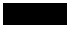 |
| MSM1373 | methyltransferase, HemK | 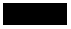 | 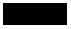 | 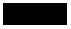 | 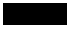 | 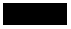 |
| MSM1374 | dimethyladenosine transferase, KsgA | 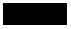 | 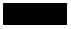 | 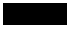 | 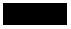 | 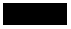 |
| MSM1375 | predicted RNA-binding protein | 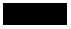 | 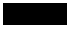 | 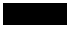 | 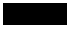 | 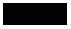 |
| MSM1376 | DNA-directed RNA polymerase subunit F | 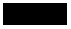 | 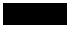 | 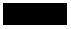 | 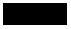 | 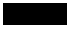 |
| MSM1377 | ribosomal protein L21e | 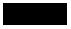 | 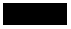 | 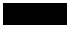 | 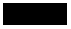 | 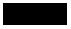 |
| MSM1378 | putative monooxygenase, ABM family | 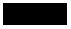 | 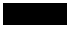 | 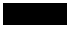 | 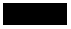 | 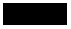 |
| MSM1379 | predicted NADP-dependent alcohol dehydrogenase | 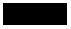 | 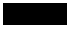 | 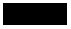 | 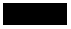 | 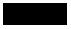 |
| MSM1380 | NADP-dependent alcohol dehydrogenase | 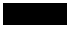 | 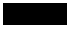 | 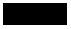 | 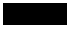 | 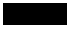 |
| MSM1381 | putative NADP-dependent alcohol dehydrogenase | 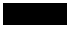 | 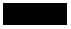 | 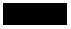 | 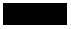 | 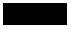 |
| MSM1382 | conserved hypothetical membrane protein | 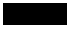 | 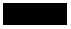 | 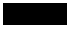 | 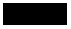 | 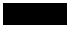 |
| MSM1383 | anaerobic ribonucleoside-triphosphate reductase, NrdD | 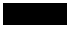 | 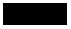 | 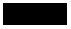 | 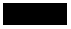 | 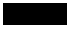 |
| MSM1384 | archaeal DNA polymerase II, large subunit, PolC | 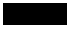 | 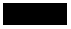 | 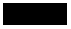 | 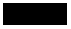 | 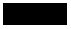 |
| MSM1385 | predicted acyltransferase | 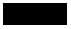 | 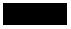 | 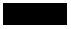 | 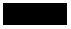 | 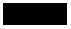 |
| MSM1386 | cytosine deaminase | 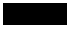 | 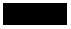 | 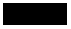 | 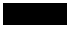 | 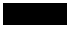 |
| MSM1387 | lysyl-tRNA synthetase (class I), LysS | 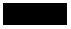 | 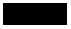 | 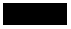 | 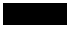 | 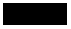 |
| MSM1388 | thiamine biosynthesis protein, ThiC | 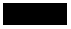 | 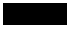 | 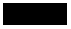 | 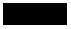 | 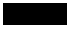 |
| MSM1389 | sugar kinase, ribokinase/pfkB superfamily | 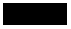 | 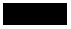 | 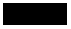 | 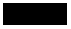 | 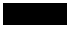 |
| MSM1390 | transcriptional regulator, LysR family | 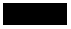 | 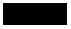 | 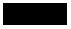 | 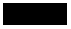 | 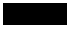 |
| MSM1391 | predicted sugar phosphate isomerase involved in capsule formation, GutQ | 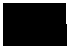 | 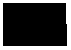 | 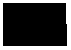 | 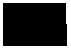 | 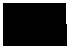 |
| MSM1392 | formate dehydrogenase accessory protein FdhD, FdhD | 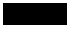 | 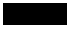 | 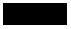 | 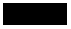 | 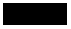 |
| MSM1393 | iron(III) ABC transporter, substrate-binding component | 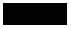 | 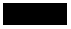 | 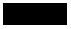 | 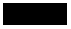 | 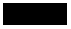 |
| MSM1394 | iron(III) ABC transporter, permease component | 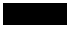 | | | | 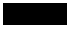 |
| MSM1395 | iron(III) ABC transporter, ATPase component | 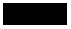 | 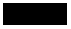 | 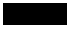 | 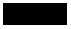 | 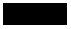 |
| MSM1396 | tungsten formylmethanofuran dehydrogenase, subunit E, FwdE | 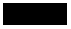 | 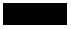 | 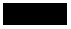 | 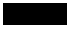 | 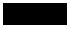 |
| MSM1397 | adhesin-like protein | 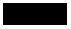 | | | 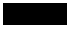 | 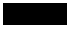 |
| MSM1398 | adhesin-like protein | 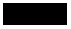 | 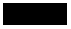 | | | 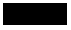 |
| MSM1399 | adhesin-like protein | 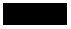 | 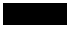 | 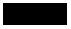 | | 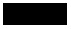 |
| MSM1400 | putative antimicrobial peptide ABC transporter, permease component | 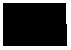 | | | | 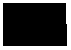 |
| MSM1401 | biopolymer transport protein | 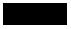 | | 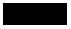 | 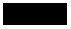 | 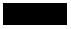 |
| MSM1402 | conserved hypothetical protein | 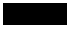 | 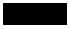 | 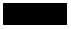 | 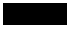 | 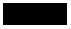 |
| MSM1403 | formate/nitrite transporter, FdhC | 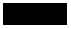 | 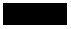 | 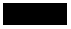 | 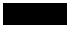 | 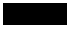 |
| MSM1404 | formate dehydrogenase, alpha subunit, FdhA | 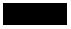 | 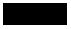 | 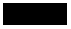 | 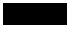 | 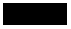 |
| MSM1405 | formate dehydrogenase, beta subunit, FdhB | 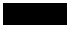 | 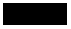 | 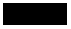 | 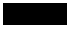 | 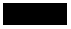 |
| MSM1406 | molybdopterin cofactor biosynthesis protein A, MoaA | 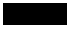 | 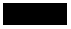 | 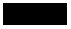 | 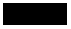 | 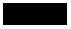 |
| MSM1407 | molybdopterin-guanine dinucleotide biosynthesis protein B, MobB | 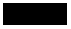 | 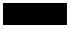 | 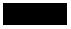 | 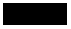 | 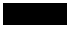 |
| MSM1408 | tungsten formylmethanofuran dehydrogenase, subunit E, FwdE | 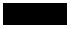 | 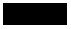 | 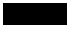 | 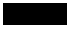 | 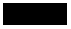 |
| MSM1409 | tungsten formylmethanofuran dehydrogenase, subunit F, FwdF | 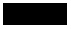 | 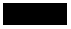 | 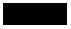 | 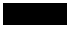 | 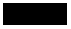 |
| MSM1410 | tungsten formylmethanofuran dehydrogenase, subunit G, FwdG | 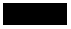 | 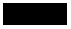 | 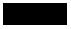 | 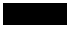 | 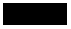 |
| MSM1411 | tungsten formylmethanofuran dehydrogenase, subunit D, FwdD | 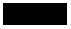 | 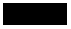 | 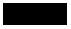 | 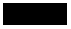 | 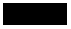 |
| MSM1412 | tungsten formylmethanofuran dehydrogenase, subunit B, FwdB | 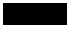 | 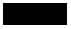 | 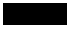 | 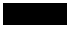 | 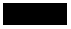 |
| MSM1413 | tungsten formylmethanofuran dehydrogenase, subunit A, FwdA | 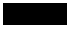 | 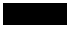 | 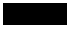 | 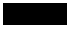 | 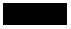 |
| MSM1414 | tungsten formylmethanofuran dehydrogenase, subunit C, FwdC | 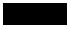 | 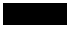 | 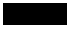 | 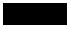 | 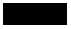 |
| MSM1415 | conserved hypothetical protein | 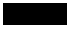 | 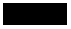 | 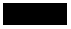 | 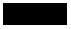 | 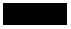 |
| MSM1416 | conserved hypothetical protein | 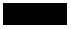 | 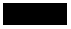 | 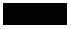 | 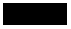 | 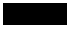 |
| MSM1417 | conserved hypothetical protein | 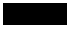 | 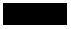 | 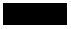 | 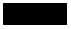 | 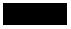 |
| MSM1418 | glutamine synthetase, GlnA | 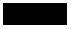 | 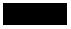 | 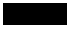 | 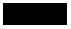 | 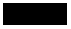 |
| MSM1419 | putative transposase | ND | | | | |
| MSM1420 | helicase, UvrD/REP family | 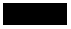 | 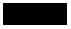 | 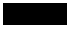 | 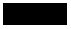 | 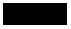 |
| MSM1421 | conserved hypothetical membrane protein | 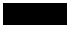 | 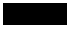 | 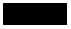 | 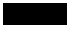 | 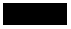 |
| MSM1422 | LemA protein | 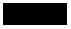 | 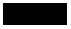 | 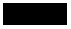 | 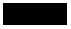 | 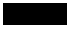 |
| MSM1423 | exopolyphosphatase, GppA | 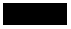 | 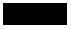 | 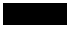 | 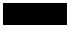 | 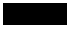 |
| MSM1424 | polyphosphate kinase, ppk | 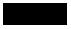 | 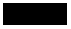 | 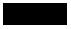 | 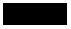 | 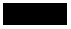 |
| MSM1425 | ribosomal protein S13p | 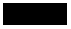 | 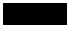 | 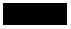 | 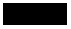 | 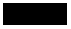 |
| MSM1426 | ribosomal protein S4p | 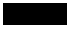 | 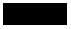 | 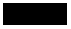 | 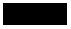 | 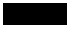 |
| MSM1427 | ribosomal protein S11p | 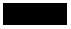 | 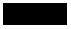 | 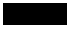 | 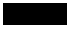 | 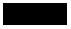 |
| MSM1428 | DNA-directed RNA polymerase, subunit D, RpoD | 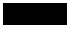 | 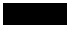 | 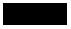 | 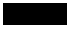 | 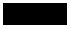 |
| MSM1429 | ribosomal protein L18e | 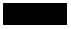 | 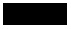 | 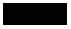 | 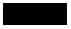 | 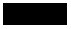 |
| MSM1430 | ribosomal protein L13p | 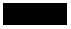 | 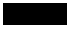 | 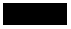 | 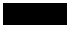 | 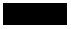 |
| MSM1431 | ribosomal protein S9p | 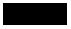 | 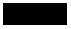 | 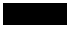 | 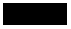 | 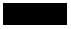 |
| MSM1432 | DNA-directed RNA polymerase, subunit N, RpoN | 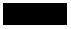 | 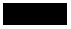 | 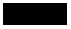 | 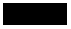 | 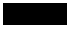 |
| MSM1433 | DNA-directed RNA polymerase, subunit K, RpoK | 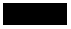 | 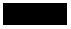 | 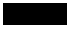 | 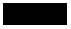 | 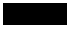 |
| MSM1434 | conserved hypothetical protein | 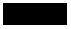 | 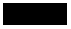 | 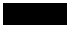 | 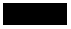 | 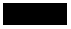 |
| MSM1435 | enolase | 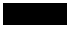 | 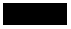 | 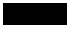 | 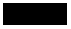 | 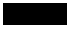 |
| MSM1436 | ferredoxin | 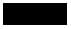 | 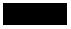 | 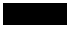 | 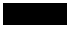 | 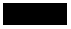 |
| MSM1437 | ribosomal protein S2p | 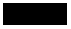 | 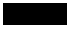 | 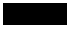 | 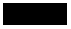 | 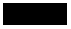 |
| MSM1438 | predicted dioxygenase | 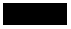 | 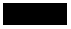 | 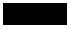 | 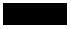 | 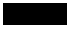 |
| MSM1439 | mevalonate kinase | 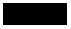 | 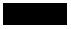 | 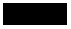 | 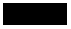 | 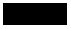 |
| MSM1440 | predicted archaeal kinase | 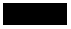 | 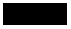 | 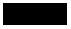 | 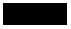 | 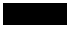 |
| MSM1441 | isopentenyl-diphosphate delta-isomerase | 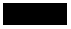 | 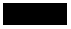 | 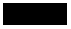 | 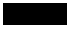 | 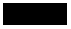 |
| MSM1442 | predicted RNA hydrolase, metallo-beta-lactamase superfamily | 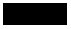 | 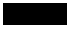 | 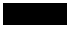 | 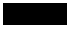 | 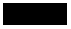 |
| MSM1443 | bifunctional short chain isoprenyl diphosphate synthase, IdsA | 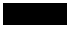 | 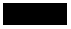 | 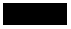 | 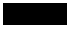 | 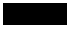 |
| MSM1444 | conserved hypothetical membrane protein | 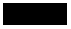 | 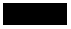 | 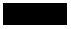 | 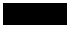 | 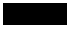 |
| MSM1445 | predicted transcriptional regulator | 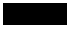 | 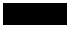 | 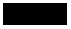 | 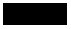 | 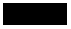 |
| MSM1446 | predicted hydroxylamine reductase, Hcp | 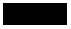 | 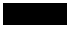 | 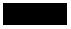 | 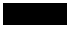 | 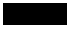 |
| MSM1447 | conserved hypothetical protein | 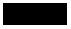 | 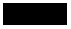 | 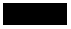 | 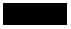 | 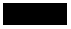 |
| MSM1448 | SAM-dependent methyltransferase | 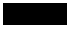 | 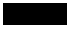 | 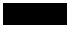 | 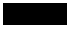 | 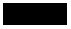 |
| MSM1449 | putative O-linked GlcNAc transferase | 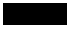 | 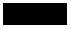 | 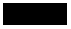 | 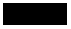 | 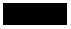 |
| MSM1450 | predicted oxidoreductase, aldo/keto reductase family | 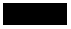 | 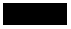 | 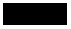 | 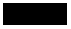 | 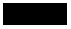 |
| MSM1451 | best blast hit to TPR repeat protein (Mba); not predicted to be a carbohydrate active enzyme by CAZy | 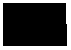 | 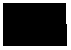 | 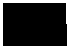 | 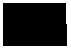 | 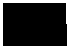 |
| MSM1452 | glutamyl-tRNA synthetase, GltX | 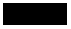 | 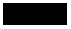 | 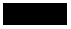 | 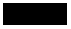 | 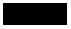 |
| MSM1453 | hypothetical protein | 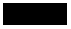 | 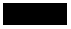 | 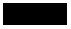 | 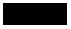 | 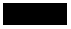 |
| MSM1454 | predicted ATPase, AAA+family | 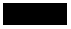 | 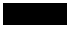 | 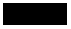 | 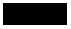 | 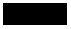 |
| MSM1455 | aspartate/tyrosine/aromatic aminotransferase | 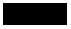 | 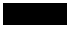 | 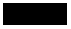 | 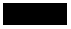 | 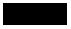 |
| MSM1456 | conserved hypothetical protein | 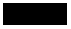 | 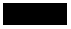 | 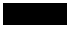 | 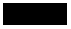 | 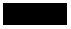 |
| MSM1457 | hypothetical protein | 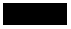 | 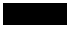 | 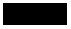 | 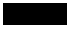 | 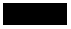 |
| MSM1458 | hypothetical protein | 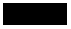 | 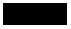 | 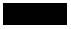 | 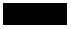 | 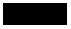 |
| MSM1459 | multidrug efflux permease, AraJ | 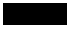 | 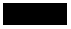 | 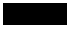 | 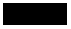 | 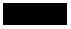 |
| MSM1460 | energy-converting hydrogenase B, subunit K, EhbK | 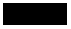 | | | 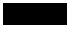 | 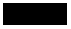 |
| MSM1461 | methyl viologen-reducing hydrogenase, delta subunit, MvhD | 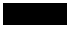 | | | 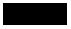 | 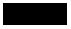 |
| MSM1462 | formate dehydrogenase, beta subunit, FdhB | 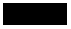 | | | 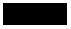 | 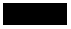 |
| MSM1463 | formate dehydrogenase, alpha subunit, FdhA | 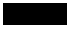 | | 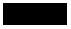 | 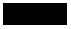 | 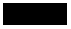 |
| MSM1464 | FlpE-related protein | 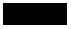 | | | 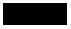 | 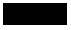 |
| MSM1465 | multidrug efflux permease, AraJ | 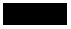 | 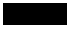 | 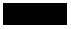 | 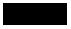 | 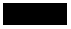 |
| MSM1466 | hypothetical protein | 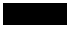 | 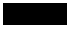 | 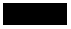 | 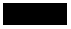 | 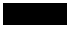 |
| MSM1467 | hypothetical protein | 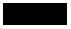 | 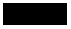 | 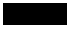 | 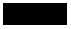 | 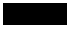 |
| MSM1468 | adenylosuccinate synthetase, PurA | 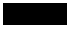 | 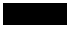 | 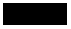 | 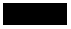 | 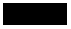 |
| MSM1469 | nitrate/sulfonate/bicarbonate ABC transporter, substrate-binding component, TauA | 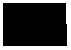 | 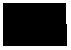 | 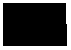 | 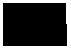 | 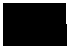 |
| MSM1470 | hypothetical protein | 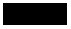 | 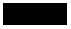 | 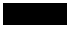 | 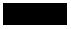 | 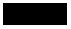 |
| MSM1471 | acyl-CoA synthetase | 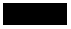 | 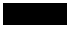 | 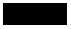 | 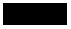 | 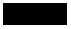 |
| MSM1472 | conserved hypothetical protein | 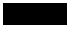 | 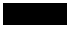 | 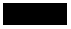 | 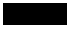 | 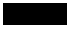 |
| MSM1473 | metal-dependent hydrolase, beta-lactamase superfamily | 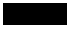 | 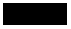 | 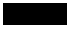 | 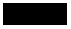 | 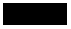 |
| MSM1474 | chorismate synthase, AroC | 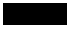 | 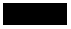 | 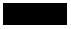 | 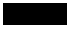 | 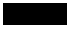 |
| MSM1475 | predicted endonuclease III-related protein | 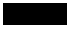 | 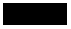 | 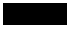 | 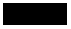 | 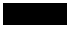 |
| MSM1476 | porphobilinogen synthase, HemB | 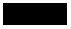 | 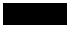 | 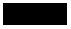 | 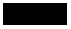 | 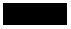 |
| MSM1477 | ATP:dephospho-CoA triphosphoribosyl transferase | 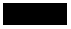 | 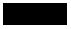 | 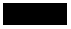 | 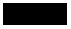 | 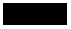 |
| MSM1478 | phenylalanyl-tRNA synthetase, PheS | 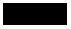 | 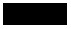 | 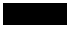 | 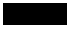 | 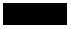 |
| MSM1479 | exodeoxyribonuclease, XthA | 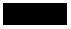 | 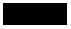 | 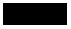 | 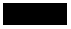 | 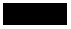 |
| MSM1480 | predicted hydrolase, HAD superfamily | 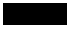 | 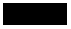 | 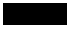 | 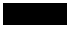 | 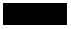 |
| MSM1481 | DNA-directed DNA polymerase, family B, PolB | 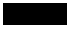 | 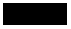 | 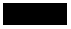 | 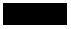 | 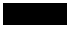 |
| MSM1482 | hypothetical protein | 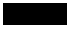 | 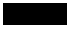 | 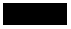 | 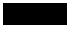 | 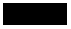 |
| MSM1483 | multidrug ABC transporter, ATPase component | 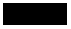 | 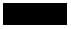 | 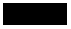 | 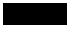 | 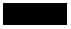 |
| MSM1484 | multidrug ABC transporter, permease component | 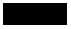 | 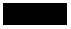 | 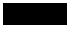 | 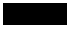 | 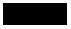 |
| MSM1485 | putative adhesin-like protein | 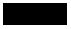 | 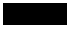 | 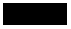 | 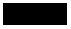 | 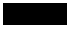 |
| MSM1486 | ribosomal protein S8e | 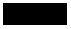 | 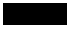 | 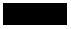 | 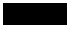 | 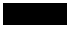 |
| MSM1487 | conserved hypothetical protein | 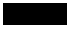 | 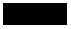 | 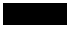 | 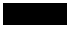 | 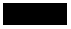 |
| MSM1488 | cobalt ABC transporter, permaease component, CbiM | 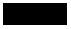 | 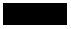 | 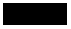 | 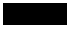 | 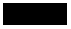 |
| MSM1489 | protein related to formylmethanofuran dehydrogenase subunit E, metalbinding | 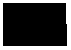 | 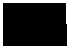 | 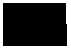 | 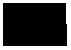 | 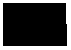 |
| MSM1490 | conserved hypothetical protein | 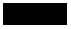 | 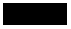 | 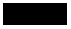 | 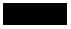 | 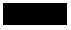 |
| MSM1491 | protein related to formylmethanofuran dehydrogenase subunit E, metalbinding | 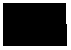 | 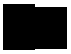 | 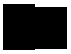 | 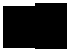 | |
| MSM1492 | hydrogenase maturation factor, HypE | 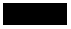 | 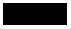 | 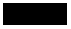 | 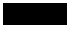 | 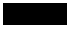 |
| MSM1493 | conserved hypothetical membrane protein, RDD family | 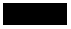 | 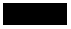 | 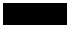 | 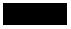 | 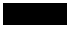 |
| MSM1494 | hypothetical protein | 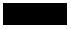 | 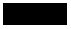 | 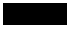 | 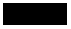 | 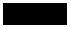 |
| MSM1495 | nuclease, Staphylococcus nuclease-like family | 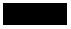 | 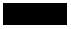 | 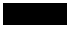 | 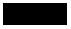 | 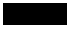 |
| MSM1496 | conserved hypothetical protein | 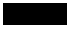 | 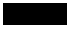 | 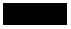 | 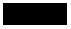 | 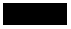 |
| MSM1497 | predicted coenzyme PQQ synthesis protein | 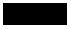 | 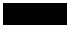 | 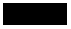 | 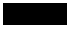 | 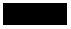 |
| MSM1498 | helicase | 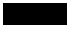 | 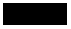 | 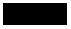 | 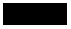 | 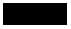 |
| MSM1499 | predicted transcriptional regulator | 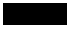 | 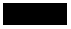 | 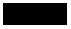 | 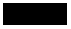 | 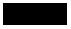 |
| MSM1500 | ssDNA exonuclease, RecJ | 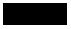 | 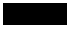 | 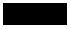 | 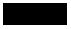 | 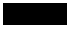 |
| MSM1501 | signal recognition particle, subunit SRP19 | 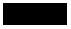 | 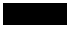 | 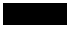 | 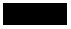 | 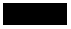 |
| MSM1502 | UDP-galactopyranose mutase | 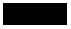 | 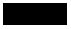 | 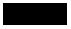 | 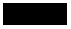 | 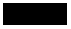 |
| MSM1503 | glycosyltransferase, GT2 family | 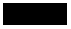 | 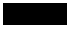 | 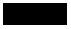 | 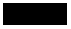 | 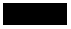 |
| MSM1504 | uroporphyrinogen III synthase, HemD | 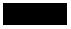 | 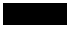 | 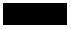 | 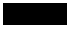 | 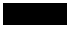 |
| MSM1505 | hypothetical protein | 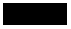 | 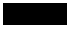 | 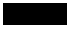 | 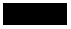 | 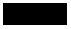 |
| MSM1506 | hypothetical protein | 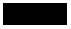 | 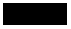 | 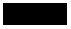 | 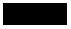 | 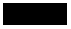 |
| MSM1507 | glycosyltransferase, GT2 family | 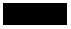 | 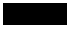 | 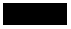 | 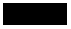 | 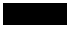 |
| MSM1508 | hypothetical protein | 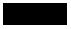 | 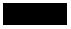 | | 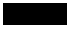 | 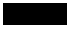 |
| MSM1509 | hypothetical protein | 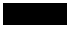 | 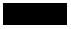 | 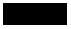 | 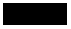 | 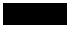 |
| MSM1510 | putative SAM-dependent methyltransferase | 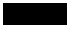 | 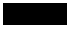 | 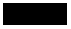 | 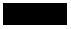 | 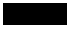 |
| MSM1511 | hypothetical protein | 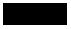 | 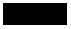 | 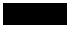 | 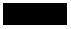 | 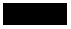 |
| MSM1512 | lipopolysaccharide cholinephosphotransferase, LicD family | 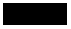 | 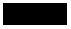 | 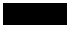 | 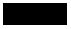 | 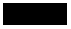 |
| MSM1513 | aspartate aminotransferase | 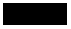 | 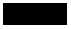 | 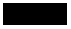 | 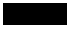 | 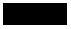 |
| MSM1514 | glycerol-3-phosphate cytidyltransferase, TagD | 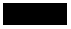 | 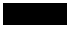 | 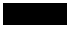 | 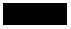 | 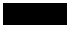 |
| MSM1515 | lipopolysaccharide cholinephosphotransferase, LicD family | 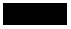 | 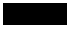 | | | 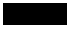 |
| MSM1516 | histidinol-phosphate aminotransferase, HisC | 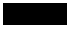 | 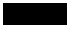 | | | |
| MSM1517 | ornithine cyclodeaminase | 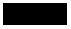 | | | | |
| MSM1518 | IS element ISM1 (ICSNY family) | 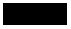 | | 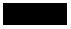 | 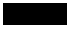 | |
| MSM1519 | IS element ISM1 (ICSNY family) | 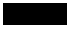 | 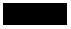 | | | |
| MSM1520 | IS element ISM1 (ICSNY family) | 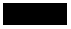 | 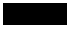 | 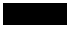 | 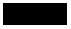 | |
| MSM1521 | hypothetical protein | 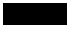 | | | | |
| MSM1522 | hypothetical protein | 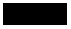 | 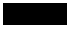 | | 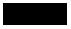 | |
| MSM1523 | transposase | 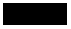 | 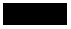 | | | |
| MSM1524 | conserved hypothetical protein | 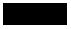 | 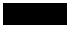 | 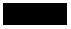 | | |
| MSM1525 | conserved hypothetical protein | 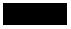 | | | 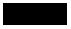 | |
| MSM1526 | conserved hypothetical membrane protein | 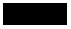 | 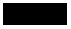 | 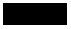 | 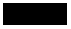 | 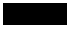 |
| MSM1527 | predicted ATPase, AAA+ superfamily | 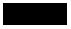 | | 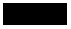 | 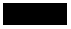 | 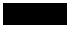 |
| MSM1528 | predicted transcriptional regulator, HTH XRE-like family | 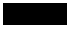 | | | 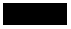 | |
| MSM1529 | putative Zn peptidase | 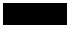 | | | 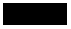 | |
| MSM1530 | putative nucleic acid-binding protein | 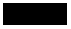 | | | 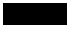 | |
| MSM1531 | Na+-dependent transporter, SNF family | 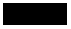 | 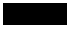 | 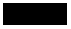 | 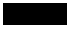 | 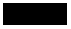 |
| MSM1532 | Na+-dependent transporter, SNF family | 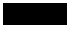 | 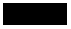 | 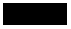 | 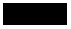 | 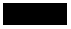 |
| MSM1533 | adhesin-like protein | 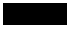 | 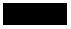 | 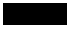 | 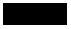 | 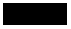 |
| MSM1534 | adhesin-like protein | 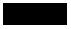 | 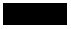 | 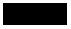 | 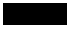 | 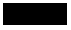 |
| MSM1535 | predicted dTDP-D-glucose 4,6-dehydratase | 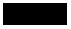 | 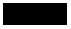 | 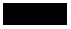 | 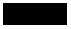 | 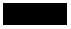 |
| MSM1536 | pleiotropic regulatory protein DegT (PLP-dependent) | 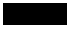 | 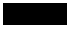 | 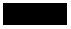 | 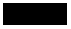 | 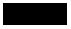 |
| MSM1537 | predicted acylneuraminate cytidylyltransferase, NeuS | 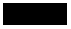 | 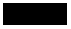 | 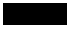 | 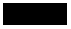 | 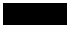 |
| MSM1538 | CMP-sialic acid synthetase, NeuA | 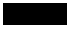 | 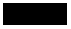 | 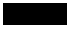 | 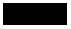 | 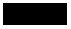 |
| MSM1539 | sialic acid synthase, NeuB | 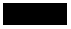 | 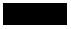 | 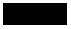 | 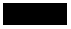 | 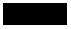 |
| MSM1540 | glycerol-3-phosphate dehydrogenase (NAD) | 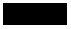 | 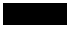 | 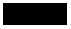 | 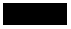 | 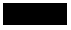 |
| MSM1541 | hypothetical protein | 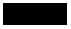 | | | | 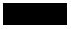 |
| MSM1542 | 4-diphosphocytidyl-2-methyl-D-erithritol synthase, IspD | 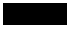 | 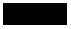 | 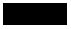 | 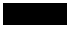 | 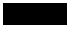 |
| MSM1543 | hypothetical protein | 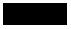 | 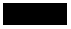 | 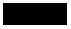 | 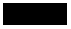 | 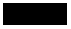 |
| MSM1544 | lipopolysaccharide cholinephosphotransferase | 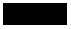 | 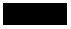 | 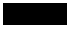 | 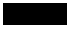 | 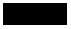 |
| MSM1545 | glycosyltransferase, GT2 family | 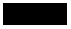 | 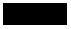 | 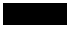 | 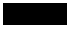 | 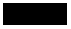 |
| MSM1546 | hypothetical protein | 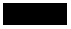 | 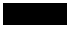 | 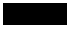 | 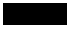 | 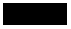 |
| MSM1547 | phosphoribosylaminoimidazole-succinocarboxamide (SAICAR) synthase, PurC | 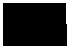 | 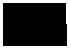 | 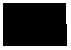 | 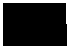 | 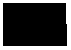 |
| MSM1548 | phosphoribosylformylglycinamidine (FGAM) synthase, PurS | 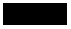 | 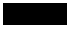 | 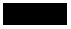 | 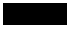 | 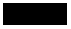 |
| MSM1549 | phosphoribosylformylglycinamidine (FGAM) synthase, PurQ | 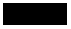 | 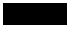 | 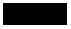 | 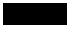 | 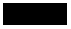 |
| MSM1550 | uroporphyrin-III C-methyltransferase, CobA | 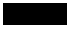 | 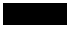 | 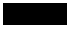 | 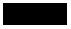 | 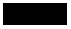 |
| MSM1551 | glucosamine--fructose-6-phosphate aminotransferase, GlmS | 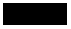 | 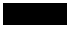 | 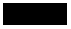 | 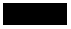 | 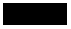 |
| MSM1552 | hypothetical protein | 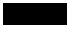 | 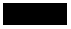 | 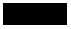 | 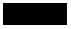 | 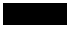 |
| MSM1553 | hypothetical protein | 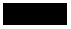 | 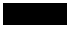 | 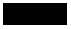 | 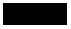 | 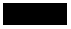 |
| MSM1554 | putative adhesin-like protein | 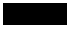 | 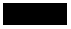 | 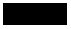 | 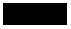 | 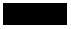 |
| MSM1555 | SAM-dependent methyltransferase | 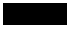 | 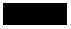 | 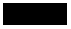 | 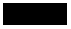 | 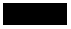 |
| MSM1556 | conserved hypothetical protein | 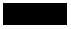 | 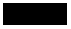 | 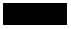 | 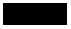 | 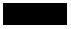 |
| MSM1557 | queuine/archaeosine tRNA-ribosyltransferase | 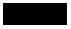 | 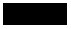 | 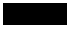 | 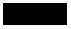 | 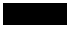 |
| MSM1558 | SAM-dependent methyltransferase, UbiE family | 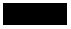 | 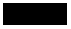 | 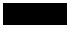 | 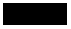 | 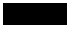 |
| MSM1559 | polysaccharide biosynthesis protein, MviN-like family | 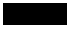 | 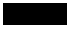 | 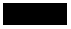 | 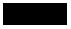 | 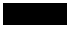 |
| MSM1560 | polysaccharide biosynthesis protein, MviN-like family | 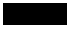 | 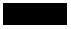 | 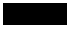 | 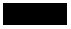 | 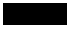 |
| MSM1561 | 3-hydroxy-3-methylglutaryl-CoA (HMG-CoA) synthase | 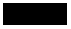 | 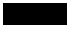 | 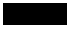 | 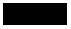 | 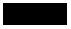 |
| MSM1562 | acetyl-CoA acyltransferase, SCP-type thiolase family | 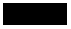 | 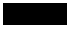 | 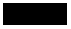 | 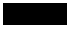 | 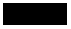 |
| MSM1563 | hypothetical protein | 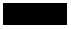 | 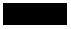 | 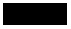 | 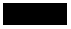 | 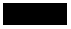 |
| MSM1564 | predicted SAM-dependent methyltransferase | 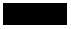 | 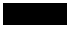 | 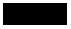 | 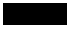 | 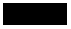 |
| MSM1565 | cobyric acid synthase, CobQ | 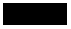 | 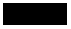 | 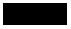 | 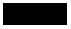 | 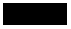 |
| MSM1566 | putative transposase | ND | | | | 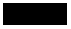 |
| MSM1567 | adhesin-like protein | 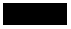 | 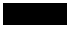 | 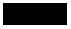 | 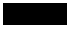 | 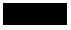 |
| MSM1568 | putative transcription regulator | 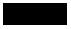 | 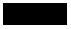 | 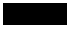 | 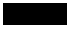 | 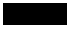 |
| MSM1569 | ATP-dependent protease La, LonB | 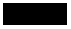 | 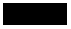 | 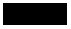 | 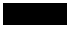 | 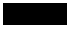 |
| MSM1570 | cell wall biosynthesis protein, MurD-like peptide ligase family | 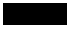 | 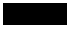 | 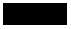 | 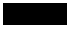 | 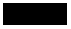 |
| MSM1571 | hypothetical protein | 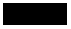 | 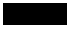 | 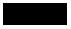 | 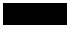 | 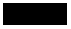 |
| MSM1572 | ADP-ribosylglycohydrolase | 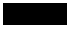 | 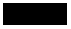 | 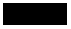 | 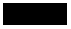 | 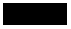 |
| MSM1573 | N-acetyltransferase, GNAT family | 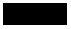 | 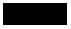 | 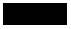 | 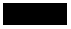 | 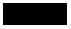 |
| MSM1574 | nitroreductase, NfnB | 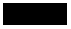 | 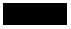 | 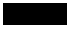 | 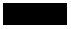 | 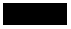 |
| MSM1575 | hypothetical protein | 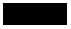 | 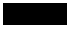 | 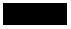 | 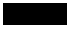 | 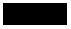 |
| MSM1576 | hypothetical protein | 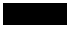 | 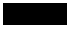 | 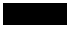 | 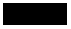 | 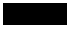 |
| MSM1577 | ribose-phosphate pyrophosphokinase, PrsA | 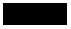 | 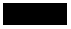 | 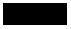 | 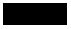 | 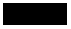 |
| MSM1578 | hypothetical protein | 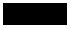 | 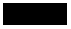 | 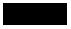 | 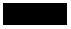 | 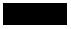 |
| MSM1579 | excinuclease ABC, subunit B, UvrB | 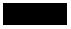 | 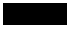 | 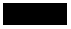 | 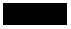 | 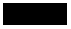 |
| MSM1580 | hypothetical protein | 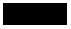 | 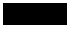 | 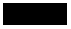 | 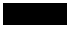 | 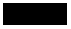 |
| MSM1581 | excinuclease ABC, subunit A, UvrA | 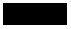 | 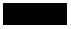 | 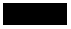 | 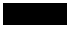 | 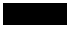 |
| MSM1582 | conserved hypothetical membrane protein | 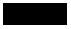 | 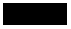 | 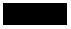 | 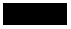 | 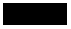 |
| MSM1583 | archaea-specific helicase | 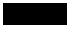 | 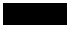 | 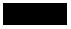 | 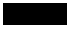 | 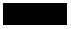 |
| MSM1584 | predicted excinuclease ABC, C subunit, UvrC | 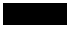 | 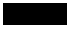 | 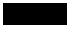 | 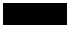 | 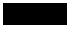 |
| MSM1585 | adhesin-like protein | 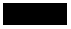 | | | | |
| MSM1586 | adhesin-like protein | 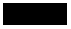 | | | 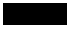 | |
| MSM1587 | adhesin-like protein | 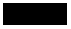 | | | | |
| MSM1588 | transposase | 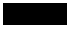 | | | 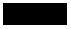 | 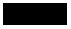 |
| MSM1589 | transposase, RNase-H-like family | ND | | | | 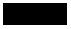 |
| MSM1590 | adhesin-like protein | 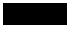 | | | | 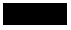 |
| MSM1591 | conserved hypothetical protein | 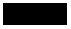 | 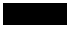 | 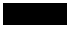 | 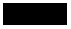 | 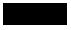 |
| MSM1592 | polysaccharide/polyol phosphate ABC transporter, ATPase component | 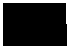 | 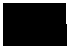 | | | 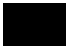 |
| MSM1593 | polysaccharide/polyol phosphate ABC transporter, permease component | 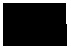 | 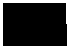 | | 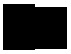 | 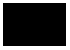 |
| MSM1594 | glycosyltransferase/CDP-glycerol:poly(glycerophosphate) glycerophosphotransferase, GT2 family | 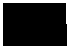 | 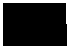 | | | 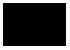 |
| MSM1595 | SAM-dependent methyltransferase, FkbM family | 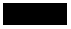 | 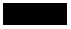 | | | 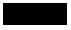 |
| MSM1596 | putative transposase | ND | | | | |
| MSM1597 | hypothetical protein | 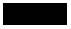 | | | | 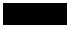 |
| MSM1598 | SAM-dependent methyltransferase | 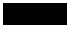 | 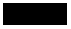 | | | 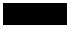 |
| MSM1599 | SAM-dependent methyltransferase | 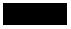 | 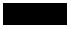 | | | 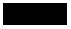 |
| MSM1600 | putative acetyltransferase, trimeric LpxA-like family | 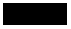 | 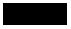 | | | 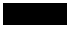 |
| MSM1601 | conserved hypothetical protein | 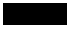 | 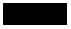 | | | 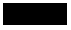 |
| MSM1602 | glycosyltransferase/CDP-glycerol:poly(glycerophosphate) glycerophosphotransferase, GT2 family | 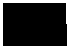 | 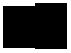 | 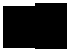 | 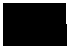 | 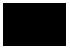 |
| MSM1603 | conserved hypothetical protein | 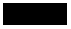 | 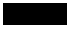 | | 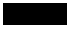 | 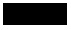 |
| MSM1604 | UDP-glucose pyrophosphorylase, GalU | 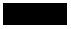 | 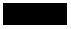 | 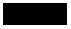 | | 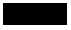 |
| MSM1605 | hypothetical protein | 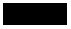 | 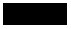 | 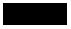 | 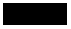 | 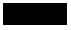 |
| MSM1606 | arylsulfatase regulator, AsIB | 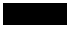 | 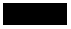 | 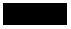 | 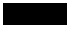 | 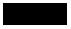 |
| MSM1607 | conserved hypothetical protein | 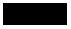 | 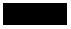 | 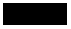 | 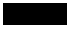 | 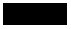 |
| MSM1608 | predicted oxidoreductase, aldo/keto reductase family | 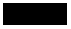 | 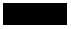 | 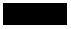 | 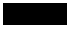 | 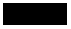 |
| MSM1609 | molybdate ABC transporter, substrate-binding component, ModA | 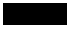 | 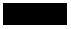 | 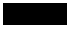 | 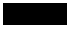 | 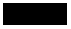 |
| MSM1610 | molybdate ABC transporter, permease component, ModC | 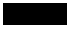 | 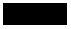 | 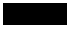 | 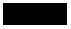 | 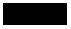 |
| MSM1611 | molybdate ABC transporter, ATPase component, ModB | 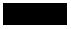 | 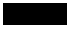 | 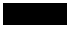 | 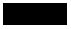 | 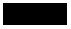 |
| MSM1612 | predicted UDP-glucose 6-dehydrogenase | 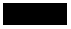 | 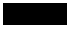 | 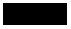 | 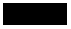 | 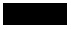 |
| MSM1613 | predicted UDP-glucose/GDP-mannose dehydrogenase | 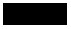 | 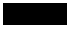 | 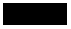 | 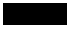 | 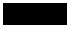 |
| MSM1614 | predicted transcriptional regulator | 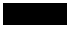 | 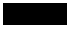 | 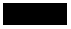 | 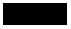 | 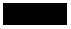 |
| MSM1615 | deoxyhypusine synthase, Dys | 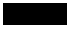 | 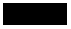 | 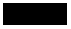 | 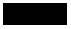 | 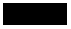 |
| MSM1616 | conserved hypothetical protein | 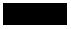 | 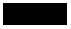 | 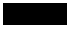 | 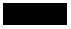 | 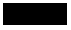 |
| MSM1617 | orotidine-5′-phosphate decarboxylase, PyrF | 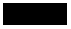 | 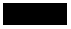 | 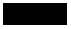 | 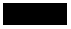 | 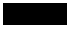 |
| MSM1618 | cobalamin biosynthesis protein M, CbiM | 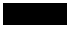 | 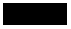 | 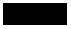 | 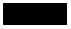 | 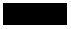 |
| MSM1619 | cobalt ABC transporter, substrate-binding component, CbiN | 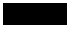 | 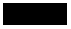 | 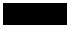 | 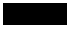 | 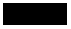 |
| MSM1620 | cobalt ABC transporter, permease component, CbiQ | 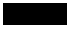 | 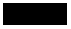 | 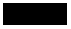 | 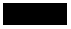 | 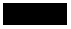 |
| MSM1621 | cobalt ABC transporter, ATPase component, CbiO | 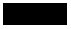 | 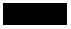 | 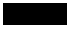 | 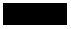 | 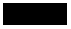 |
| MSM1622 | archaeal riboflavin synthase, RibC | 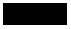 | 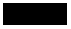 | 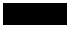 | 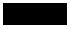 | 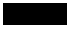 |
| MSM1623 | glycosyltransferase/dolichyl-phosphate mannose synthase, GT2 family | 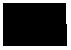 | 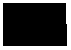 | 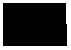 | 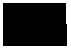 | 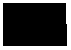 |
| MSM1624 | conserved hypothetical protein | 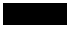 | 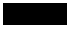 | 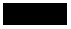 | 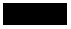 | 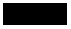 |
| MSM1625 | thiol:fumarate reductase, subunit B, TfrB | 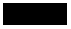 | 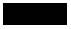 | 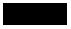 | 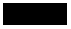 | 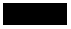 |
| MSM1626 | predicted fumarate reductase | 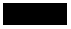 | 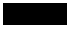 | 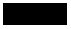 | 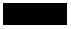 | 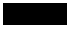 |
| MSM1627 | glycosyltransferase, GT2 family | 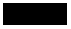 | 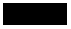 | 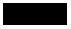 | 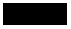 | 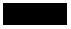 |
| MSM1628 | conserved hypothetical protein, aldolase family | 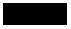 | 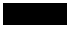 | 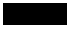 | 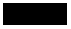 | 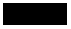 |
| MSM1629 | IMP dehydrogenase/GMP reductase, GuaB | 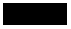 | 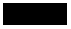 | 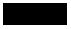 | 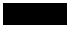 | 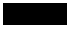 |
| MSM1630 | ribosomal protein L37Ae | 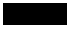 | 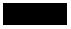 | 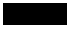 | 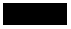 | 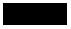 |
| MSM1631 | predicted DNA-directed RNA polymerase II, subunit RPC10 | 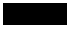 | 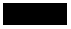 | 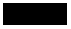 | 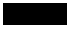 | 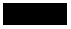 |
| MSM1632 | predicted brix-domain ribosomal biogenesis protein | 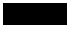 | 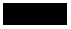 | 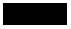 | 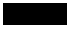 | 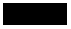 |
| MSM1633 | conserved hypothetical protein | 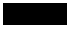 | 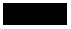 | 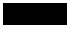 | 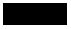 | 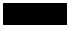 |
| MSM1634 | prefoldin, beta subunit | 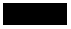 | 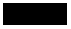 | 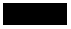 | 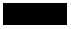 | 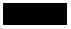 |
| MSM1635 | conserved hypothetical protein | 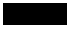 | 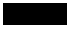 | 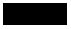 | 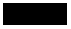 | 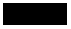 |
| MSM1636 | ProFAR isomerase-related protein | 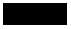 | 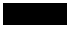 | 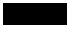 | 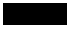 | 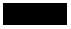 |
| MSM1637 | conserved hypothetical membrane protein | 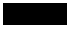 | 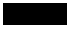 | 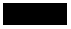 | 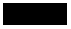 | 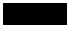 |
| MSM1638 | conserved hypothetical membrane protein | 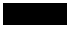 | 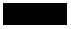 | 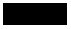 | 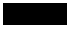 | 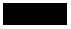 |
| MSM1639 | heavy metal cation (Co/Zn/Cd) efflux system protein, CzcD family | 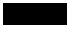 | 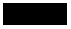 | 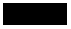 | 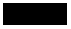 | 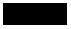 |
| MSM1640 | DNA intergrase/recombinase, phage integrase family | 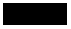 | | | 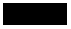 | |
| MSM1641 | hypothetical protein | 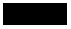 | | | | |
| MSM1642 | conserved hypothetical protein | 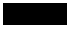 | | | | |
| MSM1643 | hypothetical protein | 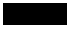 | 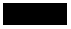 | | | |
| MSM1644 | hypothetical protein | 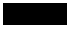 | | | 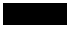 | 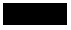 |
| MSM1645 | virulence protein | 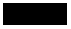 | | | | |
| MSM1646 | putative ATPase (AAA+ superfamily) | 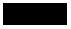 | | | | 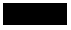 |
| MSM1647 | hypothetical protein | 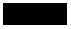 | | 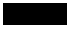 | | 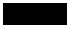 |
| MSM1648 | hypothetical protein | 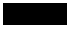 | | 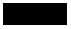 | 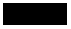 | 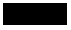 |
| MSM1649 | hypothetical protein | 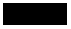 | | | 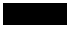 | 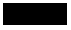 |
| MSM1650 | hypothetical protein | 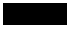 | | | 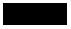 | 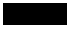 |
| MSM1651 | hypothetical protein | 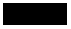 | | 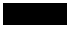 | 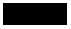 | 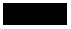 |
| MSM1652 | hypothetical protein | 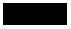 | | | 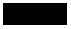 | 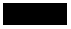 |
| MSM1653 | hypothetical protein | 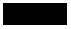 | 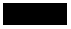 | | | 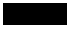 |
| MSM1654 | putative Gp40-related protein, ERF family single-strand annealing protein | 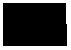 | | 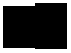 | 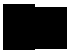 | 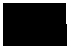 |
| MSM1655 | hypothetical protein | 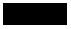 | | | | 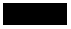 |
| MSM1656 | hypothetical protein | 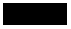 | | | | 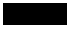 |
| MSM1657 | conserved hypothetical protein | 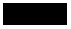 | | | | 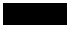 |
| MSM1658 | hypothetical protein | 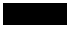 | 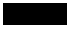 | | | |
| MSM1659 | hypothetical protein | 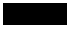 | | | | |
| MSM1660 | hypothetical protein | 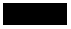 | 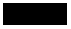 | | | |
| MSM1661 | hypothetical protein | 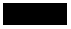 | 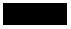 | 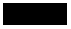 | | |
| MSM1662 | hypothetical protein | 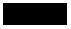 | | | 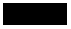 | |
| MSM1663 | hypothetical protein | 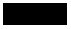 | | | 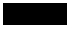 | |
| MSM1664 | hypothetical protein | 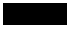 | | | 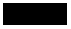 | |
| MSM1665 | hypothetical protein | 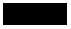 | 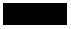 | | 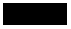 | |
| MSM1666 | hypothetical protein | 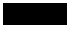 | | | 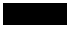 | |
| MSM1667 | hypothetical protein | 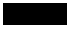 | | | | |
| MSM1668 | hypothetical protein | 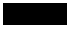 | 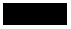 | | 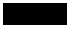 | |
| MSM1669 | hypothetical protein | 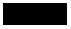 | | 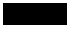 | 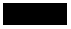 | |
| MSM1670 | hypothetical protein | 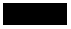 | | 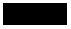 | 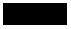 | |
| MSM1671 | large terminase subunit | 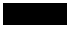 | | | 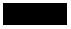 | |
| MSM1672 | bacteriophage capsid portal protein | 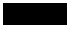 | | | 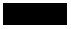 | |
| MSM1673 | conserved hypothetical protein | 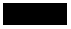 | | | | |
| MSM1674 | hypothetical protein | 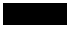 | | | 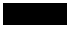 | |
| MSM1675 | putative structural protein | 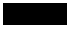 | | 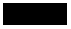 | 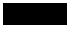 | |
| MSM1676 | hypothetical protein | 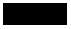 | | 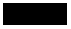 | 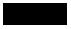 | |
| MSM1677 | putative major capsid protein gp5 | 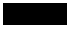 | | | 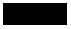 | |
| MSM1678 | hypothetical protein | 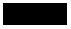 | | | 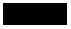 | |
| MSM1679 | hypothetical protein | 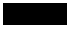 | | | 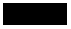 | |
| MSM1680 | hypothetical protein | 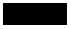 | 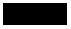 | | 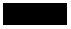 | |
| MSM1681 | hypothetical protein | 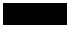 | | | 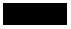 | |
| MSM1682 | hypothetical protein | 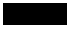 | | | 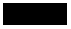 | |
| MSM1683 | hypothetical protein | 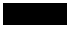 | 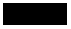 | 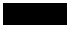 | 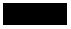 | |
| MSM1684 | phage-related minor tail protein | 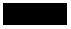 | | | 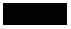 | |
| MSM1685 | hypothetical protein | 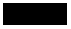 | 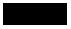 | | 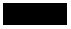 | |
| MSM1686 | hypothetical protein | 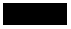 | 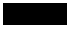 | | 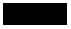 | |
| MSM1687 | conserved hypothetical protein | 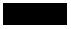 | | | 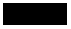 | |
| MSM1688 | hypothetical protein | 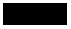 | | | 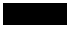 | |
| MSM1689 | putative collagen-like protein B | 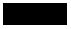 | 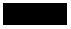 | 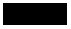 | 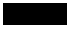 | |
| MSM1690 | hypothetical protein | 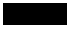 | | | 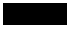 | |
| MSM1691 | putative pseudomurein endoisopeptidase, PeiW | 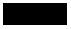 | | | 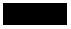 | |
| MSM1692 | hypothetical protein | 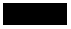 | | | | |
| MSM1693 | predicted ribokinase, PfkB family | 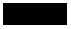 | 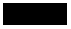 | 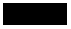 | 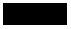 | 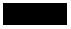 |
| MSM1694 | predicted helicase | 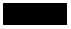 | 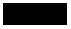 | 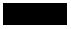 | 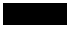 | 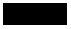 |
| MSM1695 | excinuclease ABC, subunit C, UvrC | 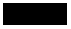 | 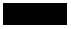 | 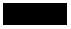 | 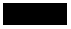 | 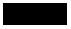 |
| MSM1696 | conserved hypothetical protein | 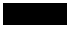 | 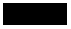 | 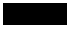 | 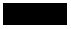 | 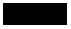 |
| MSM1697 | hypothetical protein | 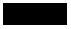 | 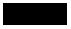 | 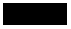 | 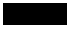 | 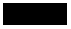 |
| MSM1698 | methyl coenzyme M reductase system, component A2-like | 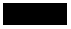 | 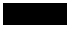 | 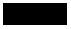 | 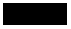 | 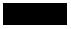 |
| MSM1699 | predicted universal stress protein, UspA | 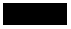 | 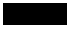 | 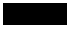 | 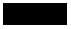 | 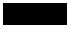 |
| MSM1700 | predicted ferredoxin | 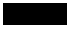 | 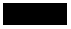 | 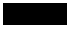 | 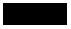 | 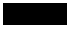 |
| MSM1701 | predicted FAD-dependent dehydrogenase, geranylgeranyl reductase family | 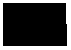 | 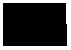 | 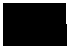 | 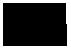 | 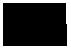 |
| MSM1702 | UDP-glucose 4-epimerase | 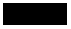 | 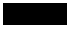 | 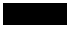 | 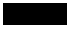 | 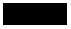 |
| MSM1703 | conserved hypothetical protein | 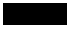 | 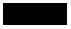 | 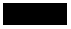 | 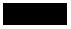 | 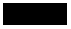 |
| MSM1704 | glutamine phosphoribosylpyrophosphate amidotransferase, PurF | 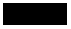 | 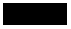 | 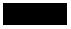 | 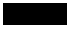 | 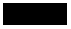 |
| MSM1705 | predicted collagenase, peptidase family U32 | 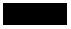 | 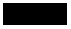 | 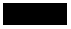 | 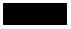 | 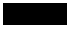 |
| MSM1706 | CDP-diacylglycerol--glycerol-3-phosphate 3-phosphatidyltransferase | 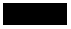 | 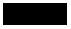 | 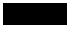 | 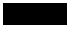 | 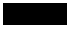 |
| MSM1707 | nitrogenase NifH subunit, NifH | 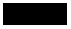 | 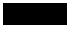 | 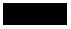 | 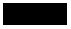 | 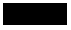 |
| MSM1708 | hypothetical protein | 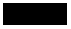 | 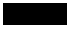 | 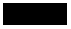 | 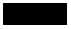 | 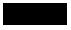 |
| MSM1709 | adhesin-like protein | 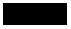 | 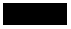 | 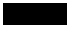 | 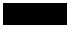 | 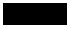 |
| MSM1710 | seryl-tRNA synthetase, SerS | 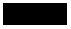 | 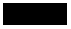 | 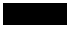 | 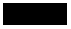 | 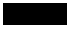 |
| MSM1711 | conserved hypothetical protein | 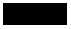 | 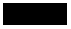 | 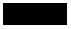 | 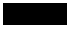 | 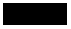 |
| MSM1712 | predicted ferritin | 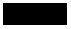 | 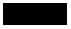 | 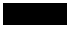 | 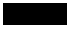 | 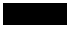 |
| MSM1713 | predicted regulatory protein, amino acid-binding ACT domain family | 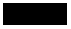 | 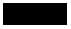 | 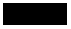 | 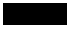 | 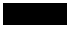 |
| MSM1714 | coenzyme F390 synthetase | 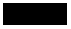 | 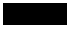 | 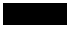 | 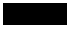 | 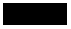 |
| MSM1715 | magnesium chelatase subunit | 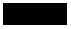 | 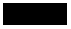 | | 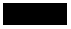 | 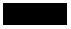 |
| MSM1716 | adhesin-like protein | 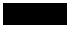 | 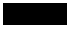 | 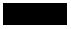 | 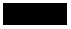 | 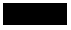 |
| MSM1717 | predicted transporter | 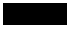 | 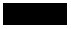 | 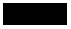 | 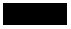 | 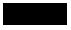 |
| MSM1718 | predicted biopolymer transport protein | 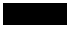 | 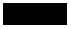 | 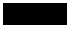 | 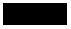 | 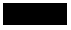 |
| MSM1719 | conserved hypothetical protein | 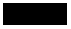 | 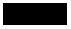 | 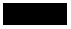 | 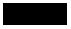 | 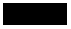 |
| MSM1720 | DNA-directed RNA polymerase, subunit M, RpoM | 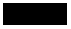 | 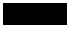 | 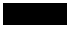 | 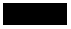 | 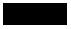 |
| MSM1721 | voltage gated chloride channel protein/cation transporter, TrkA family | 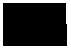 | 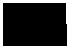 | 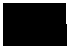 | 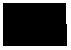 | 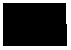 |
| MSM1722 | nitroreductase | 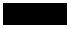 | 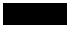 | 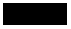 | 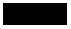 | 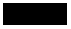 |
| MSM1723 | N5,N10-methenyl-tetrahydromethanopterin cyclohydrolase, Mch | 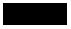 | 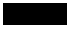 | 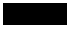 | 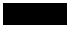 | 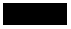 |
| MSM1724 | conserved hypothetical membrane protein | 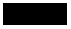 | 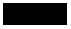 | 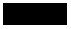 | 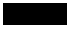 | 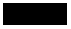 |
| MSM1725 | conserved hypothetical membrane protein | 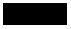 | 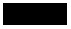 | 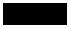 | 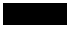 | 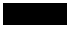 |
| MSM1726 | conserved hypothetical membrane protein | 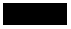 | 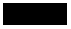 | 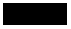 | 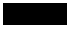 | 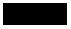 |
| MSM1727 | multimeric flavodoxin | 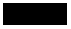 | 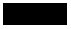 | 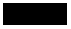 | 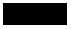 | 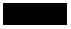 |
| MSM1728 | hypothetical protein | 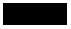 | 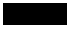 | 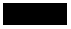 | 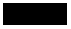 | 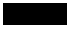 |
| MSM1729 | conserved hypothetical protein | 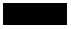 | 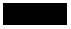 | 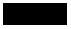 | 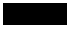 | 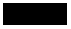 |
| MSM1730 | conserved hypothetical membrane protein | 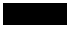 | 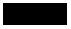 | 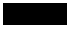 | 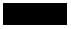 | 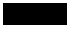 |
| MSM1731 | short chain dehydrogenase/reductase | 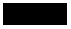 | 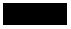 | 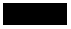 | 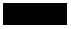 | 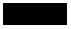 |
| MSM1732 | conserved hypothetical protein | 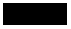 | 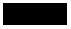 | 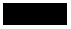 | 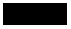 | 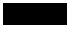 |
| MSM1733 | rubrerythrin | 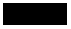 | 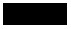 | 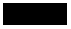 | 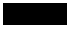 | 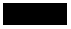 |
| MSM1734 | predicted thymidylate synthase, ThyA | 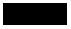 | 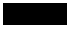 | 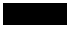 | 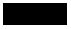 | 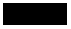 |
| MSM1735 | adhesin-like protein | 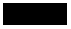 | 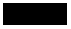 | 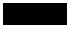 | 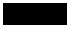 | 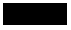 |
| MSM1736 | permease, xanthine/uracil/vitamin C permease family | 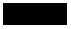 | 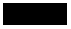 | 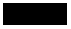 | 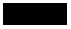 | 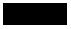 |
| MSM1737 | putative transcription regulator | 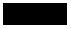 | 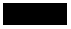 | 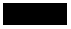 | 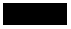 | 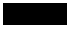 |
| MSM1738 | putative adhesin-like protein | 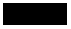 | 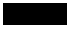 | 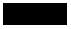 | 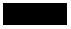 | 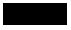 |
| MSM1739 | conserved hypothetical membrane protein | 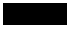 | 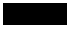 | | 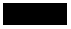 | |
| MSM1740 | O-linked GlcNAc transferase | 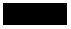 | | | 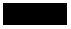 | |
| MSM1741 | conserved hypothetical protein | 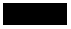 | 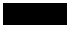 | | 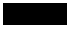 | |
| MSM1742 | predicted integrase, phage integrase-like family | 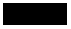 | | | | |
| MSM1743 | predicted type II restriction enzyme, methylase subunit | 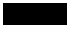 | | | | |
| MSM1744 | predicted type II restriction enzyme, methylase subunit | 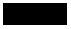 | 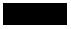 | | | |
| MSM1745 | predicted type II restriction enzyme, methylase subunit | 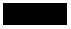 | 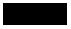 | | | |
| MSM1746 | predicted type II restriction enzyme, methylase subunit | 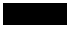 | | | | |
| MSM1747 | predicted type II restriction enzyme, methylase subunit | 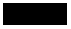 | | | | |
| MSM1748 | predicted type II restriction enzyme, methylase subunit | 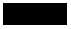 | 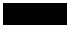 | | | |
| MSM1749 | conserved hypothetical protein | 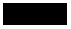 | | | | |
| MSM1750 | conserved hypothetical protein | 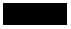 | | 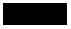 | | |
| MSM1751 | conserved hypothetical protein | 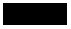 | 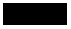 | | 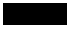 | |
| MSM1752 | predicted restriction endonuclease | 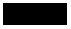 | 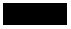 | | | |
| MSM1753 | conserved hypothetical protein | 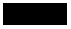 | | | | |
| MSM1754 | predicted ATP-dependent protease La, Lon | 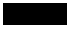 | 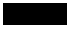 | | | |
| MSM1755 | purine/pyrimidine phosphoribosyl transferase | 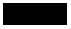 | | | | |
| MSM1756 | Smf protein | 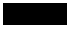 | | | 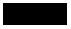 | |
| MSM1757 | hypothetical protein | 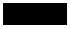 | | | | |
| MSM1758 | hypothetical protein | 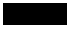 | | | 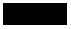 | |
| MSM1759 | hypothetical protein | 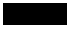 | 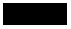 | 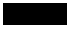 | 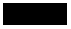 | |
| MSM1760 | hypothetical protein | 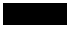 | | | 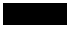 | |
| MSM1761 | predicted ATPase involved in DNA repair | 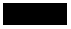 | | 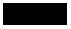 | 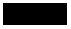 | |
| MSM1762 | hypothetical protein | 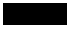 | | | 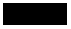 | |
| MSM1763 | predicted DNA-directed RNA polymerase, subunit M, RpoM | 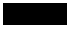 | 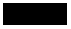 | | 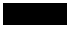 | |
| MSM1764 | conserved hypothetical protein | 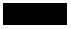 | | | 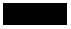 | |
| MSM1765 | conserved hypothetical protein | 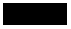 | | | 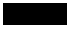 | |
| MSM1766 | O-linked GlcNAc transferase | 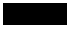 | | 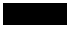 | 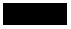 | |
| MSM1767 | hypothetical protein | 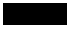 | | | 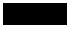 | |
| MSM1768 | hypothetical protein | 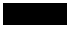 | | 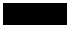 | 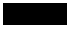 | |
| MSM1769 | conserved hypothetical membrane protein | 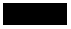 | | | 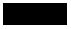 | |
| MSM1770 | conserved hypothetical membrane protein | 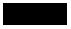 | | | 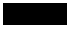 | |
| MSM1771 | DNA helicase, UvrD/REP helicase family | 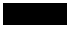 | 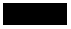 | | 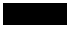 | |
| MSM1772 | conserved hypothetical protein | 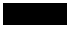 | 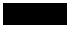 | | 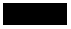 | |
| MSM1773 | conserved hypothetical protein | 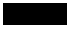 | 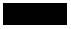 | | 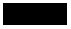 | |
| MSM1774 | hypothetical protein | 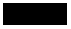 | 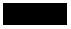 | | 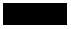 | |
| MSM1775 | putative topoisomerase IV, subunit A | 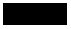 | 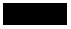 | | 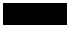 | |
| MSM1776 | TPR repeat protein | 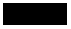 | 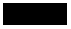 | | 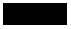 | |
| MSM1777 | putative transcription regulator | 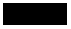 | 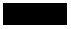 | | 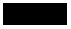 | |
| MSM1778 | conserved hypothetical protein | 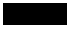 | 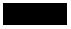 | 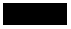 | 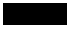 | |
| MSM1779 | conserved hypothetical protein | 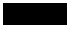 | 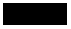 | | 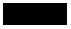 | |
| MSM1780 | conserved hypothetical membrane protein | 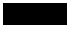 | 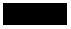 | | 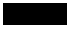 | |
| MSM1781 | conserved hypothetical protein | 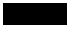 | 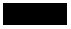 | | 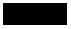 | 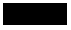 |
| MSM1782 | hypothetical protein | 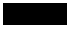 | | | | |
| MSM1783 | hypothetical protein | 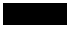 | | | | 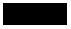 |
| MSM1784 | hypothetical protein | 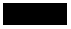 | | | | 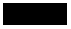 |
| MSM1785 | conserved hypothetical protein | 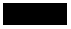 | 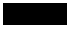 | | 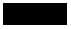 | 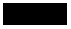 |
| MSM1786 | O-linked GlcNAc transferase | 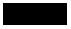 | 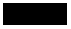 | 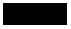 | 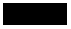 | 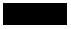 |
| MSM1787 | O-linked GlcNAc transferase | 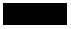 | 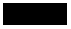 | 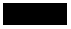 | 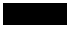 | 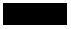 |
| MSM1788 | O-linked GlcNAc transferase | 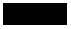 | 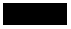 | 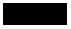 | 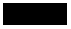 | 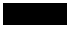 |
| MSM1789 | predicted ATPase, AAA+ superfamily | 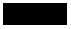 | 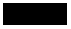 | | | 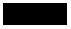 |
| MSM1790 | predicted ATPase, AAA+ superfamily | 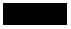 | 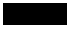 | 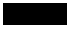 | 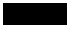 | 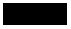 |
| MSM1791 | conserved hypothetical protein | 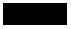 | 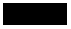 | 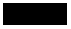 | 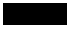 | 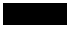 |
| MSM1792 | nicotinate phosphoribosyltransferase | 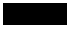 | 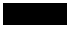 | 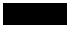 | 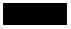 | 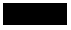 |
| MSM1793 | conserved hypothetical protein | 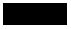 | 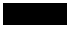 | 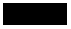 | 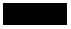 | 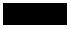 |
| MSM1794 | predicted tubulin-like protein | 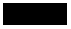 | 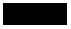 | 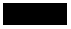 | 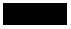 | 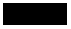 |
| MSM1795 | predicted ATPase, AAA+ superfamily | 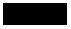 | | 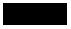 | | 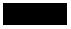 |

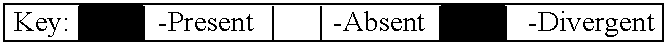

¹GeneChip-based genotyping of M. smithii strains done in duplicate; ‘present’or ‘absent’calls
were determined using a perfect match/mismatch (PM/MM) model in dChip (see Methods). Note that the term ‘absent’is
based on different criteria than those used for the human microbiome dataset (see footnote 2).
²Metagenomic datasets from the microbiomes of two healthy lean adults (Gill et al., 2006)
were tested for identity to M. smithii PS ORFs; ORFs with reads that matched with >95% identity
are called ‘present’, 80-95% identity are called ‘divergent’, and <80% identity are called ‘absent’.
ⁱⁱProbeset for M. smithii gene not represented on GeneChip.

TABLE 3
Transcriptional regulators identified in the M. smithii PS proteome
ORF COG ANNOTATION

| | | |
|---|---|---|
| MSM0026 | COG1396 | predicted transcriptional regulator (possible epoxidase activity) |
| MSM0094 | | predicted transcription regulator (TetR family) |
| MSM0155 | COG2061 | predicted allosteric regulator of homoserine dehydrogenase |
| MSM0218 | COG1321 | iron dependent transcriptional regulator (Fe2+-binding) |
| MSM0233 | COG0347 | nitrogen regulatory protein P-II, GlnK |
| MSM0255 | | putative transcription regulator (winged helix DNA-binding domain) |
| MSM0269 | COG2522 | predicted transcriptional regulator (lambda repressor-like) |
| MSM0329 | COG1396 | DNA binding protein, xenobiotic response element family |
| MSM0354 | COG1222 | ATP-dependent 26S proteasome regulatory subunit, RPT1 |
| MSM0364 | COG0864 | transcriptional regulator (nickel-responsive), NikR |
| MSM0383 | COG1409 | predicted phosphohydrolase, calcineurin-like superfamily |
| MSM0388 | COG4747 | amino acid regulator (ACT domain) |
| MSM0404 | COG4742 | predicted transcriptional regulator |
| MSM0413 | COG1846 | transcriptional regulator, MarR family |
| MSM0417 | COG4068 | predicted transmembrane protein with a zinc ribbon DNA-binding domain |
| MSM0452 | | predicted DNA-binding protein |
| MSM0453 | COG1395 | predicted transcriptional regulator |
| MSM0540 | COG2865 | predicted transcriptional regulator |
| MSM0564 | COG0704 | phosphate uptake regulator, PhoU |
| MSM0569 | COG0704 | phosphate transport system regulator related protein, PhoU |
| MSM0600 | COG1846 | transcriptional regulator, MarR family |
| MSM0635 | COG2150 | predicted regulator of amino acid metabolism |
| MSM0650 | COG1309 | transcriptional regulator, TetR/AcrR family |
| MSM0766 | COG0340 | biotin-[acetyl-CoA-carboxylase] ligase/biotin operon regulator bifunctional protein, BirA |
| MSM0775 | COG2207 | transcriptional regulator, AraC family |
| MSM0817 | COG4742 | predicted transcriptional regulator |
| MSM0818 | COG4742 | predicted transcriptional regulator |
| MSM0819 | COG0640 | putative transcription regulator, ArsR family (winged helix DNA-binding domain) |
| MSM0851 | COG1548 | predicted transcriptional regulator |
| MSM0862 | COG1781 | aspartate carbamoyltransferase regulatory chain, PyrI |
| MSM0864 | COG1733 | predicted transcriptional regulator |
| MSM0936 | COG0603 | transcription regulator-related ATPase, ExsB |
| MSM0966 | COG1223 | predicted 26S protease regulatory subunit (ATP-dependent), AAA+ family ATPase |
| MSM1030 | COG0399 | predicted pyridoxal phosphate-dependent enzyme |
| MSM1032 | COG1522 | transcriptional regulator, Lrp family |
| MSM1081 | COG1112 | transcriptional regulator, DNA2/NAM7 helicase family |
| MSM1090 | COG1489 | sugar fermentation stimulation protein, SfsA |
| MSM1106 | COG0068 | hydrogenase maturation factor, HypF |
| MSM1107 | COG1777 | predicted transcriptional regulator |
| MSM1126 | COG0640 | predicted transcriptional regulator, ArsR family (arsenic) |
| MSM1150 | COG1476 | predicted transcriptional regulator |
| MSM1207 | COG2005 | molybdate transport system regulatory protein |
| MSM1224 | COG0440 | acetolactate synthase, small subunit (regulatory), IlvH |
| MSM1230 | COG1846 | transcriptional regulator, MarR family |
| MSM1250 | COG1695 | predicted transcriptional regulator, PadR-like family |
| MSM1257 | COG1339 | predicted transcriptional regulator of riboflavin/FAD biosynthetic operon |
| MSM1292 | COG2183 | transcriptional accessory protein, S1 RNA binding family, Tex |
| MSM1315 | COG2865 | predicted transcriptional regulator |
| MSM1350 | COG0640 | predicted transcriptional regulator, ArsR family |
| MSM1390 | COG0583 | transcriptional regulator, LysR family |
| MSM1445 | COG1378 | predicted transcriptional regulator |
| MSM1499 | COG1497 | predicted transcriptional regulator |
| MSM1528 | COG1396 | predicted transcriptional regulator, HTH XRE-like family (xenobiotic) |
| MSM1536 | COG0399 | pleiotropic regulatory protein DegT (PLP-dependent) |
| MSM1568 | | putative transcription regulator |
| MSM1606 | COG0641 | arylsulfatase regulator, AslB |
| MSM1614 | COG2524 | predicted transcriptional regulator |
| MSM1713 | COG4747 | predicted regulatory protein, amino acid-binding ACT domain family |
| MSM1737 | | putative transcription regulator |
| MSM1777 | | putative transcription regulator |

TABLE 4
Machinery for genome evolution in M. smithii strain PS
ORF ANNOTATION

| | | |
|---|---|---|
| Restriction | MSM0157 | predicted type I restriction-modification enzyme, subunit S |
| Modification | MSM0158 | type I restriction-modification system methylase, subunit S |
| System | MSM1187 | predicted type III restriction enzyme |
| Subunits | MSM1217 | type II restriction endonuclease |
| | MSM1743 | predicted type II restriction enzyme, methylase subunit |
| | MSM1744 | predicted type II restriction enzyme, methylase subunit |
| | MSM1745 | predicted type II restriction enzyme, methylase subunit |
| | MSM1746 | predicted type II restriction enzyme, methylase subunit |
| | MSM1747 | predicted type II restriction enzyme, methylase subunit |
| | MSM1748 | predicted type II restriction enzyme, methylase subunit |
| | MSM1752 | predicted restriction endonuclease |
| Recombination/ | MSM0023 | uncharacterized protein predicted to be involved in DNA repair |
| Repair | MSM0097 | Mg-dependent DNase, TatD |
| | MSM0120 | purine NTPase involved in DNA repair, Rad50 |
| | MSM0121 | DNA repair exonuclease (SbcD/Mre11-family), Rad32 |
| | MSM0163 | conserved hypothetical proetin predicted to be involved in DNA repair |
| | MSM0164 | conserved hypothetical protein predicted to be involved in DNA repair |
| | MSM0167 | conserved hypothetical protein predicted to be involved in DNA repair |
| | MSM0168 | conserved hypothetical protein predicted to be involved in DNA repair |
| | MSM0170 | conserved hypothetical protein predicted to be involved in DNA repair |
| | MSM0405 | predicted metal-dependent DNase, TatD-related family |
| | MSM0416 | Mg-dependent DNase, TatD-related |
| | MSM0524 | DNA mismatch repair ATPase, MutS |
| | MSM0543 | DNA repair photolyase, SplB |
| | MSM0611 | DNA repair protein, RadB |
| | MSM0693 | ATPase involved in DNA repair, SbcC |
| | MSM0695 | DNA repair helicase |
| | MSM0725 | DNA repair flap structure-specific 5′-3′ endonuclease |
| | MSM1193 | single-stranded DNA-specific exonuclease, DHH family |
| | MSM1333 | DNA repair protein RadA, RadA |
| | MSM1500 | ssDNA exonuclease, RecJ |
| | MSM1640 | DNA intergrase/recombinase, phage integrase family |
| | MSM1761 | predicted ATPase involved in DNA repair |
| IS elements | MSM0527 | IS element ISM1 (ICSNY family) |
| | MSM0528 | IS element ISM1 (ICSNY family) |
| | MSM0532 | IS element ISM1 (ICSNY family) |
| | MSM0533 | IS element ISM1 (ICSNY family) |
| | MSM0534 | IS element ISM1 (ICSNY family) |
| | MSM1518 | IS element ISM1 (ICSNY family) |
| | MSM1519 | IS element ISM1 (ICSNY family) |
| | MSM1520 | IS element ISM1 (ICSNY family) |
| Transposases | MSM0008 | putative transposase |
| or | | |
| remnants of | MSM0087 | putative transposase |
| transposases | MSM0110 | predicted transposase |
| | MSM0230 | putative transposase |
| | MSM0256 | putative transposase |
| | MSM0342 | putative transposase |
| | MSM0396 | putative transposase |
| | MSM0458 | transposase, homeodomain-like superfamily |
| | MSM0460 | predicted transposase |
| | MSM0601 | putative transposase |
| | MSM0629 | putative transposase |
| | MSM0730 | putative transposase |
| | MSM0871 | putative transposase |
| | MSM1093 | putative transposase |
| | MSM1115 | putative transposase |
| | MSM1189 | putative transposase |
| | MSM1419 | putative transposase |
| | MSM1523 | transposase |
| | MSM1566 | putative transposase |
| | MSM1588 | predicted transposase |
| | MSM1589 | predicted transposase, RNaseH-like family |
| | MSM1596 | putative transposase |

TABLE 5
Publicly available finished genome sequences for members of Archaea

| | | | | | GenBank |
|---|---|---|---|---|---|
| | | | | Habitat of | Accession |
| Group | Strain Designation | Abbr. | Temp. | Origin | Number |
| Human Gut | Methanobrevibacter smithii PS (ATCC 35021) | Msm | Mesophilic | Host-associated | CP000678 |
| Methanogens | Methanosphaera stadtmanae DSM 3091 | Msp | Mesophilic | Host-associated | CP000102 |
| Non-Gut | Methanothermobacter thermautotrophicus | Mth | Thermophilic | Specialized | AE000666 |
| | Delta H | | | | |
| Methanogens | Methanocaldococcus jannaschii DSM 2661 | Mja | Hyperthermophilic | Aquatic | L77117 |
| | Methanococcoides burtonii DSM 6242 | Mbu | Mesophilic | Aquatic | CP000300 |
| | Methanococcus maripaludis S2 | Mmr | Mesophilic | Aquatic | BX950229 |
| | Methanopyrus kandleri AV19 | Mka | Hyperthermophilic | Specialized | AE009439 |
| | Methanosarcina acetivorans C2A | Mac | Mesophilic | Aquatic | AE010299 |
| | Methanosarcina barkeri str. Fusaro | Mba | Mesophilic | Multiple | CP000099 |
| | Methanosarcina mazei Go1 | Mma | Mesophilic | Multiple | AE008384 |
| | Methanospirillum hungatei JF-1 | Mhu | Mesophilic | Multiple | CP000254 |
| Other Archaea | Aeropyrum pernix K1 | Apx | Hyperthermophilic | Specialized | BA000002 |
| | Archaeoglobus fulgidus DSM 4304 | Afu | Hyperthermophilic | Aquatic | AE000782 |
| | Haloarcula marismortui ATCC 43049 | Hma | Mesophilic | Aquatic | AY596297 |
| | Halobacterium sp. NRC-1 | Hal | Mesophilic | Specialized | AE004437 |
| | Nanoarchaeum equitans Kin4-M | Neq | Hyperthermophilic | Host-associated | AE017199 |
| | Natronomonas pharaonis DSM 2160 | Nph | Mesophilic | Aquatic | CR936257 |
| | Picrophilus torridus DSM 9790 | Pto | Thermophilic | Specialized | AE017261 |
| | Pyrobaculum aerophilum str. IM2 | Pae | Hyperthermophilic | Aquatic | AE009441 |
| | Pyrococcus abyssi GE5 | Pab | Hyperthermophilic | Aquatic | AL096836 |
| | Pyrococcus furiosus DSM 3638 | Pfu | Hyperthermophilic | Aquatic | AE009950 |
| | Pyrococcus horikoshii OT3 | Pho | Hyperthermophilic | Aquatic | BA000001 |
| | Sulfolobus acidocaldarius DSM 639 | Sac | Thermophilic | Specialized | CP000077 |
| | Sulfolobus solfataricus P2 | Sso | Hyperthermophilic | Specialized | AE006641 |
| | Sulfolobus tokodaii str. 7 | Sto | Hyperthermophilic | Specialized | BA000023 |
| | Thermococcus kodakarensis KOD1 | Tko | Hyperthermophilic | Specialized | AP006878 |
| | Thermoplasma acidophilum DSM 1728 | Tac | Thermophilic | Specialized | AL139299 |
| | Thermoplasma volcanium GSS1 | Tvo | Thermophilic | Specialized | BA000011 |

TABLE 6
Representation of enriched gene ontology (GO) categories in the M. smithil PS
and M. stadtmanae proteomes compared to the proteomes of all sequenced
methanogenic archaea and all archaea

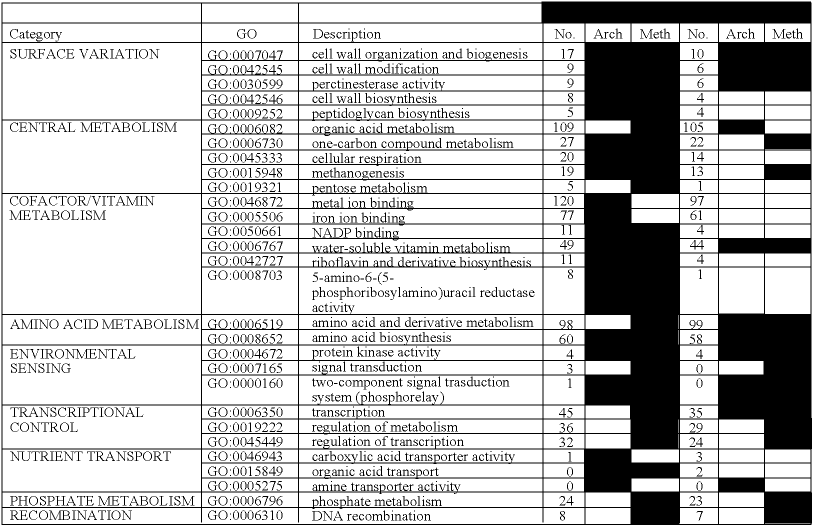

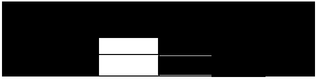

Abbreviations: ‘non-gut-associated methanogens’ (Meth) or ‘all Archaea’ (Arch) [see SI Table 5]; No., number of genes associated with gene ontology (GO) term.

TABLE 7
M. smithii strain PS genes in the significantly enriched GO categories listed in Table 6

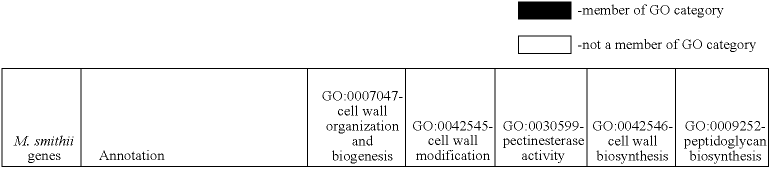

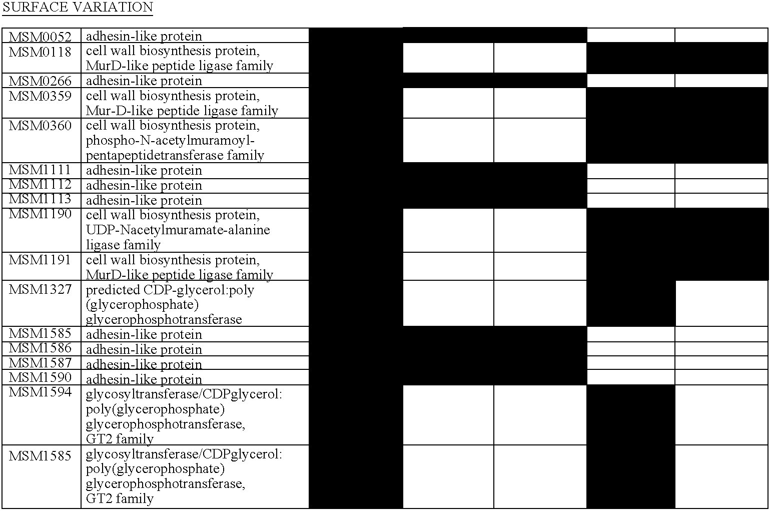

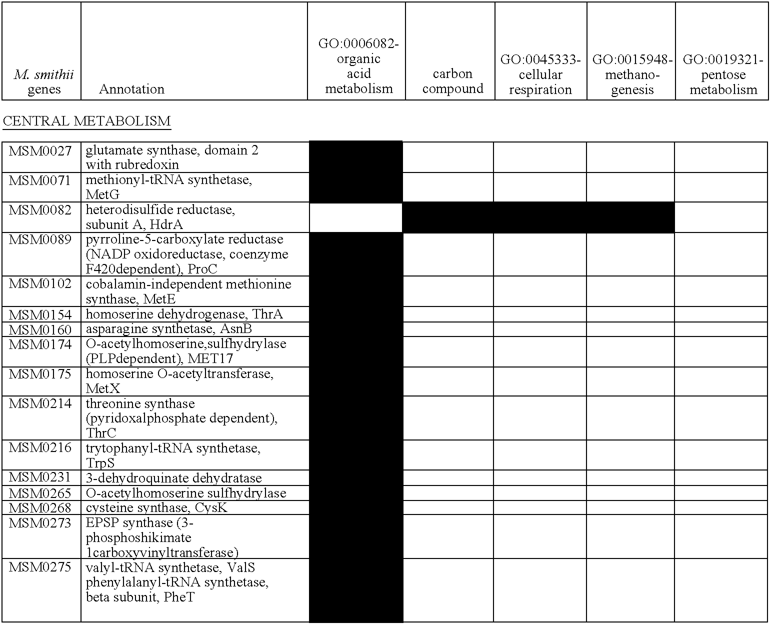

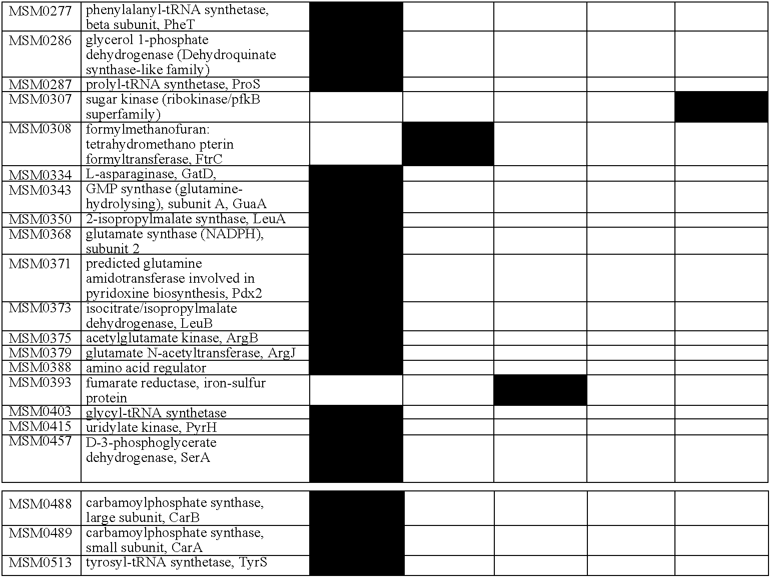

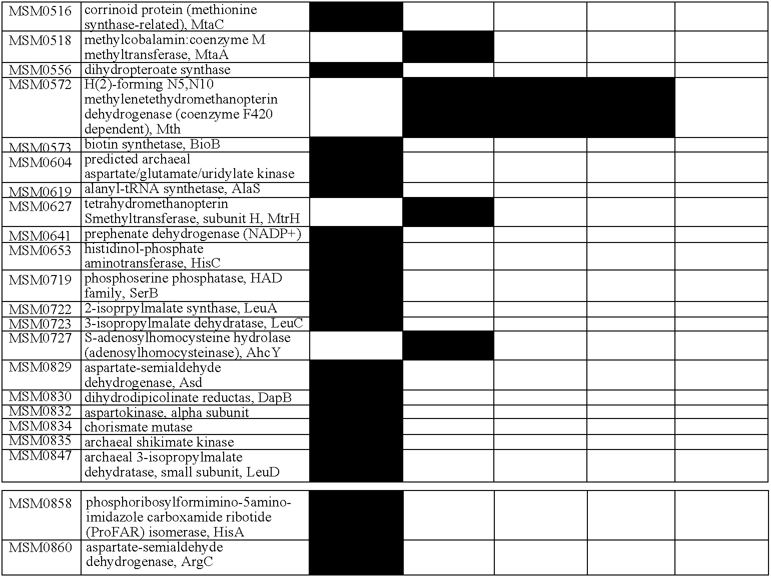

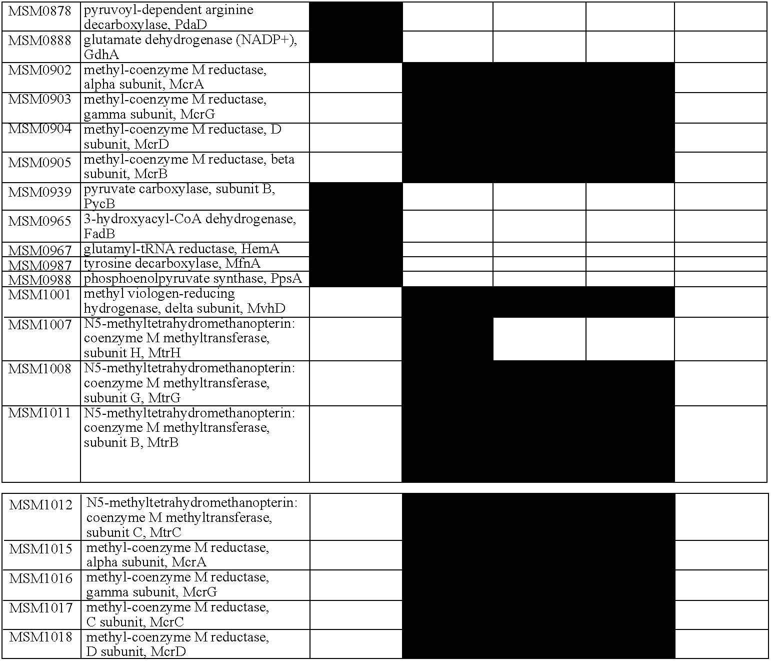

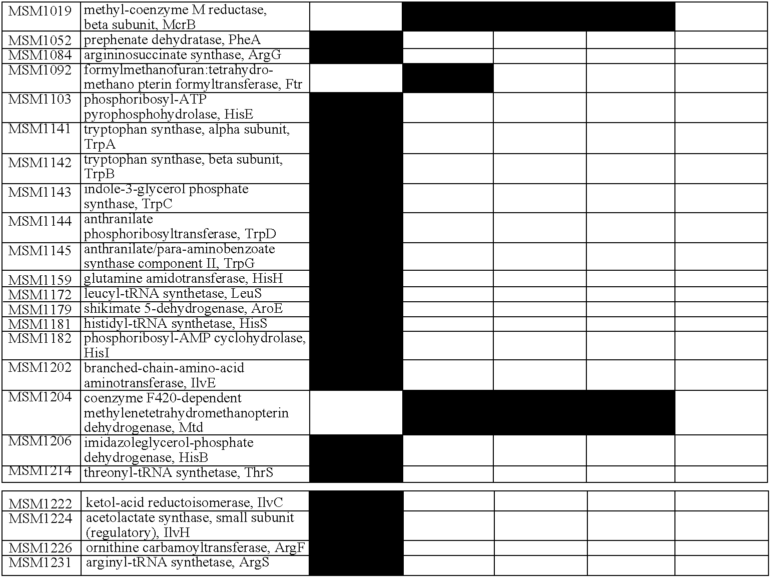

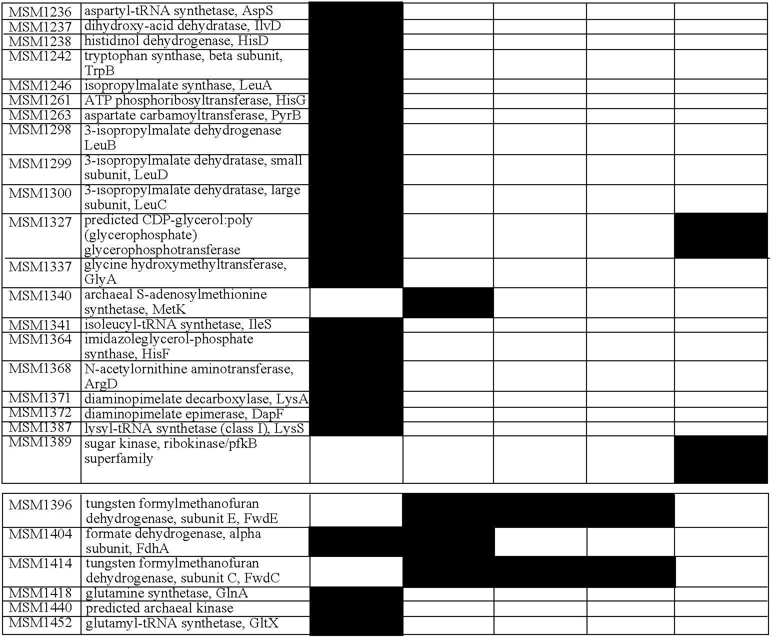

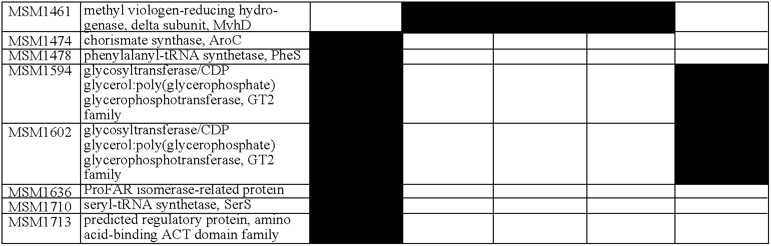

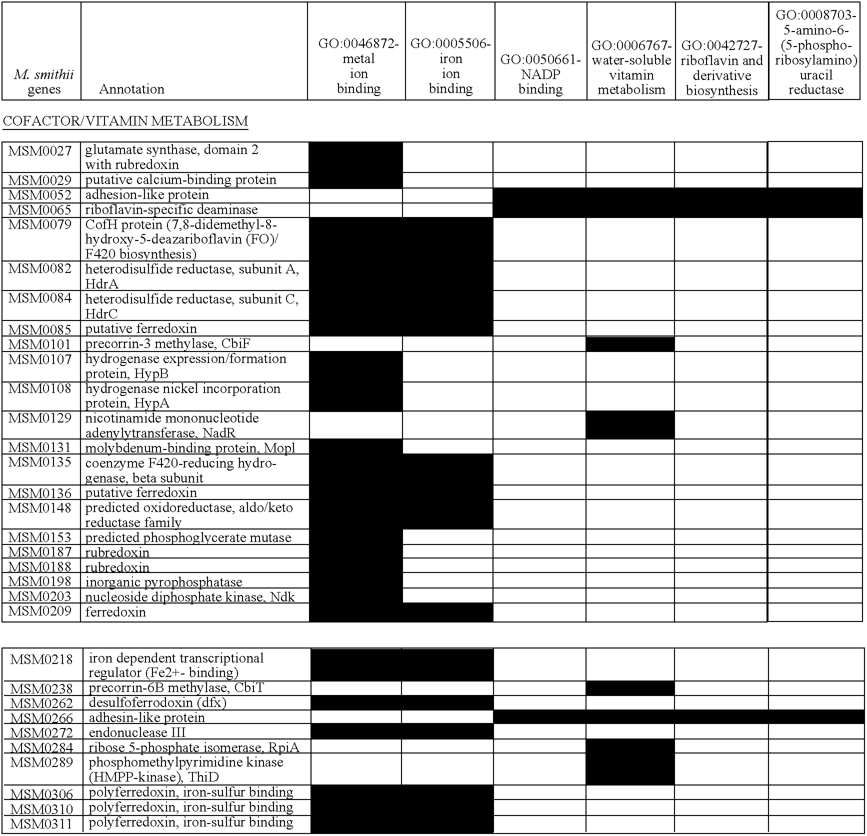

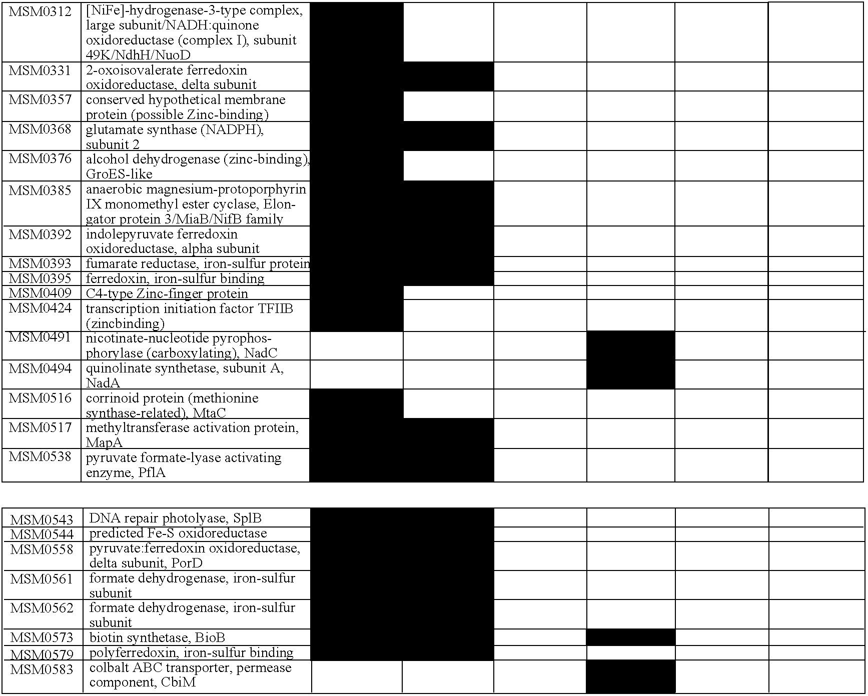

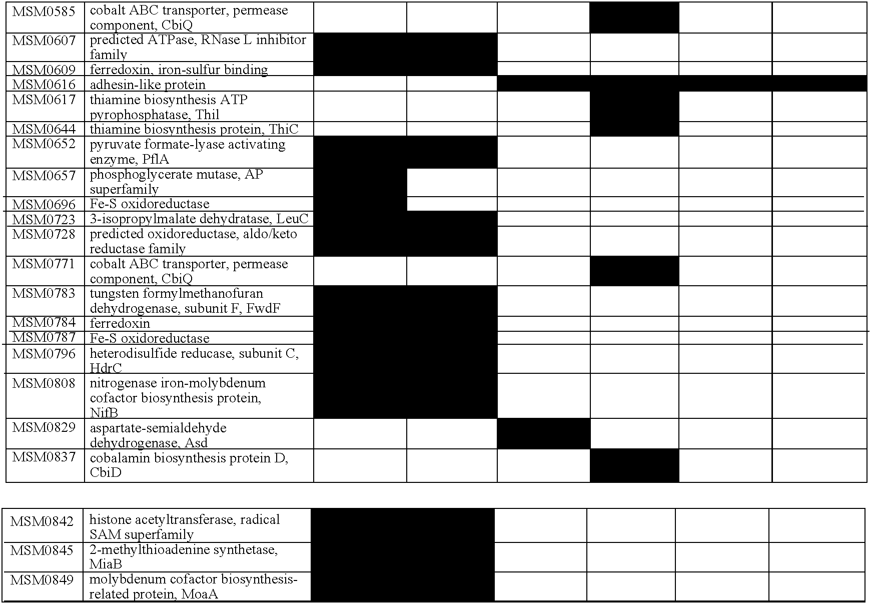

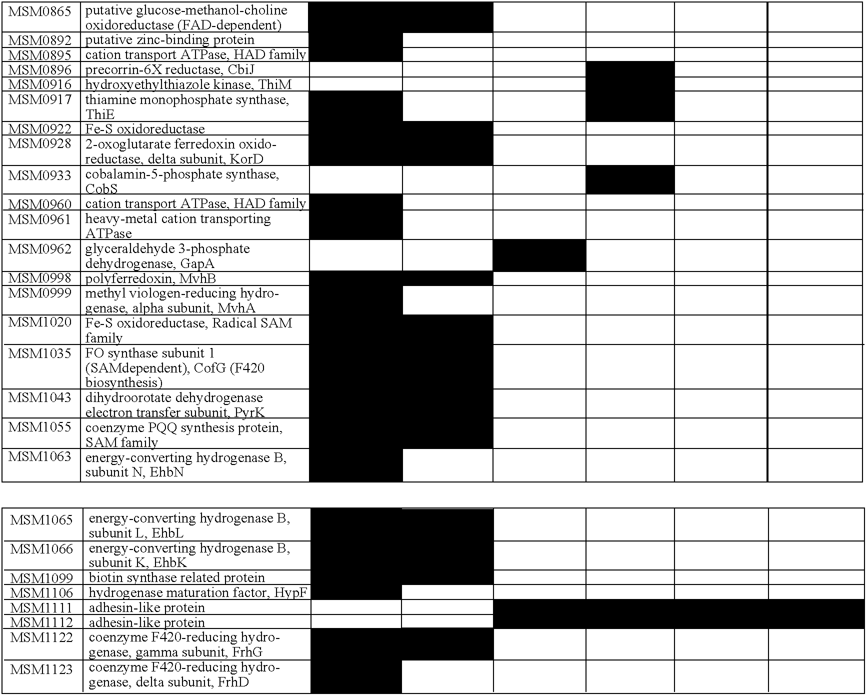

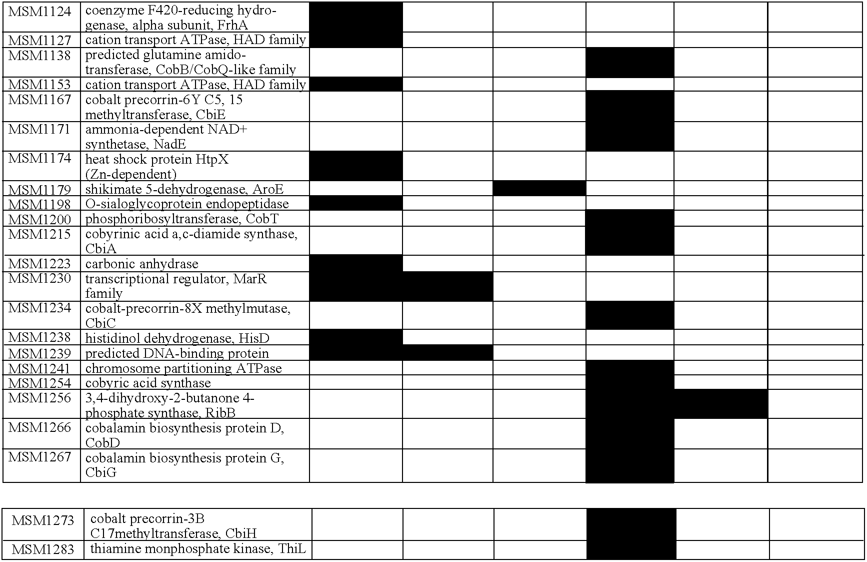

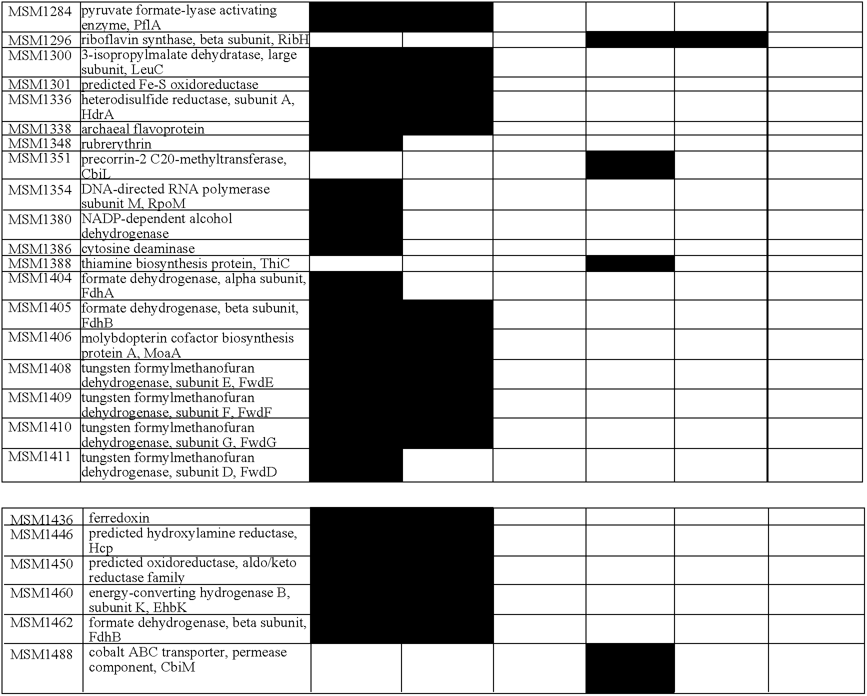

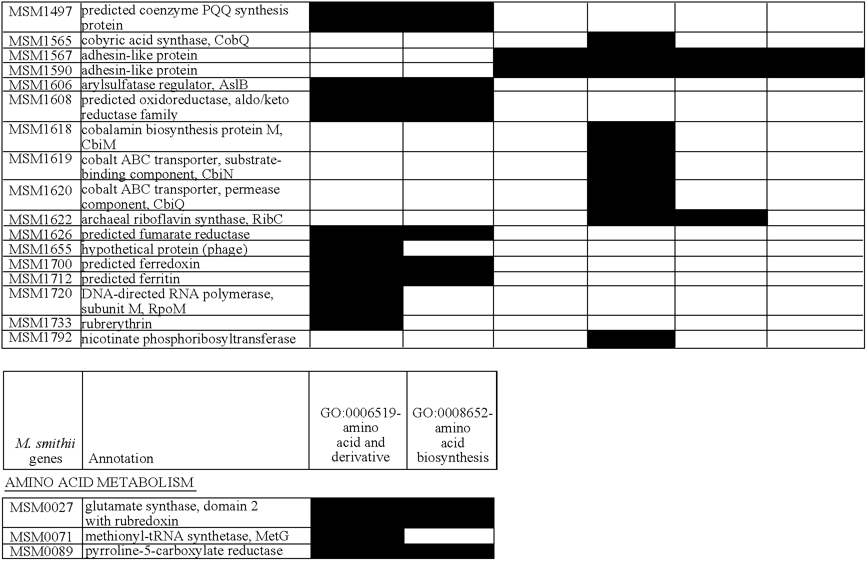

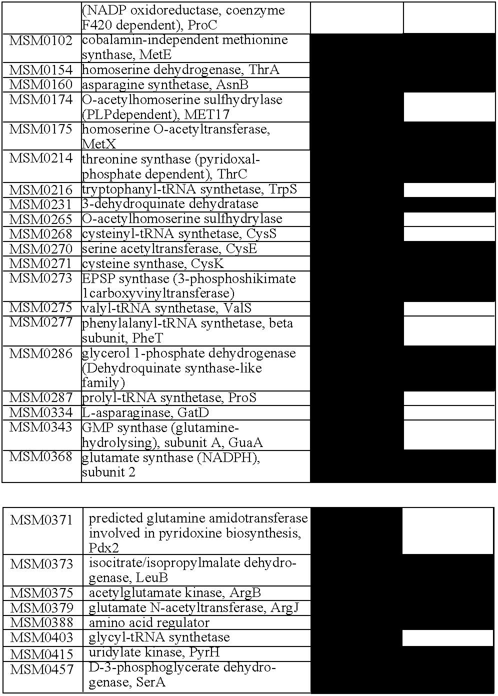

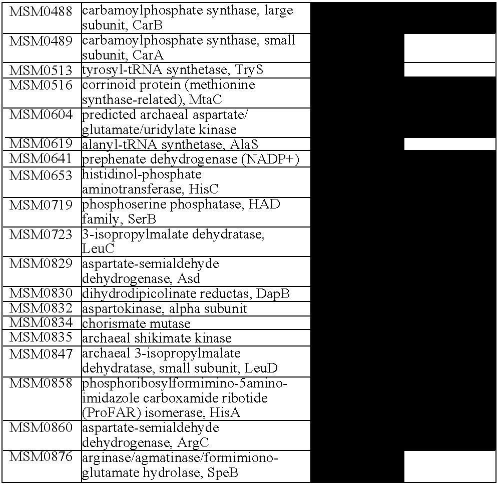

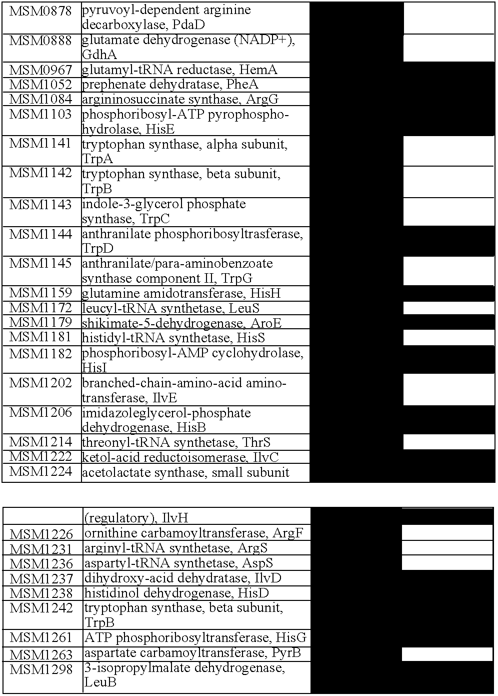

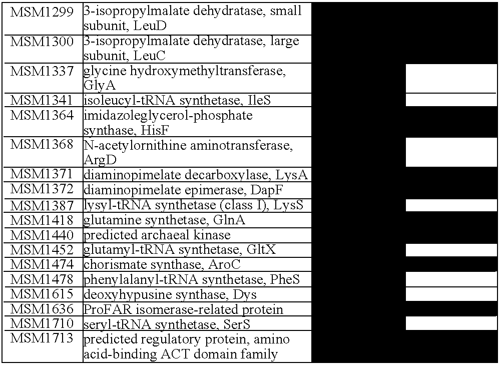

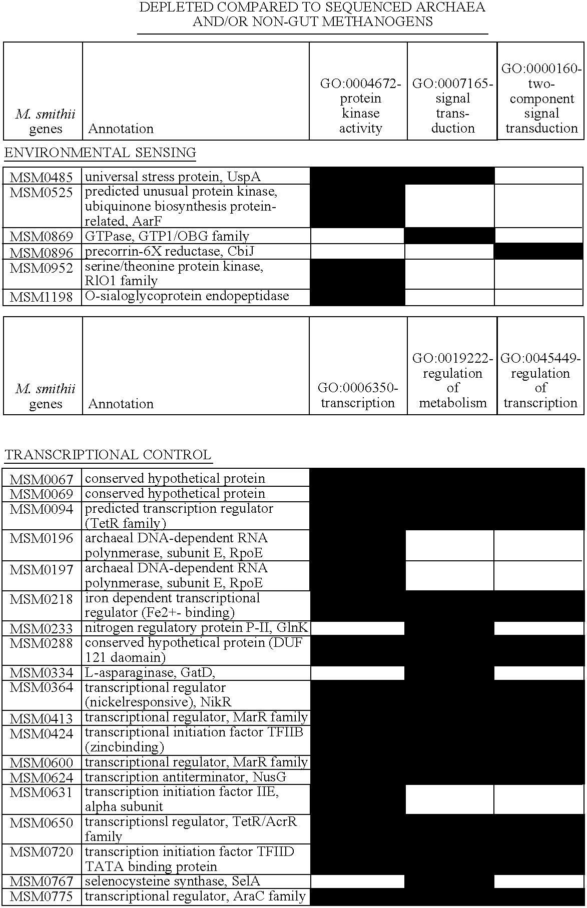

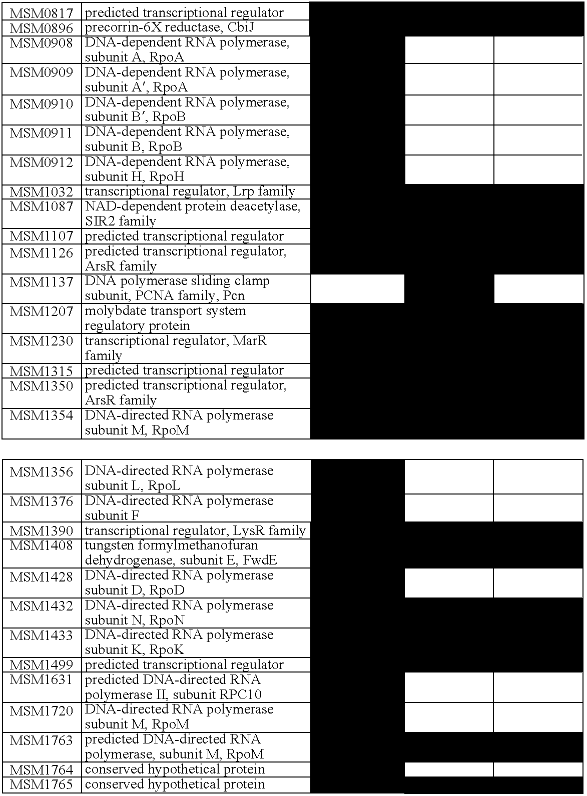

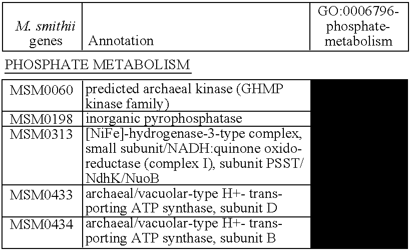

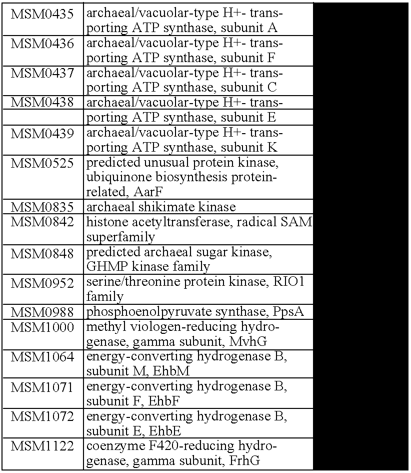

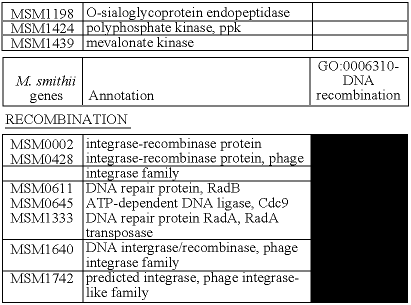

TABLE 8
M. smithii proteins with homologs in other sequenced Methanobacteriales

| | | | | Methanothermobacter | | |
|---|---|---|---|---|---|---|
| M. smithii | Methanosphaera stadmanae | | | thermoautotrophicus | | |
| ORF | ORF | ANNOTATION | E-value | ORF | ANNOTATION | E-value |
| MSM0001 | Msp_0220 | predicted glycosyltransferase | 4.2E−08 | NONE | | |
| MSM0002 | Msp_1355 | predicted site-specific | 2.0E−08 | MTH_893 | integrase-recombinase | 8.1E−16 |
| | | recombinase/integrase | | | protein | |
| MSM0003 | Msp_0548 | hypothetical membrane-spanning | 6.8E−09 | NONE | | |
| | | protein | | | | |
| MSM0004 | Msp_0803 | conserved hypothetical protein | 2.3E−24 | NONE | | |
| MSM0005 | Msp_0783 | hypothetical membrane-spanning | 3.7E−05 | MTH_1439 | unknown | 6.2E−04 |
| | | protein | | | | |
| MSM0006 | Msp_0725 | hypothetical protein | 1.3E−05 | MTH_1277 | unknown | 3.3E−05 |
| MSM0007 | NONE | | | MTH_675 | unknown | 1.1E−34 |
| MSM0008 | Msp_0017 | conserved hypothetical protein | 1.7E−28 | NONE | | |
| MSM0009 | NONE | | | MTH_675 | unknown | 8.1E−34 |
| MSM0010 | Msp_0813 | conserved hypothetical protein | 1.5E−36 | MTH_676 | unknown | 1.7E−40 |
| MSM0011 | NONE | | | NONE | | |
| MSM0012 | Msp_0317 | hypothetical protein | 3.3E−04 | NONE | | |
| MSM0013 | NONE | | | NONE | | |
| MSM0014 | NONE | | | MTH_1289 | heat shock protein GrpE | 2.6E−04 |
| MSM0015 | NONE | | | NONE | | |
| MSM0016 | NONE | | | NONE | | |
| MSM0017 | NONE | | | NONE | | |
| MSM0018 | NONE | | | NONE | | |
| MSM0019 | NONE | | | NONE | | |
| MSM0020 | Msp_1323 | conserved hypothetical protein | 1.4E−05 | MTH_83 | O-linked GlcNAc | 3.3E−07 |
| | | | | | transferase | |
| MSM0021 | Msp_0047 | predicted short chain | 3.7E−40 | NONE | | |
| | | dehydrogenase | | | | |
| MSM0022 | NONE | | | NONE | | |
| MSM0023 | Msp_0424 | conserved hypothetical protein | 1.6E−25 | MTH_1084 | conserved protein | 4.4E−18 |
| MSM0024 | NONE | | | NONE | | |
| MSM0025 | Msp_0447 | predicted acyl-CoA synthetase | 3.7E−49 | MTH_657 | long-chain-fatty-acid-CoA | 8.7E−227 |
| | | | | | ligase | |
| MSM0026 | Msp_0265 | conserved hypothetical protein | 2.0E−16 | MTH_659 | epoxidase | 4.1E−62 |
| MSM0027 | Msp_0667 | putative glutamate synthase, | 7.9E−70 | NONE | glutamate synthase | 4.6E−79 |
| | | subunit 2 with ferredoxin domain | | | (NADPH), alpha subunit | |
| MSM0028 | Msp_0602 | conserved hypothetical protein | 1.9E−13 | MTH_1876 | conserved protein | 1.7E−04 |
| MSM0029 | NONE | | | NONE | | |
| MSM0030 | Msp_0741 | conserved hypothetical | 1.8E−72 | MTH_1812 | conserved protein | 1.6E−44 |
| | | membrane-spanning protein | | | | |
| MSM0031 | Msp_1465 | member of asn/thr-rich large | 2.9E−23 | MTH_716 | cell surface glycoprotein | 3.7E−04 |
| | | protein family | | | (s-layer protein) | |
| MSM0032 | NONE | | | NONE | | |
| MSM0033 | Msp_0966 | putative 2-dehydropantoate 2- | 6.8E−112 | NONE | | |
| | | reductase | | | | |
| MSM0034 | Msp_0725 | hypothetical protein | 7.9E−06 | NONE | | |
| MSM0035 | NONE | | | NONE | | |
| MSM0036 | NONE | | | NONE | | |
| MSM0037 | NONE | | | NONE | | |
| MSM0038 | NONE | | | NONE | | |
| MSM0039 | NONE | | | NONE | | |
| MSM0040 | Msp_1274 | conserved hypothetical protein | 5.5E−05 | NONE | | |
| MSM0041 | NONE | | | NONE | | |
| MSM0042 | NONE | | | NONE | | |
| MSM0043 | Msp_0737 | putative peptide methionine | 1.6E−32 | MTH_535 | peptide methionine | 5.3E−16 |
| | | sulfoxide reductase MsrA/MsrB | | | sulfoxide reductase | |
| MSM0044 | Msp_0510 | putative aspartate | 2.0E−15 | MTH_1894 | aspartate | 3.9E−13 |
| | | aminotransferase | | | aminotransferase | |
| | | | | | homolog | |
| MSM0045 | Msp_0283 | predicted ATPase | 3.9E−93 | MTH_1176 | nucleotide-binding protein | 1.4E−70 |
| | | | | | (putative ATPase) | |
| MSM0046 | Msp_1460 | predicted NAD(FAD)-dependent | 8.4E−114 | MTH_1354 | NADH oxidase | 2.0E−149 |
| | | dehydrogenase | | | | |
| MSM0047 | NONE | | | NONE | | |
| MSM0048 | Msp_0701 | hypothetical protein | 4.0E−20 | NONE | | |
| MSM0049 | Msp_0665 | F420H2:NADP oxidoreductase | 3.1E−75 | MTH_248 | conserved protein | 9.4E−56 |
| MSM0050 | Msp_1172 | conserved hypothetical protein | 1.7E−21 | NONE | | |
| MSM0051 | Msp_1399 | member of asn/thr-rich large | 4.0E−33 | MTH_716 | cell surface glycoprotein | 3.9E−11 |
| | | protein family | | | (s-layer protein) | |
| MSM0052 | Msp_0145 | member of asn/thr-rich large | 1.4E−53 | MTH_716 | cell surface glycoprotein | 1.8E−11 |
| | | protein family | | | (s-layer protein) | |
| MSM0053 | Msp_0086 | putative tRNA | 5.0E−100 | MTH_584 | tRNA | 2.5E−110 |
| | | nucleotidyltransferase | | | nucleotidyltransferase | |
| MSM0054 | Msp_0089 | predicted 2′-5′ RNA ligase | 7.2E−37 | MTH_583 | conserved protein | 9.1E−42 |
| MSM0055 | Msp_0090 | predicted 3-dehydroquinate | 3.5E−108 | MTH_580 | conserved protein | 3.3E−124 |
| | | synthase | | | | |
| MSM0056 | Msp_0091 | predicted fructose-bisphosphate | 1.5E−100 | MTH_579 | conserved protein | 2.9E−100 |
| | | aldolase | | | | |
| MSM0057 | Msp_0762 | member of asn/thr-rich large | 1.7E−13 | MTH_716 | cell surface glycoprotein | 8.2E−07 |
| | | protein family | | | (s-layer protein) | |
| MSM0058 | Msp_0128 | predicted helicase | 8.6E−23 | MTH_472 | DNA helicase II | 1.2E−90 |
| MSM0059 | Msp_0092 | conserved hypothetical protein | 9.4E−35 | MTH_578 | unknown | 2.1E−49 |
| MSM0060 | Msp_1187 | predicted archaeal kinase | 8.2E−52 | MTH_577 | conserved protein | 2.1E−49 |
| MSM0061 | Msp_0757 | predicted ATPase | 7.5E−97 | NONE | | |
| MSM0062 | Msp_0554 | hypothetical protein | 2.2E−08 | MTH_847 | unknown | 6.9E−08 |
| MSM0063 | Msp_1186 | predicted hydrolase | 1.3E−67 | MTH_576 | conserved protein | 7.0E−51 |
| MSM0064 | Msp_0099 | conserved hypothetical protein | 4.6E−10 | MTH_812 | conserved protein | 1.5E−09 |
| MSM0065 | Msp_1185 | putative 5-amino-6-(5- | 2.6E−55 | MTH_235 | riboflavin-specific | 1.5E−66 |
| | | phosphoribosylamino)uracil | | | deaminase | |
| | | reductase | | | | |
| MSM0066 | Msp_0080 | predicted glycosyltransferase | 8.2E−107 | MTH_590 | N-acetylglucosamine-1- | 7.9E−107 |
| | | | | | phosphate transferase | |
| MSM0067 | NONE | | | NONE | | |
| MSM0068 | Msp_0407 | conserved hypothetical protein | 6.0E−04 | MTH_521 | unknown | 8.4E−04 |
| MSM0069 | Msp_0081 | conserved hypothetical protein | 2.8E−26 | MTH_589 | conserved protein | 3.1E−25 |
| MSM0070 | Msp_0082 | conserved hypothetical protein | 2.8E−99 | MTH_588 | conserved protein | 4.8E−100 |
| MSM0071 | Msp_0083 | MetG | 5.3E−199 | MTH_587 | methionyl-tRNA | 2.9E−235 |
| | | | | | synthetase | |
| MSM0072 | Msp_0216 | hypothetical membrane-spanning | 2.2E−04 | NONE | | |
| | | protein | | | | |
| MSM0073 | Msp_0084 | DNA primase, large subunit | 1.4E−102 | MTH_586 | unknown | 1.7E−118 |
| MSM0074 | NONE | | | NONE | | |
| MSM0075 | Msp_0085 | DNA primase, small subunit | 1.2E−96 | NONE | DNA primase, small | 8.1E−105 |
| | | | | | subunit | |
| MSM0076 | Msp_0710 | hypothetical protein | 9.9E−04 | NONE | | |
| MSM0077 | Msp_0357 | putative thymidylate kinase | 6.9E−16 | MTH_1100 | conserved protein | 4.6E−47 |
| MSM0078 | NONE | | | MTH_1099 | conserved protein | 3.9E−50 |
| MSM0079 | Msp_0392 | CofH | 7.6E−81 | MTH_820 | conserved protein | 1.0E−106 |
| MSM0080 | Msp_0278 | ComD | 1.0E−53 | MTH_1206 | phosphonopyruvate | 1.7E−47 |
| | | | | | decarboxylase related | |
| | | | | | protein | |
| MSM0081 | Msp_0277 | ComE | 9.4E−51 | MTH_1207 | phosphonopyruvate | 1.7E−40 |
| | | | | | decarboxylase related | |
| | | | | | protein | |
| MSM0082 | Msp_0127 | HdrA2 | 1.3E−241 | NONE | heterodisulfide reductase, | 2.5E−133 |
| | | | | | subunit A | |
| MSM0083 | Msp_0126 | HdrB2 | 2.6E−94 | NONE | heterodisulfide reductase, | 8.6E−46 |
| | | | | | subunit B | |
| MSM0084 | Msp_0125 | HdrC2 | 2.6E−48 | NONE | heterodisulfide reductase, | 3.5E−17 |
| | | | | | subunit C | |
| MSM0085 | Msp_1261 | conserved hypothetical protein | 6.6E−114 | MTH_1684 | conserved protein | 2.1E−115 |
| | | | | | (contains ferredoxin | |
| | | | | | domain) | |
| MSM0086 | Msp_1270 | ComA | 5.2E−73 | MTH_1674 | conserved protein | 3.5E−81 |
| MSM0087 | Msp_0233 | conserved hypothetical protein | 2.3E−22 | NONE | | |
| MSM0088 | Msp_1322 | conserved hypothetical protein | 7.3E−44 | MTH_727 | conserved protein | 1.6E−51 |
| MSM0089 | Msp_1314 | ProC | 8.2E−07 | NONE | | |
| MSM0090 | NONE | | | MTH_224 | conserved protein | 8.6E−30 |
| MSM0091 | Msp_0129 | putative 2,3-diphosphoglycerate | 8.6E−144 | MTH_223 | unknown | 2.0E−172 |
| | | synthase | | | | |
| MSM0092 | Msp_0154 | member of asn/thr-rich large | 5.6E−08 | NONE | | |
| | | protein family | | | | |
| MSM0093 | Msp_1068 | partially conserved hypothetical | 1.1E−58 | MTH_1858 | phage infection protein | 5.7E−98 |
| | | membrane-spanning protein | | | homolog | |
| MSM0094 | Msp_0971 | hypothetical protein | 4.4E−09 | MTH_1787 | conserved protein | 9.3E−17 |
| MSM0095 | Msp_1181 | predicted phosphotransacetylase | 1.3E−44 | MTH_231 | conserved protein | 8.8E−44 |
| MSM0096 | Msp_1182 | UppS | 2.6E−96 | MTH_232 | conserved protein | 2.3E−100 |
| MSM0097 | Msp_1183 | predicted DNase | 3.2E−57 | MTH_233 | conserved protein | 3.4E−67 |
| MSM0098 | NONE | | | NONE | | |
| MSM0099 | Msp_0079 | hypothetical membrane-spanning | 2.1E−23 | MTH_596 | unknown | 8.2E−25 |
| | | protein | | | | |
| MSM0100 | Msp_0078 | hypothetical membrane-spanning | 7.3E−12 | MTH_429 | unknown | 1.1E−13 |
| | | protein | | | | |
| MSM0101 | Msp_0988 | CbiF | 9.8E−88 | MTH_602 | precorrin-3 methylase | 1.5E−80 |
| MSM0102 | Msp_1236 | MetE | 3.4E−69 | MTH_775 | cobalamin-independent | 3.8E−75 |
| | | | | | methionine synthase | |
| MSM0103 | NONE | | | MTH_776 | conserved protein | 7.3E−33 |
| MSM0104 | NONE | | | MTH_777 | conserved protein | 2.7E−42 |
| MSM0105 | Msp_1234 | conserved hypothetical | 3.8E−86 | MTH_778 | unknown | 5.9E−118 |
| | | membrane-spanning protein | | | | |
| MSM0106 | Msp_1232 | conserved hypothetical protein | 1.8E−109 | MTH_781 | conserved protein | 2.3E−132 |
| MSM0107 | Msp_1231 | HypB | 1.4E−79 | MTH_782 | hydrogenase | 1.1E−84 |
| | | | | | expression/formation | |
| | | | | | protein HypB | |
| MSM0108 | Msp_1230 | HypA | 5.8E−35 | MTH_783 | hydrogenase | 4.8E−36 |
| | | | | | expression/formation | |
| | | | | | protein HypA | |
| MSM0109 | Msp_0987 | hypothetical membrane-spanning | 8.6E−09 | NONE | | |
| | | protein | | | | |
| MSM0110 | Msp_0017 | conserved hypothetical protein | 1.5E−22 | NONE | | |
| MSM0111 | NONE | | | NONE | | |
| MSM0112 | Msp_0367 | predicted helicase | 1.2E−208 | NONE | ATP-dependent RNA | 1.4E−235 |
| | | | | | helicase, elF-4A family | |
| MSM0113 | Msp_0128 | predicted helicase | 9.9E−137 | MTH_472 | DNA helicase II | 6.1E−26 |
| MSM0114 | NONE | | | NONE | | |
| MSM0115 | Msp_1290 | conserved hypothetical protein | 8.0E−29 | MTH_526 | conserved protein | 2.1E−51 |
| MSM0116 | Msp_1289 | conserved hypothetical protein | 3.5E−51 | MTH_528 | unknown | 9.1E−42 |
| MSM0117 | Msp_1288 | conserved hypothetical | 4.7E−56 | MTH_529 | unknown | 1.5E−66 |
| | | membrane-spanning protein | | | | |
| MSM0118 | Msp_1286 | conserved hypothetical protein | 1.1E−86 | MTH_532 | UDP-N-acetylmuramyl | 2.9E−86 |
| | | | | | tripeptide synthetase | |
| | | | | | related protein | |
| MSM0119 | Msp_0156 | predicted nuclease | 3.2E−18 | MTH_538 | unknown | 2.5E−14 |
| MSM0120 | Msp_1095 | DNA double-strand break repair | 1.3E−92 | MTH_540 | intracellular protein | 2.1E−27 |
| | | protein Rad50 | | | transport protein | |
| MSM0121 | Msp_1094 | DNA double-strand break repair | 3.7E−72 | MTH_541 | Rad32 related protein | 1.2E−16 |
| | | protein Mre11 | | | | |
| MSM0122 | Msp_1093 | predicted ATPase | 1.7E−122 | MTH_307 | conserved protein | 4.2E−124 |
| MSM0123 | Msp_1092 | conserved hypothetical protein | 2.4E−29 | MTH_306 | conserved protein | 1.2E−32 |
| MSM0124 | Msp_1291 | PcrB | 5.1E−75 | MTH_552 | conserved protein | 2.9E−84 |
| MSM0125 | Msp_1292 | 50S ribosomal protein L40e | 5.5E−23 | MTH_553 | ribosomal protein L40 | 7.6E−22 |
| MSM0126 | Msp_1293 | conserved hypothetical protein | 9.4E−51 | MTH_554 | conserved protein | 2.9E−54 |
| MSM0127 | NONE | | | NONE | | |
| MSM0128 | Msp_0853 | conserved hypothetical | 2.3E−10 | MTH_570 | unknown | 2.8E−31 |
| | | membrane-spanning protein | | | | |
| MSM0129 | Msp_0435 | nicotinamide-nucleotide | 8.1E−61 | MTH_150 | conserved protein | 6.7E−62 |
| | | adenylyltransferase | | | | |
| MSM0130 | NONE | | | MTH_149 | molybdenum cofactor | 6.6E−39 |
| | | | | | biosynthesis protein MoaE | |
| MSM0131 | NONE | | | MTH_920 | anion permease | 1.5E−04 |
| MSM0132 | NONE | | | MTH_1797 | conserved protein | 7.9E−20 |
| MSM0133 | Msp_1198 | predicted thioesterase | 2.2E−42 | MTH_658 | unknown | 4.8E−36 |
| MSM0134 | Msp_0565 | predicted M42 glutamyl | 2.2E−115 | NONE | endo-1,4-beta-glucanase | 3.7E−116 |
| | | aminopeptidase | | | | |
| MSM0135 | Msp_0668 | conserved hypothetical protein | 9.1E−85 | NONE | coenzyme F420-reducing | 4.5E−88 |
| | | | | | hydrogenase, beta | |
| | | | | | subunit homolog | |
| MSM0136 | Msp_0147 | ferredoxin | 2.2E−06 | NONE | tungsten | 2.2E−06 |
| | | | | | formylmethanofuran | |
| | | | | | dehydrogenase, subunit G | |
| MSM0137 | Msp_0220 | predicted glycosyltransferase | 3.7E−12 | MTH_540 | intracellular protein | 4.7E−05 |
| | | | | | transport protein | |
| MSM0138 | NONE | | | MTH_491 | conserved protein | 2.6E−51 |
| MSM0139 | Msp_0448 | predicted polysaccharide | 7.6E−04 | NONE | | |
| | | biosynthesis protein | | | | |
| MSM0140 | Msp_0560 | conserved hypothetical protein | 4.0E−59 | MTH_435 | conserved protein | 2.9E−68 |
| MSM0141 | Msp_0561 | predicted dephospho-CoA kinase | 5.5E−23 | MTH_434 | UMP/CMP kinase related | 5.6E−42 |
| | | | | | protein | |
| MSM0142 | Msp_0563 | predicted ATPase of PP-loop | 3.2E−66 | MTH_432 | conserved protein | 2.9E−68 |
| | | superfamily | | | | |
| MSM0143 | Msp_0564 | partially conserved hypothetical | 1.3E−30 | MTH_431 | unknown | 2.4E−34 |
| | | membrane-spanning protein | | | | |
| MSM0144 | NONE | | | NONE | | |
| MSM0145 | Msp_0451 | hypothetical membrane-spanning | 1.9E−13 | MTH_422 | unknown | 1.6E−14 |
| | | protein | | | | |
| MSM0146 | Msp_0452 | conserved hypothetical | 7.0E−18 | MTH_421 | unknown | 2.0E−21 |
| | | membrane-spanning protein | | | | |
| MSM0147 | Msp_0453 | PyrG | 2.2E−202 | MTH_419 | CTP synthase | 2.9E−212 |
| MSM0148 | Msp_0739 | predicted oxidoreductase | 3.9E−93 | MTH_907 | conserved protein | 3.1E−32 |
| MSM0149 | NONE | | | NONE | | |
| MSM0150 | NONE | | | NONE | | |
| MSM0151 | NONE | | | NONE | | |
| MSM0152 | Msp_1417 | predicted Na+-driven multidrug | 1.1E−28 | MTH_314 | conserved protein | 4.7E−23 |
| | | efflux pump | | | | |
| MSM0153 | Msp_0485 | ApgM1 | 1.3E−110 | MTH_418 | phosphonopyruvate | 2.1E−106 |
| | | | | | decarboxylase related | |
| | | | | | protein | |
| MSM0154 | Msp_0487 | putative homoserine | 1.3E−101 | MTH_417 | homoserine | 6.1E−100 |
| | | dehydrogenase | | | dehydrogenase homolog | |
| MSM0155 | Msp_0488 | predicted allosteric regulator of | 1.1E−29 | MTH_416 | conserved protein | 7.8E−36 |
| | | homoserine dehydrogenase | | | | |
| MSM0156 | Msp_0489 | conserved hypothetical protein | 2.6E−23 | MTH_415 | conserved protein | 3.3E−21 |
| MSM0157 | Msp_0484 | predicted type I restriction- | 1.9E−09 | NONE | type I restriction | 5.3E−09 |
| | | modification system subunit | | | modification system, | |
| | | | | | subunit S | |
| MSM0158 | Msp_0483 | hypothetical protein | 2.3E−17 | NONE | type I restriction | 2.2E−13 |
| | | | | | modification system, | |
| | | | | | subunit S | |
| MSM0159 | Msp_0777 | member of asn/thr-rich large | 2.1E−13 | NONE | | |
| | | protein family | | | | |
| MSM0160 | Msp_0490 | putative asparagine synthetase | 7.9E−102 | MTH_414 | asparagine synthetase | 2.3E−91 |
| MSM0161 | NONE | | | NONE | | |
| MSM0162 | NONE | | | NONE | | |
| MSM0163 | Msp_0425 | conserved hypothetical protein | 7.0E−23 | MTH_1083 | conserved protein | 5.6E−26 |
| MSM0164 | Msp_0946 | conserved hypothetical protein | 1.3E−106 | MTH_1084 | conserved protein | 4.6E−188 |
| MSM0165 | Msp_0945 | predicted RecB family | 7.9E−54 | MTH_1085 | conserved protein | 1.8E−45 |
| | | exonuclease | | | | |
| MSM0166 | Msp_0422 | predicted helicase | 2.3E−27 | MTH_1086 | conserved protein | 9.1E−32 |
| MSM0167 | NONE | | | MTH_1087 | unknown | 8.4E−04 |
| MSM0168 | NONE | | | NONE | | |
| MSM0169 | Msp_0220 | predicted glycosyltransferase | 2.1E−04 | NONE | | |
| MSM0170 | Msp_0944 | conserved hypothetical protein | 1.4E−63 | MTH_1091 | conserved protein | 3.4E−35 |
| MSM0171 | Msp_0835 | hypothetical membrane-spanning | 2.7E−43 | MTH_769 | unknown | 1.7E−34 |
| | | protein | | | | |
| MSM0172 | NONE | | | NONE | | |
| MSM0173 | Msp_0145 | member of asn/thr-rich large | 3.2E−34 | MTH_1074 | putative membrane | 5.5E−31 |
| | | protein family | | | protein | |
| MSM0174 | Msp_0677 | predicted O-acetylhomoserine | 1.9E−123 | NONE | | |
| | | sulfhydrylase | | | | |
| MSM0175 | Msp_0676 | MetX | 2.3E−166 | MTH_1820 | homoserine O- | 1.5E−21 |
| | | | | | acetyltransferase | |
| MSM0176 | NONE | | | NONE | | |
| MSM0177 | NONE | | | NONE | | |
| MSM0178 | Msp_1385 | conserved hypothetical protein | 1.5E−27 | NONE | | |
| MSM0179 | NONE | | | NONE | | |
| MSM0180 | NONE | | | MTH_698 | unknown | 1.6E−04 |
| MSM0181 | Msp_1174 | 50S ribosomal protein L37e | 9.6E−26 | MTH_648 | ribosomal protein L37 | 2.8E−24 |
| MSM0182 | Msp_1175 | putative snRNP Sm-like protein | 1.5E−27 | MTH_649 | conserved protein | 2.1E−33 |
| MSM0183 | Msp_1176 | predicted RNA-binding protein | 9.0E−46 | MTH_650 | conserved protein | 8.6E−46 |
| MSM0184 | Msp_1177 | predicted creatinine | 1.3E−51 | MTH_651 | conserved protein | 1.6E−51 |
| | | amidohydrolase | | | | |
| MSM0185 | Msp_0547 | hypothetical membrane-spanning | 7.8E−08 | MTH_515 | unknown | 4.3E−05 |
| | | protein | | | | |
| MSM0186 | Msp_0345 | conserved hypothetical protein | 1.3E−14 | NONE | | |
| MSM0187 | Msp_0444 | rubredoxin | 2.5E−09 | MTH_156 | rubredoxin | 2.3E−13 |
| MSM0188 | Msp_0444 | rubredoxin | 3.4E−14 | MTH_156 | rubredoxin | 3.5E−17 |
| MSM0189 | Msp_1301 | predicted nucleoside- | 4.6E−08 | MTH_272 | acetyl/acyl transferase | 1.3E−58 |
| | | diphosphate-sugar | | | related protein | |
| | | pyrophosphorylase | | | | |
| MSM0190 | Msp_0617 | predicted ATPase | 3.1E−84 | MTH_271 | conserved protein | 1.8E−75 |
| MSM0191 | Msp_1533 | RpoM1 | 1.5E−04 | NONE | | |
| MSM0192 | Msp_0618 | ArgH | 2.7E−147 | MTH_269 | argininosuccinate lyase | 8.2E−160 |
| MSM0193 | Msp_0620 | 30S ribosomal protein S27Ae | 1.8E−17 | MTH_268 | ribosomal protein S27a | 8.1E−18 |
| MSM0194 | Msp_0621 | 30S ribosomal protein S24e | 1.1E−26 | MTH_267 | ribosomal protein S24 | 1.6E−28 |
| MSM0195 | Msp_0622 | conserved hypothetical protein | 4.8E−31 | MTH_266 | conserved protein | 1.3E−33 |
| MSM0196 | Msp_0623 | RpoE2 | 9.0E−14 | NONE | DNA-dependent RNA | 1.5E−18 |
| | | | | | polymerase, subunit E″ | |
| MSM0197 | Msp_0624 | RpoE1 | 2.2E−65 | NONE | DNA-dependent RNA | 1.3E−67 |
| | | | | | polymerase, subunit E′ | |
| MSM0198 | Msp_0625 | inorganic pyrophosphatase | 3.1E−68 | MTH_263 | inorganic | 7.2E−65 |
| | | | | | pyrophosphatase | |
| MSM0199 | Msp_0626 | conserved hypothetical protein | 2.4E−22 | MTH_262 | conserved protein | 3.7E−29 |
| MSM0200 | Msp_0627 | putative translation initiation factor | 3.3E−158 | NONE | translation initiation factor | 1.6E−163 |
| | | 2, subunit gamma (alF- | | | elF-2, gamma subunit | |
| | | 2gamma)(elF2G) | | | | |
| MSM0201 | Msp_0628 | 30S ribosomal protein S6e | 9.9E−40 | MTH_260 | ribosomal protein S6 | 1.5E−41 |
| MSM0202 | Msp_0629 | InfB | 9.3E−202 | MTH_259 | translation initiation factor | 2.6E−218 |
| | | | | | IF2 homolog | |
| MSM0203 | Msp_0630 | nucleoside diphosphate kinase | 1.8E−56 | MTH_258 | nucleoside diphosphate | 1.9E−57 |
| | | | | | kinase | |
| MSM0204 | Msp_0631 | 50S ribosomal protein L24e | 3.0E−22 | MTH_257 | ribosomal protein L24 | 8.2E−25 |
| MSM0205 | Msp_0632 | 30S ribosomal protein S28e | 4.3E−30 | MTH_256 | ribosomal protein S28 | 2.2E−31 |
| MSM0206 | Msp_0633 | 50S ribosomal protein L7Ae | 9.3E−44 | MTH_255 | ribosomal protein L7a | 1.3E−44 |
| MSM0207 | NONE | | | MTH_1178 | conserved protein | 1.9E−41 |
| MSM0208 | NONE | | | MTH_1178 | conserved protein | 3.9E−08 |
| MSM0209 | Msp_0861 | ferredoxin | 7.3E−12 | MTH_1106 | ferredoxin | 7.6E−22 |
| MSM0210 | Msp_0253 | conserved hypothetical | 1.1E−04 | NONE | | |
| | | membrane-spanning protein | | | | |
| MSM0211 | NONE | | | NONE | | |
| MSM0212 | NONE | | | NONE | | |
| MSM0213 | Msp_0769 | archaeal histone | 8.2E−20 | MTH_821 | histone HMtA1 | 3.7E−22 |
| MSM0214 | Msp_0588 | ThrC | 2.0E−153 | MTH_253 | threonine synthase | 8.8E−163 |
| MSM0215 | Msp_0232 | hypothetical membrane-spanning | 2.4E−22 | MTH_252 | conserved protein | 4.5E−24 |
| | | protein | | | | |
| MSM0216 | Msp_0653 | TrpS | 5.0E−132 | MTH_251 | tryptophanyl-tRNA | 1.8E−116 |
| | | | | | synthetase | |
| MSM0217 | Msp_0652 | EndA | 5.0E−45 | MTH_250 | tRNA intron endonuclease | 2.7E−49 |
| MSM0218 | Msp_0446 | predicted metal-dependent | 5.3E−57 | MTH_214 | iron repressor | 6.4E−57 |
| | | transcriptional regulator | | | | |
| MSM0219 | Msp_1129 | partially conserved hypothetical | 1.0E−46 | MTH_357 | conserved protein | 4.0E−67 |
| | | membrane-spanning protein | | | | |
| MSM0220 | Msp_0114 | ThsB | 1.7E−170 | MTH_218 | chaperonin | 4.0E−183 |
| MSM0221 | Msp_0590 | member of asn/thr-rich large | 6.9E−13 | MTH_719 | cell surface glycoprotein | 4.2E−05 |
| | | protein family | | | (s-layer protein) | |
| MSM0222 | Msp_0787 | FprA | 2.5E−128 | MTH_220 | flavoprotein A homolog (II) | 3.2E−133 |
| MSM0223 | NONE | | | MTH_557 | unknown | 1.4E−22 |
| MSM0224 | NONE | | | MTH_558 | unknown | 2.1E−28 |
| MSM0225 | Msp_1294 | conserved hypothetical | 1.4E−47 | MTH_559 | conserved protein | 1.4E−54 |
| | | membrane-spanning protein | | | | |
| MSM0226 | NONE | | | NONE | | |
| MSM0227 | Msp_0584 | HmgA | 2.2E−138 | MTH_562 | 3-hydroxy-3- | 1.7E−143 |
| | | | | | methylglutaryl CoA | |
| | | | | | reductase | |
| MSM0228 | Msp_0583 | SucD | 1.7E−99 | NONE | succinyl-CoA synthetase, | 1.3E−111 |
| | | | | | alpha subunit | |
| MSM0229 | Msp_0582 | conserved hypothetical protein | 1.6E−69 | MTH_564 | conserved protein | 1.5E−87 |
| MSM0230 | Msp_0233 | conserved hypothetical protein | 2.9E−21 | NONE | | |
| MSM0231 | Msp_0577 | AroD | 9.9E−40 | MTH_566 | 3-dehydroquinate | 2.9E−52 |
| | | | | | dehydratase | |
| MSM0232 | Msp_0145 | member of asn/thr-rich large | 3.8E−05 | MTH_567 | unknown | 7.5E−31 |
| | | protein family | | | | |
| MSM0233 | Msp_0664 | nitrogen regulatory protein P-II | 7.9E−31 | MTH_664 | nitrogen regulatory protein | 1.4E−36 |
| | | | | | P-II | |
| MSM0234 | Msp_0663 | ammonium transporter | 4.8E−150 | MTH_663 | ammonium transporter | 1.2E−142 |
| MSM0235 | Msp_0119 | hypothetical membrane-spanning | 6.0E−04 | MTH_181 | unknown | 1.4E−04 |
| | | protein | | | | |
| MSM0236 | Msp_0434 | predicted phosphohydrolase | 1.2E−100 | MTH_148 | conserved protein | 7.8E−123 |
| MSM0237 | Msp_0088 | predicted 3-polyprenyl-4- | 3.1E−59 | MTH_147 | phenylacrylic acid | 2.6E−53 |
| | | hydroxybenzoate decarboxylase | | | decarboxylase | |
| MSM0238 | Msp_0087 | CbiT | 4.2E−48 | MTH_146 | precorrin-8W | 3.1E−48 |
| | | | | | decarboxylase | |
| MSM0239 | NONE | | | MTH_145 | conserved protein | 6.9E−44 |
| MSM0240 | Msp_1289 | conserved hypothetical protein | 8.3E−07 | MTH_143 | molybdopterin-guanine | 1.6E−30 |
| | | | | | dinucleotide biosynthesis | |
| | | | | | MobA related protein | |
| MSM0241 | Msp_1252 | putative exosome complex, | 1.1E−61 | MTH_682 | conserved protein | 5.6E−90 |
| | | exonuclease 2 subunit | | | | |
| MSM0242 | Msp_1251 | putative exosome complex, | 1.4E−79 | MTH_683 | ribonuclease PH | 1.1E−93 |
| | | exonuclease 1 subunit | | | | |
| MSM0243 | Msp_1250 | putative exosome complex, RNA- | 1.6E−48 | MTH_684 | conserved protein | 2.1E−90 |
| | | binding subunit | | | | |
| MSM0244 | Msp_1249 | conserved hypothetical protein | 1.8E−70 | MTH_685 | conserved protein | 8.3E−80 |
| MSM0245 | Msp_1248 | PsmA | 6.3E−77 | NONE | proteasome, alpha | 2.5E−94 |
| | | | | | subunit | |
| MSM0246 | Msp_1246 | putative ribonuclease P, | 1.3E−19 | MTH_687 | conserved protein | 2.3E−22 |
| | | component 2 | | | | |
| MSM0247 | Msp_1245 | putative ribonuclease P, | 2.1E−28 | MTH_688 | conserved protein | 3.1E−41 |
| | | component 3 | | | | |
| MSM0248 | Msp_0950 | hypothetical protein | 7.2E−05 | NONE | | |
| MSM0249 | Msp_1548 | hypothetical protein | 1.8E−04 | MTH_301 | unknown | 4.1E−23 |
| MSM0250 | Msp_0501 | hypothetical membrane-spanning | 1.0E−05 | MTH_521 | unknown | 3.6E−10 |
| | | protein | | | | |
| MSM0251 | Msp_0725 | hypothetical protein | 1.5E−04 | NONE | | |
| MSM0252 | Msp_0824 | predicted Na+-driven multidrug | 1.6E−96 | MTH_314 | conserved protein | 3.7E−93 |
| | | efflux pump | | | | |
| MSM0253 | NONE | | | MTH_1725 | unknown | 1.4E−15 |
| MSM0254 | NONE | | | NONE | | |
| MSM0255 | NONE | | | NONE | | |
| MSM0256 | Msp_0017 | conserved hypothetical protein | 1.7E−28 | NONE | | |
| MSM0257 | Msp_0975 | hypothetical membrane-spanning | 4.3E−30 | NONE | | |
| | | protein | | | | |
| MSM0258 | Msp_0724 | hypothetical membrane-spanning | 1.6E−04 | NONE | | |
| | | protein | | | | |
| MSM0259 | Msp_1548 | hypothetical protein | 1.1E−05 | MTH_521 | unknown | 6.8E−04 |
| MSM0260 | Msp_0507 | predicted archaea-specific RecJ- | 2.0E−199 | MTH_763 | conserved protein | 3.4E−225 |
| | | like exonuclease | | | | |
| MSM0261 | Msp_1384 | conserved hypothetical | 1.1E−04 | MTH_759 | unknown | 1.5E−16 |
| | | membrane-spanning protein | | | | |
| MSM0262 | Msp_0788 | desulfoferrodoxin | 1.4E−26 | MTH_757 | rubredoxin | 3.4E−26 |
| | | | | | oxidoreductase | |
| MSM0263 | Msp_1003 | predicted NifU protein | 1.1E−47 | NONE | | |
| MSM0264 | Msp_1002 | IscS | 6.6E−121 | MTH_1389 | nifS protein | 1.6E−30 |
| MSM0265 | Msp_0677 | predicted O-acetylhomoserine | 1.5E−148 | MTH_1188 | pleotropic regulatory | 3.1E−04 |
| | | sulfhydrylase | | | protein DegT | |
| MSM0266 | Msp_0145 | member of asn/thr-rich large | 2.7E−50 | MTH_911 | probable surface protein | 6.2E−09 |
| | | protein family | | | | |
| MSM0267 | Msp_0844 | predicted multimeric flavodoxin | 4.4E−53 | MTH_135 | conserved protein | 2.7E−17 |
| MSM0268 | Msp_0124 | CysS | 1.2E−139 | MTH_587 | methionyl-tRNA | 9.6E−08 |
| | | | | | synthetase | |
| MSM0269 | Msp_0527 | conserved hypothetical protein | 8.0E−38 | NONE | | |
| MSM0270 | Msp_0450 | predicted serine acetyltransferase | 8.1E−61 | MTH_1588 | ferripyochelin binding | 2.0E−06 |
| | | | | | protein | |
| MSM0271 | Msp_0449 | cysteine synthase | 2.2E−97 | NONE | tryptophan synthase, beta | 3.1E−08 |
| | | | | | subunit | |
| MSM0272 | Msp_0497 | putative endonuclease III | 2.2E−67 | MTH_764 | endonuclease III | 1.1E−70 |
| MSM0273 | Msp_0498 | AroA | 1.1E−102 | MTH_766 | 5-enolpyruvylshikimate 3- | 2.5E−62 |
| | | | | | phosphate synthase | |
| MSM0274 | NONE | | | NONE | | |
| MSM0275 | Msp_0499 | ValS | 2.4E−235 | MTH_767 | valyl-tRNA synthetase | 0.0E+00 |
| MSM0276 | Msp_0526 | hypothetical membrane-spanning | 8.1E−29 | MTH_768 | unknown | 2.9E−22 |
| | | protein | | | | |
| MSM0277 | Msp_0525 | PheT | 3.3E−151 | MTH_770 | phenylalanyl-tRNA | 4.2E−172 |
| | | | | | synthetase | |
| MSM0278 | NONE | | | NONE | | |
| MSM0279 | Msp_0522 | conserved hypothetical protein | 4.0E−36 | MTH_771 | conserved protein | 2.7E−35 |
| MSM0280 | Msp_0757 | predicted ATPase | 4.4E−13 | NONE | | |
| MSM0281 | Msp_0145 | member of asn/thr-rich large | 2.1E−09 | MTH_911 | probable surface protein | 2.9E−10 |
| | | protein family | | | | |
| MSM0282 | Msp_0141 | member of asn/thr-rich large | 1.3E−23 | MTH_911 | probable surface protein | 1.1E−17 |
| | | protein family | | | | |
| MSM0283 | NONE | | | MTH_436 | unknown | 1.1E−04 |
| MSM0284 | Msp_0995 | RpiA | 5.8E−74 | MTH_608 | ribose 5-phosphate | 1.3E−74 |
| | | | | | isomerase | |
| MSM0285 | Msp_0996 | conserved hypothetical protein | 1.3E−28 | MTH_609 | conserved protein | 1.3E−35 |
| MSM0286 | Msp_0997 | EgsA | 7.9E−102 | MTH_610 | glycerol 1-phosphate | 1.5E−112 |
| | | | | | dehydrogenase | |
| MSM0287 | Msp_1004 | ProS | 8.6E−160 | MTH_611 | prolyl-tRNA synthetase | 1.4E−155 |
| MSM0288 | Msp_1006 | conserved hypothetical protein | 1.7E−53 | MTH_613 | conserved protein | 4.2E−60 |
| MSM0289 | Msp_1007 | ThiD | 3.6E−58 | MTH_614 | transcriptional regulator | 5.1E−64 |
| MSM0290 | Msp_1000 | predicted ABC-type | 2.6E−71 | MTH_920 | anion permease | 1.4E−31 |
| | | nitrate/sulfonate/bicarbonate | | | | |
| | | transport system, ATB-binding | | | | |
| | | protein | | | | |
| MSM0291 | Msp_1001 | predicted ABC-type | 1.9E−84 | MTH_1730 | phosphate transporter | 4.8E−07 |
| | | nitrate/sulfonate/bicarbonate | | | permease PstC homolog | |
| | | transport system, permease | | | | |
| | | protein | | | | |
| MSM0292 | NONE | | | NONE | | |
| MSM0293 | Msp_0826 | predicted cation transport ATPase | 1.8E−198 | MTH_1535 | heavy-metal transporting | 1.2E−69 |
| | | | | | CPx-type ATPase | |
| MSM0294 | Msp_0825 | hypothetical protein | 4.2E−09 | NONE | | |
| MSM0295 | NONE | | | NONE | nitrate assimilation | 7.1E−49 |
| | | | | | protein, narQ | |
| MSM0296 | NONE | | | MTH_691 | conserved protein | 1.2E−30 |
| MSM0297 | Msp_1244 | predicted exosome subunit | 1.1E−24 | MTH_689 | conserved protein | 2.7E−26 |
| MSM0298 | Msp_1243 | 50S ribosomal protein L15e | 2.1E−76 | MTH_690 | ribosomal protein L15 | 1.3E−67 |
| MSM0299 | NONE | | | NONE | | |
| MSM0300 | Msp_0851 | predicted ABC-type | 1.5E−139 | NONE | | |
| | | dipeptide/oligopeptide/nickel | | | | |
| | | transport system, solute-binding | | | | |
| | | protein | | | | |
| MSM0301 | Msp_0811 | ABC-type dipeptide transport | 2.3E−120 | NONE | | |
| | | system, permease protein | | | | |
| MSM0302 | Msp_0810 | ABC-type dipeptide transport | 1.7E−99 | MTH_1729 | phosphate transporter | 2.3E−05 |
| | | system, permease protein | | | permease PstC | |
| MSM0303 | Msp_0848 | predicted ABC-type | 3.4E−101 | MTH_696 | ABC transporter | 1.4E−20 |
| | | dipeptide/oligopeptide/nickel | | | (glutamine transport ATP- | |
| | | transport system, ATP-binding | | | binding protein) | |
| | | protein | | | | |
| MSM0304 | Msp_0847 | predicted ABC-type | 4.8E−63 | NONE | methyl coenzyme M | 7.3E−21 |
| | | dipeptide/oligopeptide/nickel | | | reductase system, | |
| | | transport system, ATP-binding | | | component A2 | |
| | | protein | | | | |
| MSM0305 | Msp_0431 | GuaB | 6.1E−10 | MTH_406 | conserved protein | 7.6E−70 |
| MSM0306 | Msp_1447 | EhbK | 3.0E−18 | MTH_405 | polyferredoxin | 1.6E−37 |
| MSM0307 | Msp_0071 | predicted ribokinase | 3.4E−62 | MTH_404 | ribokinase | 3.5E−65 |
| MSM0308 | Msp_0070 | formylmethanofuran- | 6.7E−89 | MTH_403 | formylmethanofuran: | 1.7E−95 |
| | | tetrahydromethanopterin | | | tetrahydromethanopterin | |
| | | formyltransferase | | | formyltransferase II | |
| MSM0309 | Msp_0069 | conserved hypothetical | 2.4E−68 | MTH_402 | unknown | 3.9E−57 |
| | | membrane-spanning protein | | | | |
| MSM0310 | Msp_1447 | EhbK | 1.7E−23 | MTH_401 | polyferredoxin | 7.7E−77 |
| MSM0311 | Msp_1447 | EhbK | 2.1E−13 | MTH_399 | polyferredoxin | 7.4E−111 |
| MSM0312 | Msp_1444 | EhbN | 2.2E−51 | NONE | formate hydrogenlyase, | 7.8E−139 |
| | | | | | subunit 5 | |
| MSM0313 | Msp_1445 | EhbM | 5.4E−32 | NONE | formate hydrogenlyase, | 6.3E−66 |
| | | | | | subunit 7 | |
| MSM0314 | NONE | | | MTH_396 | conserved protein | 2.9E−29 |
| MSM0315 | NONE | | | MTH_395 | conserved protein | 1.9E−18 |
| MSM0316 | Msp_0616 | partially conserved hypothetical | 9.5E−04 | MTH_394 | unknown | 5.8E−08 |
| | | membrane-spanning protein | | | | |
| MSM0317 | Msp_1443 | EhbO | 1.1E−16 | NONE | NADH dehydrogenase | 1.9E−105 |
| | | | | | (ubiquinone), subunit 1 | |
| | | | | | related protein | |
| MSM0318 | NONE | | | MTH_392 | unknown | 1.4E−15 |
| MSM0319 | Msp_1452 | EhbF | 4.0E−06 | NONE | NADH dehydrogenase I, | 5.5E−83 |
| | | | | | subunit N related protein | |
| MSM0320 | NONE | | | MTH_390 | conserved protein | 7.0E−67 |
| MSM0321 | NONE | | | MTH_389 | conserved protein | 6.6E−55 |
| MSM0322 | NONE | | | MTH_388 | unknown | 1.5E−25 |
| MSM0323 | NONE | | | MTH_387 | conserved protein | 3.9E−18 |
| MSM0324 | NONE | | | MTH_386 | unknown | 6.4E−18 |
| MSM0325 | NONE | | | MTH_385 | conserved protein | 4.1E−55 |
| MSM0326 | NONE | | | MTH_384 | unknown | 3.5E−17 |
| MSM0327 | Msp_0067 | putative UDP-glucose 4- | 1.2E−73 | MTH_380 | UDP-glucose 4-epimerase | 1.7E−86 |
| | | epimerase | | | homolog | |
| MSM0328 | NONE | | | MTH_698 | unknown | 2.7E−10 |
| MSM0329 | Msp_0265 | conserved hypothetical protein | 7.4E−51 | MTH_700 | conserved protein | 5.1E−64 |
| MSM0330 | Msp_0266 | predicted acyl-CoA synthetase | 1.1E−184 | MTH_701 | acetyl-CoA synthetase | 1.0E−138 |
| | | | | | related protein | |
| MSM0331 | Msp_1390 | KorD | 7.0E−07 | NONE | 2-oxoisovalerate | 7.9E−20 |
| | | | | | oxidoreductase, gamma | |
| | | | | | subunit | |
| MSM0332 | Msp_1389 | KorA | 1.6E−56 | NONE | 2-oxoisovalerate | 6.4E−144 |
| | | | | | oxidoreductase, beta | |
| | | | | | subunit | |
| MSM0333 | Msp_1388 | KorB | 2.0E−28 | NONE | 2-oxoisovalerate | 8.0E−169 |
| | | | | | oxidoreductase, alpha | |
| | | | | | subunit | |
| MSM0334 | Msp_1411 | GatD | 9.1E−140 | MTH_706 | L-asparaginase I | 6.4E−144 |
| MSM0335 | Msp_1412 | GatE | 8.1E−187 | MTH_707 | PET112-like protein | 7.1E−209 |
| MSM0336 | NONE | | | NONE | | |
| MSM0337 | Msp_0145 | member of asn/thr-rich large | 1.1E−08 | NONE | | |
| | | protein family | | | | |
| MSM0338 | NONE | | | NONE | | |
| MSM0339 | NONE | | | NONE | | |
| MSM0340 | Msp_1413 | predicted thioredoxin reductase | 1.4E−70 | MTH_708 | thioredoxin reductase | 6.9E−92 |
| MSM0341 | NONE | | | NONE | | |
| MSM0342 | Msp_0017 | conserved hypothetical protein | 1.7E−28 | NONE | | |
| MSM0343 | Msp_1311 | GMP synthase [glutamine | 4.2E−64 | NONE | GMP synthetase, subunit A | 1.1E−68 |
| | | hydrolyzing], subunit A | | | | |
| MSM0344 | NONE | | | NONE | | |
| MSM0345 | Msp_1312 | GMP synthase [glutamine | 3.4E−117 | NONE | GMP synthetase, subunit B | 7.1E−122 |
| | | hydrolyzing], subunit B | | | | |
| MSM0346 | Msp_1315 | conserved hypothetical protein | 8.0E−125 | MTH_720 | unknown | 3.1E−128 |
| MSM0347 | Msp_1316 | conserved hypothetical protein | 6.5E−43 | MTH_721 | conserved protein | 8.6E−62 |
| MSM0348 | Msp_1317 | conserved hypothetical protein | 7.1E−14 | MTH_722 | conserved protein | 2.3E−22 |
| MSM0349 | Msp_1317 | conserved hypothetical protein | 1.5E−05 | MTH_722 | conserved protein | 1.2E−04 |
| MSM0350 | Msp_1318 | predicted | 3.9E−155 | MTH_723 | 2-isopropylmalate | 6.2E−162 |
| | | isopropylmalate/homocitrate/citra | | | synthase | |
| | | malate synthase | | | | |
| MSM0351 | NONE | | | NONE | | |
| MSM0352 | Msp_1319 | predicted DNA modification | 1.4E−72 | MTH_724 | methyltransferase related | 4.3E−83 |
| | | methylase | | | protein | |
| MSM0353 | Msp_1321 | hypothetical membrane-spanning | 4.8E−11 | NONE | | |
| | | protein | | | | |
| MSM0354 | Msp_1206 | proteasome-activating | 4.1E−144 | MTH_728 | ATP-dependent 26S | 1.2E−172 |
| | | nucleotidase | | | protease regulatory | |
| | | | | | subunit 4 | |
| MSM0355 | Msp_1207 | predicted transcriptional regulator | 7.4E−35 | MTH_729 | conserved protein | 2.7E−33 |
| MSM0356 | Msp_1208 | conserved hypothetical protein | 2.3E−24 | MTH_730 | conserved protein | 6.2E−27 |
| MSM0357 | Msp_1209 | conserved hypothetical | 1.6E−128 | MTH_731 | unknown | 1.5E−110 |
| | | membrane-spanning protein | | | | |
| MSM0358 | Msp_1210 | conserved hypothetical | 7.3E−44 | MTH_733 | unknown | 3.7E−45 |
| | | membrane-spanning protein | | | | |
| MSM0359 | Msp_1213 | predicted UDP-N-acetylmuramyl | 1.7E−108 | MTH_530 | UDP-N-acetylmuramyl | 5.2E−14 |
| | | tripeptide synthase | | | tripeptide synthase | |
| | | | | | related protein | |
| MSM0360 | Msp_1214 | predicted UDP-N-acetylmuramyl | 1.9E−91 | MTH_735 | phospho-N- | 2.8E−102 |
| | | pentapeptide phosphotransferase | | | acetylmuramoyl- | |
| | | | | | pentapeptide-transferase | |
| MSM0361 | Msp_1215 | partially conserved hypothetical | 6.8E−96 | MTH_736 | conserved protein | 2.0E−76 |
| | | protein, predicted carbamoyl- | | | | |
| | | phosphate synthase, large chain | | | | |
| MSM0362 | Msp_1216 | partially conserved hypothetical | 5.4E−16 | NONE | coenzyme F420-reducing | 5.3E−30 |
| | | protein | | | hydrogenase, delta | |
| | | | | | subunit homolog | |
| MSM0363 | Msp_1217 | predicted RNA methylase | 3.2E−50 | MTH_738 | conserved protein | 1.0E−56 |
| MSM0364 | Msp_1218 | putative nickel responsive | 3.0E−54 | MTH_739 | conserved protein | 9.1E−58 |
| | | regulator | | | | |
| MSM0365 | Msp_1090 | hypothetical protein | 2.1E−23 | MTH_741 | unknown | 1.8E−22 |
| MSM0366 | NONE | | | NONE | | |
| MSM0367 | Msp_0099 | conserved hypothetical protein | 6.0E−17 | MTH_812 | conserved protein | 5.6E−26 |
| MSM0368 | Msp_0667 | putative glutamate synthase, | 1.3E−193 | NONE | glutamate synthase | 1.3E−216 |
| | | subunit 2 with ferredoxin domain | | | (NADPH), alpha subunit | |
| MSM0369 | Msp_0669 | putative glutamate synthase, | 1.2E−68 | NONE | tungsten | 1.1E−82 |
| | | subunit 3 | | | formylmethanofuran | |
| | | | | | dehydrogenase, subunit C | |
| | | | | | homolog | |
| MSM0370 | Msp_0670 | putative glutamate synthase, | 5.7E−115 | MTH_191 | glutamine PRPP | 2.2E−127 |
| | | subunit 1 | | | amidotransferase | |
| MSM0371 | Msp_0671 | predicted glutamine | 6.2E−54 | MTH_190 | conserved protein | 3.3E−60 |
| | | amidotransferase | | | | |
| MSM0372 | Msp_0673 | partially conserved hypothetical | 1.3E−23 | MTH_187 | conserved protein | 2.8E−24 |
| | | protein | | | | |
| MSM0373 | Msp_1484 | LeuB | 3.3E−96 | MTH_184 | isocitrate dehydrogenase | 4.5E−104 |
| MSM0374 | Msp_0447 | predicted acyl-CoA synthetase | 8.3E−178 | MTH_657 | long-chain-fatty-acid-CoA | 5.0E−58 |
| | | | | | ligase | |
| MSM0375 | Msp_0550 | ArgB | 2.3E−111 | MTH_183 | acetylglutamate kinase | 2.5E−110 |
| MSM0376 | Msp_0967 | putative NADP-dependent alcohol | 6.2E−06 | NONE | | |
| | | dehydrogenase | | | | |
| MSM0377 | Msp_0310 | predicted | 4.9E−07 | MTH_1152 | conserved protein | 6.5E−05 |
| | | GTP:adenosylcobinamide- | | | | |
| | | phosphate guanylyltransferase | | | | |
| MSM0378 | NONE | | | MTH_1876 | conserved protein | 1.3E−24 |
| MSM0379 | Msp_0549 | ArgJ | 6.5E−107 | MTH_182 | glutamate N- | 1.9E−103 |
| | | | | | acetyltransferase | |
| MSM0380 | Msp_0506 | hypothetical membrane-spanning | 2.1E−05 | MTH_181 | unknown | 1.8E−04 |
| | | protein | | | | |
| MSM0381 | Msp_0546 | conserved hypothetical | 2.8E−99 | MTH_180 | unknown | 1.4E−114 |
| | | membrane-spanning protein | | | | |
| MSM0382 | Msp_0545 | conserved hypothetical protein | 3.7E−95 | MTH_179 | unknown | 1.9E−103 |
| MSM0383 | Msp_0544 | predicted phosphohydrolase | 1.0E−62 | MTH_178 | lcc related protein | 2.6E−53 |
| MSM0384 | Msp_0543 | conserved hypothetical protein | 4.1E−34 | MTH_177 | conserved protein | 1.9E−34 |
| MSM0385 | Msp_0511 | predicted Fe—S oxidoreductase | 3.2E−07 | MTH_1784 | Mg-protoporphyrin IX | 9.9E−84 |
| | | | | | monomethyl ester | |
| | | | | | oxidative cyclase | |
| MSM0386 | Msp_0148 | predicted sodium:solute | 1.9E−178 | MTH_1856 | sodium/proline symporter | 1.5E−181 |
| | | symporter | | | (proline permease) | |
| MSM0387 | Msp_1040 | coenzyme F390 synthetase II | 2.2E−145 | MTH_1855 | coenzyme F390 | 1.4E−162 |
| | | | | | synthetase II | |
| MSM0388 | Msp_1041 | predicted regulatory protein | 4.1E−34 | MTH_1854 | unknown | 2.6E−37 |
| MSM0389 | Msp_0136 | hypothetical protein | 1.5E−06 | NONE | | |
| MSM0390 | NONE | | | NONE | | |
| MSM0391 | Msp_1042 | IorB | 5.6E−53 | NONE | indolepyruvate | 2.4E−50 |
| | | | | | oxidoreductase, beta | |
| | | | | | subunit | |
| MSM0392 | Msp_1043 | IorA | 6.7E−185 | NONE | indolepyruvate | 4.1E−192 |
| | | | | | oxidoreductase, alpha | |
| | | | | | subunit | |
| MSM0393 | Msp_1044 | TfrB | 3.3E−135 | MTH_1850 | fumarate reductase | 1.4E−155 |
| MSM0394 | Msp_1047 | predicted rRNA methylase | 2.2E−65 | MTH_1849 | conserved protein | 1.2E−69 |
| MSM0395 | Msp_1581 | partially conserved hypothetical | 2.7E−46 | MTH_745 | unknown (contains | 3.9E−57 |
| | | protein | | | ferredoxin domain) | |
| MSM0396 | Msp_0233 | conserved hypothetical protein | 2.3E−22 | NONE | | |
| MSM0397 | NONE | | | NONE | | |
| MSM0398 | Msp_1229 | ribose-phosphate | 6.6E−04 | MTH_1114 | uracil | 6.6E−23 |
| | | pyrophosphokinase | | | phosphoribosyltransferase | |
| MSM0399 | NONE | | | NONE | | |
| MSM0400 | NONE | | | NONE | | |
| MSM0401 | NONE | | | MTH_75 | surface protease related | 2.7E−27 |
| | | | | | protein | |
| MSM0402 | Msp_1048 | deoxycytidine triphosphate | 3.5E−76 | MTH_1847 | deoxycytidine | 1.1E−75 |
| | | deaminase | | | triphosphate deaminase | |
| MSM0403 | Msp_1049 | GlyS | 2.1E−188 | MTH_1846 | glycyl-tRNA synthetase | 7.6E−196 |
| MSM0404 | Msp_0799 | predicted transcriptional regulator | 1.6E−25 | MTH_1843 | unknown | 9.1E−26 |
| MSM0405 | Msp_1050 | predicted metal-dependent | 1.7E−58 | MTH_1842 | conserved protein | 2.5E−46 |
| | | hydrolase | | | | |
| MSM0406 | Msp_1052 | hypothetical protein | 1.7E−10 | MTH_1838 | unknown | 6.6E−23 |
| MSM0407 | Msp_1053 | conserved hypothetical | 1.7E−115 | MTH_1837 | unknown | 1.2E−124 |
| | | membrane-spanning protein | | | | |
| MSM0408 | Msp_0406 | 2-phosphoglycerate kinase- | 4.2E−80 | MTH_1835 | 2-phosphoglycerate | 2.3E−91 |
| | | like/predicted small molecule- | | | kinase homolog | |
| | | binding domain fusion | | | | |
| MSM0409 | Msp_0407 | conserved hypothetical protein | 2.2E−42 | MTH_1834 | conserved protein | 9.5E−47 |
| MSM0410 | Msp_0409 | conserved hypothetical protein | 3.9E−52 | MTH_1833 | unknown | 4.6E−47 |
| MSM0411 | Msp_0145 | member of asn/thr-rich large | 1.3E−25 | MTH_1074 | putative membrane | 1.3E−115 |
| | | protein family | | | protein | |
| MSM0412 | Msp_0046 | member of asn/thr-rich large | 1.3E−06 | MTH_117 | unknown | 2.4E−41 |
| | | protein family | | | | |
| MSM0413 | Msp_0512 | predicted transcriptional regulator | 2.7E−21 | MTH_313 | transcriptional regulator | 1.9E−16 |
| MSM0414 | Msp_0824 | predicted Na+-driven multidrug | 2.8E−138 | MTH_314 | conserved protein | 6.7E−110 |
| | | efflux pump | | | | |
| MSM0415 | Msp_1362 | PyrH | 3.5E−76 | MTH_879 | uridine monophosphate | 2.8E−79 |
| | | | | | kinase | |
| MSM0416 | Msp_0974 | predicted Mg-dependent DNase | 1.5E−93 | MTH_233 | conserved protein | 8.0E−27 |
| MSM0417 | Msp_1361 | hypothetical membrane-spanning | 3.8E−15 | MTH_880 | unknown | 3.2E−14 |
| | | protein | | | | |
| MSM0418 | Msp_1045 | conserved hypothetical protein | 2.5E−34 | MTH_507 | conserved protein | 2.5E−32 |
| MSM0419 | Msp_0253 | conserved hypothetical | 1.4E−24 | MTH_506 | unknown | 4.2E−21 |
| | | membrane-spanning protein | | | | |
| MSM0420 | Msp_0355 | conserved hypothetical | 3.0E−22 | MTH_882 | conserved protein | 1.1E−27 |
| | | membrane-spanning protein | | | | |
| MSM0421 | NONE | | | NONE | | |
| MSM0422 | Msp_0644 | conserved hypothetical | 1.1E−36 | MTH_883 | unknown | 6.3E−48 |
| | | membrane-spanning protein | | | | |
| MSM0423 | Msp_0645 | predicted glycosyltransferase | 6.9E−157 | MTH_884 | teichoic acid biosynthesis | 4.5E−184 |
| | | | | | related protein | |
| MSM0424 | Msp_1360 | transcription initiation factor IIB | 8.1E−148 | MTH_885 | transcription initiation | 9.2E−152 |
| | | (TFIIB) | | | factor TFIIB | |
| MSM0425 | Msp_1359 | hypothetical protein | 2.3E−15 | MTH_886 | conserved protein | 3.4E−19 |
| MSM0426 | Msp_1358 | predicted demethylmenaquinone | 3.7E−33 | MTH_888 | conserved protein | 3.2E−46 |
| | | methyltransferase | | | | |
| MSM0427 | Msp_1356 | predicted DNA primase | 7.2E−108 | MTH_891 | conserved protein | 2.9E−141 |
| MSM0428 | Msp_1355 | predicted site-specific | 2.5E−66 | MTH_893 | integrase-recombinase | 7.7E−77 |
| | | recombinase/integrase | | | protein | |
| MSM0429 | Msp_1354 | conserved hypothetical protein | 4.3E−46 | MTH_905 | conserved protein | 1.8E−38 |
| MSM0430 | NONE | | | MTH_906 | unknown | 2.7E−17 |
| MSM0431 | Msp_1132 | predicted ATP-dependent | 1.7E−44 | MTH_947 | conserved protein | 2.8E−40 |
| | | carboligase | | | | |
| MSM0432 | Msp_1131 | hypothetical membrane-spanning | 5.5E−07 | NONE | | |
| | | protein | | | | |
| MSM0433 | Msp_1133 | AhaD | 1.6E−69 | NONE | ATP synthase, subunit D | 1.5E−73 |
| MSM0434 | Msp_1134 | AhaB | 1.4E−212 | NONE | ATP synthase, subunit B | 4.5E−214 |
| MSM0435 | Msp_1135 | AhaA | 1.4E−246 | NONE | ATP synthase, subunit A | 2.8E−260 |
| MSM0436 | Msp_1136 | AhaF | 8.6E−25 | NONE | ATP synthase, subunit F | 3.1E−25 |
| MSM0437 | Msp_1137 | AhaC | 1.5E−105 | NONE | ATP synthase, subunit C | 7.7E−116 |
| MSM0438 | Msp_1138 | AhaE | 3.2E−50 | NONE | ATP synthase, subunit E | 5.9E−54 |
| MSM0439 | Msp_1139 | AhaK | 7.0E−62 | NONE | ATP synthase, subunit K | 9.7E−70 |
| MSM0440 | Msp_1140 | AhaI | 1.9E−148 | NONE | ATP synthase, subunit I | 3.5E−191 |
| MSM0441 | Msp_1141 | AhaH | 7.6E−17 | MTH_961 | unknown | 3.1E−18 |
| MSM0442 | NONE | | | NONE | | |
| MSM0443 | NONE | | | NONE | | |
| MSM0444 | NONE | | | NONE | | |
| MSM0445 | Msp_0408 | putative nitroreductase protein | 2.0E−55 | MTH_120 | NADPH-oxidoreductase | 1.4E−13 |
| MSM0446 | NONE | | | MTH_962 | citrate synthase I | 6.2E−75 |
| MSM0447 | Msp_0338 | fumarate hydratase | 2.6E−15 | NONE | fumarate hydratase, class | 3.8E−75 |
| | | | | | I related protein | |
| MSM0448 | NONE | | | MTH_964 | unknown | 4.6E−102 |
| MSM0449 | NONE | | | MTH_965 | conserved protein | 1.1E−86 |
| MSM0450 | Msp_0680 | conserved hypothetical | 2.4E−38 | NONE | | |
| | | membrane-spanning protein | | | | |
| MSM0451 | Msp_0679 | conserved hypothetical | 7.8E−79 | NONE | | |
| | | membrane-spanning protein | | | | |
| MSM0452 | Msp_1142 | predicted DNA-binding protein | 3.9E−132 | MTH_966 | conserved protein | 1.8E−130 |
| MSM0453 | Msp_1143 | putative transcriptional regulator | 7.5E−58 | MTH_967 | conserved protein | 1.3E−88 |
| MSM0454 | NONE | | | NONE | | |
| MSM0455 | Msp_1144 | conserved hypothetical protein | 2.2E−35 | MTH_969 | unknown | 1.0E−43 |
| MSM0456 | Msp_1005 | conserved hypothetical protein | 2.3E−17 | MTH_544 | conserved protein | 2.7E−35 |
| MSM0457 | Msp_1145 | SerA | 8.8E−158 | MTH_970 | phosphoglycerate | 1.3E−177 |
| | | | | | dehydrogenase | |
| MSM0458 | NONE | | | NONE | | |
| MSM0459 | NONE | | | NONE | | |
| MSM0460 | NONE | | | NONE | | |
| MSM0461 | Msp_0983 | member of asn/thr-rich large | 3.0E−39 | MTH_911 | probable surface protein | 2.9E−18 |
| | | protein family | | | | |
| MSM0462 | Msp_1146 | partially conserved hypothetical | 1.8E−38 | MTH_971 | unknown | 1.0E−33 |
| | | protein | | | | |
| MSM0463 | Msp_1147 | conserved hypothetical protein | 2.0E−57 | MTH_972 | conserved protein | 3.7E−61 |
| MSM0464 | Msp_1148 | predicted dinucleotide-utilizing | 4.0E−59 | MTH_973 | conserved protein | 1.1E−77 |
| | | protein | | | | |
| MSM0465 | Msp_1149 | conserved hypothetical protein | 1.1E−17 | MTH_974 | unknown | 4.1E−23 |
| MSM0466 | Msp_1150 | predicted tRNA-binding protein | 2.4E−68 | MTH_975 | conserved protein | 1.4E−70 |
| MSM0467 | NONE | | | MTH_978 | NADP-dependent | 8.1E−137 |
| | | | | | glyceraldehyde-3- | |
| | | | | | phosphate | |
| | | | | | dehydrogenase | |
| MSM0468 | NONE | | | MTH_1490 | unknown | 2.2E−10 |
| MSM0469 | NONE | | | MTH_1490 | unknown | 1.8E−11 |
| MSM0470 | Msp_1151 | hypothetical membrane-spanning | 1.4E−10 | MTH_979 | unknown | 7.2E−10 |
| | | protein | | | | |
| MSM0471 | Msp_1152 | conserved hypothetical | 7.1E−53 | MTH_980 | conserved protein | 5.9E−70 |
| | | membrane-spanning protein | | | | |
| MSM0472 | Msp_1153 | PepQ | 2.7E−69 | MTH_981 | aminopeptidase P | 1.0E−65 |
| MSM0473 | Msp_0417 | hypothetical membrane-spanning | 2.5E−04 | NONE | | |
| | | protein | | | | |
| MSM0474 | NONE | | | NONE | | |
| MSM0475 | Msp_0417 | hypothetical membrane-spanning | 1.8E−04 | NONE | | |
| | | protein | | | | |
| MSM0476 | NONE | | | MTH_93 | unknown | 8.5E−04 |
| MSM0477 | NONE | | | NONE | | |
| MSM0478 | NONE | | | NONE | | |
| MSM0479 | Msp_1154 | conserved hypothetical | 2.4E−45 | MTH_986 | conserved protein | 2.1E−42 |
| | | membrane-spanning protein | | | | |
| MSM0480 | Msp_1155 | conserved hypothetical protein | 2.3E−95 | MTH_987 | conserved protein | 6.0E−109 |
| MSM0481 | Msp_1274 | conserved hypothetical protein | 4.4E−53 | MTH_989 | conserved protein | 2.2E−24 |
| MSM0482 | Msp_1275 | predicted ATP-utilizing enzyme | 4.6E−58 | MTH_990 | conserved protein | 2.6E−51 |
| MSM0483 | NONE | | | MTH_991 | unknown | 8.6E−14 |
| MSM0484 | Msp_1276 | conserved hypothetical protein | 9.2E−76 | MTH_992 | inosine-5′- | 2.8E−86 |
| | | | | | monophosphate | |
| | | | | | dehydrogenase related | |
| | | | | | protein IX | |
| MSM0485 | Msp_1410 | predicted universal stress protein | 9.6E−26 | MTH_993 | conserved protein | 1.0E−33 |
| MSM0486 | Msp_1199 | predicted metal-dependent | 3.1E−84 | MTH_994 | N-ethylammeline | 4.2E−85 |
| | | hydrolase | | | chlorohydrolase related | |
| | | | | | protein | |
| MSM0487 | NONE | | | NONE | | |
| MSM0488 | Msp_1200 | CarB | 0.0E+00 | NONE | carbamoyl-phosphate | 0.0E+00 |
| | | | | | synthase, large subunit | |
| MSM0489 | Msp_1201 | CarA | 1.5E−121 | NONE | carbamoyl-phosphate | 6.0E−125 |
| | | | | | synthase, small subunit | |
| MSM0490 | Msp_0602 | conserved hypothetical protein | 1.0E−28 | MTH_738 | conserved protein | 3.0E−06 |
| MSM0491 | Msp_0410 | NadC | 2.0E−64 | MTH_1832 | quinolinate | 7.7E−61 |
| | | | | | phosphoribosyltransferase | |
| MSM0492 | Msp_0411 | putative ribonuclease Z | 1.7E−76 | MTH_1831 | conserved protein | 2.6E−92 |
| MSM0493 | Msp_0982 | predicted mechanosensitive ion | 6.7E−25 | MTH_1830 | conserved protein | 1.7E−40 |
| | | channel | | | | |
| MSM0494 | Msp_0643 | NadA | 3.6E−90 | MTH_1827 | quinolinate synthetase | 6.8E−101 |
| MSM0495 | NONE | | | MTH_1821 | unknown | 2.7E−19 |
| MSM0496 | Msp_1526 | putative homoserine O- | 1.2E−84 | MTH_1820 | homoserine O- | 1.3E−67 |
| | | acetyltransferase | | | acetyltransferase | |
| MSM0497 | Msp_0157 | hypothetical protein | 6.9E−55 | MTH_1816 | conserved protein | 2.6E−76 |
| MSM0498 | NONE | | | NONE | | |
| MSM0499 | Msp_1548 | hypothetical protein | 1.0E−05 | MTH_1277 | unknown | 1.8E−06 |
| MSM0500 | Msp_0155 | predicted amidohydrolase | 3.1E−75 | MTH_1811 | N-carbamoyl-D-amino | 3.7E−77 |
| | | | | | acid amidohydrolase | |
| MSM0501 | Msp_0153 | conserved hypothetical protein | 1.8E−31 | MTH_1806 | phycocyanin alpha | 8.1E−34 |
| | | | | | phycocyanobilin lyase | |
| | | | | | CpcE | |
| MSM0502 | Msp_0150 | predicted helicase | 2.9e−310 | MTH_1802 | ATP-dependent helicase | 0.0E+00 |
| MSM0503 | Msp_0553 | hypothetical protein | 9.4E−19 | MTH_1799 | unknown | 3.9E−18 |
| MSM0504 | Msp_0927 | hypothetical protein | 2.1E−05 | MTH_1641 | unknown | 1.4E−06 |
| MSM0505 | NONE | | | NONE | | |
| MSM0506 | Msp_0240 | predicted ATP-utilizing enzyme | 3.0E−148 | MTH_1201 | conserved protein | 3.4E−145 |
| MSM0507 | Msp_0365 | predicted phosphoesterase | 6.0E−49 | MTH_1774 | conserved protein | 2.9E−52 |
| MSM0508 | Msp_0364 | putative 23S rRNA methylase | 1.9E−61 | MTH_1773 | cell division protein J | 5.9E−70 |
| MSM0509 | Msp_0363 | hypothetical membrane-spanning | 1.4E−24 | MTH_1772 | unknown | 9.1E−26 |
| | | protein | | | | |
| MSM0510 | Msp_0362 | predicted minichromosome | 1.4E−255 | MTH_1770 | DNA replication initiator | 1.4E−260 |
| | | maintenance protein | | | (Cdc21/Cdc54) | |
| MSM0511 | Msp_0361 | translation initiation factor alF-2, | 2.3E−54 | NONE | translation initiation factor | 6.9E−60 |
| | | beta subunit (elF2B) | | | elF-2, beta subunit | |
| MSM0512 | Msp_0360 | predicted NMD3-related protein | 5.2E−73 | MTH_1768 | conserved protein | 2.1E−90 |
| MSM0513 | Msp_0359 | TyrS | 2.4E−100 | MTH_1767 | tyrosyl-tRNA synthetase | 1.1E−109 |
| MSM0514 | Msp_0358 | hypothetical protein | 3.5E−05 | MTH_1766 | unknown | 1.1E−08 |
| MSM0515 | Msp_0186 | MtaB2 | 1.3E−156 | NONE | | |
| MSM0516 | Msp_0185 | MtaC3 | 5.2E−89 | NONE | | |
| MSM0517 | Msp_0190 | MapA | 8.7E−167 | MTH_278 | ferredoxin | 7.0E−04 |
| MSM0518 | Msp_0112 | MtaA2 | 2.1E−94 | MTH_775 | cobalamin-independent | 3.4E−05 |
| | | | | | methionine synthase | |
| MSM0519 | Msp_0183 | hypothetical protein | 1.2E−32 | NONE | | |
| MSM0520 | Msp_0357 | putative thymidylate kinase | 2.1E−46 | MTH_1765 | thymidylate kinase | 7.5E−47 |
| MSM0521 | NONE | | | NONE | | |
| MSM0522 | Msp_0984 | predicted peptidase | 2.7E−234 | MTH_1763 | collagenase | 3.4E−99 |
| MSM0523 | Msp_0984 | predicted peptidase | 1.6E−96 | MTH_1763 | collagenase | 6.8E−108 |
| MSM0524 | Msp_0354 | MutS | 4.3E−133 | MTH_1762 | DNA mismatch | 1.9E−176 |
| | | | | | recognition protein MutS | |
| MSM0525 | Msp_1282 | predicted protein kinase | 1.8E−104 | MTH_1645 | ABC transporter | 3.1E−112 |
| MSM0526 | NONE | | | NONE | | |
| MSM0527 | Msp_0017 | conserved hypothetical protein | 3.5E−28 | NONE | | |
| MSM0528 | Msp_0233 | conserved hypothetical protein | 1.4E−10 | NONE | | |
| MSM0529 | Msp_0725 | hypothetical protein | 1.0E−04 | NONE | | |
| MSM0530 | Msp_1323 | conserved hypothetical protein | 3.3E−04 | MTH_72 | O-linked GlcNAc | 5.5E−06 |
| | | | | | transferase | |
| MSM0531 | NONE | | | NONE | | |
| MSM0532 | Msp_0233 | conserved hypothetical protein | 3.4E−08 | NONE | | |
| MSM0533 | Msp_0017 | conserved hypothetical protein | 3.1E−16 | NONE | | |
| MSM0534 | NONE | | | NONE | | |
| MSM0535 | Msp_0466 | hypothetical protein | 7.1E−05 | NONE | | |
| MSM0536 | NONE | | | NONE | | |
| MSM0537 | NONE | | | NONE | | |
| MSM0538 | Msp_1324 | predicted glycyl radical activating | 5.1E−07 | MTH_1586 | pyruvate formate-lyase | 1.3E−05 |
| | | enzyme | | | activating enzyme | |
| MSM0539 | Msp_0219 | conserved hypothetical protein | 3.1E−04 | NONE | | |
| MSM0540 | NONE | | | NONE | | |
| MSM0541 | NONE | | | NONE | | |
| MSM0542 | Msp_1128 | F420-dependent N5,N10- | 3.4E−94 | NONE | coenzyme F420- | 1.4E−132 |
| | | methylenetetrahydromethanopterin | | | dependent N5,N10- | |
| | | reductase | | | methylene | |
| | | | | | tetrahydromethanopterin | |
| | | | | | reductase | |
| MSM0543 | Msp_0646 | predicted DNA repair photolyase | 9.3E−28 | NONE | | |
| MSM0544 | Msp_1127 | predicted Fe—S oxidoreductase | 4.4E−92 | MTH_1751 | conserved protein | 1.3E−90 |
| MSM0545 | NONE | | | NONE | | |
| MSM0546 | Msp_1046 | hypothetical membrane-spanning | 2.6E−23 | MTH_813 | unknown | 2.4E−27 |
| | | protein | | | | |
| MSM0547 | Msp_0324 | predicted nucleotidyltransferase | 1.6E−08 | MTH_1749 | unknown | 7.2E−81 |
| MSM0548 | Msp_1148 | predicted dinucleotide-utilizing | 4.4E−04 | MTH_1747 | conserved protein | 5.4E−37 |
| | | protein | | | | |
| MSM0549 | Msp_0830 | Trk-type potassium transport | 3.9E−04 | MTH_1746 | cytochrome C-type | 2.1E−28 |
| | | system, membrane protein | | | biogenesis protein | |
| MSM0550 | Msp_0656 | hypothetical membrane-spanning | 2.0E−04 | MTH_1745 | protein disulphide | 7.9E−20 |
| | | protein | | | isomerase | |
| MSM0551 | Msp_1124 | conserved hypothetical protein | 1.9E−68 | MTH_1744 | conserved protein | 2.4E−73 |
| MSM0552 | Msp_0330 | hypothetical protein | 4.6E−10 | MTH_1743 | unknown | 8.9E−12 |
| MSM0553 | Msp_0331 | predicted ATPase | 3.5E−92 | MTH_1742 | conserved protein | 1.2E−80 |
| MSM0554 | Msp_0161 | conserved hypothetical protein | 2.8E−74 | MTH_1815 | conserved protein | 2.6E−83 |
| MSM0555 | Msp_0192 | predicted MoxR-like ATPase | 3.9E−93 | MTH_1814 | conserved protein | 1.9E−87 |
| MSM0556 | Msp_0333 | predicted pterin-binding enzyme | 4.1E−121 | MTH_1741 | conserved protein | 1.1E−153 |
| MSM0557 | Msp_0334 | PorC | 2.1E−53 | NONE | pyruvate oxidoreductase, | 2.1E−65 |
| | | | | | gamma subunit | |
| MSM0558 | Msp_0335 | PorD | 4.3E−30 | NONE | pyruvate oxidoreductase, | 1.2E−32 |
| | | | | | gamma subunit | |
| MSM0559 | Msp_0336 | PorA | 2.1E−140 | NONE | pyruvate oxidoreductase, | 2.3E−148 |
| | | | | | alpha subunit | |
| MSM0560 | Msp_0337 | PorB | 1.8E−118 | NONE | pyruvate oxidoreductase, | 2.2E−127 |
| | | | | | beta subunit | |
| MSM0561 | Msp_1447 | EhbK | 8.6E−08 | NONE | formate hydrogenlyase, | 4.5E−40 |
| | | | | | iron-sulfur subunit I | |
| MSM0562 | Msp_1447 | EhbK | 4.0E−09 | NONE | formate hydrogenlyase, | 5.3E−14 |
| | | | | | iron-sulfur subunit 2 | |
| MSM0563 | Msp_0338 | fumarate hydratase | 3.3E−96 | NONE | fumarate hydratase, class I | 8.3E−96 |
| MSM0564 | Msp_0339 | predicted phosphate uptake | 4.8E−31 | MTH_1734 | phosphate transport | 2.8E−47 |
| | | regulator | | | system regulator | |
| MSM0565 | Msp_0340 | PstB | 4.0E−107 | MTH_1731 | phosphate transport | 1.5E−105 |
| | | | | | system ATP-binding | |
| MSM0566 | Msp_0341 | PstA | 1.3E−94 | MTH_1730 | phosphate transporter | 4.5E−111 |
| | | | | | permease PstC homolog | |
| MSM0567 | Msp_0342 | PstC | 7.0E−94 | MTH_1729 | phosphate transporter | 4.8E−100 |
| | | | | | permease PstC | |
| MSM0568 | Msp_0343 | PstS | 1.6E−64 | MTH_1727 | phosphate-binding protein | 2.7E−81 |
| | | | | | PstS | |
| MSM0569 | Msp_0344 | predicted phosphate uptake | 5.5E−62 | MTH_1724 | phosphate transport | 2.4E−82 |
| | | regulator | | | system regulator related | |
| | | | | | protein | |
| MSM0570 | Msp_0346 | conserved hypothetical | 5.2E−17 | MTH_1723 | unknown | 9.1E−26 |
| | | membrane-spanning protein | | | | |
| MSM0571 | NONE | | | MTH_1137 | conserved protein (FlpA) | 5.2E−165 |
| MSM0572 | NONE | | | NONE | H(2)-dependent N5,N10- | 2.4E−128 |
| | | | | | methylenetetrahydromethanopterin | |
| | | | | | dehydrogenase | |
| MSM0573 | Msp_0296 | CofG | 1.4E−15 | MTH_1143 | biotin synthetase (BioB) | 5.1E−112 |
| MSM0574 | NONE | | | MTH_1144 | conserved protein | 2.9E−38 |
| MSM0575 | Msp_1393 | conserved hypothetical | 8.5E−05 | MTH_1145 | conserved protein | 2.9E−38 |
| | | membrane-spanning protein | | | | |
| MSM0576 | NONE | | | MTH_1146 | conserved protein | 2.9E−38 |
| MSM0577 | NONE | | | MTH_1147 | conserved protein | 6.1E−52 |
| MSM0578 | NONE | | | MTH_1148 | conserved protein | 8.1E−34 |
| MSM0579 | Msp_1581 | partially conserved hypothetical | 7.5E−10 | MTH_1106 | ferredoxin | 1.3E−10 |
| | | protein | | | | |
| MSM0580 | Msp_0911 | member of asn/thr-rich large | 2.5E−05 | MTH_654 | unknown | 5.2E−39 |
| | | protein family | | | | |
| MSM0581 | Msp_0166 | conserved hypothetical | 3.9E−29 | MTH_655 | conserved protein | 6.7E−94 |
| | | membrane-spanning protein | | | | |
| MSM0582 | Msp_0737 | putative peptide methionine | 4.5E−122 | MTH_535 | peptide methionine | 2.4E−34 |
| | | sulfoxide reductase MsrA/MsrB | | | sulfoxide reductase | |
| MSM0583 | Msp_0655 | CbiM2 | 2.7E−69 | MTH_1707 | cobalamin biosynthesis | 1.5E−64 |
| | | | | | protein M | |
| MSM0584 | Msp_0656 | hypothetical membrane-spanning | 2.2E−12 | MTH_1706 | unknown | 3.4E−12 |
| | | protein | | | | |
| MSM0585 | Msp_0657 | CbiQ2 | 5.4E−55 | MTH_1705 | cobalt transport | 4.2E−60 |
| | | | | | membrane protein | |
| MSM0586 | Msp_0401 | CbiO1 | 7.6E−81 | MTH_1704 | cobalt transport ATP- | 1.2E−85 |
| | | | | | binding protein O | |
| MSM0587 | Msp_1438 | hypothetical protein | 5.9E−10 | NONE | | |
| MSM0588 | Msp_1441 | FeoA | 1.7E−12 | MTH_1362 | unknown | 2.4E−11 |
| MSM0589 | Msp_1440 | FeoB | 3.6E−200 | MTH_1361 | ferrous iron transport | 5.7E−152 |
| | | | | | protein B | |
| MSM0590 | NONE | | | NONE | | |
| MSM0591 | NONE | | | NONE | | |
| MSM0592 | Msp_0202 | conserved hypothetical | 2.3E−40 | MTH_230 | unknown | 1.2E−48 |
| | | membrane-spanning protein | | | | |
| MSM0593 | Msp_0610 | predicted ABC-type multidrug | 3.9E−77 | MTH_1487 | ABC transporter (ATP- | 2.0E−37 |
| | | transport system, ATP-binding | | | binding | |
| | | protein | | | | |
| MSM0594 | Msp_0609 | conserved hypothetical | 2.7E−44 | NONE | | |
| | | membrane-spanning protein | | | | |
| MSM0595 | Msp_0609 | conserved hypothetical | 1.8E−40 | NONE | | |
| | | membrane-spanning protein | | | | |
| MSM0596 | Msp_1163 | predicted type II secretion protein F | 3.0E−47 | MTH_1703 | unknown | 4.9E−59 |
| MSM0597 | Msp_1162 | predicted type II/IV secretion | 4.1E−121 | MTH_1702 | secretory protein kinase | 2.9E−157 |
| | | protein | | | | |
| MSM0598 | Msp_1161 | conserved hypothetical protein | 3.5E−44 | MTH_1701 | unknown | 5.6E−42 |
| MSM0599 | Msp_1160 | conserved hypothetical | 1.3E−94 | MTH_1700 | conserved protein | 8.9E−99 |
| | | membrane-spanning protein | | | | |
| MSM0600 | Msp_0512 | predicted transcriptional regulator | 7.9E−15 | MTH_313 | transcriptional regulator | 5.5E−12 |
| MSM0601 | Msp_0017 | conserved hypothetical protein | 1.7E−28 | NONE | | |
| MSM0602 | Msp_1159 | elongation factor 1-beta (aEF- | 2.2E−26 | MTH_1699 | translation elongation | 1.3E−28 |
| | | 1beta) (ef1B) | | | factor EF-1b | |
| MSM0603 | Msp_1158 | predicted Zn-ribbon RNA-binding | 4.7E−17 | MTH_1178 | conserved protein | 8.3E−04 |
| | | protein | | | | |
| MSM0604 | Msp_1157 | predicted amino acid kinase | 1.7E−42 | MTH_1698 | delta 1-pyrroline-5- | 6.2E−43 |
| | | | | | carboxylate synthetase | |
| MSM0605 | Msp_1156 | putative peptidyl-tRNA hydrolase | 1.5E−29 | MTH_1697 | conserved protein | 1.1E−36 |
| MSM0606 | NONE | | | NONE | | |
| MSM0607 | Msp_0613 | predicted ATPase | 4.1E−224 | MTH_1695 | RNase L inhibitor | 6.8E−227 |
| MSM0608 | NONE | | | NONE | | |
| MSM0609 | Msp_0147 | ferredoxin | 2.6E−04 | MTH_221 | unknown | 6.4E−25 |
| MSM0610 | Msp_0370 | putative aspartate | 8.5E−121 | MTH_1694 | aspartate | 9.6E−134 |
| | | aminotransferase | | | aminotransferase related | |
| | | | | | protein | |
| MSM0611 | Msp_0369 | RadB | 3.9E−61 | MTH_1693 | DNA repair protein Rad51 | 3.6E−63 |
| | | | | | homolog | |
| MSM0612 | Msp_0096 | conserved hypothetical protein | 1.9E−36 | MTH_1692 | conserved protein | 3.8E−43 |
| MSM0613 | Msp_0095 | predicted | 1.0E−46 | MTH_1691 | conserved protein | 4.3E−44 |
| | | phosphatidylglycerophosphate | | | | |
| | | synthase | | | | |
| MSM0614 | Msp_0094 | conserved hypothetical protein | 2.1E−14 | MTH_1690 | unknown | 1.7E−17 |
| MSM0615 | Msp_0675 | conserved hypothetical protein | 4.7E−159 | MTH_1686 | conserved protein | 7.7E−164 |
| MSM0616 | Msp_0440 | member of asn/thr-rich large | 1.1E−93 | MTH_716 | cell surface glycoprotein | 1.4E−14 |
| | | protein family | | | (s-layer protein) | |
| MSM0617 | Msp_0160 | Thil | 1.4E−102 | MTH_1685 | conserved protein | 1.1E−118 |
| MSM0618 | Msp_1489 | predicted potassium transport | 3.0E−09 | MTH_760 | Na+/H+-exchanging | 2.3E−16 |
| | | system, membrane component | | | protein:Na+/H+ antiporter | |
| MSM0619 | Msp_1262 | AlaS | 7.0E−300 | MTH_1683 | alanyl-tRNA synthetase | 1.5e−316 |
| MSM0620 | Msp_1263 | 50S ribosomal protein L12P | 1.9E−36 | MTH_1682 | ribosomal protein Lp1 | 9.4E−40 |
| MSM0621 | Msp_1264 | 50S ribosomal protein L10P | 5.3E−96 | MTH_1681 | ribosomal protein Lp0 | 2.7E−106 |
| | | | | | (E. coli) | |
| MSM0622 | Msp_1265 | 50S ribosomal protein L1P | 9.5E−74 | MTH_1680 | ribosomal protein L10a | 1.3E−81 |
| | | | | | (E. coli) | |
| MSM0623 | Msp_1266 | 50S ribosomal protein L11P | 1.3E−62 | MTH_1679 | ribosomal protein L12 | 2.2E−63 |
| | | | | | (E. coli) | |
| MSM0624 | Msp_1267 | putative transcription | 1.3E−46 | MTH_1678 | transcription termination | 1.1E−61 |
| | | antiterminator | | | factor NusG | |
| MSM0625 | Msp_1268 | partially conserved hypothetical | 1.3E−12 | MTH_1677 | protein translocation | 1.1E−13 |
| | | membrane-spanning protein | | | complex sec61 gamma | |
| | | | | | subunit related protein | |
| MSM0626 | Msp_1269 | FtsZ | 8.7E−135 | MTH_1676 | cell division protein FtsZ | 1.7E−143 |
| MSM0627 | Msp_0307 | MtrH | 8.5E−105 | MTH_1156 | N5-methyl- | 3.7E−116 |
| | | | | | tetrahydromethanopterin: | |
| | | | | | coenzyme M | |
| | | | | | methyltransferase, | |
| | | | | | subunit H | |
| MSM0628 | NONE | | | MTH_1675 | conserved protein | 7.2E−49 |
| MSM0629 | Msp_0017 | conserved hypothetical protein | 1.7E−28 | NONE | | |
| MSM0630 | Msp_1271 | conserved hypothetical protein | 7.1E−69 | MTH_1670 | conserved protein | 4.2E−76 |
| MSM0631 | Msp_1272 | predicted transcription initiation | 3.4E−37 | MTH_1669 | conserved protein | 4.6E−47 |
| | | factor IIE, alpha subunit | | | | |
| MSM0632 | Msp_1273 | conserved hypothetical protein | 6.2E−38 | MTH_1668 | conserved protein | 1.7E−40 |
| MSM0633 | Msp_1063 | predicted RNA-binding protein | 9.2E−92 | MTH_1665 | conserved protein | 6.9E−92 |
| MSM0634 | Msp_1064 | conserved hypothetical protein | 1.8E−24 | MTH_1664 | conserved protein | 6.2E−27 |
| MSM0635 | Msp_1069 | predicted regulator of aminoacid | 1.6E−41 | MTH_1654 | unknown | 1.8E−45 |
| | | metabolism | | | | |
| MSM0636 | Msp_1067 | hypothetical protein | 1.6E−23 | MTH_1649 | hydrogenase | 1.2E−25 |
| | | | | | expression/formation | |
| | | | | | protein HypC | |
| MSM0637 | Msp_1077 | predicted dihydrolipoamide | 2.4E−93 | MTH_1648 | dihydrolipoamide | 1.2E−92 |
| | | dehydrogenase-related protein | | | dehydrogenase | |
| MSM0638 | Msp_1343 | hypothetical membrane-spanning | 2.6E−78 | MTH_1646 | unknown | 5.9E−54 |
| | | multicopy protein A 3 | | | | |
| MSM0639 | Msp_1080 | conserved hypothetical | 4.5E−67 | MTH_1644 | unknown | 1.8E−52 |
| | | membrane-spanning protein | | | | |
| MSM0640 | Msp_1081 | predicted release factor aRF1 | 2.2E−106 | MTH_1642 | cell division protein | 9.6E−118 |
| MSM0641 | Msp_1083 | putative prephenate | 4.4E−92 | MTH_1640 | chorismate mutase | 1.8E−100 |
| | | dehydrogenase | | | | |
| MSM0642 | Msp_1084 | CdcH | 9.3E−273 | MTH_1639 | cell division control | 4.7E−299 |
| | | | | | protein Cdc48 | |
| MSM0643 | Msp_0227 | conserved hypothetical protein | 3.3E−71 | MTH_1574 | conserved protein | 5.2E−78 |
| MSM0644 | Msp_0228 | ThiC1 | 1.2E−144 | MTH_1576 | thiamine biosynthesis | 3.2E−158 |
| | | | | | protein | |
| MSM0645 | Msp_0258 | ATP-dependent DNA ligase | 1.1E−148 | MTH_1580 | DNA ligase | 3.9E−176 |
| MSM0646 | Msp_0504 | conserved hypothetical | 5.5E−30 | NONE | | |
| | | membrane-spanning protein | | | | |
| MSM0647 | Msp_0259 | hypothetical protein | 3.8E−15 | MTH_1581 | conserved protein | 4.8E−20 |
| MSM0648 | Msp_0263 | predicted phosphomannomutase | 1.2E−169 | MTH_1584 | phosphomannomutase | 9.9E−171 |
| MSM0649 | Msp_0970 | hypothetical membrane-spanning | 3.5E−44 | MTH_559 | conserved protein | 1.0E−06 |
| | | protein | | | | |
| MSM0650 | Msp_0971 | hypothetical protein | 1.2E−36 | MTH_1787 | conserved protein | 1.3E−07 |
| MSM0651 | Msp_1323 | conserved hypothetical protein | 1.5E−98 | MTH_1585 | O-linked GlcNAc | 1.9E−105 |
| | | | | | transferase | |
| MSM0652 | Msp_1324 | predicted glycyl radical activating | 6.3E−45 | MTH_1586 | pyruvate formate-lyase | 1.5E−50 |
| | | enzyme | | | activating enzyme | |
| MSM0653 | Msp_1326 | HisC | 2.5E−112 | MTH_1587 | histidinol-phosphate | 1.2E−119 |
| | | | | | aminotransferase | |
| MSM0654 | Msp_1325 | predicted carbonic | 1.8E−47 | MTH_1588 | ferripyochelin binding | 4.6E−47 |
| | | anhydrase/acetyltransferase | | | protein | |
| MSM0655 | Msp_1301 | predicted nucleoside- | 3.0E−134 | MTH_1589 | glucose-1-phosphate | 8.1E−137 |
| | | diphosphate-sugar | | | thymidylyltransferase | |
| | | pyrophosphorylase | | | homolog | |
| MSM0656 | Msp_1300 | predicted phosphomannomutase | 9.7E−136 | MTH_1590 | phosphomannomutase | 7.6E−141 |
| MSM0657 | Msp_1299 | ApgM2 | 6.1E−150 | MTH_1591 | phosphonopyruvate | 6.0E−148 |
| | | | | | decarboxylase | |
| MSM0658 | NONE | | | NONE | | |
| MSM0659 | Msp_1298 | conserved hypothetical | 4.8E−63 | MTH_1592 | conserved protein | 1.1E−77 |
| | | membrane-spanning protein | | | | |
| MSM0660 | Msp_1568 | conserved hypothetical | 3.9E−52 | NONE | | |
| | | membrane-spanning protein | | | | |
| MSM0661 | Msp_1297 | 30S ribosomal protein S3Ae | 3.2E−66 | MTH_1593 | ribosomal protein S3a | 8.4E−71 |
| MSM0662 | Msp_0712 | hypothetical membrane-spanning | 8.9E−07 | NONE | | |
| | | protein | | | | |
| MSM0663 | Msp_1295 | predicted iron-molybdenum | 1.4E−08 | MTH_1594 | conserved protein | 1.2E−16 |
| | | cluster-binding protein | | | | |
| MSM0664 | Msp_0540 | predicted multimeric flavodoxin | 2.4E−22 | MTH_1595 | conserved protein | 5.0E−57 |
| MSM0665 | Msp_0642 | predicted purine nucleoside | 7.4E−74 | MTH_1596 | methylthioadenosine | 3.7E−77 |
| | | phosphorylase | | | phosphorylase | |
| MSM0666 | Msp_0641 | conserved hypothetical | 6.7E−176 | MTH_1597 | conserved protein | 3.5E−184 |
| | | membrane-spanning protein | | | | |
| MSM0667 | Msp_0587 | hypothetical membrane-spanning | 1.8E−05 | MTH_520 | unknown | 3.7E−13 |
| | | protein | | | | |
| MSM0668 | Msp_0637 | conserved hypothetical protein | 4.9E−22 | MTH_1598 | conserved protein | 5.8E−40 |
| MSM0669 | NONE | | | NONE | | |
| MSM0670 | NONE | | | NONE | | |
| MSM0671 | Msp_0635 | cell division control protein 6-like 2 | 2.7E−108 | MTH_1599 | Cdc6 related protein | 5.4E−131 |
| MSM0672 | Msp_0661 | conserved hypothetical protein | 1.4E−56 | MTH_1600 | conserved protein | 7.0E−67 |
| MSM0673 | Msp_1557 | conserved hypothetical | 5.1E−27 | NONE | | |
| | | membrane-spanning protein | | | | |
| MSM0674 | NONE | | | NONE | | |
| MSM0675 | NONE | | | NONE | | |
| MSM0676 | Msp_1557 | conserved hypothetical | 9.7E−33 | NONE | | |
| | | membrane-spanning protein | | | | |
| MSM0677 | Msp_0662 | putative aspartate | 1.3E−131 | MTH_1601 | aspartate | 7.3E−136 |
| | | aminotransferase | | | aminotransferase | |
| MSM0678 | Msp_0505 | conserved hypothetical | 8.1E−29 | MTH_519 | unknown | 1.1E−20 |
| | | membrane-spanning protein | | | | |
| MSM0679 | Msp_0587 | hypothetical membrane-spanning | 8.1E−12 | MTH_520 | unknown | 8.1E−34 |
| | | protein | | | | |
| MSM0680 | Msp_0757 | predicted ATPase | 2.4E−109 | NONE | | |
| MSM0681 | NONE | | | NONE | | |
| MSM0682 | NONE | | | NONE | | |
| MSM0683 | Msp_0380 | hypothetical protein | 3.1E−13 | MTH_626 | unknown | 9.7E−22 |
| MSM0684 | Msp_0381 | hypothetical membrane-spanning | 1.2E−09 | MTH_625 | unknown | 1.5E−04 |
| | | protein | | | | |
| MSM0685 | NONE | | | NONE | | |
| MSM0686 | Msp_0605 | predicted thiamine | 2.1E−94 | NONE | acetolactate synthase, | 8.5E−94 |
| | | pyrophosphate-requiring enzyme | | | large subunit homolog | |
| MSM0687 | Msp_0604 | predicted deoxycytidine | 1.6E−57 | MTH_1605 | deoxycytidine- | 8.2E−57 |
| | | triphosphate deaminase | | | triphosphate deaminase | |
| | | | | | related protein | |
| MSM0688 | Msp_1409 | predicted tautomerase | 3.2E−11 | MTH_1606 | unknown | 1.7E−08 |
| MSM0689 | NONE | | | NONE | | |
| MSM0690 | Msp_0767 | predicted helicase | 2.1E−243 | NONE | ATP-dependent RNA | 9.5E−09 |
| | | | | | helicase, elF-4A family | |
| MSM0691 | Msp_0006 | predicted NUDIX-related protein | 1.4E−40 | MTH_1336 | mutator MutT protein | 4.1E−14 |
| | | | | | homolog | |
| MSM0692 | NONE | | | NONE | | |
| MSM0693 | Msp_0113 | conserved hypothetical protein | 1.4E−13 | MTH_540 | intracellular protein | 7.2E−10 |
| | | | | | transport protein | |
| MSM0694 | NONE | | | NONE | | |
| MSM0695 | Msp_0767 | predicted helicase | 1.0E−13 | NONE | ATP-dependent RNA | 3.7E−10 |
| | | | | | helicase, elF-4A family | |
| MSM0696 | Msp_1095 | DNA double-strand break repair | 4.0E−04 | NONE | | |
| | | protein Rad50 | | | | |
| MSM0697 | NONE | | | NONE | | |
| MSM0698 | NONE | | | NONE | | |
| MSM0699 | Msp_0738 | predicted Na+-dependent | 4.1E−137 | MTH_1909 | unknown | 5.8E−04 |
| | | transporter | | | | |
| MSM0700 | Msp_0921 | putative poly-gamma-glutamate | 1.0E−108 | NONE | | |
| | | biosynthesis protein | | | | |
| MSM0701 | Msp_0601 | partially conserved hypothetical | 2.4E−116 | MTH_1608 | signal recognition particle | 3.6E−111 |
| | | protein, predicted GTPase | | | protein (docking protein) | |
| MSM0702 | Msp_0600 | conserved hypothetical protein | 1.5E−20 | MTH_1609 | conserved protein | 1.1E−36 |
| MSM0703 | Msp_0599 | RplX | 4.1E−18 | MTH_1610 | ribosomal protein L18a | 1.0E−17 |
| MSM0704 | Msp_0598 | translation initiation factor 6 (alF- | 3.7E−56 | MTH_1611 | conserved protein | 3.8E−59 |
| | | 6) | | | | |
| MSM0705 | Msp_0597 | 50S ribosomal protein L31e | 1.4E−22 | MTH_1612 | ribosomal protein L31 | 4.7E−29 |
| MSM0706 | NONE | | | MTH_1613 | ribosomal protein L39 | 1.2E−16 |
| MSM0707 | Msp_0596 | predicted subunit of tRNA | 2.8E−58 | MTH_1614 | conserved protein | 3.8E−59 |
| | | methyltransferase | | | | |
| MSM0708 | Msp_0595 | partially conserved hypothetical | 1.4E−31 | MTH_1615 | conserved protein | 3.1E−32 |
| | | protein | | | | |
| MSM0709 | Msp_0594 | 30S ribosomal protein S19e | 1.5E−52 | MTH_1616 | ribosomal protein S19 | 5.9E−54 |
| MSM0710 | Msp_0593 | hypothetical protein | 1.3E−28 | MTH_1617 | conserved protein | 1.3E−19 |
| MSM0711 | Msp_0592 | putative ribonuclease P, subunit 4 | 8.7E−32 | MTH_1618 | conserved protein | 3.0E−34 |
| MSM0712 | NONE | | | NONE | | |
| MSM0713 | Msp_0589 | predicted nucleotide kinase | 3.1E−36 | MTH_1619 | conserved protein | 2.4E−34 |
| | | | | | (adenylate kinase | |
| | | | | | related) | |
| MSM0714 | Msp_0660 | predicted GTPase | 2.1E−46 | NONE | GTP-binding protein, | 3.9E−50 |
| | | | | | GTP1/OBG family | |
| MSM0715 | Msp_0660 | predicted GTPase | 2.4E−77 | NONE | GTP-binding protein, | 1.2E−87 |
| | | | | | GTP1/OBG family | |
| MSM0716 | Msp_0368 | conserved hypothetical | 1.1E−141 | MTH_1623 | oligosaccharyl | 7.3E−88 |
| | | membrane-spanning protein | | | transferase STT3 subunit | |
| | | | | | related protein | |
| MSM0717 | Msp_0366 | TopA | 8.0E−228 | MTH_1624 | DNA topoisomerase I | 3.1E−247 |
| MSM0718 | NONE | | | MTH_1625 | unknown | 4.6E−15 |
| MSM0719 | Msp_1096 | putative phosphoserine | 2.7E−124 | MTH_1626 | phosphoserine | 1.3E−83 |
| | | phosphatase | | | phosphatase | |
| MSM0720 | Msp_1097 | TATA-box binding protein | 5.0E−68 | MTH_1627 | TATA-binding | 1.2E−73 |
| | | | | | transcription initiation | |
| | | | | | factor | |
| MSM0721 | Msp_1098 | predicted adenylate cyclase | 2.6E−39 | MTH_1629 | conserved protein | 1.3E−42 |
| MSM0722 | Msp_1099 | LeuA2 | 1.9E−91 | MTH_1630 | 2-isopropylmalate | 1.5E−151 |
| | | | | | synthase | |
| MSM0723 | Msp_1100 | LeuC2 | 2.7E−140 | NONE | 3-isopropylmalate | 5.8E−150 |
| | | | | | dehydratase, LeuC | |
| | | | | | subunit | |
| MSM0724 | Msp_0326 | hypothetical protein | 9.1E−04 | MTH_1632 | conserved protein | 1.0E−40 |
| MSM0725 | Msp_1086 | flap structure-specific | 9.2E−92 | MTH_1633 | DNA repair protein Rad2 | 7.8E−100 |
| | | endonuclease | | | | |
| MSM0726 | NONE | | | MTH_1635 | conserved protein | 7.1E−42 |
| MSM0727 | Msp_1085 | AhcY | 1.3E−163 | MTH_1636 | S-adenosylhomocysteine | 3.7E−164 |
| | | | | | hydrolase | |
| MSM0728 | Msp_0524 | predicted oxidoreductase | 4.4E−92 | MTH_907 | conserved protein | 2.5E−62 |
| MSM0729 | Msp_0231 | predicted E1-like enzyme | 2.1E−46 | MTH_1571 | molybdopterin | 1.7E−65 |
| | | | | | biosynthesis protein | |
| | | | | | MoeB homolog | |
| MSM0730 | Msp_0017 | conserved hypothetical protein | 1.7E−28 | NONE | | |
| MSM0731 | Msp_0113 | conserved hypothetical protein | 1.6E−13 | MTH_511 | DNA helicase II | 4.6E−07 |
| MSM0732 | Msp_0873 | TruB | 3.2E−105 | MTH_32 | centromere/microtubule- | 3.2E−110 |
| | | | | | binding protein | |
| MSM0733 | Msp_0880 | 50S ribosomal protein L14e | 2.3E−24 | MTH_31 | ribosomal protein L14 | 4.1E−23 |
| MSM0734 | Msp_0881 | putative cytidylate kinase | 1.8E−56 | MTH_30 | cytidylate kinase | 3.8E−52 |
| MSM0735 | Msp_0882 | 50S ribosomal protein L34e | 2.4E−29 | MTH_29 | ribosomal protein L34 | 3.3E−37 |
| | | | | | (E. coli) | |
| MSM0736 | Msp_0883 | hypothetical membrane-spanning | 1.2E−34 | MTH_28 | conserved protein | 1.1E−50 |
| | | protein | | | | |
| MSM0737 | Msp_0884 | AdkA | 1.1E−61 | MTH_27 | adenylate kinase | 1.1E−63 |
| MSM0738 | Msp_0885 | SecY | 6.6E−153 | MTH_26 | preprotein translocase | 1.0E−145 |
| | | | | | SecY | |
| MSM0739 | Msp_0886 | 50S ribosomal protein L15P | 1.9E−43 | MTH_25 | ribosomal protein L27a | 4.1E−46 |
| | | | | | (E. coli) | |
| MSM0740 | Msp_0887 | 50S ribosomal protein L30P | 9.7E−49 | MTH_24 | ribosomal protein L7 | 1.2E−53 |
| | | | | | (E. coli) | |
| MSM0741 | Msp_0888 | 30S ribosomal protein S5P | 3.5E−92 | MTH_23 | ribosomal protein S2 | 3.7E−93 |
| | | | | | (E. coli) | |
| MSM0742 | Msp_0889 | 50S ribosomal protein L18P | 6.7E−57 | MTH_22 | ribosomal protein L5 | 8.9E−67 |
| MSM0743 | Msp_0890 | 50S ribosomal protein L19e | 4.6E−58 | MTH_21 | ribosomal protein L19 | 1.5E−64 |
| MSM0744 | Msp_0891 | 50S ribosomal protein L32e | 6.6E−34 | MTH_20 | ribosomal protein L32 | 3.1E−41 |
| MSM0745 | Msp_0892 | 50S ribosomal protein L6P | 5.7E−60 | MTH_19 | ribosomal protein L9 | 4.3E−67 |
| | | | | | (E. coli) | |
| MSM0746 | Msp_0893 | 30S ribosomal protein S8P | 9.5E−58 | MTH_18 | ribosomal protein S15a | 1.2E−55 |
| | | | | | (E. coli) | |
| MSM0747 | Msp_0894 | 30S ribosomal protein S14P | 2.1E−21 | MTH_17 | ribosomal protein S29 | 7.6E−22 |
| | | | | | (E. coli) | |
| MSM0748 | Msp_0895 | 50S ribosomal protein L5P | 2.4E−61 | MTH_16 | ribosomal protein L11 | 2.9E−61 |
| | | | | | (E. coli) | |
| MSM0749 | Msp_0896 | 30S ribosomal protein S4e | 3.0E−70 | MTH_15 | ribosomal protein S4 | 1.8E−77 |
| MSM0750 | Msp_0897 | 50S ribosomal protein L24P | 2.4E−29 | MTH_14 | ribosomal protein L26 | 1.3E−35 |
| | | | | | (E. coli) | |
| MSM0751 | Msp_0898 | 50S ribosomal protein L14P | 1.4E−56 | MTH_13 | ribosomal protein L23 | 1.0E−56 |
| | | | | | (E. coli) | |
| MSM0752 | Msp_0899 | 30S ribosomal protein S17P | 1.4E−42 | MTH_12 | ribosomal protein S11 | 1.4E−45 |
| | | | | | (E. coli) | |
| MSM0753 | Msp_0900 | putative ribonuclease P, | 4.8E−24 | MTH_11 | conserved protein | 8.7E−21 |
| | | component 1 | | | | |
| MSM0754 | Msp_0901 | protein translation factor SUI1-like | 2.4E−45 | MTH_10 | ribosomal protein SUI1 | 3.6E−47 |
| | | protein | | | | |
| MSM0755 | Msp_0902 | 50S ribosomal protein L29P | 3.3E−16 | MTH_9 | ribosomal protein L35 | 7.9E−20 |
| | | | | | (E. coli) | |
| MSM0756 | Msp_0903 | 30S ribosomal protein S3P | 6.8E−96 | MTH_8 | ribosomal protein S3 | 1.2E−96 |
| | | | | | (E. coli) | |
| MSM0757 | Msp_0904 | 50S ribosomal protein L22P | 1.3E−46 | MTH_7 | ribosomal protein L17 | 3.5E−56 |
| | | | | | (E. coli) | |
| MSM0758 | Msp_0905 | 30S ribosomal protein S19P | 1.4E−58 | MTH_6 | ribosomal protein S15 | 1.3E−58 |
| | | | | | (E. coli) | |
| MSM0759 | Msp_0906 | 50S ribosomal protein L2P | 3.1E−107 | MTH_5 | ribosomal protein L8 | 1.9E−105 |
| | | | | | (E. coli) | |
| MSM0760 | Msp_0907 | 50S ribosomal protein L23P | 2.8E−26 | MTH_4 | ribosomal protein L23a | 5.4E−28 |
| | | | | | (E. coli) | |
| MSM0761 | Msp_0908 | 50S ribosomal protein L1e | 4.5E−99 | MTH_3 | ribosomal protein L4 | 2.6E−99 |
| | | | | | (E. coli) | |
| MSM0762 | Msp_0909 | 50S ribosomal protein L3P | 1.5E−121 | MTH_2 | ribosomal protein L3 | 1.1E−132 |
| | | | | | (E. coli) | |
| MSM0763 | Msp_0910 | conserved hypothetical protein | 1.1E−79 | MTH_1 | conserved protein | 1.2E−73 |
| MSM0764 | Msp_1319 | predicted DNA modification | 1.7E−04 | MTH_1918 | possible protein | 3.7E−45 |
| | | methylase | | | methyltransferase | |
| MSM0765 | Msp_0914 | PycA | 1.7E−186 | MTH_1917 | biotin carboxylase | 5.5E−202 |
| MSM0766 | Msp_0915 | partially conserved hypothetical | 4.0E−36 | MTH_1916 | biotin acetyl-CoA | 5.3E−62 |
| | | protein | | | carboxylase ligase/biotin | |
| | | | | | operon repressor | |
| MSM0767 | Msp_0916 | predicted selenocysteine | 2.8E−99 | MTH_1914 | conserved protein | 2.3E−100 |
| | | synthase | | | | |
| MSM0768 | Msp_0917 | hypothetical protein | 7.5E−04 | MTH_1912 | unknown | 1.1E−11 |
| MSM0769 | Msp_0791 | fumarate hydratase | 3.1E−59 | NONE | fumarate hydratase, class | 1.5E−50 |
| | | | | | I related protein | |
| MSM0770 | Msp_1112 | CbiO2 | 1.2E−43 | NONE | methyl coenzyme M | 8.3E−64 |
| | | | | | reductase system, | |
| | | | | | component A2 homolog | |
| MSM0771 | Msp_0657 | CbiQ2 | 1.4E−05 | MTH_453 | conserved protein | 2.6E−12 |
| MSM0772 | NONE | | | MTH_452 | unknown | 9.2E−07 |
| MSM0773 | Msp_0958 | predicted ABC-type polar amino | 1.4E−26 | MTH_1704 | cobalt transport ATP- | 5.9E−25 |
| | | acid transport system, ATP- | | | binding protein O | |
| | | binding protein | | | | |
| MSM0774 | Msp_0340 | PstB | 1.6E−26 | MTH_1731 | phosphate transport | 5.2E−26 |
| | | | | | system ATP-binding | |
| MSM0775 | Msp_0149 | predicted transcriptional regulator | 2.0E−34 | NONE | | |
| MSM0776 | Msp_0790 | conserved hypothetical | 2.2E−138 | MTH_1909 | unknown | 2.8E−159 |
| | | membrane-spanning protein | | | | |
| MSM0777 | Msp_0491 | hypothetical membrane-spanning | 3.6E−10 | MTH_1908 | unknown | 3.2E−16 |
| | | protein | | | | |
| MSM0778 | Msp_0517 | predicted RNA-binding protein | 3.6E−184 | MTH_1907 | conserved protein | 2.0E−188 |
| MSM0779 | Msp_0516 | predicted Zn-dependent | 2.3E−70 | MTH_1902 | conserved protein | 3.5E−72 |
| | | hydrolase of the beta-lactamase | | | | |
| | | superfamily | | | | |
| MSM0780 | NONE | | | MTH_1901 | unknown | 2.9E−16 |
| MSM0781 | Msp_1151 | hypothetical membrane-spanning | 1.2E−09 | MTH_1533 | unknown | 1.3E−10 |
| | | protein | | | | |
| MSM0782 | Msp_1151 | hypothetical membrane-spanning | 2.4E−04 | MTH_979 | unknown | 1.2E−05 |
| | | protein | | | | |
| MSM0783 | Msp_1447 | EhbK | 3.3E−20 | NONE | tungsten | 3.5E−88 |
| | | | | | formylmethanofuran | |
| | | | | | dehydrogenase, subunit | |
| | | | | | F homolog | |
| MSM0784 | Msp_0236 | ferredoxin | 5.5E−14 | MTH_927 | ferredoxin | 5.1E−16 |
| MSM0785 | Msp_0514 | putative phosphopantetheine | 1.0E−37 | MTH_1896 | conserved protein | 1.3E−42 |
| | | adenylyltransferase | | | | |
| MSM0786 | Msp_1129 | partially conserved hypothetical | 1.1E−49 | MTH_412 | conserved protein | 1.3E−69 |
| | | membrane-spanning protein | | | | |
| MSM0787 | Msp_0511 | predicted Fe—S oxidoreductase | 7.6E−120 | MTH_1895 | conserved protein | 8.7E−124 |
| MSM0788 | Msp_0510 | putative aspartate | 5.5E−117 | MTH_1894 | aspartate | 3.3E−108 |
| | | aminotransferase | | | aminotransferase | |
| | | | | | homolog | |
| MSM0789 | Msp_0519 | predicted Co/Zn/Cd cation | 7.6E−33 | MTH_1893 | cation efflux system | 1.8E−77 |
| | | transporter | | | protein (zinc/cadmium) | |
| MSM0790 | Msp_1428 | conserved hypothetical protein | 1.3E−15 | MTH_1884 | conserved protein | 3.0E−36 |
| MSM0791 | Msp_0443 | 2-phosphoglycerate kinase | 3.6E−81 | MTH_1883 | 2-phosphoglycerate | 3.7E−84 |
| | | | | | kinase | |
| MSM0792 | Msp_1010 | predicted phosphoesterase | 1.8E−47 | MTH_1882 | conserved protein | 2.3E−52 |
| MSM0793 | Msp_1011 | conserved hypothetical protein | 1.9E−29 | MTH_1881 | conserved protein | 4.4E−42 |
| MSM0794 | Msp_1012 | conserved hypothetical protein | 1.9E−20 | MTH_1880 | conserved protein | 2.1E−28 |
| MSM0795 | Msp_1013 | HdrB1 | 1.9E−116 | NONE | heterodisulfide reductase, | 4.3E−115 |
| | | | | | subunit B | |
| MSM0796 | Msp_1014 | HdrC1 | 1.6E−69 | NONE | heterodisulfide reductase, | 4.7E−77 |
| | | | | | subunit C | |
| MSM0797 | Msp_1015 | conserved hypothetical protein | 2.5E−50 | MTH_1877 | conserved protein | 1.6E−53 |
| MSM0798 | NONE | | | NONE | | |
| MSM0799 | Msp_0113 | conserved hypothetical protein | 1.6E−12 | MTH_1626 | phosphoserine | 2.2E−06 |
| | | | | | phosphatase | |
| MSM0800 | NONE | | | NONE | | |
| MSM0801 | Msp_1017 | DphB | 1.7E−74 | MTH_1874 | diphthine synthase | 2.9E−77 |
| MSM0802 | Msp_1022 | predicted methyltransferase | 3.6E−81 | MTH_1873 | met-10+ protein | 1.3E−74 |
| MSM0803 | NONE | | | MTH_633 | conserved protein | 4.3E−04 |
| MSM0804 | Msp_1023 | putative translation initiation factor | 5.0E−100 | NONE | translation initiation factor | 2.2E−125 |
| | | alF-2B, subunit 1 | | | elF-2B, alpha subunit | |
| MSM0805 | Msp_0958 | predicted ABC-type polar amino | 5.0E−100 | MTH_696 | ABC transporter | 2.7E−35 |
| | | acid transport system, ATP- | | | (glutamine transport ATP- | |
| | | binding protein | | | binding protein) | |
| MSM0806 | Msp_0959 | predicted ABC-type polar amino | 2.1E−92 | NONE | | |
| | | acid transport system, permease | | | | |
| | | protein | | | | |
| MSM0807 | Msp_0960 | predicted ABC-type polar amino | 3.5E−108 | NONE | | |
| | | acid transport system, periplasmic | | | | |
| | | substrate-binding protein | | | | |
| MSM0808 | Msp_1024 | conserved hypothetical protein | 2.9E−104 | MTH_1871 | nitrogenase iron- | 1.6E−115 |
| | | | | | molybdenum cofactor | |
| | | | | | biosynthesis protein NifB | |
| MSM0809 | Msp_1025 | conserved hypothetical protein | 2.3E−40 | MTH_1870 | conserved protein | 3.1E−41 |
| MSM0810 | Msp_1026 | predicted activator of 2- | 5.5E−165 | MTH_1869 | activator of (R)-2- | 1.7E−175 |
| | | hydroxyglutaryl-CoA dehydratase | | | hydroxyglutaryl-CoA | |
| MSM0811 | Msp_1027 | conserved hypothetical protein | 1.7E−53 | MTH_1868 | conserved protein | 1.2E−57 |
| MSM0812 | Msp_1029 | conserved hypothetical protein | 1.3E−39 | MTH_1866 | conserved protein | 1.0E−40 |
| MSM0813 | Msp_1030 | predicted peptidyl-prolyl cis-trans | 2.6E−135 | MTH_1865 | conserved protein | 2.3E−146 |
| | | isomerase | | | | |
| MSM0814 | Msp_1032 | predicted selenophosphate | 3.3E−87 | MTH_1864 | phosphoribosylformylglycinamidine | 6.2E−91 |
| | | synthetase-related protein | | | synthase II | |
| | | | | | related protein | |
| MSM0815 | Msp_1033 | conserved hypothetical protein | 4.5E−99 | MTH_1863 | conserved protein | 4.4E−97 |
| MSM0816 | Msp_1034 | predicted nucleic acid-binding | 3.7E−33 | MTH_1862 | conserved protein | 3.5E−40 |
| | | protein | | | | |
| MSM0817 | Msp_0799 | predicted transcriptional regulator | 6.6E−34 | MTH_1843 | unknown | 1.0E−33 |
| MSM0818 | Msp_0798 | predicted transcriptional regulator | 5.0E−36 | MTH_1843 | unknown | 2.1E−26 |
| MSM0819 | NONE | | | MTH_1438 | unknown | 4.6E−15 |
| MSM0820 | NONE | | | MTH_1861 | molybdenum cofactor | 2.5E−46 |
| | | | | | biosynthesis MoaB | |
| MSM0821 | Msp_1036 | PyrE | 3.1E−59 | MTH_1860 | uridine 5′- | 5.2E−55 |
| | | | | | monophosphate synthase | |
| MSM0822 | Msp_1035 | hypothetical protein | 3.1E−13 | MTH_1859 | unknown | 1.4E−15 |
| MSM0823 | NONE | | | NONE | | |
| MSM0824 | NONE | | | NONE | N-terminal | 3.1E−06 |
| | | | | | acetyltransferase | |
| | | | | | complex, subunit ARD1 | |
| MSM0825 | Msp_0437 | conserved hypothetical protein | 4.7E−56 | NONE | | |
| MSM0826 | Msp_0114 | ThsB | 8.2E−226 | MTH_794 | chaperonin | 2.4E−231 |
| MSM0827 | Msp_0747 | member of asn/thr-rich large | 5.9E−04 | MTH_796 | conserved protein | 4.5E−33 |
| | | protein family | | | | |
| MSM0828 | Msp_0220 | predicted glycosyltransferase | 2.0E−14 | MTH_540 | intracellular protein | 8.1E−06 |
| | | | | | transport protein | |
| MSM0829 | Msp_0110 | aspartate-semialdehyde | 6.6E−121 | MTH_799 | aspartate-semialdehyde | 2.3E−132 |
| | | dehydrogenase | | | dehydrogenase | |
| MSM0830 | Msp_0109 | DapB | 1.0E−85 | MTH_800 | dihydrodipicolinate | 3.2E−87 |
| | | | | | reductase | |
| MSM0831 | Msp_0108 | DapA | 4.9E−86 | MTH_801 | dihydrodipicolinate | 2.0E−85 |
| | | | | | synthase | |
| MSM0832 | Msp_0107 | putative aspartokinase | 2.2E−129 | MTH_802 | aspartokinase II alpha | 6.7E−149 |
| | | | | | subunit | |
| MSM0833 | Msp_0106 | 30S ribosomal protein S17e | 1.3E−19 | MTH_803 | ribosomal protein S17 | 1.5E−23 |
| MSM0834 | Msp_0105 | putative chorismate mutase | 3.8E−15 | NONE | chorismate mutase, | 9.3E−17 |
| | | | | | subunit A | |
| MSM0835 | Msp_0104 | AroK | 4.7E−56 | MTH_805 | conserved protein | 2.6E−76 |
| | | | | | (homoserine kinase | |
| | | | | | related) | |
| MSM0836 | Msp_0101 | predicted glycosyltransferase | 2.6E−64 | MTH_450 | LPS biosynthesis RfbU | 9.6E−31 |
| | | | | | related protein | |
| MSM0837 | Msp_0102 | CbiD | 6.5E−91 | MTH_808 | cobalamin biosynthesis | 4.0E−87 |
| | | | | | protein D | |
| MSM0838 | Msp_0103 | putative thioredoxin | 2.5E−18 | MTH_807 | thioredoxin | 7.1E−19 |
| MSM0839 | Msp_0100 | predicted helicase | 2.1E−227 | MTH_810 | DNA helicase related | 9.1E−248 |
| | | | | | protein | |
| MSM0840 | Msp_0097 | conserved hypothetical protein | 3.0E−15 | MTH_814 | conserved protein | 1.6E−14 |
| MSM0841 | Msp_0371 | hypothetical protein | 6.6E−11 | MTH_815 | unknown | 2.2E−15 |
| MSM0842 | Msp_0372 | predicted histone | 1.5E−187 | MTH_817 | conserved protein | 6.2E−189 |
| | | acetyltransferase | | | | |
| MSM0843 | NONE | | | MTH_818 | deoxyribose-phosphate | 2.1E−26 |
| | | | | | aldolase | |
| MSM0844 | Msp_0122 | archaeal histone | 3.5E−21 | MTH_821 | histone HMtA1 | 2.5E−23 |
| MSM0845 | Msp_0376 | predicted 2-methylthioadenine | 8.9E−126 | MTH_826 | conserved protein | 3.8E−130 |
| | | synthetase | | | | |
| MSM0846 | Msp_0375 | conserved hypothetical protein | 1.6E−39 | MTH_828 | conserved protein | 1.6E−46 |
| MSM0847 | Msp_0374 | LeuD2 | 4.1E−57 | NONE | 3-isopropylmalate | 7.4E−56 |
| | | | | | dehydratase, LeuD | |
| | | | | | subunit | |
| MSM0848 | Msp_0373 | predicted archaeal sugar kinase | 1.5E−73 | MTH_830 | conserved protein | 3.0E−82 |
| MSM0849 | Msp_0384 | predicted Fe—S oxidoreductase | 6.6E−169 | MTH_831 | molybdenum cofactor | 2.7E−177 |
| | | | | | biosynthesis MoaA | |
| | | | | | homolog | |
| MSM0850 | Msp_0385 | conserved hypothetical | 2.4E−45 | MTH_832 | conserved protein | 1.4E−43 |
| | | membrane-spanning protein | | | | |
| MSM0851 | Msp_0386 | predicted transcriptional regulator | 1.1E−70 | MTH_834 | conserved protein | 3.0E−98 |
| MSM0852 | Msp_0387 | predicted ATP-utilizing enzyme | 2.3E−40 | MTH_835 | conserved protein | 1.0E−53 |
| MSM0853 | Msp_0217 | predicted UDP-N- | 1.4E−120 | MTH_837 | UDP-N- | 1.3E−136 |
| | | acetylglucosamine 2-epimerase | | | acetylglucosamine 2- | |
| | | | | | epimerase | |
| MSM0854 | NONE | | | NONE | | |
| MSM0855 | Msp_0388 | TruA | 5.2E−50 | MTH_840 | pseudouridylate synthase I | 1.6E−51 |
| MSM0856 | NONE | | | MTH_695 | conserved protein | 1.7E−08 |
| MSM0857 | Msp_1000 | predicted ABC-type | 1.5E−29 | MTH_696 | ABC transporter | 3.3E−44 |
| | | nitrate/sulfonate/bicarbonate | | | (glutamine transport ATP- | |
| | | transport system, ATB-binding | | | binding protein) | |
| | | protein | | | | |
| MSM0858 | Msp_0389 | HisA | 6.3E−77 | MTH_843 | phosphoribosylformimino- | 7.4E−79 |
| | | | | | 5-aminoimidazole | |
| | | | | | carboxamide ribotide | |
| | | | | | isomerase | |
| MSM0859 | Msp_0390 | putative cytidylyltransferase | 5.1E−43 | MTH_844 | autotrophic growth | 1.5E−48 |
| | | | | | protein | |
| MSM0860 | Msp_0552 | ArgC | 4.9E−109 | MTH_846 | N-acetyl-gamma-glutamyl- | 2.0E−108 |
| | | | | | phosphate reductase | |
| MSM0861 | Msp_0554 | hypothetical protein | 4.8E−31 | MTH_847 | unknown | 3.3E−44 |
| MSM0862 | Msp_0521 | PyrI | 2.1E−44 | MTH_850 | aspartate | 7.5E−47 |
| | | | | | carbamoyltransferase | |
| | | | | | regulatory subunit | |
| MSM0863 | Msp_1419 | hypothetical protein | 3.1E−20 | NONE | | |
| MSM0864 | NONE | | | MTH_1285 | conserved protein | 2.7E−10 |
| MSM0865 | Msp_0159 | conserved hypothetical protein | 1.1E−79 | MTH_853 | conserved protein | 2.4E−96 |
| MSM0866 | Msp_0402 | predicted zinc metalloprotease | 4.7E−143 | MTH_856 | zinc metalloproteinase | 8.2E−144 |
| MSM0867 | Msp_0403 | conserved hypothetical protein | 1.1E−47 | MTH_857 | conserved protein | 4.0E−48 |
| MSM0868 | NONE | | | NONE | | |
| MSM0869 | Msp_0404 | predicted GTPase | 3.0E−93 | NONE | GTP-binding protein, | 8.2E−112 |
| | | | | | GTP1/OBG family | |
| MSM0870 | Msp_0405 | putative small heat shock protein | 1.2E−16 | NONE | heat shock protein, class I | 3.8E−20 |
| MSM0871 | Msp_0017 | conserved hypothetical protein | 1.7E−28 | NONE | | |
| MSM0872 | Msp_1054 | predicted phosphosugar | 1.2E−103 | MTH_860 | glucosamine-fructose-6- | 5.6E−113 |
| | | isomerase | | | phosphate | |
| | | | | | aminotransferase | |
| MSM0873 | Msp_1309 | conserved hypothetical protein | 7.6E−17 | MTH_863 | conserved protein | 5.4E−28 |
| MSM0874 | Msp_1308 | adenine deaminase | 1.5E−139 | MTH_866 | adenine deaminase | 1.3E−132 |
| MSM0875 | Msp_1347 | conserved hypothetical protein | 6.0E−136 | MTH_867 | conserved protein | 6.4E−144 |
| MSM0876 | Msp_0415 | predicted | 1.3E−71 | MTH_868 | agmatine ureohydrolase | 1.2E−73 |
| | | arginase/agmatinase/formimionoglutamate | | | | |
| | | hydrolase | | | | |
| MSM0877 | Msp_1352 | translation initiation factor 5A (alF- | 4.4E−53 | NONE | translation initiation factor, | 1.7E−49 |
| | | 5A) | | | elF-5A | |
| MSM0878 | Msp_1327 | PdaD | 2.1E−37 | MTH_870 | conserved protein | 3.4E−42 |
| MSM0879 | Msp_1330 | PpnK | 7.2E−60 | MTH_872 | conserved protein | 9.0E−77 |
| MSM0880 | Msp_1331 | predicted UDP-N-acetylmuramyl | 1.1E−47 | MTH_873 | UDP-N-acetylmuramyl | 5.4E−81 |
| | | pentapeptide synthase | | | tripeptide synthetase | |
| | | | | | related protein | |
| MSM0881 | Msp_1332 | HemC | 7.3E−83 | MTH_874 | porphobilinogen | 2.0E−85 |
| | | | | | deaminase | |
| MSM0882 | Msp_1333 | predicted dehydrogenase | 2.7E−101 | NONE | 3-chlorobenzoate-3,4- | 3.0E−130 |
| | | | | | dioxygenase | |
| | | | | | dyhydrogenase related | |
| | | | | | protein | |
| MSM0883 | Msp_1334 | predicted orotate | 5.6E−53 | MTH_876 | orotate | 9.7E−70 |
| | | phosphoribosyltransferase | | | phosphoribosyltransferase | |
| MSM0884 | Msp_0747 | member of asn/thr-rich large | 1.5E−18 | MTH_716 | cell surface glycoprotein | 4.1E−07 |
| | | protein family | | | (s-layer protein) | |
| MSM0885 | Msp_1465 | member of asn/thr-rich large | 2.4E−39 | MTH_716 | cell surface glycoprotein | 1.7E−08 |
| | | protein family | | | (s-layer protein) | |
| MSM0886 | NONE | | | NONE | | |
| MSM0887 | Msp_1410 | predicted universal stress protein | 2.5E−18 | MTH_898 | conserved protein | 1.5E−18 |
| MSM0888 | Msp_1416 | GdhA | 2.6E−181 | NONE | | |
| MSM0889 | NONE | | | NONE | | |
| MSM0890 | NONE | | | NONE | | |
| MSM0891 | Msp_1363 | peptide chain release factor, | 3.4E−149 | NONE | peptide chain release | 8.7E−156 |
| | | subunit 1 (aRF-1) | | | factor eRF, subunit 1 | |
| MSM0892 | Msp_1056 | hypothetical membrane-spanning | 5.4E−06 | MTH_1905 | unknown | 3.2E−06 |
| | | protein | | | | |
| MSM0893 | Msp_1202 | predicted acetyltransferase | 2.4E−29 | NONE | N-terminal | 3.7E−38 |
| | | | | | acetyltransferase | |
| | | | | | complex, subunit ARD1 | |
| MSM0894 | Msp_1203 | conserved hypothetical protein | 5.7E−28 | MTH_1000 | conserved protein | 1.2E−25 |
| MSM0895 | Msp_1204 | predicted cation transport ATPase | 3.9E−235 | MTH_1001 | cation-transporting P- | 9.8E−251 |
| | | | | | ATPase PacL | |
| MSM0896 | Msp_1205 | CbiJ | 6.5E−43 | MTH_1002 | cobalamin biosynthesis | 8.5E−39 |
| | | | | | protein J | |
| MSM0897 | Msp_1365 | 30S ribosomal protein S10P | 1.6E−48 | MTH_1059 | ribosomal protein S20 | 1.3E−49 |
| | | | | | (E. coli) | |
| MSM0898 | Msp_1366 | translation elongation factor 1- | 1.9E−185 | NONE | translation elongation | 3.9E−192 |
| | | alpha (EF-Tu) | | | factor, EF-1 alpha | |
| MSM0899 | Msp_1367 | FusA | 1.7e−319 | NONE | translation elongation | 1.9e−318 |
| | | | | | factor, EF-2 | |
| MSM0900 | Msp_1368 | 30S ribosomal protein S7P | 3.3E−80 | MTH_1056 | ribosomal protein S5 | 9.2E−81 |
| | | | | | (E. coli) | |
| MSM0901 | Msp_1369 | 30S ribosomal protein S12P | 4.4E−69 | MTH_1055 | ribosomal protein S23 | 7.8E−68 |
| | | | | | (E. coli) | |
| MSM0902 | Msp_0321 | MrtA | 5.7E−250 | NONE | methyl coenzyme M | 2.0E−250 |
| | | | | | reductase II, alpha | |
| | | | | | subunit | |
| MSM0903 | Msp_0320 | MrtG | 1.6E−103 | NONE | methyl coenzyme M | 1.8E−116 |
| | | | | | reductase II, gamma | |
| | | | | | subunit | |
| MSM0904 | Msp_0319 | MrtD | 1.9E−45 | NONE | methyl coenzyme M | 2.2E−40 |
| | | | | | reductase II, D protein | |
| MSM0905 | Msp_0318 | MrtB | 9.8E−159 | NONE | methyl coenzyme M | 4.1E−181 |
| | | | | | reductase II, beta subunit | |
| MSM0906 | Msp_1370 | NusA | 1.7E−44 | MTH_1054 | transcription termination | 2.5E−55 |
| | | | | | factor NusA | |
| MSM0907 | Msp_1371 | 50S ribosomal protein L30e | 6.0E−33 | MTH_1053 | ribosomal protein L30 | 3.0E−36 |
| MSM0908 | Msp_1372 | RpoA2 | 2.1E−126 | NONE | DNA-dependent RNA | 4.7E−141 |
| | | | | | polymerase, subunit A″ | |
| MSM0909 | Msp_1373 | RpoA1 | 0.0E+00 | NONE | DNA-dependent RNA | 0.0E+00 |
| | | | | | polymerase, subunit A′ | |
| MSM0910 | Msp_1374 | RpoB1 | 6.1E−253 | NONE | DNA-dependent RNA | 4.6E−276 |
| | | | | | polymerase, subunit B′ | |
| MSM0911 | Msp_1375 | RpoB2 | 3.3E−103 | NONE | DNA-dependent RNA | 8.6E−220 |
| | | | | | polymerase, subunit B″ | |
| MSM0912 | Msp_1376 | RpoH | 7.6E−17 | NONE | DNA-dependent RNA | 4.6E−15 |
| | | | | | polymerase, subunit H | |
| MSM0913 | NONE | | | NONE | | |
| MSM0914 | NONE | | | MTH_72 | O-linked GlcNAc | 3.0E−04 |
| | | | | | transferase | |
| MSM0915 | NONE | | | NONE | | |
| MSM0916 | Msp_0682 | ThiM1 | 1.2E−73 | NONE | | |
| MSM0917 | Msp_0683 | hypothetical protein | 7.7E−56 | NONE | | |
| MSM0918 | Msp_1381 | phosphoglycerate kinase | 1.1E−120 | MTH_1042 | 3-phosphoglycerate | 4.3E−131 |
| | | | | | kinase | |
| MSM0919 | Msp_1382 | TpiA | 4.9E−77 | MTH_1041 | triosephosphate | 3.2E−71 |
| | | | | | isomerase | |
| MSM0920 | Msp_1103 | member of asn/thr-rich large | 4.2E−04 | NONE | | |
| | | protein family | | | | |
| MSM0921 | Msp_0548 | hypothetical membrane-spanning | 1.1E−05 | NONE | | |
| | | protein | | | | |
| MSM0922 | Msp_1383 | predicted Fe—S oxidoreductase | 1.7E−97 | MTH_1039 | conserved protein | 4.9E−98 |
| MSM0923 | Msp_0540 | predicted multimeric flavodoxin | 1.2E−16 | MTH_135 | conserved protein | 1.3E−17 |
| MSM0924 | Msp_1386 | SucC | 3.4E−101 | NONE | succinyl-CoA synthetase, | 3.7E−116 |
| | | | | | beta subunit | |
| MSM0925 | Msp_1387 | KorC | 9.5E−58 | NONE | 2-oxoglutarate | 8.8E−60 |
| | | | | | oxidoreductase, gamma | |
| | | | | | subunit | |
| MSM0926 | Msp_1388 | KorB | 1.3E−99 | NONE | 2-oxoglutarate | 2.2E−102 |
| | | | | | oxidoreductase, beta | |
| | | | | | subunit | |
| MSM0927 | Msp_1389 | KorA | 4.5E−138 | NONE | 2-oxoglutarate | 6.2E−130 |
| | | | | | oxidoreductase, alpha | |
| | | | | | subunit | |
| MSM0928 | Msp_1390 | KorD | 3.0E−15 | NONE | ferredoxin (putative 2- | 8.6E−14 |
| | | | | | oxoglutarate | |
| | | | | | oxidoreductase, delat | |
| | | | | | subunit) | |
| MSM0929 | Msp_0791 | fumarate hydratase | 3.7E−17 | NONE | fumarate hydratase, class I | 3.5E−40 |
| MSM0930 | Msp_0325 | predicted peptidyl-prolyl cis-trans | 3.5E−67 | MTH_1125 | fkbp-type peptidyl-prolyl | 1.8E−77 |
| | | isomerase 2 | | | cis-trans isomerase | |
| MSM0931 | Msp_0801 | conserved hypothetical protein | 7.0E−94 | MTH_448 | unknown | 4.8E−68 |
| MSM0932 | Msp_1167 | conserved hypothetical protein | 4.7E−49 | MTH_1113 | conserved protein | 1.6E−58 |
| MSM0933 | Msp_1168 | CobS | 1.2E−50 | MTH_1112 | cobalamin (5′-phosphate) | 1.9E−41 |
| | | | | | synthase | |
| MSM0934 | Msp_1169 | hypothetical protein | 1.1E−06 | MTH_1111 | conserved protein | 1.5E−41 |
| MSM0935 | Msp_1170 | conserved hypothetical protein | 4.5E−106 | MTH_1109 | conserved protein | 4.2E−92 |
| MSM0936 | Msp_1171 | predicted ATPase | 6.3E−77 | MTH_1108 | conserved protein | 1.0E−65 |
| MSM0937 | NONE | | | NONE | | |
| MSM0938 | NONE | | | NONE | | |
| MSM0939 | Msp_1173 | PycB | 1.4E−212 | NONE | oxaloacetate | 2.8E−221 |
| | | | | | decarboxylase, alpha | |
| | | | | | subunit | |
| MSM0940 | Msp_1166 | predicted myo-inositol-1- | 5.3E−151 | MTH_1105 | conserved protein | 9.4E−159 |
| | | phosphate synthase | | | | |
| MSM0941 | Msp_0634 | predicted prenyltransferase | 2.3E−70 | MTH_1098 | bacteriochlorophyll | 4.2E−69 |
| | | | | | synthase related protein | |
| MSM0942 | Msp_0616 | partially conserved hypothetical | 5.0E−52 | MTH_371 | unknown | 5.1E−35 |
| | | membrane-spanning protein | | | | |
| MSM0943 | NONE | | | MTH_466 | unknown | 5.6E−09 |
| MSM0944 | NONE | | | NONE | | |
| MSM0945 | Msp_1285 | hydrogenase | 9.3E−147 | MTH_1072 | hydrogenase | 2.2E−141 |
| | | expression/formation protein | | | expression/formation | |
| | | | | | protein HypD | |
| MSM0946 | Msp_0215 | predicted glycosyltransferase | 6.1E−04 | MTH_1071 | conserved protein | 3.9E−50 |
| MSM0947 | Msp_1284 | predicted modulator of DNA | 3.7E−95 | MTH_1070 | conserved protein | 1.5E−96 |
| | | gyrase | | | | |
| MSM0948 | Msp_0220 | predicted glycosyltransferase | 4.0E−04 | NONE | | |
| MSM0949 | Msp_1351 | predicted transcriptional activator | 6.7E−18 | MTH_628 | unknown | 1.6E−19 |
| MSM0950 | NONE | | | MTH_1003 | molybdenum cofactor | 6.8E−101 |
| | | | | | biosynthesis protein MoeA | |
| MSM0951 | Msp_1335 | translation initiation factor 1A (alF- | 1.6E−41 | NONE | translation initiation factor, | 1.3E−44 |
| | | 1A) (elF1A) | | | elF-1A | |
| MSM0952 | Msp_1337 | predicted serine/threonine protein | 5.1E−59 | MTH_1005 | conserved protein | 1.1E−75 |
| | | kinase | | | | |
| MSM0953 | NONE | | | MTH_630 | unknown | 1.5E−04 |
| MSM0954 | Msp_1338 | predicted RNA-binding protein | 1.4E−56 | MTH_1006 | conserved protein | 2.0E−60 |
| MSM0955 | Msp_1339 | type II DNA topoisomerase VI, | 2.4E−203 | MTH_1007 | conserved protein | 1.5E−213 |
| | | subunit B | | | | |
| MSM0956 | Msp_1340 | type II DNA topoisomerase VI, | 4.3E−149 | MTH_1008 | conserved protein | 1.8E−155 |
| | | subunit A | | | | |
| MSM0957 | Msp_0119 | hypothetical membrane-spanning | 6.8E−20 | MTH_524 | unknown | 4.9E−35 |
| | | protein | | | | |
| MSM0958 | Msp_1110 | CobN | 5.3E−11 | MTH_515 | unknown | 1.1E−08 |
| MSM0959 | Msp_0994 | conserved hypothetical protein | 3.0E−31 | NONE | | |
| MSM0960 | Msp_0678 | predicted cation transport ATPase | 4.8E−134 | MTH_411 | cadmium efflux ATPase | 1.9E−80 |
| MSM0961 | Msp_0224 | predicted cation transport ATPase | 9.6E−07 | MTH_1535 | heavy-metal transporting | 1.4E−08 |
| | | | | | CPx-type ATPase | |
| MSM0962 | Msp_1346 | glyceraldehyde 3-phosphate | 4.7E−127 | MTH_1009 | glyceraldehyde 3- | 5.9E−134 |
| | | dehydrogenase | | | phosphate | |
| | | | | | dehydrogenase | |
| MSM0963 | Msp_0992 | putative endonuclease IV | 9.5E−06 | MTH_1010 | endonuclease IV | 6.6E−71 |
| MSM0964 | Msp_1349 | predicted phosphohydrolase | 8.0E−19 | MTH_1179 | conserved protein | 1.1E−38 |
| MSM0965 | Msp_0718 | preducted 3-hydroxyacyl-CoA | 2.6E−126 | NONE | | |
| | | dehydrogenase | | | | |
| MSM0966 | Msp_1415 | putative 26S protease, regulatory | 6.5E−107 | MTH_1011 | ATP-dependent 26S | 7.4E−111 |
| | | subunit | | | protease regulatory | |
| | | | | | subunit 8 | |
| MSM0967 | Msp_1408 | HemA | 4.6E−90 | MTH_1012 | glutamyl-tRNA reductase | 3.2E−94 |
| MSM0968 | Msp_1407 | predicted siroheme synthase | 2.4E−45 | MTH_1013 | conserved protein | 1.9E−41 |
| MSM0969 | Msp_1406 | predicted metal-binding | 4.9E−54 | MTH_1014 | conserved protein | 5.6E−58 |
| | | transcription factor | | | | |
| MSM0970 | Msp_0784 | hypothetical protein | 1.3E−21 | NONE | | |
| MSM0971 | Msp_0393 | methyl-coenzyme M reductase, | 7.6E−191 | NONE | methyl coenzyme M | 4.3E−209 |
| | | component A2 | | | reductase system, | |
| | | | | | component A2 | |
| MSM0972 | Msp_1405 | conserved hypothetical protein | 1.3E−46 | MTH_1016 | conserved protein | 5.5E−51 |
| MSM0973 | Msp_1404 | putative GTP cyclohydrolase III | 9.2E−76 | MTH_1017 | conserved protein | 1.3E−88 |
| MSM0974 | Msp_1403 | CofD | 3.6E−90 | MTH_1018 | conserved protein | 8.0E−98 |
| MSM0975 | Msp_1402 | CofE | 3.8E−63 | MTH_1019 | conserved protein | 1.6E−76 |
| MSM0976 | Msp_1398 | PurO | 2.8E−51 | MTH_1020 | conserved protein | 1.0E−51 |
| MSM0977 | Msp_1397 | conserved hypothetical | 3.7E−24 | MTH_1021 | unknown | 3.2E−30 |
| | | membrane-spanning protein | | | | |
| MSM0978 | Msp_1396 | predicted biopolymer transport | 1.5E−77 | MTH_1022 | biopolymer transport | 4.1E−94 |
| | | protein | | | protein | |
| MSM0979 | Msp_1395 | RnhB | 1.6E−48 | MTH_1023 | ribonuclease HII | 9.8E−61 |
| MSM0980 | Msp_1517 | DnaK | 5.3E−16 | MTH_1024 | rod shape-determining | 7.3E−136 |
| | | | | | protein | |
| MSM0981 | NONE | | | MTH_1025 | unknown | 2.6E−51 |
| MSM0982 | Msp_1394 | partially conserved hypothetical | 2.4E−38 | MTH_1027 | CDP-diacylglycerol-serine | 8.2E−41 |
| | | membrane-spanning protein | | | O-phosphatidyltransferase | |
| MSM0983 | Msp_1393 | conserved hypothetical | 8.7E−48 | MTH_1028 | unknown | 1.7E−70 |
| | | membrane-spanning protein | | | | |
| MSM0984 | NONE | | | MTH_1030 | unknown | 1.4E−45 |
| MSM0985 | Msp_1392 | conserved hypothetical protein | 1.1E−29 | MTH_1031 | conserved protein | 6.3E−34 |
| MSM0986 | Msp_0760 | putative bile salt acid hydrolase | 4.3E−110 | NONE | | |
| MSM0987 | Msp_0329 | MfnA | 3.9E−100 | MTH_1116 | glutamate decarboxylase | 6.1E−123 |
| MSM0988 | Msp_0328 | PpsA | 1.7E−273 | MTH_1118 | phosphoenolpyruvate | 2.0E−250 |
| | | | | | synthase | |
| MSM0989 | Msp_0327 | 50S ribosomal protein L10e | 2.8E−58 | MTH_1119 | ribosomal protein L10 | 2.1E−65 |
| MSM0990 | Msp_1000 | predicted ABC-type | 4.7E−40 | MTH_920 | anion permease | 4.2E−37 |
| | | nitrate/sulfonate/bicarbonate | | | | |
| | | transport system, ATB-binding | | | | |
| | | protein | | | | |
| MSM0991 | Msp_1001 | predicted ABC-type | 2.4E−11 | MTH_478 | sulfate transport system | 4.1E−09 |
| | | nitrate/sulfonate/bicarbonate | | | permease protein | |
| | | transport system, permease | | | | |
| | | protein | | | | |
| MSM0992 | Msp_0326 | hypothetical protein | 1.0E−12 | MTH_1121 | unknown | 8.9E−12 |
| MSM0993 | Msp_0601 | partially conserved hypothetical | 3.9E−04 | MTH_1123 | unknown | 1.9E−15 |
| | | protein, predicted GTPase | | | | |
| MSM0994 | Msp_0324 | predicted nucleotidyltransferase | 3.4E−101 | MTH_1126 | conserved protein | 2.7E−90 |
| MSM0995 | Msp_0590 | member of asn/thr-rich large | 8.7E−33 | MTH_716 | cell surface glycoprotein | 1.3E−09 |
| | | protein family | | | (s-layer protein) | |
| MSM0996 | Msp_0983 | member of asn/thr-rich large | 2.6E−26 | MTH_716 | cell surface glycoprotein | 1.1E−09 |
| | | protein family | | | (s-layer protein) | |
| MSM0997 | Msp_0323 | PyrC | 1.1E−97 | MTH_1127 | dihydroorotase | 7.8E−100 |
| MSM0998 | Msp_1447 | EhbK | 1.0E−30 | MTH_1133 | polyferredoxin (MvhB) | 4.4E−145 |
| MSM0999 | Msp_0316 | MvhA | 3.4E−181 | NONE | methyl viologen-reducing | 2.1E−207 |
| | | | | | hydrogenase, alpha | |
| | | | | | subunit | |
| MSM1000 | Msp_0315 | MvhG | 3.2E−128 | NONE | methyl viologen-reducing | 5.5E−138 |
| | | | | | hydrogenase, gamma | |
| | | | | | subunit | |
| MSM1001 | Msp_0314 | MvhD1 | 3.9E−61 | NONE | methyl viologen-reducing | 1.6E−67 |
| | | | | | hydrogenase, delta | |
| | | | | | subunit | |
| MSM1002 | Msp_0312 | conserved hypothetical protein | 1.2E−130 | MTH_1150 | ABC transporter subunit | 3.5E−152 |
| | | | | | Ycf24 | |
| MSM1003 | Msp_0313 | predicted ABC-type transport | 3.2E−82 | MTH_1149 | ABC transporter subunit | 8.0E−98 |
| | | system | | | Ycf16 | |
| MSM1004 | Msp_0311 | conserved hypothetical protein | 1.2E−27 | MTH_1151 | unknown | 9.3E−33 |
| MSM1005 | Msp_0310 | predicted | 4.0E−36 | MTH_1152 | conserved protein | 7.0E−35 |
| | | GTP:adenosylcobinamide- | | | | |
| | | phosphate guanylyltransferase | | | | |
| MSM1006 | Msp_0308 | conserved hypothetical protein | 2.2E−90 | MTH_1153 | conserved protein | 5.2E−165 |
| MSM1007 | Msp_0307 | MtrH | 2.1E−108 | MTH_1156 | N5-methyl- | 2.9E−125 |
| | | | | | tetrahydromethanopterin:coenzyme M | |
| | | | | | methyltransferase, subunit H | |
| MSM1008 | Msp_0306 | MtrG | 5.7E−12 | MTH_1157 | N5-methyl- | 4.2E−21 |
| | | | | | tetrahydromethanopterin:coenzyme M | |
| | | | | | methyltransferase, subunit G | |
| MSM1009 | Msp_0305 | MtrF | 5.5E−07 | MTH_1158 | N5-methyl- | 9.3E−17 |
| | | | | | tetrahydromethanopterin:coenzyme M | |
| | | | | | methyltransferase, subunit F | |
| MSM1010 | Msp_0304 | MtrA | 9.0E−62 | MTH_1159 | N5-methyl- | 9.8E−93 |
| | | | | | tetrahydromethanopterin:coenzyme M | |
| | | | | | methyltransferase, subunit A | |
| MSM1011 | Msp_0303 | MtrB | 1.0E−12 | MTH_1160 | N5-methyl- | 1.7E−31 |
| | | | | | tetrahydromethanopterin:coenzyme M | |
| | | | | | methyltransferase, subunit B | |
| MSM1012 | Msp_0302 | MtrC | 7.6E−49 | MTH_1161 | N5-methyl- | 7.2E−81 |
| | | | | | tetrahydromethanopterin:coenzyme M | |
| | | | | | methyltransferase, subunit C | |
| MSM1013 | Msp_0301 | MtrD | 2.0E−57 | MTH_1162 | N5-methyl- | 1.0E−81 |
| | | | | | tetrahydromethanopterin:coenzyme M | |
| | | | | | methyltransferase, subunit D | |
| MSM1014 | Msp_0300 | MtrE | 9.5E−74 | MTH_1163 | N5-methyl- | 1.5E−121 |
| | | | | | tetrahydromethanopterin:coenzyme M | |
| | | | | | methyltransferase, subunit E | |
| MSM1015 | Msp_0321 | MrtA | 7.6E−207 | NONE | methyl coenzyme M | 1.7E−253 |
| | | | | | reductase I, alpha subunit | |
| MSM1016 | Msp_0320 | MrtG | 6.2E−86 | NONE | methyl coenzyme M | 2.9E−109 |
| | | | | | reductase I, gamma | |
| | | | | | subunit | |
| MSM1017 | Msp_0299 | McrC | 2.8E−67 | NONE | methyl coenzyme M | 2.6E−83 |
| | | | | | reductase I, C protein | |
| MSM1018 | Msp_0319 | MrtD | 7.4E−19 | NONE | methyl coenzyme M | 1.1E−34 |
| | | | | | reductase I, D protein | |
| MSM1019 | Msp_0318 | MrtB | 1.6E−133 | NONE | methyl coenzyme M | 3.4E−177 |
| | | | | | reductase I, beta subunit | |
| MSM1020 | Msp_0298 | predicted Fe—S oxidoreductase | 2.0E−119 | MTH_1170 | conserved protein | 1.7E−136 |
| MSM1021 | Msp_0284 | conserved hypothetical protein | 1.7E−99 | MTH_1180 | conserved protein | 6.7E−117 |
| MSM1022 | Msp_0285 | conserved hypothetical protein | 8.5E−34 | MTH_1181 | unknown | 2.0E−23 |
| MSM1023 | Msp_0973 | ComB2 | 1.3E−44 | MTH_1182 | conserved protein | 2.7E−42 |
| MSM1024 | Msp_0287 | conserved hypothetical | 1.9E−98 | MTH_1183 | pheromone shutdown | 4.4E−58 |
| | | membrane-spanning protein | | | protein TraB | |
| MSM1025 | Msp_0288 | hypothetical protein | 1.5E−20 | MTH_1184 | unknown | 3.0E−20 |
| MSM1026 | NONE | | | MTH_1224 | inosine-5′- | 5.6E−04 |
| | | | | | monophosphate | |
| | | | | | dehydrogenase related | |
| | | | | | protein III | |
| MSM1027 | NONE | | | MTH_1155 | Na+/Ca+ exchanging | 2.1E−42 |
| | | | | | protein related | |
| MSM1028 | Msp_0289 | predicted ATPase | 9.5E−74 | MTH_1186 | conserved protein | 2.0E−85 |
| MSM1029 | Msp_0693 | conserved hypothetical protein | 1.3E−39 | MTH_1187 | conserved protein | 3.2E−23 |
| MSM1030 | Msp_0290 | predicted pyridoxal phosphate- | 1.3E−124 | MTH_1188 | pleiotropic regulatory | 6.1E−123 |
| | | dependent enzyme | | | protein DegT | |
| MSM1031 | Msp_0291 | N2,N2-dimethylguanosine tRNA | 1.1E−109 | NONE | N2,N2-dimethylguanosine | 4.1E−110 |
| | | methyltransferase | | | tRNA methyltransferase | |
| MSM1032 | Msp_0293 | predicted transcriptional regulator | 9.3E−44 | MTH_1193 | transcriptional regulator | 2.9E−52 |
| MSM1033 | Msp_0294 | conserved hypothetical protein | 1.8E−109 | MTH_1196 | conserved protein | 7.7E−116 |
| MSM1034 | Msp_0295 | conserved hypothetical protein | 6.0E−17 | MTH_1197 | conserved protein | 1.1E−22 |
| MSM1035 | Msp_0296 | CofG | 4.2E−96 | MTH_1198 | biotin synthetase related | 6.4E−105 |
| | | | | | protein | |
| MSM1036 | Msp_0297 | predicted methyltransferase | 2.3E−70 | MTH_1200 | met-10+ related protein | 5.7E−72 |
| MSM1037 | Msp_0282 | PsmB | 7.5E−58 | NONE | proteasome, beta subunit | 7.8E−68 |
| MSM1038 | Msp_0281 | predicted exonuclease | 5.4E−245 | MTH_1203 | cleavage and | 3.5E−278 |
| | | | | | polyadenylation specificity | |
| | | | | | factor | |
| MSM1039 | Msp_0280 | PurM | 1.6E−103 | MTH_1204 | phosphoribosylformylglycinamidine | 4.0E−112 |
| | | | | | cyclo-ligase | |
| MSM1040 | Msp_0279 | ComC | 7.6E−104 | MTH_1205 | malate dehydrogenase | 5.7E−104 |
| MSM1041 | Msp_1507 | putative DNA polymerase | 6.8E−167 | MTH_1208 | DNA-dependent DNA | 5.1E−183 |
| | | | | | polymerase family B | |
| | | | | | (PolB1) | |
| MSM1042 | NONE | | | MTH_1211 | conserved protein | 4.0E−71 |
| MSM1043 | Msp_1420 | PyrK | 4.4E−69 | NONE | cytochrome-c3 | 1.6E−74 |
| | | | | | hydrogenase, gamma | |
| | | | | | subunit | |
| MSM1044 | Msp_1421 | PyrD | 7.4E−90 | MTH_1213 | dihydroorotate oxidase | 1.3E−106 |
| MSM1045 | Msp_0220 | predicted glycosyltransferase | 1.9E−12 | MTH_1626 | phosphoserine | 2.4E−05 |
| | | | | | phosphatase | |
| MSM1046 | Msp_1422 | predicted ribosomal biogenesis | 1.2E−89 | MTH_1214 | pre-mRNA splicing protein | 1.4E−88 |
| | | protein | | | PRP31 | |
| MSM1047 | Msp_1423 | FlpA | 5.3E−64 | MTH_1215 | fibrillarin-like pre-rRNA | 2.5E−62 |
| | | | | | processing protein | |
| MSM1048 | Msp_1424 | predicted | 1.9E−43 | MTH_1216 | pantothenate metabolism | 2.3E−52 |
| | | phosphopantothenoylcysteine | | | flavoprotein | |
| | | synthetase/decarboxylase | | | | |
| MSM1049 | Msp_1424 | predicted | 2.0E−55 | MTH_1216 | pantothenate metabolism | 2.2E−54 |
| | | phosphopantothenoylcysteine | | | flavoprotein | |
| | | synthetase/decarboxylase | | | | |
| MSM1050 | Msp_1425 | conserved hypothetical | 4.7E−11 | MTH_1218 | unknown | 3.3E−21 |
| | | membrane-spanning protein | | | | |
| MSM1051 | Msp_1426 | hypothetical membrane-spanning | 3.5E−05 | MTH_1219 | unknown | 9.0E−19 |
| | | protein | | | | |
| MSM1052 | Msp_1427 | PheA | 2.5E−59 | MTH_1220 | chorismate mutase | 1.1E−70 |
| MSM1053 | Msp_1428 | conserved hypothetical protein | 4.4E−60 | MTH_1222 | inosine-5′- | 4.5E−72 |
| | | | | | monophosphate | |
| | | | | | dehydrogenase related | |
| | | | | | protein I | |
| MSM1054 | Msp_1429 | conserved hypothetical protein | 2.2E−74 | MTH_1224 | inosine-5′- | 1.3E−83 |
| | | | | | monophosphate | |
| | | | | | dehydrogenase related | |
| | | | | | protein III | |
| MSM1055 | Msp_1431 | partially conserved hypothetical | 1.9E−36 | MTH_1227 | coenzyme PQQ synthesis | 1.9E−57 |
| | | protein | | | protein III | |
| MSM1056 | Msp_1432 | putative 6-pyruvoyl | 1.4E−38 | MTH_1228 | conserved protein | 4.6E−47 |
| | | tetrahydrobiopterin synthase | | | | |
| MSM1057 | Msp_1433 | conserved hypothetical protein | 2.1E−53 | MTH_1229 | conserved protein | 2.1E−49 |
| MSM1058 | Msp_1434 | conserved hypothetical protein | 5.6E−85 | MTH_1231 | conserved protein | 1.1E−95 |
| MSM1059 | Msp_0945 | predicted RecB family | 1.2E−06 | MTH_1233 | unknown | 1.4E−36 |
| | | exonuclease | | | | |
| MSM1060 | Msp_1436 | EhbQ | 4.9E−61 | MTH_1235 | conserved protein | 1.2E−69 |
| MSM1061 | Msp_1442 | EhbP | 6.3E−22 | MTH_1236 | conserved protein | 1.6E−28 |
| MSM1062 | Msp_1443 | EhbO | 6.1E−79 | NONE | NADH dehydrogenase | 5.8E−111 |
| | | | | | (ubiquinone), subunit 1 | |
| | | | | | related protein | |
| MSM1063 | Msp_1444 | EhbN | 8.0E−141 | NONE | formate hydrogenlyase, | 2.8E−143 |
| | | | | | subunit 5 | |
| MSM1064 | Msp_1445 | EhbM | 1.0E−62 | NONE | formate hydrogenlyase, | 1.6E−67 |
| | | | | | subunit 7 | |
| MSM1065 | Msp_1446 | EhbL | 8.6E−41 | MTH_1240 | ferredoxin-like protein | 3.4E−51 |
| MSM1066 | Msp_1447 | EhbK | 7.7E−72 | MTH_1241 | polyferredoxin | 1.7E−97 |
| MSM1067 | Msp_1448 | EhbJ | 4.5E−12 | MTH_1242 | unknown | 5.5E−19 |
| MSM1068 | Msp_1449 | EhbI | 4.2E−48 | MTH_1243 | conserved protein | 1.0E−49 |
| MSM1069 | Msp_1450 | EhbH | 3.5E−21 | MTH_1244 | conserved protein | 5.0E−25 |
| MSM1070 | Msp_1451 | EhbG | 4.8E−15 | MTH_1245 | unknown | 6.6E−16 |
| MSM1071 | Msp_1452 | EhbF | 1.1E−134 | NONE | NADH dehydrogenase I, | 8.4E−142 |
| | | | | | subunit N | |
| MSM1072 | Msp_1453 | EhbE | 2.0E−32 | MTH_1247 | conserved protein | 4.5E−40 |
| MSM1073 | Msp_1454 | EhbD | 4.1E−18 | MTH_1248 | conserved protein | 9.4E−24 |
| MSM1074 | Msp_1455 | EhbC | 1.4E−10 | MTH_1249 | conserved protein | 1.5E−18 |
| MSM1075 | Msp_1456 | EhbB | 2.2E−10 | MTH_1250 | unknown | 1.1E−13 |
| MSM1076 | Msp_1457 | EhbA | 1.2E−27 | MTH_1251 | conserved protein | 6.8E−37 |
| MSM1077 | Msp_1336 | predicted permease | 2.3E−05 | NONE | | |
| MSM1078 | Msp_1336 | predicted permease | 9.6E−97 | MTH_900 | conserved protein | 3.1E−32 |
| MSM1079 | Msp_1458 | conserved hypothetical | 2.1E−28 | MTH_1252 | conserved protein | 1.6E−35 |
| | | membrane-spanning protein | | | | |
| MSM1080 | NONE | | | MTH_1253 | unknown | 2.5E−48 |
| MSM1081 | Msp_0795 | partially conserved hypothetical | 1.4E−56 | MTH_1634 | transcriptional control | 5.0E−176 |
| | | protein | | | factor (enhancer-binding | |
| | | | | | protein) | |
| MSM1082 | NONE | | | NONE | | |
| MSM1083 | Msp_0202 | conserved hypothetical | 4.5E−35 | MTH_230 | unknown | 1.0E−33 |
| | | membrane-spanning protein | | | | |
| MSM1084 | Msp_1459 | ArgG | 7.4E−138 | MTH_1254 | argininosuccinate | 2.1E−136 |
| | | | | | synthase | |
| MSM1085 | Msp_1240 | AqpM2 | 1.8E−54 | MTH_103 | water channel protein | 1.5E−71 |
| MSM1086 | NONE | | | MTH_101 | unknown | 3.8E−194 |
| MSM1087 | NONE | | | NONE | | |
| MSM1088 | NONE | | | NONE | | |
| MSM1089 | Msp_0506 | hypothetical membrane-spanning | 3.3E−04 | NONE | | |
| | | protein | | | | |
| MSM1090 | Msp_1057 | SfsA | 6.0E−33 | MTH_1521 | sugar fermentation | 3.6E−31 |
| | | | | | stimulation protein | |
| MSM1091 | Msp_1501 | predicted sugar kinase | 3.6E−97 | MTH_1256 | conserved protein | 1.4E−114 |
| MSM1092 | Msp_1502 | formylmethanofuran- | 1.2E−91 | MTH_1259 | formylmethanofuran: | 1.3E−127 |
| | | tetrahydromethanopterin | | | tetrahydromethanopterin | |
| | | formyltransferase | | | formyltransferase | |
| MSM1093 | Msp_0233 | conserved hypothetical protein | 2.3E−22 | NONE | | |
| MSM1094 | Msp_1503 | conserved hypothetical | 2.8E−81 | MTH_1261 | conserved protein | 7.2E−97 |
| | | membrane-spanning protein | | | | |
| MSM1095 | Msp_0830 | Trk-type potassium transport | 2.6E−62 | MTH_1264 | TRK system potassium | 2.1E−122 |
| | | system, membrane protein | | | uptake protein TrkH | |
| MSM1096 | Msp_0250 | TrkA1 | 3.1E−52 | MTH_1265 | TRK system potassium | 3.6E−79 |
| | | | | | uptake protein TrkA | |
| MSM1097 | Msp_1505 | putative Zn-dependent hydrolase | 2.3E−40 | MTH_1267 | conserved protein | 1.2E−53 |
| MSM1098 | Msp_1418 | putative archaeal holliday junction | 1.4E−38 | MTH_1270 | conserved protein | 1.4E−43 |
| | | resolvase | | | | |
| MSM1099 | Msp_0270 | predicted biotin synthase related | 7.4E−106 | MTH_1279 | conserved protein | 2.3E−75 |
| | | protein | | | | |
| MSM1100 | NONE | | | MTH_627 | unknown | 7.2E−10 |
| MSM1101 | Msp_0269 | GatB | 1.4E−175 | MTH_1280 | PET112-like protein | 3.6E−182 |
| MSM1102 | Msp_0268 | conserved hypothetical protein | 3.4E−78 | MTH_1282 | inosine-5′- | 2.3E−93 |
| | | | | | monophosphate | |
| | | | | | dehydrogenase related | |
| | | | | | protein VI | |
| MSM1103 | Msp_0267 | HisE | 4.8E−31 | MTH_1283 | phosphoribosyl-AMP | 3.0E−34 |
| | | | | | cyclohydrolase homolog | |
| MSM1104 | Msp_1506 | predicted acetyltransferase | 2.6E−11 | MTH_1284 | conserved protein | 3.2E−16 |
| MSM1105 | Msp_1492 | conserved hypothetical protein | 7.0E−62 | MTH_1286 | phosphoribosylaminoimidazole | 1.7E−65 |
| | | | | | carboxylase related | |
| | | | | | protein | |
| MSM1106 | Msp_1497 | HypF | 8.5E−208 | MTH_1287 | transcriptional regulator | 2.3E−219 |
| | | | | | HypF homolog | |
| MSM1107 | Msp_1519 | predicted transcriptional regulator | 6.6E−34 | MTH_1288 | unknown | 1.8E−52 |
| MSM1108 | Msp_1518 | GrpE | 2.1E−44 | MTH_1289 | heat shock protein GrpE | 1.6E−44 |
| MSM1109 | Msp_1517 | DnaK | 8.6E−247 | MTH_1290 | DnaK protein (Hsp70) | 7.7E−251 |
| MSM1110 | Msp_1516 | DnaJ | 3.0E−118 | MTH_1291 | DnaJ protein | 1.0E−122 |
| MSM1111 | Msp_0145 | member of asn/thr-rich large | 5.9E−49 | MTH_716 | cell surface glycoprotein | 7.7E−12 |
| | | protein family | | | (s-layer protein) | |
| MSM1112 | Msp_0762 | member of asn/thr-rich large | 1.6E−40 | MTH_716 | cell surface glycoprotein | 3.3E−11 |
| | | protein family | | | (s-layer protein) | |
| MSM1113 | Msp_0762 | member of asn/thr-rich large | 2.9E−70 | MTH_716 | cell surface glycoprotein | 1.2E−05 |
| | | protein family | | | (s-layer protein) | |
| MSM1114 | Msp_0145 | member of asn/thr-rich large | 1.3E−24 | MTH_716 | cell surface glycoprotein | 3.3E−15 |
| | | protein family | | | (s-layer protein) | |
| MSM1115 | Msp_0017 | conserved hypothetical protein | 2.2E−21 | NONE | | |
| MSM1116 | Msp_1108 | member of asn/thr-rich large | 4.2E−137 | MTH_911 | probable surface protein | 1.5E−12 |
| | | protein family | | | | |
| MSM1117 | Msp_1110 | CobN | 8.5E−304 | MTH_514 | cobalamin biosynthesis | 1.4E−239 |
| | | | | | protein N | |
| MSM1118 | Msp_1494 | hypothetical membrane-spanning | 1.5E−18 | MTH_1294 | unknown | 2.5E−23 |
| | | protein | | | | |
| MSM1119 | Msp_1495 | hypothetical membrane-spanning | 4.1E−25 | MTH_1295 | unknown | 4.8E−36 |
| | | protein | | | | |
| MSM1120 | Msp_1496 | methionine aminopeptidase | 3.4E−53 | MTH_1296 | methionine | 2.8E−86 |
| | | | | | aminopeptidase | |
| MSM1121 | Msp_1305 | FrhB | 3.9E−77 | NONE | coenzyme F420-reducing | 2.1E−97 |
| | | | | | hydrogenase, beta | |
| | | | | | subunit | |
| MSM1122 | Msp_1304 | FrhG | 4.6E−81 | NONE | coenzyme F420-reducing | 2.2E−102 |
| | | | | | hydrogenase, gamma | |
| | | | | | subunit | |
| MSM1123 | Msp_1514 | putative coenzyme F420 | 9.3E−44 | NONE | coenzyme F420-reducing | 4.7E−61 |
| | | hydrogenase, delta subunit-like | | | hydrogenase, delta | |
| | | protein | | | subunit | |
| MSM1124 | Msp_1302 | FrhA | 9.4E−138 | NONE | coenzyme F420-reducing | 8.8E−163 |
| | | | | | hydrogenase, alpha | |
| | | | | | subunit | |
| MSM1125 | Msp_1110 | CobN | 2.3E−10 | MTH_1301 | unknown | 3.8E−11 |
| MSM1126 | Msp_0120 | predicted transcriptional regulator | 3.1E−20 | MTH_1795 | transcriptional regulator | 1.1E−20 |
| MSM1127 | Msp_0121 | predicted cation transport ATPase | 1.2E−162 | MTH_411 | cadmium efflux ATPase | 1.2E−119 |
| MSM1128 | NONE | | | NONE | | |
| MSM1129 | Msp_1523 | conserved hypothetical protein | 2.3E−118 | MTH_1305 | conserved protein | 3.6E−134 |
| MSM1130 | Msp_1028 | conserved hypothetical protein | 4.5E−44 | MTH_1868 | conserved protein | 1.4E−15 |
| MSM1131 | Msp_1524 | conserved hypothetical protein | 1.1E−56 | MTH_1306 | conserved protein | 1.1E−59 |
| MSM1132 | Msp_1525 | ribosome biogenesis protein | 2.3E−15 | MTH_1307 | unknown | 4.0E−16 |
| | | Nop10 | | | | |
| MSM1133 | Msp_1527 | putative translation initiation factor | 3.4E−94 | NONE | translation initiation factor | 3.5E−104 |
| | | 2, alpha subunit (alF-2alpha) | | | elF-2, alpha subunit | |
| | | (elF2A) | | | | |
| MSM1134 | Msp_1528 | 30S ribosomal protein S27e | 2.3E−17 | MTH_1309 | ribosomal protein S27 | 8.1E−18 |
| MSM1135 | Msp_1529 | 50S ribosomal protein L44e | 1.6E−41 | MTH_1310 | ribosomal protein L36a | 2.7E−42 |
| MSM1136 | Msp_1530 | partially conserved hypothetical | 1.6E−30 | MTH_1311 | unknown | 2.1E−49 |
| | | protein | | | | |
| MSM1137 | Msp_1531 | DNA polymerase sliding clamp | 1.5E−73 | MTH_1312 | proliferating-cell nuclear | 6.0E−93 |
| | | (PCNA) | | | antigen | |
| MSM1138 | Msp_0580 | predicted glutamine | 5.2E−73 | MTH_787 | cobyric acid synthase | 9.2E−10 |
| | | amidotransferase | | | | |
| MSM1139 | Msp_0581 | predicted UDP-N-acetylmuramyl | 3.6E−90 | MTH_530 | UDP-N-acetylmuramyl | 6.8E−16 |
| | | tripeptide synthase | | | tripeptide synthetase | |
| | | | | | related protein | |
| MSM1140 | Msp_0417 | hypothetical membrane-spanning | 2.7E−04 | NONE | | |
| | | protein | | | | |
| MSM1141 | Msp_1075 | TrpA | 7.3E−44 | NONE | tryptophan synthase, | 6.5E−48 |
| | | | | | subunit alpha | |
| MSM1142 | Msp_1074 | TrpB | 6.4E−123 | NONE | tryptophan synthase, | 1.3E−120 |
| | | | | | beta subunit | |
| MSM1143 | Msp_1072 | TrpC | 1.7E−42 | MTH_1657 | indole-3-glycerol | 1.4E−38 |
| | | | | | phosphate synthase | |
| MSM1144 | Msp_1076 | TrpD | 2.0E−71 | MTH_1661 | anthranilate | 2.3E−68 |
| | | | | | phosphoribosyltransferase | |
| MSM1145 | Msp_1071 | TrpG | 7.4E−51 | MTH_1656 | anthranilate synthase | 1.1E−43 |
| | | | | | component II | |
| MSM1146 | Msp_1070 | TrpE | 6.5E−78 | MTH_1655 | anthranilate synthase | 9.9E−84 |
| | | | | | component I | |
| MSM1147 | NONE | | | NONE | | |
| MSM1148 | NONE | | | MTH_1189 | conserved protein | 8.2E−08 |
| MSM1149 | Msp_0607 | hypothetical membrane-spanning | 6.0E−33 | MTH_1192 | conserved protein | 2.8E−31 |
| | | protein | | | | |
| MSM1150 | Msp_0608 | predicted transcriptional regulator | 9.4E−19 | MTH_1328 | conserved protein | 1.3E−17 |
| MSM1151 | Msp_1247 | PurB | 6.0E−159 | MTH_1537 | adenylosuccinate lyase | 8.4E−174 |
| MSM1152 | Msp_0879 | hypothetical membrane-spanning | 2.8E−04 | MTH_1538 | unknown | 6.4E−25 |
| | | protein | | | | |
| MSM1153 | Msp_0224 | predicted cation transport ATPase | 1.1E−205 | MTH_1535 | heavy-metal transporting | 5.1E−199 |
| | | | | | CPx-type ATPase | |
| MSM1154 | Msp_0200 | predicted metal-dependent | 1.2E−07 | MTH_1534 | aryldialkylphosphatase | 5.0E−89 |
| | | hydrolase | | | related protein | |
| MSM1155 | Msp_0225 | conserved hypothetical protein | 1.4E−40 | MTH_1530 | conserved protein | 1.7E−42 |
| MSM1156 | Msp_0221 | TruD | 6.2E−125 | MTH_1529 | conserved protein | 4.6E−134 |
| MSM1157 | Msp_1512 | hypothetical membrane-spanning | 3.5E−05 | MTH_1526 | conserved protein | 8.9E−04 |
| | | protein | | | | |
| MSM1158 | Msp_1511 | HypE2 | 8.9E−126 | MTH_1525 | hydrogenase | 4.2E−156 |
| | | | | | expression/formation | |
| | | | | | protein HypE related | |
| | | | | | protein | |
| MSM1159 | Msp_1510 | HisH | 3.0E−38 | MTH_1524 | imidazoleglycerol- | 9.1E−58 |
| | | | | | phosphate synthase | |
| MSM1160 | Msp_1461 | predicted nitrogenase | 3.8E−118 | MTH_1522 | nitrogenase alpha chain | 8.9E−131 |
| | | molybdenum-iron protein | | | (NifD) related protein | |
| MSM1161 | Msp_0719 | partially conserved hypothetical | 2.8E−05 | NONE | | |
| | | membrane-spanning protein | | | | |
| MSM1162 | NONE | | | NONE | | |
| MSM1163 | NONE | | | NONE | | |
| MSM1164 | Msp_1463 | predicted GTPase | 1.4E−143 | MTH_1515 | GTP-binding protein | 2.4E−153 |
| MSM1165 | Msp_1472 | predicted phosphohydrolase | 2.2E−67 | MTH_1179 | conserved protein | 9.0E−10 |
| MSM1166 | Msp_1474 | conserved hypothetical membrane- | 1.5E−146 | NONE | | |
| | | spanning protein | | | | |
| MSM1167 | Msp_1464 | CbiE | 6.8E−48 | MTH_1514 | precorrin-6Y methylase | 3.9E−50 |
| MSM1168 | Msp_0590 | member of asn/thr-rich large | 1.7E−16 | MTH_75 | surface protease related | 2.1E−11 |
| | | protein family | | | protein | |
| MSM1169 | NONE | | | NONE | | |
| MSM1170 | Msp_0169 | putative arsenical prump-driving | 5.3E−96 | MTH_1511 | arsenical pump-driving | 6.9E−108 |
| | | ATPase | | | ATPase | |
| MSM1171 | Msp_0170 | NadE | 1.1E−63 | MTH_1510 | NH(3)-dependent NAD+ | 1.3E−60 |
| | | | | | synthetase | |
| MSM1172 | Msp_0171 | LeuS | 0.0E+00 | MTH_1508 | leucyl-tRNA synthetase | 0.0E+00 |
| MSM1173 | Msp_0004 | predicted tRNA(1- | 1.0E−62 | MTH_1414 | protein-L-isoaspartate | 1.4E−77 |
| | | methyladenosine) | | | methyltransferase | |
| | | methyltransferase | | | homolog | |
| MSM1174 | Msp_0309 | HtpX | 1.8E−38 | MTH_569 | heat shock protein X | 2.1E−67 |
| MSM1175 | Msp_0548 | hypothetical membrane-spanning | 6.6E−11 | NONE | | |
| | | protein | | | | |
| MSM1176 | Msp_0413 | RfcS | 2.2E−115 | NONE | replication factor C, small | 3.7E−125 |
| | | | | | subunit | |
| MSM1177 | Msp_0414 | RfcL | 1.1E−113 | NONE | replication factor C, large | 3.8E−123 |
| | | | | | subunit | |
| MSM1178 | Msp_0578 | conserved hypothetical protein | 4.1E−34 | MTH_239 | unknown | 9.7E−38 |
| MSM1179 | Msp_0647 | AroE | 1.8E−72 | MTH_242 | shikimate 5- | 1.2E−71 |
| | | | | | dehydrogenase | |
| MSM1180 | NONE | | | MTH_1189 | conserved protein | 1.6E−08 |
| MSM1181 | Msp_0648 | HisS | 5.1E−114 | MTH_244 | histidyl-tRNA synthetase | 3.8E−130 |
| MSM1182 | Msp_0649 | HisI | 1.6E−39 | MTH_245 | phosphoribosyl-AMP | 1.0E−40 |
| | | | | | cyclohydrolase | |
| MSM1183 | Msp_0650 | predicted ATPase | 1.5E−155 | MTH_246 | twitching mobility (PilT) | 8.0E−185 |
| | | | | | related protein | |
| MSM1184 | Msp_0651 | predicted sugar phosphate | 8.7E−48 | MTH_247 | conserved protein | 4.5E−49 |
| | | isomerase/epimerase or | | | | |
| | | endonuclease | | | | |
| MSM1185 | Msp_1499 | putative methylated-DNA-protein- | 1.3E−12 | MTH_618 | O6-methylguanidine- | 2.8E−15 |
| | | cysteine methyltransferase | | | DNA methyltransferase | |
| MSM1186 | Msp_1489 | predicted potassium transport | 9.9E−111 | NONE | | |
| | | system, membrane component | | | | |
| MSM1187 | Msp_0007 | predicted ERCC4-like helicase | 5.4E−213 | NONE | ATP-dependent RNA | 3.5E−241 |
| | | | | | helicase, elF-4A family | |
| MSM1188 | Msp_0590 | member of asn/thr-rich large | 1.4E−49 | MTH_716 | cell surface glycoprotein | 6.9E−13 |
| | | protein family | | | (s-layer protein) | |
| MSM1189 | Msp_0017 | conserved hypothetical protein | 1.7E−28 | NONE | | |
| MSM1190 | Msp_1211 | partially conserved hypothetical | 6.7E−128 | MTH_530 | UDP-N-acetylmuramyl | 3.1E−57 |
| | | membrane-spanning protein | | | tripeptide synthetase | |
| | | | | | related protein | |
| MSM1191 | Msp_1212 | predicted UDP-N- | 7.9E−102 | MTH_531 | UDP-N-acetylmuramyl | 1.3E−40 |
| | | acetylmuramoylalanine-D- | | | tripeptide synthetase | |
| | | glutamate ligase | | | related protein | |
| MSM1192 | Msp_0008 | conserved hypothetical protein | 9.1E−124 | MTH_1421 | conserved protein | 5.0E−137 |
| MSM1193 | Msp_0009 | putative single-stranded-DNA- | 9.9E−111 | MTH_1422 | conserved protein | 9.3E−136 |
| | | specific exonuclease | | | | |
| MSM1194 | Msp_0010 | 30S ribosomal protein S15P | 5.3E−48 | MTH_1423 | ribosomal protein S13 | 2.1E−49 |
| | | | | | (E. coli) | |
| MSM1195 | Msp_0011 | putative xanthosine triphosphate | 1.9E−61 | MTH_1424 | conserved protein | 1.2E−62 |
| | | pyrophosphatase | | | | |
| MSM1196 | Msp_0635 | cell division control protein 6-like 2 | 9.7E−06 | NONE | | |
| MSM1197 | NONE | | | NONE | | |
| MSM1198 | Msp_0013 | putative O-sialoglycoprotein | 7.7E−159 | MTH_1425 | O-sialoglycoprotein | 1.9E−174 |
| | | endopeptidase | | | endopeptidase | |
| MSM1199 | Msp_0999 | hypothetical protein | 7.0E−06 | NONE | | |
| MSM1200 | Msp_0012 | predicted | 1.4E−88 | MTH_1426 | conserved protein | 3.4E−99 |
| | | phosphoribosyltransferase | | | | |
| MSM1201 | Msp_0014 | UppP | 6.0E−72 | MTH_1428 | bacitracin resistance | 1.1E−43 |
| | | | | | protein | |
| MSM1202 | Msp_0015 | IlvE | 4.0E−114 | MTH_1430 | branched-chain amino- | 5.2E−110 |
| | | | | | acid aminotransferase | |
| MSM1203 | Msp_0724 | hypothetical membrane-spanning | 6.7E−09 | MTH_470 | conserved protein | 7.9E−05 |
| | | protein | | | | |
| MSM1204 | Msp_0163 | F420-dependent | 4.0E−82 | NONE | coenzyme F420- | 2.2E−102 |
| | | methylenetetrahydromethanopterin | | | dependent N5,N10- | |
| | | dehydrogenase | | | methylene | |
| | | | | | tetrahydromethanopterin | |
| | | | | | dehydrogenase | |
| MSM1205 | Msp_0417 | hypothetical membrane-spanning | 5.3E−04 | MTH_1490 | unknown | 3.5E−17 |
| | | protein | | | | |
| MSM1206 | Msp_0164 | HisB | 2.5E−57 | MTH_1467 | imidazoleglycerol- | 9.7E−54 |
| | | | | | phosphate dehydratase | |
| MSM1207 | NONE | | | MTH_1470 | molybdenum transport | 2.2E−17 |
| | | | | | protein ModA related | |
| | | | | | protein | |
| MSM1208 | Msp_0165 | predicted polysaccharide | 5.0E−116 | MTH_1471 | O-antigen transporter | 3.2E−87 |
| | | biosynthesis protein | | | homolog | |
| MSM1209 | Msp_0540 | predicted multimeric flavodoxin | 6.7E−25 | MTH_1473 | conserved protein | 4.7E−54 |
| MSM1210 | Msp_0925 | predicted arabinose efflux | 7.5E−22 | MTH_195 | efflux pump antibiotic | 2.5E−24 |
| | | permease | | | resistance protein | |
| MSM1211 | Msp_0260 | hypothetical protein | 4.6E−16 | MTH_1626 | phosphoserine | 4.3E−06 |
| | | | | | phosphatase | |
| MSM1212 | NONE | | | NONE | | |
| MSM1213 | Msp_1498 | formaldehyde activating enzyme | 8.3E−162 | MTH_1474 | D-arabino 3-hexulose 6- | 6.3E−169 |
| | | fused to 3-hexulose-6phosphate | | | phosphate formaldehyde | |
| | | synthase | | | lyase related protein | |
| MSM1214 | Msp_1573 | ThrS | 7.3E−202 | MTH_1455 | threonyl-tRNA | 1.3E−225 |
| | | | | | synthetase | |
| MSM1215 | Msp_0162 | CbiA | 1.7E−147 | NONE | cobyrinic acid a,c- | 9.4E−143 |
| | | | | | diamide synthase | |
| MSM1216 | Msp_0166 | conserved hypothetical membrane- | 1.3E−74 | MTH_1461 | conserved protein | 2.1E−67 |
| | | spanning protein | | | | |
| MSM1217 | Msp_0019 | partially conserved hypothetical | 5.0E−45 | MTH_1434 | unknown | 1.3E−55 |
| | | protein | | | | |
| MSM1218 | Msp_0020 | SurE | 1.2E−68 | MTH_1435 | survival protein SurE | 1.5E−73 |
| MSM1219 | NONE | | | NONE | | |
| MSM1220 | NONE | | | MTH_1440 | unknown | 8.6E−14 |
| MSM1221 | Msp_0021 | conserved hypothetical protein | 5.2E−89 | MTH_1441 | conserved protein | 3.4E−106 |
| MSM1222 | Msp_0022 | IlvC | 6.9E−126 | MTH_1442 | ketol-acid | 2.7E−122 |
| | | | | | reductoisomerase | |
| MSM1223 | Msp_0591 | predicted carbonic anhydrase | 8.1E−13 | MTH_1582 | carbonic anhydrase | 3.7E−38 |
| MSM1224 | Msp_0025 | IlvH1 | 1.1E−45 | NONE | acetolactate synthase, | 4.1E−55 |
| | | | | | small subunit | |
| MSM1225 | Msp_0026 | IlvB1 | 6.3E−180 | NONE | acetolactate synthase, | 3.5E−207 |
| | | | | | large subunit | |
| MSM1226 | Msp_0031 | ArgF | 2.3E−102 | MTH_1446 | ornithine | 4.6E−102 |
| | | | | | carbamoyltransferase | |
| MSM1227 | Msp_0030 | PurD | 1.1E−150 | MTH_1445 | glycinamide | 4.2E−147 |
| | | | | | ribonucleotide | |
| | | | | | synthetase | |
| MSM1228 | Msp_0513 | predicted Na+-driven multidrug | 5.6E−108 | MTH_314 | conserved protein | 2.8E−95 |
| | | efflux pump | | | | |
| MSM1229 | Msp_0513 | predicted Na+-driven multidrug | 1.1E−125 | MTH_314 | conserved protein | 3.1E−105 |
| | | efflux pump | | | | |
| MSM1230 | Msp_0512 | predicted transcriptional regulator | 5.3E−25 | MTH_313 | transcriptional regulator | 2.2E−17 |
| MSM1231 | Msp_1574 | ArgS | 1.4E−157 | MTH_1447 | arginyl-tRNA synthetase | 9.3E−175 |
| MSM1232 | Msp_1575 | putative signal peptidase | 3.6E−42 | MTH_1448 | signal peptidase | 2.7E−42 |
| MSM1233 | Msp_1180 | HemL | 5.8E−138 | MTH_228 | glutamate-1- | 2.1E−136 |
| | | | | | semialdehyde | |
| | | | | | aminotransferase | |
| MSM1234 | Msp_1179 | CbiC | 8.2E−68 | MTH_227 | precorrin isomerase | 7.1E−58 |
| MSM1235 | Msp_0093 | predicted flavoprotein | 2.5E−59 | NONE | | |
| MSM1236 | Msp_0135 | AspS | 1.9E−164 | MTH_226 | aspartyl-tRNA | 1.2E−165 |
| | | | | | synthetase | |
| MSM1237 | Msp_1576 | IlvD | 7.2E−195 | MTH_1449 | dihydroxy-acid | 3.4E−177 |
| | | | | | dehydratase | |
| MSM1238 | Msp_0134 | HisD | 2.7E−131 | MTH_225 | histidinol dehydrogenase | 2.7E−138 |
| MSM1239 | Msp_1569 | predicted DNA-binding protein | 2.7E−92 | MTH_1458 | unknown | 5.1E−96 |
| MSM1240 | Msp_1570 | conserved hypothetical protein | 8.9E−23 | MTH_1457 | unknown | 3.0E−24 |
| MSM1241 | Msp_1571 | predicted ATPase | 5.2E−82 | MTH_1456 | chromosome partitioning | 1.9E−73 |
| | | | | | protein Soj | |
| MSM1242 | Msp_1074 | TrpB | 7.2E−37 | NONE | tryptophan synthase, | 1.0E−168 |
| | | | | | beta subunit homolog | |
| MSM1243 | NONE | | | MTH_1477 | unknown | 3.1E−73 |
| MSM1244 | Msp_1491 | predicted metal-dependent | 1.9E−45 | MTH_1478 | conserved protein | 8.9E−28 |
| | | phosphoesterase | | | | |
| MSM1245 | Msp_0198 | AlbA | 2.2E−26 | MTH_1483 | conserved protein | 3.8E−27 |
| MSM1246 | Msp_0199 | LeuA1 | 8.3E−162 | MTH_1481 | isopropylmalate synthase | 2.8E−175 |
| MSM1247 | Msp_0197 | conserved hypothetical membrane- | 2.6E−78 | MTH_1485 | serine/threonine protein | 1.2E−92 |
| | | spanning protein | | | kinase related protein | |
| MSM1248 | Msp_0196 | ABC-type multidrug transport | 4.6E−74 | MTH_1486 | conserved protein | 1.5E−82 |
| | | system, permease protein | | | | |
| MSM1249 | Msp_0195 | ABC-type multidrug transport | 1.6E−94 | MTH_1487 | ABC transporter (ATP- | 5.1E−103 |
| | | system, ATP-binding protein | | | binding | |
| MSM1250 | Msp_0194 | predicted transcriptional regulator | 3.6E−19 | MTH_1488 | unknown | 1.6E−19 |
| MSM1251 | Msp_0651 | predicted sugar phosphate | 7.5E−26 | MTH_1489 | conserved protein | 8.8E−60 |
| | | isomerase/epimerase or | | | | |
| | | endonuclease | | | | |
| MSM1252 | Msp_0191 | MapB | 8.0E−38 | MTH_1493 | cation transporting P- | 1.8E−54 |
| | | | | | type ATPase related | |
| | | | | | protein | |
| MSM1253 | Msp_0181 | GatA | 2.1E−165 | MTH_1496 | amidase | 1.1E−164 |
| MSM1254 | Msp_0174 | predicted cobyric acid synthase | 7.3E−115 | NONE | cobyrinic acid a,c- | 8.9E−115 |
| | | | | | diamide synthase related | |
| | | | | | protein | |
| MSM1255 | NONE | | | NONE | | |
| MSM1256 | Msp_0175 | RibB | 2.5E−59 | MTH_1499 | GTP cyclohydrolase II | 2.8E−63 |
| MSM1257 | Msp_0177 | predicted transcriptional regulator | 1.7E−19 | MTH_1500 | conserved protein | 9.4E−24 |
| MSM1258 | Msp_0180 | TfrA | 2.0E−174 | NONE | succinate | 3.9E−185 |
| | | | | | dehydrogenase, | |
| | | | | | flavoprotein subunit | |
| MSM1259 | Msp_0200 | predicted metal-dependent | 1.0E−115 | MTH_1505 | N-ethylammeline | 9.3E−120 |
| | | hydrolase | | | chlorohydrolase homolog | |
| MSM1260 | Msp_0383 | archaeal histone | 8.8E−16 | MTH_1696 | histone HMtA2 | 8.4E−16 |
| MSM1261 | Msp_0178 | HisG | 1.4E−88 | MTH_1506 | ATP | 1.3E−90 |
| | | | | | phosphoribosyltransferase | |
| MSM1262 | NONE | | | NONE | | |
| MSM1263 | Msp_0003 | PyrB | 8.4E−98 | MTH_1413 | aspartate | 5.1E−96 |
| | | | | | carbamoyltransferase | |
| MSM1264 | Msp_0001 | cell division control protein 6-like 1 | 4.9E−141 | MTH_1412 | Cdc6 related protein | 8.2E−160 |
| MSM1265 | NONE | | | MTH_1410 | unknown | 1.4E−31 |
| MSM1266 | Msp_1588 | CobD | 4.4E−76 | MTH_1409 | cobalamin biosynthesis | 7.6E−54 |
| | | | | | protein B | |
| MSM1267 | Msp_1587 | CbiG | 2.3E−70 | MTH_1408 | cobalamin biosynthesis | 3.0E−50 |
| | | | | | protein G | |
| MSM1268 | Msp_1586 | conserved hypothetical protein | 2.7E−21 | MTH_1407 | conserved protein | 2.6E−28 |
| MSM1269 | NONE | | | NONE | | |
| MSM1270 | Msp_1585 | predicted class II aldolase | 4.7E−40 | MTH_1406 | fuculose-1-phosphate | 4.9E−43 |
| | | | | | aldolase | |
| MSM1271 | Msp_1584 | PolB | 4.5E−131 | MTH_1405 | DNA polymerase delta | 3.6E−156 |
| | | | | | small subunit | |
| MSM1272 | Msp_1583 | hypothetical membrane-spanning | 5.8E−19 | MTH_1404 | unknown | 4.3E−28 |
| | | protein | | | | |
| MSM1273 | Msp_1582 | CbiH | 2.5E−98 | MTH_1403 | precorrin-3 methylase | 1.2E−101 |
| MSM1274 | NONE | | | MTH_1402 | conserved protein | 6.4E−73 |
| MSM1275 | Msp_0962 | hypothetical membrane-spanning | 2.4E−04 | MTH_1401 | unknown | 5.4E−108 |
| | | protein | | | | |
| MSM1276 | Msp_1558 | hypothetical protein | 1.7E−10 | MTH_1400 | unknown | 1.3E−16 |
| MSM1277 | Msp_1559 | conserved hypothetical membrane- | 8.0E−38 | MTH_1399 | unknown | 2.0E−46 |
| | | spanning protein | | | | |
| MSM1278 | Msp_0757 | predicted ATPase | 4.3E−101 | NONE | | |
| MSM1279 | Msp_1562 | conserved hypothetical protein | 1.5E−50 | MTH_1398 | conserved protein | 2.3E−52 |
| MSM1280 | Msp_1561 | conserved hypothetical protein | 5.0E−52 | MTH_1397 | conserved protein | 1.2E−25 |
| MSM1281 | Msp_1563 | CbiX | 7.5E−42 | MTH_1397 | conserved protein | 8.6E−30 |
| MSM1282 | Msp_0590 | member of asn/thr-rich large | 3.1E−13 | MTH_716 | cell surface glycoprotein | 2.7E−05 |
| | | protein family | | | (s-layer protein) | |
| MSM1283 | Msp_1564 | ThiL | 6.8E−48 | MTH_1396 | thiamine monphosphate | 3.1E−57 |
| | | | | | kinase | |
| MSM1284 | Msp_1565 | predicted pyruvate-formate lyase- | 1.5E−66 | MTH_1395 | pyruvate formate-lyase | 3.5E−81 |
| | | activating enzyme | | | activating enzyme | |
| | | | | | related protein | |
| MSM1285 | Msp_0615 | partially conserved hypothetical | 6.8E−05 | NONE | | |
| | | membrane-spanning protein | | | | |
| MSM1286 | Msp_1479 | predicted 3-octaprenyl-4- | 5.7E−147 | MTH_1394 | conserved protein | 3.5E−152 |
| | | hydroxybenzoate carboxy-lyase | | | | |
| MSM1287 | Msp_1480 | PurE | 6.4E−68 | MTH_1393 | phosphoribosylaminoimidazole | 1.9E−80 |
| | | | | | carboxylase | |
| MSM1288 | NONE | | | NONE | | |
| MSM1289 | Msp_1168 | CobS | 6.5E−04 | NONE | | |
| MSM1290 | Msp_0054 | predicted glycosyltransferase | 1.4E−33 | MTH_374 | dolichyl-phosphate | 7.5E−31 |
| | | | | | mannose synthase | |
| | | | | | related protein | |
| MSM1291 | NONE | | | NONE | | |
| MSM1292 | Msp_0920 | predicted transcriptional accessory | 9.5E−232 | NONE | translation initiation | 2.1E−04 |
| | | protein | | | factor elF-2, alpha | |
| | | | | | subunit | |
| MSM1293 | Msp_0965 | predicted nitroreductase | 3.3E−16 | MTH_120 | NADPH-oxidoreductase | 2.1E−33 |
| MSM1294 | Msp_1481 | conserved hypothetical membrane- | 3.4E−124 | MTH_1392 | dolichyl-phosphate | 5.8E−150 |
| | | spanning protein | | | mannoosyltransferase | |
| | | | | | related protein | |
| MSM1295 | Msp_1482 | conserved hypothetical membrane- | 7.0E−94 | MTH_1391 | conserved protein | 3.8E−114 |
| | | spanning protein | | | | |
| MSM1296 | Msp_1483 | RibH | 2.0E−50 | MTH_1390 | riboflavin synthase beta | 1.4E−54 |
| | | | | | subunit | |
| MSM1297 | Msp_0219 | conserved hypothetical protein | 3.0E−70 | NONE | | |
| MSM1298 | Msp_1484 | LeuB | 3.8E−109 | MTH_1388 | 3-isopropylmalate | 3.2E−103 |
| | | | | | dehydrogenase | |
| MSM1299 | Msp_1485 | LeuD1 | 3.1E−43 | NONE | 3-isopropylmalate | 3.3E−60 |
| | | | | | dehydratase, LeuC | |
| | | | | | subunit | |
| MSM1300 | Msp_1486 | LeuC1 | 1.3E−165 | NONE | 3-isopropylmalate | 1.7E−175 |
| | | | | | dehydratase, LeuD | |
| | | | | | subunit | |
| MSM1301 | NONE | | | NONE | | |
| MSM1302 | NONE | | | NONE | | |
| MSM1303 | Msp_0214 | predicted UDP-N-acetyl-D- | 2.3E−143 | MTH_836 | UDP-N-acetyl-D- | 2.8E−79 |
| | | mannosaminuronate | | | mannosaminuronic acid | |
| | | dehydrogenase | | | dehydrogenase | |
| MSM1304 | Msp_1116 | predicted dTDP-4- | 9.6E−42 | MTH_1792 | dTDP-4- | 1.9E−73 |
| | | dehydrorhamnose reductase | | | dehydrorhamnose | |
| | | | | | reductase | |
| MSM1305 | Msp_0762 | member of asn/thr-rich large | 5.3E−36 | MTH_716 | cell surface glycoprotein | 2.2E−12 |
| | | protein family | | | (s-layer protein) | |
| MSM1306 | Msp_0590 | member of asn/thr-rich large | 3.5E−45 | MTH_716 | cell surface glycoprotein | 1.8E−07 |
| | | protein family | | | (s-layer protein) | |
| MSM1307 | Msp_1102 | predicted dTDP-glucose | 4.1E−41 | MTH_1791 | glucose-1-phosphate | 1.4E−123 |
| | | pyrophosphorylase | | | thymidylyltransferase | |
| MSM1308 | Msp_0539 | predicted dTDP-4- | 1.9E−68 | NONE | dTDP-4- | 5.4E−60 |
| | | dehydrorhamnose 3,5-epimerase | | | dehydrorhamnose 3,5- | |
| | | | | | epimerase | |
| MSM1309 | Msp_1114 | predicted dTDP-D-glucose 4,6- | 4.5E−106 | NONE | dTDP-glucose 4,6- | 3.0E−137 |
| | | dehydratase | | | dehydratase | |
| MSM1310 | Msp_0212 | predicted glycosyltransferase | 1.8E−54 | MTH_884 | teichoic acid biosynthesis | 7.1E−10 |
| | | | | | related protein | |
| MSM1311 | Msp_0496 | predicted glycosyltransferase | 2.8E−34 | MTH_136 | dolichyl-phosphate | 2.2E−05 |
| | | | | | mannose synthase | |
| MSM1312 | Msp_0500 | predicted glycosyltransferase | 4.8E−79 | MTH_172 | conserved protein | 6.5E−19 |
| MSM1313 | Msp_0492 | predicted glycosyltransferase | 6.1E−57 | MTH_338 | LPS biosynthesis RfbU | 2.9E−07 |
| | | | | | related protein | |
| MSM1314 | NONE | | | NONE | | |
| MSM1315 | NONE | | | NONE | | |
| MSM1316 | Msp_0495 | predicted glycosyltransferase | 2.3E−33 | MTH_884 | teichoic acid biosynthesis | 8.9E−09 |
| | | | | | related protein | |
| MSM1317 | Msp_0500 | predicted glycosyltransferase | 2.9E−07 | NONE | | |
| MSM1318 | Msp_0927 | hypothetical protein | 2.1E−30 | NONE | | |
| MSM1319 | Msp_0928 | hypothetical protein | 3.0E−31 | NONE | | |
| MSM1320 | Msp_0492 | predicted glycosyltransferase | 4.1E−58 | NONE | | |
| MSM1321 | Msp_0500 | predicted glycosyltransferase | 4.4E−76 | MTH_172 | conserved protein | 9.5E−17 |
| MSM1322 | Msp_0492 | predicted glycosyltransferase | 6.5E−62 | MTH_338 | LPS biosynthesis RfbU | 9.6E−12 |
| | | | | | related protein | |
| MSM1323 | Msp_0495 | predicted glycosyltransferase | 5.3E−34 | MTH_884 | teichoic acid biosynthesis | 2.0E−08 |
| | | | | | related protein | |
| MSM1324 | Msp_0215 | predicted glycosyltransferase | 1.0E−32 | MTH_884 | teichoic acid biosynthesis | 1.5E−08 |
| | | | | | related protein | |
| MSM1325 | Msp_0204 | predicted ABC-type | 1.2E−64 | MTH_1092 | putative membrane | 6.6E−06 |
| | | polysaccharide/polyol phosphate | | | protein | |
| | | export system, permease protein | | | | |
| MSM1326 | Msp_0205 | predicted ABC-type | 3.7E−79 | MTH_1370 | ABC transporter (ATP- | 2.0E−16 |
| | | polysaccharide/polyol phosphate | | | binding protein) | |
| | | export system, ATP-binding protein | | | | |
| MSM1327 | NONE | | | MTH_361 | teichoic acid biosynthesis | 2.4E−17 |
| | | | | | protein RodC related | |
| | | | | | protein | |
| MSM1328 | Msp_0212 | predicted glycosyltransferase | 2.9E−26 | MTH_884 | teichoic acid biosynthesis | 2.0E−12 |
| | | | | | related protein | |
| MSM1329 | Msp_0206 | predicted glycosyltransferase | 5.2E−82 | MTH_172 | conserved protein | 2.5E−46 |
| MSM1330 | Msp_0207 | predicted glycosyltransferase | 9.1E−69 | MTH_172 | conserved protein | 1.1E−20 |
| MSM1331 | Msp_0208 | predicted bacterial sugar | 9.0E−117 | NONE | | |
| | | transferase | | | | |
| MSM1332 | Msp_1487 | predicted ssDNA-binding protein | 6.2E−157 | MTH_1385 | replication factor A | 7.8E−152 |
| | | | | | related protein | |
| MSM1333 | Msp_1488 | RadA | 6.9E−142 | MTH_1383 | DNA repair protein RadA | 6.4E−144 |
| MSM1334 | Msp_1477 | predicted permease | 1.4E−56 | MTH_1382 | conserved protein | 1.2E−57 |
| MSM1335 | NONE | | | NONE | | |
| MSM1336 | Msp_1476 | HdrA1 | 6.9E−277 | NONE | heterodisulfide | 2.0E−298 |
| | | | | | reductase, subunit A | |
| MSM1337 | Msp_1475 | GlyA | 5.9E−145 | MTH_1380 | serine | 6.5E−151 |
| | | | | | hydroxymethyltransferase | |
| MSM1338 | Msp_1473 | predicted flavoprotein | 3.4E−53 | MTH_1379 | conserved protein | 5.0E−73 |
| | | | | | (contains ferredoxin | |
| | | | | | domain) | |
| MSM1339 | Msp_1471 | conserved hypothetical protein | 2.5E−11 | MTH_1377 | conserved protein | 9.7E−22 |
| MSM1340 | Msp_1470 | S-adenosylmethionine synthetase | 2.2E−138 | MTH_1376 | conserved protein | 3.7E−148 |
| MSM1341 | Msp_1468 | IleS | 0.0E+00 | MTH_1375 | isoleucyl-tRNA | 0.0E+00 |
| | | | | | synthetase | |
| MSM1342 | Msp_1467 | PurL | 5.9E−239 | MTH_1374 | phosphoribosylformylglycinamidine | 4.4E−255 |
| | | | | | synthase II | |
| MSM1343 | NONE | | | MTH_1369 | molybdenum cofactor | 2.5E−110 |
| | | | | | biosynthesis MoeA | |
| MSM1344 | Msp_1466 | predicted membrane-associated | 1.4E−81 | MTH_1368 | conserved protein | 3.4E−99 |
| | | Zn-dependent protease | | | | |
| MSM1345 | NONE | | | NONE | | |
| MSM1346 | Msp_0822 | hypothetical protein | 1.6E−06 | NONE | | |
| MSM1347 | NONE | | | NONE | | |
| MSM1348 | Msp_0789 | rubrerythrin | 2.7E−04 | MTH_1351 | conserved protein | 4.2E−37 |
| MSM1349 | Msp_0787 | FprA | 2.9E−136 | MTH_1350 | flavoprotein AI | 2.7E−152 |
| MSM1350 | Msp_0061 | conserved hypothetical protein | 5.4E−32 | MTH_1349 | conserved protein | 3.1E−48 |
| MSM1351 | Msp_0038 | CbiL | 1.1E−58 | MTH_1348 | precorrin-2 | 9.8E−61 |
| | | | | | methyltransferase | |
| MSM1352 | Msp_0036 | putative ATP-dependent helicase | 1.1E−175 | MTH_1347 | probable ATP-dependent | 3.4E−212 |
| | | | | | helicase | |
| MSM1353 | Msp_1532 | hypothetical membrane-spanning | 1.6E−08 | MTH_1313 | unknown | 9.0E−13 |
| | | protein | | | | |
| MSM1354 | Msp_1533 | RpoM1 | 4.7E−33 | MTH_1314 | transcription elongation | 4.8E−36 |
| | | | | | factor TFIIS | |
| MSM1355 | Msp_1534 | putative ADP-ribose | 4.9E−38 | MTH_1315 | mutator MutT protein | 1.1E−34 |
| | | pyrophosphatase | | | | |
| MSM1356 | Msp_1535 | RpoL | 2.1E−14 | NONE | DNA-dependent RNA | 5.5E−19 |
| | | | | | polymerase, subunit L | |
| MSM1357 | Msp_1536 | predicted RNA-binding protein | 2.6E−32 | MTH_1318 | conserved protein | 1.6E−46 |
| MSM1358 | Msp_1537 | predicted diphthamide synthase, | 6.1E−95 | MTH_1319 | conserved protein | 1.1E−109 |
| | | subunit DPH2 | | | | |
| MSM1359 | Msp_1538 | putative adenine | 5.0E−52 | MTH_1320 | adenine | 2.2E−54 |
| | | phosphoribosyltransferase | | | phosphoribosyltransferase | |
| MSM1360 | Msp_1539 | signal recognition particle, 54 kDa | 2.0E−151 | MTH_1321 | signal recognition particle | 5.8E−159 |
| | | protein | | | protein SRP54 | |
| MSM1361 | Msp_1541 | predicted pseudouridylate synthase | 4.0E−82 | MTH_1322 | conserved protein | 1.0E−104 |
| MSM1362 | NONE | | | MTH_809 | molybdenum cofactor | 2.2E−47 |
| | | | | | biosynthesis protein | |
| | | | | | MoaC | |
| MSM1363 | Msp_0229 | SecG | 2.2E−12 | NONE | | |
| MSM1364 | Msp_0032 | HisF | 1.6E−112 | MTH_1343 | imidazoleglycerol- | 3.7E−109 |
| | | | | | phosphate synthase | |
| | | | | | (cyclase) | |
| MSM1365 | Msp_0034 | putative 3-methyladenine DNA | 2.1E−37 | MTH_1342 | 8-oxoguanine DNA | 1.1E−68 |
| | | glycosylase/8-oxoguanine DNA | | | glycosylase | |
| | | glycosylase | | | | |
| MSM1366 | NONE | | | MTH_758 | S-D-lactoylglutathione | 7.2E−26 |
| | | | | | methylglyoxal lyase | |
| MSM1367 | Msp_0035 | predicted peptidyl-prolyl cis-trans | 2.3E−63 | MTH_1338 | peptidyl-prolyl cis-trans | 1.9E−57 |
| | | isomerase 1 | | | isomerase B | |
| MSM1368 | Msp_0037 | ArgD | 6.6E−121 | MTH_1337 | N-acetylornithine | 8.1E−121 |
| | | | | | aminotransferase | |
| MSM1369 | Msp_0006 | predicted NUDIX-related protein | 4.5E−12 | MTH_1336 | mutator MutT protein | 1.0E−17 |
| | | | | | homolog | |
| MSM1370 | Msp_0715 | conserved hypothetical membrane- | 9.6E−97 | NONE | | |
| | | spanning protein | | | | |
| MSM1371 | Msp_1578 | LysA | 2.9E−152 | MTH_1335 | diaminopimelate | 2.3E−155 |
| | | | | | decarboxylase | |
| MSM1372 | Msp_1579 | DapF | 1.3E−74 | MTH_1334 | diaminopimelate | 2.8E−86 |
| | | | | | epimerase | |
| MSM1373 | Msp_1545 | conserved hypothetical protein | 3.2E−50 | MTH_1329 | methyltransferase related | 4.1E−46 |
| | | | | | protein | |
| MSM1374 | Msp_1544 | KsgA | 1.6E−62 | MTH_1326 | dimethyladenosine | 1.3E−56 |
| | | | | | transferase | |
| MSM1375 | NONE | | | MTH_1325 | conserved protein | 2.9E−61 |
| MSM1376 | Msp_1543 | conserved hypothetical protein | 5.1E−20 | MTH_1324 | conserved protein | 2.1E−28 |
| MSM1377 | Msp_1542 | 50S ribosomal protein L21e | 3.3E−32 | MTH_1323 | ribosomal protein L21 | 2.7E−35 |
| MSM1378 | Msp_0981 | conserved hypothetical protein | 7.4E−19 | NONE | | |
| MSM1379 | Msp_0967 | putative NADP-dependent alcohol | 1.4E−24 | NONE | | |
| | | dehydrogenase | | | | |
| MSM1380 | Msp_0967 | putative NADP-dependent alcohol | 4.6E−74 | NONE | | |
| | | dehydrogenase | | | | |
| MSM1381 | Msp_0967 | putative NADP-dependent alcohol | 2.2E−11 | NONE | | |
| | | dehydrogenase | | | | |
| MSM1382 | Msp_0504 | conserved hypothetical membrane- | 2.7E−53 | NONE | | |
| | | spanning protein | | | | |
| MSM1383 | Msp_0254 | anaerobic ribonucleotide- | 1.6E−307 | MTH_1539 | anaerobic | 9.9E−306 |
| | | triphosphate reductase | | | ribonucleoside- | |
| | | | | | triphosphate reductase | |
| MSM1384 | Msp_0255 | PolC | 3.9E−290 | MTH_1536 | conserved protein | 0.0E+00 |
| MSM1385 | Msp_0113 | conserved hypothetical protein | 7.7E−16 | MTH_1626 | phosphoserine | 2.3E−09 |
| | | | | | phosphatase | |
| MSM1386 | NONE | | | NONE | | |
| MSM1387 | Msp_0249 | LysS | 4.8E−205 | MTH_1542 | conserved protein | 2.6E−202 |
| MSM1388 | Msp_0251 | ThiC2 | 1.0E−156 | MTH_1543 | thiamine biosynthesis | 5.3E−172 |
| | | | | | protein | |
| MSM1389 | Msp_0252 | predicted ribokinase | 1.3E−78 | MTH_1544 | ribokinase | 3.8E−91 |
| MSM1390 | Msp_0248 | conserved hypothetical protein | 2.5E−50 | MTH_1545 | conserved protein | 1.5E−55 |
| MSM1391 | Msp_0247 | predicted sugar phosphate | 1.2E−52 | MTH_1546 | conserved protein | 1.3E−51 |
| | | isomerase | | | | |
| MSM1392 | NONE | | | NONE | nitrate assimilation | 4.4E−58 |
| | | | | | protein, narQ | |
| MSM1393 | NONE | | | NONE | | |
| MSM1394 | Msp_0355 | conserved hypothetical membrane- | 1.5E−04 | NONE | | |
| | | spanning protein | | | | |
| MSM1395 | Msp_0340 | PstB | 3.1E−27 | MTH_605 | ABC transporter | 3.2E−30 |
| MSM1396 | NONE | | | MTH_1345 | conserved protein | 4.7E−22 |
| MSM1397 | Msp_0432 | member of asn/thr-rich large protein | 7.3E−30 | MTH_911 | probable surface protein | 3.0E−12 |
| | | family | | | | |
| MSM1398 | Msp_0762 | member of asn/thr-rich large protein | 4.2E−21 | MTH_716 | cell surface glycoprotein | 2.4E−10 |
| | | family | | | (s-layer protein) | |
| MSM1399 | Msp_0911 | member of asn/thr-rich large protein | 5.8E−13 | MTH_716 | cell surface glycoprotein | 4.7E−13 |
| | | family | | | (s-layer protein) | |
| MSM1400 | Msp_0615 | partially conserved hypothetical | 5.3E−05 | MTH_672 | unknown | 1.6E−04 |
| | | membrane-spanning protein | | | | |
| MSM1401 | Msp_1106 | conserved hypothetical membrane- | 5.9E−42 | MTH_671 | unknown | 1.9E−48 |
| | | spanning protein | | | | |
| MSM1402 | Msp_1107 | conserved hypothetical membrane- | 4.2E−16 | MTH_670 | unknown | 2.4E−11 |
| | | spanning protein | | | | |
| MSM1403 | NONE | | | NONE | | |
| MSM1404 | Msp_0243 | FwdB | 5.2E−23 | NONE | formate dehydrogenase, | 1.9E−153 |
| | | | | | alpha subunit homolog | |
| MSM1405 | Msp_0639 | FdhB | 5.0E−84 | NONE | formate dehydrogenase, | 7.8E−84 |
| | | | | | beta subunit related | |
| | | | | | protein FlpB | |
| MSM1406 | Msp_0384 | predicted Fe—S oxidoreductase | 2.7E−19 | MTH_1550 | molybdenum cofactor | 2.6E−99 |
| | | | | | biosynthesis MoaA | |
| MSM1407 | Msp_0488 | predicted allosteric regulator of | 9.7E−04 | MTH_1551 | molybdopterin-guanine | 2.3E−36 |
| | | homoserine dehydrogenase | | | dinucleotide biosynthesis | |
| | | | | | protein B related | |
| MSM1408 | Msp_0147 | ferredoxin | 7.5E−10 | NONE | tungsten | 8.3E−48 |
| | | | | | formylmethanofuran | |
| | | | | | dehydrogenase, subunit H | |
| MSM1409 | Msp_1447 | EhbK | 6.0E−18 | NONE | tungsten | 3.1E−97 |
| | | | | | formylmethanofuran | |
| | | | | | dehydrogenase, subunit F | |
| MSM1410 | Msp_0241 | FwdG | 1.8E−22 | NONE | tungsten | 2.7E−19 |
| | | | | | formylmethanofuran | |
| | | | | | dehydrogenase, subunit G | |
| MSM1411 | Msp_0242 | FwdD | 5.4E−39 | NONE | tungsten | 6.9E−21 |
| | | | | | formylmethanofuran | |
| | | | | | dehydrogenase, subunit D | |
| MSM1412 | Msp_0243 | FwdB | 1.6E−156 | NONE | tungsten | 5.3E−117 |
| | | | | | formylmethanofuran | |
| | | | | | dehydrogenase, subunit B | |
| MSM1413 | Msp_0244 | FwdA | 6.4E−203 | NONE | tungsten | 1.7E−182 |
| | | | | | formylmethanofuran | |
| | | | | | dehydrogenase, subunit A | |
| MSM1414 | Msp_0245 | FwdC | 1.9E−66 | NONE | tungsten | 2.9E−52 |
| | | | | | formylmethanofuran | |
| | | | | | dehydrogenase, subunit C | |
| MSM1415 | Msp_0246 | hypothetical protein | 3.9E−13 | MTH_1568 | unknown | 1.1E−08 |
| MSM1416 | Msp_0246 | hypothetical protein | 6.8E−09 | MTH_1568 | unknown | 1.6E−05 |
| MSM1417 | Msp_0235 | conserved hypothetical membrane- | 2.9E−150 | MTH_1569 | conserved protein | 6.5E−151 |
| | | spanning protein | | | | |
| MSM1418 | Msp_0234 | GlnA | 3.8E−157 | MTH_1570 | glutamine synthetase | 4.7E−164 |
| MSM1419 | Msp_0017 | conserved hypothetical protein | 1.7E−28 | NONE | | |
| MSM1420 | Msp_0128 | predicted helicase | 5.7E−11 | MTH_511 | DNA helicase II | 1.5E−13 |
| MSM1421 | Msp_1566 | conserved hypothetical membrane- | 4.4E−92 | NONE | | |
| | | spanning protein | | | | |
| MSM1422 | Msp_1568 | conserved hypothetical membrane- | 3.5E−67 | NONE | | |
| | | spanning protein | | | | |
| MSM1423 | Msp_0721 | partially conserved hypothetical | 5.9E−42 | NONE | | |
| | | protein | | | | |
| MSM1424 | Msp_0720 | polyphosphate kinase | 2.4E−258 | NONE | | |
| MSM1425 | Msp_0871 | 30S ribosomal protein S13P | 7.7E−56 | MTH_34 | ribosomal protein S18 | 2.9E−54 |
| | | | | | (E. coli) | |
| MSM1426 | Msp_0870 | 30S ribosomal protein S4P | 6.5E−59 | MTH_35 | ribosomal protein S9 | 4.4E−65 |
| | | | | | (E. coli) | |
| MSM1427 | Msp_0869 | 30S ribosomal protein S11P | 2.5E−59 | MTH_36 | ribosomal protein S14 | 2.9E−61 |
| | | | | | (E. coli) | |
| MSM1428 | Msp_0868 | RpoD | 6.3E−61 | NONE | DNA-dependent RNA | 9.1E−74 |
| | | | | | polymerase, subunit D | |
| MSM1429 | Msp_0867 | 50S ribosomal protein L18e | 1.1E−33 | MTH_38 | ribosomal protein L18 | 5.5E−35 |
| | | | | | (E. coli) | |
| MSM1430 | Msp_0866 | 50S ribosomal protein L13P | 1.3E−51 | MTH_39 | ribosomal protein S16 | 7.1E−58 |
| | | | | | (E. coli) | |
| MSM1431 | Msp_0865 | 30S ribosomal protein S9P | 2.9E−56 | MTH_39 | ribosomal protein S16 | 1.3E−56 |
| | | | | | (E. coli) | |
| MSM1432 | Msp_0864 | RpoN | 9.4E−19 | NONE | DNA-dependent RNA | 1.3E−24 |
| | | | | | polymerase, subunit N | |
| MSM1433 | Msp_0863 | RpoK | 6.9E−16 | NONE | DNA-dependent RNA | 2.4E−18 |
| | | | | | polymerase, subunit K | |
| MSM1434 | NONE | | | NONE | | |
| MSM1435 | Msp_0862 | enolase | 2.2E−113 | MTH_43 | enolase | 3.0E−121 |
| MSM1436 | Msp_0861 | ferredoxin | 3.0E−15 | MTH_1106 | ferredoxin | 6.2E−20 |
| MSM1437 | Msp_0860 | ribosomal protein S2P | 3.9E−84 | MTH_44 | ribosomal protein Sa | 5.5E−83 |
| | | | | | (E. coli) | |
| MSM1438 | Msp_0859 | conserved hypothetical protein | 1.9E−59 | MTH_45 | conserved protein | 5.1E−64 |
| MSM1439 | Msp_0858 | putative mevalonate kinase | 2.1E−60 | MTH_46 | mevalonate kinase | 4.6E−63 |
| MSM1440 | Msp_0857 | predicted archaeal kinase | 9.2E−60 | MTH_47 | conserved protein | 3.6E−70 |
| MSM1441 | Msp_0856 | isopentenyl-diphosphate delta- | 6.2E−118 | MTH_48 | conserved protein | 4.1E−117 |
| | | isomerase | | | | |
| MSM1442 | Msp_0855 | predicted hydrolase | 8.3E−178 | MTH_49 | conserved protein | 8.6E−188 |
| MSM1443 | Msp_0854 | IdsA | 1.3E−90 | MTH_50 | bifunctional short chain | 4.1E−94 |
| | | | | | isoprenyl diphosphate | |
| | | | | | synthase | |
| MSM1444 | NONE | | | NONE | | |
| MSM1445 | Msp_1125 | predicted transcriptional regulator | 1.4E−38 | MTH_1454 | conserved protein | 2.9E−45 |
| MSM1446 | Msp_1126 | putative hydroxylamine reductase | 1.8E−152 | MTH_1453 | 6Fe-6S prismane- | 3.6E−173 |
| | | | | | containing protein | |
| MSM1447 | Msp_0002 | conserved hypothetical protein | 1.1E−31 | MTH_1452 | unknown | 2.3E−36 |
| MSM1448 | Msp_1545 | conserved hypothetical protein | 1.9E−08 | MTH_146 | precorrin-8W | 1.7E−05 |
| | | | | | decarboxylase | |
| MSM1449 | Msp_0219 | conserved hypothetical protein | 7.9E−04 | MTH_83 | O-linked GlcNAc | 9.2E−05 |
| | | | | | transferase | |
| MSM1450 | Msp_0524 | predicted oxidoreductase | 8.4E−25 | MTH_907 | conserved protein | 6.8E−08 |
| MSM1451 | Msp_0039 | predicted glycosyltransferase | 2.2E−06 | MTH_83 | O-linked GlcNAc | 3.2E−10 |
| | | | | | transferase | |
| MSM1452 | Msp_0923 | GltX | 1.1E−184 | MTH_51 | glutamyl-tRNA | 8.5E−181 |
| | | | | | synthetase | |
| MSM1453 | NONE | | | NONE | | |
| MSM1454 | Msp_0226 | hypothetical protein | 9.5E−14 | NONE | heterodisulfide | 6.6E−06 |
| | | | | | reductase, subunit C | |
| MSM1455 | Msp_0924 | predicted | 3.8E−166 | MTH_52 | aspartate | 6.6E−158 |
| | | aspartate/tyrosine/aromatic | | | aminotransferase related | |
| | | aminotransferase | | | protein | |
| MSM1456 | NONE | | | NONE | | |
| MSM1457 | NONE | | | NONE | | |
| MSM1458 | NONE | | | NONE | | |
| MSM1459 | Msp_0925 | predicted arabinose efflux | 7.3E−115 | MTH_195 | efflux pump antibiotic | 7.7E−93 |
| | | permease | | | resistance protein | |
| MSM1460 | Msp_1447 | EhbK | 1.8E−33 | MTH_1133 | polyferredoxin (MvhB) | 5.8E−143 |
| MSM1461 | Msp_0638 | MvhD2 | 1.3E−53 | NONE | methyl viologen-reducing | 2.7E−58 |
| | | | | | hydrogenase, delta | |
| | | | | | subunit homolog FlpD | |
| MSM1462 | Msp_0639 | FdhB | 1.2E−119 | NONE | formate dehydrogenase, | 1.9E−135 |
| | | | | | beta subunit related | |
| | | | | | protein FlpB | |
| MSM1463 | Msp_0640 | FdhA | 4.1E−50 | NONE | formate dehydrogenase, | 2.0E−39 |
| | | | | | alpha subunit related | |
| | | | | | protein FlpC | |
| MSM1464 | NONE | | | MTH_1141 | conserved protein (FlpE) | 1.2E−18 |
| MSM1465 | Msp_0925 | predicted arabinose efflux | 1.3E−115 | MTH_195 | efflux pump antibiotic | 9.5E−95 |
| | | permease | | | resistance protein | |
| MSM1466 | NONE | | | NONE | | |
| MSM1467 | NONE | | | NONE | | |
| MSM1468 | Msp_0986 | PurA | 7.6E−136 | MTH_615 | adenylosuccinate | 9.4E−143 |
| | | | | | synthetase | |
| MSM1469 | Msp_1164 | predicted ABC-type | 2.4E−91 | MTH_924 | molybdate-binding | 5.9E−06 |
| | | nitrate/sulfonate/bicarbonate | | | periplasmic protein | |
| | | transport system, periplasmic | | | | |
| | | solute-binding protein | | | | |
| MSM1470 | NONE | | | NONE | | |
| MSM1471 | Msp_0919 | predicted acyl-CoA synthetase | 2.3E−237 | NONE | succinyl-CoA synthetase, | 2.5E−07 |
| | | | | | alpha subunit | |
| MSM1472 | NONE | | | MTH_752 | conserved protein | 3.7E−77 |
| MSM1473 | Msp_0575 | predicted metal-dependent | 2.9E−79 | MTH_751 | conserved protein | 9.4E−72 |
| | | hydrolase | | | | |
| MSM1474 | Msp_0579 | AroC | 7.2E−124 | MTH_748 | chorismate synthase | 4.7E−125 |
| MSM1475 | Msp_0497 | putative endonuclease III | 1.0E−14 | MTH_746 | endonuclease III related | 2.1E−51 |
| | | | | | protein | |
| MSM1476 | Msp_0416 | HemB | 6.2E−102 | MTH_744 | porphobilinogen | 3.6E−102 |
| | | | | | synthase | |
| MSM1477 | Msp_0428 | predicted ATP:dephospho-CoA | 1.7E−58 | MTH_743 | conserved protein | 5.9E−70 |
| | | triphosphoribosyl transferase | | | | |
| MSM1478 | Msp_0429 | PheS | 2.6E−165 | MTH_742 | phenylalanyl-tRNA | 5.5E−170 |
| | | | | | synthetase | |
| MSM1479 | NONE | | | MTH_212 | exodeoxyribonuclease | 2.4E−73 |
| MSM1480 | Msp_1260 | predicted hydrolase | 1.5E−59 | MTH_209 | conserved protein | 1.1E−77 |
| MSM1481 | Msp_1281 | conserved hypothetical protein | 6.5E−59 | MTH_208 | DNA-dependent DNA | 2.0E−69 |
| | | | | | polymerase family B | |
| | | | | | (PolB2) | |
| MSM1482 | NONE | | | NONE | | |
| MSM1483 | Msp_0195 | ABC-type multidrug transport | 2.0E−41 | MTH_1093 | ABC transporter (ATP- | 1.4E−54 |
| | | system, ATP-binding protein | | | binding | |
| MSM1484 | Msp_0196 | ABC-type multidrug transport | 8.1E−29 | MTH_1486 | conserved protein | 1.0E−19 |
| | | system, permease protein | | | | |
| MSM1485 | Msp_0440 | member of asn/thr-rich large protein | 3.3E−06 | NONE | | |
| | | family | | | | |
| MSM1486 | Msp_1280 | 30S ribosomal protein S8e | 6.6E−34 | MTH_207 | ribosomal protein S8 | 1.5E−41 |
| MSM1487 | NONE | | | MTH_199 | unknown | 9.6E−31 |
| MSM1488 | Msp_0977 | conserved hypothetical protein | 3.1E−27 | MTH_200 | cobalamin biosynthesis | 3.0E−50 |
| | | | | | protein M related protein | |
| MSM1489 | Msp_0474 | hypothetical protein | 1.2E−09 | MTH_1346 | unknown | 1.3E−177 |
| MSM1490 | Msp_0474 | hypothetical protein | 7.1E−06 | MTH_201 | unknown | 4.9E−11 |
| MSM1491 | Msp_0474 | hypothetical protein | 9.8E−08 | MTH_1346 | unknown | 1.3E−159 |
| MSM1492 | Msp_1279 | HypE1 | 1.0E−122 | MTH_205 | hydrogenase | 3.2E−126 |
| | | | | | expression/formation | |
| | | | | | protein HypE | |
| MSM1493 | Msp_1278 | conserved hypothetical membrane- | 1.3E−21 | MTH_204 | conserved protein | 4.3E−19 |
| | | spanning protein | | | | |
| MSM1494 | NONE | | | NONE | | |
| MSM1495 | Msp_1089 | predicted nuclease | 1.8E−40 | MTH_494 | thermonuclease | 8.5E−39 |
| | | | | | precursor | |
| MSM1496 | Msp_0024 | hypothetical protein | 4.5E−67 | NONE | | |
| MSM1497 | NONE | | | MTH_1785 | coenzyme PQQ | 6.4E−57 |
| | | | | | synthesis protein | |
| MSM1498 | Msp_1228 | predicted helicase | 2.1E−131 | NONE | ATP-dependent RNA | 3.8E−114 |
| | | | | | helicase, elF-4A family | |
| MSM1499 | Msp_1188 | predicted transcriptional regulator | 8.1E−61 | MTH_163 | conserved protein | 2.5E−62 |
| MSM1500 | Msp_1189 | RecJ | 1.5E−114 | MTH_164 | single-stranded DNA | 1.1E−116 |
| | | | | | exonuclease RecJ | |
| | | | | | related protein | |
| MSM1501 | Msp_1190 | signal recognition particle, 19 kDa | 4.0E−20 | MTH_165 | signal recognition particle | 9.3E−17 |
| | | protein | | | 19 kDa protein | |
| MSM1502 | Msp_0223 | predicted UDP-galactopyranose | 3.6E−65 | MTH_344 | UDP-galactopyranose | 2.4E−80 |
| | | mutase | | | mutase | |
| MSM1503 | Msp_0215 | predicted glycosyltransferase | 4.0E−39 | MTH_884 | teichoic acid biosynthesis | 2.4E−06 |
| | | | | | related protein | |
| MSM1504 | Msp_1191 | HemD | 2.2E−49 | MTH_166 | uroporphyrinogen III | 1.1E−52 |
| | | | | | synthase | |
| MSM1505 | NONE | | | NONE | | |
| MSM1506 | NONE | | | NONE | | |
| MSM1507 | Msp_0215 | predicted glycosyltransferase | 5.6E−34 | MTH_884 | teichoic acid biosynthesis | 7.4E−10 |
| | | | | | related protein | |
| MSM1508 | NONE | | | NONE | | |
| MSM1509 | NONE | | | NONE | | |
| MSM1510 | NONE | | | NONE | | |
| MSM1511 | NONE | | | NONE | | |
| MSM1512 | Msp_0060 | putative lipooligosaccharide | 7.0E−62 | NONE | | |
| | | cholinephosphotransferase | | | | |
| MSM1513 | Msp_0662 | putative aspartate aminotransferase | 2.7E−37 | MTH_1601 | aspartate | 1.9E−41 |
| | | | | | aminotransferase | |
| MSM1514 | Msp_1333 | predicted dehydrogenase | 1.3E−06 | NONE | 3-chlorobenzoate-3,4- | 8.7E−09 |
| | | | | | dioxygenase | |
| | | | | | dyhydrogenase related | |
| | | | | | protein | |
| MSM1515 | Msp_0060 | putative lipooligosaccharide | 1.1E−24 | NONE | | |
| | | cholinephosphotransferase | | | | |
| MSM1516 | Msp_1326 | HisC | 1.7E−26 | MTH_1587 | histidinol-phosphate | 5.5E−22 |
| | | | | | aminotransferase | |
| MSM1517 | NONE | | | MTH_1495 | omithine cyclodeaminase | 1.2E−15 |
| MSM1518 | Msp_0017 | conserved hypothetical protein | 1.2E−11 | NONE | | |
| MSM1519 | NONE | | | NONE | | |
| MSM1520 | NONE | | | NONE | | |
| MSM1521 | NONE | | | NONE | | |
| MSM1522 | NONE | | | NONE | | |
| MSM1523 | NONE | | | NONE | | |
| MSM1524 | NONE | | | NONE | | |
| MSM1525 | NONE | | | NONE | | |
| MSM1526 | Msp_0772 | hypothetical membrane-spanning | 2.3E−15 | MTH_252 | conserved protein | 7.1E−19 |
| | | protein | | | | |
| MSM1527 | NONE | | | NONE | | |
| MSM1528 | Msp_0608 | predicted transcriptional regulator | 1.9E−04 | MTH_700 | conserved protein | 1.1E−04 |
| MSM1529 | NONE | | | NONE | | |
| MSM1530 | NONE | | | NONE | | |
| MSM1531 | Msp_0691 | predicted Na+-dependent | 1.3E−131 | NONE | | |
| | | transporter | | | | |
| MSM1532 | Msp_0691 | predicted Na+-dependent | 2.0E−137 | NONE | | |
| | | transporter | | | | |
| MSM1533 | Msp_1465 | member of asn/thr-rich large protein | 7.2E−12 | MTH_1074 | putative membrane | 3.7E−06 |
| | | family | | | protein | |
| MSM1534 | Msp_0590 | member of asn/thr-rich large protein | 2.0E−24 | MTH-1074 | putative membrane | 3.0E−123 |
| | | family | | | protein | |
| MSM1535 | Msp_1114 | predicted dTDP-D-glucose 4,6- | 1.3E−10 | NONE | dTDP-glucose 4,6- | 1.2E−06 |
| | | dehydratase | | | dehydratase | |
| MSM1536 | Msp_0290 | predicted pyridoxal phosphate- | 6.9E−71 | MTH_1188 | pleiotropic regulatory | 6.6E−71 |
| | | dependent enzyme | | | protein DegT | |
| MSM1537 | Msp_0310 | predicted | 4.2E−04 | NONE | | |
| | | GTP:adenosylcobinamide- | | | | |
| | | phosphate guanylyltransferase | | | | |
| MSM1538 | Msp_1202 | predicted acetyltransferase | 1.9E−08 | NONE | N-terminal | 3.5E−06 |
| | | | | | acetyltransferase | |
| | | | | | complex, subunit ARD1 | |
| MSM1539 | NONE | | | NONE | | |
| MSM1540 | NONE | | | MTH_368 | glycerol-3-phosphate | 6.5E−48 |
| | | | | | dehydrogenase (NAD) | |
| MSM1541 | NONE | | | NONE | | |
| MSM1542 | Msp_0310 | predicted | 4.6E−06 | MTH_1152 | conserved protein | 1.4E−04 |
| | | GTP:adenosylcobinamide- | | | | |
| | | phosphate guanylyltransferase | | | | |
| MSM1543 | NONE | | | NONE | | |
| MSM1544 | Msp_0060 | putative lipooligosaccharide | 3.9E−22 | NONE | | |
| | | cholinephosphotransferase | | | | |
| MSM1545 | Msp_0495 | predicted glycosyltransferase | 1.3E−31 | MTH_136 | dolichyl-phosphate | 1.4E−08 |
| | | | | | mannose synthase | |
| MSM1546 | NONE | | | NONE | | |
| MSM1547 | Msp_1195 | PurC | 3.9E−77 | MTH_170 | phosphoribosylamino- | 6.8E−69 |
| | | | | | imidazolesuccinocarboxamide synthase | |
| MSM1548 | Msp_1194 | predicted | 1.2E−25 | MTH_169 | conserved protein | 4.5E−24 |
| | | phosphoribosylformylglycinamidine | | | | |
| | | synthase | | | | |
| MSM1549 | Msp_1193 | PurQ | 2.4E−75 | MTH_168 | phosphoribosylformylglycinamidine | 6.8E−85 |
| | | | | | synthase I | |
| MSM1550 | Msp_1192 | CobA | 6.2E−86 | MTH_167 | S-adenosyl-L-methionine | 7.1E−90 |
| | | | | | uroporphyrinogen | |
| | | | | | methyltransferase | |
| MSM1551 | Msp_1196 | GlmS | 1.5E−201 | MTH_171 | glutamine-fructose-6- | 1.5E−208 |
| | | | | | phosphate transaminase | |
| MSM1552 | NONE | | | NONE | | |
| MSM1553 | NONE | | | NONE | | |
| MSM1554 | Msp_0141 | member of asn/thr-rich large protein | 1.1E−09 | NONE | | |
| | | family | | | | |
| MSM1555 | Msp_0076 | conserved hypothetical protein | 3.5E−60 | MTH_175 | conserved protein | 4.7E−77 |
| MSM1556 | Msp_1344 | conserved hypothetical membrane- | 6.5E−75 | NONE | | |
| | | spanning protein | | | | |
| MSM1557 | Msp_0520 | predicted queuine/archaeosine | 5.0E−219 | MTH_176 | tRNA-guanine | 1.2E−206 |
| | | tRNA-ribosyltransferase | | | transglycosylase | |
| MSM1558 | NONE | | | MTH_1329 | methyltransferase related | 3.1E−04 |
| | | | | | protein | |
| MSM1559 | Msp_0063 | predicted polysaccharide | 9.5E−74 | MTH_379 | O-antigen transporter | 1.7E−72 |
| | | biosynthesis protein | | | related protein | |
| MSM1560 | Msp_0448 | predicted polysaccharide | 1.3E−78 | MTH-379 | O-antigen transporter | 4.9E−75 |
| | | biosynthesis protein | | | related protein | |
| MSM1561 | Msp_0117 | predicted 3-hydroxy-3- | 3.6E−145 | MTH_792 | 3-hydroxy-3- | 3.4E−145 |
| | | methylglutaryl CoA synthase | | | methylglutaryl-CoA- | |
| | | | | | synthase | |
| MSM1562 | Msp_0116 | predicted thiolase | 2.1E−156 | MTH_793 | lipid-transfer protein | 3.5E−168 |
| | | | | | (sterol or nonspecific) | |
| MSM1563 | NONE | | | NONE | | |
| MSM1564 | Msp_0087 | CbiT | 4.6E−05 | NONE | | |
| MSM1565 | Msp_1226 | CobQ | 9.4E−154 | MTH_787 | cobyric acid synthase | 1.1E−162 |
| MSM1566 | Msp_0233 | conserved hypothetical protein | 2.3E−22 | NONE | | |
| MSM1567 | Msp_0762 | member of asn/thr-rich large protein | 7.2E−35 | MTH_1485 | serine/threonine protein | 5.1E−13 |
| | | family | | | kinase related protein | |
| MSM1568 | NONE | | | NONE | | |
| MSM1569 | Msp_1227 | predicted ATP-dependent protease | 2.4E−226 | MTH_785 | ATP-dependent protease | 9.0E−241 |
| | | | | | LA | |
| MSM1570 | Msp_0557 | hypothetical protein | 1.1E−127 | MTH_530 | UDP-N-acetylmuramyl | 2.6E−25 |
| | | | | | tripeptide synthetase | |
| | | | | | related protein | |
| MSM1571 | NONE | | | NONE | | |
| MSM1572 | Msp_0683 | hypothetical protein | 4.9E−61 | NONE | | |
| MSM1573 | NONE | | | NONE | | |
| MSM1574 | Msp_0797 | predicted nitroreductase | 6.3E−10 | MTH_120 | NADPH-oxidoreductase | 4.2E−11 |
| MSM1575 | Msp_1055 | hypothetical membrane-spanning | 7.8E−04 | MTH_521 | unknown | 8.2E−05 |
| | | protein | | | | |
| MSM1576 | NONE | | | NONE | | |
| MSM1577 | Msp_1229 | ribose-phosphate | 1.2E−84 | MTH_784 | ribose-phosphate | 1.0E−88 |
| | | pyrophosphokinase | | | pyrophosphokinase | |
| MSM1578 | NONE | | | NONE | | |
| MSM1579 | Msp_0573 | UvrB | 1.2E−247 | MTH_442 | excinuclease ABC | 1.2E−261 |
| | | | | | subunit B | |
| MSM1580 | NONE | | | NONE | | |
| MSM1581 | Msp_0574 | UvrA | 0.0E+00 | MTH_443 | excinuclease ABC | 0.0E+00 |
| | | | | | subunit A | |
| MSM1582 | Msp_0603 | conserved hypothetical membrane- | 5.6E−85 | MTH_465 | unknown | 4.8E−84 |
| | | spanning protein | | | | |
| MSM1583 | Msp_1178 | predicted helicase | 7.4E−193 | MTH_656 | ATP-dependent RNA | 2.1E−232 |
| | | | | | helicase related protein | |
| MSM1584 | Msp_1119 | conserved hypothetical protein | 1.0E−37 | MTH_641 | conserved protein | 2.9E−29 |
| MSM1585 | Msp_0983 | member of asn/thr-rich large protein | 5.5E−38 | MTH_911 | probable surface protein | 9.9E−06 |
| | | family | | | | |
| MSM1586 | Msp_0713 | member of asn/thr-rich large protein | 1.8E−52 | MTH_911 | probable surface protein | 3.7E−14 |
| | | family | | | | |
| MSM1587 | Msp_0590 | member of asn/thr-rich large protein | 6.0E−44 | MTH_716 | cell surface glycoprotein | 1.2E−06 |
| | | family | | | (s-layer protein) | |
| MSM1588 | NONE | | | NONE | | |
| MSM1589 | NONE | | | NONE | | |
| MSM1590 | Msp_0619 | member of asn/thr-rich large protein | 2.5E−48 | MTH_716 | cell surface glycoprotein | 1.3E−07 |
| | | family | | | (s-layer protein) | |
| MSM1591 | Msp_1118 | conserved hypothetical protein | 1.0E−37 | MTH_639 | conserved protein | 5.6E−42 |
| MSM1592 | Msp_0205 | predicted ABC-type | 9.8E−72 | MTH_1370 | ABC transporter (ATP- | 1.5E−20 |
| | | polysaccharide/polyol phosphate | | | binding protein) | |
| | | export system, ATP-binding protein | | | | |
| MSM1593 | Msp_0204 | predicted ABC-type | 1.3E−53 | MTH_1092 | putative membrane | 5.7E−11 |
| | | polysaccharide/polyol phosphate | | | protein | |
| | | export system, permease protein | | | | |
| MSM1594 | Msp_0442 | predicted glycosyltransferase | 4.4E−60 | MTH_884 | teichoic acid biosynthesis | 1.5E−07 |
| | | | | | related protein | |
| MSM1595 | Msp_0929 | predicted helicase | 6.7E−04 | NONE | | |
| MSM1596 | Msp_0017 | conserved hypothetical protein | 1.7E−28 | NONE | | |
| MSM1597 | NONE | | | NONE | | |
| MSM1598 | NONE | | | NONE | | |
| MSM1599 | NONE | | | NONE | | |
| MSM1600 | NONE | | | NONE | | |
| MSM1601 | Msp_0692 | hypothetical membrane-spanning | 1.3E−07 | NONE | | |
| | | protein | | | | |
| MSM1602 | Msp_0220 | predicted glycosyltransferase | 6.9E−20 | MTH_361 | teichoic acid biosynthesis | 1.7E−04 |
| | | | | | protein RodC related | |
| | | | | | protein | |
| MSM1603 | NONE | | | MTH_637 | conserved protein | 1.1E−20 |
| MSM1604 | Msp_1101 | predicted UDP-glucose | 1.2E−103 | MTH_634 | UTP-glucose-1- | 7.6E−109 |
| | | pyrophosphorylase | | | phosphate | |
| | | | | | uridylyltransferase | |
| MSM1605 | NONE | | | NONE | | |
| MSM1606 | Msp_0612 | predicted arylsulfatase regulatory | 4.8E−102 | MTH_114 | arylsulfatase regulatory | 1.9E−64 |
| | | protein | | | protein | |
| MSM1607 | Msp_1060 | hypothetical protein | 2.4E−13 | MTH_121 | unknown | 1.2E−05 |
| MSM1608 | Msp_1350 | putative oxidoreductase | 5.9E−97 | MTH_907 | conserved protein | 8.1E−50 |
| MSM1609 | NONE | | | MTH_924 | molybdate-binding | 6.6E−23 |
| | | | | | periplasmic protein | |
| MSM1610 | Msp_0342 | PstC | 1.1E−15 | MTH_921 | anion transport system | 6.4E−25 |
| | | | | | permease protein | |
| MSM1611 | Msp_1000 | predicted ABC-type | 1.7E−28 | MTH_920 | anion permease | 2.4E−34 |
| | | nitrate/sulfonate/bicarbonate | | | | |
| | | transport system, ATB-binding | | | | |
| | | protein | | | | |
| MSM1612 | Msp_0210 | predicted UDP-glucose 6- | 6.3E−93 | MTH_836 | UDP-N-acetyl-D- | 5.4E−24 |
| | | dehydrogenase | | | mannosaminuronic acid | |
| | | | | | dehydrogenase | |
| MSM1613 | NONE | | | NONE | | |
| MSM1614 | Msp_0394 | predicted transcriptional regulator | 1.3E−74 | MTH_126 | inosine-5′- | 2.1E−97 |
| | | | | | monophosphate | |
| | | | | | dehydrogenase related | |
| | | | | | protein VII | |
| MSM1615 | Msp_0395 | putative deoxyhypusine synthase | 7.4E−106 | MTH_127 | deoxyhypusine synthase | 4.6E−95 |
| MSM1616 | Msp_0396 | hypothetical membrane-spanning | 4.0E−27 | MTH_128 | unknown | 6.2E−27 |
| | | protein | | | | |
| MSM1617 | Msp_0397 | PyrF | 1.9E−66 | MTH_129 | orotidine 5′ | 4.3E−67 |
| | | | | | monophosphate | |
| | | | | | decarboxylase | |
| MSM1618 | Msp_0398 | CbiM1 | 6.0E−72 | MTH_130 | cobalamin biosynthesis | 9.5E−79 |
| | | | | | protein M | |
| MSM1619 | Msp_0399 | CbiN | 3.0E−31 | MTH_131 | cobalt transport protein N | 7.2E−26 |
| MSM1620 | Msp_0400 | CbiQ1 | 3.0E−38 | MTH_132 | cobalt transport protein Q | 3.4E−42 |
| MSM1621 | Msp_0401 | CbiO1 | 6.0E−88 | MTH_133 | cobalt transport ATP- | 9.3E−88 |
| | | | | | binding protein O | |
| MSM1622 | Msp_1239 | RibC | 6.9E−55 | MTH_134 | riboflavin synthase | 2.3E−61 |
| MSM1623 | Msp_0541 | predicted glycosyltransferase | 2.1E−46 | MTH_136 | dolichyl-phosphate | 6.1E−52 |
| | | | | | mannose synthase | |
| MSM1624 | Msp_0542 | hypothetical membrane-spanning | 9.4E−19 | MTH_137 | unknown | 1.2E−18 |
| | | protein | | | | |
| MSM1625 | Msp_1044 | TfrB | 3.2E−34 | MTH_1850 | fumarate reductase | 7.6E−33 |
| MSM1626 | Msp_1044 | TfrB | 3.0E−07 | MTH_140 | conserved protein | 4.8E−107 |
| MSM1627 | Msp_0989 | predicted glycosyltransferase | 9.5E−11 | MTH_377 | dolichyl-phosphate | 2.0E−11 |
| | | | | | mannose synthase | |
| | | | | | related protein | |
| MSM1628 | Msp_0430 | conserved hypothetical protein | 1.9E−75 | MTH_141 | conserved protein | 7.0E−99 |
| MSM1629 | Msp_0431 | GuaB | 2.1E−163 | MTH_142 | inosine-5′- | 1.5E−174 |
| | | | | | monophosphate | |
| | | | | | dehydrogenase | |
| MSM1630 | Msp_1253 | 50S ribosomal protein L37Ae | 6.0E−33 | MTH_681 | ribosomal protein L37a | 1.1E−36 |
| MSM1631 | NONE | | | NONE | | |
| MSM1632 | Msp_1254 | partially conserved hypothetical | 1.0E−21 | MTH_680 | conserved protein | 1.4E−15 |
| | | protein | | | | |
| MSM1633 | Msp_1255 | conserved hypothetical protein | 1.0E−12 | MTH_679 | unknown | 5.3E−14 |
| MSM1634 | Msp_1256 | partially conserved hypothetical | 2.5E−27 | MTH_678 | conserved protein | 2.1E−35 |
| | | protein | | | | |
| MSM1635 | NONE | | | MTH_677 | unknown | 1.7E−10 |
| MSM1636 | Msp_1257 | conserved hypothetical protein | 2.6E−39 | MTH_669 | phosphoribosylformimino- | 1.3E−58 |
| | | | | | 5-aminoimidazole | |
| | | | | | carboxamide ribotide | |
| | | | | | isomeras related protein | |
| MSM1637 | Msp_0173 | hypothetical membrane-spanning | 9.9E−08 | NONE | | |
| | | protein | | | | |
| MSM1638 | Msp_1259 | hypothetical membrane-spanning | 1.6E−09 | MTH_667 | unknown | 3.0E−11 |
| | | protein | | | | |
| MSM1639 | Msp_0519 | predicted Co/Zn/Cd cation | 4.1E−16 | MTH_1893 | cation efflux system | 3.7E−17 |
| | | transporter | | | protein (zinc/cadmium) | |
| MSM1640 | Msp_0482 | hypothetical membrane-spanning | 1.8E−38 | NONE | | |
| | | protein | | | | |
| MSM1641 | NONE | | | NONE | | |
| MSM1642 | NONE | | | NONE | | |
| MSM1643 | NONE | | | NONE | | |
| MSM1644 | NONE | | | NONE | | |
| MSM1645 | NONE | | | NONE | | |
| MSM1646 | NONE | | | NONE | | |
| MSM1647 | NONE | | | NONE | | |
| MSM1648 | NONE | | | NONE | | |
| MSM1649 | NONE | | | NONE | | |
| MSM1650 | Msp_0260 | hypothetical protein | 7.9E−04 | NONE | | |
| MSM1651 | NONE | | | NONE | | |
| MSM1652 | NONE | | | NONE | | |
| MSM1653 | NONE | | | NONE | | |
| MSM1654 | NONE | | | NONE | | |
| MSM1655 | Msp_1059 | hypothetical protein | 1.3E−05 | NONE | | |
| MSM1656 | NONE | | | NONE | | |
| MSM1657 | Msp_0793 | hypothetical protein | 4.9E−06 | NONE | | |
| MSM1658 | NONE | | | NONE | | |
| MSM1659 | NONE | | | NONE | | |
| MSM1660 | NONE | | | NONE | | |
| MSM1661 | NONE | | | NONE | | |
| MSM1662 | NONE | | | NONE | | |
| MSM1663 | NONE | | | NONE | | |
| MSM1664 | NONE | | | NONE | | |
| MSM1665 | NONE | | | NONE | | |
| MSM1666 | Msp_0946 | conserved hypothetical protein | 1.2E−05 | NONE | | |
| MSM1667 | NONE | | | NONE | | |
| MSM1668 | NONE | | | NONE | | |
| MSM1669 | NONE | | | NONE | | |
| MSM1670 | Msp_0113 | conserved hypothetical protein | 1.8E−04 | NONE | | |
| MSM1671 | NONE | | | NONE | | |
| MSM1672 | NONE | | | NONE | | |
| MSM1673 | Msp_0474 | hypothetical protein | 4.6E−04 | NONE | | |
| MSM1674 | Msp_0822 | hypothetical protein | 2.5E−04 | NONE | | |
| MSM1675 | NONE | | | NONE | | |
| MSM1676 | NONE | | | NONE | | |
| MSM1677 | NONE | | | NONE | | |
| MSM1678 | NONE | | | NONE | | |
| MSM1679 | NONE | | | NONE | | |
| MSM1680 | NONE | | | NONE | | |
| MSM1681 | NONE | | | NONE | | |
| MSM1682 | NONE | | | NONE | | |
| MSM1683 | NONE | | | NONE | | |
| MSM1684 | Msp_0912 | member of asn/thr-rich large protein | 2.1E−06 | MTH_412 | conserved protein | 4.7E−04 |
| | | family | | | | |
| MSM1685 | NONE | | | NONE | | |
| MSM1686 | NONE | | | NONE | | |
| MSM1687 | Msp_0658 | hypothetical membrane-spanning | 8.1E−07 | MTH_1459 | unknown | 3.6E−07 |
| | | protein | | | | |
| MSM1688 | NONE | | | NONE | | |
| MSM1689 | NONE | | | NONE | | |
| MSM1690 | NONE | | | NONE | | |
| MSM1691 | Msp_1039 | partially conserved hypothetical | 1.5E−07 | MTH_357 | conserved protein | 5.3E−08 |
| | | membrane-spanning protein | | | | |
| MSM1692 | NONE | | | NONE | | |
| MSM1693 | Msp_1258 | predicted ribokinase | 6.9E−39 | MTH_668 | unknown | 1.8E−20 |
| MSM1694 | Msp_0929 | predicted helicase | 3.6E−193 | MTH_487 | DNA helicase related | 4.9E−304 |
| | | | | | protein | |
| MSM1695 | Msp_0572 | UvrC | 6.3E−164 | MTH_441 | excinuclease ABC | 5.6E−161 |
| | | | | | subunit C | |
| MSM1696 | Msp_1548 | hypothetical protein | 1.7E−08 | NONE | | |
| MSM1697 | NONE | | | NONE | | |
| MSM1698 | Msp_0439 | methyl-coenzyme M reductase, | 2.7E−147 | NONE | methyl coenzyme M | 5.4E−179 |
| | | component A2-like protein | | | reductase system, | |
| | | | | | component A2 homolog | |
| MSM1699 | Msp_0438 | predicted universal stress protein | 2.1E−14 | MTH_153 | conserved protein | 5.4E−21 |
| MSM1700 | Msp_1061 | hypothetical protein | 7.3E−12 | MTH_278 | ferredoxin | 1.4E−20 |
| MSM1701 | Msp_1062 | predicted dehydrogenase | 4.0E−130 | MTH_277 | bacteriochlorophyll | 8.8E−147 |
| | | | | | synthase 43 kDa subunit | |
| MSM1702 | Msp_1088 | ExoB | 7.9E−102 | MTH_631 | UDP-glucose 4- | 3.5E−97 |
| | | | | | epimerase | |
| MSM1703 | NONE | | | MTH_647 | unknown | 5.0E−25 |
| MSM1704 | Msp_1122 | PurF | 1.4E−143 | MTH_646 | amidophosphoribosyltransferase | 1.2E−156 |
| MSM1705 | Msp_1121 | predicted peptidase | 2.4E−100 | MTH_645 | collagenase | 3.7E−100 |
| MSM1706 | Msp_1513 | hypothetical membrane-spanning | 2.9E−24 | NONE | | |
| | | protein | | | | |
| MSM1707 | Msp_1120 | NifH | 2.6E−96 | MTH_643 | nitrogenase NifH subunit | 5.5E−99 |
| MSM1708 | NONE | | | NONE | | |
| MSM1709 | Msp_0440 | member of asn/thr-rich large protein | 1.3E−35 | MTH_716 | cell surface glycoprotein | 2.4E−04 |
| | | family | | | (s-layer protein) | |
| MSM1710 | Msp_1277 | SerS | 1.9E−187 | MTH_1455 | threonyl-tRNA | 5.3E−06 |
| | | | | | synthetase | |
| MSM1711 | Msp_0725 | hypothetical protein | 1.0E−08 | NONE | | |
| MSM1712 | Msp_0852 | predicted ferritin | 8.4E−50 | MTH_158 | ferritin like protein (RsgA) | 2.3E−59 |
| MSM1713 | Msp_1008 | predicted regulatory protein | 5.4E−32 | MTH_162 | unknown | 1.5E−41 |
| MSM1714 | Msp_1040 | coenzyme F390 synthetase II | 6.3E−164 | MTH_161 | coenzyme F390 | 3.7E−164 |
| | | | | | synthetase III | |
| MSM1715 | Msp_1110 | CobN | 1.7E−68 | MTH_714 | magnesium chelatase | 0.0E+00 |
| | | | | | subunit | |
| MSM1716 | Msp_0590 | member of asn/thr-rich large protein | 2.5E−16 | MTH_717 | unknown | 3.9E−25 |
| | | family | | | | |
| MSM1717 | Msp_1105 | predicted transporter | 1.9E−52 | MTH_672 | unknown | 2.3E−52 |
| MSM1718 | Msp_1106 | conserved hypothetical membrane- | 2.0E−50 | MTH_671 | unknown | 3.7E−61 |
| | | spanning protein | | | | |
| MSM1719 | Msp_1107 | conserved hypothetical membrane- | 4.1E−25 | MTH_670 | unknown | 1.2E−32 |
| | | spanning protein | | | | |
| MSM1720 | Msp_1533 | RpoM1 | 7.3E−28 | MTH_1314 | transcription elongation | 8.6E−30 |
| | | | | | factor TFIIS | |
| MSM1721 | NONE | | | NONE | | |
| MSM1722 | Msp_0965 | predicted nitroreductase | 6.9E−16 | MTH_120 | NADPH-oxidoreductase | 7.3E−33 |
| MSM1723 | Msp_1238 | N(5),N(10)- | 6.7E−105 | NONE | N5,N10-methenyl- | 2.1E−138 |
| | | methenyltetrahydromethanopterin | | | tetrahydromethanopterin | |
| | | cyclohydrolase | | | cyclohydrolase | |
| MSM1724 | Msp_0961 | hypothetical membrane-spanning | 3.1E−36 | MTH_1192 | conserved protein | 9.2E−25 |
| | | protein | | | | |
| MSM1725 | Msp_0961 | hypothetical membrane-spanning | 5.7E−28 | MTH_1192 | conserved protein | 1.6E−30 |
| | | protein | | | | |
| MSM1726 | Msp_0879 | hypothetical membrane-spanning | 9.0E−30 | MTH_1192 | conserved protein | 1.3E−25 |
| | | protein | | | | |
| MSM1727 | Msp_0844 | predicted multimeric flavodoxin | 1.2E−18 | MTH_135 | conserved protein | 1.9E−18 |
| MSM1728 | NONE | | | NONE | | |
| MSM1729 | Msp_0587 | hypothetical membrane-spanning | 5.0E−29 | MTH_520 | unknown | 3.9E−10 |
| | | protein | | | | |
| MSM1730 | Msp_0607 | hypothetical membrane-spanning | 6.5E−20 | MTH_1192 | conserved protein | 1.2E−26 |
| | | protein | | | | |
| MSM1731 | Msp_0714 | predicted short chain | 1.7E−115 | NONE | | |
| | | dehydrogenase | | | | |
| MSM1732 | Msp_1548 | hypothetical protein | 8.2E−07 | NONE | | |
| MSM1733 | Msp_0789 | rubrerythrin | 1.6E−39 | MTH_756 | rubrerythrin | 3.3E−43 |
| MSM1734 | Msp_1237 | ThyA | 8.9E−28 | MTH_774 | thymidylate synthase | 7.2E−26 |
| MSM1735 | Msp_0777 | member of asn/thr-rich large protein | 7.4E−116 | MTH_716 | cell surface glycoprotein | 1.4E−06 |
| | | family | | | (s-layer protein) | |
| MSM1736 | NONE | | | NONE | | |
| MSM1737 | NONE | | | NONE | | |
| MSM1738 | Msp_0154 | member of asn/thr-rich large protein | 2.3E−06 | NONE | | |
| | | family | | | | |
| MSM1739 | Msp_0987 | hypothetical membrane-spanning | 2.7E−07 | MTH_521 | unknown | 1.4E−05 |
| | | protein | | | | |
| MSM1740 | Msp_1323 | conserved hypothetical protein | 1.1E−16 | MTH_83 | O-linked GlcNAc | 4.7E−38 |
| | | | | | transferase | |
| MSM1741 | Msp_0113 | conserved hypothetical protein | 5.0E−05 | NONE | | |
| MSM1742 | Msp_0482 | hypothetical membrane-spanning | 2.7E−76 | NONE | | |
| | | protein | | | | |
| MSM1743 | Msp_0113 | conserved hypothetical protein | 4.1E−06 | NONE | | |
| MSM1744 | NONE | | | NONE | | |
| MSM1745 | Msp_0344 | predicted phosphate uptake | 2.0E−04 | NONE | | |
| | | regulator | | | | |
| MSM1746 | NONE | | | NONE | | |
| MSM1747 | Msp_0911 | member of asn/thr-rich large protein | 8.1E−06 | NONE | | |
| | | family | | | | |
| MSM1748 | NONE | | | NONE | | |
| MSM1749 | NONE | | | NONE | | |
| MSM1750 | NONE | | | NONE | | |
| MSM1751 | Msp_0113 | conserved hypothetical protein | 6.3E−15 | NONE | | |
| MSM1752 | Msp_0702 | conserved hypothetical protein | 1.2E−59 | MTH_1210 | mrr restriction system | 3.4E−42 |
| | | | | | related protein | |
| MSM1753 | Msp_0465 | conserved hypothetical membrane- | 6.7E−04 | NONE | | |
| | | spanning protein | | | | |
| MSM1754 | Msp_1328 | putative ATP-dependent protease | 3.6E−06 | NONE | | |
| | | La | | | | |
| MSM1755 | Msp_0219 | conserved hypothetical protein | 6.7E−04 | NONE | | |
| MSM1756 | Msp_0976 | hypothetical protein | 2.8E−05 | NONE | | |
| MSM1757 | NONE | | | NONE | | |
| MSM1758 | NONE | | | NONE | | |
| MSM1759 | NONE | | | NONE | | |
| MSM1760 | NONE | | | NONE | | |
| MSM1761 | Msp_0113 | conserved hypothetical protein | 7.6E−07 | MTH_540 | intracellular protein | 2.7E−05 |
| | | | | | transport protein | |
| MSM1762 | NONE | | | NONE | | |
| MSM1763 | Msp_1533 | RpoM1 | 4.6E−10 | MTH_1314 | transcription elongation | 3.1E−09 |
| | | | | | factor TFIIS | |
| MSM1764 | Msp_0226 | hypothetical protein | 8.9E−04 | NONE | | |
| MSM1765 | NONE | | | NONE | | |
| MSM1766 | Msp_1323 | conserved hypothetical protein | 4.8E−15 | MTH_83 | O-linked GlcNAc | 3.4E−35 |
| | | | | | transferase | |
| MSM1767 | Msp_1548 | hypothetical protein | 1.3E−04 | NONE | | |
| MSM1768 | NONE | | | NONE | | |
| MSM1769 | Msp_0724 | hypothetical membrane-spanning | 2.1E−08 | MTH_1277 | unknown | 8.9E−05 |
| | | protein | | | | |
| MSM1770 | Msp_0934 | conserved hypothetical membrane- | 1.4E−17 | MTH_518 | conserved protein | 3.4E−19 |
| | | spanning protein | | | | |
| MSM1771 | Msp_0128 | predicted helicase | 5.0E−19 | MTH_511 | DNA helicase II | 1.1E−26 |
| MSM1772 | Msp_0725 | hypothetical protein | 4.0E−11 | MTH_470 | conserved protein | 1.2E−04 |
| MSM1773 | Msp_1548 | hypothetical protein | 4.3E−07 | MTH_521 | unknown | 7.7E−05 |
| MSM1774 | NONE | | | NONE | | |
| MSM1775 | NONE | | | NONE | | |
| MSM1776 | NONE | | | NONE | | |
| MSM1777 | Msp_0799 | predicted transcriptional regulator | 3.3E−05 | MTH_671 | unknown | 2.6E−04 |
| MSM1778 | Msp_0726 | hypothetical protein | 2.7E−69 | NONE | | |
| MSM1779 | Msp_0725 | hypothetical protein | 2.6E−119 | NONE | | |
| MSM1780 | Msp_1055 | hypothetical membrane-spanning | 1.1E−10 | MTH_1277 | unknown | 2.7E−06 |
| | | protein | | | | |
| MSM1781 | Msp_0725 | hypothetical protein | 2.4E−13 | MTH_470 | conserved protein | 1.4E−05 |
| MSM1782 | NONE | | | NONE | | |
| MSM1783 | NONE | | | NONE | | |
| MSM1784 | NONE | | | NONE | | |
| MSM1785 | NONE | | | NONE | | |
| MSM1786 | Msp_1323 | conserved hypothetical protein | 4.1E−07 | MTH_83 | O-linked GlcNAc | 6.9E−12 |
| | | | | | transferase | |
| MSM1787 | Msp_1323 | conserved hypothetical protein | 5.6E−09 | MTH_72 | O-linked GlcNAc | 3.6E−16 |
| | | | | | transferase | |
| MSM1788 | Msp_1323 | conserved hypothetical protein | 7.3E−11 | MTH_83 | O-linked GlcNAc | 2.0E−20 |
| | | | | | transferase | |
| MSM1789 | Msp_0757 | predicted ATPase | 2.5E−08 | NONE | | |
| MSM1790 | Msp_0757 | predicted ATPase | 4.9E−08 | NONE | | |
| MSM1791 | NONE | | | MTH_512 | unknown | 1.1E−25 |
| MSM1792 | Msp_0764 | predicted nicotinate | 1.7E−193 | NONE | | |
| | | phosphoribosyltransferase | | | | |
| MSM1793 | NONE | | | NONE | | |
| MSM1794 | Msp_1103 | member of asn/thr-rich large protein | 1.5E−04 | MTH_512 | unknown | 1.2E−24 |
| | | family | | | | |
| MSM1795 | Msp_0757 | predicted ATPase | 1.7E−99 | NONE | | |

TABLE 9
Cluster of Orthologous Groups (COG) represented in the M. smithii PS
proteome
A. Summary

| Number | | |
|---|---|---|
| of M. smithii | | |
| genes | | |
| in COG | Code | Functional Category |
| 136 | J | Translation |
| 60 | K | Transcription |
| 78 | L | Replication, Recombination and Repair |
| 3 | B | Chromatin Structure and Dynamics |
| 6 | D | Cell Cycle Control |
| 26 | V | Defense Mechanisms |
| 8 | T | Signal Transduction Mechanisms |
| 59 | M | Cell Wall/Membrane Biogenesis |
| 3 | N | Cell Motility |
| 1 | Z | Cytoskeleton |
| 17 | U | Intracellular Trafficking and Secretion |
| 41 | O | Post-translational Modification, Protein Turnover, |
| | | Chaperones |
| 121 | C | Energy Production and Conversion |
| 30 | G | Carbohydrate Transport and Metabolism |
| 82 | E | Amino Acid Transport and Metabolism |
| 42 | F | Nucleic Acid Transport and Metabolism |
| 92 | H | Coenzyme Transport and Metabolism |
| 18 | I | Lipid Transport and Metabolism |
| 57 | P | Inorganic Ion Transport and Metabolism |
| 1 | Q | Secondary Metabolites Biosynthesis, Transport and |
| | | Catabolism |
| 201 | R | General Function Prediction Only |
| 171 | S | Function Unknown |
| 491 | — | Not in COGs |

B. M. smithii genes in each COG

| | | |
|---|---|---|
| # in COG COG | Description | M. smithii gene(s) |

Translation (J)

| | | | |
|---|---|---|---|
| 1 | COG0008 | Glutamyl- and glutaminyl-tRNA synthetases | MSM1452 |
| 1 | COG0009 | Putative translation factor (SUA5) | MSM0612 |
| 1 | COG0012 | Predicted GTPase, probable translation factor | MSM1164 |
| 1 | COG0013 | Alanyl-tRNA synthetase | MSM0619 |
| 1 | COG0016 | Phenylalanyl-tRNA synthetase alpha subunit | MSM1478 |
| 1 | COG0017 | Aspartyl/asparaginyl-tRNA synthetases | MSM1236 |
| 1 | COG0018 | Arginyl-tRNA synthetase | MSM1231 |
| 1 | COG0023 | Translation initiation factor 1 (elF-1/SUI1) and related | MSM0754 |
| | | proteins | |
| 1 | COG0024 | Methionine aminopeptidase | MSM1120 |
| 1 | COG0030 | Dimethyladenosine transferase (rRNA methylation) | MSM1374 |
| 1 | COG0042 | tRNA-dihydrouridine synthase | MSM0972 |
| 1 | COG0048 | Ribosomal protein S12 | MSM0901 |
| 1 | COG0049 | Ribosomal protein S7 | MSM0900 |
| 1 | COG0051 | Ribosomal protein S10 | MSM0897 |
| 1 | COG0060 | Isoleucyl-tRNA synthetase | MSM1341 |
| 1 | COG0064 | Asp-tRNAAsn/Glu-tRNAGln amidotransferase B | MSM1101 |
| | | subunit (PET112 homolog) | |
| 1 | COG0072 | Phenylalanyl-tRNA synthetase beta subunit | MSM0277 |
| 1 | COG0080 | Ribosomal protein L11 | MSM0623 |
| 1 | COG0081 | Ribosomal protein L1 | MSM0622 |
| 1 | COG0087 | Ribosomal protein L3 | MSM0762 |
| 1 | COG0088 | Ribosomal protein L4 | MSM0761 |
| 1 | COG0089 | Ribosomal protein L23 | MSM0760 |
| 1 | COG0090 | Ribosomal protein L2 | MSM0759 |
| 1 | COG0091 | Ribosomal protein L22 | MSM0757 |
| 1 | COG0092 | Ribosomal protein S3 | MSM0756 |
| 1 | COG0093 | Ribosomal protein L14 | MSM0751 |
| 1 | COG0094 | Ribosomal protein L5 | MSM0748 |
| 1 | COG0096 | Ribosomal protein S8 | MSM0746 |
| 1 | COG0097 | Ribosomal protein L6P/L9E | MSM0745 |
| 1 | COG0098 | Ribosomal protein S5 | MSM0741 |
| 1 | COG0099 | Ribosomal protein S13 | MSM1425 |
| 1 | COG0100 | Ribosomal protein S11 | MSM1427 |
| 1 | COG0101 | Pseudouridylate synthase | MSM0855 |
| 1 | COG0102 | Ribosomal protein L13 | MSM1430 |
| 1 | COG0103 | Ribosomal protein S9 | MSM1431 |
| 1 | COG0124 | Histidyl-tRNA synthetase | MSM1181 |
| 1 | COG0130 | Pseudouridine synthase | MSM0732 |
| 1 | COG0143 | Methionyl-tRNA synthetase | MSM0071 |
| 1 | COG0154 | Asp-tRNAAsn/Glu-tRNAGln amidotransferase A | MSM1253 |
| | | subunit and related amidases | |
| 1 | COG0162 | Tyrosyl-tRNA synthetase | MSM0513 |
| 1 | COG0172 | Seryl-tRNA synthetase | MSM1710 |
| 1 | COG0180 | Tryptophanyl-tRNA synthetase | MSM0216 |
| 1 | COG0182 | Predicted translation initiation factor 2B subunit, elF- | MSM0804 |
| | | 2B alpha/beta/delta family | |
| 1 | COG0184 | Ribosomal protein S15P/S13E | MSM1194 |
| 1 | COG0185 | Ribosomal protein S19 | MSM0758 |
| 1 | COG0186 | Ribosomal protein S17 | MSM0752 |
| 1 | COG0197 | Ribosomal protein L16/L10E | MSM0989 |
| 1 | COG0198 | Ribosomal protein L24 | MSM0750 |
| 1 | COG0199 | Ribosomal protein S14 | MSM0747 |
| 1 | COG0200 | Ribosomal protein L15 | MSM0739 |
| 1 | COG0215 | Cysteinyl-tRNA synthetase | MSM0268 |
| 1 | COG0231 | Translation elongation factor P (EF-P)/translation | MSM0877 |
| | | initiation factor 5A (elF-5A) | |
| 1 | COG0244 | Ribosomal protein L10 | MSM0621 |
| 1 | COG0255 | Ribosomal protein L29 | MSM0755 |
| 1 | COG0256 | Ribosomal protein L18 | MSM0742 |
| 1 | COG0293 | 23S rRNA methylase | MSM0508 |
| 1 | COG0343 | Queuine/archaeosine tRNA-ribosyltransferase | MSM1557 |
| 1 | COG0423 | Glycyl-tRNA synthetase (class II) | MSM0403 |
| 1 | COG0441 | Threonyl-tRNA synthetase | MSM1214 |
| 1 | COG0442 | Prolyl-tRNA synthetase | MSM0287 |
| 1 | COG0480 | Translation elongation factors (GTPases) | MSM0899 |
| 1 | COG0495 | Leucyl-tRNA synthetase | MSM1172 |
| 1 | COG0522 | Ribosomal protein S4 and related proteins | MSM1426 |
| 1 | COG0525 | Valyl-tRNA synthetase | MSM0275 |
| 1 | COG0532 | Translation initiation factor 2 (IF-2; GTPase) | MSM0202 |
| 1 | COG0565 | rRNA methylase | MSM0394 |
| 1 | COG0621 | 2-methylthioadenine synthetase | MSM0845 |
| 1 | COG0689 | RNase PH | MSM0242 |
| 1 | COG1093 | Translation initiation factor 2, alpha subunit (elF- | MSM1133 |
| | | 2alpha) | |
| 1 | COG1096 | Predicted RNA-binding protein (consists of S1 | MSM1357 |
| | | domain and a Zn-ribbon domain) | |
| 1 | COG1097 | RNA-binding protein Rrp4 and related proteins | MSM0243 |
| | | (contain S1 domain and KH domain) | |
| 1 | COG1258 | Predicted pseudouridylate synthase | MSM1361 |
| 1 | COG1325 | Predicted exosome subunit | MSM0297 |
| 1 | COG1358 | Ribosomal protein HS6-type (S12/L30/L7a) | MSM0206 |
| 1 | COG1369 | RNase P/RNase MRP subunit POP5 | MSM0246 |
| 1 | COG1383 | Ribosomal protein S17E | MSM0833 |
| 1 | COG1384 | Lysyl-tRNA synthetase (class I) | MSM1387 |
| 1 | COG1471 | Ribosomal protein S4E | MSM0749 |
| 1 | COG1491 | Predicted RNA-binding protein | MSM1375 |
| 1 | COG1498 | Protein implicated in ribosomal biogenesis, Nop56p | MSM1046 |
| | | homolog | |
| 1 | COG1500 | Predicted exosome subunit | MSM0244 |
| 1 | COG1503 | Peptide chain release factor 1 (eRF1) | MSM0891 |
| 1 | COG1514 | 2′-5′ RNA ligase | MSM0054 |
| 1 | COG1534 | Predicted RNA-binding protein containing KH | MSM0710 |
| | | domain, possibly ribosomal protein | |
| 2 | COG1549 | Queuine tRNA-ribosyltransferases, contain PUA | MSM0633, MSM0797 |
| | | domain | |
| 1 | COG1552 | Ribosomal protein L40E | MSM0125 |
| 1 | COG1588 | RNase P/RNase MRP subunit p29 | MSM0753 |
| 1 | COG1601 | Translation initiation factor 2, beta subunit (elF- | MSM0511 |
| | | 2beta)/elF-5 N-terminal domain | |
| 1 | COG1603 | RNase P/RNase MRP subunit p30 | MSM0247 |
| 1 | COG1631 | Ribosomal protein L44E | MSM1135 |
| 1 | COG1632 | Ribosomal protein L15E | MSM0298 |
| 1 | COG1670 | Acetyltransferases, including N-acetylases of | MSM1573 |
| | | ribosomal proteins | |
| 1 | COG1676 | tRNA splicing endonuclease | MSM0217 |
| 1 | COG1717 | Ribosomal protein L32E | MSM0744 |
| 1 | COG1727 | Ribosomal protein L18E | MSM1429 |
| 1 | COG1736 | Diphthamide synthase subunit DPH2 | MSM1358 |
| 1 | COG1746 | tRNA nucleotidyltransferase (CCA-adding enzyme) | MSM0053 |
| 1 | COG1798 | Diphthamide biosynthesis methyltransferase | MSM0801 |
| 1 | COG1841 | Ribosomal protein L30/L7E | MSM0740 |
| 1 | COG1867 | N2,N2-dimethylguanosine tRNA methyltransferase | MSM1031 |
| 1 | COG1889 | Fibrillarin-like rRNA methylase | MSM1047 |
| 1 | COG1890 | Ribosomal protein S3AE | MSM0661 |
| 1 | COG1911 | Ribosomal protein L30E | MSM0907 |
| 1 | COG1976 | Translation initiation factor 6 (elF-6) | MSM0704 |
| 1 | COG1997 | Ribosomal protein L37AE/L43A | MSM1630 |
| 1 | COG1998 | Ribosomal protein S27AE | MSM0193 |
| 1 | COG2004 | Ribosomal protein S24E | MSM0194 |
| 1 | COG2007 | Ribosomal protein S8E | MSM1486 |
| 1 | COG2016 | Predicted RNA-binding protein (contains PUA | MSM0183 |
| | | domain) | |
| 1 | COG2023 | RNase P subunit RPR2 | MSM0711 |
| 1 | COG2051 | Ribosomal protein S27E | MSM1134 |
| 1 | COG2053 | Ribosomal protein S28E/S33 | MSM0205 |
| 1 | COG2075 | Ribosomal protein L24E | MSM0204 |
| 1 | COG2092 | Translation elongation factor EF-1beta | MSM0602 |
| 1 | COG2097 | Ribosomal protein L31E | MSM0705 |
| 1 | COG2117 | Predicted subunit of tRNA(5-methylaminomethyl-2- | MSM0707 |
| | | thiouridylate) methyltransferase, contains the PP-loop | |
| | | ATPase domain | |
| 1 | COG2123 | RNase PH-related exoribonuclease | MSM0241 |
| 1 | COG2125 | Ribosomal protein S6E (S10) | MSM0201 |
| 1 | COG2126 | Ribosomal protein L37E | MSM0181 |
| 1 | COG2139 | Ribosomal protein L21E | MSM1377 |
| 1 | COG2147 | Ribosomal protein L19E | MSM0743 |
| 1 | COG2157 | Ribosomal protein L20A (L18A) | MSM0703 |
| 1 | COG2163 | Ribosomal protein L14E/L6E/L27E | MSM0733 |
| 1 | COG2167 | Ribosomal protein L39E | MSM0706 |
| 1 | COG2174 | Ribosomal protein L34E | MSM0735 |
| 1 | COG2238 | Ribosomal protein S19E (S16A) | MSM0709 |
| 1 | COG2260 | Predicted Zn-ribbon RNA-binding protein | MSM1132 |
| 1 | COG2263 | Predicted RNA methylase | MSM0764 |
| 1 | COG2511 | Archaeal Glu-tRNAGln amidotransferase subunit E | MSM0335 |
| | | (contains GAD domain) | |
| 1 | COG2519 | tRNA(1-methyladenosine) methyltransferase and | MSM1173 |
| | | related methyltransferases | |
| 1 | COG2888 | Predicted Zn-ribbon RNA-binding protein with a | MSM0603 |
| | | function in translation | |
| 1 | COG2890 | Methylase of polypeptide chain release factors | MSM1373 |
| 1 | COG3277 | RNA-binding protein involved in rRNA processing | MSM0425 |
| 1 | COG5256 | Translation elongation factor EF-1alpha (GTPase) | MSM0898 |
| 1 | COG5257 | Translation initiation factor 2, gamma subunit (elF- | MSM0200 |
| | | 2gamma; GTPase) | |

Transcription (K)

| | | | |
|---|---|---|---|
| 2 | COG0085 | DNA-directed RNA polymerase, beta subunit/140 kD | MSM0910, MSM0911 |
| | | subunit | |
| 2 | COG0086 | DNA-directed RNA polymerase, beta′ subunit/160 kD | MSM0908, MSM0909 |
| | | subunit | |
| 1 | COG0195 | Transcription elongation factor | MSM0906 |
| 1 | COG0202 | DNA-directed RNA polymerase, alpha subunit/40 kD | MSM1428 |
| | | subunit | |
| 1 | COG0250 | Transcription antiterminator | MSM0624 |
| 1 | COG0571 | dsRNA-specific ribonuclease | MSM0176 |
| 1 | COG0583 | Transcriptional regulator | MSM1390 |
| 3 | COG0640 | Predicted transcriptional regulators | MSM0819, MSM1126, |
| | | | MSM1350 |
| 1 | COG0789 | Predicted transcriptional regulators | MSM0949 |
| 1 | COG0846 | NAD-dependent protein deacetylases, SIR2 family | MSM1087 |
| 1 | COG0864 | Predicted transcriptional regulators containing the | MSM0364 |
| | | CopG/Arc/MetJ DNA-binding domain and a metal- | |
| | | binding domain | |
| 1 | COG1095 | DNA-directed RNA polymerase, subunit E′ | MSM0197 |
| 1 | COG1293 | Predicted RNA-binding protein homologous to | MSM0778 |
| | | eukaryotic snRNP | |
| 1 | COG1308 | Transcription factor homologous to NACalpha-BTF3 | MSM0384 |
| 2 | COG1309 | Transcriptional regulator | MSM0094, MSM0650 |
| 1 | COG1321 | Mn-dependent transcriptional regulator | MSM0218 |
| 1 | COG1378 | Predicted transcriptional regulators | MSM1445 |
| 1 | COG1395 | Predicted transcriptional regulator | MSM0453 |
| 3 | COG1396 | Predicted transcriptional regulators | MSM0026, MSM0329, |
| | | | MSM1528 |
| 1 | COG1405 | Transcription initiation factor TFIIIB, Brf1 | MSM0424 |
| | | subunit/Transcription initiation factor TFIIB | |
| 1 | COG1476 | Predicted transcriptional regulators | MSM1150 |
| 1 | COG1497 | Predicted transcriptional regulator | MSM1499 |
| 1 | COG1522 | Transcriptional regulators | MSM1032 |
| 1 | COG1581 | Archaeal DNA-binding protein | MSM1245 |
| 3 | COG1594 | DNA-directed RNA polymerase, subunit | MSM1354, MSM1720, |
| | | M/Transcription elongation factor TFIIS | MSM1763 |
| 1 | COG1644 | DNA-directed RNA polymerase, subunit N | MSM1432 |
| | | (RpoN/RPB10) | |
| 1 | COG1675 | Transcription initiation factor IIE, alpha subunit | MSM0631 |
| 1 | COG1695 | Predicted transcriptional regulators | MSM1250 |
| 1 | COG1733 | Predicted transcriptional regulators | MSM0864 |
| 1 | COG1758 | DNA-directed RNA polymerase, subunit K/omega | MSM1433 |
| 1 | COG1761 | DNA-directed RNA polymerase, subunit L | MSM1356 |
| 1 | COG1777 | Predicted transcriptional regulators | MSM1107 |
| 1 | COG1813 | Predicted transcription factor, homolog of eukaryotic | MSM0355 |
| | | MBF1 | |
| 3 | COG1846 | Transcriptional regulators | MSM0413, MSM0600, |
| | | | MSM1230 |
| 2 | COG1958 | Small nuclear ribonucleoprotein (snRNP) homolog | MSM0182, MSM1220 |
| 1 | COG1996 | DNA-directed RNA polymerase, subunit RPC10 | MSM1631 |
| | | (contains C4-type Zn-finger) | |
| 1 | COG2012 | DNA-directed RNA polymerase, subunit H, | MSM0912 |
| | | RpoH/RPB5 | |
| 1 | COG2093 | DNA-directed RNA polymerase, subunit E″ | MSM0196 |
| 1 | COG2101 | TATA-box binding protein (TBP), component of TFIID | MSM0720 |
| | | and TFIIIB | |
| 1 | COG2183 | Transcriptional accessory protein | MSM1292 |
| 1 | COG2207 | AraC-type DNA-binding domain-containing proteins | MSM0775 |
| 1 | COG2524 | Predicted transcriptional regulator, contains C- | MSM1614 |
| | | terminal CBS domains | |
| 2 | COG2865 | Predicted transcriptional regulator containing an HTH | MSM0540, MSM1315 |
| | | domain and an uncharacterized domain shared with | |
| | | the mammalian protein Schlafen | |
| 1 | COG4008 | Predicted metal-binding transcription factor | MSM0969 |
| 3 | COG4742 | Predicted transcriptional regulator | MSM0404, MSM0817, |
| | | | MSM0818 |

Replication, Recombination and Repair (L)

| | | | |
|---|---|---|---|
| 2 | COG0084 | Mg-dependent DNase | MSM0097, MSM0416 |
| 1 | COG0122 | 3-methyladenine DNA glycosylase/8-oxoguanine | MSM1365 |
| | | DNA glycosylase | |
| 1 | COG0164 | Ribonuclease HII | MSM0979 |
| 2 | COG0177 | Predicted EndoIII-related endonuclease | MSM0272, MSM1584 |
| 1 | COG0178 | Excinuclease ATPase subunit | MSM1581 |
| 2 | COG0188 | Type IIA topoisomerase (DNA gyrase/topo II, | MSM1353, MSM1775 |
| | | topoisomerase IV), A subunit | |
| 5 | COG0210 | Superfamily I DNA and RNA helicases | MSM0058, MSM0113, |
| | | | MSM0731, MSM1420, |
| | | | MSM1771 |
| 1 | COG0258 | 5′-3′ exonuclease (including N-terminal domain of | MSM0725 |
| | | Poll) | |
| 1 | COG0270 | Site-specific DNA methylase | MSM0531 |
| 1 | COG0322 | Nuclease subunit of the excinuclease complex | MSM1695 |
| 1 | COG0350 | Methylated DNA-protein cysteine methyltransferase | MSM1185 |
| 1 | COG0358 | DNA primase (bacterial type) | MSM0427 |
| 2 | COG0417 | DNA polymerase elongation subunit (family B) | MSM1041, MSM1481 |
| 3 | COG0419 | ATPase involved in DNA repair | MSM0120, MSM0693, |
| | | | MSM1761 |
| 1 | COG0420 | DNA repair exonuclease | MSM0121 |
| 2 | COG0468 | RecA/RadA recombinase | MSM0611, MSM1333 |
| 2 | COG0470 | ATPase involved in DNA replication | MSM1176, MSM1177 |
| 1 | COG0550 | Topoisomerase IA | MSM0717 |
| 1 | COG0556 | Helicase subunit of the DNA excision repair complex | MSM1579 |
| 3 | COG0582 | Integrase | MSM0428, MSM1640, |
| | | | MSM1742 |
| 1 | COG0592 | DNA polymerase sliding clamp subunit (PCNA | MSM1137 |
| | | homolog) | |
| 2 | COG0608 | Single-stranded DNA-specific exonuclease | MSM1193, MSM1500 |
| 1 | COG0648 | Endonuclease IV | MSM0963 |
| 1 | COG0708 | Exonuclease III | MSM1479 |
| 1 | COG1041 | Predicted DNA modification methylase | MSM0352 |
| 1 | COG1107 | Archaea-specific RecJ-like exonuclease, contains | MSM0260 |
| | | DnaJ-type Zn finger domain | |
| 1 | COG1111 | ERCC4-like helicases | MSM1187 |
| 2 | COG1112 | Superfamily I DNA and RNA helicases and helicase | MSM1081, MSM1694 |
| | | subunits | |
| 1 | COG1193 | Mismatch repair ATPase (MutS family) | MSM0524 |
| 1 | COG1241 | Predicted ATPase involved in replication control, | MSM0510 |
| | | Cdc46/Mcm family | |
| 1 | COG1311 | Archaeal DNA polymerase II, small subunit/DNA | MSM1271 |
| | | polymerase delta, subunit B | |
| 1 | COG1343 | Uncharacterized protein predicted to be involved in | MSM0163 |
| | | DNA repair | |
| 1 | COG1389 | DNA topoisomerase VI, subunit B | MSM0955 |
| 2 | COG1468 | RecB family exonuclease | MSM0165, MSM1059 |
| 2 | COG1518 | Uncharacterized protein predicted to be involved in | MSM0023, MSM0164 |
| | | DNA repair | |
| 1 | COG1525 | Micrococcal nuclease (thermonuclease) homologs | MSM1495 |
| 1 | COG1533 | DNA repair photolyase | MSM0543 |
| 1 | COG1570 | Exonuclease VII, large subunit | MSM0001 |
| 1 | COG1583 | Uncharacterized protein predicted to be involved in | MSM0170 |
| | | DNA repair (RAMP superfamily) | |
| 1 | COG1591 | Holliday junction resolvase - archaeal type | MSM1098 |
| 1 | COG1599 | Single-stranded DNA-binding replication protein A | MSM1332 |
| | | (RPA), large (70 kD) subunit and related ssDNA- | |
| | | binding proteins | |
| 1 | COG1637 | Predicted nuclease of the RecB family | MSM0497 |
| 1 | COG1688 | Uncharacterized protein predicted to be involved in | MSM0167 |
| | | DNA repair (RAMP superfamily) | |
| 1 | COG1697 | DNA topoisomerase VI, subunit A | MSM0956 |
| 1 | COG1793 | ATP-dependent DNA ligase | MSM0645 |
| 1 | COG1857 | Uncharacterized protein predicted to be involved in | MSM0168 |
| | | DNA repair | |
| 1 | COG1933 | Archaeal DNA polymerase II, large subunit | MSM1384 |
| 1 | COG2219 | Eukaryotic-type DNA primase, large subunit | MSM0073 |
| 1 | COG2231 | Uncharacterized protein related to Endonuclease III | MSM1475 |
| 2 | COG3335 | Transposase and inactivated derivatives | MSM0460, MSM1589 |
| 1 | COG3359 | Predicted exonuclease | MSM0138 |
| 2 | COG3415 | Transposase and inactivated derivatives | MSM0458, MSM1588 |
| 5 | COG3464 | Transposase and inactivated derivatives | MSM0087, MSM0230, |
| | | | MSM0396, MSM1093, |
| | | | MSM1566 |
| 1 | COG3666 | Transposase and inactivated derivatives | MSM1523 |

Chromatin Structure and Dynamics (B)

| | | | |
|---|---|---|---|
| 3 | COG2036 | Histones H3 and H4 | MSM0213, MSM0844, |
| | | | MSM1260 |

Cell Cycle Control (D)

| | | | |
|---|---|---|---|
| 3 | COG0037 | Predicted ATPase of the PP-loop superfamily | MSM0553, MSM1028, |
| | | implicated in cell cycle control | MSM1178 |
| 1 | COG0489 | ATPases involved in chromosome partitioning | MSM0045 |
| 1 | COG1077 | Actin-like ATPase involved in cell morphogenesis | MSM0980 |
| 1 | COG1192 | ATPases involved in chromosome partitioning | MSM1241 |

Defense Mechanisms (V)

| | | | |
|---|---|---|---|
| 5 | COG0534 | Na+-driven multidrug efflux pump | MSM0152, MSM0252, |
| | | | MSM0414, MSM1228, |
| | | | MSM1229 |
| 2 | COG0577 | ABC-type antimicrobial peptide transport system, | MSM0856, MSM1400 |
| | | permease component | |
| 2 | COG0732 | Restriction endonuclease S subunits | MSM0157, MSM0158 |
| 2 | COG0842 | ABC-type multidrug transport system, permease | MSM1248, MSM1484 |
| | | component | |
| 6 | COG1002 | Type II restriction enzyme, methylase subunits | MSM1743, MSM1744, |
| | | | MSM1745, MSM1746, |
| | | | MSM1747, MSM1748 |
| 3 | COG1131 | ABC-type multidrug transport system, ATPase | MSM0593, MSM1249, |
| | | component | MSM1483 |
| 2 | COG1132 | ABC-type multidrug transport system, ATPase and | MSM0773, MSM0774 |
| | | permease components | |
| 1 | COG1136 | ABC-type antimicrobial peptide transport system, | MSM0857 |
| | | ATPase component | |
| 1 | COG1715 | Restriction endonuclease | MSM1752 |
| 1 | COG1968 | Uncharacterized bacitracin resistance protein | MSM1201 |
| 1 | COG4845 | Chloramphenicol O-acetyltransferase | MSM0047 |

Signal Transduction Mechanisms (T)

| | | | |
|---|---|---|---|
| 3 | COG0589 | Universal stress protein UspA and related nucleotide- | MSM0485, MSM0887, |
| | | binding proteins | MSM1699 |
| 5 | COG3448 | CBS-domain-containing membrane protein | MSM0305, MSM0484, |
| | | | MSM0790, MSM1053, |
| | | | MSM1054 |

Cell Wall/Membrane Biogenesis (M)

| | | | |
|---|---|---|---|
| 1 | COG0381 | UDP-N-acetylglucosamine 2-epimerase | MSM0853 |
| 3 | COG0399 | Predicted pyridoxal phosphate-dependent enzyme | MSM0347, MSM1030, |
| | | apparently involved in regulation of cell wall | MSM1536 |
| | | biogenesis | |
| 4 | COG0438 | Glycosyltransferase | MSM0836, MSM1313, |
| | | | MSM1317, MSM1322 |
| 1 | COG0449 | Glucosamine 6-phosphate synthetase, contains | MSM1551 |
| | | amidotransferase and phosphosugar isomerase | |
| | | domains | |
| 14 | COG0463 | Glycosyltransferases involved in cell wall biogenesis | MSM0423, MSM1290, |
| | | | MSM1294, MSM1297, |
| | | | MSM1310, MSM1311, |
| | | | MSM1312, MSM1316, |
| | | | MSM1323, MSM1324, |
| | | | MSM1328, MSM1545, |
| | | | MSM1623, MSM1627 |
| 2 | COG0472 | UDP-N-acetylmuramyl pentapeptide | MSM0066, MSM0360 |
| | | phosphotransferase/UDP-Nacetylglucosamine-1- | |
| | | phosphate transferase | |
| 1 | COG0562 | UDP-galactopyranose mutase | MSM1502 |
| 1 | COG0668 | Small-conductance mechanosensitive channel | MSM0493 |
| 1 | COG0677 | UDP-N-acetyl-D-mannosaminuronate dehydrogenase | MSM1303 |
| 1 | COG0707 | pfam match to MurG; not predicted to be a | MSM0638 |
| | | carbohydrate active enzyme by CAZy | |
| 1 | COG0750 | Predicted membrane-associated Zn-dependent | MSM1344 |
| | | proteases 1 | |
| 3 | COG0769 | UDP-N-acetylmuramyl tripeptide synthase | MSM0359, MSM1139, |
| | | | MSM1570 |
| 1 | COG0770 | UDP-N-acetylmuramyl pentapeptide synthase | MSM0880 |
| 1 | COG0771 | UDP-N-acetylmuramoylalanine-D-glutamate ligase | MSM0118 |
| 1 | COG0773 | UDP-N-acetylmuramate-alanine ligase | MSM1190 |
| 1 | COG0794 | Predicted sugar phosphate isomerase involved in | MSM1391 |
| | | capsule formation | |
| 1 | COG1004 | Predicted UDP-glucose 6-dehydrogenase | MSM1612 |
| 1 | COG1083 | CMP-N-acetylneuraminic acid synthetase | MSM0944 |
| 1 | COG1087 | UDP-glucose 4-epimerase | MSM1702 |
| 1 | COG1088 | dTDP-D-glucose 4,6-dehydratase | MSM1309 |
| 1 | COG1091 | dTDP-4-dehydrorhamnose reductase | MSM1304 |
| 1 | COG1209 | dTDP-glucose pyrophosphorylase | MSM1307 |
| 1 | COG1210 | UDP-glucose pyrophosphorylase | MSM1604 |
| 1 | COG1861 | Spore coat polysaccharide biosynthesis protein F, | MSM1537 |
| | | CMP-KDO synthetase homolog | |
| 1 | COG1887 | Putative glycosyl/glycerophosphate transferases | MSM1327 |
| | | involved in teichoic acid biosynthesis | |
| | | TagF/TagB/EpsJ/RodC | |
| 1 | COG1898 | dTDP-4-dehydrorhamnose 3,5-epimerase and related | MSM1308 |
| | | enzymes | |
| 1 | COG2089 | Sialic acid synthase | MSM1539 |
| 1 | COG2148 | Sugar transferases involved in lipopolysaccharide | MSM1331 |
| | | synthesis | |
| 1 | COG2222 | Predicted phosphosugar isomerases | MSM0872 |
| 2 | COG2230 | Cyclopropane fatty acid synthase and related | MSM0274, MSM0490 |
| | | methyltransferases | |
| 1 | COG2843 | Putative enzyme of poly-gamma-glutamate | MSM0700 |
| | | biosynthesis (capsule formation) | |
| 1 | COG3049 | Penicillin V acylase and related amidases | MSM0986 |
| 3 | COG3475 | LPS biosynthesis protein | MSM1512, MSM1515, |
| | | | MSM1544 |
| 1 | COG3764 | Sortase (surface protein transpeptidase) | MSM0984 |
| 1 | COG3980 | Spore coat polysaccharide biosynthesis protein, | MSM1538 |
| | | predicted glycosyltransferase | |

Cell Motility (N)

| | | | |
|---|---|---|---|
| 1 | COG3351 | Putative archaeal flagellar protein D/E | MSM0137 |
| 2 | COG5651 | PPE-repeat proteins | MSM1586, MSM1590 |

Cytoskeleton (Z)

| | | | |
|---|---|---|---|
| 1 | COG5023 | Tubulin | MSM1794 |

Intracellular Trafficking and Secretion (U)

| | | | |
|---|---|---|---|
| 1 | COG0201 | Preprotein translocase subunit SecY | MSM0738 |
| 1 | COG0541 | Signal recognition particle GTPase | MSM1360 |
| 1 | COG0552 | Signal recognition particle GTPase | MSM0701 |
| 2 | COG0681 | Signal peptidase I | MSM0232, MSM1232 |
| 3 | COG0811 | Biopolymer transport proteins | MSM0978, MSM1401, |
| | | | MSM1718 |
| 1 | COG0848 | Biopolymer transport protein | MSM0977 |
| 1 | COG1400 | Signal recognition particle 19 kDa protein | MSM1501 |
| 1 | COG2443 | Preprotein translocase subunit Sss1 | MSM0625 |
| 2 | COG3210 | Large exoproteins involved in heme utilization or | MSM0461, MSM1398 |
| | | adhesion | |
| 1 | COG4023 | Preprotein translocase subunit Sec61beta | MSM1363 |
| 1 | COG4962 | Flp pilus assembly protein, ATPase CpaF | MSM0597 |
| 2 | COG4965 | Flp pilus assembly protein TadB | MSM0471, MSM0596 |

Post-translational Modification, Protein Turnover, Chaperones (O)

| | | | |
|---|---|---|---|
| 1 | COG0068 | Hydrogenase maturation factor | MSM1106 |
| 1 | COG0071 | Molecular chaperone (small heat shock protein) | MSM0870 |
| 1 | COG0225 | Peptide methionine sulfoxide reductase | MSM0582 |
| 1 | COG0298 | Hydrogenase maturation factor | MSM0636 |
| 1 | COG0309 | Hydrogenase maturation factor | MSM1492 |
| 1 | COG0396 | ABC-type transport system involved in Fe—S cluster | MSM1003 |
| | | assembly, ATPase component | |
| 1 | COG0409 | Hydrogenase maturation factor | MSM0945 |
| 1 | COG0443 | Molecular chaperone | MSM1109 |
| 3 | COG0459 | Chaperonin GroEL (HSP60 family) | MSM0220, MSM0826, |
| | | | MSM1533 |
| 1 | COG0464 | ATPases of the AAA+ class | MSM0642 |
| 1 | COG0484 | DnaJ-class molecular chaperone with C-terminal Zn | MSM1110 |
| | | finger domain | |
| 1 | COG0492 | Thioredoxin reductase | MSM0340 |
| 2 | COG0501 | Zn-dependent protease with chaperone function | MSM1174, MSM1203 |
| 1 | COG0533 | Metal-dependent proteases with possible chaperone | MSM1198 |
| | | activity | |
| 1 | COG0576 | Molecular chaperone GrpE (heat shock protein) | MSM1108 |
| 1 | COG0602 | Organic radical activating enzymes | MSM1055 |
| 2 | COG0638 | 20S proteasome, alpha and beta subunits | MSM0245, MSM1037 |
| 1 | COG0652 | Peptidyl-prolyl cis-trans isomerase (rotamase) - | MSM1367 |
| | | cyclophilin family | |
| 1 | COG0719 | ABC-type transport system involved in Fe—S cluster | MSM1002 |
| | | assembly, permease component | |
| 1 | COG0785 | Cytochrome c biogenesis protein | MSM0549 |
| 3 | COG0826 | Collagenase and related proteases | MSM0522, MSM0523, |
| | | | MSM1705 |
| 1 | COG1047 | FKBP-type peptidyl-prolyl cis-trans isomerases 2 | MSM0930 |
| 1 | COG1067 | Predicted ATP-dependent protease | MSM1569 |
| 3 | COG1180 | Pyruvate-formate lyase-activating enzyme | MSM0538, MSM0652, |
| | | | MSM1284 |
| 1 | COG1222 | ATP-dependent 26S proteasome regulatory subunit | MSM0354 |
| 1 | COG1382 | Prefoldin, chaperonin cofactor | MSM1634 |
| 1 | COG1397 | ADP-ribosylglycohydrolase | MSM1572 |
| 1 | COG1730 | Predicted prefoldin, molecular chaperone implicated | MSM0702 |
| | | in de novo protein folding | |
| 1 | COG1899 | Deoxyhypusine synthase | MSM1615 |
| 1 | COG1973 | Hydrogenase maturation factor | MSM1158 |
| 1 | COG2143 | Thioredoxin-related protein | MSM0550 |
| 1 | COG4070 | Predicted peptidyl-prolyl cis-trans isomerase | MSM0813 |
| | | (rotamase), cyclophilin family | |
| 1 | COG4930 | Predicted ATP-dependent Lon-type protease | MSM1754 |

Energy Production and Conversion (C)

| | | | |
|---|---|---|---|
| 1 | COG0045 | Succinyl-CoA synthetase, beta subunit | MSM0924 |
| 1 | COG0074 | Succinyl-CoA synthetase, alpha subunit | MSM0228 |
| 1 | COG0221 | Inorganic pyrophosphatase | MSM0198 |
| 1 | COG0240 | Glycerol-3-phosphate dehydrogenase | MSM1540 |
| 2 | COG0243 | Anaerobic dehydrogenases, typically selenocysteine- | MSM1404, MSM1463 |
| | | containing | |
| 1 | COG0247 | Fe—S oxidoreductase | MSM1625 |
| 1 | COG0371 | Glycerol dehydrogenase and related enzymes | MSM0286 |
| 1 | COG0372 | Citrate synthase | MSM0446 |
| 2 | COG0426 | Uncharacterized flavoproteins | MSM0222, MSM1349 |
| 1 | COG0479 | Succinate dehydrogenase/fumarate reductase, Fe—S | MSM0393 |
| | | protein subunit | |
| 1 | COG0636 | F0F1-type ATP synthase, subunit | MSM0439 |
| | | c/Archaeal/vacuolar-type H+-ATPase, subunit K | |
| 1 | COG0644 | Dehydrogenases (flavoproteins) | MSM1701 |
| 2 | COG0650 | Formate hydrogenlyase subunit 4 | MSM0317, MSM1062 |
| 3 | COG0674 | Pyruvate:ferredoxin oxidoreductase and related 2- | MSM0332, MSM0559, |
| | | oxoacid:ferredoxin oxidoreductases, alpha subunit | MSM0927 |
| 1 | COG0680 | Ni,Fe-hydrogenase maturation factor | MSM1123 |
| 3 | COG0716 | Flavodoxins | MSM0062, MSM0503, |
| | | | MSM0861 |
| 1 | COG0731 | Fe—S oxidoreductases | MSM0922 |
| 4 | COG0778 | Nitroreductase | MSM0445, MSM1293, |
| | | | MSM1574, MSM1722 |
| 1 | COG0822 | NifU homolog involved in Fe—S cluster formation | MSM0263 |
| 1 | COG1012 | NAD-dependent aldehyde dehydrogenases | MSM0467 |
| 3 | COG1013 | Pyruvate:ferredoxin oxidoreductase and related 2- | MSM0333, MSM0560, |
| | | oxoacid:ferredoxin oxidoreductases, beta subunit | MSM0926 |
| 3 | COG1014 | Pyruvate:ferredoxin oxidoreductase and related 2- | MSM0391, MSM0557, |
| | | oxoacid:ferredoxin oxidoreductases, gamma subunit | MSM0925 |
| 1 | COG1029 | Formylmethanofuran dehydrogenase subunit B | MSM1412 |
| 2 | COG1032 | Fe—S oxidoreductase | MSM0696, MSM0787 |
| 4 | COG1035 | Coenzyme F420-reducing hydrogenase, beta subunit | MSM0135, MSM1121, |
| | | | MSM1405, MSM1462 |
| 1 | COG1036 | Archaeal flavoproteins | MSM1338 |
| 1 | COG1042 | Acyl-CoA synthetase (NDP forming) | MSM1471 |
| 1 | COG1053 | Succinate dehydrogenase/fumarate reductase, | MSM1258 |
| | | flavoprotein subunit | |
| 1 | COG1139 | Uncharacterized conserved protein containing a | MSM1626 |
| | | ferredoxin-like domain | |
| 2 | COG1142 | Fe—S-cluster-containing hydrogenase components 2 | MSM0561, MSM0562 |
| 2 | COG1143 | Formate hydrogenlyase subunit 6/NADH:ubiquinone | MSM0998, MSM1065 |
| | | oxidoreductase 23 kD subunit (chain I) | |
| 1 | COG1144 | Pyruvate:ferredoxin oxidoreductase and related 2- | MSM0558 |
| | | oxoacid:ferredoxin oxidoreductases, delta subunit | |
| 12 | COG1145 | Ferredoxin | MSM0136, MSM0306, |
| | | | MSM0310, MSM0311, |
| | | | MSM0395, MSM0579, |
| | | | MSM0783, MSM0784, |
| | | | MSM1066, MSM1409, |
| | | | MSM1410, MSM1700 |
| 5 | COG1146 | Ferredoxin | MSM0085, MSM0209, |
| | | | MSM0331, MSM0928, |
| | | | MSM1408 |
| 2 | COG1148 | Heterodisulfide reductase, subunit A and related | MSM0082, MSM1336 |
| | | polyferredoxins | |
| 2 | COG1150 | Heterodisulfide reductase, subunit C | MSM0084, MSM0796 |
| 1 | COG1151 | 6Fe—6S prismane cluster-containing protein | MSM1446 |
| 1 | COG1153 | Formylmethanofuran dehydrogenase subunit D | MSM1411 |
| 1 | COG1155 | Archaeal/vacuolar-type H+-ATPase subunit A | MSM0435 |
| 1 | COG1156 | Archaeal/vacuolar-type H+-ATPase subunit B | MSM0434 |
| 1 | COG1229 | Formylmethanofuran dehydrogenase subunit A | MSM1413 |
| 1 | COG1249 | Pyruvate/2-oxoglutarate dehydrogenase complex, | MSM0637 |
| | | dihydrolipoamide dehydrogenase (E3) component, | |
| | | and related enzymes | |
| 1 | COG1269 | Archaeal/vacuolar-type H+-ATPase subunit I | MSM0440 |
| 1 | COG1304 | L-lactate dehydrogenase (FMN-dependent) and | MSM1441 |
| | | related alpha-hydroxy acid dehydrogenases | |
| 1 | COG1390 | Archaeal/vacuolar-type H+-ATPase subunit E | MSM0438 |
| 1 | COG1394 | Archaeal/vacuolar-type H+-ATPase subunit D | MSM0433 |
| 2 | COG1413 | FOG: HEAT repeat | MSM0372, MSM0501 |
| 1 | COG1436 | Archaeal/vacuolar-type H+-ATPase subunit F | MSM0436 |
| 2 | COG1526 | Uncharacterized protein required for formate | MSM0295, MSM1392 |
| | | dehydrogenase activity | |
| 1 | COG1527 | Archaeal/vacuolar-type H+-ATPase subunit C | MSM0437 |
| 2 | COG1592 | Rubrerythrin | MSM1348, MSM1733 |
| 1 | COG1600 | Uncharacterized Fe—S protein | MSM0609 |
| 1 | COG1625 | Fe—S oxidoreductase, related to NifB/MoaA family | MSM1020 |
| 2 | COG1773 | Rubredoxin | MSM0187, MSM0188 |
| 2 | COG1838 | Tartrate dehydratase beta subunit/Fumarate | MSM0769, MSM0929 |
| | | hydratase class I, C-terminal domain | |
| 2 | COG1908 | Coenzyme F420-reducing hydrogenase, delta subunit | MSM1001, MSM1461 |
| 2 | COG1941 | Coenzyme F420-reducing hydrogenase, gamma | MSM1000, MSM1122 |
| | | subunit | |
| 2 | COG1951 | Tartrate dehydratase alpha subunit/Fumarate | MSM0447, MSM0563 |
| | | hydratase class I, N-terminal domain | |
| 1 | COG2033 | Desulfoferrodoxin | MSM0262 |
| 2 | COG2037 | Formylmethanofuran:tetrahydromethanopterin | MSM0308, MSM1092 |
| | | formyltransferase | |
| 2 | COG2048 | Heterodisulfide reductase, subunit B | MSM0083, MSM0795 |
| 1 | COG2055 | Malate/L-lactate dehydrogenases | MSM1040 |
| 1 | COG2141 | Coenzyme F420-dependent N5,N10-methylene | MSM0542 |
| | | tetrahydromethanopterin reductase and related flavin- | |
| | | dependent oxidoreductases | |
| 1 | COG2191 | Formylmethanofuran dehydrogenase subunit E | MSM1396 |
| 1 | COG2218 | Formylmethanofuran dehydrogenase subunit C | MSM1414 |
| 1 | COG2710 | Nitrogenase molybdenum-iron protein, alpha and beta | MSM1160 |
| | | chains | |
| 1 | COG2811 | Archaeal/vacuolar-type H+-ATPase subunit H | MSM0441 |
| 2 | COG3259 | Coenzyme F420-reducing hydrogenase, alpha subunit | MSM0999, MSM1124 |
| 1 | COG3260 | Ni,Fe-hydrogenase III small subunit | MSM1064 |
| 1 | COG3261 | Ni,Fe-hydrogenase III large subunit | MSM1063 |
| 2 | COG4231 | Indolepyruvate ferredoxin oxidoreductase, alpha and | MSM0392, MSM1460 |
| | | beta subunits | |
| 1 | COG5016 | Pyruvate/oxaloacetate carboxyltransferase | MSM0939 |

Carbohydrate Transport and Metabolism (G)

| | | | |
|---|---|---|---|
| 1 | COG0057 | Glyceraldehyde-3-phosphate | MSM0962 |
| | | dehydrogenase/erythrose-4-phosphate | |
| | | dehydrogenase | |
| 1 | COG0063 | Predicted sugar kinase | MSM1091 |
| 1 | COG0120 | Ribose 5-phosphate isomerase | MSM0284 |
| 1 | COG0126 | 3-phosphoglycerate kinase | MSM0918 |
| 1 | COG0148 | Enolase | MSM1435 |
| 1 | COG0149 | Triosephosphate isomerase | MSM0919 |
| 1 | COG0235 | Ribulose-5-phosphate 4-epimerase and related | MSM1270 |
| | | epimerases and aldolases | |
| 1 | COG0483 | Archaeal fructose-1,6-bisphosphatase and related | MSM0879 |
| | | enzymes of inositol monophosphatase family | |
| 3 | COG0524 | Sugar kinases, ribokinase family | MSM0307, MSM1389, |
| | | | MSM1693 |
| 2 | COG0574 | Phosphoenolpyruvate synthase/pyruvate phosphate | MSM0823, MSM0988 |
| | | dikinase | |
| 1 | COG0580 | Glycerol uptake facilitator and related permeases | MSM1085 |
| | | (Major Intrinsic Protein Family) | |
| 2 | COG1082 | Sugar phosphate isomerases/epimerases | MSM1184, MSM1251 |
| 2 | COG1109 | Phosphomannomutase | MSM0648, MSM0656 |
| 1 | COG1363 | Cellulase M and related proteins | MSM0134 |
| 1 | COG1830 | DhnA-type fructose-1,6-bisphosphate aldolase and | MSM0056 |
| | | related enzymes | |
| 1 | COG1980 | Archaeal fructose 1,6-bisphosphatase | MSM0615 |
| 2 | COG2074 | 2-phosphoglycerate kinase | MSM0408, MSM0791 |
| 2 | COG2730 | Endoglucanase | MSM1051, MSM1125 |
| 2 | COG2814 | Arabinose efflux permease | MSM1459, MSM1465 |
| 2 | COG3635 | Predicted phosphoglycerate mutase, AP superfamily | MSM0153, MSM0657 |
| 1 | COG5297 | Cellobiohydrolase A (1,4-beta-cellobiosidase A) | MSM0958 |

Amino Acid Transport and Metabolism (E)

| | | | |
|---|---|---|---|
| 1 | COG0002 | Acetylglutamate semialdehyde dehydrogenase | MSM0860 |
| 1 | COG0006 | Xaa-Pro aminopeptidase | MSM0472 |
| 1 | COG0019 | Diaminopimelate decarboxylase | MSM1371 |
| 1 | COG0031 | Cysteine synthase | MSM0271 |
| 1 | COG0040 | ATP phosphoribosyltransferase | MSM1261 |
| 2 | COG0065 | 3-isopropylmalate dehydratase large subunit | MSM0723, MSM1300 |
| 2 | COG0066 | 3-isopropylmalate dehydratase small subunit | MSM0847, MSM1299 |
| 1 | COG0067 | Glutamate synthase domain 1 | MSM0370 |
| 2 | COG0069 | Glutamate synthase domain 2 | MSM0027, MSM0368 |
| 1 | COG0070 | Glutamate synthase domain 3 | MSM0369 |
| 2 | COG0075 | Serine-pyruvate aminotransferase/archaeal aspartate | MSM0677, MSM1513 |
| | | aminotransferase | |
| 1 | COG0076 | Glutamate decarboxylase and related PLP-dependent | MSM0987 |
| | | proteins | |
| 1 | COG0077 | Prephenate dehydratase | MSM1052 |
| 1 | COG0078 | Ornithine carbamoyltransferase | MSM1226 |
| 2 | COG0079 | Histidinol-phosphate/aromatic aminotransferase and | MSM0653, MSM1516 |
| | | cobyric acid decarboxylase | |
| 1 | COG0082 | Chorismate synthase | MSM1474 |
| 1 | COG0106 | Phosphoribosylformimino-5-aminoimidazole | MSM0858 |
| | | carboxamide ribonucleotide (ProFAR) isomerase | |
| 1 | COG0107 | Imidazoleglycerol-phosphate synthase | MSM1364 |
| 1 | COG0112 | Glycine/serine hydroxymethyltransferase | MSM1337 |
| 1 | COG0118 | Glutamine amidotransferase | MSM1159 |
| 3 | COG0119 | Isopropylmalate/homocitrate/citramalate synthases | MSM0350, MSM0722, |
| | | | MSM1246 |
| 1 | COG0128 | 5-enolpyruvylshikimate-3-phosphate synthase | MSM0273 |
| 1 | COG0131 | Imidazoleglycerol-phosphate dehydratase | MSM1206 |
| 1 | COG0133 | Tryptophan synthase beta chain | MSM1142 |
| 1 | COG0134 | Indole-3-glycerol phosphate synthase | MSM1143 |
| 1 | COG0136 | Aspartate-semialdehyde dehydrogenase | MSM0829 |
| 1 | COG0137 | Argininosuccinate synthase | MSM1084 |
| 1 | COG0139 | Phosphoribosyl-AMP cyclohydrolase | MSM1182 |
| 1 | COG0140 | Phosphoribosyl-ATP pyrophosphohydrolase | MSM1103 |
| 1 | COG0141 | Histidinol dehydrogenase | MSM1238 |
| 1 | COG0165 | Argininosuccinate lyase | MSM0192 |
| 1 | COG0169 | Shikimate 5-dehydrogenase | MSM1179 |
| 1 | COG0174 | Glutamine synthetase | MSM1418 |
| 1 | COG0253 | Diaminopimelate epimerase | MSM1372 |
| 1 | COG0287 | Prephenate dehydrogenase | MSM0641 |
| 1 | COG0289 | Dihydrodipicolinate reductase | MSM0830 |
| 1 | COG0334 | Glutamate dehydrogenase/leucine dehydrogenase | MSM0888 |
| 1 | COG0345 | Pyrroline-5-carboxylate reductase | MSM0089 |
| 1 | COG0346 | Lactoylglutathione lyase and related lyases | MSM1366 |
| 1 | COG0347 | Nitrogen regulatory protein PII | MSM0233 |
| 1 | COG0367 | Asparagine synthase (glutamine-hydrolyzing) | MSM0160 |
| 3 | COG0436 | Aspartate/tyrosine/aromatic aminotransferase | MSM0610, MSM0788, |
| | | | MSM1455 |
| 1 | COG0440 | Acetolactate synthase, small (regulatory) subunit | MSM1224 |
| 1 | COG0460 | Homoserine dehydrogenase | MSM0154 |
| 1 | COG0498 | Threonine synthase | MSM0214 |
| 1 | COG0527 | Aspartokinases | MSM0832 |
| 1 | COG0547 | Anthranilate phosphoribosyltransferase | MSM1144 |
| 1 | COG0548 | Acetylglutamate kinase | MSM0375 |
| 1 | COG0560 | Phosphoserine phosphatase | MSM0719 |
| 1 | COG0620 | Methionine synthase II (cobalamin-independent) | MSM0102 |
| 1 | COG0710 | 3-dehydroquinate dehydratase | MSM0231 |
| 1 | COG0747 | ABC-type dipeptide transport system, periplasmic | MSM0300 |
| | | component | |
| 1 | COG0765 | ABC-type amino acid transport system, permease | MSM0806 |
| | | component | |
| 1 | COG1045 | Serine acetyltransferase | MSM0270 |
| 1 | COG1104 | Cysteine sulfinate desulfinase/cysteine desulfurase | MSM0264 |
| | | and related enzymes | |
| 1 | COG1125 | ABC-type proline/glycine betaine transport systems, | MSM0990 |
| | | ATPase components | |
| 1 | COG1126 | ABC-type polar amino acid transport system, ATPase | MSM0805 |
| | | component | |
| 1 | COG1168 | Bifunctional PLP-dependent enzyme with beta- | MSM0044 |
| | | cystathionase and maltose regulon repressor activities | |
| 1 | COG1174 | ABC-type proline/glycine betaine transport systems, | MSM0991 |
| | | permease component | |
| 2 | COG1305 | Transglutaminase-like enzymes, putative cysteine | MSM0219, MSM0786 |
| | | proteases | |
| 1 | COG1465 | Predicted alternative 3-dehydroquinate synthase | MSM0055 |
| 1 | COG1605 | Chorismate mutase | MSM0834 |
| 1 | COG1812 | Archaeal S-adenosylmethionine synthetase | MSM1340 |
| 1 | COG1921 | Selenocysteine synthase [seryl-tRNASer selenium | MSM0767 |
| | | transferase] | |
| 1 | COG2021 | Homoserine acetyltransferase | MSM0496 |
| 1 | COG2061 | ACT-domain-containing protein, predicted allosteric | MSM0155 |
| | | regulator of homoserine dehydrogenase | |
| 1 | COG2303 | Choline dehydrogenase and related flavoproteins | MSM0865 |
| 1 | COG2423 | Predicted ornithine cyclodeaminase, mu-crystallin | MSM1517 |
| | | homolog | |
| 1 | COG2856 | Predicted Zn peptidase | MSM1529 |
| 2 | COG2873 | O-acetylhomoserine sulfhydrylase | MSM0174, MSM0265 |
| 1 | COG4992 | Ornithine/acetylornithine aminotransferase | MSM1368 |

Nucleic Acid Transport and Metabolism (F)

| | | | |
|---|---|---|---|
| 1 | COG0005 | Purine nucleoside phosphorylase | MSM0665 |
| 1 | COG0015 | Adenylosuccinate lyase | MSM1151 |
| 1 | COG0034 | Glutamine phosphoribosylpyrophosphate | MSM1704 |
| | | amidotransferase | |
| 1 | COG0035 | Uracil phosphoribosyltransferase | MSM0398 |
| 1 | COG0041 | Phosphoribosylcarboxyaminoimidazole (NCAIR) | MSM1287 |
| | | mutase | |
| 1 | COG0044 | Dihydroorotase and related cyclic amidohydrolases | MSM0997 |
| 1 | COG0046 | Phosphoribosylformylglycinamidine (FGAM) synthase, | MSM1342 |
| | | synthetase domain | |
| 1 | COG0047 | Phosphoribosylformylglycinamidine (FGAM) synthase, | MSM1549 |
| | | glutamine amidotransferase domain | |
| 1 | COG0104 | Adenylosuccinate synthase | MSM1468 |
| 1 | COG0105 | Nucleoside diphosphate kinase | MSM0203 |
| 2 | COG0125 | Thymidylate kinase | MSM0077, MSM0520 |
| 1 | COG0127 | Xanthosine triphosphate pyrophosphatase | MSM1195 |
| 1 | COG0150 | Phosphoribosylaminoimidazole (AIR) synthetase | MSM1039 |
| 1 | COG0151 | Phosphoribosylamine-glycine ligase | MSM1227 |
| 1 | COG0152 | Phosphoribosylaminoimidazolesuccinocarboxamide | MSM1547 |
| | | (SAICAR) synthase | |
| 1 | COG0167 | Dihydroorotate dehydrogenase | MSM1044 |
| 1 | COG0207 | Thymidylate synthase | MSM1734 |
| 1 | COG0274 | Deoxyribose-phosphate aldolase | MSM0843 |
| 1 | COG0284 | Orotidine-5′-phosphate decarboxylase | MSM1617 |
| 1 | COG0461 | Orotate phosphoribosyltransferase | MSM0821 |
| 1 | COG0503 | Adenine/guanine phosphoribosyltransferases and | MSM1359 |
| | | related PRPP-binding proteins | |
| 1 | COG0504 | CTP synthase (UTP-ammonia lyase) | MSM0147 |
| 1 | COG0516 | IMP dehydrogenase/GMP reductase | MSM1629 |
| 1 | COG0518 | GMP synthase - Glutamine amidotransferase domain | MSM0343 |
| 1 | COG0519 | GMP synthase, PP-ATPase domain/subunit | MSM0345 |
| 1 | COG0528 | Uridylate kinase | MSM0415 |
| 1 | COG0540 | Aspartate carbamoyltransferase, catalytic chain | MSM1263 |
| 2 | COG0717 | Deoxycytidine deaminase | MSM0402, MSM0687 |
| 1 | COG0856 | Orotate phosphoribosyltransferase homologs | MSM0883 |
| 1 | COG1001 | Adenine deaminase | MSM0874 |
| 1 | COG1051 | ADP-ribose pyrophosphatase | MSM1355 |
| 1 | COG1102 | Cytidylate kinase | MSM0734 |
| 1 | COG1328 | Oxygen-sensitive ribonucleoside-triphosphate | MSM1383 |
| | | reductase | |
| 1 | COG1437 | Adenylate cyclase, class 2 (thermophilic) | MSM0721 |
| 1 | COG1781 | Aspartate carbamoyltransferase, regulatory subunit | MSM0862 |
| 1 | COG1828 | Phosphoribosylformylglycinamidine (FGAM) synthase, | MSM1548 |
| | | PurS component | |
| 1 | COG1936 | Predicted nucleotide kinase (related to CMP and AMP | MSM0713 |
| | | kinases) | |
| 1 | COG2019 | Archaeal adenylate kinase | MSM0737 |
| 1 | COG2233 | Xanthine/uracil permeases | MSM0397 |
| 1 | COG3363 | Archaeal IMP cyclohydrolase | MSM0976 |

Coenzyme Transport and Metabolism (H)

| | | | |
|---|---|---|---|
| 1 | COG0001 | Glutamate-1-semialdehyde aminotransferase | MSM1233 |
| 1 | COG0007 | Uroporphyrinogen-III methylase | MSM1550 |
| 1 | COG0043 | 3-polyprenyl-4-hydroxybenzoate decarboxylase and | MSM1286 |
| | | related decarboxylases | |
| 1 | COG0054 | Riboflavin synthase beta-chain | MSM1296 |
| 1 | COG0108 | 3,4-dihydroxy-2-butanone 4-phosphate synthase | MSM1256 |
| 1 | COG0113 | Delta-aminolevulinic acid dehydratase | MSM1476 |
| 1 | COG0142 | Geranylgeranyl pyrophosphate synthase | MSM1443 |
| 1 | COG0157 | Nicotinate-nucleotide pyrophosphorylase | MSM0491 |
| 1 | COG0163 | 3-polyprenyl-4-hydroxybenzoate decarboxylase | MSM0237 |
| 1 | COG0171 | NAD synthase | MSM1171 |
| 1 | COG0181 | Porphobilinogen deaminase | MSM0881 |
| 1 | COG0237 | Dephospho-CoA kinase | MSM0141 |
| 1 | COG0294 | Dihydropteroate synthase and related enzymes | MSM0556 |
| 1 | COG0301 | Thiamine biosynthesis ATP pyrophosphatase | MSM0617 |
| 2 | COG0303 | Molybdopterin biosynthesis enzyme | MSM0950, MSM1343 |
| 1 | COG0311 | Predicted glutamine amidotransferase involved in | MSM0371 |
| | | pyridoxine biosynthesis | |
| 1 | COG0314 | Molybdopterin converting factor, large subunit | MSM0130 |
| 1 | COG0315 | Molybdenum cofactor biosynthesis enzyme | MSM1362 |
| 1 | COG0340 | Biotin-(acetyl-CoA carboxylase) ligase | MSM0766 |
| 1 | COG0351 | Hydroxymethylpyrimidine/phosphomethylpyrimidine | MSM0289 |
| | | kinase | |
| 1 | COG0352 | Thiamine monophosphate synthase | MSM0917 |
| 1 | COG0373 | Glutamyl-tRNA reductase | MSM0967 |
| 1 | COG0379 | Quinolinate synthase | MSM0494 |
| 1 | COG0382 | 4-hydroxybenzoate polyprenyltransferase and related | MSM0941 |
| | | prenyltransferases | |
| 1 | COG0407 | Uroporphyrinogen-III decarboxylase | MSM0518 |
| 2 | COG0422 | Thiamine biosynthesis protein ThiC | MSM0644, MSM1388 |
| 2 | COG0452 | Phosphopantothenoylcysteine | MSM1048, MSM1049 |
| | | synthetase/decarboxylase | |
| 1 | COG0476 | Dinucleotide-utilizing enzymes involved in | MSM0729 |
| | | molybdopterin and thiamine biosynthesis family 2 | |
| 1 | COG0499 | S-adenosylhomocysteine hydrolase | MSM0727 |
| 2 | COG0502 | Biotin synthase and related enzymes | MSM0573, MSM1099 |
| 1 | COG0521 | Molybdopterin biosynthesis enzymes | MSM0820 |
| 1 | COG0611 | Thiamine monophosphate kinase | MSM1283 |
| 1 | COG0684 | Demethylmenaquinone methyltransferase | MSM0426 |
| 1 | COG0720 | 6-pyruvoyl-tetrahydropterin synthase | MSM1056 |
| 1 | COG0746 | Molybdopterin-guanine dinucleotide biosynthesis | MSM0240 |
| | | protein A | |
| 1 | COG1010 | Precorrin-3B methylase | MSM1273 |
| 1 | COG1056 | Nicotinamide mononucleotide adenylyltransferase | MSM0129 |
| 1 | COG1270 | Cobalamin biosynthesis protein CobD/CbiB | MSM1266 |
| 2 | COG1429 | Cobalamin biosynthesis protein CobN and related Mg- | MSM1117, MSM1715 |
| | | chelatases | |
| 1 | COG1488 | Nicotinic acid phosphoribosyltransferase | MSM1792 |
| 2 | COG1492 | Cobyric acid synthase | MSM1254, MSM1565 |
| 2 | COG1541 | Coenzyme F390 synthetase | MSM0387, MSM1714 |
| 1 | COG1587 | Uroporphyrinogen-III synthase | MSM1504 |
| 1 | COG1648 | Siroheme synthase (precorrin-2 oxidase/ferrochelatase | MSM0968 |
| | | domain) | |
| 1 | COG1731 | Archaeal riboflavin synthase | MSM1622 |
| 1 | COG1763 | Molybdopterin-guanine dinucleotide biosynthesis | MSM1407 |
| | | protein | |
| 1 | COG1767 | Triphosphoribosyl-dephospho-CoA synthetase | MSM1477 |
| 1 | COG1797 | Cobyrinic acid a,c-diamide synthase | MSM1215 |
| 1 | COG1893 | Ketopantoate reductase | MSM0033 |
| 2 | COG1962 | Tetrahydromethanopterin S-methyltransferase, subunit H | MSM0627, MSM1007 |
| 1 | COG1985 | Pyrimidine reductase, riboflavin biosynthesis | MSM0065 |
| 1 | COG2038 | NaMN:DMB phosphoribosyltransferase | MSM1200 |
| 1 | COG2073 | Cobalamin biosynthesis protein CbiG | MSM1267 |
| 1 | COG2082 | Precorrin isomerase | MSM1234 |
| 1 | COG2099 | Precorrin-6x reductase | MSM0896 |
| 1 | COG2104 | Sulfur transfer protein involved in thiamine | MSM0552 |
| | | biosynthesis | |
| 1 | COG2145 | Hydroxyethylthiazole kinase, sugar kinase family | MSM0916 |
| 3 | COG2226 | Methylase involved in ubiquinone/menaquinone | MSM1448, MSM1558, |
| | | biosynthesis | MSM1564 |
| 1 | COG2241 | Precorrin-6B methylase 1 | MSM1167 |
| 1 | COG2242 | Precorrin-6B methylase 2 | MSM0238 |
| 1 | COG2243 | Precorrin-2 methylase | MSM1351 |
| 1 | COG2266 | GTP:adenosylcobinamide-phosphate | MSM1005 |
| | | guanylyltransferase | |
| 1 | COG2875 | Precorrin-4 methylase | MSM0101 |
| 1 | COG2896 | Molybdenum cofactor biosynthesis enzyme | MSM1406 |
| 1 | COG3161 | 4-hydroxybenzoate synthetase (chorismate lyase) | MSM0724 |
| 1 | COG3252 | Methenyltetrahydromethanopterin cyclohydrolase | MSM1723 |
| 2 | COG4054 | Methyl coenzyme M reductase, beta subunit | MSM0905, MSM1019 |
| 2 | COG4055 | Methyl coenzyme M reductase, subunit D | MSM0904, MSM1018 |
| 1 | COG4056 | Methyl coenzyme M reductase, subunit C | MSM1017 |
| 2 | COG4057 | Methyl coenzyme M reductase, gamma subunit | MSM0903, MSM1016 |
| 2 | COG4058 | Methyl coenzyme M reductase, alpha subunit | MSM0902, MSM1015 |
| 1 | COG4059 | Tetrahydromethanopterin S-methyltransferase, | MSM1014 |
| | | subunit E | |
| 1 | COG4060 | Tetrahydromethanopterin S-methyltransferase, | MSM1013 |
| | | subunit D | |
| 1 | COG4061 | Tetrahydromethanopterin S-methyltransferase, | MSM1012 |
| | | subunit C | |
| 1 | COG4062 | Tetrahydromethanopterin S-methyltransferase, | MSM1011 |
| | | subunit B | |
| 1 | COG4063 | Tetrahydromethanopterin S-methyltransferase, | MSM1010 |
| | | subunit A | |
| 1 | COG4064 | Tetrahydromethanopterin S-methyltransferase, | MSM1008 |
| | | subunit G | |
| 1 | COG4218 | Tetrahydromethanopterin S-methyltransferase, | MSM1009 |
| | | subunit F | |

Lipid Transport and Metabolism (I)

| | | | |
|---|---|---|---|
| 1 | COG0020 | Undecaprenyl pyrophosphate synthase | MSM0096 |
| 1 | COG0170 | Dolichol kinase | MSM0078 |
| 1 | COG0183 | Acetyl-CoA acetyltransferase | MSM1562 |
| 1 | COG0365 | Acyl-coenzyme A synthetases/AMP-(fatty) acid | MSM0330 |
| | | ligases | |
| 1 | COG0439 | Biotin carboxylase | MSM0765 |
| 2 | COG0558 | Phosphatidylglycerophosphate synthase | MSM0613, MSM1706 |
| 1 | COG0575 | CDP-diglyceride synthetase | MSM0850 |
| 1 | COG1183 | Phosphatidylserine synthase | MSM0982 |
| 2 | COG1211 | 4-diphosphocytidyl-2-methyl-D-erithritol synthase | MSM0377, MSM1542 |
| 1 | COG1250 | 3-hydroxyacyl-CoA dehydrogenase | MSM0965 |
| 1 | COG1257 | Hydroxymethylglutaryl-CoA reductase | MSM0227 |
| 1 | COG1260 | Myo-inositol-1-phosphate synthase | MSM0940 |
| 1 | COG1267 | Phosphatidylglycerophosphatase A and related | MSM0934 |
| | | proteins | |
| 1 | COG1577 | Mevalonate kinase | MSM1439 |
| 1 | COG1924 | Activator of 2-hydroxyglutaryl-CoA dehydratase | MSM0810 |
| | | (HSP70-class ATPase domain) | |
| 1 | COG2084 | | MSM0548 |
| 1 | COG3425 | 3-hydroxy-3-methylglutaryl CoA synthase | MSM1561 |

Inorganic Ion Transport and Metabolism (P)

| | | | |
|---|---|---|---|
| 1 | COG0003 | Oxyanion-translocating ATPase | MSM1170 |
| 1 | COG0004 | Ammonia permease | MSM0234 |
| 1 | COG0038 | Chloride channel protein EriC | MSM1721 |
| 1 | COG0053 | Predicted Co/Zn/Cd cation transporters | MSM0789 |
| 1 | COG0168 | Trk-type K+ transport systems, membrane | MSM1095 |
| | | components | |
| 1 | COG0226 | ABC-type phosphate transport system, periplasmic | MSM0568 |
| | | component | |
| 1 | COG0288 | Carbonic anhydrase | MSM1223 |
| 4 | COG0310 | ABC-type Co2+ transport system, permease | MSM0583, MSM0584, |
| | | component | MSM1488, MSM1618 |
| 1 | COG0370 | Fe2+ transport system protein B | MSM0589 |
| 1 | COG0474 | Cation transport ATPase | MSM0895 |
| 1 | COG0475 | Kef-type K+ transport systems, membrane | MSM1186 |
| | | components | |
| 1 | COG0530 | Ca2+/Na+ antiporter | MSM1027 |
| 1 | COG0569 | K+ transport systems, NAD-binding component | MSM1096 |
| 1 | COG0573 | ABC-type phosphate transport system, permease | MSM0567 |
| | | component | |
| 1 | COG0581 | ABC-type phosphate transport system, permease | MSM0566 |
| | | component | |
| 1 | COG0600 | ABC-type nitrate/sulfonate/bicarbonate transport | MSM0291 |
| | | system, permease component | |
| 1 | COG0609 | ABC-type Fe3+-siderophore transport system, | MSM1394 |
| | | permease component | |
| 1 | COG0614 | ABC-type Fe3+-hydroxamate transport system, | MSM1393 |
| | | periplasmic component | |
| 3 | COG0619 | ABC-type cobalt transport system, permease | MSM0585, MSM0771, |
| | | component CbiQ and related transporters | MSM1620 |
| 2 | COG0704 | Phosphate uptake regulator | MSM0564, MSM0569 |
| 1 | COG0715 | ABC-type nitrate/sulfonate/bicarbonate transport | MSM1469 |
| | | systems, periplasmic components | |
| 1 | COG0725 | ABC-type molybdate transport system, periplasmic | MSM1609 |
| | | component | |
| 1 | COG0798 | Arsenite efflux pump ACR3 and related permeases | MSM1078 |
| 1 | COG0855 | Polyphosphate kinase | MSM1424 |
| 1 | COG1006 | Multisubunit Na+/H+ antiporter, MnhC subunit | MSM1072 |
| 1 | COG1116 | ABC-type nitrate/sulfonate/bicarbonate transport | MSM0290 |
| | | system, ATPase component | |
| 1 | COG1117 | ABC-type phosphate transport system, ATPase | MSM0565 |
| | | component | |
| 1 | COG1118 | ABC-type sulfate/molybdate transport systems, | MSM1611 |
| | | ATPase component | |
| 2 | COG1122 | ABC-type cobalt transport system, ATPase | MSM0586, MSM1621 |
| | | component | |
| 1 | COG1230 | Co/Zn/Cd efflux system component | MSM1639 |
| 1 | COG1320 | Multisubunit Na+/H+ antiporter, MnhG subunit | MSM1074 |
| 1 | COG1348 | Nitrogenase subunit NifH (ATPase) | MSM1707 |
| 1 | COG1528 | Ferritin-like protein | MSM1712 |
| 1 | COG1563 | Predicted subunit of the Multisubunit Na+/H+ | MSM1073 |
| | | antiporter | |
| 1 | COG1824 | Permease, similar to cation transporters | MSM1275 |
| 1 | COG1863 | Multisubunit Na+/H+ antiporter, MnhE subunit | MSM1076 |
| 1 | COG1918 | Fe2+ transport system protein A | MSM0588 |
| 1 | COG1930 | ABC-type cobalt transport system, periplasmic | MSM1619 |
| | | component | |
| 2 | COG2111 | Multisubunit Na+/H+ antiporter, MnhB subunit | MSM1068, MSM1069 |
| 1 | COG2116 | Formate/nitrite family of transporters | MSM1403 |
| 1 | COG2212 | Multisubunit Na+/H+ antiporter, MnhF subunit | MSM1075 |
| 4 | COG2217 | Cation transport ATPase | MSM0293, MSM0960, |
| | | | MSM1127, MSM1153 |
| 1 | COG2608 | Copper chaperone | MSM0961 |
| 1 | COG3263 | NhaP-type Na+/H+ and K+/H+ antiporters with a | MSM0618 |
| | | unique C-terminal domain | |
| 1 | COG3420 | Nitrous oxidase accessory protein | MSM1397 |
| 1 | COG4149 | ABC-type molybdate transport system, permease | MSM1610 |
| | | component | |

Secondary Metabolites Biosynthesis, Transport and Catabolism (Q)

| | | | |
|---|---|---|---|
| 1 | COG1228 | Imidazolonepropionase and related amidohydrolases | MSM1154 |

General Function Prediction Only (R)

| | | | |
|---|---|---|---|
| 2 | COG0110 | Acetyltransferase (isoleucine patch superfamily) | MSM0189, MSM1600 |
| 2 | COG0312 | Predicted Zn-dependent proteases and their | MSM0866, MSM0947 |
| | | inactivated homologs | |
| 1 | COG0375 | Zn finger protein HypA/HybF (possibly regulating | MSM0108 |
| | | hydrogenase expression) | |
| 1 | COG0388 | Predicted amidohydrolase | MSM0500 |
| 1 | COG0433 | Predicted ATPase | MSM0122 |
| 1 | COG0446 | Uncharacterized NAD(FAD)-dependent | MSM0046 |
| | | dehydrogenases | |
| 2 | COG0456 | Acetyltransferases | MSM0893, MSM1104 |
| 11 | COG0457 | FOG: TPR repeat | MSM0530, MSM0651, |
| | | | MSM0914, MSM1449, |
| | | | MSM1451, MSM1740, |
| | | | MSM1766, MSM1776, |
| | | | MSM1786, MSM1787, |
| | | | MSM1788 |
| 2 | COG0491 | Zn-dependent hydrolases, including glyoxylases | MSM0421, MSM1097 |
| 1 | COG0496 | Predicted acid phosphatase | MSM1218 |
| 2 | COG0517 | FOG: CBS domain | MSM0175, MSM1102 |
| 4 | COG0535 | Predicted Fe—S oxidoreductases | MSM0663, MSM0808, |
| | | | MSM1301, MSM1497 |
| 1 | COG0561 | Predicted hydrolases of the HAD superfamily | MSM0946 |
| 1 | COG0595 | Predicted hydrolase of the metallo-beta-lactamase | MSM1442 |
| | | superfamily | |
| 1 | COG0603 | Predicted PP-loop superfamily ATPase | MSM0936 |
| 1 | COG0613 | Predicted metal-dependent phosphoesterases (PHP | MSM1244 |
| | | family) | |
| 1 | COG0622 | Predicted phosphoesterase | MSM0507 |
| 1 | COG0627 | Predicted esterase | MSM0149 |
| 1 | COG0628 | Predicted permease | MSM1042 |
| 1 | COG0641 | Arylsulfatase regulator (Fe—S oxidoreductase) | MSM1606 |
| 5 | COG0655 | Multimeric flavodoxin WrbA | MSM0267, MSM0664, |
| | | | MSM0923, MSM1209, |
| | | | MSM1727 |
| 1 | COG0661 | Predicted unusual protein kinase | MSM0525 |
| 1 | COG0663 | Carbonic anhydrases/acetyltransferases, isoleucine | MSM0654 |
| | | patch superfamily | |
| 1 | COG0666 | FOG: Ankyrin repeat | MSM0266 |
| 1 | COG0673 | Predicted dehydrogenases and related proteins | MSM0882 |
| 1 | COG0679 | Predicted permeases | MSM1334 |
| 1 | COG0714 | MoxR-like ATPases | MSM0555 |
| 1 | COG0730 | Predicted permeases | MSM0420 |
| 3 | COG0733 | Na+-dependent transporters of the SNF family | MSM0699, MSM1531, |
| | | | MSM1532 |
| 1 | COG0824 | Predicted thioesterase | MSM0133 |
| 1 | COG1011 | Predicted hydrolase (HAD superfamily) | MSM1480 |
| 1 | COG1019 | Predicted nucleotidyltransferase | MSM0785 |
| 1 | COG1078 | HD superfamily phosphohydrolases | MSM0236 |
| 1 | COG1084 | Predicted GTPase | MSM0869 |
| 1 | COG1094 | Predicted RNA-binding protein (contains KH domains) | MSM0954 |
| 1 | COG1099 | Predicted metal-dependent hydrolases with the TIM- | MSM0405 |
| | | barrel fold | |
| 3 | COG1123 | ATPase components of various ABC-type transport | MSM0770, MSM0971, |
| | | systems, contain duplicated ATPase | MSM1698 |
| 2 | COG1163 | Predicted GTPase | MSM0714, MSM0715 |
| 1 | COG1201 | Lhr-like helicases | MSM0502 |
| 1 | COG1202 | Superfamily II helicase, archaea-specific | MSM1583 |
| 1 | COG1203 | Predicted helicases | MSM0166 |
| 1 | COG1204 | Superfamily II helicase | MSM0839 |
| 1 | COG1205 | Distinct helicase family with a unique C-terminal | MSM0112 |
| | | domain including a metal-binding cysteine cluster | |
| 5 | COG1216 | Predicted glycosyltransferases | MSM1321, MSM1329, |
| | | | MSM1330, MSM1503, |
| | | | MSM1507 |
| 1 | COG1223 | Predicted ATPase (AAA+ superfamily) | MSM0966 |
| 1 | COG1234 | Metal-dependent hydrolases of the beta-lactamase | MSM0492 |
| | | superfamily III | |
| 1 | COG1235 | Metal-dependent hydrolases of the beta-lactamase | MSM1473 |
| | | superfamily I | |
| 1 | COG1244 | Predicted Fe—S oxidoreductase | MSM0544 |
| 1 | COG1245 | Predicted ATPase, RNase L inhibitor (RLI) homolog | MSM0607 |
| 1 | COG1253 | Hemolysins and related proteins containing CBS | MSM1026 |
| | | domains | |
| 4 | COG1266 | Predicted metal-dependent membrane protease | MSM0292, MSM0803, |
| | | | MSM1148, MSM1180 |
| 1 | COG1268 | Uncharacterized conserved protein | MSM0429 |
| 2 | COG1277 | ABC-type transport system involved in multi-copper | MSM0594, MSM0595 |
| | | enzyme maturation, permease component | |
| 1 | COG1287 | Uncharacterized membrane protein, required for N- | MSM0716 |
| | | linked glycosylation | |
| 1 | COG1310 | Predicted metal-dependent protease of the | MSM0462 |
| | | PAD1/JAB1 superfamily | |
| 2 | COG1323 | Predicted nucleotidyltransferase | MSM0547, MSM0994 |
| 1 | COG1326 | Uncharacterized archaeal Zn-finger protein | MSM0846 |
| 2 | COG1342 | Predicted DNA-binding proteins | MSM0207, MSM0208 |
| 1 | COG1350 | Predicted alternative tryptophan synthase beta- | MSM1242 |
| | | subunit (paralog of TrpB) | |
| 1 | COG1355 | Predicted dioxygenase | MSM1438 |
| 1 | COG1365 | Predicted ATPase (PP-loop superfamily) | MSM0190 |
| 9 | COG1373 | Predicted ATPase (AAA+ superfamily) | MSM0061, MSM0280, |
| | | | MSM0680, MSM1197, |
| | | | MSM1278, MSM1527, |
| | | | MSM1789, MSM1790, |
| | | | MSM1795 |
| 1 | COG1402 | Uncharacterized protein, putative amidase | MSM0184 |
| 2 | COG1408 | Predicted phosphohydrolases | MSM0964, MSM1165 |
| 1 | COG1409 | Predicted phosphohydrolases | MSM0383 |
| 1 | COG1411 | Uncharacterized protein related to proFAR isomerase | MSM1636 |
| | | (HisA) | |
| 1 | COG1412 | Uncharacterized proteins of PilT N-term./Vapc | MSM0199 |
| | | superfamily | |
| 1 | COG1418 | Predicted HD superfamily hydrolase | MSM0632 |
| 1 | COG1439 | Predicted nucleic acid-binding protein, consists of a | MSM0816 |
| | | PIN domain and a Znribbon module | |
| 4 | COG1453 | Predicted oxidoreductases of the aldo/keto reductase | MSM0148, MSM0728, |
| | | family | MSM1450, MSM1608 |
| 1 | COG1489 | DNA-binding protein, stimulates sugar fermentation | MSM1090 |
| 1 | COG1537 | Predicted RNA-binding proteins | MSM0640 |
| 1 | COG1545 | Predicted nucleic-acid-binding protein containing a | MSM1279 |
| | | Zn-ribbon | |
| 2 | COG1571 | Predicted DNA-binding protein containing a Zn-ribbon | MSM0452, MSM1295 |
| | | domain | |
| 1 | COG1606 | ATP-utilizing enzymes of the PP-loop superfamily | MSM0482 |
| 1 | COG1608 | Predicted archaeal kinase | MSM1440 |
| 1 | COG1611 | Predicted Rossmann fold nucleotide-binding protein | MSM0004 |
| 1 | COG1634 | Uncharacterized Rossmann fold enzyme | MSM0672 |
| 1 | COG1646 | Predicted phosphate-binding enzymes, TIM-barrel | MSM0124 |
| | | fold | |
| 2 | COG1672 | Predicted ATPase (AAA+ superfamily) | MSM1196, MSM1646 |
| 1 | COG1691 | NCAIR mutase (PurE)-related proteins | MSM1105 |
| 1 | COG1707 | ACT domain-containing protein | MSM1060 |
| 1 | COG1759 | ATP-utilizing enzymes of ATP-grasp superfamily | MSM0506 |
| | | (probably carboligases) | |
| 1 | COG1779 | C4-type Zn-finger protein | MSM0409 |
| 1 | COG1782 | Predicted metal-dependent RNase, consists of a | MSM1038 |
| | | metallo-beta-lactamase domain and an RNA-binding | |
| | | KH domain | |
| 1 | COG1821 | Predicted ATP-utilizing enzyme (ATP-grasp | MSM0852 |
| | | superfamily) | |
| 1 | COG1829 | Predicted archaeal kinase (sugar kinase superfamily) | MSM0060 |
| 1 | COG1855 | ATPase (PilT family) | MSM1183 |
| 1 | COG1878 | Predicted metal-dependent hydrolase | MSM0827 |
| 1 | COG1907 | Predicted archaeal sugar kinases | MSM0848 |
| 1 | COG1942 | Uncharacterized protein, 4-oxalocrotonate | MSM0688 |
| | | tautomerase homolog | |
| 1 | COG1964 | Predicted Fe—S oxidoreductases | MSM0849 |
| 1 | COG1988 | Predicted membrane-bound metal-dependent | MSM1079 |
| | | hydrolases | |
| 1 | COG1994 | Zn-dependent proteases | MSM0479 |
| 2 | COG2005 | N-terminal domain of molybdenum-binding protein | MSM0131, MSM1207 |
| 1 | COG2047 | Uncharacterized protein (ATP-grasp superfamily) | MSM1131 |
| 1 | COG2054 | Uncharacterized archaeal kinase related to | MSM0604 |
| | | aspartokinases, uridylate kinases | |
| 1 | COG2068 | Uncharacterized MobA-related protein | MSM0116 |
| 1 | COG2079 | Uncharacterized protein involved in propionate | MSM0449 |
| | | catabolism | |
| 1 | COG2081 | Predicted flavoproteins | MSM1235 |
| 1 | COG2085 | Predicted dinucleotide-binding enzymes | MSM0049 |
| 1 | COG2102 | Predicted ATPases of PP-loop superfamily | MSM0142 |
| 1 | COG2118 | DNA-binding protein | MSM0708 |
| 1 | COG2129 | Predicted phosphoesterases, related to the lcc | MSM0792 |
| | | protein | |
| 1 | COG2150 | Predicted regulator of amino acid metabolism, | MSM0635 |
| | | contains ACT domain | |
| 1 | COG2151 | Predicted metal-sulfur cluster biosynthetic enzyme | MSM0634 |
| 1 | COG2220 | Predicted Zn-dependent hydrolases of the beta- | MSM0779 |
| | | lactamase fold | |
| 1 | COG2232 | Predicted ATP-dependent carboligase related to | MSM0431 |
| | | biotin carboxylase | |
| 3 | COG2244 | Membrane protein involved in the export of O-antigen | MSM1208, MSM1559, |
| | | and teichoic acid | MSM1560 |
| 1 | COG2252 | Permeases | MSM1736 |
| 1 | COG2403 | Predicted GTPase | MSM0091 |
| 1 | COG2405 | Predicted nucleic acid-binding protein, contains PIN | MSM1530 |
| | | domain | |
| 1 | COG2517 | Predicted RNA-binding protein containing a C- | MSM0466 |
| | | terminal EMAP domain | |
| 2 | COG2520 | Predicted methyltransferase | MSM0802, MSM1036 |
| 1 | COG2522 | Predicted transcriptional regulator | MSM0269 |
| 3 | COG3291 | FOG: PKD repeat | MSM0281, MSM1716, |
| | | | MSM1735 |
| 1 | COG3442 | Predicted glutamine amidotransferase | MSM1138 |
| 1 | COG3552 | Protein containing von Willebrand factor type A | MSM0554 |
| | | (vWA) domain | |
| 1 | COG3608 | Predicted deacylase | MSM1080 |
| 1 | COG3894 | Uncharacterized metal-binding protein | MSM0517 |
| 1 | COG3942 | Surface antigen | MSM0921 |
| 1 | COG3943 | Virulence protein | MSM1645 |
| 1 | COG4002 | Predicted phosphotransacetylase | MSM0095 |
| 1 | COG4015 | Predicted dinucleotide-utilizing enzyme of the | MSM0577 |
| | | ThiF/HesA family | |
| 1 | COG4026 | Uncharacterized protein containing TOPRIM domain, | MSM1703 |
| | | potential nuclease | |
| 2 | COG4032 | Predicted thiamine-pyrophosphate-binding protein | MSM0080, MSM0081 |
| 1 | COG4052 | Uncharacterized protein related to methyl coenzyme | MSM1021 |
| | | M reductase subunit C | |
| 1 | COG4076 | Predicted RNA methylase | MSM0363 |
| 1 | COG4085 | Predicted RNA-binding protein, contains TRAM | MSM0647 |
| | | domain | |
| 1 | COG4087 | Soluble P-type ATPase | MSM1252 |
| 1 | COG4277 | Predicted DNA-binding protein with the Helix-hairpin- | MSM1239 |
| | | helix motif | |
| 2 | COG4747 | ACT domain-containing protein | MSM0388, MSM1713 |
| 1 | COG4801 | Predicted acyltransferase | MSM1385 |
| 1 | COG4827 | Predicted transporter | MSM1717 |
| 1 | COG5012 | Predicted cobalamin binding protein | MSM0516 |
| 3 | COG5271 | AAA ATPase containing von Willebrand factor type A | MSM0993, MSM1240, |
| | | (vWA) domain | MSM1454 |
| 1 | COG5362 | Phage-related terminase | MSM1671 |
| 1 | COG5518 | Bacteriophage capsid portal protein | MSM1672 |
| 2 | COG5643 | Protein containing a metal-binding domain shared | MSM1489, MSM1491 |
| | | with formylmethanofuran dehydrogenase subunit E | |

Function Unknown (S)

| | | | |
|---|---|---|---|
| 1 | COG0011 | Uncharacterized conserved protein | MSM1029 |
| 2 | COG0028 | | MSM0686, MSM1225 |
| 1 | COG0059 | | MSM1222 |
| 1 | COG0111 | | MSM0457 |
| 1 | COG0147 | | MSM1146 |
| 1 | COG0248 | | MSM1423 |
| 2 | COG0318 | | MSM0025, MSM0374 |
| 1 | COG0327 | Uncharacterized conserved protein | MSM0576 |
| 1 | COG0378 | | MSM0107 |
| 1 | COG0391 | Uncharacterized conserved protein | MSM0974 |
| 1 | COG0392 | Predicted integral membrane protein | MSM1094 |
| 2 | COG0393 | Uncharacterized conserved protein | MSM0418, MSM0456 |
| 1 | COG0432 | Uncharacterized conserved protein | MSM0279 |
| 1 | COG0444 | | MSM0303 |
| 1 | COG0451 | | MSM0327 |
| 2 | COG0458 | | MSM0361, MSM0488 |
| 1 | COG0462 | | MSM1577 |
| 2 | COG0473 | | MSM0373, MSM1298 |
| 2 | COG0477 | | MSM0772, MSM1210 |
| 2 | COG0500 | | MSM0028, MSM1510 |
| 1 | COG0505 | | MSM0489 |
| 1 | COG0512 | | MSM1145 |
| 1 | COG0513 | | MSM1498 |
| 1 | COG0543 | | MSM1043 |
| 1 | COG0585 | Uncharacterized conserved protein | MSM1156 |
| 1 | COG0591 | | MSM0386 |
| 1 | COG0599 | Uncharacterized homolog of gamma- | MSM0296 |
| | | carboxymuconolactone decarboxylase subunit | |
| 1 | COG0601 | | MSM0301 |
| 2 | COG0615 | | MSM0859, MSM1514 |
| 1 | COG1028 | | MSM1731 |
| 2 | COG1061 | | MSM0690, MSM0695 |
| 1 | COG1063 | | MSM0376 |
| 1 | COG1086 | | MSM1535 |
| 1 | COG1120 | | MSM1395 |
| 1 | COG1124 | | MSM0304 |
| 2 | COG1134 | | MSM1326, MSM1592 |
| 1 | COG1173 | | MSM0302 |
| 1 | COG1199 | | MSM1352 |
| 1 | COG1208 | | MSM0655 |
| 1 | COG1243 | | MSM0842 |
| 1 | COG1255 | Uncharacterized protein conserved in archaea | MSM0894 |
| 2 | COG1300 | Uncharacterized membrane protein | MSM0215, MSM1526 |
| 1 | COG1303 | Uncharacterized protein conserved in archaea | MSM0932 |
| 1 | COG1339 | | MSM1257 |
| 1 | COG1359 | Uncharacterized conserved protein | MSM1378 |
| 1 | COG1371 | Uncharacterized conserved protein | MSM0668 |
| 1 | COG1379 | Uncharacterized conserved protein | MSM1129 |
| 1 | COG1387 | | MSM0063 |
| 1 | COG1415 | Uncharacterized conserved protein | MSM0931 |
| 1 | COG1422 | Predicted membrane protein | MSM0736 |
| 1 | COG1430 | Uncharacterized conserved protein | MSM1339 |
| 1 | COG1460 | Uncharacterized protein conserved in archaea | MSM1376 |
| 1 | COG1469 | Uncharacterized conserved protein | MSM1033 |
| 2 | COG1474 | | MSM0671, MSM1264 |
| 1 | COG1478 | Uncharacterized conserved protein | MSM0975 |
| 1 | COG1511 | Predicted membrane protein | MSM0093 |
| 2 | COG1520 | FOG: WD40-like repeat | MSM1247, MSM1567 |
| 1 | COG1548 | | MSM0851 |
| 1 | COG1578 | Uncharacterized conserved protein | MSM0551 |
| 1 | COG1602 | Uncharacterized conserved protein | MSM0346 |
| 2 | COG1617 | Uncharacterized conserved protein | MSM0348, MSM0349 |
| 1 | COG1627 | Uncharacterized protein conserved in archaea | MSM0983 |
| 1 | COG1630 | Uncharacterized protein conserved in archaea | MSM0123 |
| 1 | COG1641 | Uncharacterized conserved protein | MSM0935 |
| 1 | COG1665 | Uncharacterized protein conserved in archaea | MSM1058 |
| 1 | COG1679 | Uncharacterized conserved protein | MSM1192 |
| 1 | COG1685 | | MSM0835 |
| 1 | COG1690 | Uncharacterized conserved protein | MSM0666 |
| 1 | COG1693 | Uncharacterized protein conserved in archaea | MSM1417 |
| 1 | COG1698 | Uncharacterized protein conserved in archaea | MSM1268 |
| 1 | COG1701 | Uncharacterized protein conserved in archaea | MSM0140 |
| 2 | COG1704 | Uncharacterized conserved protein | MSM0660, MSM1422 |
| 1 | COG1710 | Uncharacterized protein conserved in archaea | MSM0069 |
| 1 | COG1711 | Uncharacterized protein conserved in archaea | MSM1136 |
| 1 | COG1714 | Predicted membrane protein/domain | MSM1493 |
| 1 | COG1718 | | MSM0952 |
| 1 | COG1720 | Uncharacterized conserved protein | MSM0132 |
| 2 | COG1738 | Uncharacterized conserved protein | MSM0646, MSM1382 |
| 1 | COG1739 | Uncharacterized conserved protein | MSM0186 |
| 1 | COG1751 | Uncharacterized conserved protein | MSM0628 |
| 1 | COG1771 | Uncharacterized protein conserved in archaea | MSM0070 |
| 1 | COG1784 | Predicted membrane protein | MSM0599 |
| 1 | COG1786 | Uncharacterized conserved protein | MSM1155 |
| 1 | COG1795 | Uncharacterized conserved protein | MSM1213 |
| 1 | COG1809 | Uncharacterized conserved protein | MSM0086 |
| 1 | COG1817 | Uncharacterized protein conserved in archaea | MSM0106 |
| 2 | COG1822 | Predicted archaeal membrane protein | MSM0581, MSM1216 |
| 1 | COG1836 | Predicted membrane protein | MSM0659 |
| 1 | COG1844 | Uncharacterized protein conserved in archaea | MSM0356 |
| 1 | COG1849 | Uncharacterized protein conserved in archaea | MSM0614 |
| 2 | COG1852 | Uncharacterized conserved protein | MSM0225, MSM0649 |
| 1 | COG1860 | Uncharacterized protein conserved in archaea | MSM0285 |
| 1 | COG1865 | Uncharacterized conserved protein | MSM0825 |
| 1 | COG1872 | Uncharacterized conserved protein | MSM1603 |
| 4 | COG1873 | Uncharacterized conserved protein | MSM0465, MSM0822, |
| | | | MSM0841, MSM1004 |
| 1 | COG1891 | Uncharacterized protein conserved in archaea | MSM1628 |
| 1 | COG1909 | Uncharacterized protein conserved in archaea | MSM0195 |
| 1 | COG1915 | Uncharacterized conserved protein | MSM0875 |
| 1 | COG1916 | Uncharacterized homolog of PrgY (pheromone | MSM1024 |
| | | shutdown protein) | |
| 1 | COG1917 | Uncharacterized conserved protein, contains double- | MSM1447 |
| | | stranded beta-helix domain | |
| 1 | COG1920 | Uncharacterized conserved protein | MSM0288 |
| 1 | COG1937 | Uncharacterized protein conserved in bacteria | MSM0959 |
| 1 | COG1944 | Uncharacterized conserved protein | MSM0480 |
| 1 | COG1945 | Uncharacterized conserved protein | MSM0878 |
| 1 | COG1950 | Predicted membrane protein | MSM1166 |
| 1 | COG1971 | Predicted membrane protein | MSM0030 |
| 1 | COG1990 | Uncharacterized conserved protein | MSM0605 |
| 1 | COG1991 | Uncharacterized conserved protein | MSM0145 |
| 1 | COG2029 | Uncharacterized conserved protein | MSM1057 |
| 1 | COG2035 | Predicted membrane protein | MSM1582 |
| 1 | COG2042 | Uncharacterized conserved protein | MSM0126 |
| 1 | COG2043 | Uncharacterized protein conserved in archaea | MSM0115 |
| 1 | COG2078 | Uncharacterized conserved protein | MSM0867 |
| 1 | COG2090 | Uncharacterized protein conserved in archaea | MSM1591 |
| 1 | COG2098 | Uncharacterized protein conserved in archaea | MSM0985 |
| 1 | COG2106 | Uncharacterized conserved protein | MSM0763 |
| 1 | COG2122 | Uncharacterized conserved protein | MSM0088 |
| 1 | COG2136 | | MSM1632 |
| 2 | COG2138 | Uncharacterized conserved protein | MSM1280, MSM1281 |
| 1 | COG2246 | Predicted membrane protein | MSM1289 |
| 2 | COG2314 | Predicted membrane protein | MSM0109, MSM1739 |
| 2 | COG2364 | Predicted membrane protein | MSM0673, MSM0676 |
| 1 | COG2429 | Uncharacterized conserved protein | MSM0973 |
| 1 | COG2450 | Uncharacterized conserved protein | MSM0406 |
| 1 | COG2456 | Uncharacterized conserved protein | MSM1624 |
| 1 | COG2457 | Uncharacterized conserved protein | MSM0873 |
| 1 | COG2892 | Uncharacterized protein conserved in archaea | MSM1633 |
| 1 | COG3273 | Uncharacterized conserved protein | MSM1274 |
| 2 | COG3274 | Uncharacterized protein conserved in bacteria | MSM1370, MSM1556 |
| 1 | COG3356 | Predicted membrane protein | MSM0776 |
| 1 | COG3367 | Uncharacterized conserved protein | MSM0407 |
| 1 | COG3482 | Uncharacterized conserved protein | MSM0481 |
| 1 | COG3543 | Uncharacterized conserved protein | MSM0430 |
| 3 | COG3548 | Predicted integral membrane protein | MSM0468, MSM0469, |
| | | | MSM1205 |
| 1 | COG3586 | Uncharacterized conserved protein | MSM1741 |
| 1 | COG3815 | Predicted membrane protein | MSM1770 |
| 1 | COG3874 | Uncharacterized conserved protein | MSM0683 |
| 1 | COG3976 | Uncharacterized protein conserved in bacteria | MSM1637 |
| 1 | COG4009 | Uncharacterized protein conserved in archaea | MSM0794 |
| 1 | COG4010 | Uncharacterized protein conserved in archaea | MSM0793 |
| 1 | COG4012 | Uncharacterized protein conserved in archaea | MSM1243 |
| 1 | COG4014 | Uncharacterized protein conserved in archaea | MSM0840 |
| 1 | COG4016 | Uncharacterized protein conserved in archaea | MSM0578 |
| 1 | COG4017 | Uncharacterized protein conserved in archaea | MSM0575 |
| 1 | COG4018 | Uncharacterized protein conserved in archaea | MSM0571 |
| 1 | COG4019 | Uncharacterized protein conserved in archaea | MSM0574 |
| 1 | COG4020 | Uncharacterized protein conserved in archaea | MSM1221 |
| 1 | COG4021 | Uncharacterized conserved protein | MSM0463 |
| 1 | COG4022 | Uncharacterized protein conserved in archaea | MSM0643 |
| 1 | COG4029 | Uncharacterized protein conserved in archaea | MSM0812 |
| 1 | COG4030 | Uncharacterized protein conserved in archaea | MSM0309 |
| 1 | COG4033 | Uncharacterized protein conserved in archaea | MSM0103 |
| 1 | COG4035 | Predicted membrane protein | MSM0315 |
| 1 | COG4036 | Predicted membrane protein | MSM0320 |
| 1 | COG4037 | Predicted membrane protein | MSM0321 |
| 1 | COG4038 | Predicted membrane protein | MSM0322 |
| 1 | COG4039 | Predicted membrane protein | MSM0323 |
| 1 | COG4040 | Predicted membrane protein | MSM0324 |
| 1 | COG4041 | Predicted membrane protein | MSM0325 |
| 1 | COG4042 | Predicted membrane protein | MSM0326 |
| 2 | COG4050 | Uncharacterized protein conserved in archaea | MSM0811, MSM1130 |
| 1 | COG4051 | Uncharacterized protein conserved in archaea | MSM0809 |
| 1 | COG4053 | Uncharacterized protein conserved in archaea | MSM0229 |
| 1 | COG4065 | Uncharacterized protein conserved in archaea | MSM1006 |
| 2 | COG4066 | Uncharacterized protein conserved in archaea | MSM0064, MSM0367 |
| 1 | COG4068 | Uncharacterized protein containing a Zn-ribbon | MSM0417 |
| 1 | COG4069 | Uncharacterized protein conserved in archaea | MSM0815 |
| 1 | COG4071 | Uncharacterized protein conserved in archaea | MSM0630 |
| 1 | COG4073 | Uncharacterized protein conserved in archaea | MSM0726 |
| 1 | COG4077 | Uncharacterized protein conserved in archaea | MSM1034 |
| 1 | COG4078 | Predicted membrane protein | MSM0319 |
| 1 | COG4079 | Uncharacterized protein conserved in archaea | MSM1472 |
| 1 | COG4081 | Uncharacterized protein conserved in archaea | MSM0104 |
| 1 | COG4084 | Uncharacterized protein conserved in archaea | MSM0314 |
| 1 | COG4121 | Uncharacterized conserved protein | MSM1555 |
| 1 | COG4289 | Uncharacterized protein conserved in bacteria | MSM1302 |
| 1 | COG4635 | | MSM1262 |
| 3 | COG4713 | Predicted membrane protein | MSM0521, MSM1291, |
| | | | MSM1444 |
| 2 | COG4744 | Uncharacterized conserved protein | MSM1402, MSM1719 |
| 1 | COG4883 | Uncharacterized protein conserved in archaea | MSM1086 |
| 1 | COG4907 | Predicted membrane protein | MSM1421 |
| 1 | COG5015 | Uncharacterized conserved protein | MSM0863 |
| 1 | COG5305 | Predicted membrane protein | MSM1288 |
| 1 | COG5423 | Predicted metal-binding protein | MSM0050 |
| 1 | COG5440 | Uncharacterized conserved protein | MSM1265 |
| 4 | COG5464 | Uncharacterized conserved protein | MSM0067, MSM0681, |
| | | | MSM1765, MSM1785 |

TABLE 10
Glycosyltransferases (GT) in M. smithii strain PS and M. stadtmanae proteomes
classified according to Carbohydrate Active enZyme (CAZy) database
CAZy GT family Protein Annotation

| | | | |
|---|---|---|---|
| M. smithii | GT1 | MSM0423* | glycosyltransferase (modular protein with two domains distantly related to |
| | | | glycosyltransferases), GT2/GT1 families [CAZy] |
| | GT2 | MSM0423* | glycosyltransferase (modular protein with two domains distantly related to |
| | | | glycosyltransferases), GT2/GT1 families [CAZy] |
| | | MSM1290 | glycosyltransferase (related to beta-glycosyltransferases), GT2 family [CAZy] |
| | | MSM1294 | glycosyltransferase (related to beta-glycosyltransferases), GT2 family [CAZy] |
| | | MSM1297 | glycosyltransferase (related to beta-glycosyltransferases), GT2 family [CAZy] |
| | | MSM1310 | glycosyltransferase (related to beta-glycosyltransferases), GT2 family [CAZy] |
| | | MSM1311 | glycosyltransferase (related to beta-glycosyltransferases), GT2 family [CAZy] |
| | | MSM1312 | glycosyltransferase (related to beta-glycosyltransferases), GT2 family [CAZy] |
| | | MSM1316 | glycosyltransferase (related to beta-glycosyltransferases), GT2 family [CAZy] |
| | | MSM1321 | glycosyltransferase (related to beta-glycosyltransferases), GT2 family [CAZy] |
| | | MSM1323 | glycosyltransferase (related to beta-glycosyltransferases), GT2 family [CAZy] |
| | | MSM1324 | glycosyltransferase (related to beta-glycosyltransferases), GT2 family [CAZy] |
| | | MSM1328 | glycosyltransferase (related to beta-glycosyltransferases), GT2 family [CAZy] |
| | | MSM1329 | glycosyltransferase (related to beta-glycosyltransferases), GT2 family [CAZy] |
| | | MSM1330 | glycosyltransferase (related to beta-glycosyltransferases), GT2 family [CAZy] |
| | | MSM1503 | glycosyltransferase (related to beta-glycosyltransferases), GT2 family [CAZy] |
| | | MSM1507 | glycosyltransferase (related to beta-glycosyltransferases), GT2 family [CAZy] |
| | | MSM1545 | glycosyltransferase (related to beta-glycosyltransferases), GT2 family [CAZy] |
| | | MSM1594 | glycosyltransferase (modular protein with two N-terminal beta- |
| | | | glycosyltransferaserelated domains and C-terminal |
| | | | glycerophosphotransferase-related domain), GT2 families [CAZy] |
| | | MSM1602 | glycosyltransferase (modular protein with N-terminal beta- |
| | | | glycosyltransferase-related domain and C-terminal |
| | | | glycerophosphotransferase-related domain), GT2 family [CAZy] |
| | | MSM1623 | glycosyltransferase (related to beta-glycosyltransferases), GT2 family [CAZy] |
| | | MSM1627 | glycosyltransferase (related to bactoprenol beta-glucosyltransferase), GT2 family [CAZy] |
| | GT4 | MSM0836 | related to alpha-glycosyltransferases, GT4 family [CAZy] |
| | | MSM1313 | distantly related to glycosyltransferases, GT4 family [CAZy] |
| | | MSM1317 | distantly related to glycosyltransferases, GT4 family [CAZy] |
| | | MSM1322 | distantly related to alpha-glycosyltransferases, GT4 family [CAZy] |
| | GT66 | MSM0716 | glycosyltransferase (distantly related to oligosaccharyltransferases), STT3 |
| | | | subunit, GT66 family [CAZy] |
| M. stadtmanae | GT1 | Msp_0515 | partially conserved hypothetical protein |
| | | Msp_0645 | predicted glycosyltransferase |
| | GT2 | Msp_0042** | predicted glycosyltransferase |
| | | Msp_0045 | predicted glycosyltransferase |
| | | Msp_0054 | predicted glycosyltransferase |
| | | Msp_0203 | predicted glycosyltransferase |
| | | Msp_0206 | predicted glycosyltransferase |
| | | Msp_0207 | predicted glycosyltransferase |
| | | Msp_0212 | predicted glycosyltransferase |
| | | Msp_0215 | predicted glycosyltransferase |
| | | Msp_0218 | predicted glycosyltransferase |
| | | Msp_0220 | predicted glycosyltransferase |
| | | Msp_0441 | predicted glycosyltransferase |
| | | Msp_0442 | predicted glycosyltransferase |
| | | Msp_0492 | predicted glycosyltransferase |
| | | Msp_0493 | predicted glycosyltransferase |
| | | Msp_0495 | predicted glycosyltransferase |
| | | Msp_0496 | predicted glycosyltransferase |
| | | Msp_0500 | predicted glycosyltransferase |
| | | Msp_0538 | predicted glycosyltransferase |
| | | Msp_0541 | predicted glycosyltransferase |
| | | Msp_0645 | predicted glycosyltransferase |
| | | Msp_0989 | predicted glycosyltransferase |
| | | Msp_1087 | predicted glycosyltransferase |
| | | Msp_1481 | conserved hypothetical membrane-spanning protein |
| | | Msp_1540 | partially conserved hypothetical protein |
| | GT4 | Msp_0039 | predicted glycosyltransferase |
| | | Msp_0044 | predicted glycosyltransferase |
| | | Msp_0049 | predicted glycosyltransferase |
| | | Msp_0051 | predicted glycosyltransferase |
| | | Msp_0052 | predicted glycosyltransferase |
| | | Msp_0053 | predicted glycosyltransferase |
| | | Msp_0055 | predicted glycosyltransferase |
| | | Msp_0056 | predicted glycosyltransferase |
| | | Msp_0057 | predicted glycosyltransferase |
| | | Msp_0101 | predicted glycosyltransferase |
| | | Msp_0492 | predicted glycosyltransferase |
| | | Msp_0991 | predicted glycosyltransferase |
| | GT66 | Msp_0368 | conserved hypothetical membrane-spanning protein |

*modular protein
**probable fragment

TABLE 11
InterPro-based classification of adhesin-like proteins (ALPs) in the M. smithii
strain PS and M. stadtmanae proteomes

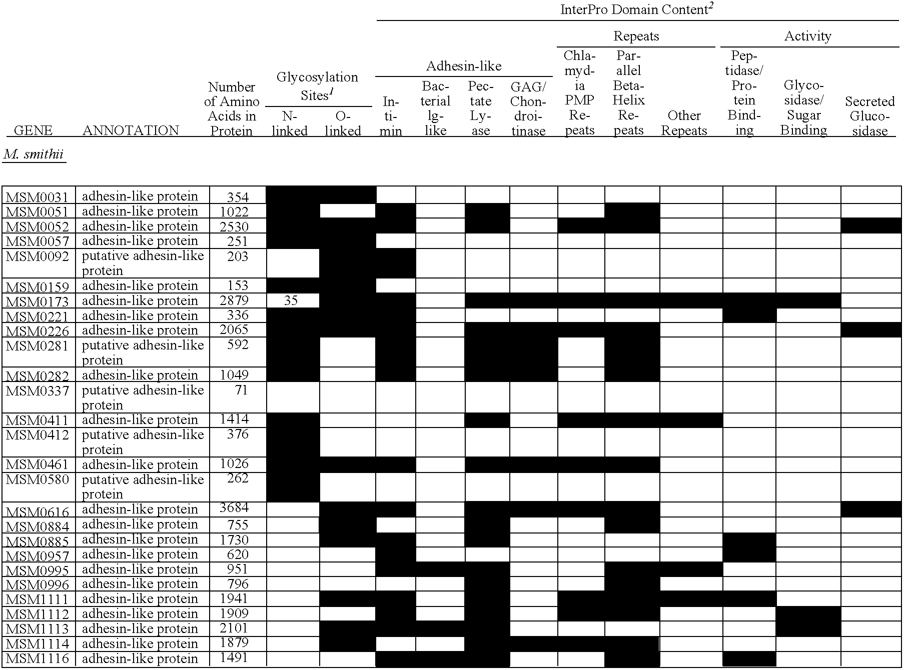

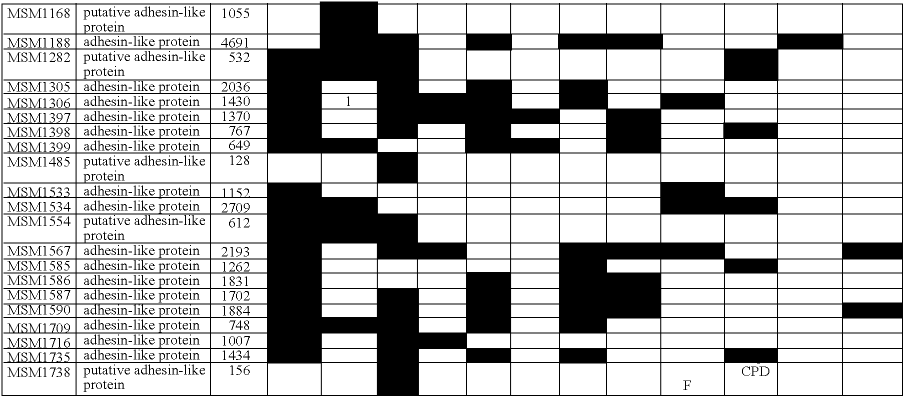

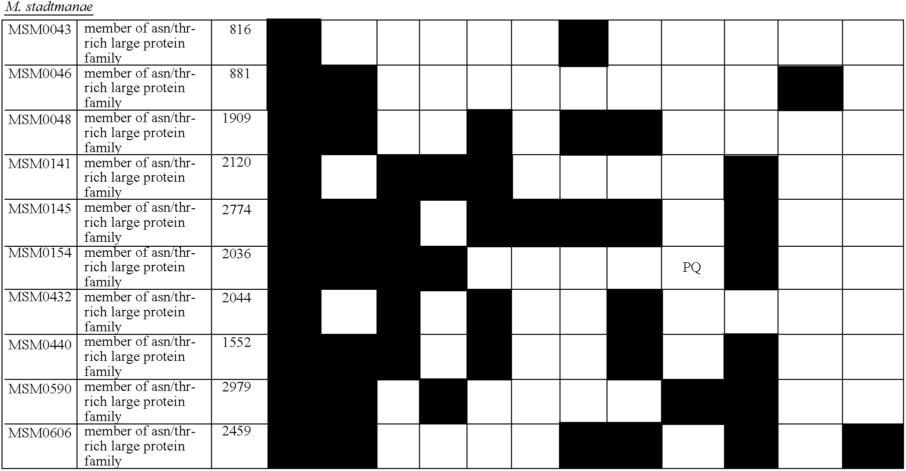

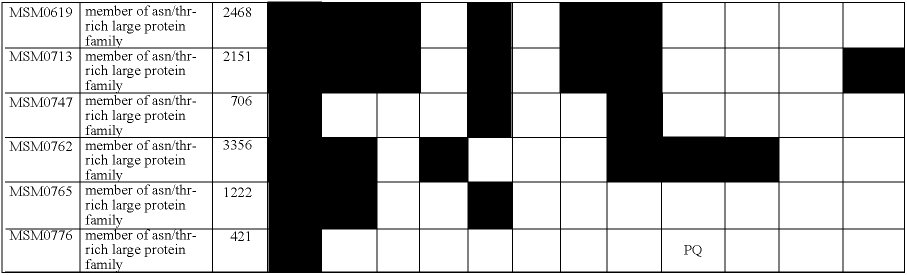

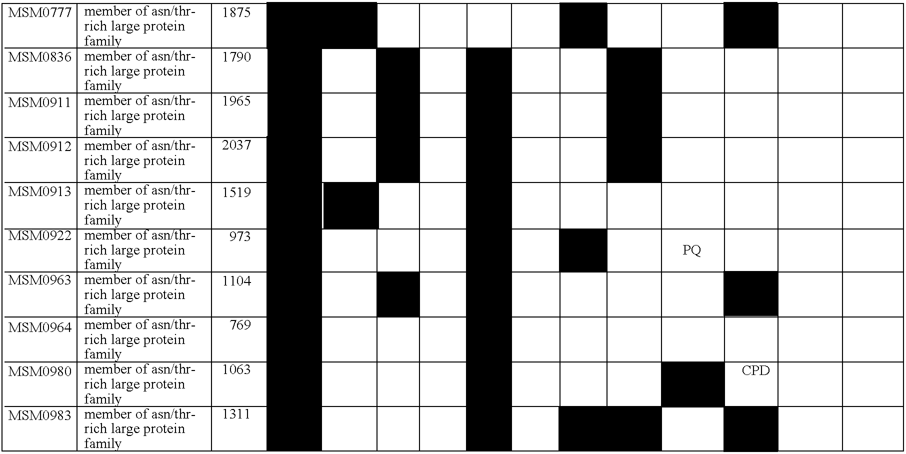

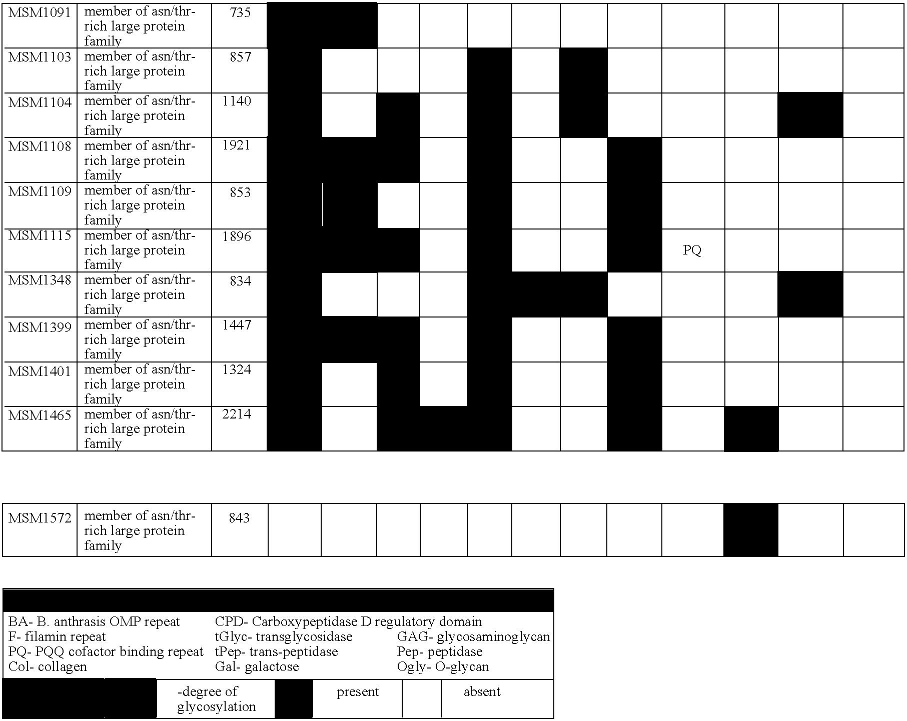

¹Predictions completed using NetNGlyc and NetOglyc (htt://www.cbs.dtu.dk/services/).
²InterPro domains: Invasin/intimin cell-adhesion (IPR008964); Bacterial Ig-like (IPR003344); pectin lyase fold (IPRO11O5O); GAG lyase, Chondroitinase B-type (IPR012333); Polymorphic membrane protein, Chlamydia (IPR003368); Parallel beta-helix repeat (IPR006626); Peptidase S8 and S53 (IPR000209); Penicillin-binding protein, transpeptidase fold (IPR012338); Carboxypeptidase regulatory region (IPR008969)

TABLE 12
M. smithii GeneChip
Genes Probe Average number of Naming Prefix Represented
Probesets pairs probe pairs per probeset

| | | | | | |
|---|---|---|---|---|---|
| control sequences | AFFX | 64 | 64 | 1024 | 16 |
| protein coding genes | MSM | 1778 | 2018 | 19967 | 11 |
| tRNA genes (1-2 | MSM-tRNAxx | 34 | 74 | 450 | 11 |
| probesets/gene) | | | | | |
| rRNA genes1 | MSMxx-rRNA | 8 | 7 | 77 | 11 |
| intergenic sequences | ig | | 1581 | 4931 | 3 |

¹Note that the M. smithii genome contains three 5S rRNA genes, one 7S rRNA gene, two 16S rRNA genes, and two 23S rRNA genes. Due to the high nucleotide sequence identity among rRNA genes of a given type, each is represented by a single probeset (the 16S rRNA probeset is replicated four times on the GeneChip

TABLE 13
BLAST analysis of the putative M. smithii strain PS prophage

| | Phage Protein | | | | |
|---|---|---|---|---|---|
| M. smithii Protein | Sequence ID* | Function | HMM Annotation | Phage HMM | E value |
| MSM1640 | 5417 | unknown | Phage_integrase: Phage integrase family | PF00589 | 2.30E−06 |
| MSM1654 | 5721 | Gp40 | ERF: ERF superfamily | PF04404 | 6.90E−11 |
| MSM1671 | 5397 | large terminase subunit | psiM2_ORF9: phage uncharacterized protein, | TIGR01630 | 0.0042 |
| | | | C-terminal domain | | |
| MSM1672 | 5398 | portal protein | portal_PBSX: phage portal protein, PBSX | TIGR01540 | 6.70E−12 |
| | | | family | | |
| MSM1675 | 6246 | putative structural protein | | | |
| MSM1677 | 6247 | putative structural protein | | | |
| MSM1684 | 20206 | ORF001 | TMP: TMP repeat | PF05017 | 0.0036 |
| MSM1691 | 6262 | PeiW | | | |

*from the Phage Sequence Databank

TABLE 14
M. smithii strain PS treated with varying concentrations of statins
Atorvastatin treated cells, average optical density
(600 nm), standard deviation

| 1 mM | 100 μM | 10 μM | methanol |
|---|---|---|---|
| 0.032 (0.006) | 0.032 (0.003) | 0.03 (0.001) | 0.032 (0.004) |
| 0.018 (0.002) | 0.032 (0.007) | 0.042 (0.004) | 0.07 (0.007) |
| 0.001 (0.003) | 0.031 (0.006) | 0.09 (0.005) | 0.135 (0.008) |
| 0.001 (0.004) | 0.03 (0.007) | 0.079 (0.027) | 0.13 (0.012) |
| 0.008 (0.004) | 0.033 (0.007) | 0.139 (0.043) | 0.234 (0.018) |
| 0.007 (0.012) | 0.033 (0.002) | 0.233 (0.11) | 0.195 (0.05) |
| 0.001 (0.006) | 0.024 (0.007) | 0.115 (0.045) | 0.218 (0.064) |

Pravastatin treated cells, average optical density
(600 nm), standard deviation

| 1 mM | 100 μM | 10 μM | ethanol |
|---|---|---|---|
| 0.034 (0.003) | 0.035 (0.003) | 0.039 (0.004) | 0.036 (0.005) |
| 0.036 (0.006) | 0.069 (0.02) | 0.066 (0.003) | 0.072 (0.012) |
| 0.031 (0.003) | 0.104 (0.03) | 0.097 (0.025) | 0.128 (0.011) |
| 0.038 (0.003) | 0.104 (0.024) | 0.084 (0.009) | 0.109 (0.011) |
| 0.026 (0.006) | 0.139 (0.078) | 0.08 (0.014) | 0.223 (0.015) |
| 0.016 (0.01) | 0.217 (0.175) | 0.181 (0.048) | 0.258 (0.105) |
| 0.017 (0.004) | 0.297 (0.111) | 0.039 (0.015) | 0.212 (0.113) |

Rosuvastatin treated cells, average optical density
(600 nm), standard deviation

| 1 mM | 100 μM | 10 μM | DMSO |
|---|---|---|---|
| 0.031 (0.002) | 0.031 (0.003) | 0.034 (0.002) | 0.033 (0.002) |
| 0.024 (0.006) | 0.026 (0.009) | 0.068 (0.006) | 0.075 (0.006) |
| 0.017 (0.006) | 0.021 (0.002) | 0.101 (0.009) | 0.125 (0.013) |
| 0.03 (0.014) | 0.02 (0.004) | 0.082 (0.011) | 0.093 (0.007) |
| 0.013 (0.008) | 0.027 (0.016) | 0.122 (0.039) | 0.152 (0.05) |
| 0.018 (0.004) | 0.033 (0.005) | 0.159 (0.058) | 0.117 (0.029) |
| 0.003 (0.002) | 0.033 (0.042) | 0.174 (0.146) | 0.183 (0.071) |

TABLE 15
M. smithii strain F1 treated with varying concentrations of statins
Atorvastatin treated cells, average optical density
(600 nm), standard deviation

| 1 mM | 100 μM | 10 μM | methanol |
|---|---|---|---|
| 0.015 (0.006) | 0.01 (0) | 0.019 (0.001) | 0.015 (0.003) |
| 0.008 (0.014) | 0.018 (0.001) | 0.039 (0.004) | 0.045 (0.003) |
| 0.013 (0.01) | 0.018 (0.002) | 0.039 (0.007) | 0.069 (0.002) |
| 0.004 (0.014) | 0.018 (0.003) | 0.056 (0.011) | 0.092 (0.003) |
| 0.001 (0.011) | 0.016 (0.002) | 0.061 (0.023) | 0.115 (0.008) |
| 0.001 (0.015) | 0.015 (0.001) | 0.084 (0.033) | 0.155 (0.019) |

Pravastatin treated cells, average optical density
(600 nm), standard deviation

| 1 mM | 100 μM | 10 μ | ethanol |
|---|---|---|---|
| 0.011 (0.001) | 0.007 (0.002) | 0.019 (0.001) | 0.017 (0.002) |
| 0.022 (0.002) | 0.047 (0.004) | 0.05 (0.003) | 0.05 (0.005) |
| 0.026 (0.003) | 0.066 (0.004) | 0.071 (0.003) | 0.073 (0.006) |
| 0.026 (0.003) | 0.085 (0.008) | 0.102 (0.003) | 0.095 (0.004) |
| 0.022 (0.002) | 0.089 (0.01) | 0.124 (0.004) | 0.121 (0.011) |
| 0.018 (0.003) | 0.133 (0.029) | 0.168 (0.004) | 0.153 (0.024) |

Rosuvastatin treated cells, average optical density
(600 nm), standard deviation

| 1 mM | 100 μM | 10 μM | DMSO |
|---|---|---|---|
| 0.015 (0.003) | 0.01 (0.003) | 0.021 (0.003) | 0.015 (0.003) |
| 0.016 (0.003) | 0.026 (0.003) | 0.046 (0.004) | 0.043 (0.001) |
| 0.019 (0.003) | 0.027 (0.004) | 0.057 (0.002) | 0.062 (0.003) |
| 0.019 (0.003) | 0.026 (0.004) | 0.081 (0.008) | 0.081 (0.005) |
| 0.018 (0.003) | 0.025 (0.001) | 0.085 (0.021) | 0.103 (0.005) |
| 0.02 (0.006) | 0.016 (0.003) | 0.094 (0.048) | 0.102 (0.017) |

TABLE 16
M. smithii strain ALI treated with varying concentrations of statins
Atorvastatin treated cells, average optical density
(600 nm), standard deviation

| 1 mM | 100 μM | 10 μM | methanol |
|---|---|---|---|
| 0.01 (0.008) | 0.015 (0.003) | 0.012 (0.002) | 0.019 (0.004) |
| 0.016 (0.007) | 0.008 (0.002) | 0.026 (0.016) | 0.043 (0.015) |
| 0.052 (0.063) | 0.002 (0.001) | 0.058 (0.084) | 0.046 (0.022) |
| 0.018 (0.028) | 0.014 (0.016) | 0.072 (0.066) | 0.074 (0.024) |
| 0.025 (0.043) | 0.008 (0.014) | 0.031 (0.046) | 0.06 (0.044) |
| 0.01 (0.012) | 0.001 (0) | 0.024 (0.02) | 0.093 (0.053) |

Pravastatin treated cells, average optical density
(600 nm), standard deviation

| 1 mM | 100 μM | 10 μM | ethanol |
|---|---|---|---|
| 0.013 (0.002) | 0.011 (0.003) | 0.015 (0.001) | 0.025 (0.009) |
| 0.036 (0.045) | 0.054 (0.036) | 0.06 (0.027) | 0.047 (0.012) |
| 0.103 (0.176) | 0.072 (0.076) | 0.071 (0.037) | 0.061 (0.026) |
| 0.051 (0.027) | 0.079 (0.122) | 0.086 (0.048) | 0.083 (0.036) |
| 0.018 (0.026) | 0.104 (0.154) | 0.083 (0.053) | 0.083 (0.038) |
| 0.081 (0.032) | 0.091 (0.143) | 0.116 (0.05) | 0.111 (0.047) |

Rosuvastatin treated cells, average optical density
(600 nm), standard deviation

| 1 mM | 100 μM | 10 μM | DMSO |
|---|---|---|---|
| 0.017 (0.007) | 0.029 (0.016) | 0.019 (0.005) | 0.014 (0.002) |
| 0.032 (0.02) | 0.033 (0.037) | 0.044 (0.008) | 0.04 (0.007) |
| 0.02 (0.02) | 0.012 (0.009) | 0.038 (0.011) | 0.044 (0.008) |
| 0.013 (0.01) | 0.028 (0.021) | 0.056 (0.036) | 0.058 (0.006) |
| 0.015 (0.009) | 0.015 (0.018) | 0.074 (0.036) | 0.085 (0.003) |
| 0.016 (0.01) | 0.015 (0.026) | 0.1 (0.02) | 0.126 (0.013) |

TABLE 17
M. smithii strain B181 treated with
varying concentrations of statins
Atorvastatin treated cells, average optical density
(600 nm), standard deviation

| 1 mM | 100 μM | 10 μM | methanol |
|---|---|---|---|
| 0.007 (0.004) | 0.004 (0.001) | 0.011 (0.001) | 0.007 (0.003) |
| 0.018 (0.001) | 0.013 (0.003) | 0.032 (0.007) | 0.034 (0.006) |
| 0.014 (0.003) | 0.005 (0.002) | 0.032 (0.006) | 0.046 (0.022) |
| 0.009 (0.002) | 0.003 (0.005) | 0.04 (0.008) | 0.07 (0.029) |
| 0.01 (0.004) | 0.003 (0) | 0.044 (0.011) | 0.121 (0.027) |
| 0.01 (0.003) | 0.006 (0.001) | 0.048 (0.009) | 0.133 (0.026) |

Pravastatin treated cells, average optical density
(600 nm), standard deviation

| 1 mM | 100 μM | 10 μM | ethanol |
|---|---|---|---|
| 0.007 (0.001) | 0.003 (0.001) | 0.011 (0.001) | 0.009 (0.003) |
| 0.019 (0.003) | 0.039 (0.005) | 0.047 (0.002) | 0.039 (0.013) |
| 0.015 (0.008) | 0.061 (0.004) | 0.061 (0.003) | 0.048 (0.03) |
| 0.014 (0.001) | 0.088 (0.002) | 0.102 (0.007) | 0.094 (0.075) |
| 0.016 (0.002) | 0.114 (0.006) | 0.135 (0.01) | 0.137 (0.057) |
| 0.015 (0.006) | 0.171 (0.031) | 0.198 (0.02) | 0.14 (0.037) |

Rosuvastatin treated cells, average optical density
(600 nm), standard deviation

| 1 mM | 100 μM | 10 μM | DMSO |
|---|---|---|---|
| 0.01 (0) | 0.006 (0.006) | 0.012 (0.002) | 0.005 (0.004) |
| 0.016 (0.004) | 0.013 (0.003) | 0.029 (0.001) | 0.032 (0.003) |
| 0.011 (0.002) | 0.008 (0.001) | 0.04 (0.001) | 0.066 (0.02) |
| 0.01 (0.005) | 0.007 (0.003) | 0.066 (0.005) | 0.095 (0.018) |
| 0.014 (0.004) | 0.004 (0.002) | 0.097 (0.014) | 0.148 (0.032) |
| 0.008 (0.003) | 0.001 (0.002) | 0.121 (0.012) | 0.194 (0.073) |

What is claimed is:

1. An array comprising a substrate, the substrate having disposed thereon at least one nucleic acid, wherein the nucleic acid comprises a nucleic acid sequence selected from the nucleic acid sequences listed in Table A.

2. The array of claim 1, wherein the nucleic acid or nucleic acids are located at a spatially defined address of the array.

3. The array of claim 2, wherein the array has no more than 500 spatially defined addresses.

4. The array of claim 2, wherein the array has at least 500 spatially defined addresses.

5. A method of selecting a compound that has efficacy for modulating a gene product of M. smithii present in the gastrointestinal tract of a subject, the method comprising:
a. comparing an M. smithii gene profile to a gene profile of the subject,
b. identifying a gene product of the M. smithii gene profile that is divergent from a corresponding gene product of the subject gene profile, or absent in the gene profile of the subject, and
c. selecting a compound that modulates the M. smithii gene product but does not substantially modulate the corresponding divergent gene product of the subject.

6. The method of claim 5, wherein the compound inhibits the M. smithii gene product, but does not substantially inhibit the corresponding gene product of the subject.

7. The method of claim 6, wherein the compound inhibits the growth of M. smithii.

8. The method of claim 6, wherein the compound decreases the efficiency of carbohydrate metabolism in the subject.

9. The method of claim 6, wherein the compound promotes weight loss.

10. The method of claim 5, wherein the compound upregulates the M. smithii gene product, but does not substantially upregulate the corresponding gene product of the subject.

11. The method of claim 10, wherein the compound promotes the growth of M. smithii.

12. The method of claim 10, wherein the compound increases the efficiency of carbohydrate metabolism in the subject.

13. The method of claim 10, wherein the compound promotes weight gain.

14. The method of claim 5, wherein the compound, as administered to a subject, modulates the M. smithii gene product but does not substantially modulate the corresponding divergent gene product of the subject.

15. The method of claim 14, wherein the compound is an HMG-CoA reductase inhibitor.

16. A method for modulating a gene product of M. smithii present in the gastrointestinal tract of a subject, the method comprising administering to the subject an HMG-CoA reductase inhibitor that has been formulated for release in the distal portion of the subject's gastrointestinal tract and thereby substantially inhibits more of the HMG-CoA reductase of M. smithii compared to the subject's HMG-CoA reductase.

17. The method of claim 16, wherein the inhibitor is a statin.
